(19) United States
(12) Patent Application Publication
(10) Pub. No.: US 2011/0307398 A1
(43) Pub. Date: Dec. 15, 2011

(54) Managing Consistent Interfaces for Request for Information, Request for Information Response, Supplier Assessment Profile, Supplier Questionnaire Assessment, and Supplier Transaction Assessment Business Objects across Heterogeneous Systems

(76) Inventors: Tilo Reinhardt, Bad Schoenborn (DE); Christoph Jungkind, Heidelberg (DE); Tobias Hoppe-Boeken, Wiesbaden (DE); Frank Symmank, Heidelberg (DE); Sarah Vanessa Pesch, Edingen-Neckarhausen (DE); Peter Josef Fitz, Waldsee (DE); Antonia Gross-Tarakji, Nussloch (DE); Melanie Siegmann, Heidelberg (DE); Gururaj C S, Bangalore (IN); Azita Agha Moradlou, Heidelberg (DE); Brit Panzer, Mannheim (DE); Ruediger Erich Wolfram Partsch, Hessheim (DE); Andre Wagner, Sinsheim (DE); Werner Gnan, Angelbachtal (DE); Michael Seubert, Sinsheim (DE); Bikash Bansal, Assam (IN); Santhosh Guru, Bangalore (IN)

(21) Appl. No.: 12/816,268

(22) Filed: Jun. 15, 2010

(51) Int. Cl. G06Q 99/00

(52) U.S. Cl. 705/319; 705/347

(57) ABSTRACT

A business object model, which reflects data that is used during a given business transaction, is utilized to generate interfaces. This business object model facilitates commercial transactions by providing consistent interfaces that are suitable for use across industries, across businesses, and across different departments within a business during a business transaction. In some operations, software creates, updates, or otherwise processes information related to a request for information, a request for information response, a supplier assessment profile, a supplier questionnaire assessment, and/or a supplier transaction assessment business object.

### TECHNICAL FIELD

The subject matter described herein relates generally to the generation and use of consistent interfaces (or services) derived from a business object model. More particularly, the present disclosure relates to the generation and use of consistent interfaces or services that are suitable for use across industries, across businesses, and across different departments within a business.

### BACKGROUND

Transactions are common among businesses and between business departments within a particular business. During any given transaction, these business entities exchange information. For example, during a sales transaction, numerous business entities may be involved, such as a sales entity that sells merchandise to a customer, a financial institution that handles the financial transaction, and a warehouse that sends the merchandise to the customer. The end-to-end business transaction may require a significant amount of information to be exchanged between the various business entities involved. For example, the customer may send a request for the merchandise as well as some form of payment authorization for the merchandise to the sales entity, and the sales entity may send the financial institution a request for a transfer of funds from the customer's account to the sales entity's account.

Exchanging information between different business entities is not a simple task. This is particularly true because the information used by different business entities is usually tightly tied to the business entity itself. Each business entity may have its own program for handling its part of the transaction. These programs differ from each other because they typically are created for different purposes and because each business entity may use semantics that differ from the other business entities. For example, one program may relate to accounting, another program may relate to manufacturing, and a third program may relate to inventory control. Similarly, one program may identify merchandise using the name of the product while another program may identify the same merchandise using its model number. Further, one business entity may use U.S. dollars to represent its currency while another business entity may use Japanese Yen. A simple difference in formatting, e.g., the use of upper-case lettering rather than lower-case or title-case, makes the exchange of information between businesses a difficult task. Unless the individual businesses agree upon particular semantics, human interaction typically is required to facilitate transactions between these businesses. Because these “heterogeneous” programs are used by different companies or by different business areas within a given company, a need exists for a consistent way to exchange information and perform a business transaction between the different business entities.

Currently, many standards exist that offer a variety of interfaces used to exchange business information. Most of these interfaces, however, apply to only one specific industry and are not consistent between the different standards. Moreover, a number of these interfaces are not consistent within an individual standard.

### SUMMARY

In a first aspect, a tangible computer readable medium includes program code for providing a message-based interface for exchanging capabilities-related information based on a request for information (RFI) between a buyer and existing or potential suppliers. The medium comprises program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for a request from the buyer to the supplier to provide a response to the RFI that includes a first message package derived from the common business object model and hierarchically organized in memory as a form RFI response request message entity and a request for information package comprising a request for information entity, where the request for information entity includes a watermark name and an ID.

The medium further comprises program code for processing the first message according to the hierarchical organization of the first message package, where processing the first message includes unpacking the first message package based on the common business object model.

The medium further comprises program code for sending a second message to the heterogeneous application responsive to the first message, where the second message includes a second message package derived from the common business object model to provide consistent semantics with the first message package.

Implementations can include the following. The request for information package further comprises at least one of the following: a party package, a property package, a text package, an attachment package, and a section package. The request for information entity comprises at least one of the following: a reconciliation period counter value, a name, and a supplier group code.

In another aspect, a distributed system operates in a landscape of computer systems providing message-based services defined in a service registry. The system comprises a graphical user interface comprising computer readable instructions, embedded on tangible media, for a request from a buyer to a potential supplier to provide a response to an RFI, using a request.

The system further comprises a first memory storing a user interface controller for processing the request and involving a message including a message package derived from a common business object model, where the common business object model includes business objects having relationships that enable derivation of message-based service interfaces and message packages, the message package hierarchically organized as a form RFI response request message entity and a request for information package comprising a request for information entity, where the request for information entity includes a watermark name and an ID.

The system further comprises a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

Implementations can include the following. The first memory is remote from the graphical user interface. The first memory is remote from the second memory.

In another aspect, a tangible computer readable medium includes program code for providing a message-based interface for exchanging RFI response-related information in response to a request for information in which an existing supplier and/or potential supplier provides the requested information. The medium comprises program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for a confirmation submitted by a supplier to a buyer in response to the request for information that includes a first message package derived from the common business object model and hierarchically organized in memory as an RFI response confirmation message entity and an RFI response package comprising an RFI response entity, a party package and a business transaction document reference package, where the party package includes a seller party entity, where the business transaction document reference package includes a base request for information reference entity, and further where the base request for information reference entity comprises an ID.

The medium further comprises program code for processing the first message according to the hierarchical organization of the first message package, where processing the first message includes unpacking the first message package based on the common business object model.

The medium further comprises program code for sending a second message to the heterogeneous application responsive to the first message, where the second message includes a second message package derived from the common business object model to provide consistent semantics with the first message package.

Implementations can include the following. The RFI response package further comprises at least one of the following: a properties package, a text package, an attachment package, and a section package.

In another aspect, a distributed system operates in a landscape of computer systems providing message-based services defined in a service registry. The system comprises a graphical user interface comprising computer readable instructions, embedded on tangible media, for a confirmation submitted by a supplier to a buyer in response to a request for information using a request.

The system further comprises a first memory storing a user interface controller for processing the request and involving a message including a message package derived from a common business object model, where the common business object model includes business objects having relationships that enable derivation of message-based service interfaces and message packages, the message package hierarchically organized as an RFI response confirmation message entity and an RFI response package comprising an RFI response entity, a party package and a business transaction document reference package, where the party package includes a seller party entity, where the business transaction document reference package includes a base request for information reference entity, and further where the base request for information reference entity comprises an ID.

The system further comprises a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

Implementations can include the following. The first memory is remote from the graphical user interface. The first memory is remote from the second memory.

In another aspect, a tangible computer readable medium includes program code for providing a message-based interface for exchanging supplier assessment profile-related information, including information for a profile for assessing suppliers that includes rules, weighted assessment criteria, and questions related to supplier performance. The medium comprises program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for requesting supplier assessment profile-related information that includes a first message package derived from the common business object model and hierarchically organized in memory as a supplier assessment profile request message entity and a supplier assessment profile package comprising a supplier assessment profile entity and an access control list package, where the supplier assessment profile entity includes an identifier (ID), a universally unique identifier (UUID), system administrative data, a time zone code, and a template indicator.

The medium further comprises program code for processing the first message according to the hierarchical organization of the first message package, where processing the first message includes unpacking the first message package based on the common business object model.

The medium further comprises program code for sending a second message to the heterogeneous application responsive to the first message, where the second message includes a second message package derived from the common business object model to provide consistent semantics with the first message package.

Implementations can include the following. The supplier assessment profile package further comprises at least one of the following: a party package, an assessment category package, a calendar day recurrence specification package, a text collection package, an attachment folder package, and a calculated assessment period. The supplier assessment profile entity further comprises at least one of the following: a name and a product category.

In another aspect, a distributed system operates in a landscape of computer systems providing message-based services defined in a service registry. The system comprises a graphical user interface comprising computer readable instructions, embedded on tangible media, for requesting supplier assessment profile-related information, including information for a profile for assessing suppliers that includes rules, weighted assessment criteria, and questions related to supplier performance using a request.

The system further comprises a first memory storing a user interface controller for processing the request and involving a message including a message package derived from a common business object model, where the common business object model includes business objects having relationships that enable derivation of message-based service interfaces and message packages, the message package hierarchically organized as a supplier assessment profile request message entity and a supplier assessment profile package comprising a supplier assessment profile entity and an access control list package, where the supplier assessment profile entity includes an identifier (ID), a universally unique identifier (UUID), system administrative data, a time zone code, and a template indicator.

The system further comprises a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

Implementations can include the following. The first memory is remote from the graphical user interface. The first memory is remote from the second memory.

In another aspect, a tangible computer readable medium includes program code for providing a message-based interface for exchanging supplier questionnaire assessment-related information, including an assessment of a supplier's performance based on a questionnaire that includes answers to a list of questions about the supplier that is submitted by a buyer. The medium comprises program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for a confirmation about the completion of a supplier questionnaire assessment that includes a first message package derived from the common business object model and hierarchically organized in memory as a supplier questionnaire assessment completion confirmation message entity and a supplier questionnaire assessment package comprising a supplier questionnaire assessment entity and a party package, where the supplier questionnaire assessment entity includes an ID, and where the party package includes an appraiser party entity, and further where the appraiser party entity includes a seller ID.

The medium further comprises program code for processing the first message according to the hierarchical organization of the first message package, where processing the first message includes unpacking the first message package based on the common business object model.

The medium further comprises program code for sending a second message to the heterogeneous application responsive to the first message, where the second message includes a second message package derived from the common business object model to provide consistent semantics with the first message package.

Implementations can include the following. The supplier questionnaire assessment entity further comprises a reconciliation period counter value. The supplier questionnaire assessment package further comprises at least one of the following: a text package, an attachment package, and a category package.

In another aspect, a distributed system operates in a landscape of computer systems providing message-based services defined in a service registry. The system comprises a graphical user interface comprising computer readable instructions, embedded on tangible media, for a confirmation about the completion of a supplier questionnaire assessment, including an assessment of a supplier's performance based on a questionnaire that includes answers to a list of questions about a supplier that is submitted by a buyer using a request.

The system further comprises a first memory storing a user interface controller for processing the request and involving a message including a message package derived from a common business object model, where the common business object model includes business objects having relationships that enable derivation of message-based service interfaces and message packages, the message package hierarchically organized as a supplier questionnaire assessment completion confirmation message entity and a supplier questionnaire assessment package comprising a supplier questionnaire assessment entity and a party package, where the supplier questionnaire assessment entity includes an ID, and where the party package includes an appraiser party entity, and further where the appraiser party entity includes a seller ID.

The system further comprises a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

Implementations can include the following. The first memory is remote from the graphical user interface. The first memory is remote from the second memory.

In another aspect, a tangible computer readable medium includes program code for providing a message-based interface for exchanging supplier transaction assessment-related information, including an assessment of a supplier's performance based on an automatic evaluation of a business transaction and follow-on business transactions. The medium comprises program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for requesting supplier transaction assessment-related information that includes a first message package derived from the common business object model and hierarchically organized in memory as a supplier transaction assessment request message entity and a supplier transaction assessment package comprising a supplier transaction assessment entity, where the supplier transaction assessment entity includes a universally unique identifier, system administrative data, and a base business transaction document key.

The medium further comprises program code for processing the first message according to the hierarchical organization of the first message package, where processing the first message includes unpacking the first message package based on the common business object model.

The medium further comprises program code for sending a second message to the heterogeneous application responsive to the first message, where the second message includes a second message package derived from the common business object model to provide consistent semantics with the first message package.

Implementations can include the following. The supplier transaction assessment package further comprises at least one of the following: an item package and a party package. The supplier transaction assessment entity comprises at least one of the following: a base business transaction document ID and a base business transaction document type code.

In another aspect, a distributed system operates in a landscape of computer systems providing message-based services defined in a service registry. The system comprises a graphical user interface comprising computer readable instructions, embedded on tangible media, for requesting supplier transaction assessment-related information, including an assessment of a supplier's performance based on an automatic evaluation of a business transaction and follow-on business transactions using a request.

The system further comprises a first memory storing a user interface controller for processing the request and involving a message including a message package derived from a common business object model, where the common business object model includes business objects having relationships that enable derivation of message-based service interfaces and message packages, the message package hierarchically organized as a supplier transaction assessment request message entity and a supplier transaction assessment package comprising a supplier transaction assessment entity, where the supplier transaction assessment entity includes a universally unique identifier, system administrative data, and a base business transaction document key.

The system further comprises a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

Implementations can include the following. The first memory is remote from the graphical user interface. The first memory is remote from the second memory.

### BRIEF DESCRIPTION OF THE DRAWINGS

FIG. 1 depicts a flow diagram of the overall steps performed by methods and systems consistent with the subject matter described herein.

FIG. 2 depicts a business document flow for an invoice request in accordance with methods and systems consistent with the subject matter described herein.

FIGS. 3A-B illustrate example environments implementing the transmission, receipt, and processing of data between heterogeneous applications in accordance with certain embodiments included in the present disclosure.

FIG. 4 illustrates an example application implementing certain techniques and components in accordance with one embodiment of the system of FIG. 1.

FIG. 5A depicts an example development environment in accordance with one embodiment of FIG. 1.

FIG. 5B depicts a simplified process for mapping a model representation to a runtime representation using the example development environment of FIG. 5A or some other development environment.

FIG. 6 depicts message categories in accordance with methods and systems consistent with the subject matter described herein.

FIG. 7 depicts an example of a package in accordance with methods and systems consistent with the subject matter described herein.

FIG. 8 depicts another example of a package in accordance with methods and systems consistent with the subject matter described herein.

FIG. 9 depicts a third example of a package in accordance with methods and systems consistent with the subject matter described herein.

FIG. 10 depicts a fourth example of a package in accordance with methods and systems consistent with the subject matter described herein.

FIG. 11 depicts the representation of a package in the XML schema in accordance with methods and systems consistent with the subject matter described herein.

FIG. 12 depicts a graphical representation of cardinalities between two entities in accordance with methods and systems consistent with the subject matter described herein.

FIG. 13 depicts an example of a composition in accordance with methods and systems consistent with the subject matter described herein.

FIG. 14 depicts an example of a hierarchical relationship in accordance with methods and systems consistent with the subject matter described herein.

FIG. 15 depicts an example of an aggregating relationship in accordance with methods and systems consistent with the subject matter described herein.

FIG. 16 depicts an example of an association in accordance with methods and systems consistent with the subject matter described herein.

FIG. 17 depicts an example of a specialization in accordance with methods and systems consistent with the subject matter described herein.

FIG. 18 depicts the categories of specializations in accordance with methods and systems consistent with the subject matter described herein.

FIG. 19 depicts an example of a hierarchy in accordance with methods and systems consistent with the subject matter described herein.

FIG. 20 depicts a graphical representation of a hierarchy in accordance with methods and systems consistent with the subject matter described herein.

FIGS. 21A-B depict a flow diagram of the steps performed to create a business object model in accordance with methods and systems consistent with the subject matter described herein.

FIGS. 22A-F depict a flow diagram of the steps performed to generate an interface from the business object model in accordance with methods and systems consistent with the subject matter described herein.

FIG. 23 depicts an example illustrating the transmittal of a business document in accordance with methods and systems consistent with the subject matter described herein.

FIG. 24 depicts an interface proxy in accordance with methods and systems consistent with the subject matter described herein.

FIG. 25 depicts an example illustrating the transmittal of a message using proxies in accordance with methods and systems consistent with the subject matter described herein.

FIG. 26A depicts components of a message in accordance with methods and systems consistent with the subject matter described herein.

FIG. 26B depicts IDs used in a message in accordance with methods and systems consistent with the subject matter described herein.

FIGS. 27A-E depict a hierarchization process in accordance with methods and systems consistent with the subject matter described herein.

FIG. 28 illustrates an example method for service enabling in accordance with one embodiment of the present disclosure.

FIG. 29 is a graphical illustration of an example business object and associated components as may be used in the enterprise service infrastructure system of the present disclosure.

FIG. 30 illustrates an example method for managing a process agent framework in accordance with one embodiment of the present disclosure.

FIG. 31 illustrates an example method for status and action management in accordance with one embodiment of the present disclosure.

FIGS. 32-1 through 32-6 depict an example object model for a business object Request for Information.

FIGS. 33-1 through 33-2 depict an example Form RFI Response Request Message Data Type.

FIGS. 34-1 through 34-2 depict an example Interactive Form RFI Response Request Message Data Type.

FIGS. 35-1 through 35-94 show an example configuration of an Element Structure that includes a FormRFIResponseRequest package.

FIGS. 36-1 through 36-112 show an example configuration of an Element Structure that includes an InteractiveFormRFIResponseRequest package.

FIGS. 37-1 through 37-4 depict an example object model for a business object RFI Response.

FIGS. 38-1 through 38-2 depict an example Response for Information Response Confirmation Message Data Type.

FIGS. 39-1 through 39-3 show an example configuration of an Element Structure that includes a RFIResponseConfirmationMessage package.

FIGS. 40-1 through 40-4 depict an example object model for a business object Supplier Assessment Profile.

FIGS. 41-1 through 41-4 depict an example object model for a business object Supplier Questionnaire Assessment.

FIGS. 42-1 through 42-2 depict an example Interactive Form Supplier Questionnaire Assessment Completion Request Message Data Type.

FIG. 43 depicts an example Supplier Questionnaire Assessment Completion Confirmation Message Data Type.

FIGS. 44-1 through 44-65 show an example configuration of an Element Structure that includes an InteractiveFormSupplierQuestionnaireAssessmentCompletionRequest package.

FIGS. 45-1 through 45-79 show an example configuration of an Element Structure that includes a SupplierQuestionnaireAssessmentCompletionConfirmation package.

FIGS. 46-1 through 46-8 depict an example object model for a business object Supplier Transaction Assessment.

### DETAILED DESCRIPTION

A. Overview

Methods and systems consistent with the subject matter described herein facilitate e-commerce by providing consistent interfaces that are suitable for use across industries, across businesses, and across different departments within a business during a business transaction. To generate consistent interfaces, methods and systems consistent with the subject matter described herein utilize a business object model, which reflects the data that will be used during a given business transaction. An example of a business transaction is the exchange of purchase orders and order confirmations between a buyer and a seller. The business object model is generated in a hierarchical manner to ensure that the same type of data is represented the same way throughout the business object model. This ensures the consistency of the information in the business object model. Consistency is also reflected in the semantic meaning of the various structural elements. That is, each structural element has a consistent business meaning. For example, the location entity, regardless of in which package it is located, refers to a location.

From this business object model, various interfaces are derived to accomplish the functionality of the business transaction. Interfaces provide an entry point for components to access the functionality of an application. For example, the interface for a Purchase Order Request provides an entry point for components to access the functionality of a Purchase Order, in particular, to transmit and/or receive a Purchase Order Request. One skilled in the art will recognize that each of these interfaces may be provided, sold, distributed, utilized, or marketed as a separate product or as a major component of a separate product. Alternatively, a group of related interfaces may be provided, sold, distributed, utilized, or marketed as a product or as a major component of a separate product. Because the interfaces are generated from the business object model, the information in the interfaces is consistent, and the interfaces are consistent among the business entities. Such consistency facilitates heterogeneous business entities in cooperating to accomplish the business transaction.

Generally, the business object is a representation of a type of a uniquely identifiable business entity (an object instance) described by a structural model. In the architecture, processes may typically operate on business objects. Business objects represent a specific view on some well-defined business content. In other words, business objects represent content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. The process component is a software package that realizes a business process and generally exposes its functionality as services. The functionality contains business transactions. In general, the process component contains one or more semantically related business objects. Often, a particular business object belongs to no more than one process component. Interactions between process component pairs involving their respective business objects, process agents, operations, interfaces, and messages are described as process component interactions, which generally determine the interactions of a pair of process components across a deployment unit boundary. Interactions between process components within a deployment unit are typically not constrained by the architectural design and can be implemented in any convenient fashion. Process components may be modular and context-independent. In other words, process components may not be specific to any particular application and as such, may be reusable. In some implementations, the process component is the smallest (most granular) element of reuse in the architecture. An external process component is generally used to represent the external system in describing interactions with the external system; however, this should be understood to require no more of the external system than that able to produce and receive messages as required by the process component that interacts with the external system. For example, process components may include multiple operations that may provide interaction with the external system. Each operation generally belongs to one type of process component in the architecture. Operations can be synchronous or asynchronous, corresponding to synchronous or asynchronous process agents, which will be described below. The operation is often the smallest, separately-callable function, described by a set of data types used as input, output, and fault parameters serving as a signature.

The architectural elements may also include the service interface, referred to simply as the interface. The interface is a named group of operations. The interface often belongs to one process component and process component might contain multiple interfaces. In one implementation, the service interface contains only inbound or outbound operations, but not a mixture of both. One interface can contain both synchronous and asynchronous operations. Normally, operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. Operation can use multiple message types for inbound, outbound, or error messages. When two process components are in different deployment units, invocation of an operation of one process component by the other process component is accomplished by the operation on the other process component sending a message to the first process component.

The architectural elements may also include the process agent. Process agents do business processing that involves the sending or receiving of messages. Each operation normally has at least one associated process agent. Each process agent can be associated with one or more operations. Process agents can be either inbound or outbound and either synchronous or asynchronous. Asynchronous outbound process agents are called after a business object changes such as after a “create,” “update,” or “delete” of a business object instance. Synchronous outbound process agents are generally triggered directly by business object. An outbound process agent will generally perform some processing of the data of the business object instance whose change triggered the event. The outbound agent triggers subsequent business process steps by sending messages using well-defined outbound services to another process component, which generally will be in another deployment unit, or to an external system. The outbound process agent is linked to the one business object that triggers the agent, but it is sent not to another business object but rather to another process component. Thus, the outbound process agent can be implemented without knowledge of the exact business object design of the recipient process component. Alternatively, the process agent may be inbound. For example, inbound process agents may be used for the inbound part of a message-based communication. Inbound process agents are called after a message has been received. The inbound process agent starts the execution of the business process step requested in a message by creating or updating one or multiple business object instances. Inbound process agent is not generally the agent of business object but of its process component. Inbound process agent can act on multiple business objects in a process component. Regardless of whether the process agent is inbound or outbound, an agent may be synchronous if used when a process component requires a more or less immediate response from another process component, and is waiting for that response to continue its work.

The architectural elements also include the deployment unit. Each deployment unit may include one or more process components that are generally deployed together on a single computer system platform. Conversely, separate deployment units can be deployed on separate physical computing systems. The process components of one deployment unit can interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by the deployment unit to be scaled to meet demand by creating as many instances as needed.

Since interaction between deployment units is through process component operations, one deployment unit can be replaced by other another deployment unit as long as the new deployment unit supports the operations depended upon by other deployment units as appropriate. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement generally supports the operations of the original.

Services (or interfaces) may be provided in a flexible architecture to support varying criteria between services and systems. The flexible architecture may generally be provided by a service delivery business object. The system may be able to schedule a service asynchronously as necessary, or on a regular basis. Services may be planned according to a schedule manually or automatically. For example, a follow-up service may be scheduled automatically upon completing an initial service. In addition, flexible execution periods may be possible (e.g. hourly, daily, every three months, etc.). Each customer may plan the services on demand or reschedule service execution upon request.

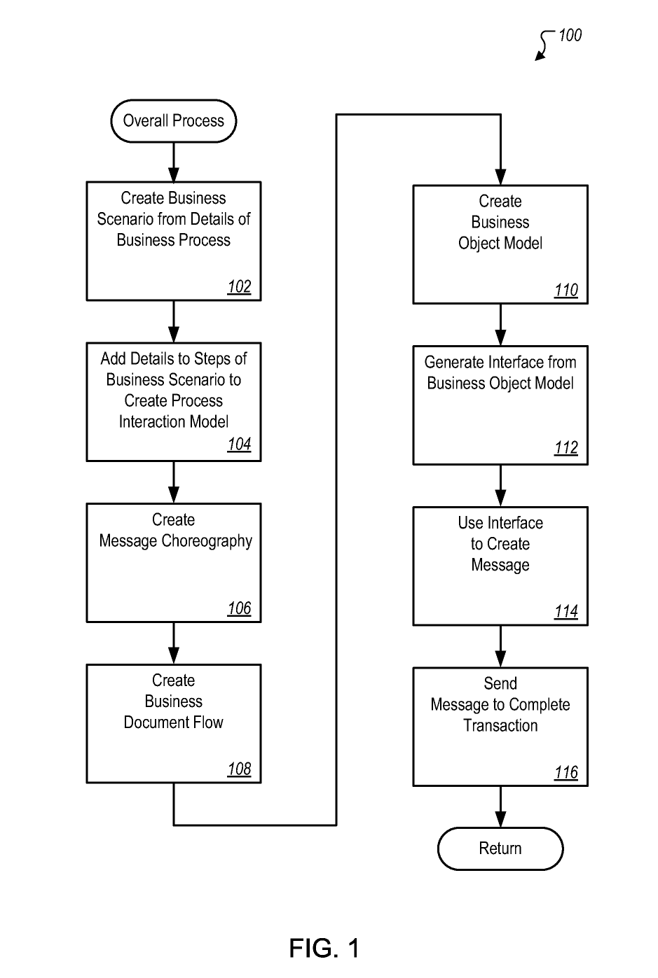

FIG. 1 depicts a flow diagram 100 showing an example technique, perhaps implemented by systems similar to those disclosed herein. Initially, to generate the business object model, design engineers study the details of a business process, and model the business process using a “business scenario” (step 102). The business scenario identifies the steps performed by the different business entities during a business process. Thus, the business scenario is a complete representation of a clearly defined business process.

After creating the business scenario, the developers add details to each step of the business scenario (step 104). In particular, for each step of the business scenario, the developers identify the complete process steps performed by each business entity. A discrete portion of the business scenario reflects a “business transaction,” and each business entity is referred to as a “component” of the business transaction. The developers also identify the messages that are transmitted between the components. A “process interaction model” represents the complete process steps between two components.

After creating the process interaction model, the developers create a “message choreography” (step 106), which depicts the messages transmitted between the two components in the process interaction model. The developers then represent the transmission of the messages between the components during a business process in a “business document flow” (step 108). Thus, the business document flow illustrates the flow of information between the business entities during a business process.

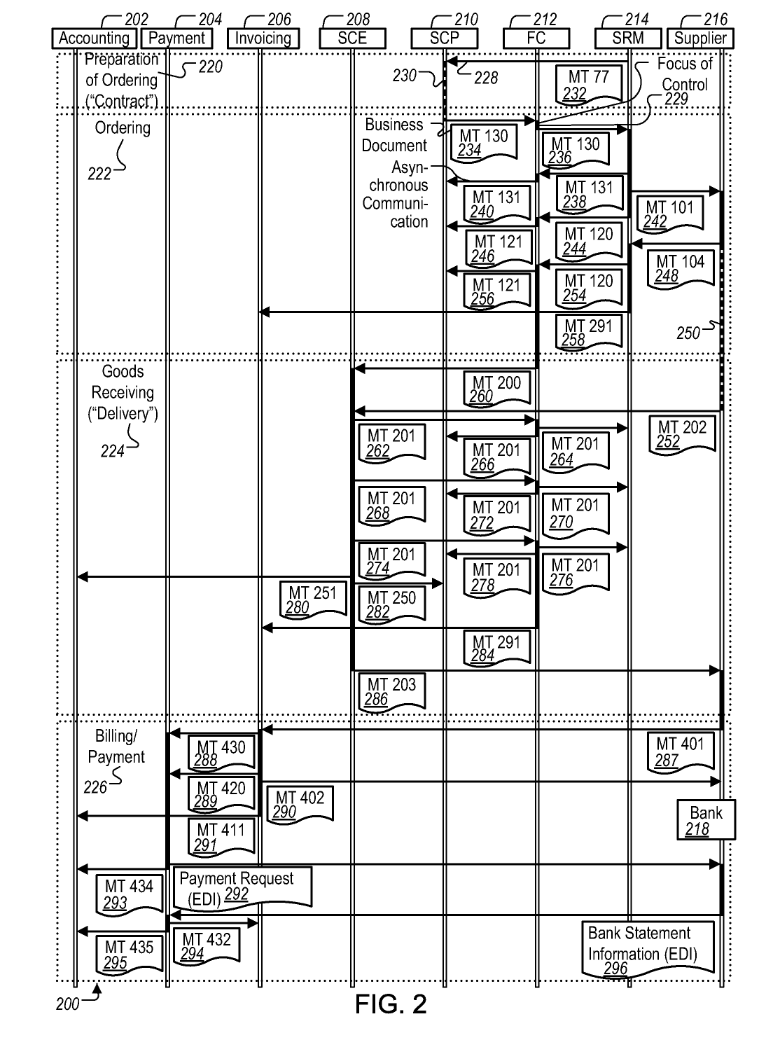

FIG. 2 depicts an example business document flow 200 for the process of purchasing a product or service. The business entities involved with the illustrative purchase process include Accounting 202, Payment 204, Invoicing 206, Supply Chain Execution (“SCE”) 208, Supply Chain Planning (“SCP”) 210, Fulfillment Coordination (“FC”) 212, Supply Relationship Management (“SRM”) 214, Supplier 216, and Bank 218. The business document flow 200 is divided into four different transactions: Preparation of Ordering (“Contract”) 220, Ordering 222, Goods Receiving (“Delivery”) 224, and Billing/Payment 226. In the business document flow, arrows 228 represent the transmittal of documents. Each document reflects a message transmitted between entities. One of ordinary skill in the art will appreciate that the messages transferred may be considered to be a communications protocol. The process flow follows the focus of control, which is depicted as a solid vertical line (e.g., 229) when the step is required, and a dotted vertical line (e.g., 230) when the step is optional.

During the Contract transaction 220, the SRM 214 sends a Source of Supply Notification 232 to the SCP 210. This step is optional, as illustrated by the optional control line 230 coupling this step to the remainder of the business document flow 200. During the Ordering transaction 222, the SCP 210 sends a Purchase Requirement Request 234 to the FC 212, which forwards a Purchase Requirement Request 236 to the SRM 214. The SRM 214 then sends a Purchase Requirement Confirmation 238 to the FC 212, and the FC 212 sends a Purchase Requirement Confirmation 240 to the SCP 210. The SRM 214 also sends a Purchase Order Request 242 to the Supplier 216, and sends Purchase Order Information 244 to the FC 212. The FC 212 then sends a Purchase Order Planning Notification 246 to the SCP 210. The Supplier 216, after receiving the Purchase Order Request 242, sends a Purchase Order Confirmation 248 to the SRM 214, which sends a Purchase Order Information confirmation message 254 to the FC 212, which sends a message 256 confirming the Purchase Order Planning Notification to the SCP 210. The SRM 214 then sends an Invoice Due Notification 258 to Invoicing 206.

During the Delivery transaction 224, the FC 212 sends a Delivery Execution Request 260 to the SCE 208. The Supplier 216 could optionally (illustrated at control line 250) send a Dispatched Delivery Notification 252 to the SCE 208. The SCE 208 then sends a message 262 to the FC 212 notifying the FC 212 that the request for the Delivery Information was created. The FC 212 then sends a message 264 notifying the SRM 214 that the request for the Delivery Information was created. The FC 212 also sends a message 266 notifying the SCP 210 that the request for the Delivery Information was created. The SCE 208 sends a message 268 to the FC 212 when the goods have been set aside for delivery. The FC 212 sends a message 270 to the SRM 214 when the goods have been set aside for delivery. The FC 212 also sends a message 272 to the SCP 210 when the goods have been set aside for delivery.

The SCE 208 sends a message 274 to the FC 212 when the goods have been delivered. The FC 212 then sends a message 276 to the SRM 214 indicating that the goods have been delivered, and sends a message 278 to the SCP 210 indicating that the goods have been delivered. The SCE 208 then sends an Inventory Change Accounting Notification 280 to Accounting 202, and an Inventory Change Notification 282 to the SCP 210. The FC 212 sends an Invoice Due Notification 284 to Invoicing 206, and SCE 208 sends a Received Delivery Notification 286 to the Supplier 216.

During the Billing/Payment transaction 226, the Supplier 216 sends an Invoice Request 287 to Invoicing 206. Invoicing 206 then sends a Payment Due Notification 288 to Payment 204, a Tax Due Notification 289 to Payment 204, an Invoice Confirmation 290 to the Supplier 216, and an Invoice Accounting Notification 291 to Accounting 202. Payment 204 sends a Payment Request 292 to the Bank 218, and a Payment Requested Accounting Notification 293 to Accounting 202. Bank 218 sends a Bank Statement Information 296 to Payment 204. Payment 204 then sends a Payment Done Information 294 to Invoicing 206 and a Payment Done Accounting Notification 295 to Accounting 202.

Within a business document flow, business documents having the same or similar structures are marked. For example, in the business document flow 200 depicted in FIG. 2, Purchase Requirement Requests 234, 236 and Purchase Requirement Confirmations 238, 240 have the same structures. Thus, each of these business documents is marked with an “O6.” Similarly, Purchase Order Request 242 and Purchase Order Confirmation 248 have the same structures. Thus, both documents are marked with an “O1.” Each business document or message is based on a message type.

From the business document flow, the developers identify the business documents having identical or similar structures, and use these business documents to create the business object model (step 110). The business object model includes the objects contained within the business documents. These objects are reflected as packages containing related information, and are arranged in a hierarchical structure within the business object model, as discussed below.

Methods and systems consistent with the subject matter described herein then generate interfaces from the business object model (step 112). The heterogeneous programs use instantiations of these interfaces (called “business document objects” below) to create messages (step 114), which are sent to complete the business transaction (step 116). Business entities use these messages to exchange information with other business entities during an end-to-end business transaction. Since the business object model is shared by heterogeneous programs, the interfaces are consistent among these programs. The heterogeneous programs use these consistent interfaces to communicate in a consistent manner, thus facilitating the business transactions.

Standardized Business-to-Business (“B2B”) messages are compliant with at least one of the e-business standards (i.e., they include the business-relevant fields of the standard). The e-business standards include, for example, RosettaNet for the high-tech industry, Chemical Industry Data Exchange (“CIDX”), Petroleum Industry Data Exchange (“PIDX”) for the oil industry, UCCnet for trade, PapiNet for the paper industry, Odette for the automotive industry, HR-XML for human resources, and XML Common Business Library (“xCBL”). Thus, B2B messages enable simple integration of components in heterogeneous system landscapes. Application-to-Application (“A2A”) messages often exceed the standards and thus may provide the benefit of the full functionality of application components. Although various steps of FIG. 1 were described as being performed manually, one skilled in the art will appreciate that such steps could be computer-assisted or performed entirely by a computer, including being performed by either hardware, software, or any other combination thereof.

B. Implementation Details

As discussed above, methods and systems consistent with the subject matter described herein create consistent interfaces by generating the interfaces from a business object model. Details regarding the creation of the business object model, the generation of an interface from the business object model, and the use of an interface generated from the business object model are provided below.

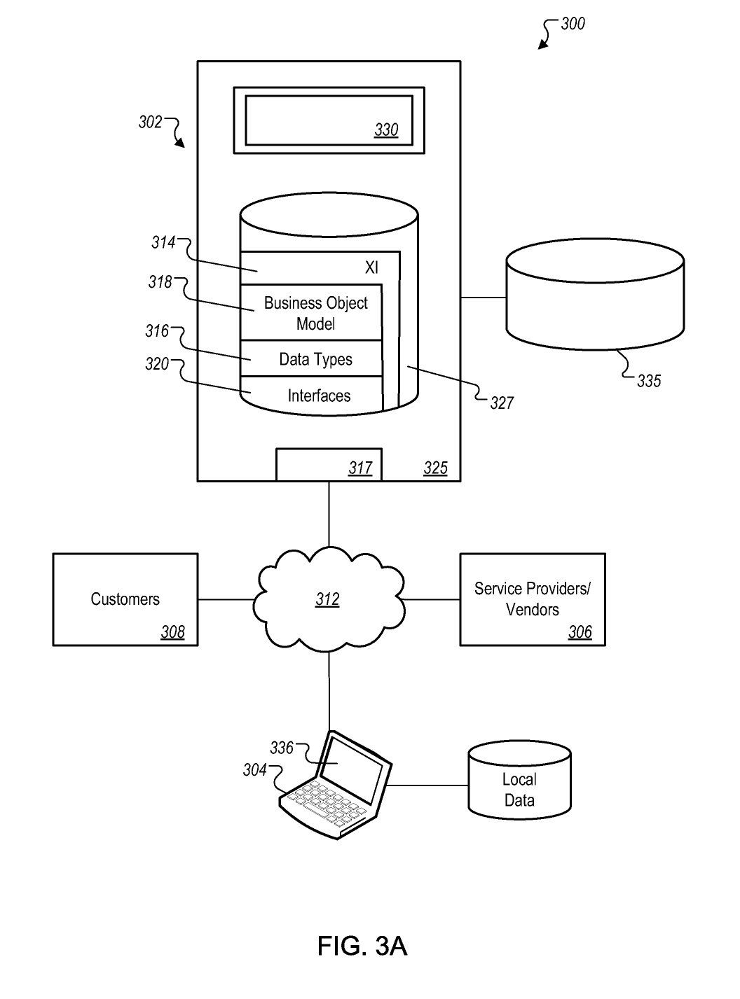

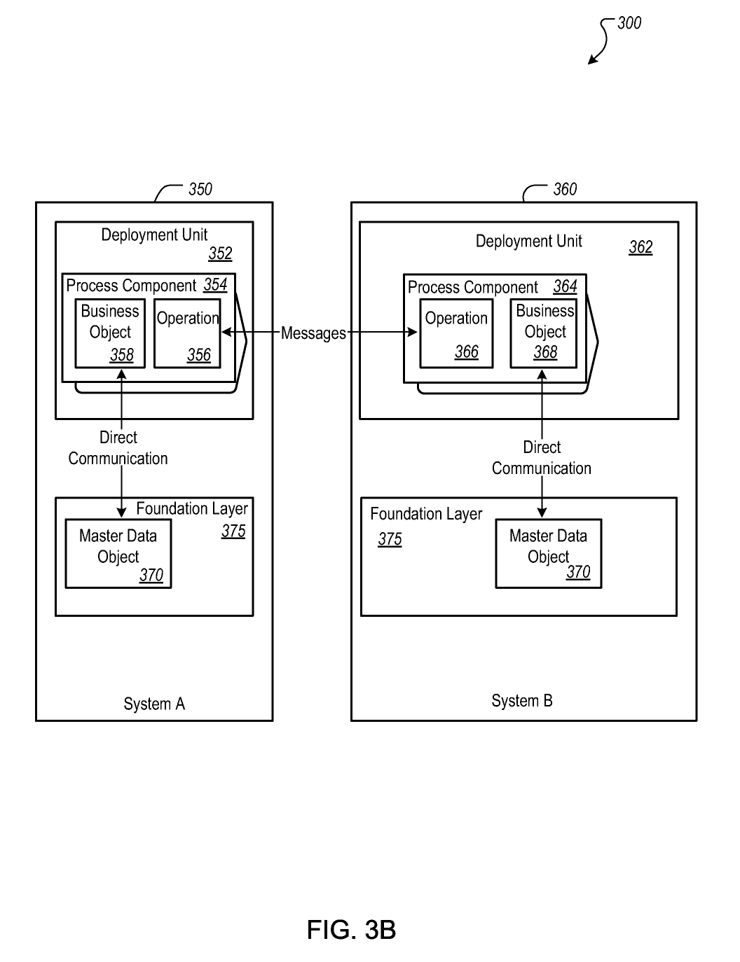

Turning to the illustrated embodiment in FIG. 3A, environment 300 includes or is communicably coupled (such as via a one-, bi- or multi-directional link or network) with server 302, one or more clients 304, one or more or vendors 306, one or more customers 308, at least some of which communicate across network 312. But, of course, this illustration is for example purposes only, and any distributed system or environment implementing one or more of the techniques described herein may be within the scope of this disclosure. Server 302 comprises an electronic computing device operable to receive, transmit, process and store data associated with environment 300. Generally, FIG. 3A provides merely one example of computers that may be used with the disclosure. Each computer is generally intended to encompass any suitable processing device. For example, although FIG. 3A illustrates one server 302 that may be used with the disclosure, environment 300 can be implemented using computers other than servers, as well as a server pool. Indeed, server 302 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 302 may be adapted to execute any operating system including Linux, UNIX, Windows Server, or any other suitable operating system. According to one embodiment, server 302 may also include or be communicably coupled with a web server and/or a mail server.

As illustrated (but not required), the server 302 is communicably coupled with a relatively remote repository 335 over a portion of the network 312. The repository 335 is any electronic storage facility, data processing center, or archive that may supplement or replace local memory (such as 327). The repository 335 may be a central database communicably coupled with the one or more servers 302 and the clients 304 via a virtual private network (VPN), SSH (Secure Shell) tunnel, or other secure network connection. The repository 335 may be physically or logically located at any appropriate location including in one of the example enterprises or off-shore, so long as it remains operable to store information associated with the environment 300 and communicate such data to the server 302 or at least a subset of plurality of the clients 304.

Illustrated server 302 includes local memory 327. Memory 327 may include any memory or database module and may take the form of volatile or non-volatile memory including, without limitation, magnetic media, optical media, random access memory (RAM), read-only memory (ROM), removable media, or any other suitable local or remote memory component. Illustrated memory 327 includes an exchange infrastructure (“XI”) 314, which is an infrastructure that supports the technical interaction of business processes across heterogeneous system environments. XI 314 centralizes the communication between components within a business entity and between different business entities. When appropriate, XI 314 carries out the mapping between the messages. XI 314 integrates different versions of systems implemented on different platforms (e.g., Java and ABAP). XI 314 is based on an open architecture, and makes use of open standards, such as eXtensible Markup Language (XML)™ and Java environments. XI 314 offers services that are useful in a heterogeneous and complex system landscape. In particular, XI 314 offers a runtime infrastructure for message exchange, configuration options for managing business processes and message flow, and options for transforming message contents between sender and receiver systems.

XI 314 stores data types 316, a business object model 318, and interfaces 320. The details regarding the business object model are described below. Data types 316 are the building blocks for the business object model 318. The business object model 318 is used to derive consistent interfaces 320. XI 314 allows for the exchange of information from a first company having one computer system to a second company having a second computer system over network 312 by using the standardized interfaces 320.

While not illustrated, memory 327 may also include business objects and any other appropriate data such as services, interfaces, VPN applications or services, firewall policies, a security or access log, print or other reporting files, HTML files or templates, data classes or object interfaces, child software applications or sub-systems, and others. This stored data may be stored in one or more logical or physical repositories. In some embodiments, the stored data (or pointers thereto) may be stored in one or more tables in a relational database described in terms of SQL statements or scripts. In the same or other embodiments, the stored data may also be formatted, stored, or defined as various data structures in text files, XML documents, Virtual Storage Access Method (VSAM) files, flat files, Btrieve files, comma-separated-value (CSV) files, internal variables, or one or more libraries. For example, a particular data service record may merely be a pointer to a particular piece of third party software stored remotely. In another example, a particular data service may be an internally stored software object usable by authenticated customers or internal development. In short, the stored data may comprise one table or file or a plurality of tables or files stored on one computer or across a plurality of computers in any appropriate format. Indeed, some or all of the stored data may be local or remote without departing from the scope of this disclosure and store any type of appropriate data.

Server 302 also includes processor 325. Processor 325 executes instructions and manipulates data to perform the operations of server 302 such as, for example, a central processing unit (CPU), a blade, an application specific integrated circuit (ASIC), or a field-programmable gate array (FPGA). Although FIG. 3A illustrates a single processor 325 in server 302, multiple processors 325 may be used according to particular needs and reference to processor 325 is meant to include multiple processors 325 where applicable. In the illustrated embodiment, processor 325 executes at least business application 330.

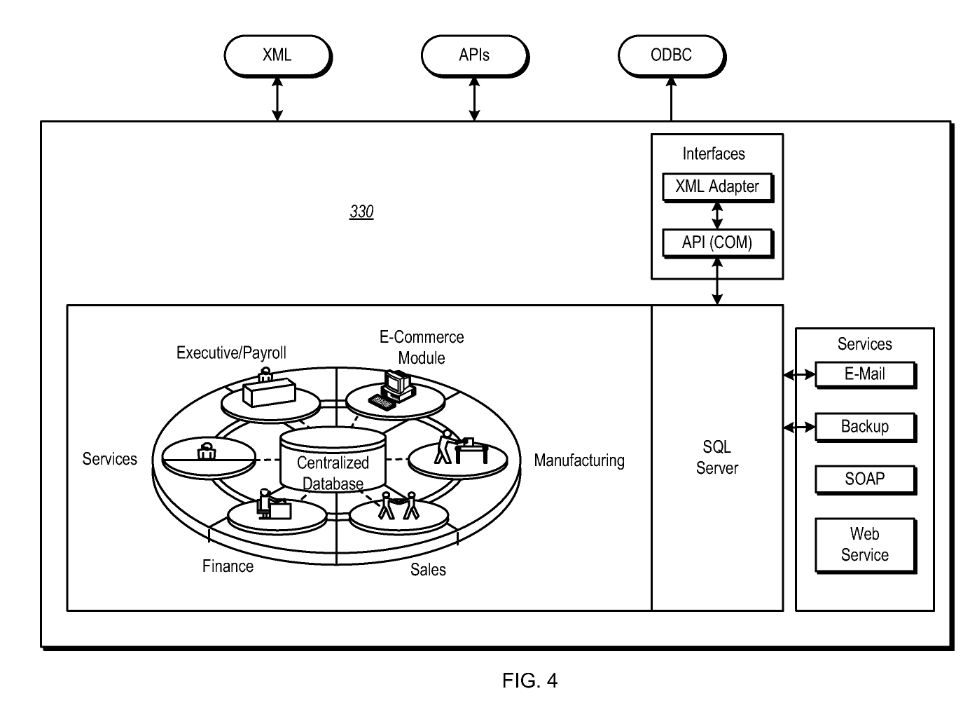

At a high level, business application 330 is any application, program, module, process, or other software that utilizes or facilitates the exchange of information via messages (or services) or the use of business objects. For example, application 330 may implement, utilize or otherwise leverage an enterprise service-oriented architecture (enterprise SOA), which may be considered a blueprint for an adaptable, flexible, and open IT architecture for developing services-based, enterprise-scale business solutions. This example enterprise service may be a series of web services combined with business logic that can be accessed and used repeatedly to support a particular business process. Aggregating web services into business-level enterprise services helps provide a more meaningful foundation for the task of automating enterprise-scale business scenarios Put simply, enterprise services help provide a holistic combination of actions that are semantically linked to complete the specific task, no matter how many cross-applications are involved. In certain cases, environment 300 may implement a composite application 330, as described below in FIG. 4. Regardless of the particular implementation, “software” may include software, firmware, wired or programmed hardware, or any combination thereof as appropriate. Indeed, application 330 may be written or described in any appropriate computer language including C, C++, Java, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while application 330 is illustrated in FIG. 4 as including various sub-modules, application 330 may include numerous other sub-modules or may instead be a single multi-tasked module that implements the various features and functionality through various objects, methods, or other processes. Further, while illustrated as internal to server 302, one or more processes associated with application 330 may be stored, referenced, or executed remotely. For example, a portion of application 330 may be a web service that is remotely called, while another portion of application 330 may be an interface object bundled for processing at remote client 304. Moreover, application 330 may be a child or sub-module of another software module or enterprise application (not illustrated) without departing from the scope of this disclosure. Indeed, application 330 may be a hosted solution that allows multiple related or third parties in different portions of the process to perform the respective processing.

More specifically, as illustrated in FIG. 4, application 330 may be a composite application, or an application built on other applications, that includes an object access layer (OAL) and a service layer. In this example, application 330 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, composite application 330 may run on a heterogeneous IT platform. In doing so, composite application may be cross-functional in that it may drive business processes across different applications, technologies, and organizations. Accordingly, composite application 330 may drive end-to-end business processes across heterogeneous systems or sub-systems. Application 330 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 330, it may instead be a standalone or (relatively) simple software program. Regardless, application 330 may also perform processing automatically, which may indicate that the appropriate processing is substantially performed by at least one component of environment 300. It should be understood that automatically further contemplates any suitable administrator or other user interaction with application 330 or other components of environment 300 without departing from the scope of this disclosure.

Returning to FIG. 3A, illustrated server 302 may also include interface 317 for communicating with other computer systems, such as clients 304, over network 312 in a client-server or other distributed environment. In certain embodiments, server 302 receives data from internal or external senders through interface 317 for storage in memory 327, for storage in DB 335, and/or processing by processor 325. Generally, interface 317 comprises logic encoded in software and/or hardware in a suitable combination and operable to communicate with network 312. More specifically, interface 317 may comprise software supporting one or more communications protocols associated with communications network 312 or hardware operable to communicate physical signals.

Network 312 facilitates wireless or wireline communication between computer server 302 and any other local or remote computer, such as clients 304. Network 312 may be all or a portion of an enterprise or secured network. In another example, network 312 may be a VPN merely between server 302 and client 304 across wireline or wireless link. Such an example wireless link may be via 802.11a, 802.11b, 802.11g, 802.20, WiMax, and many others. While illustrated as a single or continuous network, network 312 may be logically divided into various sub-nets or virtual networks without departing from the scope of this disclosure, so long as at least portion of network 312 may facilitate communications between server 302 and at least one client 304. For example, server 302 may be communicably coupled to one or more “local” repositories through one sub-net while communicably coupled to a particular client 304 or “remote” repositories through another. In other words, network 312 encompasses any internal or external network, networks, sub-network, or combination thereof operable to facilitate communications between various computing components in environment 300. Network 312 may communicate, for example, Internet Protocol (IP) packets, Frame Relay frames, Asynchronous Transfer Mode (ATM) cells, voice, video, data, and other suitable information between network addresses. Network 312 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 312 may be a secure network associated with the enterprise and certain local or remote vendors 306 and customers 308. As used in this disclosure, customer 308 is any person, department, organization, small business, enterprise, or any other entity that may use or request others to use environment 300. As described above, vendors 306 also may be local or remote to customer 308. Indeed, a particular vendor 306 may provide some content to business application 330, while receiving or purchasing other content (at the same or different times) as customer 308. As illustrated, customer 308 and vendor 06 each typically perform some processing (such as uploading or purchasing content) using a computer, such as client 304.

Client 304 is any computing device operable to connect or communicate with server 302 or network 312 using any communication link. For example, client 304 is intended to encompass a personal computer, touch screen terminal, workstation, network computer, kiosk, wireless data port, smart phone, personal data assistant (PDA), one or more processors within these or other devices, or any other suitable processing device used by or for the benefit of business 308, vendor 306, or some other user or entity. At a high level, each client 304 includes or executes at least GUI 336 and comprises an electronic computing device operable to receive, transmit, process and store any appropriate data associated with environment 300. It will be understood that there may be any number of clients 304 communicably coupled to server 302. Further, “client 304,” “business,” “business analyst,” “end user,” and “user” may be used interchangeably as appropriate without departing from the scope of this disclosure. Moreover, for ease of illustration, each client 304 is described in terms of being used by one user. But this disclosure contemplates that many users may use one computer or that one user may use multiple computers. For example, client 304 may be a PDA operable to wirelessly connect with external or unsecured network. In another example, client 304 may comprise a laptop that includes an input device, such as a keypad, touch screen, mouse, or other device that can accept information, and an output device that conveys information associated with the operation of server 302 or clients 304, including digital data, visual information, or GUI 336. Both the input device and output device may include fixed or removable storage media such as a magnetic computer disk, CD-ROM, or other suitable media to both receive input from and provide output to users of clients 304 through the display, namely the client portion of GUI or application interface 336.

GUI 336 comprises a graphical user interface operable to allow the user of client 304 to interface with at least a portion of environment 300 for any suitable purpose, such as viewing application or other transaction data. Generally, GUI 336 provides the particular user with an efficient and user-friendly presentation of data provided by or communicated within environment 300. For example, GUI 336 may present the user with the components and information that is relevant to their task, increase reuse of such components, and facilitate a sizable developer community around those components. GUI 336 may comprise a plurality of customizable frames or views having interactive fields, pull-down lists, and buttons operated by the user. For example, GUI 336 is operable to display data involving business objects and interfaces in a user-friendly form based on the user context and the displayed data. In another example, GUI 336 is operable to display different levels and types of information involving business objects and interfaces based on the identified or supplied user role. GUI 336 may also present a plurality of portals or dashboards. For example, GUI 336 may display a portal that allows users to view, create, and manage historical and real-time reports including role-based reporting and such. Of course, such reports may be in any appropriate output format including PDF, HTML, and printable text. Real-time dashboards often provide table and graph information on the current state of the data, which may be supplemented by business objects and interfaces. It should be understood that the term graphical user interface may be used in the singular or in the plural to describe one or more graphical user interfaces and each of the displays of a particular graphical user interface. Indeed, reference to GUI 336 may indicate a reference to the front-end or a component of business application 330, as well as the particular interface accessible via client 304, as appropriate, without departing from the scope of this disclosure. Therefore, GUI 336 contemplates any graphical user interface, such as a generic web browser or touchscreen, that processes information in environment 300 and efficiently presents the results to the user. Server 302 can accept data from client 304 via the web browser (e.g., Microsoft Internet Explorer or Netscape Navigator) and return the appropriate HTML or XML responses to the browser using network 312.

More generally in environment 300 as depicted in FIG. 3B, a Foundation Layer 375 can be deployed on multiple separate and distinct hardware platforms, e.g., System A 350 and System B 360, to support application software deployed as two or more deployment units distributed on the platforms, including deployment unit 352 deployed on System A and deployment unit 362 deployed on System B. In this example, the foundation layer can be used to support application software deployed in an application layer. In particular, the foundation layer can be used in connection with application software implemented in accordance with a software architecture that provides a suite of enterprise service operations having various application functionality. In some implementations, the application software is implemented to be deployed on an application platform that includes a foundation layer that contains all fundamental entities that can used from multiple deployment units. These entities can be process components, business objects, and reuse service components. A reuse service component is a piece of software that is reused in different transactions. A reuse service component is used by its defined interfaces, which can be, e.g., local APIs or service interfaces. As explained above, process components in separate deployment units interact through service operations, as illustrated by messages passing between service operations 356 and 366, which are implemented in process components 354 and 364, respectively, which are included in deployment units 352 and 362, respectively. As also explained above, some form of direct communication is generally the form of interaction used between a business object, e.g., business object 358 and 368, of an application deployment unit and a business object, such as master data object 370, of the Foundation Layer 375.

Various components of the present disclosure may be modeled using a model-driven environment. For example, the model-driven framework or environment may allow the developer to use simple drag-and-drop techniques to develop pattern-based or freestyle user interfaces and define the flow of data between them. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding.

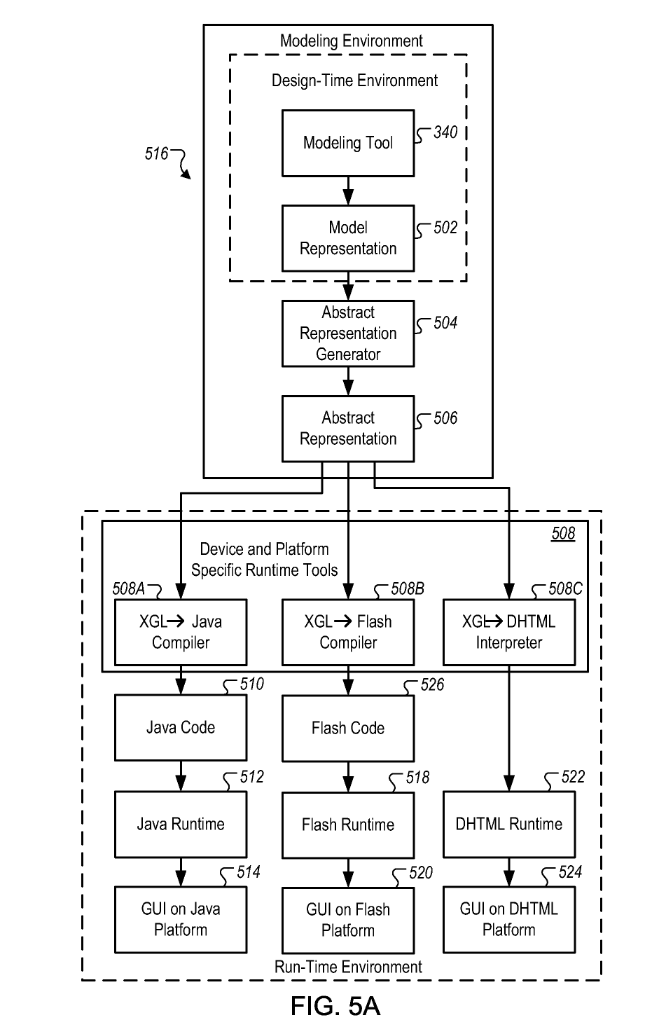

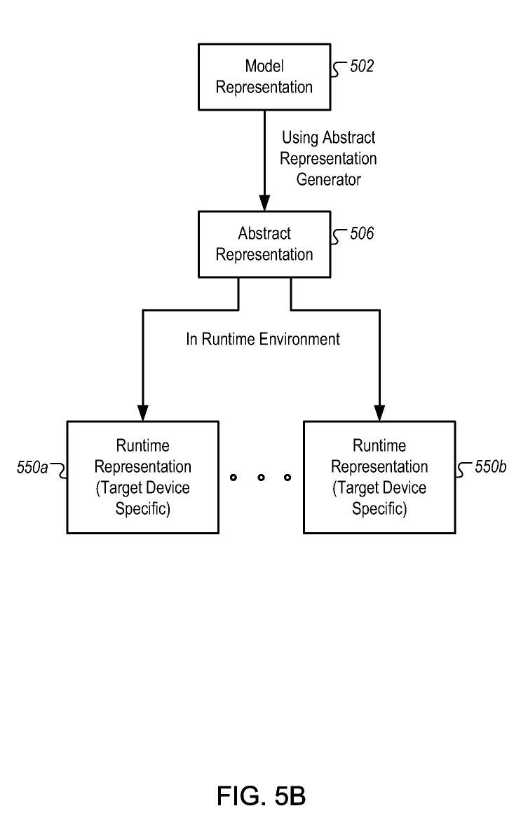

FIG. 5A depicts an example modeling environment 516, namely a modeling environment, in accordance with one embodiment of the present disclosure. Thus, as illustrated in FIG. 5A, such a modeling environment 516 may implement techniques for decoupling models created during design-time from the runtime environment. In other words, model representations for GUIs created in a design time environment are decoupled from the runtime environment in which the GUIs are executed. Often in these environments, a declarative and executable representation for GUIs for applications is provided that is independent of any particular runtime platform, GUI framework, device, or programming language.

According to some embodiments, a modeler (or other analyst) may use the model-driven modeling environment 516 to create pattern-based or freestyle user interfaces using simple drag-and-drop services. Because this development may be model-driven, the modeler can typically compose an application using models of business objects without having to write much, if any, code. In some cases, this example modeling environment 516 may provide a personalized, secure interface that helps unify enterprise applications, information, and processes into a coherent, role-based portal experience. Further, the modeling environment 516 may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements. Indeed, the modeling environment 516 may provide a shared set of services for finding, organizing, and accessing unstructured content stored in third-party repositories and content management systems across various networks 312. Classification tools may automate the organization of information, while subject-matter experts and content managers can publish information to distinct user audiences. Regardless of the particular implementation or architecture, this modeling environment 516 may allow the developer to easily model hosted business objects 140 using this model-driven approach.

In certain embodiments, the modeling environment 516 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and therefore can unambiguously encapsulate execution semantics for the GUI described by a model representation. In short, models of different types can be transformed to XGL representations.

The XGL representation may be used for generating representations of various different GUIs and supports various GUI features including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 5A, modeling tool 340 may be used by a GUI designer or business analyst during the application design phase to create a model representation 502 for a GUI application. It will be understood that modeling environment 516 may include or be compatible with various different modeling tools 340 used to generate model representation 502. This model representation 502 may be a machine-readable representation of an application or a domain specific model. Model representation 502 generally encapsulates various design parameters related to the GUI such as GUI components, dependencies between the GUI components, inputs and outputs, and the like. Put another way, model representation 502 provides a form in which the one or more models can be persisted and transported, and possibly handled by various tools such as code generators, runtime interpreters, analysis and validation tools, merge tools, and the like. In one embodiment, model representation 502 maybe a collection of XML documents with a well-formed syntax.

Illustrated modeling environment 516 also includes an abstract representation generator (or XGL generator) 504 operable to generate an abstract representation (for example, XGL representation or XGL-compliant representation) 506 based upon model representation 502. Abstract representation generator 504 takes model representation 502 as input and outputs abstract representation 506 for the model representation. Model representation 502 may include multiple instances of various forms or types depending on the tool/language used for the modeling. In certain cases, these various different model representations may each be mapped to one or more abstract representations 506. Different types of model representations may be transformed or mapped to XGL representations. For each type of model representation, mapping rules may be provided for mapping the model representation to the XGL representation 506. Different mapping rules may be provided for mapping a model representation to an XGL representation.

This XGL representation 506 that is created from a model representation may then be used for processing in the runtime environment. For example, the XGL representation 506 may be used to generate a machine-executable runtime GUI (or some other runtime representation) that may be executed by a target device. As part of the runtime processing, the XGL representation 506 may be transformed into one or more runtime representations, which may indicate source code in a particular programming language, machine-executable code for a specific runtime environment, executable GUI, and so forth, which may be generated for specific runtime environments and devices. Since the XGL representation 506, rather than the design-time model representation, is used by the runtime environment, the design-time model representation is decoupled from the runtime environment. The XGL representation 506 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 506 generated for a model representation 502 is generally declarative and executable in that it provides a representation of the GUI of model representation 502 that is not dependent on any device or runtime platform, is not dependent on any programming language, and unambiguously encapsulates execution semantics for the GUI. The execution semantics may include, for example, identification of various components of the GUI, interpretation of connections between the various GUI components, information identifying the order of sequencing of events, rules governing dynamic behavior of the GUI, rules governing handling of values by the GUI, and the like. The abstract representation 506 is also not GUI runtime-platform specific. The abstract representation 506 provides a self-contained, closed, and deterministic definition of all aspects of a graphical user interface that is device independent and language independent.

Abstract representation 506 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), the GUI generated by the devices are consistent with each other in their appearance and behavior.

Abstract representation generator 504 may be configured to generate abstract representation 506 for models of different types, which may be created using different modeling tools 340. It will be understood that modeling environment 516 may include some, none, or other sub-modules or components as those shown in this example illustration. In other words, modeling environment 516 encompasses the design-time environment (with or without the abstract generator or the various representations), a modeling toolkit (such as 340) linked with a developer's space, or any other appropriate software operable to decouple models created during design-time from the runtime environment. Abstract representation 506 provides an interface between the design time environment and the runtime environment. As shown, this abstract representation 506 may then be used by runtime processing.

As part of runtime processing, modeling environment 516 may include various runtime tools 508 and may generate different types of runtime representations based upon the abstract representation 506. Examples of runtime representations include device or language-dependent (or specific) source code, runtime platform-specific machine-readable code, GUIs for a particular target device, and the like. The runtime tools 508 may include compilers, interpreters, source code generators, and other such tools that are configured to generate runtime platform-specific or target device-specific runtime representations of abstract representation 506. The runtime tool 508 may generate the runtime representation from abstract representation 506 using specific rules that map abstract representation 506 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 506 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 5A, an XGL-to-Java compiler 508A may take abstract representation 506 as input and generate Java code 510 for execution by a target device comprising a Java runtime 512. Java runtime 512 may execute Java code 510 to generate or display a GUI 514 on a Java-platform target device. As another example, an XGL-to-Flash compiler 508B may take abstract representation 506 as input and generate Flash code 526 for execution by a target device comprising a Flash runtime 518. Flash runtime 518 may execute Flash code 516 to generate or display a GUI 520 on a target device comprising a Flash platform. As another example, an XGL-to-DHTML (dynamic HTML) interpreter 508C may take abstract representation 506 as input and generate DHTML statements (instructions) on the fly which are then interpreted by a DHTML runtime 522 to generate or display a GUI 524 on a target device comprising a DHTML platform.

It should be apparent that abstract representation 506 may be used to generate GUIs for Extensible Application Markup Language (XAML) or various other runtime platforms and devices. The same abstract representation 506 may be mapped to various runtime representations and device-specific and runtime platform-specific GUIs. In general, in the runtime environment, machine executable instructions specific to a runtime environment may be generated based upon the abstract representation 506 and executed to generate a GUI in the runtime environment. The same XGL representation may be used to generate machine executable instructions specific to different runtime environments and target devices.

According to certain embodiments, the process of mapping a model representation 502 to an abstract representation 506 and mapping an abstract representation 506 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 506 rather than model representation 502 for runtime processing, the model representation 502 that is created during design-time is decoupled from the runtime environment. Abstract representation 506 thus provides an interface between the modeling environment and the runtime environment. As a result, changes may be made to the design time environment, including changes to model representation 502 or changes that affect model representation 502, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies such as the target device platform or programming language dependencies.

FIG. 5B depicts an example process for mapping a model representation 502 to a runtime representation using the example modeling environment 516 of FIG. 5A or some other modeling environment. Model representation 502 may comprise one or more model components and associated properties that describe a data object, such as hosted business objects and interfaces. As described above, at least one of these model components is based on or otherwise associated with these hosted business objects and interfaces. The abstract representation 506 is generated based upon model representation 502. Abstract representation 506 may be generated by the abstract representation generator 504. Abstract representation 506 comprises one or more abstract GUI components and properties associated with the abstract GUI components. As part of generation of abstract representation 506, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 550a, including GUIs for specific runtime environment platforms, may be generated from abstract representation 506. A device-dependent runtime representation may be generated for a particular type of target device platform to be used for executing and displaying the GUI encapsulated by the abstract representation. The GUIs generated from abstract representation 506 may comprise various types of GUI elements such as buttons, windows, scrollbars, input boxes, etc. Rules may be provided for mapping an abstract representation to a particular runtime representation. Various mapping rules may be provided for different runtime environment platforms.

Methods and systems consistent with the subject matter described herein provide and use interfaces 320 derived from the business object model 318 suitable for use with more than one business area, for example different departments within a company such as finance, or marketing. Also, they are suitable across industries and across businesses. Interfaces 320 are used during an end-to-end business transaction to transfer business process information in an application-independent manner. For example the interfaces can be used for fulfilling a sales order.

1. Message Overview

To perform an end-to-end business transaction, consistent interfaces are used to create business documents that are sent within messages between heterogeneous programs or modules.

a) Message Categories

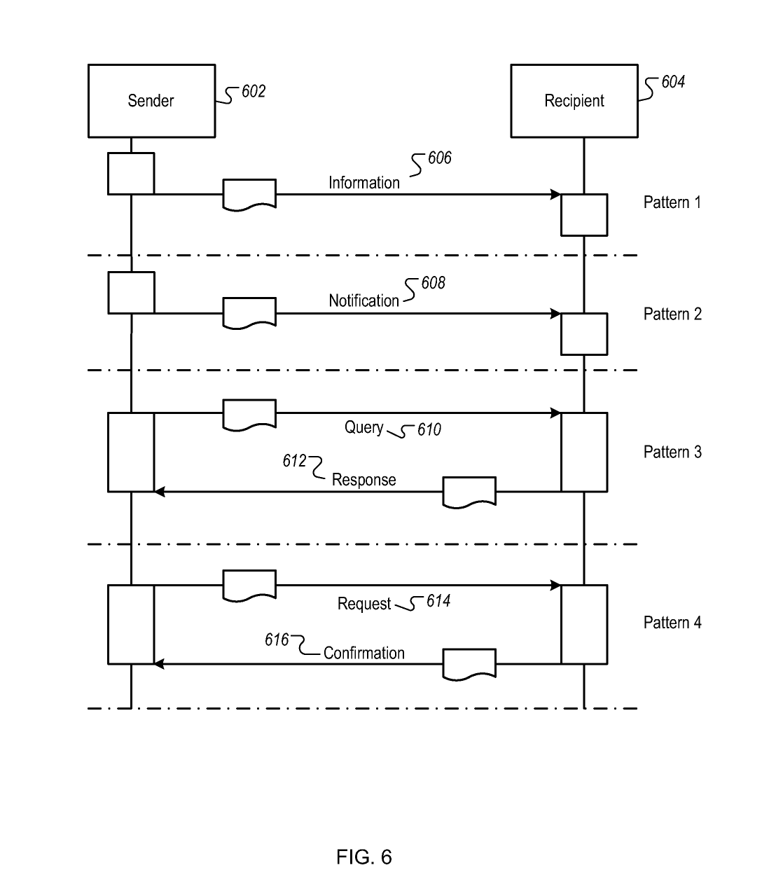

As depicted in FIG. 6, the communication between a sender 602 and a recipient 604 can be broken down into basic categories that describe the type of the information exchanged and simultaneously suggest the anticipated reaction of the recipient 604. A message category is a general business classification for the messages. Communication is sender-driven. In other words, the meaning of the message categories is established or formulated from the perspective of the sender 602. The message categories include information 606, notification 608, query 610, response 612, request 614, and confirmation 616.

(1) Information

Information 606 is a message sent from a sender 602 to a recipient 604 concerning a condition or a statement of affairs. No reply to information is expected. Information 606 is sent to make business partners or business applications aware of a situation. Information 606 is not compiled to be application-specific. Examples of “information” are an announcement, advertising, a report, planning information, and a message to the business warehouse.

(2) Notification

A notification 608 is a notice or message that is geared to a service. A sender 602 sends the notification 608 to a recipient 604. No reply is expected for a notification. For example, a billing notification relates to the preparation of an invoice while a dispatched delivery notification relates to preparation for receipt of goods.

(3) Query

A query 610 is a question from a sender 602 to a recipient 604 to which a response 612 is expected. A query 610 implies no assurance or obligation on the part of the sender 602. Examples of a query 610 are whether space is available on a specific flight or whether a specific product is available. These queries do not express the desire for reserving the flight or purchasing the product.

(4) Response

A response 612 is a reply to a query 610. The recipient 604 sends the response 612 to the sender 602. A response 612 generally implies no assurance or obligation on the part of the recipient 604. The sender 602 is not expected to reply. Instead, the process is concluded with the response 612. Depending on the business scenario, a response 612 also may include a commitment, i.e., an assurance or obligation on the part of the recipient 604. Examples of responses 612 are a response stating that space is available on a specific flight or that a specific product is available. With these responses, no reservation was made.

(5) Request

A request 614 is a binding requisition or requirement from a sender 602 to a recipient 604. Depending on the business scenario, the recipient 604 can respond to a request 614 with a confirmation 616. The request 614 is binding on the sender 602. In making the request 614, the sender 602 assumes, for example, an obligation to accept the services rendered in the request 614 under the reported conditions. Examples of a request 614 are a parking ticket, a purchase order, an order for delivery and a job application.

(6) Confirmation

A confirmation 616 is a binding reply that is generally made to a request 614. The recipient 604 sends the confirmation 616 to the sender 602. The information indicated in a confirmation 616, such as deadlines, products, quantities and prices, can deviate from the information of the preceding request 614. A request 614 and confirmation 616 may be used in negotiating processes. A negotiating process can consist of a series of several request 614 and confirmation 616 messages. The confirmation 616 is binding on the recipient 604. For example, 100 units of X may be ordered in a purchase order request; however, only the delivery of 80 units is confirmed in the associated purchase order confirmation.

b) Message Choreography

A message choreography is a template that specifies the sequence of messages between business entities during a given transaction. The sequence with the messages contained in it describes in general the message “lifecycle” as it proceeds between the business entities. If messages from a choreography are used in a business transaction, they appear in the transaction in the sequence determined by the choreography. This illustrates the template character of a choreography, i.e., during an actual transaction, it is not necessary for all messages of the choreography to appear. Those messages that are contained in the transaction, however, follow the sequence within the choreography. A business transaction is thus a derivation of a message choreography. The choreography makes it possible to determine the structure of the individual message types more precisely and distinguish them from one another.

2. Components of the Business Object Model

The overall structure of the business object model ensures the consistency of the interfaces that are derived from the business object model. The derivation ensures that the same business-related subject matter or concept is represented and structured in the same way in all interfaces.

The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Each business object is generally a capsule with an internal hierarchical structure, behavior offered by its operations, and integrity constraints. Business objects are semantically disjoint, i.e., the same business information is represented once. In the business object model, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects are arranged from the top to the bottom based on defined order of the business areas, e.g., finance could be arranged at the top of the business object model with CRM below finance and SRM below CRM.

To ensure the consistency of interfaces, the business object model may be built using standardized data types as well as packages to group related elements together, and package templates and entity templates to specify the arrangement of packages and entities within the structure.

a) Data Types

Data types are used to type object entities and interfaces with a structure. This typing can include business semantic. Such data types may include those generally described at pages 96 through 1642 (which are incorporated by reference herein) of U.S. patent application Ser. No. 11/803,178, filed on May 11, 2007 and entitled “Consistent Set Of Interfaces Derived From A Business Object Model.” For example, the data type BusinessTransactionDocumentID is a unique identifier for a document in a business transaction. Also, as an example, Data type BusinessTransactionDocumentParty contains the information that is exchanged in business documents about a party involved in a business transaction, and includes the party's identity, the party's address, the party's contact person and the contact person's address. BusinessTransactionDocumentParty also includes the role of the party, e.g., a buyer, seller, product recipient, or vendor.

The data types are based on Core Component Types (“CCTs”), which themselves are based on the World Wide Web Consortium (“W3C”) data types. “Global” data types represent a business situation that is described by a fixed structure. Global data types include both context-neutral generic data types (“GDTs”) and context-based context data types (“CDTs”). GDTs contain business semantics, but are application-neutral, i.e., without context. CDTs, on the other hand, are based on GDTs and form either a use-specific view of the GDTs, or a context-specific assembly of GDTs or CDTs. A message is typically constructed with reference to a use and is thus a use-specific assembly of GDTs and CDTs. The data types can be aggregated to complex data types.

To achieve a harmonization across business objects and interfaces, the same subject matter is typed with the same data type. For example, the data type “GeoCoordinates” is built using the data type “Measure” so that the measures in a GeoCoordinate (i.e., the latitude measure and the longitude measure) are represented the same as other “Measures” that appear in the business object model.

b) Entities

Entities are discrete business elements that are used during a business transaction. Entities are not to be confused with business entities or the components that interact to perform a transaction. Rather, “entities” are one of the layers of the business object model and the interfaces. For example, a Catalogue entity is used in a Catalogue Publication Request and a Purchase Order is used in a Purchase Order Request. These entities are created using the data types defined above to ensure the consistent representation of data throughout the entities.

c) Packages

Packages group the entities in the business object model and the resulting interfaces into groups of semantically associated information. Packages also may include “sub”-packages, i.e., the packages may be nested.

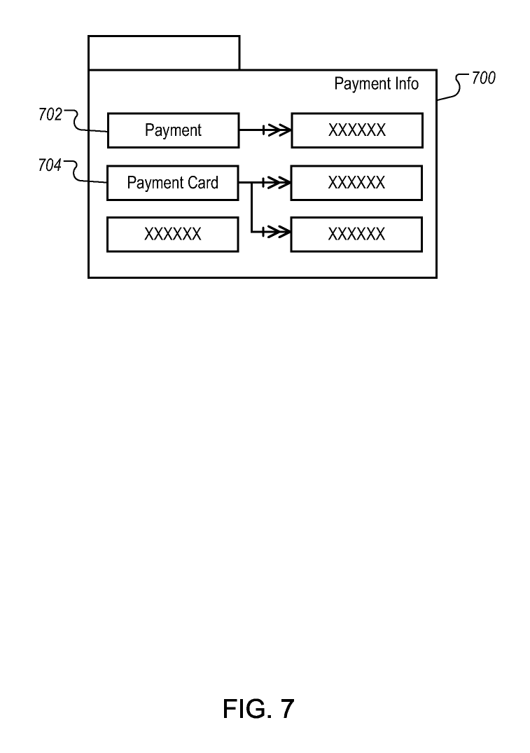

Packages may group elements together based on different factors, such as elements that occur together as a rule with regard to a business-related aspect. For example, as depicted in FIG. 7, in a Purchase Order, different information regarding the purchase order, such as the type of payment 702, and payment card 704, are grouped together via the PaymentInformation package 700.

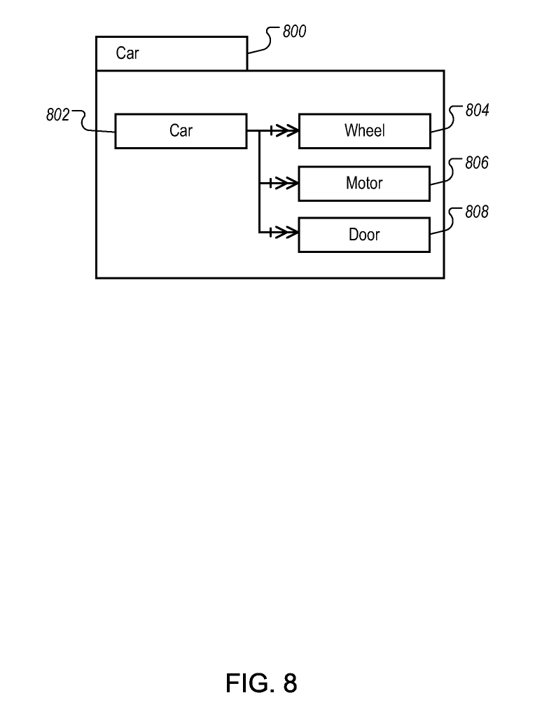

Packages also may combine different components that result in a new object. For example, as depicted in FIG. 8, the components wheels 804, motor 806, and doors 808 are combined to form a composition “Car” 802. The “Car” package 800 includes the wheels, motor and doors as well as the composition “Car.”

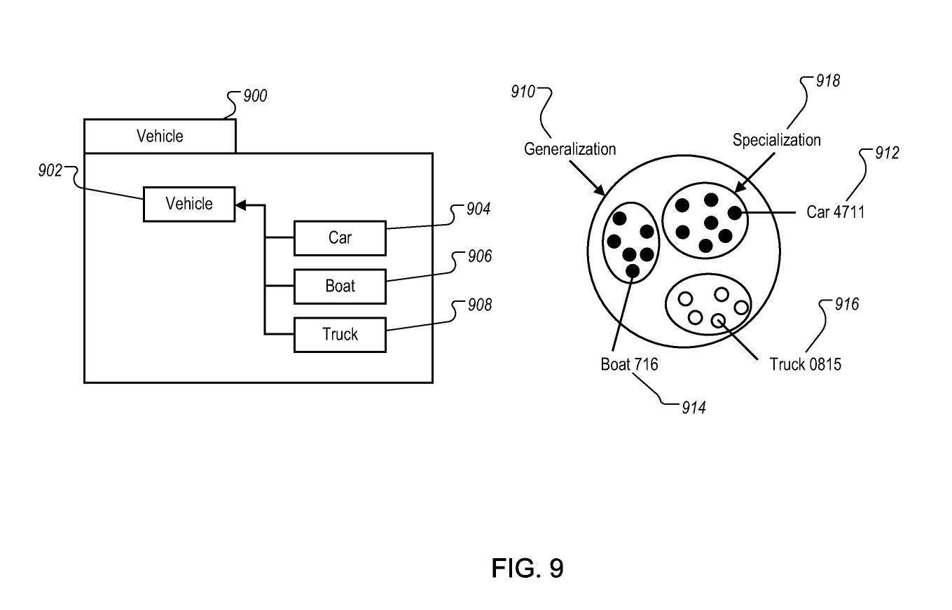

Another grouping within a package may be subtypes within a type. In these packages, the components are specialized forms of a generic package. For example, as depicted in FIG. 9, the components Car 904, Boat 906, and Truck 908 can be generalized by the generic term Vehicle 902 in Vehicle package 900. Vehicle in this case is the generic package 910, while Car 912, Boat 914, and Truck 916 are the specializations 918 of the generalized vehicle 910.

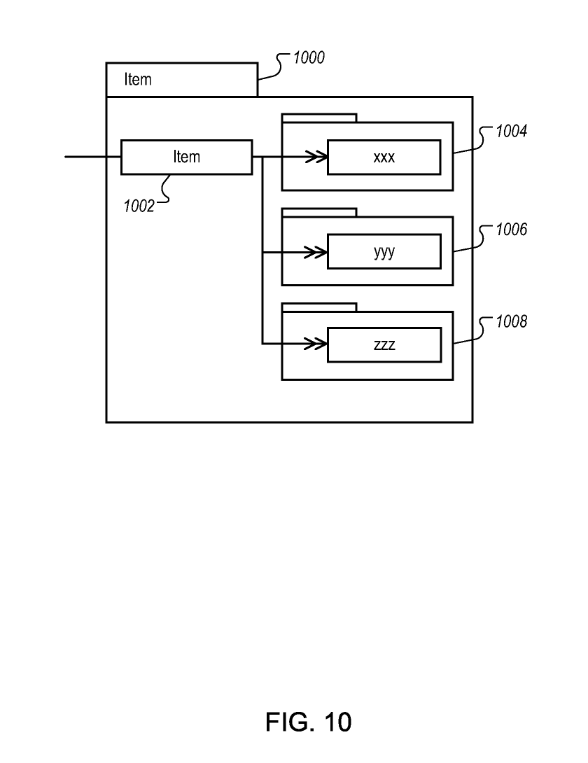

Packages also may be used to represent hierarchy levels. For example, as depicted in FIG. 10, the Item Package 1000 includes Item 1002 with subitem xxx 1004, subitem yyy 1006, and subitem zzz 1008.

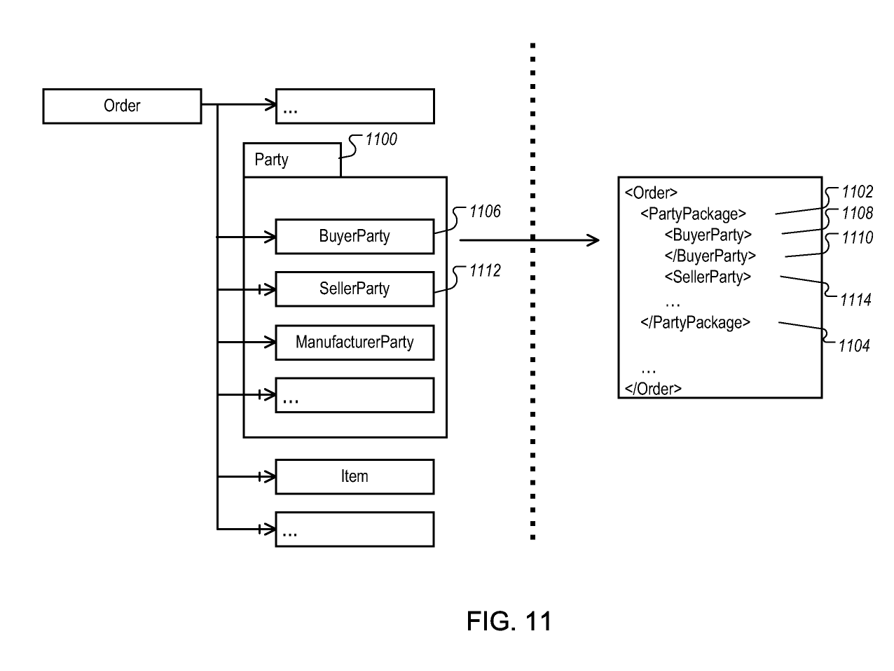

Packages can be represented in the XML schema as a comment. One advantage of this grouping is that the document structure is easier to read and is more understandable. The names of these packages are assigned by including the object name in brackets with the suffix “Package.” For example, as depicted in FIG. 11, Party package 1100 is enclosed by <PartyPackage> 1102 and </PartyPackage> 1104. Party package 1100 illustratively includes a Buyer Party 1106, identified by <BuyerParty> 1108 and </BuyerParty> 1110, and a Seller Party 1112, identified by <SellerParty> 1114 and </SellerParty>, etc.

d) Relationships

Relationships describe the interdependencies of the entities in the business object model, and are thus an integral part of the business object model.

(1) Cardinality of Relationships

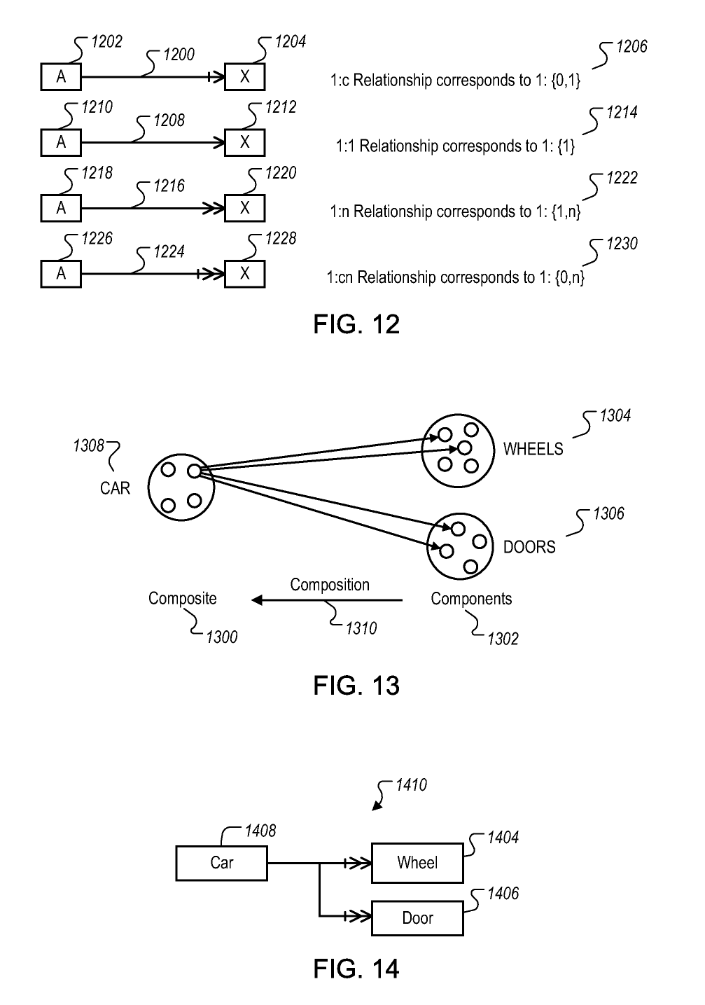

FIG. 12 depicts a graphical representation of the cardinalities between two entities. The cardinality between a first entity and a second entity identifies the number of second entities that could possibly exist for each first entity. Thus, a 1:c cardinality 1200 between entities A 1202 and X 1204 indicates that for each entity A 1202, there is either one or zero 1206 entity X 1204. A 1:1 cardinality 1208 between entities A 1210 and X 1212 indicates that for each entity A 1210, there is exactly one 1214 entity X 1212. A 1:n cardinality 1216 between entities A 1218 and X 1220 indicates that for each entity A 1218, there are one or more 1222 entity Xs 1220. A 1:cn cardinality 1224 between entities A 1226 and X 1228 indicates that for each entity A 1226, there are any number 1230 of entity Xs 1228 (i.e., 0 through n Xs for each A).

(2) Types of Relationships

(a) Composition

A composition or hierarchical relationship type is a strong whole-part relationship which is used to describe the structure within an object. The parts, or dependent entities, represent a semantic refinement or partition of the whole, or less dependent entity. For example, as depicted in FIG. 13, the components 1302, wheels 1304, and doors 1306 may be combined to form the composite 1300 “Car” 1308 using the composition 1310. FIG. 14 depicts a graphical representation of the composition 1410 between composite Car 1408 and components wheel 1404 and door 1406.

(b) Aggregation

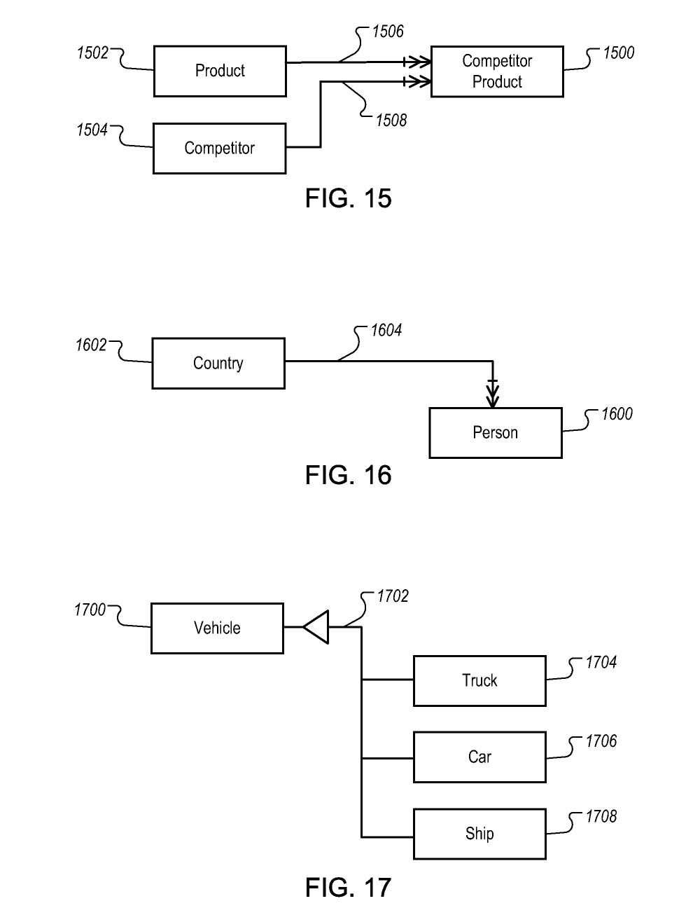

An aggregation or an aggregating relationship type is a weak whole-part relationship between two objects. The dependent object is created by the combination of one or several less dependent objects. For example, as depicted in FIG. 15, the properties of a competitor product 1500 are determined by a product 1502 and a competitor 1504. A hierarchical relationship 1506 exists between the product 1502 and the competitor product 1500 because the competitor product 1500 is a component of the product 1502. Therefore, the values of the attributes of the competitor product 1500 are determined by the product 1502. An aggregating relationship 1508 exists between the competitor 1504 and the competitor product 1500 because the competitor product 1500 is differentiated by the competitor 1504. Therefore the values of the attributes of the competitor product 1500 are determined by the competitor 1504.

(c) Association

An association or a referential relationship type describes a relationship between two objects in which the dependent object refers to the less dependent object. For example, as depicted in FIG. 16, a person 1600 has a nationality, and thus, has a reference to its country 1602 of origin. There is an association 1604 between the country 1602 and the person 1600. The values of the attributes of the person 1600 are not determined by the country 1602.

(3) Specialization

Entity types may be divided into subtypes based on characteristics of the entity types. For example, FIG. 17 depicts an entity type “vehicle” 1700 specialized 1702 into subtypes “truck” 1704, “car” 1706, and “ship” 1708. These subtypes represent different aspects or the diversity of the entity type.

Subtypes may be defined based on related attributes. For example, although ships and cars are both vehicles, ships have an attribute, “draft,” that is not found in cars. Subtypes also may be defined based on certain methods that can be applied to entities of this subtype and that modify such entities. For example, “drop anchor” can be applied to ships. If outgoing relationships to a specific object are restricted to a subset, then a subtype can be defined which reflects this subset.

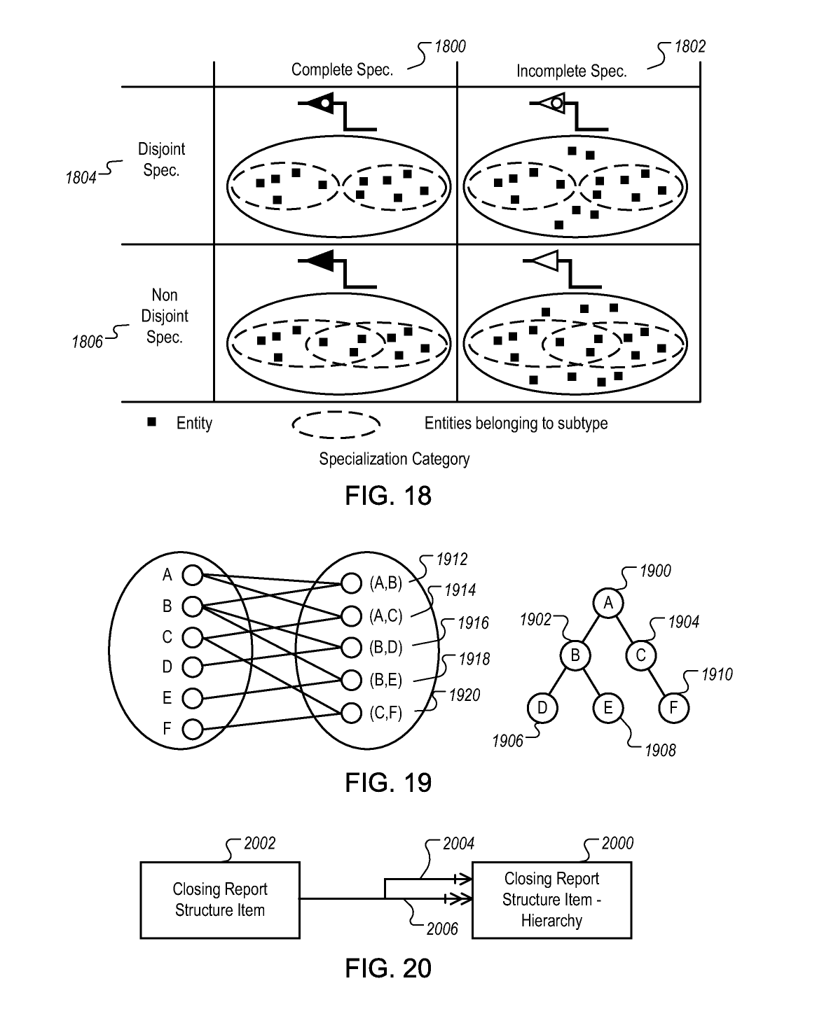

As depicted in FIG. 18, specializations may further be characterized as complete specializations 1800 or incomplete specializations 1802. There is a complete specialization 1800 where each entity of the generalized type belongs to at least one subtype. With an incomplete specialization 1802, there is at least one entity that does not belong to a subtype. Specializations also may be disjoint 1804 or nondisjoint 1806. In a disjoint specialization 1804, each entity of the generalized type belongs to a maximum of one subtype. With a nondisjoint specialization 1806, one entity may belong to more than one subtype. As depicted in FIG. 18, four specialization categories result from the combination of the specialization characteristics.

e) Structural Patterns

(1) Item

An item is an entity type which groups together features of another entity type. Thus, the features for the entity type chart of accounts are grouped together to form the entity type chart of accounts item. For example, a chart of accounts item is a category of values or value flows that can be recorded or represented in amounts of money in accounting, while a chart of accounts is a superordinate list of categories of values or value flows that is defined in accounting.

The cardinality between an entity type and its item is often either 1:n or 1:cn. For example, in the case of the entity type chart of accounts, there is a hierarchical relationship of the cardinality 1:n with the entity type chart of accounts item since a chart of accounts has at least one item in all cases.

(2) Hierarchy

A hierarchy describes the assignment of subordinate entities to superordinate entities and vice versa, where several entities of the same type are subordinate entities that have, at most, one directly superordinate entity. For example, in the hierarchy depicted in FIG. 19, entity B 1902 is subordinate to entity A 1900, resulting in the relationship (A,B) 1912. Similarly, entity C 1904 is subordinate to entity A 1900, resulting in the relationship (A,C) 1914. Entity D 1906 and entity E 1908 are subordinate to entity B 1902, resulting in the relationships (B,D) 1916 and (B,E) 1918, respectively. Entity F 1910 is subordinate to entity C 1904, resulting in the relationship (C,F) 1920.

Because each entity has at most one superordinate entity, the cardinality between a subordinate entity and its superordinate entity is 1:c. Similarly, each entity may have 0, 1 or many subordinate entities. Thus, the cardinality between a superordinate entity and its subordinate entity is 1:cn. FIG. 20 depicts a graphical representation of a Closing Report Structure Item hierarchy 2000 for a Closing Report Structure Item 2002. The hierarchy illustrates the 1:c cardinality 2004 between a subordinate entity and its superordinate entity, and the 1:cn cardinality 2006 between a superordinate entity and its subordinate entity.

3. Creation of the Business Object Model

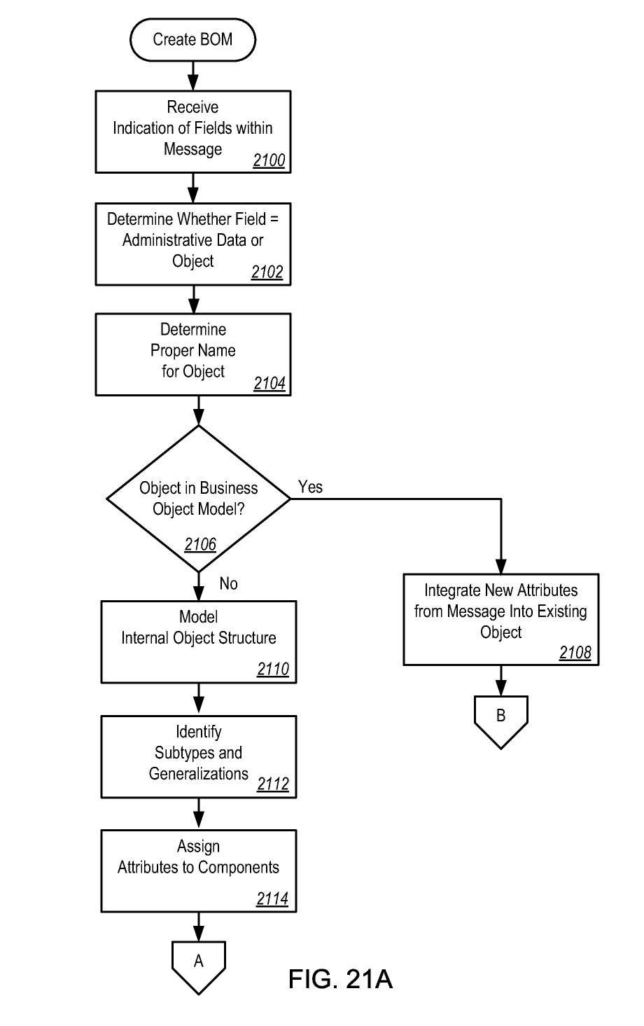

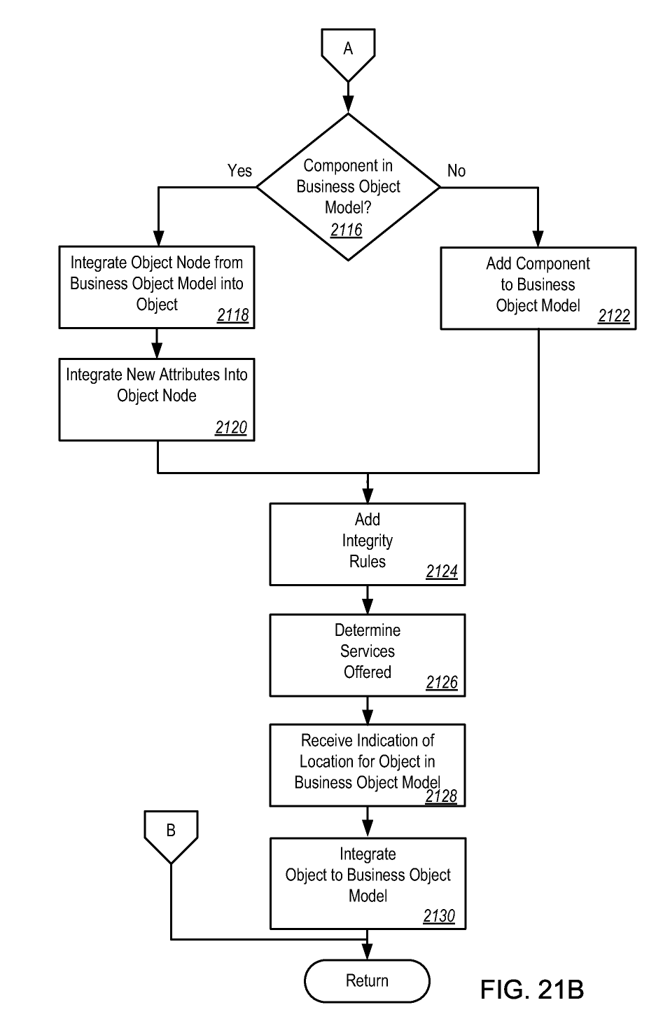

FIGS. 21A-B depict the steps performed using methods and systems consistent with the subject matter described herein to create a business object model. Although some steps are described as being performed by a computer, these steps may alternatively be performed manually, or computer-assisted, or any combination thereof. Likewise, although some steps are described as being performed by a computer, these steps may also be computer-assisted, or performed manually, or any combination thereof.

As discussed above, the designers create message choreographies that specify the sequence of messages between business entities during a transaction. After identifying the messages, the developers identify the fields contained in one of the messages (step 2100, FIG. 21A). The designers then determine whether each field relates to administrative data or is part of the object (step 2102). Thus, the first eleven fields identified below in the left column are related to administrative data, while the remaining fields are part of the object.

| | |
|---|---|
| MessageID | Admin |
| ReferenceID | |
| CreationDate | |
| SenderID | |
| AdditionalSenderID | |
| ContactPersonID | |
| SenderAddress | |
| RecipientID | |
| AdditionalRecipientID | |
| ContactPersonID | |
| RecipientAddress | |
| ID | Main Object |
| AdditionalID | |
| PostingDate | |
| LastChangeDate | |
| AcceptanceStatus | |
| Note | |
| CompleteTransmission Indicator | |
| Buyer | |
| BuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobileNumber | |
| Facsimile | |
| Email | |
| Seller | |
| SellerAddress | |
| Location | |
| LocationType | |
| DeliveryItemGroupID | |
| DeliveryPriority | |
| DeliveryCondition | |
| TransferLocation | |
| NumberofPartialDelivery | |
| QuantityTolerance | |
| MaximumLeadTime | |
| TransportServiceLevel | |
| TranportCondition | |
| TransportDescription | |
| CashDiscountTerms | |
| PaymentForm | |
| PaymentCardID | |
| PaymentCardReferenceID | |
| SequenceID | |
| Holder | |
| ExpirationDate | |
| AttachmentID | |
| AttachmentFilename | |
| DescriptionofMessage | |
| ConfirmationDescriptionof Message | |
| FollowUpActivity | |
| ItemID | |
| ParentItemID | |
| HierarchyType | |
| ProductID | |
| ProductType | |
| ProductNote | |
| ProductCategoryID | |
| Amount | |
| BaseQuantity | |
| ConfirmedAmount | |
| ConfirmedBaseQuantity | |
| ItemBuyer | |
| ItemBuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobilNumber | |
| Facsimile | |
| Email | |
| ItemSeller | |
| ItemSellerAddress | |
| ItemLocation | |
| ItemLocationType | |
| ItemDeliveryItemGroupID | |
| ItemDeliveryPriority | |
| ItemDeliveryCondition | |
| ItemTransferLocation | |
| ItemNumberofPartialDelivery | |
| ItemQuantityTolerance | |
| ItemMaximumLeadTime | |
| ItemTransportServiceLevel | |
| ItemTranportCondition | |
| ItemTransportDescription | |
| ContractReference | |
| QuoteReference | |
| CatalogueReference | |
| ItemAttachmentID | |
| ItemAttachmentFilename | |
| ItemDescription | |
| ScheduleLineID | |
| DeliveryPeriod | |
| Quantity | |
| ConfirmedScheduleLineID | |
| ConfirmedDeliveryPeriod | |
| ConfirmedQuantity | |

Next, the designers determine the proper name for the object according to the ISO 11179 naming standards (step 2104). In the example above, the proper name for the “Main Object” is “Purchase Order.” After naming the object, the system that is creating the business object model determines whether the object already exists in the business object model (step 2106). If the object already exists, the system integrates new attributes from the message into the existing object (step 2108), and the process is complete.

If at step 2106 the system determines that the object does not exist in the business object model, the designers model the internal object structure (step 2110). To model the internal structure, the designers define the components. For the above example, the designers may define the components identified below.

| | | | |
|---|---|---|---|
| ID | Pur- | | |
| AdditionalID | chase | | |
| PostingDate | Order | | |
| LastChangeDate | | | |
| AcceptanceStatus | | | |
| Note | | | |
| CompleteTransmission | | | |
| Indicator | | | |
| Buyer | | Buyer | |
| BuyerOrganisationName | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobileNumber | | | |
| Facsimile | | | |
| Email | | | |
| Seller | | Seller | |
| SellerAddress | | | |
| Location | | Location | |
| LocationType | | | |
| DeliveryItemGroupID | | DeliveryTerms | |
| DeliveryPriority | | | |
| DeliveryCondition | | | |
| TransferLocation | | | |
| NumberofPartialDelivery | | | |
| QuantityTolerance | | | |
| MaximumLeadTime | | | |
| TransportServiceLevel | | | |
| TranportCondition | | | |
| TransportDescription | | | |
| CashDiscountTerms | | | |
| PaymentForm | | Payment | |
| PaymentCardID | | | |
| PaymentCardReferenceID | | | |
| SequenceID | | | |
| Holder | | | |
| ExpirationDate | | | |
| AttachmentID | | | |
| AttachmentFilename | | | |
| DescriptionofMessage | | | |
| ConfirmationDescriptionof | | | |
| Message | | | |
| FollowUpActivity | | | |
| ItemID | | Purchase Order | |
| ParentItemID | | Item | |
| HierarchyType | | | |
| ProductID | | | Product |
| ProductType | | | |
| ProductNote | | | |
| ProductCategoryID | | | ProductCategory |
| Amount | | | |
| BaseQuantity | | | |
| ConfirmedAmount | | | |
| ConfirmedBaseQuantity | | | |
| ItemBuyer | | | Buyer |
| ItemBuyerOrganisation | | | |
| Name | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobilNumber | | | |
| Facsimile | | | |
| Email | | | |
| ItemSeller | | | Seller |
| ItemSellerAddress | | | |
| ItemLocation | | | Location |
| ItemLocationType | | | |
| ItemDeliveryItemGroupID | | | |
| ItemDeliveryPriority | | | |
| ItemDeliveryCondition | | | |
| ItemTransferLocation | | | |
| ItemNumberofPartial | | | |
| Delivery | | | |
| ItemQuantityTolerance | | | |
| ItemMaximumLeadTime | | | |
| ItemTransportServiceLevel | | | |
| ItemTranportCondition | | | |
| ItemTransportDescription | | | |
| ContractReference | | | Contract |
| QuoteReference | | | Quote |
| CatalogueReference | | | Catalogue |
| ItemAttachmentID | | | |
| ItemAttachmentFilename | | | |
| ItemDescription | | | |
| ScheduleLineID | | | |
| DeliveryPeriod | | | |
| Quantity | | | |
| ConfirmedScheduleLineID | | | |
| ConfirmedDeliveryPeriod | | | |
| ConfirmedQuantity | | | |

During the step of modeling the internal structure, the designers also model the complete internal structure by identifying the compositions of the components and the corresponding cardinalities, as shown below.

| | | | | |
|---|---|---|---|---|
| PurchaseOrder | | | | 1 |
| | Buyer | | | 0 . . . 1 |
| | | Address | | 0 . . . 1 |
| | | ContactPerson | | 0 . . . 1 |
| | | | Address | 0 . . . 1 |
| | Seller | | | 0 . . . 1 |
| | Location | | | 0 . . . 1 |
| | | Address | | 0 . . . 1 |
| | DeliveryTerms | | | 0 . . . 1 |
| | | Incoterms | | 0 . . . 1 |
| | | PartialDelivery | | 0 . . . 1 |
| | | QuantityTolerance | | 0 . . . 1 |
| | | Transport | | 0 . . . 1 |
| | CashDiscount | | | 0 . . . 1 |
| | Terms | | | |
| | | MaximumCashDiscount | | 0 . . . 1 |
| | | NormalCashDiscount | | 0 . . . 1 |
| | PaymentForm | | | 0 . . . 1 |
| | | PaymentCard | | 0 . . . 1 |
| | Attachment | | | 0 . . . n |
| | Description | | | 0 . . . 1 |
| | Confirmation | | | 0 . . . 1 |
| | Description | | | |
| | Item | | | 0 . . . n |
| | | HierarchyRelationship | | 0 . . . 1 |
| | | Product | | 0 . . . 1 |
| | | ProductCategory | | 0 . . . 1 |
| | | Price | | 0 . . . 1 |
| | | | NetunitPrice | 0 . . . 1 |
| | | ConfirmedPrice | | 0 . . . 1 |
| | | | NetunitPrice | 0 . . . 1 |
| | | Buyer | | 0 . . . 1 |
| | | Seller | | 0 . . . 1 |
| | | Location | | 0 . . . 1 |
| | | DeliveryTerms | | 0 . . . 1 |
| | | Attachment | | 0 . . . n |
| | | Description | | 0 . . . 1 |
| | | ConfirmationDescription | | 0 . . . 1 |
| | | ScheduleLine | | 0 . . . n |
| | | | DeliveryPeriod | 1 |
| | | ConfirmedScheduleLine | | 0 . . . n |

After modeling the internal object structure, the developers identify the subtypes and generalizations for all objects and components (step 2112). For example, the Purchase Order may have subtypes Purchase Order Update, Purchase Order Cancellation and Purchase Order Information. Purchase Order Update may include Purchase Order Request, Purchase Order Change, and Purchase Order Confirmation. Moreover, Party may be identified as the generalization of Buyer and Seller. The subtypes and generalizations for the above example are shown below.

| | | | | | |
|---|---|---|---|---|---|
| Purchase | | | | | 1 |
| Order | | | | | |
| | PurchaseOrder | | | | |
| | Update | | | | |
| | | PurchaseOrder Request | | | |
| | | PurchaseOrder Change | | | |
| | | PurchaseOrder | | | |
| | | Confirmation | | | |
| | PurchaseOrder | | | | |
| | Cancellation | | | | |
| | PurchaseOrder | | | | |
| | Information | | | | |
| | Party | | | | |
| | | BuyerParty | | | 0 . . . 1 |
| | | | Address | | 0 . . . 1 |
| | | | ContactPerson | | 0 . . . 1 |
| | | | | Address | 0 . . . 1 |
| | | SellerParty | | | 0 . . . 1 |
| | Location | | | | |
| | | ShipToLocation | | | 0 . . . 1 |
| | | | Address | | 0 . . . 1 |
| | | ShipFromLocation | | | 0 . . . 1 |
| | | | Address | | 0 . . . 1 |
| | DeliveryTerms | | | | 0 . . . 1 |
| | | Incoterms | | | 0 . . . 1 |
| | | PartialDelivery | | | 0 . . . 1 |
| | | QuantityTolerance | | | 0 . . . 1 |
| | | Transport | | | 0 . . . 1 |
| | CashDiscount | | | | 0 . . . 1 |
| | Terms | | | | |
| | | MaximumCash Discount | | | 0 . . . 1 |
| | | NormalCashDiscount | | | 0 . . . 1 |
| | PaymentForm | | | | 0 . . . 1 |
| | | PaymentCard | | | 0 . . . 1 |
| | Attachment | | | | 0 . . . n |
| | Description | | | | 0 . . . 1 |
| | Confirmation | | | | 0 . . . 1 |
| | Description | | | | |
| | Item | | | | 0 . . . n |
| | | HierarchyRelationship | | | 0 . . . 1 |
| | | Product | | | 0 . . . 1 |
| | | ProductCategory | | | 0 . . . 1 |
| | | Price | | | 0 . . . 1 |
| | | | NetunitPrice | | 0 . . . 1 |
| | | ConfirmedPrice | | | 0 . . . 1 |
| | | | NetunitPrice | | 0 . . . 1 |
| | | Party | | | |
| | | | BuyerParty | | 0 . . . 1 |
| | | | SellerParty | | 0 . . . 1 |
| | | Location | | | |
| | | | ShipTo | | 0 . . . 1 |
| | | | Location | | |
| | | | ShipFrom | | 0 . . . 1 |
| | | | Location | | |
| | | DeliveryTerms | | | 0 . . . 1 |
| | | Attachment | | | 0 . . . n |
| | | Description | | | 0 . . . 1 |
| | | Confirmation Description | | | 0 . . . 1 |
| | | ScheduleLine | | | 0 . . . n |
| | | | Delivery | | 1 |
| | | | Period | | |
| | | ConfirmedScheduleLine | | | 0 . . . n |

After identifying the subtypes and generalizations, the developers assign the attributes to these components (step 2114). The attributes for a portion of the components are shown below.

| | | | | |
|---|---|---|---|---|
| Purchase | | | | 1 |
| Order | | | | |
| | ID | | | 1 |
| | SellerID | | | 0 . . . 1 |
| | BuyerPosting | | | 0 . . . 1 |
| | DateTime | | | |
| | BuyerLast | | | 0 . . . 1 |
| | ChangeDate | | | |
| | Time | | | |
| | SellerPosting | | | 0 . . . 1 |
| | DateTime | | | |
| | SellerLast | | | 0 . . . 1 |
| | ChangeDate | | | |
| | Time | | | |
| | Acceptance | | | 0 . . . 1 |
| | StatusCode | | | |
| | Note | | | 0 . . . 1 |
| | ItemList | | | 0 . . . 1 |
| | Complete | | | |
| | Transmission | | | |
| | Indicator | | | |
| | BuyerParty | | | 0 . . . 1 |
| | | StandardID | | 0 . . . n |
| | | BuyerID | | 0 . . . 1 |
| | | SellerID | | 0 . . . 1 |
| | | Address | | 0 . . . 1 |
| | | ContactPerson | | 0 . . . 1 |
| | | | BuyerID | 0 . . . 1 |
| | | | SellerID | 0 . . . 1 |
| | | | Address | 0 . . . 1 |
| | SellerParty | | | 0 . . . 1 |
| | Product | | | 0 . . . 1 |
| | RecipientParty | | | |
| | VendorParty | | | 0 . . . 1 |
| | Manufacturer | | | 0 . . . 1 |
| | Party | | | |
| | BillToParty | | | 0 . . . 1 |
| | PayerParty | | | 0 . . . 1 |
| | CarrierParty | | | 0 . . . 1 |
| | ShipTo | | | 0 . . . 1 |
| | Location | | | |
| | | StandardID | | 0 . . . n |
| | | BuyerID | | 0 . . . 1 |
| | | SellerID | | 0 . . . 1 |
| | | Address | | 0 . . . 1 |
| | ShipFrom | | | 0 . . . 1 |
| | Location | | | |

The system then determines whether the component is one of the object nodes in the business object model (step 2116, FIG. 21B). If the system determines that the component is one of the object nodes in the business object model, the system integrates a reference to the corresponding object node from the business object model into the object (step 2118). In the above example, the system integrates the reference to the Buyer party represented by an ID and the reference to the ShipToLocation represented by an into the object, as shown below. The attributes that were formerly located in the PurchaseOrder object are now assigned to the new found object party. Thus, the attributes are removed from the PurchaseOrder object.

| | | |
|---|---|---|
| PurchaseOrder | ID | |
| | SellerID | |
| | BuyerPostingDateTime | |
| | BuyerLastChangeDateTime | |
| | SellerPostingDateTime | |
| | SellerLastChangeDateTime | |
| | AcceptanceStatusCode | |
| | Note | |
| | ItemListComplete | |
| | TransmissionIndicator | |
| | BuyerParty | |
| | | ID |
| | SellerParty | |
| | ProductRecipientParty | |
| | VendorParty | |
| | ManufacturerParty | |
| | BillToParty | |
| | PayerParty | |
| | CarrierParty | |
| | ShipToLocation | |
| | | ID |
| | ShipFromLocation | |

During the integration step, the designers classify the relationship (i.e., aggregation or association) between the object node and the object being integrated into the business object model. The system also integrates the new attributes into the object node (step 2120). If at step 2116, the system determines that the component is not in the business object model, the system adds the component to the business object model (step 2122).

Regardless of whether the component was in the business object model at step 2116, the next step in creating the business object model is to add the integrity rules (step 2124). There are several levels of integrity rules and constraints which should be described. These levels include consistency rules between attributes, consistency rules between components, and consistency rules to other objects. Next, the designers determine the services offered, which can be accessed via interfaces (step 2126). The services offered in the example above include PurchaseOrderCreateRequest, PurchaseOrderCancellationRequest, and PurchaseOrderReleaseRequest. The system then receives an indication of the location for the object in the business object model (step 2128). After receiving the indication of the location, the system integrates the object into the business object model (step 2130).

4. Structure of the Business Object Model

The business object model, which serves as the basis for the process of generating consistent interfaces, includes the elements contained within the interfaces. These elements are arranged in a hierarchical structure within the business object model.

5. Interfaces Derived from Business Object Model

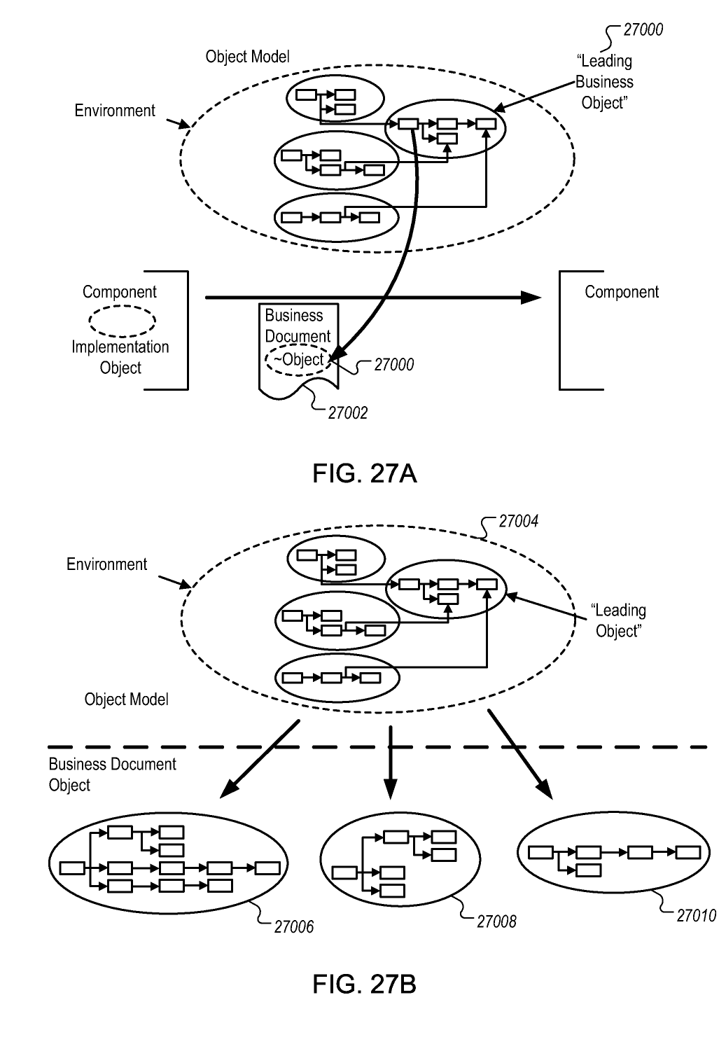

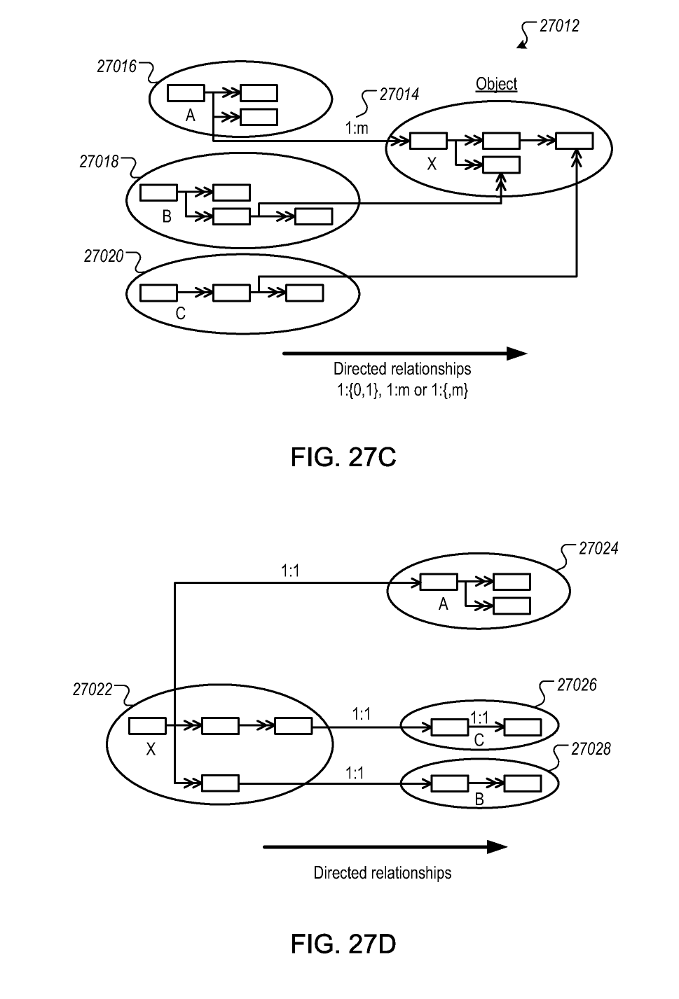

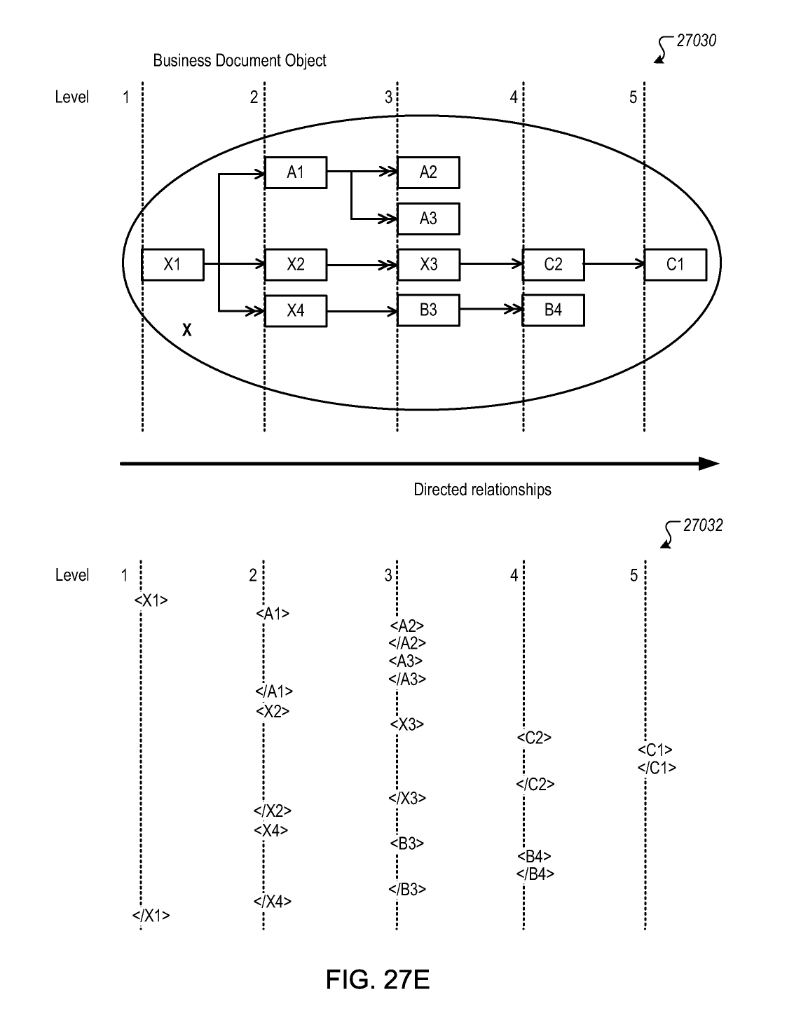

Interfaces are the starting point of the communication between two business entities. The structure of each interface determines how one business entity communicates with another business entity. The business entities may act as a unified whole when, based on the business scenario, the business entities know what an interface contains from a business perspective and how to fill the individual elements or fields of the interface. As illustrated in FIG. 27A, communication between components takes place via messages that contain business documents (e.g., business document 27002). The business document 27002 ensures a holistic business-related understanding for the recipient of the message. The business documents are created and accepted or consumed by interfaces, specifically by inbound and outbound interfaces. The interface structure and, hence, the structure of the business document are derived by a mapping rule. This mapping rule is known as “hierarchization.” An interface structure thus has a hierarchical structure created based on the leading business object 27000. The interface represents a usage-specific, hierarchical view of the underlying usage-neutral object model.

As illustrated in FIG. 27B, several business document objects 27006, 27008, and 27010 as overlapping views may be derived for a given leading object 27004. Each business document object results from the object model by hierarchization.

To illustrate the hierarchization process, FIG. 27C depicts an example of an object model 27012 (i.e., a portion of the business object model) that is used to derive a service operation signature (business document object structure). As depicted, leading object X 27014 in the object model 27012 is integrated in a net of object A 27016, object B 27018, and object C 27020. Initially, the parts of the leading object 27014 that are required for the business object document are adopted. In one variation, all parts required for a business document object are adopted from leading object 27014 (making such an operation a maximal service operation). Based on these parts, the relationships to the superordinate objects (i.e., objects A, B, and C from which object X depends) are inverted. In other words, these objects are adopted as dependent or subordinate objects in the new business document object.

For example, object A 27016, object B 27018, and object C 27020 have information that characterize object X. Because object A 27016, object B 27018, and object C 27020 are superordinate to leading object X 27014, the dependencies of these relationships change so that object A 27016, object B 27018, and object C 27020 become dependent and subordinate to leading object X 27014. This procedure is known as “derivation of the business document object by hierarchization.”

Business-related objects generally have an internal structure (parts). This structure can be complex and reflect the individual parts of an object and their mutual dependency. When creating the operation signature, the internal structure of an object is strictly hierarchized. Thus, dependent parts keep their dependency structure, and relationships between the parts within the object that do not represent the hierarchical structure are resolved by prioritizing one of the relationships.

Relationships of object X to external objects that are referenced and whose information characterizes object X are added to the operation signature. Such a structure can be quite complex (see, for example, FIG. 27D). The cardinality to these referenced objects is adopted as 1:1 or 1:C, respectively. By this, the direction of the dependency changes. The required parts of this referenced object are adopted identically, both in their cardinality and in their dependency arrangement.

The newly created business document object contains all required information, including the incorporated master data information of the referenced objects. As depicted in FIG. 27D, components Xi in leading object X 27022 are adopted directly. The relationship of object X 27022 to object A 27024, object B 27028, and object C 27026 are inverted, and the parts required by these objects are added as objects that depend from object X 27022. As depicted, all of object A 27024 is adopted. B3 and B4 are adopted from object B 27028, but B1 is not adopted. From object C 27026, C2 and C1 are adopted, but C3 is not adopted.

FIG. 27E depicts the business document object X 27030 created by this hierarchization process. As shown, the arrangement of the elements corresponds to their dependency levels, which directly leads to a corresponding representation as an XML structure 27032.

The following provides certain rules that can be adopted singly or in combination with regard to the hierarchization process. A business document object always refers to a leading business document object and is derived from this object. The name of the root entity in the business document entity is the name of the business object or the name of a specialization of the business object or the name of a service specific view onto the business object. The nodes and elements of the business object that are relevant (according to the semantics of the associated message type) are contained as entities and elements in the business document object.

The name of a business document entity is predefined by the name of the corresponding business object node. The name of the superordinate entity is not repeated in the name of the business document entity. The “full” semantic name results from the concatenation of the entity names along the hierarchical structure of the business document object.

The structure of the business document object is, except for deviations due to hierarchization, the same as the structure of the business object. The cardinalities of the business document object nodes and elements are adopted identically or more restrictively to the business document object. An object from which the leading business object is dependent can be adopted to the business document object. For this arrangement, the relationship is inverted, and the object (or its parts, respectively) are hierarchically subordinated in the business document object.

Nodes in the business object representing generalized business information can be adopted as explicit entities to the business document object (generally speaking, multiply TypeCodes out). When this adoption occurs, the entities are named according to their more specific semantic (name of TypeCode becomes prefix). Party nodes of the business object are modeled as explicit entities for each party role in the business document object. These nodes are given the name <Prefix><Party Role> Party, for example, BuyerParty, ItemBuyerParty. BTDReference nodes are modeled as separate entities for each reference type in the business document object. These nodes are given the name <Qualifier><BO><Node>Reference, for example SalesOrderReference, OriginSalesOrderReference, SalesOrderItemReference. A product node in the business object comprises all of the information on the Product, ProductCategory, and Batch. This information is modeled in the business document object as explicit entities for Product, ProductCategory, and Batch.

Entities which are connected by a 1:1 relationship as a result of hierarchization can be combined to a single entity, if they are semantically equivalent. Such a combination can often occurs if a node in the business document object that results from an assignment node is removed because it does not have any elements.

The message type structure is typed with data types. Elements are typed by GDTs according to their business objects. Aggregated levels are typed with message type specific data types (Intermediate Data Types), with their names being built according to the corresponding paths in the message type structure. The whole message type structured is typed by a message data type with its name being built according to the root entity with the suffix “Message.” For the message type, the message category (e.g., information, notification, query, response, request, confirmation, etc.) is specified according to the suited transaction communication pattern.

In one variation, the derivation by hierarchization can be initiated by specifying a leading business object and a desired view relevant for a selected service operation. This view determines the business document object. The leading business object can be the source object, the target object, or a third object. Thereafter, the parts of the business object required for the view are determined. The parts are connected to the root node via a valid path along the hierarchy. Thereafter, one or more independent objects (object parts, respectively) referenced by the leading object which are relevant for the service may be determined (provided that a relationship exists between the leading object and the one or more independent objects).

Once the selection is finalized, relevant nodes of the leading object node that are structurally identical to the message type structure can then be adopted. If nodes are adopted from independent objects or object parts, the relationships to such independent objects or object parts are inverted. Linearization can occur such that a business object node containing certain TypeCodes is represented in the message type structure by explicit entities (an entity for each value of the TypeCode). The structure can be reduced by checking all 1:1 cardinalities in the message type structure. Entities can be combined if they are semantically equivalent, one of the entities carries no elements, or an entity solely results from an n:m assignment in the business object.

After the hierarchization is completed, information regarding transmission of the business document object (e.g., CompleteTransmissionIndicator, ActionCodes, message category, etc.) can be added. A standardized message header can be added to the message type structure and the message structure can be typed. Additionally, the message category for the message type can be designated.

Invoice Request and Invoice Confirmation are examples of interfaces. These invoice interfaces are used to exchange invoices and invoice confirmations between an invoicing party and an invoice recipient (such as between a seller and a buyer) in a B2B process. Companies can create invoices in electronic as well as in paper form. Traditional methods of communication, such as mail or fax, for invoicing are cost intensive, prone to error, and relatively slow, since the data is recorded manually. Electronic communication eliminates such problems. The motivating business scenarios for the Invoice Request and Invoice Confirmation interfaces are the Procure to Stock (PTS) and Sell from Stock (SFS) scenarios. In the PTS scenario, the parties use invoice interfaces to purchase and settle goods. In the SFS scenario, the parties use invoice interfaces to sell and invoice goods. The invoice interfaces directly integrate the applications implementing them and also form the basis for mapping data to widely-used XML standard formats such as RosettaNet, PIDX, xCBL, and CIDX.

The invoicing party may use two different messages to map a B2B invoicing process: (1) the invoicing party sends the message type InvoiceRequest to the invoice recipient to start a new invoicing process; and (2) the invoice recipient sends the message type InvoiceConfirmation to the invoicing party to confirm or reject an entire invoice or to temporarily assign it the status “pending.”

An InvoiceRequest is a legally binding notification of claims or liabilities for delivered goods and rendered services—usually, a payment request for the particular goods and services. The message type InvoiceRequest is based on the message data type InvoiceMessage. The InvoiceRequest message (as defined) transfers invoices in the broader sense. This includes the specific invoice (request to settle a liability), the debit memo, and the credit memo.

InvoiceConfirmation is a response sent by the recipient to the invoicing party confirming or rejecting the entire invoice received or stating that it has been assigned temporarily the status “pending.” The message type InvoiceConfirmation is based on the message data type InvoiceMessage. An InvoiceConfirmation is not mandatory in a B2B invoicing process, however, it automates collaborative processes and dispute management.

Usually, the invoice is created after it has been confirmed that the goods were delivered or the service was provided. The invoicing party (such as the seller) starts the invoicing process by sending an InvoiceRequest message. Upon receiving the InvoiceRequest message, the invoice recipient (for instance, the buyer) can use the InvoiceConfirmation message to completely accept or reject the invoice received or to temporarily assign it the status “pending.” The InvoiceConfirmation is not a negotiation tool (as is the case in order management), since the options available are either to accept or reject the entire invoice. The invoice data in the InvoiceConfirmation message merely confirms that the invoice has been forwarded correctly and does not communicate any desired changes to the invoice. Therefore, the InvoiceConfirmation includes the precise invoice data that the invoice recipient received and checked. If the invoice recipient rejects an invoice, the invoicing party can send a new invoice after checking the reason for rejection (AcceptanceStatus and ConfirmationDescription at Invoice and InvoiceItem level). If the invoice recipient does not respond, the invoice is generally regarded as being accepted and the invoicing party can expect payment.

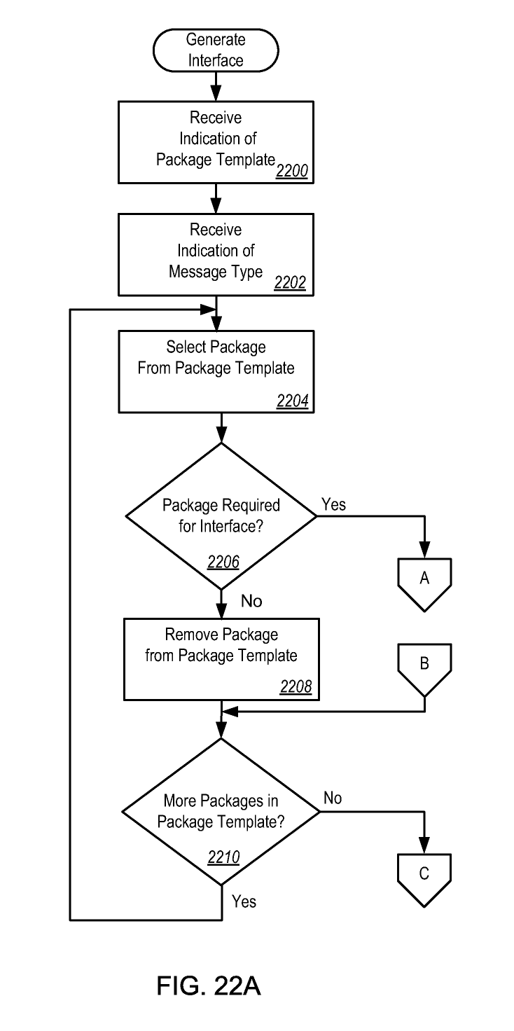

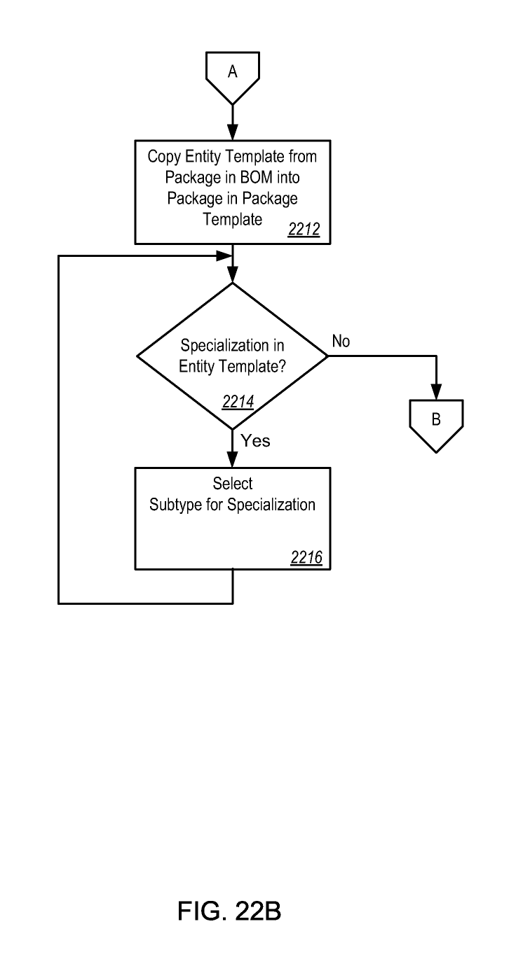

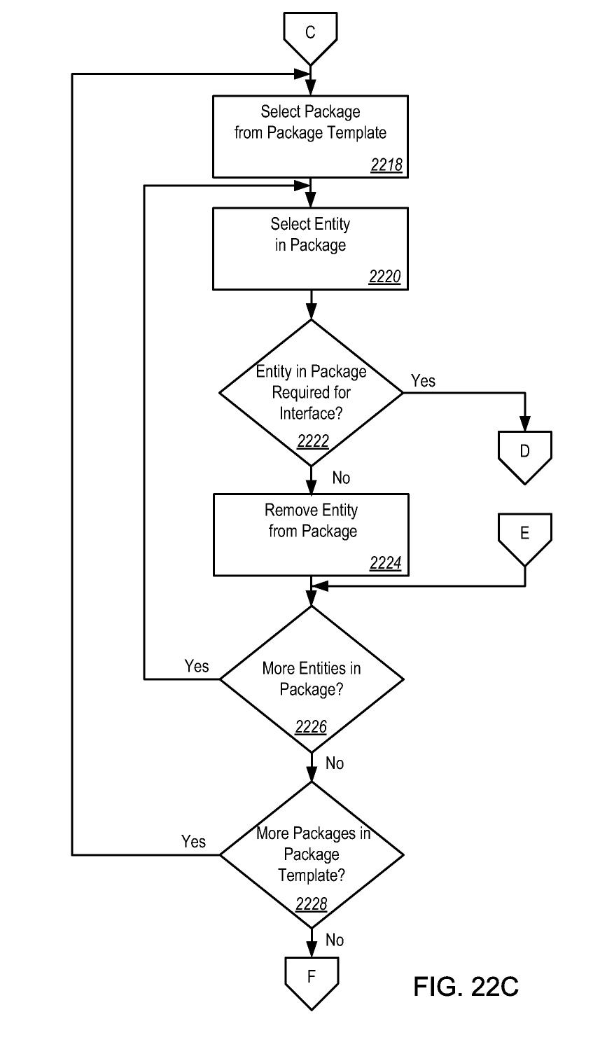

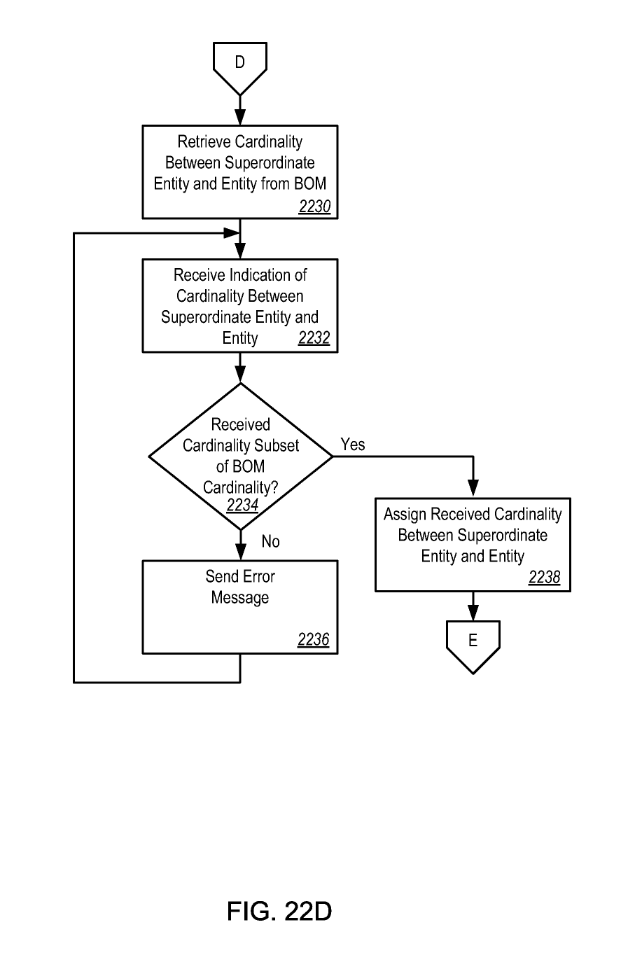

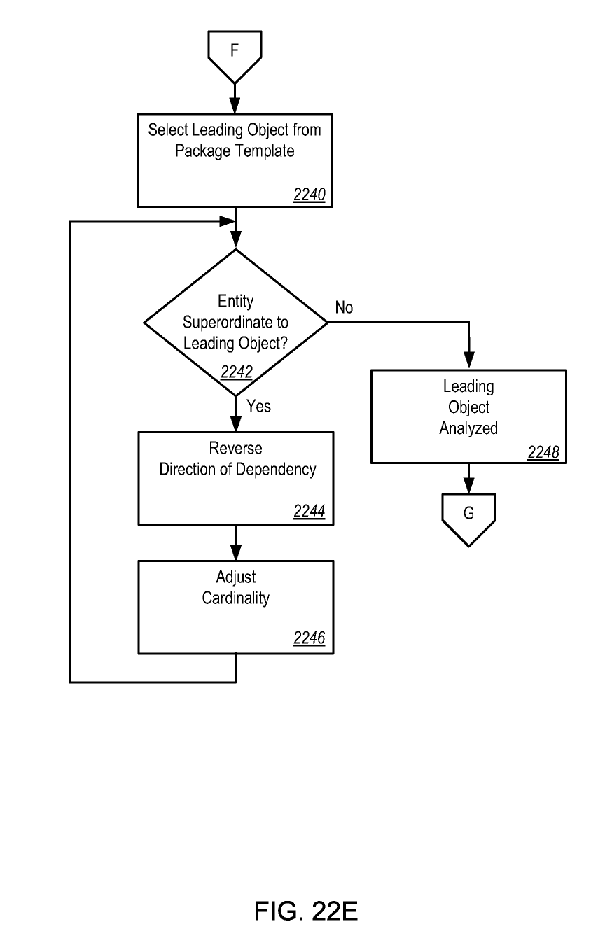

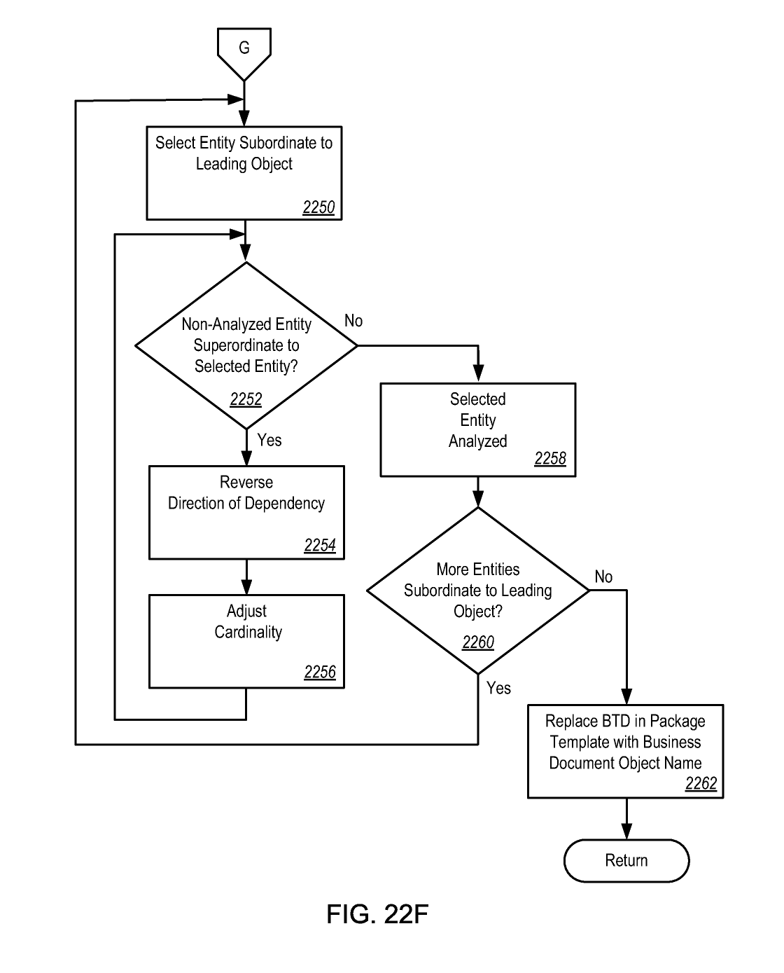

FIGS. 22A-F depict a flow diagram of the steps performed by methods and systems consistent with the subject matter described herein to generate an interface from the business object model. Although described as being performed by a computer, these steps may alternatively be performed manually, or using any combination thereof. The process begins when the system receives an indication of a package template from the designer, i.e., the designer provides a package template to the system (step 2200).

Package templates specify the arrangement of packages within a business transaction document. Package templates are used to define the overall structure of the messages sent between business entities. Methods and systems consistent with the subject matter described herein use package templates in conjunction with the business object model to derive the interfaces.

The system also receives an indication of the message type from the designer (step 2202). The system selects a package from the package template (step 2204), and receives an indication from the designer whether the package is required for the interface (step 2206). If the package is not required for the interface, the system removes the package from the package template (step 2208). The system then continues this analysis for the remaining packages within the package template (step 2210).

If, at step 2206, the package is required for the interface, the system copies the entity template from the package in the business object model into the package in the package template (step 2212, FIG. 22B). The system determines whether there is a specialization in the entity template (step 2214). If the system determines that there is a specialization in the entity template, the system selects a subtype for the specialization (step 2216). The system may either select the subtype for the specialization based on the message type, or it may receive this information from the designer. The system then determines whether there are any other specializations in the entity template (step 2214). When the system determines that there are no specializations in the entity template, the system continues this analysis for the remaining packages within the package template (step 2210, FIG. 22A).

At step 2210, after the system completes its analysis for the packages within the package template, the system selects one of the packages remaining in the package template (step 2218, FIG. 22C), and selects an entity from the package (step 2220). The system receives an indication from the designer whether the entity is required for the interface (step 2222). If the entity is not required for the interface, the system removes the entity from the package template (step 2224). The system then continues this analysis for the remaining entities within the package (step 2226), and for the remaining packages within the package template (step 2228).

If, at step 2222, the entity is required for the interface, the system retrieves the cardinality between a superordinate entity and the entity from the business object model (step 2230, FIG. 22D). The system also receives an indication of the cardinality between the superordinate entity and the entity from the designer (step 2232). The system then determines whether the received cardinality is a subset of the business object model cardinality (step 2234). If the received cardinality is not a subset of the business object model cardinality, the system sends an error message to the designer (step 2236). If the received cardinality is a subset of the business object model cardinality, the system assigns the received cardinality as the cardinality between the superordinate entity and the entity (step 2238). The system then continues this analysis for the remaining entities within the package (step 2226, FIG. 22C), and for the remaining packages within the package template (step 2228).

The system then selects a leading object from the package template (step 2240, FIG. 22E). The system determines whether there is an entity superordinate to the leading object (step 2242). If the system determines that there is an entity superordinate to the leading object, the system reverses the direction of the dependency (step 2244) and adjusts the cardinality between the leading object and the entity (step 2246). The system performs this analysis for entities that are superordinate to the leading object (step 2242). If the system determines that there are no entities superordinate to the leading object, the system identifies the leading object as analyzed (step 2248).

The system then selects an entity that is subordinate to the leading object (step 2250, FIG. 22F). The system determines whether any non-analyzed entities are superordinate to the selected entity (step 2252). If a non-analyzed entity is superordinate to the selected entity, the system reverses the direction of the dependency (step 2254) and adjusts the cardinality between the selected entity and the non-analyzed entity (step 2256). The system performs this analysis for non-analyzed entities that are superordinate to the selected entity (step 2252). If the system determines that there are no non-analyzed entities superordinate to the selected entity, the system identifies the selected entity as analyzed (step 2258), and continues this analysis for entities that are subordinate to the leading object (step 2260). After the packages have been analyzed, the system substitutes the BusinessTransactionDocument (“BTD”) in the package template with the name of the interface (step 2262). This includes the “BTD” in the BTDItem package and the “BTD” in the BTDItemScheduleLine package.

6. Use of an Interface

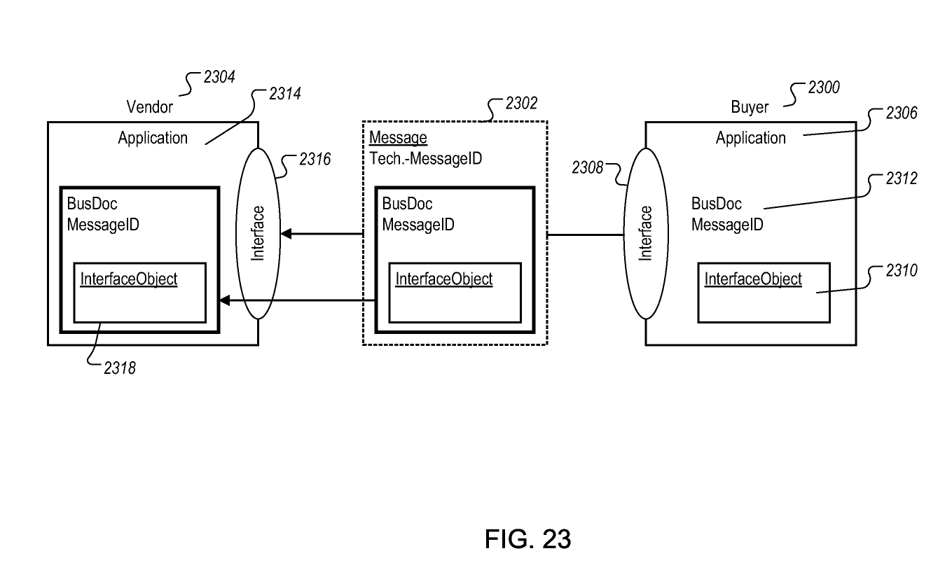

The XI stores the interfaces (as an interface type). At runtime, the sending party's program instantiates the interface to create a business document, and sends the business document in a message to the recipient. The messages are preferably defined using XML. In the example depicted in FIG. 23, the Buyer 2300 uses an application 2306 in its system to instantiate an interface 2308 and create an interface object or business document object 2310. The Buyer's application 2306 uses data that is in the sender's component-specific structure and fills the business document object 2310 with the data. The Buyer's application 2306 then adds message identification 2312 to the business document and places the business document into a message 2302. The Buyer's application 2306 sends the message 2302 to the Vendor 2304. The Vendor 2304 uses an application 2314 in its system to receive the message 2302 and store the business document into its own memory. The Vendor's application 2314 unpacks the message 2302 using the corresponding interface 2316 stored in its XI to obtain the relevant data from the interface object or business document object 2318.

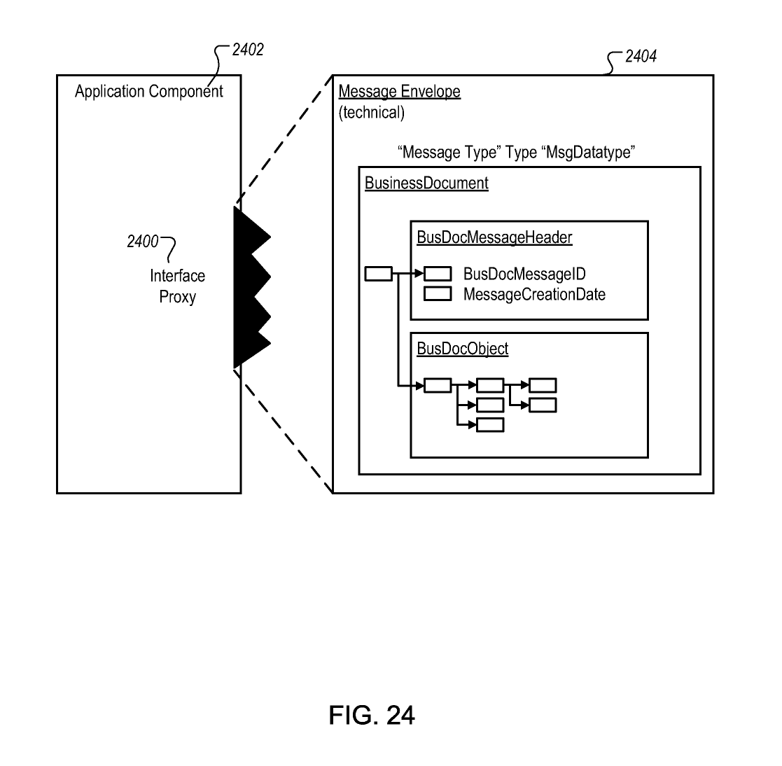

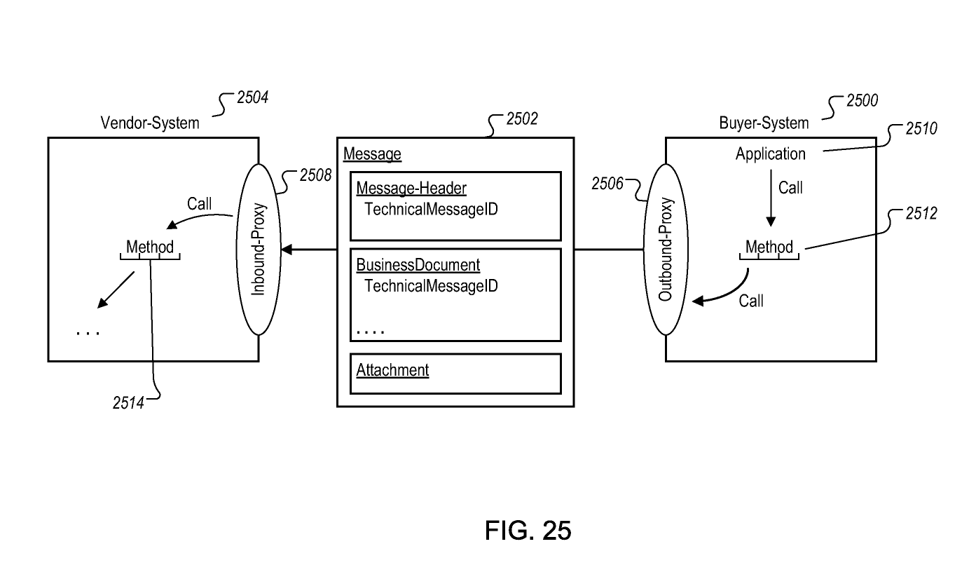

From the component's perspective, the interface is represented by an interface proxy 2400, as depicted in FIG. 24. The proxies 2400 shield the components 2402 of the sender and recipient from the technical details of sending messages 2404 via XI. In particular, as depicted in FIG. 25, at the sending end, the Buyer 2500 uses an application 2510 in its system to call an implemented method 2512, which generates the outbound proxy 2506. The outbound proxy 2506 parses the internal data structure of the components and converts them to the XML structure in accordance with the business document object. The outbound proxy 2506 packs the document into a message 2502. Transport, routing and mapping the XML message to the recipient 28304 is done by the routing system (XI, modeling environment 516, etc.).

When the message arrives, the recipient's inbound proxy 2508 calls its component-specific method 2514 for creating a document. The proxy 2508 at the receiving end downloads the data and converts the XML structure into the internal data structure of the recipient component 2504 for further processing.

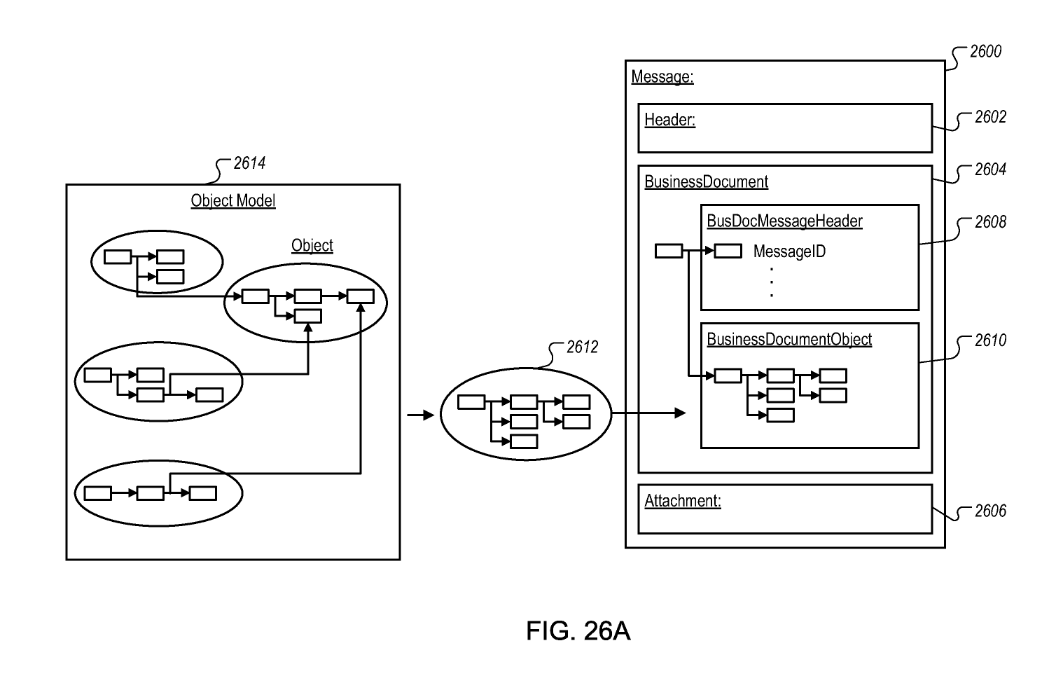

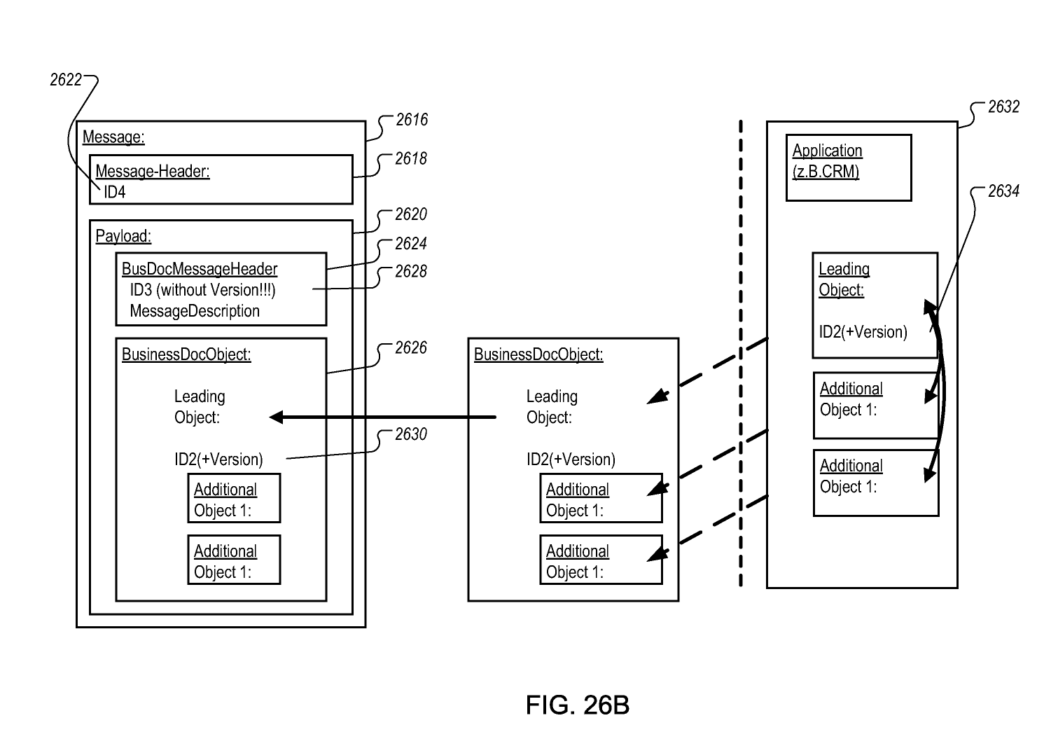

As depicted in FIG. 26A, a message 2600 includes a message header 2602 and a business document 2604. The message 2600 also may include an attachment 2606. For example, the sender may attach technical drawings, detailed specifications or pictures of a product to a purchase order for the product. The business document 2604 includes a business document message header 2608 and the business document object 2610. The business document message header 2608 includes administrative data, such as the message ID and a message description. As discussed above, the structure 2612 of the business document object 2610 is derived from the business object model 2614. Thus, there is a strong correlation between the structure of the business document object and the structure of the business object model. The business document object 2610 forms the core of the message 2600.

In collaborative processes as well as Q&A processes, messages should refer to documents from previous messages. A simple business document object ID or object ID is insufficient to identify individual messages uniquely because several versions of the same business document object can be sent during a transaction. A business document object ID with a version number also is insufficient because the same version of a business document object can be sent several times. Thus, messages require several identifiers during the course of a transaction.

As depicted in FIG. 26B, the message header 2618 in message 2616 includes a technical ID (“ID4”) 2622 that identifies the address for a computer to route the message. The sender's system manages the technical ID 2622.

The administrative information in the business document message header 2624 of the payload or business document 2620 includes a BusinessDocumentMessageID (“ID3”) 2628. The business entity or component 2632 of the business entity manages and sets the BusinessDocumentMessageID 2628. The business entity or component 2632 also can refer to other business documents using the BusinessDocumentMessageID 2628. The receiving component 2632 requires no knowledge regarding the structure of this ID. The BusinessDocumentMessageID 2628 is, as an ID, unique. Creation of a message refers to a point in time. No versioning is typically expressed by the ID. Besides the BusinessDocumentMessageID 2628, there also is a business document object ID 2630, which may include versions.

The component 2632 also adds its own component object ID 2634 when the business document object is stored in the component. The component object ID 2634 identifies the business document object when it is stored within the component. However, not all communication partners may be aware of the internal structure of the component object ID 2634. Some components also may include a versioning in their ID 2634.

7. Use of Interfaces Across Industries

Methods and systems consistent with the subject matter described herein provide interfaces that may be used across different business areas for different industries. Indeed, the interfaces derived using methods and systems consistent with the subject matter described herein may be mapped onto the interfaces of different industry standards. Unlike the interfaces provided by any given standard that do not include the interfaces required by other standards, methods and systems consistent with the subject matter described herein provide a set of consistent interfaces that correspond to the interfaces provided by different industry standards. Due to the different fields provided by each standard, the interface from one standard does not easily map onto another standard. By comparison, to map onto the different industry standards, the interfaces derived using methods and systems consistent with the subject matter described herein include most of the fields provided by the interfaces of different industry standards. Missing fields may easily be included into the business object model. Thus, by derivation, the interfaces can be extended consistently by these fields. Thus, methods and systems consistent with the subject matter described herein provide consistent interfaces or services that can be used across different industry standards.

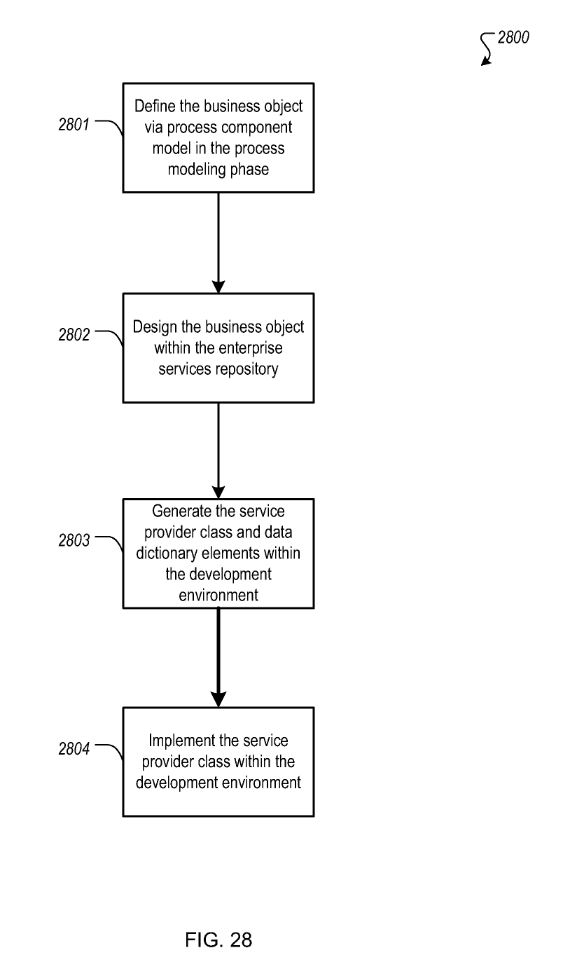

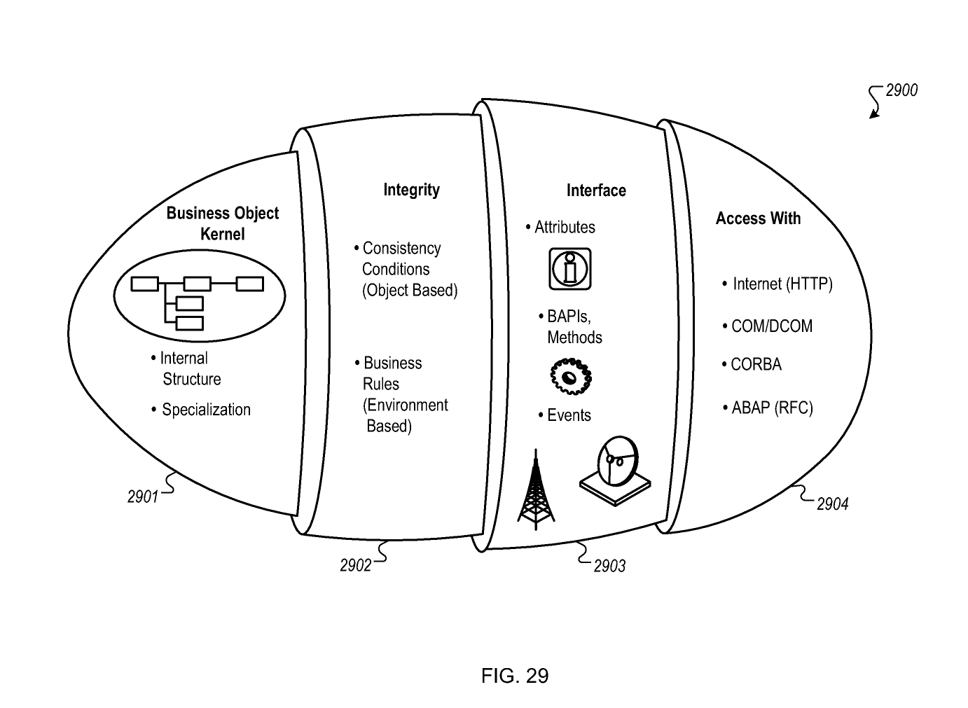

For example, FIG. 28 illustrates an example method 2800 for service enabling. In this example, the enterprise services infrastructure may offer one common and standard-based service infrastructure. Further, one central enterprise services repository may support uniform service definition, implementation and usage of services for user interface, and cross-application communication. In step 2801, a business object is defined via a process component model in a process modeling phase. Next, in step 2802, the business object is designed within an enterprise services repository. For example, FIG. 29 provides a graphical representation of one of the business objects 2900. As shown, an innermost layer or kernel 2901 of the business object may represent the business object's inherent data. Inherent data may include, for example, an employee's name, age, status, position, address, etc. A second layer 2902 may be considered the business object's logic. Thus, the layer 2902 includes the rules for consistently embedding the business object in a system environment as well as constraints defining values and domains applicable to the business object. For example, one such constraint may limit sale of an item only to a customer with whom a company has a business relationship. A third layer 2903 includes validation options for accessing the business object. For example, the third layer 2903 defines the business object's interface that may be interfaced by other business objects or applications. A fourth layer 2904 is the access layer that defines technologies that may externally access the business object.

Accordingly, the third layer 2903 separates the inherent data of the first layer 2901 and the technologies used to access the inherent data. As a result of the described structure, the business object reveals only an interface that includes a set of clearly defined methods. Thus, applications access the business object via those defined methods. An application wanting access to the business object and the data associated therewith usually includes the information or data to execute the clearly defined methods of the business object's interface. Such clearly defined methods of the business object's interface represent the business object's behavior. That is, when the methods are executed, the methods may change the business object's data. Therefore, an application may utilize any business object by providing the information or data without having any concern for the details related to the internal operation of the business object. Returning to method 2800, a service provider class and data dictionary elements are generated within a development environment at step 2803. In step 2804, the service provider class is implemented within the development environment.

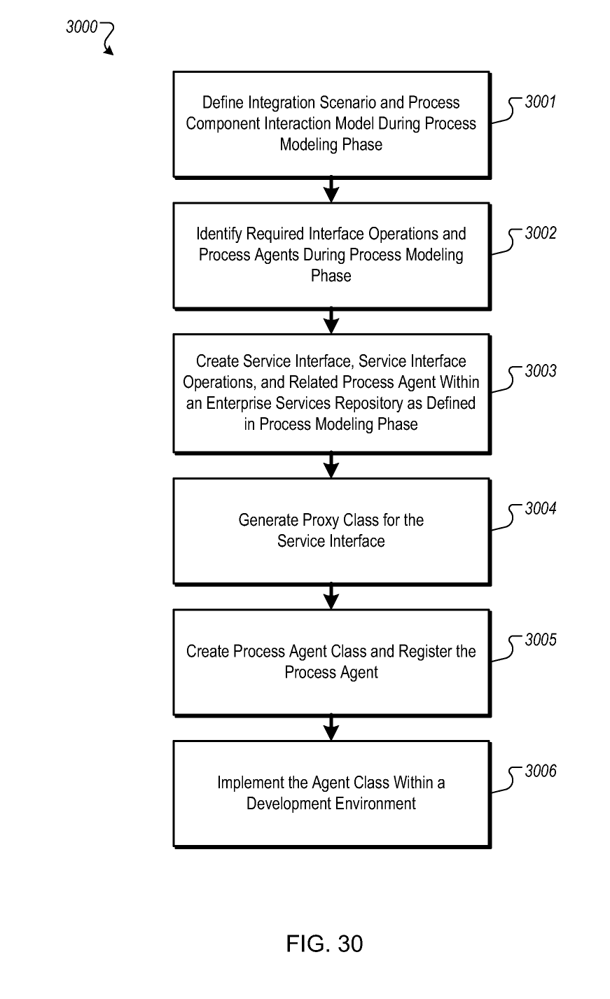

FIG. 30 illustrates an example method 3000 for a process agent framework. For example, the process agent framework may be the basic infrastructure to integrate business processes located in different deployment units. It may support a loose coupling of these processes by message based integration. A process agent may encapsulate the process integration logic and separate it from business logic of business objects. As shown in FIG. 30, an integration scenario and a process component interaction model are defined during a process modeling phase in step 3001. In step 3002, required interface operations and process agents are identified during the process modeling phase also. Next, in step 3003, a service interface, service interface operations, and the related process agent are created within an enterprise services repository as defined in the process modeling phase. In step 3004, a proxy class for the service interface is generated. Next, in step 3005, a process agent class is created and the process agent is registered. In step 3006, the agent class is implemented within a development environment.

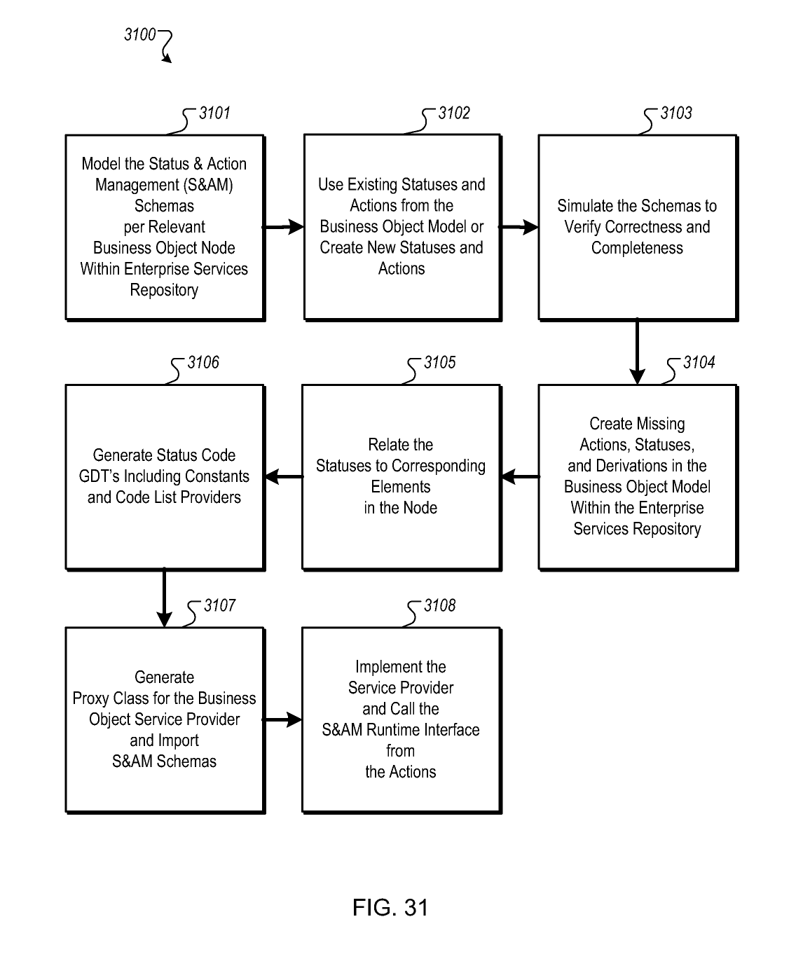

FIG. 31 illustrates an example method 3100 for status and action management (S&AM). For example, status and action management may describe the life cycle of a business object (node) by defining actions and statuses (as their result) of the business object (node), as well as, the constraints that the statuses put on the actions. In step 3101, the status and action management schemas are modeled per a relevant business object node within an enterprise services repository. In step 3102, existing statuses and actions from the business object model are used or new statuses and actions are created. Next, in step 3103, the schemas are simulated to verify correctness and completeness. In step 3104, missing actions, statuses, and derivations are created in the business object model with the enterprise services repository. Continuing with method 3100, the statuses are related to corresponding elements in the node in step 3105. In step 3106, status code GDT's are generated, including constants and code list providers. Next, in step 3107, a proxy class for a business object service provider is generated and the proxy class S&AM schemas are imported. In step 3108, the service provider is implemented and the status and action management runtime interface is called from the actions.

Regardless of the particular hardware or software architecture used, the disclosed systems or software are generally capable of implementing business objects and deriving (or otherwise utilizing) consistent interfaces that are suitable for use across industries, across businesses, and across different departments within a business in accordance with some or all of the following description. In short, system 100 contemplates using any appropriate combination and arrangement of logical elements to implement some or all of the described functionality.

Moreover, the preceding flowcharts and accompanying description illustrate example methods. The present services environment contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, the services environment may use methods with additional steps, fewer steps, and/or different steps, so long as the methods remain appropriate.

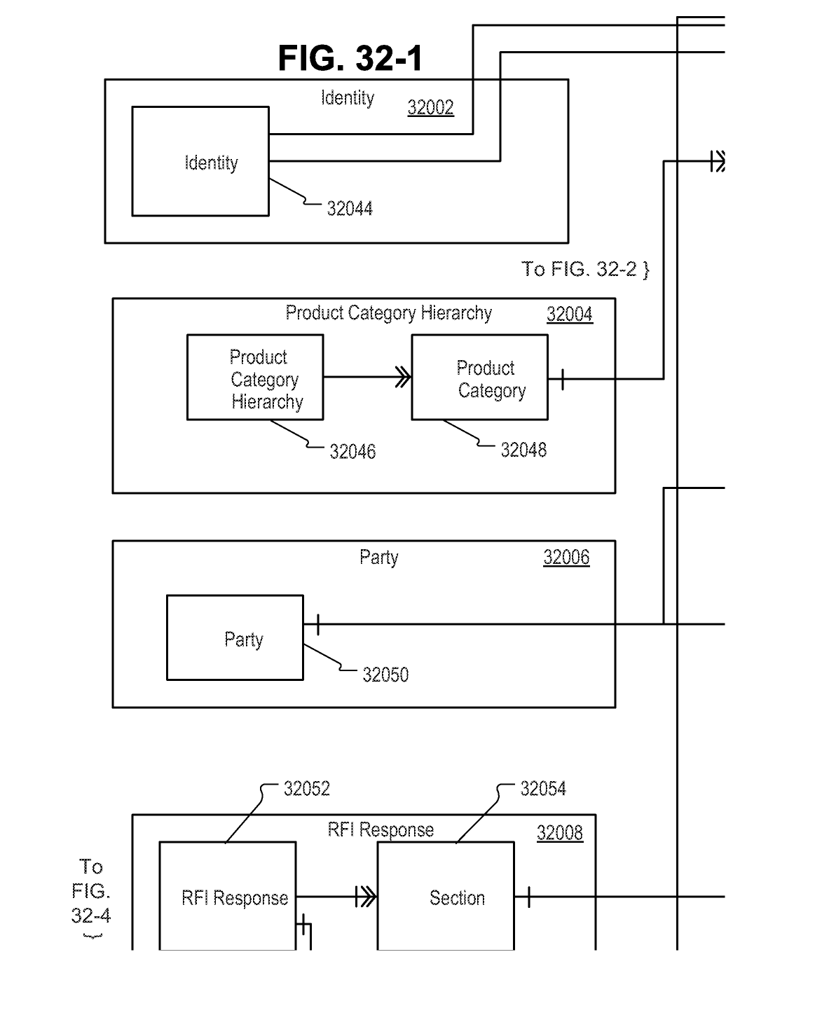

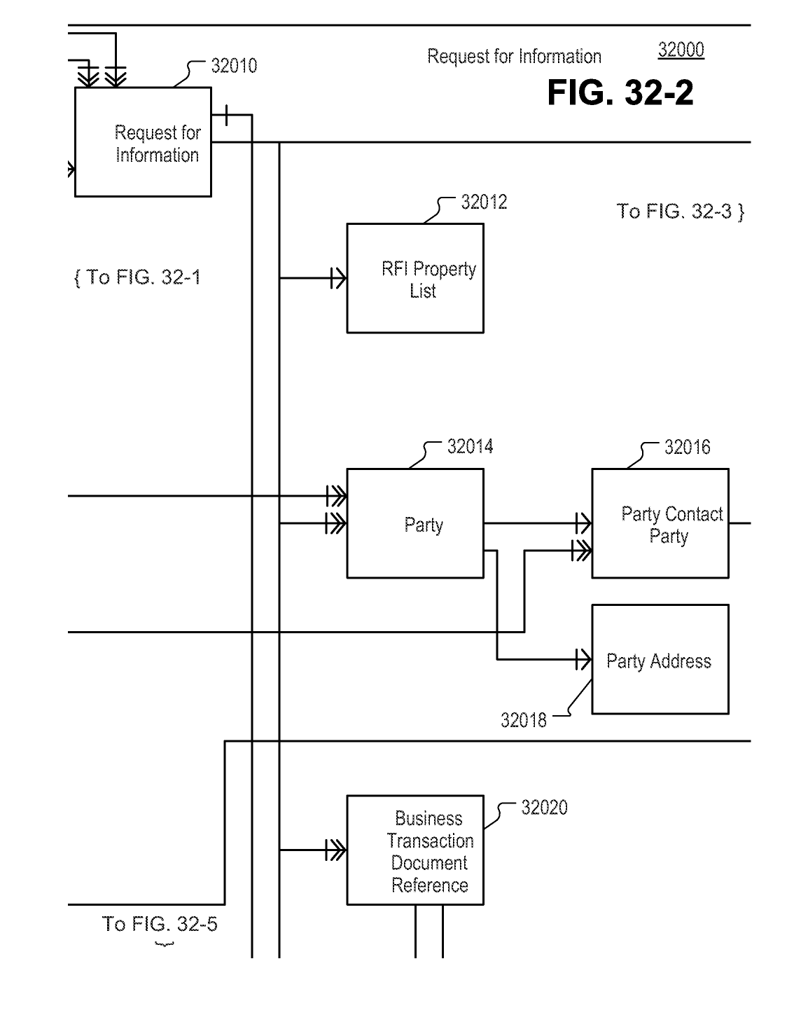

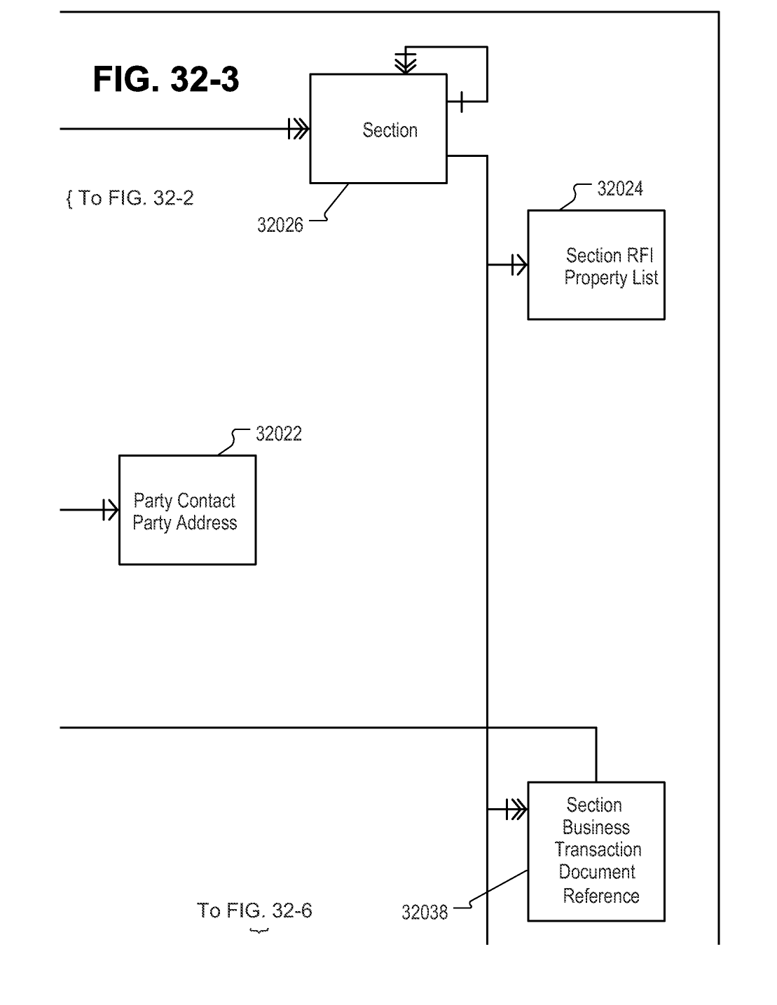

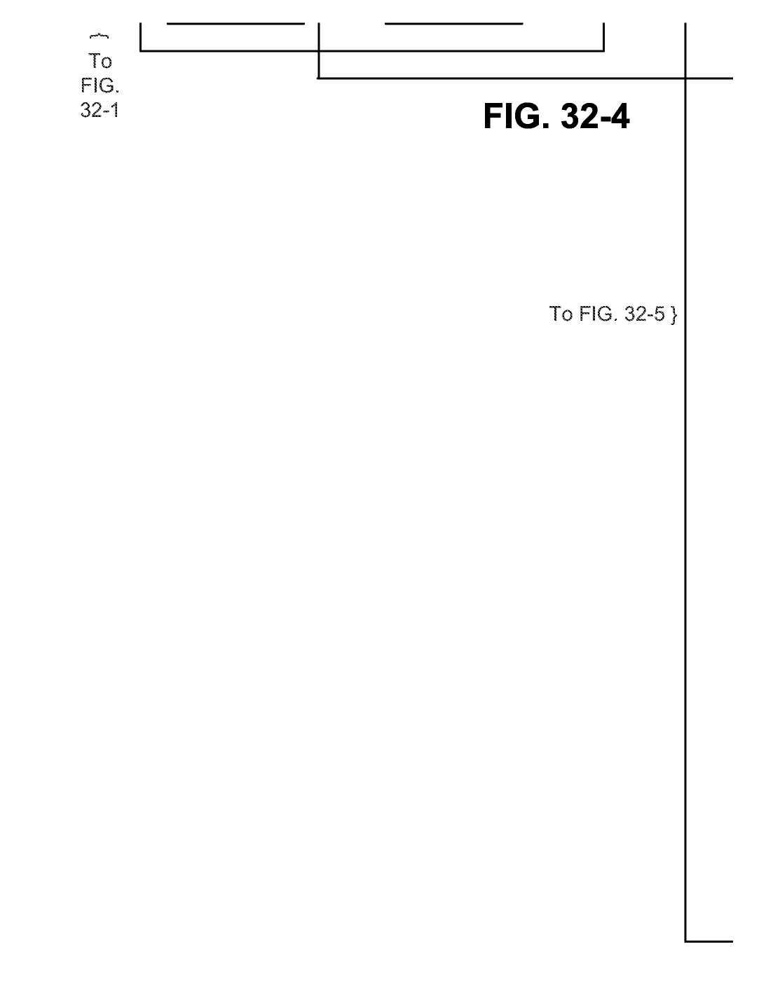

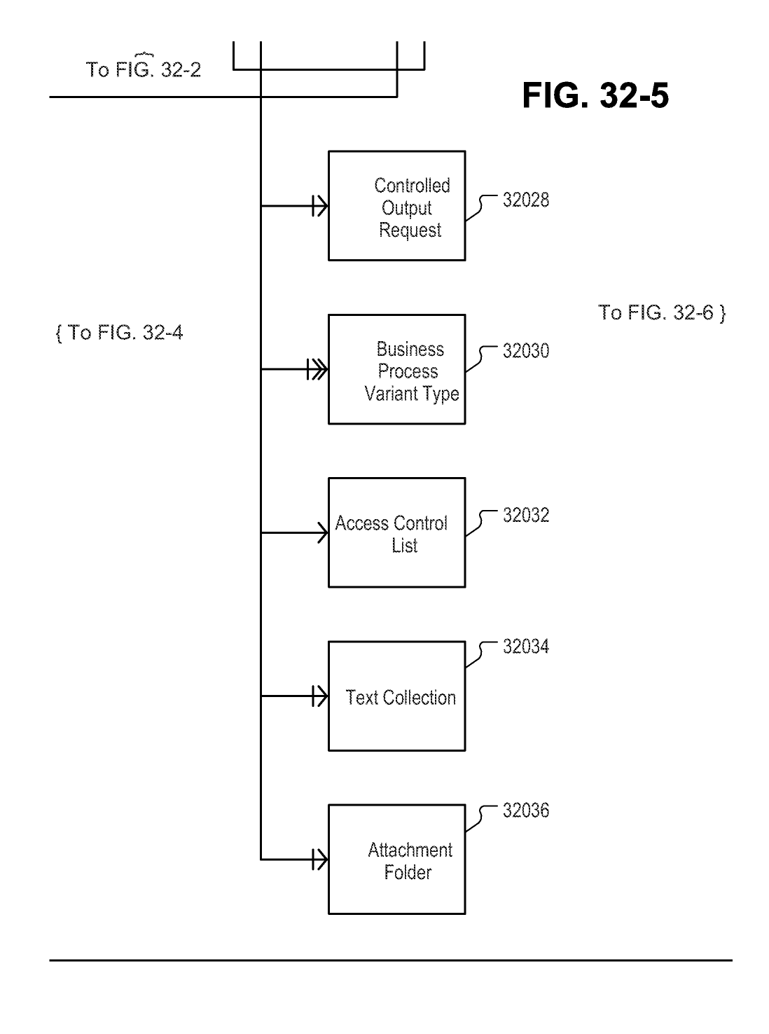

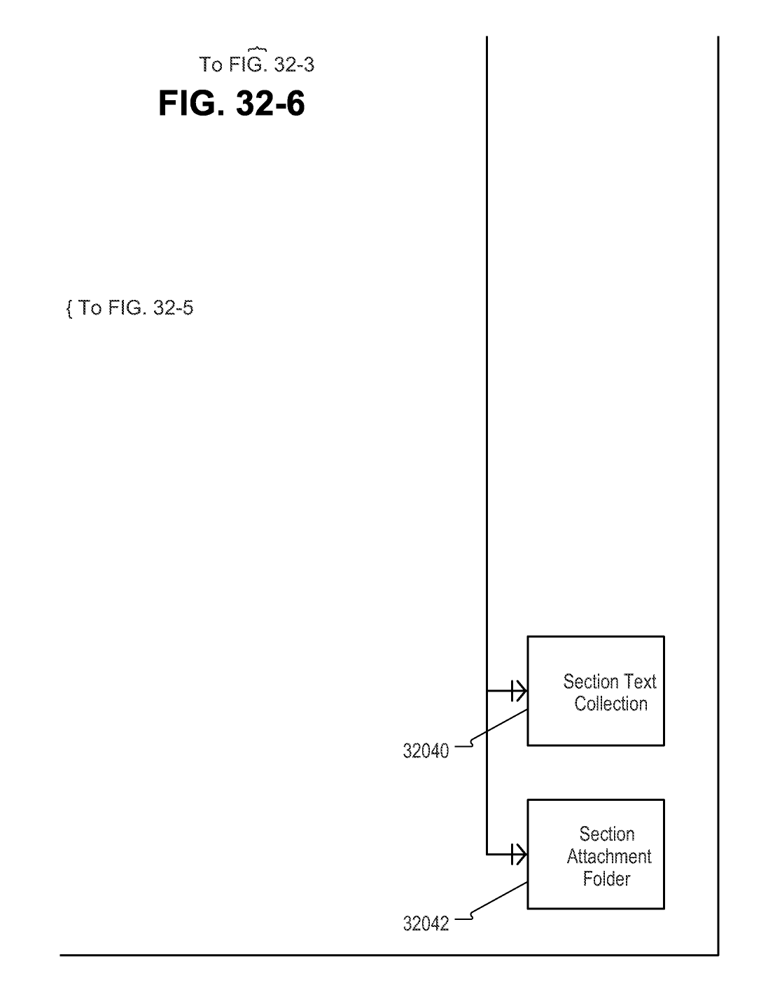

FIGS. 32-1 through 32-6 depict an example object model for a business object Request for Information 32000. The business object 32000 has relationships with other objects 32002-32008, as shown with lines and arrows. The business object 32000 hierarchically comprises elements 32010-32042. The other objects 32002-32008 include respective elements 32044-32054 as shown.

A business object Request for Information is a request from a buyer to existing and/or potential suppliers to provide information about their capabilities. The business object Request for Information can belong to the process component Request for Information Processing. The Request for Information can be addressed to a broader range of potential suppliers for the purpose of supply market research, developing a strategy, preparing further steps (request for quote), or collecting data about suppliers and their strategy and focus. A company planning the outsourcing of a large software development project can request information from new suppliers and suppliers they are already doing business with about the supplier's capabilities in such projects, such as, software development environments they have experience with or available resources. The Request for Information includes a root node with general information, dates, involved parties, main texts, attachments, and questions. The Request for Information includes a hierarchy of section nodes that can contain texts, attachments, and questions. In some implementations, there are three possibilities to add questions to a Request for Information: on a root level, on a section level, or both on a root and a section level. In some implementations, the Request for Information is involved in the following Process Component Interaction Models: Request for Information Processing_IForm Lead/Opportunity Processing at Supplier or Request for Information Processing_Lead/Opportunity Processing at Supplier.

The Request for Information Root Node can be a request from a buyer to existing and/or potential suppliers to provide specific information about their capabilities. The Request for Information Root Node can include the identification information of the document as well as name and general categorization criteria. The Request for Information Root Node can be time dependent on Time Point. The elements located directly at the Request for Information Root Node can be defined by the data type RequestForInformationElements. These elements can include: an ID, a UUID, a Name, a SupplierGroupCode, and a ProductCategory. The ID can be an alternative key. The ID is an identifier for a Request for Information and can be based on datatype GDT: BusinessTransactionDocumentID. The UUID can be an alternative key. The UUID is a globally unique identifier for a Request for Information and can be based on datatype GDT: UUID. The Name can be optional. The Name is the name of the Request for Information and can be based on datatype GDT: MEDIUM_Name. The SupplierGroupCode can be optional. The SupplierGroupCode is a coded representation of a group of suppliers according to subjective criteria. The Request for Information is intended for the specified group of suppliers and can be based on datatype GDT: SupplierGroupCode. In some implementations, a group of suppliers is used in SupplyBaseManagement to support strategic buyers during the evaluation and introduction of new, potential suppliers. Using the SupplierGroupCode and based on own criteria, buyers arrange suppliers in different groups. The ProductCategory can be optional. The ProductCategory is a product category the Request for Information is about and can be based on datatype BOIDT: RequestForInformationProductCategory.

The ProductCategory can include a UUID, an IDKey, a ProductCategoryHierarchyID, and a ProductCategoryInternalID. The UUID is a globally unique identifier of a product category and can be based on datatype GDT: UUID. The IDKey is an identifier key of a product category and can be based on datatype KDT: ProductCategoryHierarchyProductCategoryIDKey. The ProductCategoryHierarchyID is an identifier for a product category hierarchy and can be based on datatype GDT: ProductCategoryHierarchyID. The ProductCategoryInternalID is an identifier for a product category and can be based on datatype GDT: ProductCategoryInternalID.

Requests for Information can be categorized by product categories for referencing purposes. The product categories can include TimeSettings, Status, and SystemAdministrativeData. The TimeSettings can be optional. The TimeSettings are settings that are relevant for the timing of a Request for Information process. The TimeSettings include the elements that are defined by the data type RequestForInformationTimeSettings and can be based on datatype BOIDT: RequestForInformationTimeSettings. The TimeSettings can include a SubmissionPeriod. The SubmissionPeriod is the period in which a Request for Information response can be submitted and can be based on datatype GDT: UPPEROPEN_LOCALNORMALISED_DateTimePeriod, with a qualifier of Submission. The Status is information about the lifecycle of the Request for Information, the results, and the prerequisites for its processing steps. The Status includes the elements that are defined by the data type Request for Information Status Elements and can be based on datatype BOIDT: RequestForInformationStatus. The Status can include ConsistencyStatusCode, CancellationStatusCode, PublishingStatusCode, ClosureStatusCode, and LifeCycleStatusCode. The ConsistencyStatusCode is a coded representation of the consistency status of a Request for Information after a check process. The ConsistencyStatusCode can be a Boolean status variable, which can either be consistent or inconsistent, depending on whether the check process returned error messages or not, that is, whether the business object is consistent and error-free and can be based on datatype GDT: ConsistencyStatusCode. In some implementations, the consistency status is essential for publishing the Request for Information. For example, in order to be published, a Request for Information can be consistent. This is ensured by a required precondition from Consistent to Publish. In some implementations, the element is restricted to the following code values: 2—Inconsistent and 3—Consistent. The CancellationStatusCode is a coded representation of the cancellation status of a Request for Information that describes whether the business transaction for a Request for Information is canceled and can be based on datatype GDT: CancellationStatusCode. The status value Canceled finishes the Request for Information business transaction. In some implementations, the element is restricted to the following code values: 1—Not Canceled and 4—Canceled. The PublishingStatusCode is a coded representation of the publishing status of a Request for Information that specifies whether the Request for Information has already been sent to the assigned suppliers or is still in preparation and can be based on datatype GDT: PublishingStatusCode. In some implementations, the element is restricted to the following code values: 1—Not Published and 2—Published. The ClosureStatusCode is a coded representation of the closure status of a Request for Information that describes whether the business transaction for the Request for Information is closed or not. In some implementations, if a Request for Information is closed, this means that all Request for Information processes associated with the Request for Information are finished and can be based on datatype GDT: ClosureStatusCode. The LifeCycleStatusCode is a coded representation of the life cycle status of a Request for Information, which describes the current state of the Request for Information and can be based on datatype GDT: RequestForInformationLifeCycleStatusCode. A life cycle status is a status that denotes a prominent stage of a life cycle. A life cycle is a series of prominent stages through which an object can pass during its lifetime. A possible sequence of the stages is determined by the constraints under which an object can pass from one stage to another. The Request for Information Life Cycle status is derived from the Publishing, Cancellation, and Closure status variables. The SystemAdministrativeData is administrative data that includes system users and change dates/times and can be based on datatype GDT: SystemAdministrativeData.

The following composition relationships to subordinate nodes can exist: Section, with a cardinality of 1:CN, Request for Information Property List, with a cardinality of 1:C, Party, with a cardinality of 1:CN, Business Transaction Document Reference, with a cardinality of 1:CN, Controlled Output Request, with a cardinality of 1:C, Business Process Variant Type, with a cardinality of 1:CN, Access Control List, with a cardinality of 1:1, Text Collection, with a cardinality of 1:C, and Attachment Folder, with a cardinality of 1:C. A Request for Information Root Node inbound aggregation relationship can exist from the business object Product Category Hierarchy/node Product Category. The relationship with the Product Category can have a cardinality of C:CN. The Product Category can be the product category that classifies the whole Request for Information. A Request for Information Root Node inbound association relationship can exist from the business object Identity/node Identity. The association relationship with Last Change Identity can have a cardinality of 1:CN. The Last Change Identity can be the Identity that changed the Request for Information in the last time. The association relationship with Creation Identity can have a cardinality of 1:CN. The Creation Identity can be the Identity that created the Request for Information.

The Request for Information Root Node can include the following Specialization Associations for Navigation: to Section node, to node Party, to node BusinessTransactionDocumentReference, and to the BusinessProcessVariantType node. The Specialization Association for Navigation to Section node can be to a Top Level Section with a target cardinality of CN. The Top Level Section association can be an association to sections that are semantically associated with the root as parent; other sections with a parent section in Hierarchy Relationship are subordinate sections. The Specialization Association for Navigation to node Party can be to an Employee Responsible Party with a target cardinality of C, a Responsible Purchasing Unit Party with a target cardinality of C, a Seller Party with a target cardinality of CN, a Buyer Party with a target cardinality of C, or an Other Party with a target cardinality of CN. The Employee Responsible Party is a party that is responsible for the creation of the Request for Information, its publishing as well as the evaluation and comparison of received Request for Information responses. The Responsible Purchasing Unit Party is a party that is responsible for the Request for Information process. The Seller Party is a party that provides the information that is requested in a Request for Information. The Buyer Party is a party on behalf of which a Request for Information is created. The Other Party is a party that is informed about the Request for Information process without necessarily having any specific responsibilities in the process. The Specialization Association for Navigation to node BusinessTransactionDocumentReference can be to a Base Request for Information Reference with target cardinality of C, a Request for Information Reference with a target cardinality of CN, or a Request for Information Response reference: target cardinality of CN. The Base Request for Information Reference association is an association to a Request for Information Business Transaction Document reference to Request for Information that is a predecessor document of the Request for Information. The Request for Information Reference association is an association to requests for information Business Transaction Document references that refer to follow up Requests for Information of the Request for Information. The Request for Information Response reference association is an association to Request for Information Business Transaction Document references that refer to Request for Information responses received for the Request for Information. The Specialization Association for Navigation to the BusinessProcessVariantType node can be to a MainBusinessProcessVariantType with a target cardinality of C. The MainBusinessProcessVariantType association can be an association to a business process variant type that is the main business process variant type.

In some implementations, the ID is not changed after creation. In some implementations, the UUID is determined by the service provider and is not changed. In some implementations, the SystemAdministrativeData is determined by the service provider and is not changed. In some implementations, once a Request for Information is published, the Request for Information is not changed. In some implementations, a complete Request for Information includes one Buyer Party, one Employee Responsible Party, one Responsible Purchasing Unit Party, and at least one Seller Party.

The Request for Information Root Node can include Enterprise Service Infrastructure Actions. The Enterprise Service Infrastructure Actions can include the following actions: Create with Reference, Create Copy with Reference, Publish action, Cancel action, and Close action. The Create with Reference action can create a Request for Information based on information from other business object instances passed as reference. The Create with Reference action accepts a Request for Information reference as referencing nodes parameter to create a follow-up Request for Information for the referenced Request for Information. The referenced Request for Information is maintained as Base Request for Information Reference in the Business Transaction Document Reference node. The Create with Reference action accepts references to business objects Supplier and Prospect Supplier to create a Request for Information with the referenced business partners as seller party. In some implementations, the Create with Reference action creates a Request for Information from a Request for Information template when available. The Create with Reference action creates a new Request for Information. If a Request for Information is created with reference to another Request for Information follow-up, a business transaction document reference to the predecessor can be maintained at the follow-up document. If a Request for Information is created with reference to another Request for Information follow-up, a business transaction document reference to the follow-up document can be maintained at the predecessor document. The status of the newly created Request for Information can be set to its initial values.

The Create Copy with Reference action can create a Request for Information based on information from another Request for Information passed as reference. Main data and section structure, texts, attachments, properties, and parties can be copied from the referenced Request for Information. In some implementations, no references are maintained between the Request for Information and the copy of it. A new Request for Information is created. The status of the newly created Request for Information can be set to its initial values. The Publish action can trigger the sending of a Request for Information to the assigned suppliers or to publish it. The action can require the consistency status to be set to Consistent. The action sets the Publishing status to Published. In some implementations, the Publish action requires that the document is consistent and error free and has not been published yet. The Publish action can set the Publishing status. For example, the Publishing status can be set to Published. The Cancel action cancels an already published Request for Information before the submission deadline is reached. A cancellation can be possible if a Request for Information has been published. In some implementations, if a submission deadline is specified, the submission deadline must not have been reached yet. In some implementations, if no submission deadline is specified, cancellation is only possible if it the Request for Information has not been closed yet. The Cancel action can set the Cancellation status. For example, the Cancellation status can be set to Canceled. The Close action is an action that ends the life cycle of the Request for Information and all associated responses by setting the closure status to closed. In some implementations, closing a Request for Information is not possible if the Request for Information has not been published yet. In some implementations, if a submission deadline has been specified, closing a Request for Information is possible if the Request for Information has been published and the specified submission deadline has already been reached. In some implementations, no changes are allowed after closure. The Close action can set the Closure status. For example, the Closure status is set to closed. In some implementations, all associated Request for Information responses are closed as well.

The Request for Information Root Node can include Queries. Queries can include Query by Elements and Select All. Select All can return the node IDs of all instances of a node. Select All can be used to enable the initial load of data for the Fast Search Infrastructure. Query by Elements can return a list of Requests for Information according to the specified selection elements. The query elements are defined by the data type RequestForInformationElementsQueryElements. These elements can include: SearchText, ID, Name, TimeSettings, Status, ProductCategoryIDKey, SupplierGroupCode, BuyerPartyPartyKey, EmployeeResponsiblePartyPartyKey, ResponsiblePurchasingUnitPartyPartyKey, SellerPartyPartyKey, InterestedPartyPartyKey, and SystemAdministrativeData. The SearchText can be optional. The SearchText can be a text that is searched for in all search parameters and can be based on datatype GDT: SearchText. The ID can be optional. The ID can be an identifier of a Request for Information and can be based on datatype GDT: BusinessTransactionDocumentID. The Name can be optional. The Name can be a name of a Request for Information and can be based on datatype GDT: MEDIUM_Name. The TimeSettings can be optional. The TimeSettings can be settings that are relevant for the timing of the Request for Information process and can be based on datatype BOIDT: RequestForInformationTimeSettings. The TimeSettings can include a SubmissionPeriod. The SubmissionPeriod is the period in which a Request for Information response must be submitted and can be based on datatype GDT: UPPEROPEN_LOCALNORMALISED_DateTimePeriod, with a qualifier of Submission.

The Status can be optional. The Status can be Information about the status of a Request for Information and can be based on datatype BOIDT: RequestForInformationStatus. The Status can include the following elements: ConsistencyStatusCode, CancellationStatusCode, PublishingStatusCode, ClosureStatusCode, and LifeCycleStatusCode. The ConsistencyStatusCode is a coded representation of the consistency status of a Request for Information after a check process. The ConsistencyStatusCode can be a Boolean status variable, which can either be consistent or inconsistent, depending on whether the check process returned error messages or not, that is, whether the business object is consistent and error-free and can be based on datatype GDT: ConsistencyStatusCode. In some implementations, in order to be published, a Request for Information is consistent. Consistency can be ensured by a required precondition from Consistent to Publish. In some implementations, the ConsistencyStatusCode is restricted to the following code values: 2—Inconsistent and 3—Consistent. The CancellationStatusCode is a coded representation of the cancellation status of a Request for Information that describes whether the business transaction for a Request for Information is canceled and can be based on datatype GDT: CancellationStatusCode. The status value Canceled can finish the Request for Information business transaction. In some implementations, the CancellationStatusCode is restricted to the following code values: 1—Not Canceled and 4—Canceled. The PublishingStatusCode is a coded representation of the publishing status of a Request for Information that specifies whether the Request for Information has already been sent to the assigned suppliers or is still in preparation and can be based on datatype GDT: PublishingStatusCode. In some implementations, the PublishingStatusCode is restricted to the following code values: 1—Not Published and 2—Published. The ClosureStatusCode is a coded representation of the closure status of a Request for Information that describes whether the business transaction for a Request for Information is closed or not. In some implementations, if a Request for Information is closed, this means that all Request for Information processes associated with the Request for Information are finished. The ClosureStatusCode can be based on datatype GDT: ClosureStatusCode. The LifeCycleStatusCode is a coded representation of the life cycle status of a Request for Information, which describes the current state of the Request for Information and can be based on datatype GDT: RequestForInformationLifeCycleStatusCode. A life cycle status can be a status that denotes a prominent stage of a life cycle. A life cycle can be a series of prominent stages through which an object can pass during its lifetime. A possible sequence of the stages can be determined by the constraints under which an object can pass from one stage to another. The Request for Information Life Cycle status can be derived from the Publishing, Cancellation and Closure status variables.

The ProductCategoryIDKey can be optional. The ProductCategoryIDKey is a grouping of elements that uniquely identifies a product category by product category hierarchy ID and product category internal ID and can be based on datatype KDT: ProductCategoryHierarchyProductCategoryIDKey. The ProductCategoryIDKey can include the following elements: ProductCategoryHierarchyID and ProductCategoryInternalID. The ProductCategoryHierarchyID is an identifier for a product category hierarchy and can be based on datatype GDT: ProductCategoryHierarchyID. The ProductCategoryInternalID is an identifier for a product category and can be based on datatype GDT: ProductCategoryInternalID. The SupplierGroupCode can be optional. The SupplierGroupCode is a search parameter to find a Request for Information by the Supplier Group Code and can be based on datatype GDT: SupplierGroupCode. A group of suppliers can be used in SupplyBaseManagement to support strategic purchasers during the evaluation and introduction of new, potential suppliers. By the means of the SupplierGroupCode and based on own criteria, the purchasers can arrange the suppliers in different groups. The BuyerPartyPartyKey can be optional. The BuyerPartyPartyKey is a grouping of elements that uniquely identifies a buyer party by party type code and party ID and can be based on datatype KDT: PartyKey. The BuyerPartyPartyKey can include PartyTypeCode and PartyID. The PartyTypeCode can be optional. The PartyTypeCode is a coded representation of a type of party and can be based on datatype GDT: BusinessObjectTypeCode. The PartyID can be optional. The PartyID is an identifier for a party and can be based on datatype GDT: PartyID. The EmployeeResponsiblePartyPartyKey can be optional. The EmployeeResponsiblePartyPartyKey is a grouping of elements that uniquely identifies an employee responsible party by party type code and party ID and can be based on datatype KDT: PartyKey. The EmployeeResponsiblePartyPartyKey can include PartyTypeCode and PartyID. The PartyTypeCode can be optional. The PartyTypeCode is a coded representation of a type of party and can be based on datatype GDT: BusinessObjectTypeCode. The PartyID can be optional. The PartyID is an identifier for a party and can be based on datatype GDT: PartyID. The ResponsiblePurchasingUnitPartyPartyKey can be optional. The ResponsiblePurchasingUnitPartyPartyKey is a grouping of elements that uniquely identifies a purchasing unit party by party type code and party ID and can be based on datatype KDT: PartyKey. The ResponsiblePurchasingUnitPartyPartyKey can include PartyTypeCode and PartyID. The PartyTypeCode can be optional. The PartyTypeCode is a coded representation of a type of party and can be based on datatype GDT: BusinessObjectTypeCode. The PartyID can be optional. The PartyID is an identifier for a party and can be based on datatype GDT: PartyID. The SellerPartyPartyKey can be optional. The SellerPartyPartyKey is a grouping of elements that uniquely identifies a seller party by party type code and party ID and can be based on datatype KDT: PartyKey. The SellerPartyPartyKey can include PartyTypeCode and PartyID. The PartyTypeCode can be optional. The PartyTypeCode is a coded representation of a type of party and can be based on datatype GDT: BusinessObjectTypeCode. The PartyID can be optional. The PartyID is an identifier for a party and can be based on datatype GDT: PartyID. The InterestedPartyPartyKey can be optional. The InterestedPartyPartyKey is a grouping of elements that uniquely identifies an interested party by party type code and party ID and can be based on datatype KDT: PartyKey. The InterestedPartyPartyKey can include PartyTypeCode and PartyID. The PartyTypeCode can be optional. The PartyTypeCode is a coded representation of a type of party and can be based on datatype GDT: BusinessObjectTypeCode. The PartyID can be optional. The PartyID is an identifier for a party and can be based on datatype GDT: PartyID.

The SystemAdministrativeData can be optional. The SystemAdministrativeData is a search parameter to find requests for information by creator, creation time, last changer, and last change time. The SystemAdministrativeData can be based on the datatype QueryIDT: QueryElementSystemAdministrativeData. The SystemAdministrativeData can include CreationDateTime, CreationIdentityUUID, CreationIdentityID, CreationIdentityBusinessPartnerInternalID, CreationIdentityBusinessPartnerPersonFamilyName, CreationIdentityBusinessPartnerPersonGivenName, CreationIdentityEmployeeID, LastChangeDateTime, LastChangeIdentityUUID, LastChangeIdentityID, LastChangeIdentityBusinessPartnerInternalID, LastChangeIdentityBusinessPartnerPersonFamilyName, LastChangeIdentityBusinessPartnerPersonGivenName, and LastChangeIdentityEmployeeID. The CreationDateTime can be optional. The CreationDateTime is the point in time that the goods tag is created date and time stamp and can be based on datatype GDT: GLOBAL_DateTime. The CreationIdentityUUID can be optional. The CreationIdentityUUID is a globally unique identifier for the person who did the creation and can be based on datatype GDT: UUID. The CreationIdentityID can be optional. The CreationIdentityID is an identifier for the person who did the creation and can be based on datatype GDT: IdentityID. The CreationIdentityBusinessPartnerInternalID can be optional. The CreationIdentityBusinessPartnerInternalID is a proprietary identifier for the business partner that is attributed to the creation identity and that can be reached following the relationships of the creation identity and can be based on datatype GDT: BusinessPartnerInternalID. The CreationIdentityBusinessPartnerPersonFamilyName can be optional. The CreationIdentityBusinessPartnerPersonFamilyName is the family name of the business partner of the category person that is attributed to the creation identity and that can be reached following the relationships of the creation identity and can be based on datatype GDT: LANGUAGEINDEPENDENT_MEDIUM_Name. The CreationIdentityBusinessPartnerPersonGivenName can be optional. The CreationIdentityBusinessPartnerPersonGivenName is the given name of the business partner of the category person that is attributed to the creation identity and that can be reached following the relationships of the creation identity and can be based on datatype GDT: LANGUAGEINDEPENDENT_MEDIUM_Name. The CreationIdentityEmployeeID can be optional. The CreationIdentityEmployeeID is an identifier for the employee that is attributed to the creation identity and that can be reached following the relationships of the creation identity and can be based on datatype GDT: EmployeeID. The LastChangeDateTime can be optional. The LastChangeDateTime is the point in time date and time stamp of the last change and can be based on datatype GDT: GLOBAL_DateTime. The LastChangeIdentityUUID can be optional. The LastChangeIdentityUUID is a globally unique identifier for an identity who made the last changes and can be based on datatype GDT: UUID. The LastChangeIdentityID can be optional. The LastChangeIdentityID is an identifier for an identity who made the last changes and can be based on datatype GDT: IdentityID. The LastChangeIdentityBusinessPartnerInternalID can be optional. The LastChangeIdentityBusinessPartnerInternalID is a proprietary identifier for the business partner that is attributed to the last change identity and that can be reached following the relationships of the last change identity and can be based on datatype GDT: BusinessPartnerInternalID. The LastChangeIdentityBusinessPartnerPersonFamilyName can be optional. The LastChangeIdentityBusinessPartnerPersonFamilyName is the family name of the business partner of the category person that is attributed to the last change identity and that can be reached following the relationships of the last change identity and can be based on datatype GDT: LANGUAGEINDEPENDENT_MEDIUM_Name. The LastChangeIdentityBusinessPartnerPersonGivenName can be optional. The LastChangeIdentityBusinessPartnerPersonGivenName is the given name of the business partner of the category person that is attributed to the last change identity and that can be reached following the relationships of the last change identity and can be based on datatype GDT: LANGUAGEINDEPENDENT_MEDIUM_Name. The LastChangeIdentityEmployeeID can be optional. The LastChangeIdentityEmployeeID is an identifier for the employee that is attributed to the last change identity and that can be reached following the relationships of the last change identity and can be based on datatype GDT: EmployeeID.

A Section is a subtopic in a Request for Information. Sections can be structured in a hierarchical way by creating subsections. Section is the usual business term instead of Item in the context of a Request for Information. The Section includes all texts, attachments and properties for a defined subtopic of a Request for Information. The elements located directly at the node Section are defined by the data type RequestForInformationSectionElements. These elements can include: ID, UUID, FormattedID, OrdinalNumberValue, and HierarchyRelationship. The ID is a unique identifier for a Request for Information section and can be based on datatype GDT: BusinessTransactionDocumentItemID. The UUID can be an alternative key. The UUID is a globally unique identifier for a Request for Information section and can be based on datatype GDT: UUID. The FormattedID is an identifier for a Request for Information section that is unique and human-readable and can be based on datatype GDT: RequestForInformationSectionFormattedID. The OrdinalNumberValue is a value that indicates the position of a section in a linearly ordered set of sections with the same parent and can be based on datatype GDT: OrdinalNumberValue. The HierarchyRelationship can be optional. The HierarchyRelationship is the relationship between a sub-section and a higher-level parent section in a section hierarchy and can be based on datatype BOIDT: RequestForInformationSectionHierarchyRelationship. The HierarchyRelationship can include ParentSectionUUID. The ParentSectionUUID is a globally unique identifier for the hierarchically superior Request for Information section and can be based on datatype GDT: UUID. In some implementations, if the section does not have a parent section, it is on the first hierarchy level. The following composition relationships to subordinate nodes can exist: Section Request for Information Property List with a cardinality of 1:C, Section Business Transaction Document Reference with a cardinality of 1:CN, Section Text Collection with a cardinality of 1:C, and Section Attachment Folder with a cardinality of 1:C. A Section inbound association relationship can exist from the business object Request for Information/node Section. The association relationship with the Parent Section can have a cardinality of C:CN. The parent section of a section is the hierarchically superordinate section. In some implementations, if a section is not associated with a parent section, it is at the top most level. A Section can have Specialization Associations for Navigation. The Specialization Associations for Navigation can include to node Section and to node SectionBusinessTransactionDocumentReference. The to node Section can be to a Sub Section with a target cardinality CN. In some implementations, Specialization association can be directly to subordinate sections. The to node SectionBusinessTransactionDocumentReference can be to a Request for Information Response Section Reference with a target cardinality of CN.

A Section Request for Information Property List dependent object inclusion node is a list of pre-defined properties for a Request for Information section. These properties are defined in the property library and referenced from Request for Information Property List. Attributes of the pre-defined properties can be added or changed in Request for Information Property List. A Section Business Transaction Document Reference is a unique reference between the Request for Information section and another business transaction document or business transaction document item. The BusinessTransactionDocumentReference can occur in the following incomplete and disjoint specializations: Request for Information Response Section Reference cn. The elements located directly at the node Section Business Transaction Document Reference are defined by the data type RequestForInformationSectionBusinessTransactionDocumentReferenceElements. These elements can include: BusinessTransactionDocumentReference and BusinessTransactionDocumentRelationshipRoleCode. The BusinessTransactionDocumentReference is a reference to another business document that is of significance within the Request for Information process for this section and can be based on datatype GDT: BusinessTransactionDocumentReference. The BusinessTransactionDocumentRelationshipRoleCode can be optional. The BusinessTransactionDocumentRelationshipRoleCode is a coded representation of the role that a business document has when it is set against the Request for Information section within a relationship and can be based on datatype GDT: BusinessTransactionDocumentRelationshipRoleCode. A Section Business Transaction Document Reference inbound association relationship can exist from the business object Request for Information Response/node Section. The association relationship with the Request for Information Response Section can have a cardinality of C:CN.

A Section Text Collection dependent object inclusion node is a collection of natural-language texts with additional information about a Request for Information section. Each text can be specified in different languages and can include formatting information. A Section Attachment Folder dependent object inclusion node is a folder for one or more documents in electronic form including additional information about a Request for Information section. A Request for Information Property List dependent object inclusion node is a list of pre-defined properties for a Request for Information. These properties can be defined in the property library and referenced from the Request for Information Property List. Attributes of the pre-defined properties can be added or changed in the Request for Information Property List. A Party is a natural or legal person, an organization, an organizational unit, or a group that is involved in a Request for Information in a party role. A Party can occur within the following complete and disjoint specializations: Seller Party, Buyer Party, Responsible Purchasing Unit Party, Employee Responsible Party, and Other Party. The Seller Party is a party that provides the information that is requested in a Request for Information. The Seller Party can have a contact person that creates and submits the Request for Information response. The contact person can be a business partner of the specialization BusinessPartner. The Buyer Party is a party on behalf of which a Request for Information is created. A BuyerParty can have a contact person. The Responsible Purchasing Unit Party is a party that is responsible for the Request for Information process. The Employee Responsible Party is a party that is responsible for the creation of the Request for Information, its publishing as well as the evaluation and comparison of received Request for Information responses. The Other Party is a party that is informed about the Request for Information process without necessarily having any specific responsibilities in the process. The Other Party can be involved in creation and publishing as well as the evaluation and comparison of received Request for Information responses. The Other Party role can be restricted to employees. The party can reference the following using the inbound aggregation relationship from the Party transformed object: a business partner or one of its specializations for example, customer, supplier, employee or one of the following specializations of an organizational center: company or functional unit. A party can exist without a reference to a business partner or an organizational unit. The external identifier and the description can be included in the business document.

The elements located directly at the node Party can be defined by the data type RequestForInformationPartyElements. These elements can include: UUID, PartyUUID, PartyTypeCode, RoleCategoryCode, RoleCode, AddressReference, DeterminationMethodCode, and PartyKey. The UUID can be an alternative key. The UUID is a globally unique identifier for the Request for Information party for referencing purposes and can be based on datatype GDT: UUID. The PartyUUID can be optional. The PartyUUID is a globally unique identifier for a business partner, the organizational center, or their specializations and can be based on datatype GDT: UUID. The PartyTypeCode can be optional. The PartyTypeCode is a coded representation of a type of business partner, organizational center, or their specializations referenced by the PartyUUID element and can be based on datatype GDT: BusinessObjectTypeCode. The RoleCategoryCode can be optional. The RoleCategoryCode is a coded representation of a role category of the party in the Request for Information and can be based on datatype GDT: PartyRoleCategoryCode. In some implementations, the RoleCategoryCode is restricted to the following code values: 1—Buyer Party, 2—Seller Party, 39—Employee Responsible Party, 75—Responsible Purchasing Unit Party, and 100—Other Party. The RoleCode is a coded representation of a role of the party in the Request for Information and can be based on datatype GDT: PartyRoleCode. The AddressReference can be optional. The AddressReference is a unique reference to the address of a party and can be based on datatype GDT: PartyAddressReference. The DeterminationMethodCode can be optional. The DeterminationMethodCode is a coded representation of the determination method of a party and can be based on datatype GDT: PartyDeterminationMethodCode. The PartyKey can be optional. The PartyKey is a grouping of elements that uniquely identifies a party by party type code and party ID and can be based on datatype KDT: PartyKey. The PartyKey can include PartyTypeCode and PartyID. The PartyTypeCode can be optional. The PartyTypeCode is a coded representation of a type of party and can be based on datatype GDT: BusinessObjectTypeCode. The PartyID can be optional. The PartyID is an identifier for a party and can be based on datatype GDT: PartyID. The following composition relationships to subordinate nodes can exist: Party Contact Party with a cardinality of 1:C, and Party Address with a cardinality of 1:C. A Party inbound aggregation relationship can exist from the business object Party/node Party with a cardinality of C:CN. The aggregation relationship can be referenced by the Party in Master Data.

The Party can include the following Specialization Associations for Navigation: to Used Address transformed object/Root node. The to Used Address transformed object/Root node can include UsedAddress with a target cardinality of C. The Used Address transformed object can represent a uniform way to access a party address of a procurement document, which can be a business partner address, an organization center address or an address specified within a procurement document. For the address used for the Party this can be: a referenced address of a master data object or the party address used by the composition relationship. The Party Address Host Type Code element can determine which of the addresses is used. The instance of the Used Address transformed object represents this address. In some implementations, the Party Type Code, Party Address UUID and Party Address Host Type Code elements can be used to determine the Node ID of the node in the master data object, which holds the composition relationship to the Address dependent object, which is represented by the Used Address transformed object. In some implementations, the following information is sent to the Used Address transformed object in the implemented association: the fact that it is a master data address and the Business Object Type Code, Business Object Node Type Code and Node ID of the Item Party node. These can be required if changes are made to the Used Address transformed object. In some implementations, if so, the Used Address transformed object copies the master data address, the changes are applied, and a corresponding Address dependent object is generated on the Item Party node by the Party Address composition relationship. In some implementations, the Business Object Type Code, Business Object Node Type Code and Node ID of the Item Party are communicated to the Used Address transformed object. Whether or not it is a referenced address can be included. In this implementation, the Used Address transformed object represents the Address dependent object that is integrated by the Party Address composition relationship on the Item Party node. In some implementations, if the PartyUUID exists, the PartyTypeCode must exist. In some implementations, Parties can only be referenced by the Party transformed object, which represents at least one of the following business objects: Company, Functional Unit, Supplier, Employee, and Business Partner.

A Party Contact Party is a natural person or organizational unit that can be contacted for the party. The contact can be a contact person or, for example, a secretary's office. In some implementations, communication data for the contact is available. The elements located at the node Party Contact Party can be defined by the data type RequestForInformationPartyContactPartyElements. These elements can include: UUID, PartyUUID, PartyTypeCode, AddressReference, DeterminationMethodCode, and PartyKey. The UUID can be an alternative key. The UUID is a globally unique identifier for the Request for Information party contact party and can be based on datatype GDT: UUID. The PartyUUID can be optional. The PartyUUID is a globally unique identifier for the contact in this party role in the Request for Information or master data object and can be based on datatype GDT: UUID. The PartyTypeCode can be optional. The PartyTypeCode is a coded representation of the type of business partner, organizational center, or their specializations referenced by the PartyUUID element and can be based on datatype GDT: BusinessObjectTypeCode. The AddressReference can be optional. The AddressReference is a reference to the address of the party contact and can be based on datatype GDT: PartyAddressReference. The DeterminationMethodCode can be optional. The DeterminationMethodCode is a coded representation of the determination method of the party contact and can be based on datatype GDT: PartyDeterminationMethodCode. The PartyKey can be optional. The PartyKey is a grouping of elements that uniquely identifies a party by party type code and party ID and can be based on datatype KDT: PartyKey. The PartyKey can include PartyTypeCode and PartyID. The PartyTypeCode can be optional. The PartyTypeCode is a coded representation of a type of party and can be based on datatype GDT: BusinessObjectTypeCode. The PartyID can be optional. The PartyID is an identifier for a party and can be based on datatype GDT: PartyID. The following composition relationships to subordinate nodes can exist: Party Contact Party Address with a cardinality of 1:C. A Party Contact Party inbound aggregation relationship can exist from the business object Party/node Party with a cardinality of C:CN. The aggregation relationship can be referenced by Contact Party in Master Data. The Party Contact Party can include the following Specialization Associations for Navigation: to Used Address transformed object/Root node. The to Used Address transformed object/Root node can include UsedAddress with a target cardinality of CN. The UsedAddress can be the address used for the contact party. A Party Contact Party Address dependent object inclusion node is a Request for Information specific address of the party contact. A Party Address dependent object inclusion node is a Request for Information specific address of the party.

A Business Transaction Document Reference is a unique reference between the Request for Information and another business transaction document or business transaction document item. The BusinessTransactionDocumentReference can occur in the following incomplete and disjoint specializations: Predecessor Request for Information Reference c, Follow Up Request for Information Reference cn, or Request for Information Response Reference cn. The Predecessor Request for Information Reference c is a reference to a Request for Information that is a predecessor of the Request for Information. The Follow Up Request for Information Reference cn is a reference to Requests for Information that are follow up documents of the Request for Information. The Request for Information Response Reference cn is a reference to Request for Information responses received for the Request for Information. The elements located at the node Business Transaction Document Reference can be defined by the data type RequestForInformationBusinessTransactionDocumentReferenceElements. These elements can include: BusinessTransactionDocumentReference and BusinessTransactionDocumentReferenceRoleCode. The BusinessTransactionDocumentReference is a reference to another business document that is of significance within the Request for Information process and can be based on datatype GDT: BusinessTransactionDocumentReference. The BusinessTransactionDocumentReferenceRoleCode can be optional. The BusinessTransactionDocumentReferenceRoleCode is a coded representation of the role that a business document has when it is set against a Request for Information within a relationship and can be based on datatype GDT: BusinessTransactionDocumentRelationshipRoleCode. A Business Transaction Document Reference inbound association relationship can exist from the business object Request for Information Response/node Request for Information Response with a cardinality of C:CN. A Business Transaction Document Reference inbound association relationship can exist from the business object Request for Information/node Request for Information with a cardinality of C:CN.

A Controlled Output Request dependent object inclusion node is a controller of output requests and processed output requests related to the Request for Information. Several output channels can be supported for sending out documents. A Business Process Variant Type is a representation of a typical way of processing a Request for Information within a process component, from a business point of view. A BusinessProcessVariantType can occur within the following specializations: MainBusinessProcessVariantType or AdditionalBusinessProcessVariantType. A business process variant can be a configuration of a process component. A business process variant can belong to one process component. A process component can be a software package that realizes a business process and exposes its functionality as services. The functionality can include business transactions. A process component can include one or more semantically related business objects. A business object can belong to exactly one process component. The elements located at the node Business Process Variant Type can be defined by the data type RequestForInformationBusinessProcessVariantTypeElements. These elements can include: BusinessProcessVariantTypeCode and MainIndicator. The BusinessProcessVariantTypeCode is a coded representation of a Request for Information Processing business process variant type and can be based on datatype GDT: BusinessProcessVariantTypeCode. In some implementations, the BusinessProcessVariantTypeCode is restricted to the following code values: NN—Standard. The MainIndicator is an indicator that specifies whether or not a business process variant type is a main business process variant type and can be based on datatype GDT: Indicator.

An Access Control List dependent object inclusion node is a list of access groups that have access to a Request for Information. A Text Collection dependent object inclusion node is a collection of natural-language texts with additional information about a Request for Information. Each text can be specified in different languages and can include formatting information. An Attachment Folder dependent object inclusion node is a folder for one or more documents in electronic form including additional information about a Request for Information.

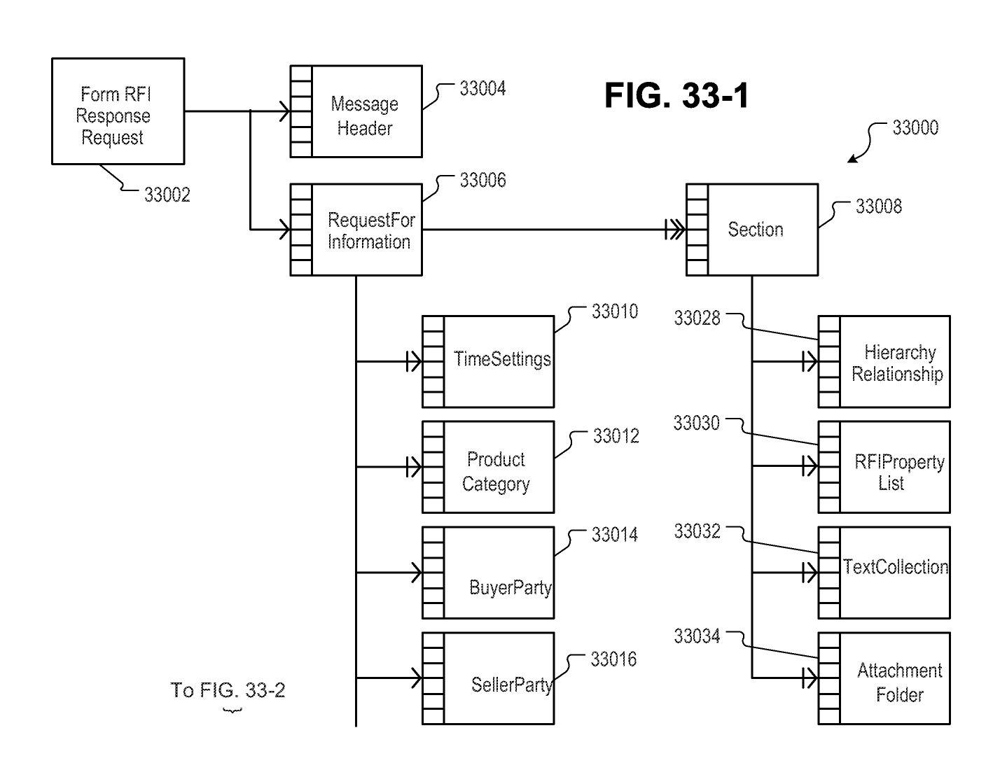

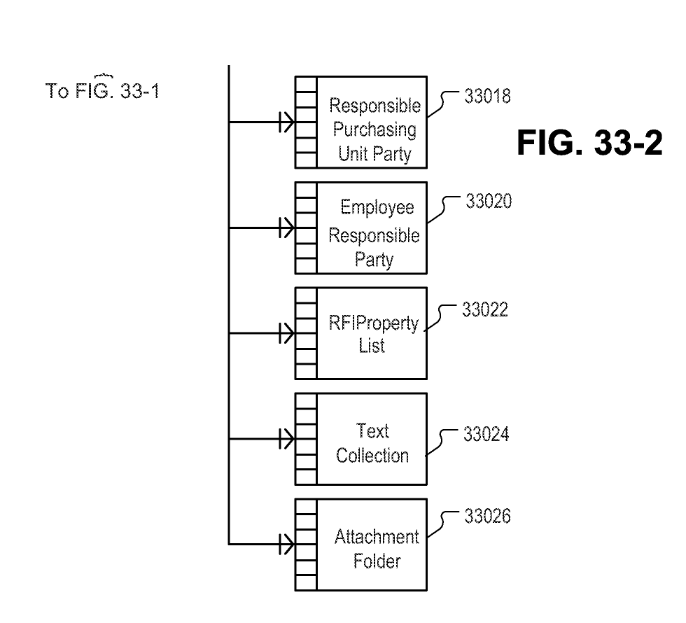

FIGS. 33-1 through 33-2 depict an example Form RFI Response Request Message Data Type 33000, which comprises elements 33002-33034, hierarchically related as shown. For example, the Form RFI Response Request 33002 includes a Message Header 33004.

The Message type Form RFI Response Request is derived from the business object Request for Information as leading object together with its operation signature. Form RFI Response Request is a message type to enable form-based output for an RFI Response Request. The RFIResponseRequest message is a request from a buyer to a potential supplier to provide a response to a request for information (RFI). The structure of this message type is determined by the message data type FormRFIResponseRequestMessage. In some implementations, an RFIResponseRequest may be sent once for each invited supplier. The message type FormRFIResponseRequest may be sent from a buyer to a supplier, and may be used to render a form starting a new Request for Information process. The message data type FormRFIResponseRequestMessage includes the object RequestForInformation which is included in the business document, business information that is relevant for sending a business document in a message, the MessageHeader package, and the RequestForInformation package. The message data type FormRFIResponseRequestMessage provides a structure for the message type Form RFI Response Request and for associated operations.

The MessageHeader package is a grouping of business information that is relevant for sending a business document in a message. The MessageHeader package includes the MessageHeader node. The MessageHeader node is a grouping of business information from the perspective of a sending application, such as information to identify the business document in a message, information about the sender, and optionally information about the recipient. The MessageHeader includes SenderParty and RecipientParty. MessageHeader may be based on the datatype GDT:BusinessDocumentMessageHeader. The following elements of the GDT may be used: RecipientParty, BusinessScope, SenderParty, SenderBusinessSystemID, TestDataIndicator, RecipientBusinessSystemID, ReferenceID, ReferenceUUID, ReconciliationIndicator, ID, UUID, and CreationDateTime. SenderParty is the partner responsible for sending a business document at a business application level. The SenderParty is of the type GDT:BusinessDocumentMessageHeaderParty. RecipientParty is of the type GDT:BusinessDocumentMessageHeaderParty. RecipientParty is the partner responsible for receiving a business document at a business application level.

The RequestForInformation package is a grouping of RequestForInformation with its Party, Property, Text, Attachment, and Section packages and with the RequestForInformation entity. RequestForInformation includes the ReconciliationPeriodCounterValue attribute. ReconciliationPeriodCounterValue may be optional, is a counter for reconciliation periods, and may be based on datatype GDT:CounterValue. RequestForInformation may include the following non-node elements: WatermarkName, Name, and SupplierGroupCode. WatermarkName may be based on datatype and may be based on datatype CDT:LANGUAGEINDEPENDENT_MEDIUM_Name. ID may be based on datatype GDT:BusinessTransactionDocumentID. Name may be optional and may be based on datatype CDT:MEDIUM_Name. SupplierGroupCode may be optional and may be based on datatype GDT:SupplierGroupCode. RequestForInformation includes the following relationships with node elements: TimeSettings with a cardinality of 1:C, ProductCategory with a cardinality of 1:C, BuyerParty with a cardinality of 1:1, SellerParty with a cardinality of 1:1, ResponsiblePurchasingUnitParty with a cardinality of 1:C, EmployeeResponsibleParty with a cardinality of 1:C, RFIPropertyList with a cardinality of 1:C, TextCollection with a cardinality of 1:C, AttachmentFolder with a cardinality of 1:C, and Section with a cardinality of 1:CN.

TimeSettings includes the SubmissionPeriod non-node element, which may be based on datatype GDT:UPPEROPEN_LOCAL DateTimePeriod. ProductCategory includes the following non-node elements: InternalID, StandardID, BuyerID, SellerID, ProductRecipientID, VendorID, ManufacturerID, BillToID, BillFromID, BidderID, and Description. InternalID may be optional, and may be based on datatype GDT:ProductInternalID. StandardID, and may be based on datatype GDT:ProductStandardID. BuyerID may be optional, and may be based on datatype GDT:ProductCategoryPartyID. SellerID may be optional, and may be based on datatype GDT:ProductCategoryPartyID. ProductRecipientID may be optional, and may be based on datatype GDT:ProductCategoryPartyID. VendorID may be optional, and may be based on datatype GDT:ProductCategoryPartyID. ManufacturerID may be optional, and may be based on datatype GDT:ProductCategoryPartyID. BillToID may be optional, and may be based on datatype GDT:ProductCategoryPartyID. BillFromID may be optional, and may be based on datatype GDT:ProductCategoryPartyID. BidderID may be optional, and may be based on datatype GDT:ProductCategoryPartyID. Description may be optional, and may be based on datatype GDT:MEDIUM_Description.

The RequestForInformationParty package includes the BuyerParty, SellerParty, ResponsiblePurchasingUnitParty, and EmployeeResponsibleParty entities. BuyerParty includes the following non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormattedName, and FormAddress. InternalID may be optional, and may be based on datatype GDT:PartyInternalID. StandardID, and may be based on datatype GDT:PartyStandardID. BuyerID may be optional, and may be based on datatype GDT:PartyPartyID. SellerID may be optional, and may be based on datatype GDT:PartyPartyID. ProductRecipientID may be optional, and may be based on datatype GDT:PartyPartyID. VendorID may be optional, and may be based on datatype GDT:PartyPartyID. BillToID may be optional, and may be based on datatype GDT:PartyPartyID. BillFromID may be optional, and may be based on datatype GDT:PartyPartyID. BidderID may be optional, and may be based on datatype GDT:PartyPartyID. PaymentTransactionInitiatorID may be optional, and may be based on datatype GDT:PartyPartyID. PaymentTransactionDestinatedID may be optional, and may be based on datatype GDT:PartyPartyID. TaxID may be optional, and may be based on datatype GDT:PartyTaxID. TypeCode may be optional, and may be based on datatype GDT:BusinessObjectTypeCode. FormattedName may be optional, and may be based on datatype CDT:LANGUAGEINDEPENDENT_LONG Name. FormAddress may be optional, and may be based on datatype GDT:FormAddress. BuyerParty include the node element ContactPerson in a 1:C cardinality relationship.

ContactPerson includes the following non-node elements: InternalID, BuyerID, SellerID, ProductRecipientID, VendorID, BillToID, BillFromID, BidderID, FormAddress, and FormattedName. InternalID may be optional, is a proprietary identifier that is used when both sender and recipient can access shared master data, and may be based on datatype GDT:ContactPersonPartyID, with a qualifier of Internal. BuyerID may be optional, and may be based on datatype GDT:ContactPersonPartyID. SellerID may be optional, is an identifier that is used by the SellerParty proprietarily for this location, and may be based on datatype GDT:ContactPersonPartyID, with a qualifier of Seller. ProductRecipientID may be optional, is an identifier that is used by the ProductRecipientParty proprietarily for this location, and may be based on datatype GDT:ContactPersonPartyID, with a qualifier of Product Recipient. VendorID may be optional, and may be based on datatype GDT:ContactPersonPartyID. BillToID may be optional, and may be based on datatype GDT:ContactPersonPartyID. BillFromID may be optional, and may be based on datatype GDT:ContactPersonPartyID. BidderID may be optional, and may be based on datatype GDT:ContactPersonPartyID. FormAddress may be optional, and may be based on datatype GDT:FormAddress. FormattedName may be optional, and may be based on datatype CDT:LANGUAGEINDEPENDENT_LONG_Name. SellerParty, ResponsiblePurchasingUnitParty, and EmployeeResponsibleParty each may have similar structures to that of BuyerParty.

The RequestForInformationProperty package includes the RFIPropertyList entity. RFIPropertyList includes the following non-node elements: Property, AllowedValue, IntervalBoundaryTypeCode, LowerBoundaryObjectPropertyValue, UpperBoundaryObjectPropertyValue, PropertyValueName, PropertyValueTextCollection, OrdinalNumberValue, Name, TextCollection, DataTypeFormatCode, UngroupedOrdinalNumberValue, ValuationRequiredIndicator, SupplierAssessmentSpecification, SupplierAssessmentPropertyAssessmentMethodCode, SupplierAssessmentPropertyAssessmentMethodCodeName, WeightingFactorValue, PropertyGroup, Property, PropertyID, OrdinalNumberValue, Name, OrdinalNumberValue.

Property is a property from a property library that is collected and adjusted to suit one or more objects, and may be based on datatype FMIDT:FormPropertyListProperty. AllowedValue is an allowed property-list specific value, and may be based on datatype FMIDT:FormPropertyValue. IntervalBoundaryTypeCode is a coded representation of an interval boundary type, and may be based on datatype GDT:IntervalBoundaryTypeCode. LowerBoundaryObjectPropertyValue is a lower boundary property value, and may be based on datatype GDT:ObjectPropertyValue with a qualifier of LowerBoundary. Lower boundary property value is also used to store single values. UpperBoundaryObjectPropertyValue may be optional, is an upper boundary property value, and may be based on datatype GDT:UpperBoundaryObjectPropertyValue. PropertyValueName may be optional, is a language-specific designation for a property value, and may be based on datatype CDT:EXTENDED_Name. PropertyValueTextCollection may be optional, is a collection of natural-language specific texts with additional information about the property value. PropertyValueTextCollection may include formatting information. PropertyValueTextCollection can be used for different purposes depending on the use case. PropertyValueTextCollection may be based on datatype FMIDT:FormTextCollection. OrdinalNumberValue may be optional, is a value that specifies a position of a property value for a multivalued property in a list, and may be based on datatype GDT:OrdinalNumberValue. ID is an identifier for a property in a property library, and may be based on datatype GDT:PropertyID. Name may be optional, includes a word or combination of words that names a property, and may be based on datatype CDT:EXTENDED_Name. TextCollection may be optional, and is a collection of natural-language specific texts with additional information about a property. TextCollection text may include formatting information and may be used for different purposes depending on the use case. TextCollection may be based on datatype FMIDT:FormTextCollection. DataTypeFormatCode is a format of a property and may be based on datatype GDT:PropertyDataTypeFormatCode. UngroupedOrdinalNumberValue may be optional, is a value that specifies a position of a property in a property list, and may be based on datatype GDT:OrdinalNumberValue. ValuationRequiredIndicator is an indicator that specifies whether a value is assigned to a property during valuation, and may be based on datatype CDT:Indicator, with a qualifier of Required. SupplierAssessmentSpecification may be optional, is a collection of supplier assessment specific information about a property, and may be based on datatype FMIDT:FormPropertyListPropertySupplierAssessmentSpecification. SupplierAssessmentPropertyAssessmentMethodCode is a coded representation of a property assessment method which specifies a method according to which a supplier assessment property is assessed, and may be based on datatype GDT:SupplierAssessmentPropertyAssessmentMethodCode. SupplierAssessmentPropertyAssessmentMethodCodeName may be optional, is a word or combination of words that names a property assessment method, and may be based on datatype CDT:EXTENDED_Name. WeightingFactorValue may be optional, is a value that specifies a weighting of a property in a supplier assessment, and may be based on datatype GDT:WeightingFactorValue. PropertyGroup is a grouping of properties, and may be based on datatype FMIDT:FormPropertyListPropertyGroup. Property is a reference to a property from a property list that belongs to a property group, and may be based on datatype FMIDT:FormPropertyListPropertyGroupProperty. PropertyID is an identifier for a property in a property library, and may be based on datatype GDT:PropertyID. OrdinalNumberValue may be optional, specifies the position of a property within a property group, and may be based on datatype GDT:OrdinalNumberValue. Name may be optional, is a word or combination of words that names a property group, and may be based on datatype CDT:EXTENDED_Name. OrdinalNumberValue may be optional, is a position of a property group within a property list, and may be based on datatype GDT:OrdinalNumberValue.

TextCollection and PropertyValueTextCollection each may include a collection of text elements (represented by the data type FMIDT:FormTextCollectionText). The data type FMIDT:FormTextCollectionText may include the following elements: Text, TypeCode, TypeName, SystemAdministrativeData, CreationDateTime, CreationIdentityUUID, CreationUserAccountID, CreationBusinessPartnerFormattedName, LastChangeDateTime, LastChangeIdentityUUID, LastChangeUserAccountID, LastChangeBusinessPartnerFormattedName, CreationDateTime, ContentText, PropertyDataTypeFormatCode, PropertyValue, IntervalBoundaryTypeCode, LowerBoundaryObjectPropertyValue, UpperBoundaryObjectPropertyValue, and PropertyValueName. Text may be based on datatype FMIDT:FormTextCollectionText. TypeCode may be optional, and may be based on datatype GDT:TextCollectionTextTypeCode. TypeName may be optional, and may be based on datatype CDT:LANGUAGEINDEPENDENT_MEDIUM_Name. SystemAdministrativeData may be optional, is FMIDT:FormSystemAdministrativeData. CreationDateTime may be based on datatype CDT:LOCAL_DateTime. CreationIdentityUUID may be optional, and may be based on datatype GDT:UUID. CreationUserAccountID may be optional, and may be based on datatype GDT:UserAccountID. CreationBusinessPartnerFormattedName may be optional, and may be based on datatype CDT:LANGUAGEINDEPENDENT_LONG_Name. LastChangeDateTime may be optional, and may be based on datatype CDT:LOCAL_DateTime. LastChangeIdentityUUID may be optional, and may be based on datatype GDT:UUID. LastChangeUserAccountID may be optional, and may be based on datatype GDT:UserAccountID. LastChangeBusinessPartnerFormattedName may be optional, and may be based on datatype CDT:LANGUAGEINDEPENDENT_LONG_Name. CreationDateTime may be optional, and may be based on datatype CDT:LOCAL_DateTime. ContentText, and may be based on datatype CDT:Text.

The RequestForInformationText package includes the TextCollection entity. TextCollection includes the following non-node elements: Text, TypeCode, TypeName, CreationDateTime, CreationIdentityUUID, CreationUserAccountID, CreationBusinessPartnerFormattedName, LastChangeDateTime, LastChangeIdentityUUID, LastChangeUserAccountID, LastChangeBusinessPartnerFormattedName, CreationDateTime, and ContentText. Text may be based on datatype FMIDT:FormTextCollectionText/TypeCode may be optional, and may be based on datatype GDT:TextCollectionTextTypeCode. TypeName may be optional, and may be based on datatype CDT:LANGUAGEINDEPENDENT_MEDIUM_Name. SystemAdministrativeData may be optional, and may be based on datatype FMIDT:FormSystemAdministrativeData. CreationDateTime may be based on datatype CDT:LOCAL_DateTime. CreationIdentityUUID may be optional, and may be based on datatype GDT:UUID. CreationUserAccountID may be optional, and may be based on datatype GDT:UserAccountID. CreationBusinessPartnerFormattedName may be optional, and may be based on datatype CDT:LANGUAGEINDEPENDENT_LONG_Name. LastChangeDateTime may be optional, and may be based on datatype CDT:LOCAL_DateTime. LastChangeIdentityUUID may be optional, and may be based on datatype GDT:UUID. LastChangeUserAccountID may be optional, and may be based on datatype GDT:UserAccountID. LastChangeBusinessPartnerFormattedName may be optional, and may be based on datatype CDT:LANGUAGEINDEPENDENT_LONG_Name. CreationDateTime may be optional, and may be based on datatype CDT:LOCAL_DateTime. ContentText may be based on datatype CDT:Text.

The RequestForInformationAttachment package includes the AttachmentFolder entity. AttachmentFolder is typed by AttachmentFolder. The RequestForInformationSection package includes a grouping of the packages Property, Text, and Attachment, and the HierarchyRelationship entity. Section includes the following non-node elements: ID, FormattedID, and OrdinalNumberValue. ID may be based on datatype GDT:BusinessTransactionDocumentItemID. FormattedID may be based on datatype GDT:RequestForInformationSectionFormattedID. OrdinalNumberValue may be based on datatype GDT:OrdinalNumberValue. Section include the following relationships with node elements: RFIPropertyList in a 1:C cardinality relationship, HierarchyRelationship in a 1:C cardinality relationship, TextCollection in a 1:C cardinality relationship, and AttachmentFolder in a 1:C cardinality relationship. HierarchyRelationship includes the ParentSectionID non-node element, which may be based on datatype GDT:BusinessTransactionDocumentItemID.

The RequestForInformationSectionProperty package includes the RFIPropertyList entity. RFIPropertyList may be structured as described above with respect to the RequestForInformationProperty package. The RequestForInformationSectionText package includes the TextCollection entity. TextCollection includes the Text non-node element. Text may be based on datatype FMIDT:FormTextCollectionText. Text may include the following elements: TypeCode, TypeName, SystemAdministrativeData, CreationDateTime, CreationIdentityUUID, CreationUserAccountID, CreationBusinessPartnerFormattedName, LastChangeDateTime, LastChangeIdentityUUID, LastChangeUserAccountID, LastChangeBusinessPartnerFormattedName, CreationDateTime, and ContentText. The datatypes of the elements included in the Text element may be based on various datatypes, as described above. The RequestForInformationSectionAttachment package includes the AttachmentFolder entity. The AttachmentFolder entity may be typed by datatype AttachmentFolder.

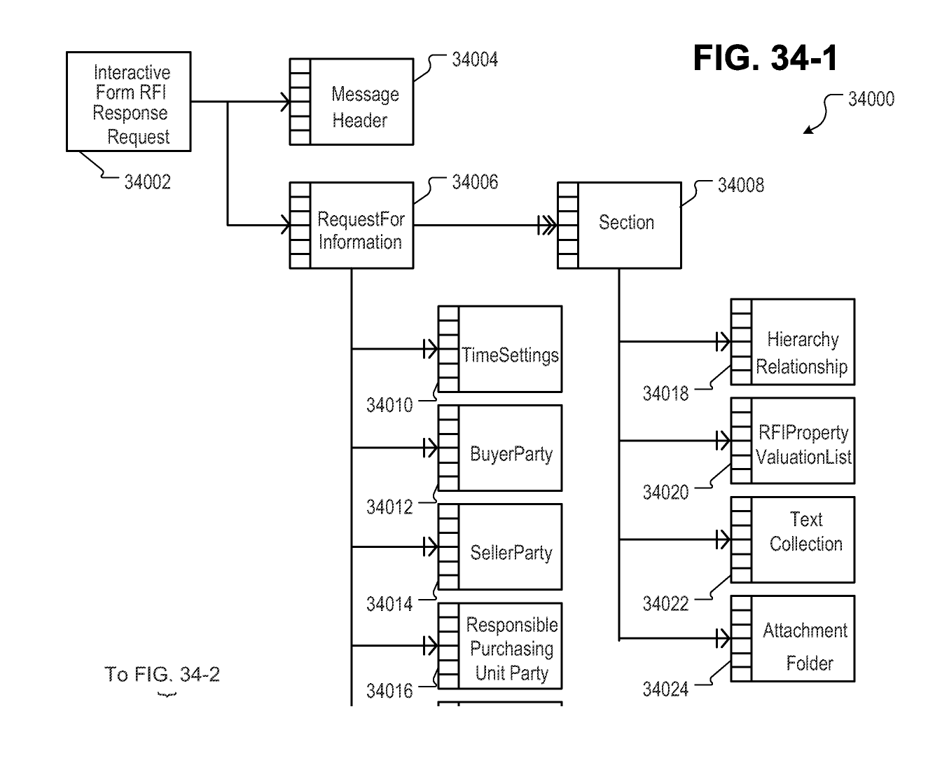

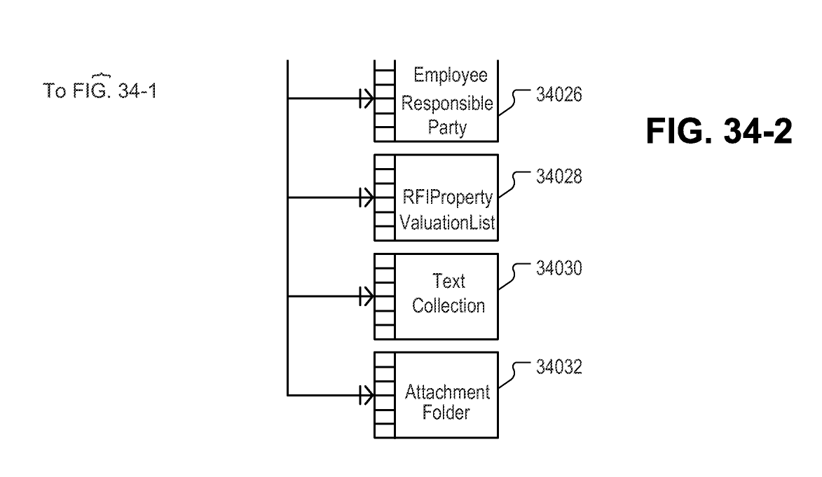

FIGS. 34-1 through 34-2 depict an example Interactive Form RFI Response Request Message Data Type 34000, which comprises elements 34002-34032, hierarchically related as shown. For example, the Interactive Form RFI Response Request 34002 includes a Message Header 34004.

The message type Interactive Form RFI Response Request is derived from the business object Request for Information as a leading object together with its operation signature. The message type Interactive Form RFI Response Request is a message type to enable interactive data entry in a Form RFI Response Request. The RFIResponseRequest message is sent from the buyer to the bidder. The structure of the message type Interactive Form RFI Response Request is determined by the message data type InteractiveFormRFIResponseRequestMessage. The RFIResponseRequest is sent once for each invited supplier. The message type FormRFIResponseRequest is sent from the buyer to the supplier and is used to render a form starting a new Request for Information process. The message data type InteractiveFormRFIResponseRequestMessage includes the object InteractiveFormReturnURI which is included in a business document, business information that is relevant for sending a business document in a message, the MessageHeader package, and the InteractiveFormReturnURI package. The message data type InteractiveFormRFIResponseRequestMessage provides a structure for the message type Interactive Form RFI Response Request and for associated operations.

The MessageHeader package is a grouping of business information that is relevant for sending a business document in a message. The MessageHeader package includes the MessageHeader node. The MessageHeader node is a grouping of business information from the perspective of a sending application, such as information to identify the business document in a message, information about the sender, and optionally information about the recipient. The MessageHeader includes SenderParty and RecipientParty. MessageHeader may be based on the datatype GDT:BusinessDocumentMessageHeader. The following elements of the GDT may be used: RecipientParty, BusinessScope, SenderParty, SenderBusinessSystemID, TestDataIndicator, RecipientBusinessSystemID, ReferenceID, ReferenceUUID, ReconciliationIndicator, ID, UUID, and CreationDateTime. SenderParty is the partner responsible for sending a business document at a business application level. The SenderParty is of the type GDT:BusinessDocumentMessageHeaderParty. RecipientParty is of the type GDT:BusinessDocumentMessageHeaderParty. RecipientParty is the partner responsible for receiving a business document at a business application level.

The RequestForInformation package is a grouping of InteractiveFormReturnURI with its Property, Party, Text, Attachment, and Section packages and with the RequestForInformation entity. RequestForInformation includes the ReconciliationPeriodCounterValue attribute. ReconciliationPeriodCounterValue may be optional, is a counter for reconciliation periods, and may be based on datatype GDT:CounterValue. RequestForInformation includes the non-node elements WatermarkName, ID, Name, and SupplierGroupCode. WatermarkName may be based on datatype CDT:LANGUAGEINDEPENDENT_Name. ID may be based on datatype GDT:BusinessTransactionDocumentID. Name may be optional and may be based on datatype CDT:MEDIUM_Name. SupplierGroupCode may be optional and may be based on datatype GDT: SupplierGroupCode. RequestForInformation includes the following relationships with node elements: RFIPropertyValuationList in a 1:C cardinality relationship, TimeSettings in a 1:C cardinality relationship, ProductCategory in a 1:C cardinality relationship, BuyerParty in a 1:1 cardinality relationship, SellerParty in a 1:1 cardinality relationship, ResponsiblePurchasingUnitParty in a 1:C cardinality relationship, EmployeeResponsibleParty in a 1:C cardinality relationship, TextCollection in a 1:C cardinality relationship, AttachmentFolder in a 1:C cardinality relationship, and Section in a 1:CN cardinality relationship.

TimeSettings includes the SubmissionPeriod non-node element, which may be based on datatype GDT:UPPEROPEN_LOCAL_DateTimePeriod. ProductCategory includes the following non-node elements: InternalID, StandardID, BuyerID, SellerID, ProductRecipientID, VendorID, ManufacturerID, BillToID, BillFromID, BidderID, and Description. InternalID may be optional, and may be based on datatype GDT:ProductInternalID. StandardID, and may be based on datatype GDT:ProductStandardID. BuyerID may be optional, and may be based on datatype GDT:ProductCategoryPartyID. SellerID may be optional, and may be based on datatype GDT:ProductCategoryPartyID. ProductRecipientID may be optional, and may be based on datatype GDT:ProductCategoryPartyID. VendorID may be optional, and may be based on datatype GDT:ProductCategoryPartyID. ManufacturerID may be optional, and may be based on datatype GDT:ProductCategoryPartyID. BillToID may be optional, and may be based on datatype GDT:ProductCategoryPartyID. BillFromID may be optional, and may be based on datatype GDT:ProductCategoryPartyID. BidderID may be optional, and may be based on datatype GDT:ProductCategoryPartyID. Description may be optional, and may be based on datatype GDT:MEDIUM_Description.

The RequestForInformationProperty package includes the RFIPropertyValuationList entity. RFIPropertyValuationList includes the following non-node elements: PropertyValuation, PropertyID, PropertyName, PropertyTextCollection, PropertyValueTextCollection, OrdinalNumberValue, PropertyValuationTextCollection, AllowedValue, IntervalBoundaryTypeCode, LowerBoundaryObjectPropertyValue, UpperBoundaryObjectPropertyValue, PropertyValueName, PropertyValueTextCollection, OrdinalNumberValue, OrdinalNumberValue, ValuationRequiredIndicator, SupplierAssessmentSpecification, SupplierAssessmentPropertyAssessmentMethodCode, SupplierAssessmentPropertyAssessmentMethodCodeName, and WeightingFactorValue. PropertyValuation is a valuation of a property and may be based on datatype FMIDT:FormPropertyValuationListPropertyValuation. PropertyID is an identifier for a property in a property library, and may be based on datatype GDT:PropertyID. PropertyName may be optional, is a word or combination of words that names a property, and may be based on datatype CDT:EXTENDED_Name. PropertyTextCollection may be optional, is a collection of natural-language specific texts with additional information about a property. This text may include formatting information. PropertyTextCollection can be used for different purposes depending on the use case. PropertyTextCollection may be based on datatype FMIDT:FormTextCollection. PropertyDataTypeFormatCode is a format of a property, and may be based on datatype GDT:PropertyDataTypeFormatCode. PropertyValue may be optional, is a value of a property, and may be based on datatype FMIDT:FormPropertyValue. IntervalBoundaryTypeCode is a coded representation of an interval boundary type, and may be based on datatype GDT:IntervalBoundaryTypeCode. LowerBoundaryObjectPropertyValue is a lower boundary property value. Lower boundary property value is also used to store single values, and may be based on datatype GDT:ObjectPropertyValue. with a qualifier of LowerBoundary. UpperBoundaryObjectPropertyValue may be optional, is an upper boundary property value, and may be based on datatype GDT:UpperBoundaryObjectPropertyValue. PropertyValueName may be optional, is a language-specific designation for a property value, and may be based on datatype CDT:EXTENDED_Name. PropertyValueTextCollection may be optional, and is a collection of natural-language specific texts with additional information about a property value. This text may include formatting information. PropertyValueTextCollection can be used for different purposes depending on the use case. PropertyValueTextCollection may be based on datatype FMIDT:FormTextCollection. OrdinalNumberValue may be optional, is a value that specifies the position of a property value for a multivalued property in a list, and may be based on datatype GDT:OrdinalNumberValue. PropertyValuationTextCollection may be optional, is a collection of natural-language specific texts with additional information about a property valuation. PropertyValuationTextCollection text may include formatting information. PropertyValuationTextCollection can be used for different purposes depending on the use case. PropertyValuationTextCollection may be based on datatype FMIDT:FormTextCollection. AllowedValue is an allowed property-valuation-list specific value that can be chosen during property valuation, and may be based on datatype FMIDT:FormPropertyValue. IntervalBoundaryTypeCode is a coded representation of an interval boundary type, and may be based on datatype GDT:IntervalBoundaryTypeCode. LowerBoundaryObjectPropertyValue is a lower boundary property value. Lower boundary property value is also used to store single values, and may be based on datatype GDT:ObjectPropertyValue, with a qualifier of LowerBoundary. UpperBoundaryObjectPropertyValue may be optional, is an upper boundary property value, and may be based on datatype GDT:UpperBoundaryObjectPropertyValue. PropertyValueName may be optional, is a language-specific designation for a property value, and may be based on datatype CDT:EXTENDED_Name. PropertyValueTextCollection may be optional, is a collection of natural-language specific texts with additional information about a property value. PropertyValueTextCollection may include formatting information. PropertyValueTextCollection can be used for different purposes depending on the use case. PropertyValueTextCollection may be based on datatype FMIDT:FormTextCollection. OrdinalNumberValue may be optional, is a value that specifies the position of a property value for a multivalued property in a list, and may be based on datatype GDT:OrdinalNumberValue. ValuationRequiredIndicator is an indicator that specifies whether or not a value is assigned to a property valuation, and may be based on datatype CDT:Indicator, with a qualifier of Required. SupplierAssessmentSpecification may be optional, is a collection of supplier assessment specific information about the property, and may be based on datatype FMIDT:FormPropertyListPropertySupplierAssessmentSpecification. SupplierAssessmentPropertyAssessmentMethodCode is a coded representation of a property assessment method which specifies a method according to which supplier assessment property is assessed, and may be based on datatype GDT: SupplierAssessmentPropertyAssessmentMethodCode. SupplierAssessmentPropertyAssessmentMethodCodeName may be optional, is a word or combination of words that names a property assessment method, and may be based on datatype CDT:EXTENDED_Name. WeightingFactorValue may be optional, is a value that specifies the weighting of the property in a supplier assessment, and may be based on datatype GDT: WeightingFactorValue.

PropertyTextCollection, PropertyValueTextCollection, PropertyValuationTextCollection, and PropertyValueTextCollection each may include a collection of text elements (represented by the data type FMIDT:FormTextCollectionText). The data type FMIDT:FormTextCollectionText may include the following elements: Text, TypeCode, TypeName, SystemAdministrativeData, CreationDateTime, CreationIdentityUUID, CreationUserAccountID, CreationBusinessPartnerFormattedName, LastChangeDateTime, LastChangeIdentityUUID, LastChangeUserAccountID, LastChangeBusinessPartnerFormattedName, CreationDateTime, ContentText, PropertyDataTypeFormatCode, PropertyValue, IntervalBoundaryTypeCode, LowerBoundaryObjectPropertyValue, UpperBoundaryObjectPropertyValue, and PropertyValueName. Text may be based on datatype FMIDT:FormTextCollectionText. TypeCode may be optional, and may be based on datatype GDT:TextCollectionTextTypeCode. TypeName may be optional, and may be based on datatype CDT:LANGUAGEINDEPENDENT_MEDIUM_Name. SystemAdministrativeData may be optional, is FMIDT:FormSystemAdministrativeData. CreationDateTime may be based on datatype CDT:LOCAL_DateTime. CreationIdentityUUID may be optional, and may be based on datatype GDT:UUID. CreationUserAccountID may be optional, and may be based on datatype GDT:UserAccountID. CreationBusinessPartnerFormattedName may be optional, and may be based on datatype CDT:LANGUAGEINDEPENDENT_LONG Name. LastChangeDateTime may be optional, and may be based on datatype CDT:LOCAL_DateTime. LastChangeIdentityUUID may be optional, and may be based on datatype GDT:UUID. LastChangeUserAccountID may be optional, and may be based on datatype GDT:UserAccountID. LastChangeBusinessPartnerFormattedName may be optional, and may be based on datatype CDT:LANGUAGEINDEPENDENT_LONG_Name. CreationDateTime may be optional, and may be based on datatype CDT:LOCAL_DateTime. ContentText, and may be based on datatype CDT:Text.

The RequestForInformationParty package includes the BuyerParty, SellerParty, ResponsiblePurchasingUnitParty, and EmployeeResponsibleParty entities. BuyerParty includes the following non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormattedName, and FormAddress. InternalID may be optional, and may be based on datatype GDT:PartyInternalID. StandardID, and may be based on datatype GDT:PartyStandardID. BuyerID may be optional, and may be based on datatype GDT:PartyPartyID. SellerID may be optional, and may be based on datatype GDT:PartyPartyID. ProductRecipientID may be optional, and may be based on datatype GDT:PartyPartyID. VendorID may be optional, and may be based on datatype GDT:PartyPartyID. BillToID may be optional, and may be based on datatype GDT:PartyPartyID. BillFromID may be optional, and may be based on datatype GDT:PartyPartyID. BidderID may be optional, and may be based on datatype GDT:PartyPartyID. PaymentTransactionInitiatorID may be optional, and may be based on datatype GDT:PartyPartyID. PaymentTransactionDestinatedID may be optional, and may be based on datatype GDT:PartyPartyID. TaxID may be optional, and may be based on datatype GDT:PartyTaxID. TypeCode may be optional, and may be based on datatype GDT:BusinessObjectTypeCode. FormattedName may be optional, and may be based on datatype CDT:LANGUAGEINDEPENDENT_LONG Name. FormAddress may be optional, and may be based on datatype GDT:FormAddress. BuyerParty include the node element ContactPerson in a 1:C cardinality relationship.

ContactPerson includes the following non-node elements: InternalID, BuyerID, SellerID, ProductRecipientID, VendorID, BillToID, BillFromID, BidderID, FormAddress, and FormattedName. InternalID may be optional, is a proprietary identifier that is used when both sender and recipient can access shared master data, and may be based on datatype GDT:ContactPersonPartyID, with a qualifier of Internal. BuyerID may be optional, and may be based on datatype GDT:ContactPersonPartyID. SellerID may be optional, is an identifier that is used by the SellerParty proprietarily for this location, and may be based on datatype GDT:ContactPersonPartyID, with a qualifier of Seller. ProductRecipientID may be optional, is an identifier that is used by the ProductRecipientParty proprietarily for this location, and may be based on datatype GDT:ContactPersonPartyID, with a qualifier of Product Recipient. VendorID may be optional, and may be based on datatype GDT:ContactPersonPartyID. BillToID may be optional, and may be based on datatype GDT:ContactPersonPartyID. BillFromID may be optional, and may be based on datatype GDT:ContactPersonPartyID. BidderID may be optional, and may be based on datatype GDT:ContactPersonPartyID. FormAddress may be optional, and may be based on datatype GDT:FormAddress. FormattedName may be optional, and may be based on datatype CDT:LANGUAGEINDEPENDENT_LONG_Name. SellerParty, ResponsiblePurchasingUnitParty, and EmployeeResponsibleParty each may have similar structures to that of BuyerParty.

The RequestForInformationText package includes the TextCollection entity. TextCollection includes the following non-node elements: Text, TypeCode, TypeName, CreationDateTime, CreationIdentityUUID, CreationUserAccountID, CreationBusinessPartnerFormattedName, LastChangeDateTime, LastChangeIdentityUUID, LastChangeUserAccountID, LastChangeBusinessPartnerFormattedName, CreationDateTime, and ContentText. Text may be based on datatype FMIDT:FormTextCollectionText/TypeCode may be optional, and may be based on datatype GDT:TextCollectionTextTypeCode. TypeName may be optional, and may be based on datatype CDT:LANGUAGEINDEPENDENT_MEDIUM_Name. SystemAdministrativeData may be optional, and may be based on datatype FMIDT:FormSystemAdministrativeData. CreationDateTime may be based on datatype CDT:LOCAL_DateTime. CreationIdentityUUID may be optional, and may be based on datatype GDT:UUID. CreationUserAccountID may be optional, and may be based on datatype GDT:UserAccountID. CreationBusinessPartnerFormattedName may be optional, and may be based on datatype CDT:LANGUAGEINDEPENDENT_LONG_Name. LastChangeDateTime may be optional, and may be based on datatype CDT:LOCAL_DateTime. LastChangeIdentityUUID may be optional, and may be based on datatype GDT:UUID. LastChangeUserAccountID may be optional, and may be based on datatype GDT:UserAccountID. LastChangeBusinessPartnerFormattedName may be optional, and may be based on datatype CDT:LANGUAGEINDEPENDENT_LONG_Name. CreationDateTime may be optional, and may be based on datatype CDT:LOCAL_DateTime. ContentText may be based on datatype CDT:Text.

The RequestForInformationAttachment package includes the AttachmentFolder entity. AttachmentFolder is typed by AttachmentFolder. The RequestForInformationSection package includes a grouping of the packages Property, Text, and Attachment, and the HierarchyRelationship entity. Section includes the following non-node elements: ID, FormattedID, and OrdinalNumberValue. ID may be based on datatype GDT:BusinessTransactionDocumentItemID. FormattedID may be based on datatype GDT:RequestForInformationSectionFormattedID. OrdinalNumberValue may be based on datatype GDT:OrdinalNumberValue. Section include the following relationships with node elements: RFIPropertyValuationList in a 1:C cardinality relationship, HierarchyRelationship in a 1:C cardinality relationship, TextCollection in a 1:C cardinality relationship, and AttachmentFolder in a 1:C cardinality relationship. HierarchyRelationship includes the ParentSectionID non-node element, which may be based on datatype GDT:BusinessTransactionDocumentItemID.

The RequestForInformationSectionProperty package includes the RFIPropertyValuationList entity. RFIPropertyValuationList may be structured as described above with respect to the RequestForInformationProperty package. The RequestForInformationSectionText package includes the TextCollection entity. TextCollection includes the Text non-node element. Text may be based on datatype FMIDT:FormTextCollectionText. Text may include the following elements: TypeCode, TypeName, SystemAdministrativeData, CreationDateTime, CreationIdentityUUID, CreationUserAccountID, CreationBusinessPartnerFormattedName, LastChangeDateTime, LastChangeIdentityUUID, LastChangeUserAccountID, LastChangeBusinessPartnerFormattedName, CreationDateTime, and ContentText. The RequestForInformationSectionAttachment package includes the AttachmentFolder entity. AttachmentFolder is typed by AttachmentFolder. The InteractiveFormReturnURI package is a grouping of InteractiveFormReturnURI with its packages and with the InteractiveFormReturnURI entity. InteractiveFormReturnURI is typed by EmailURI. TimeSettings includes the SubmissionPeriod non-node element which may be based on datatype GDT:UPPEROPEN_LOCAL_DateTimePeriod. ProductCategory may be structured as described above.

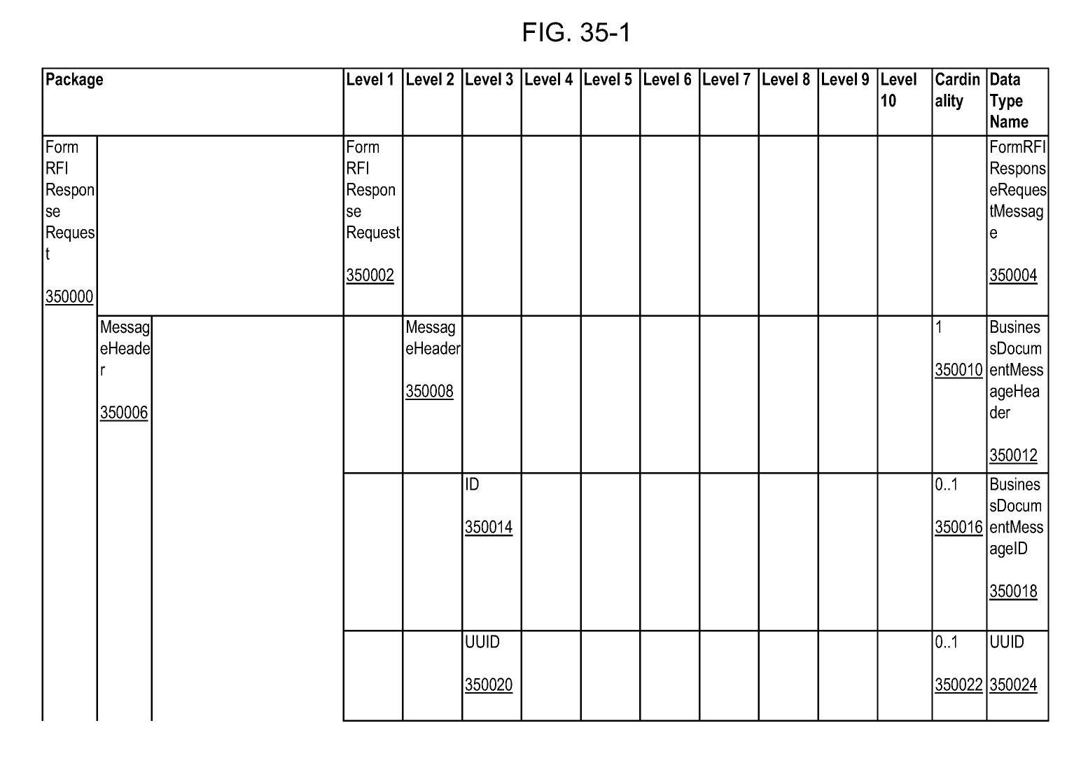

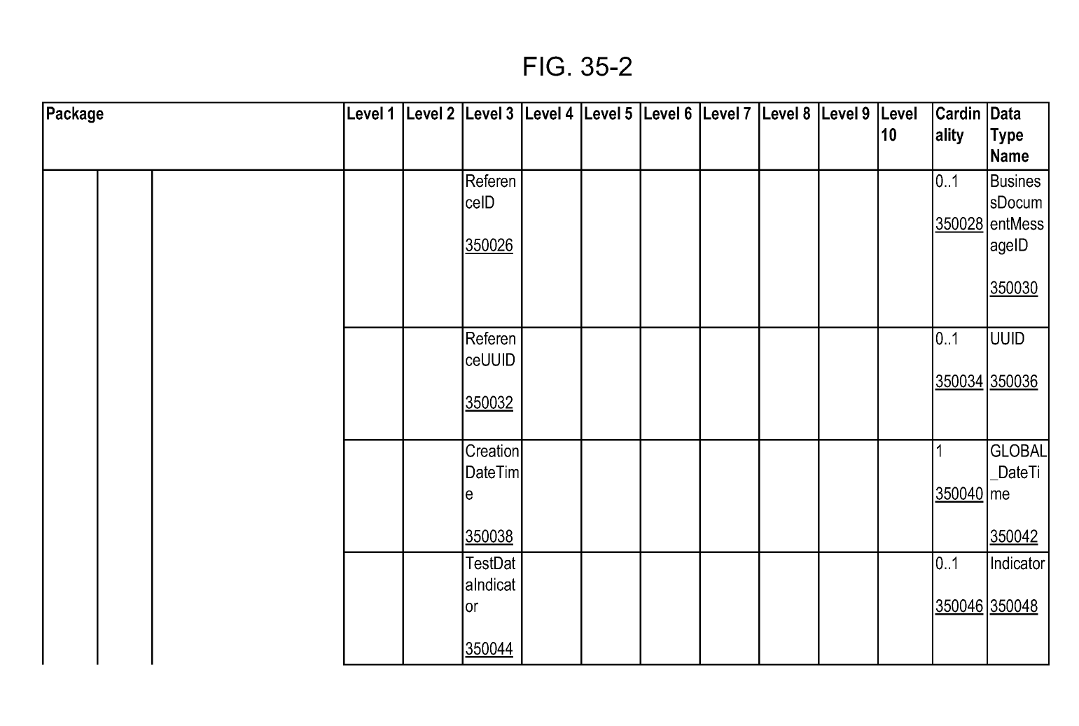

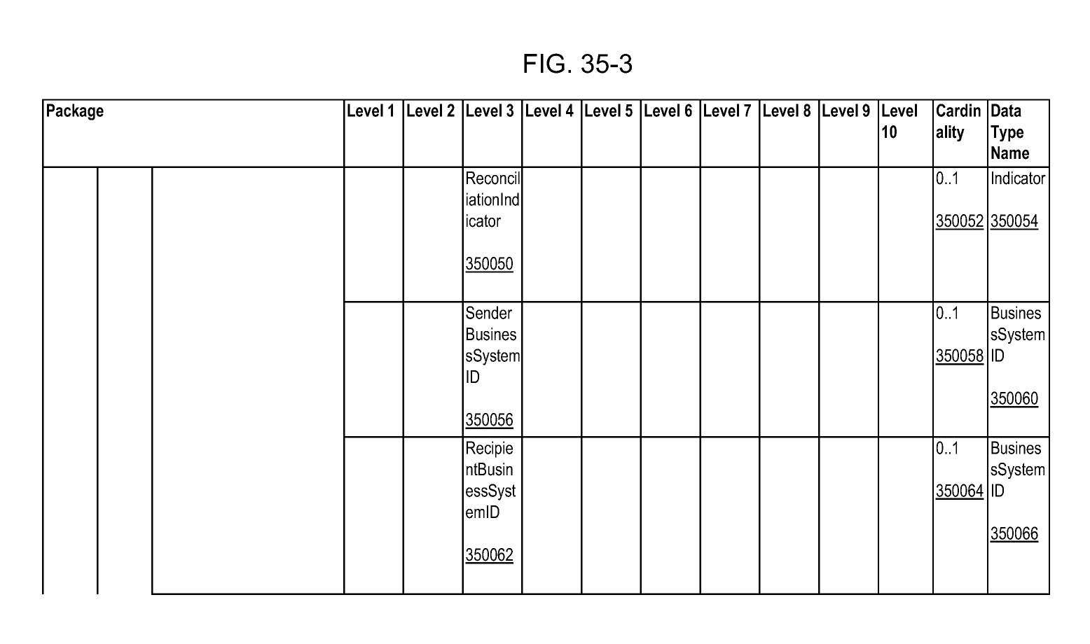

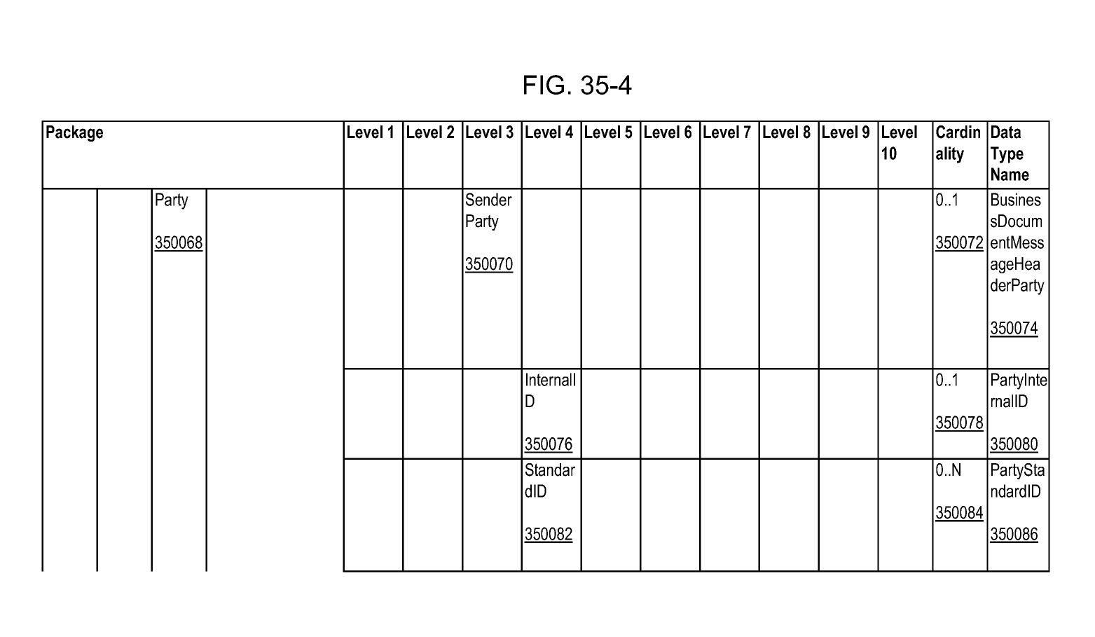

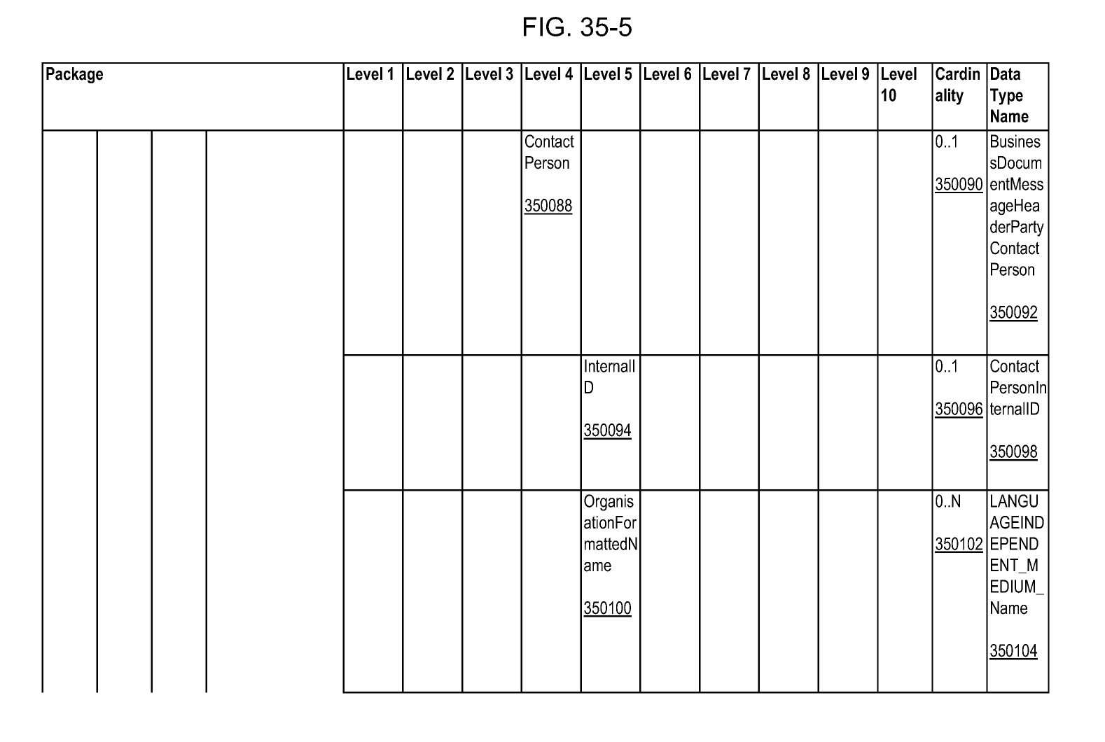

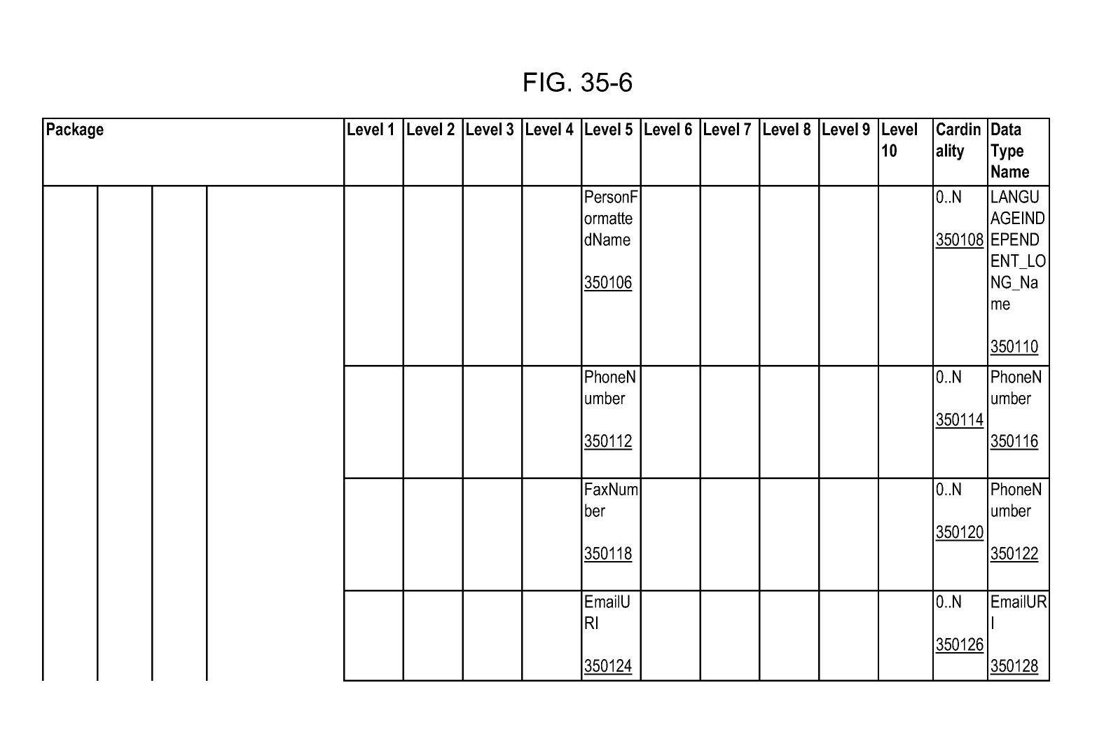

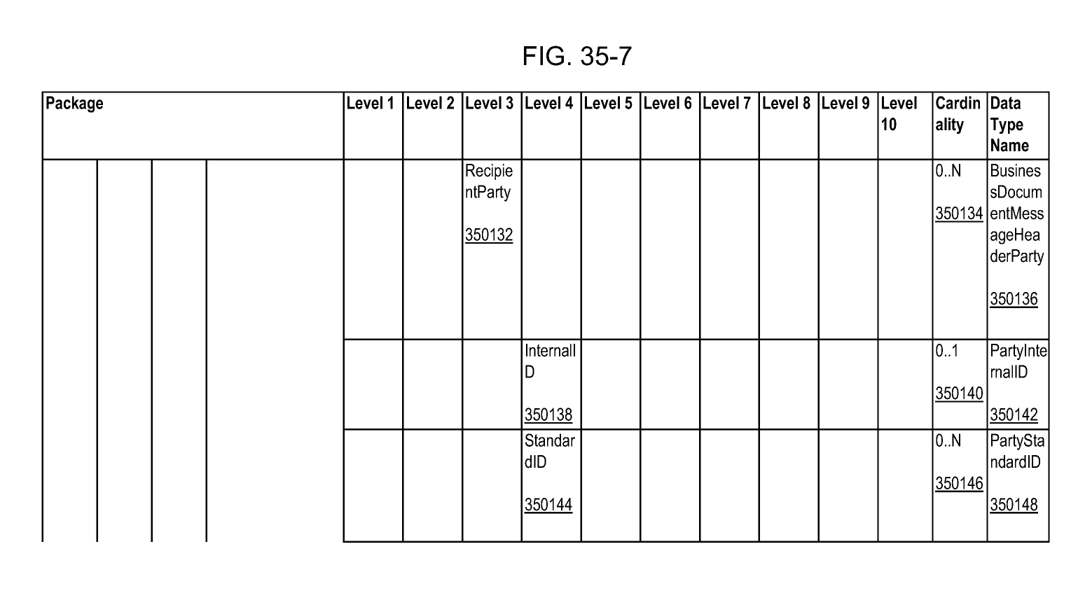

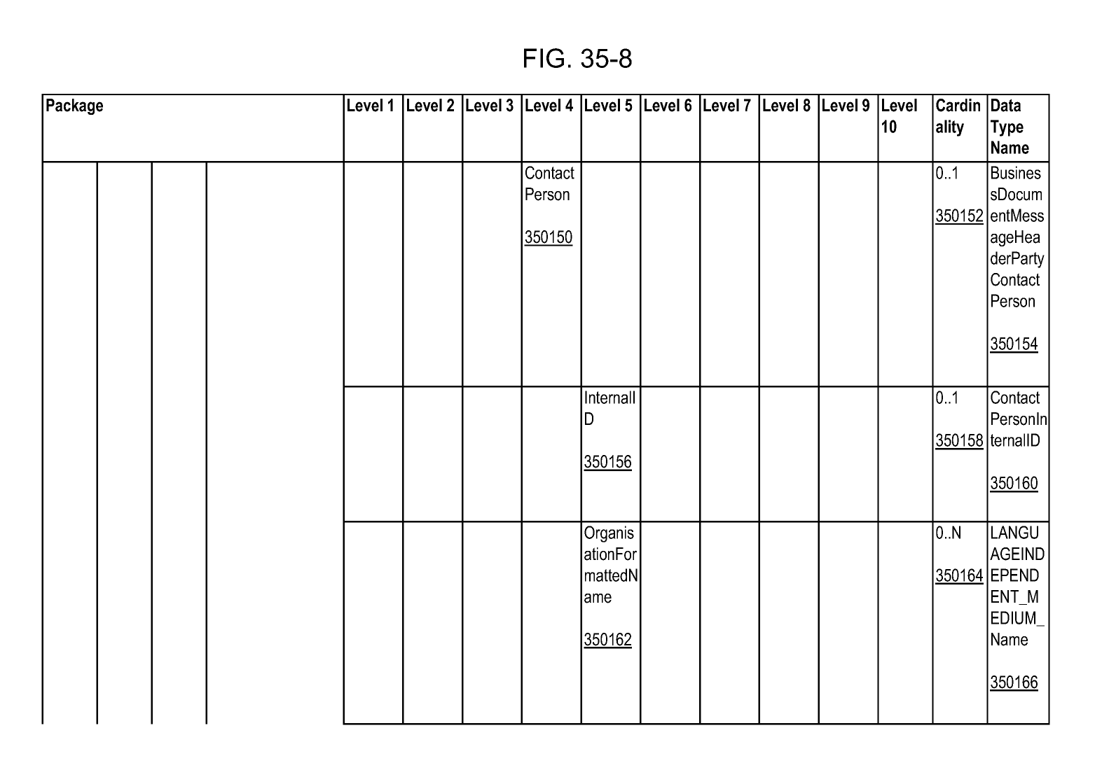

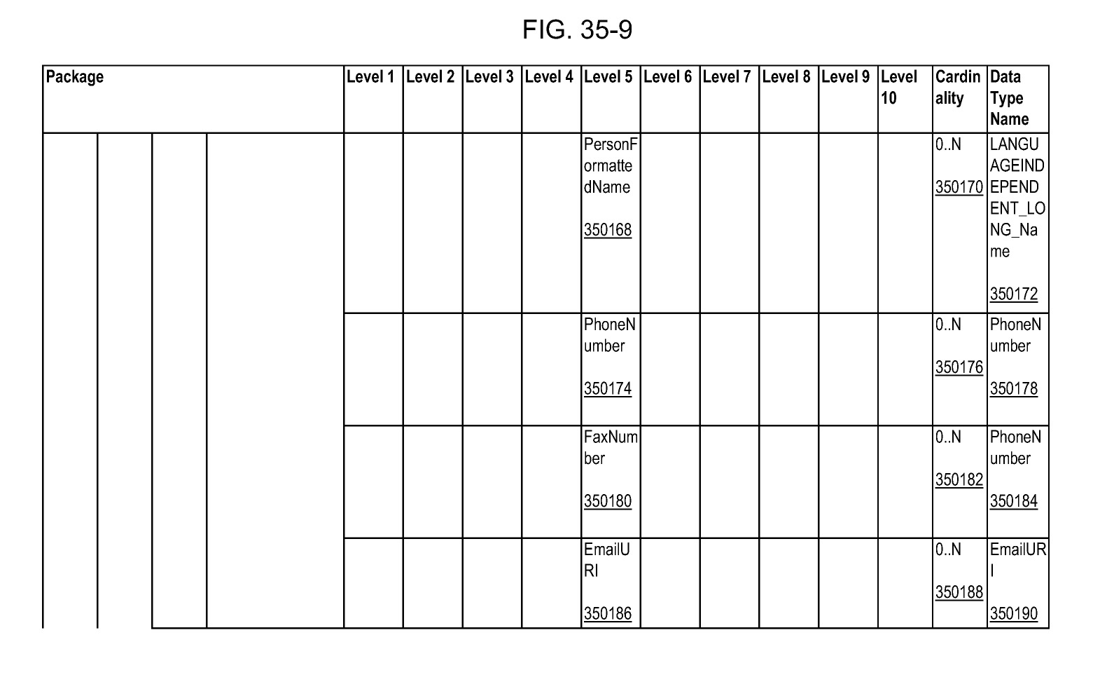

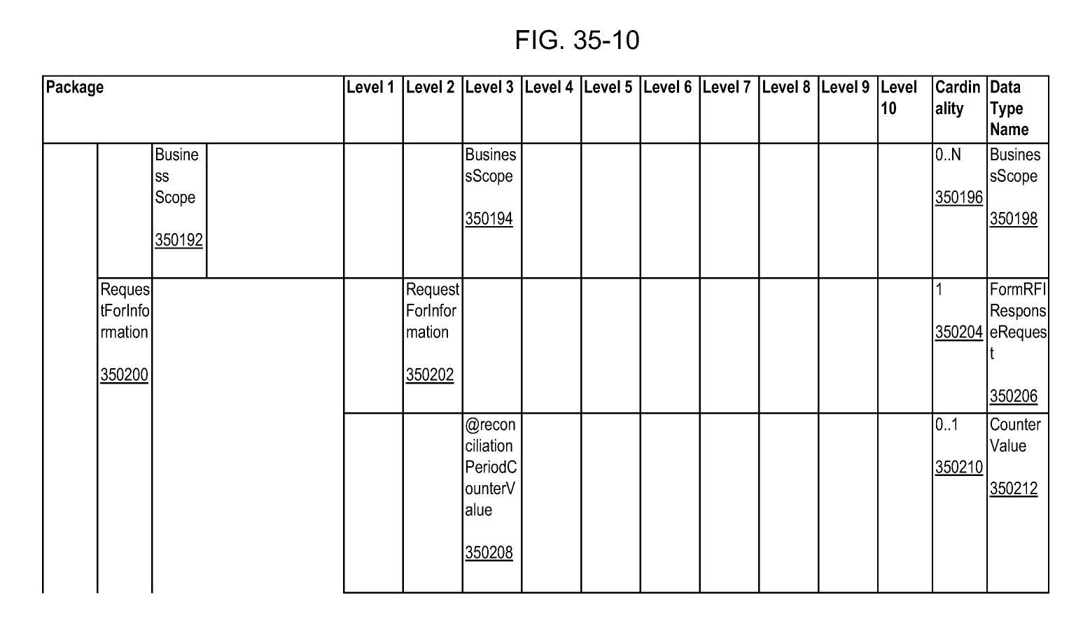

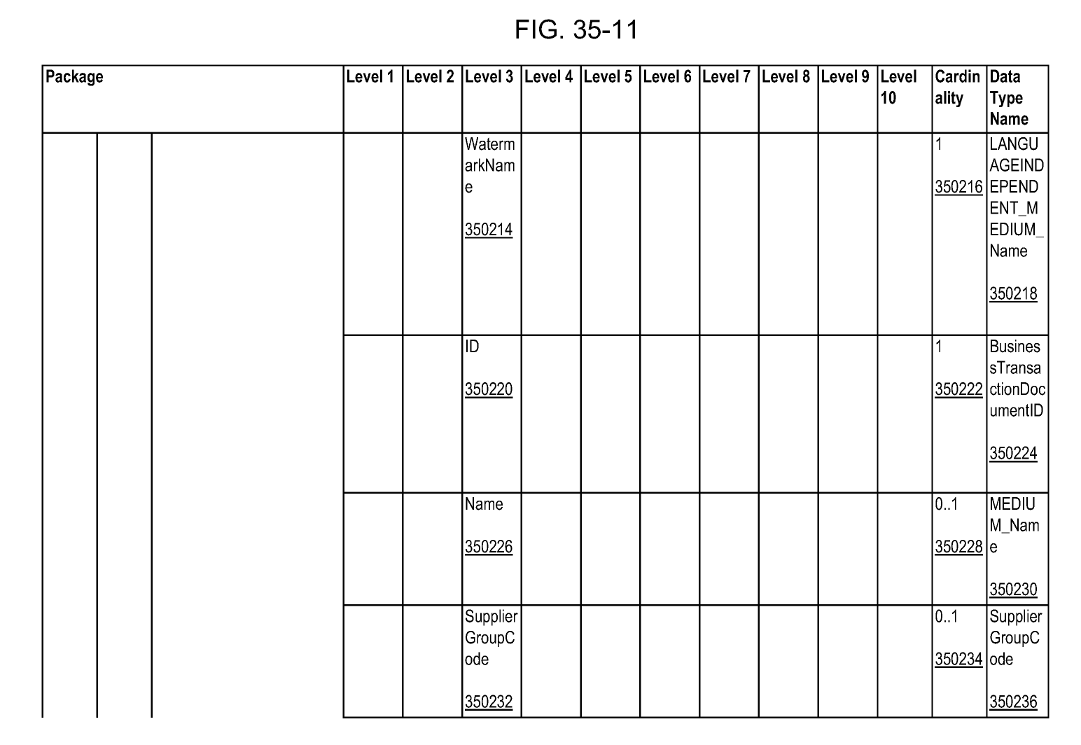

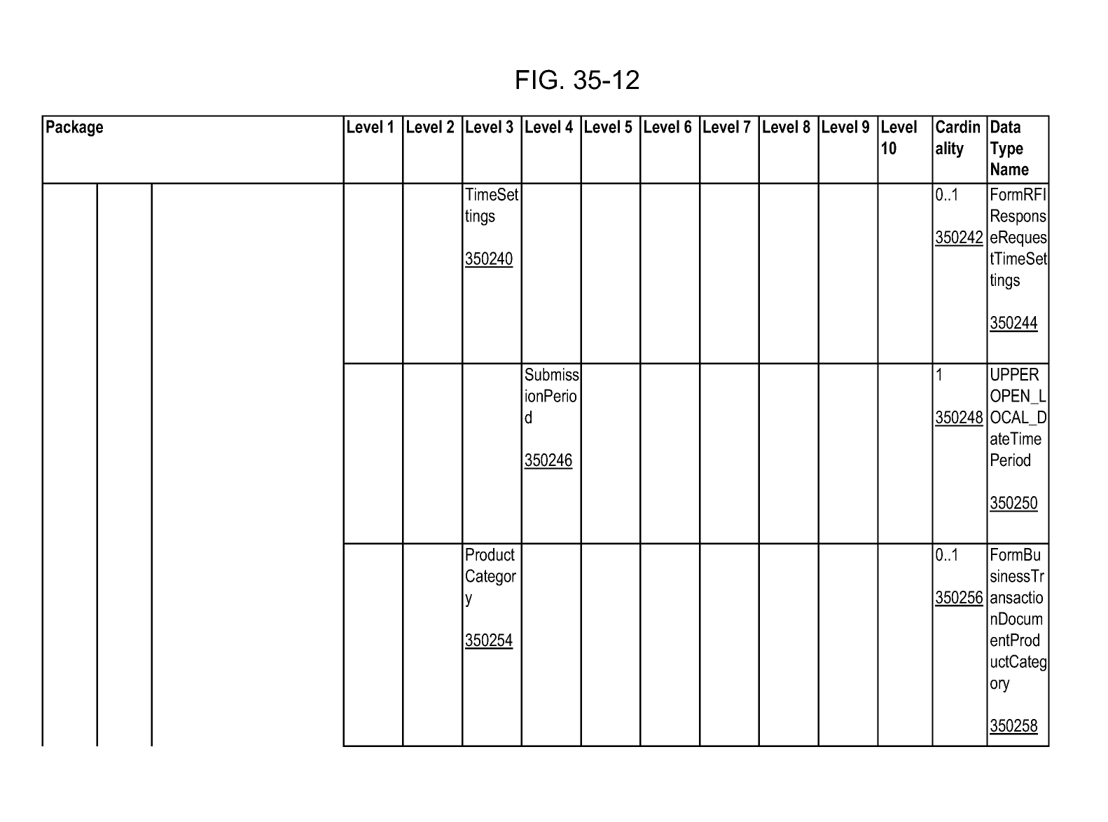

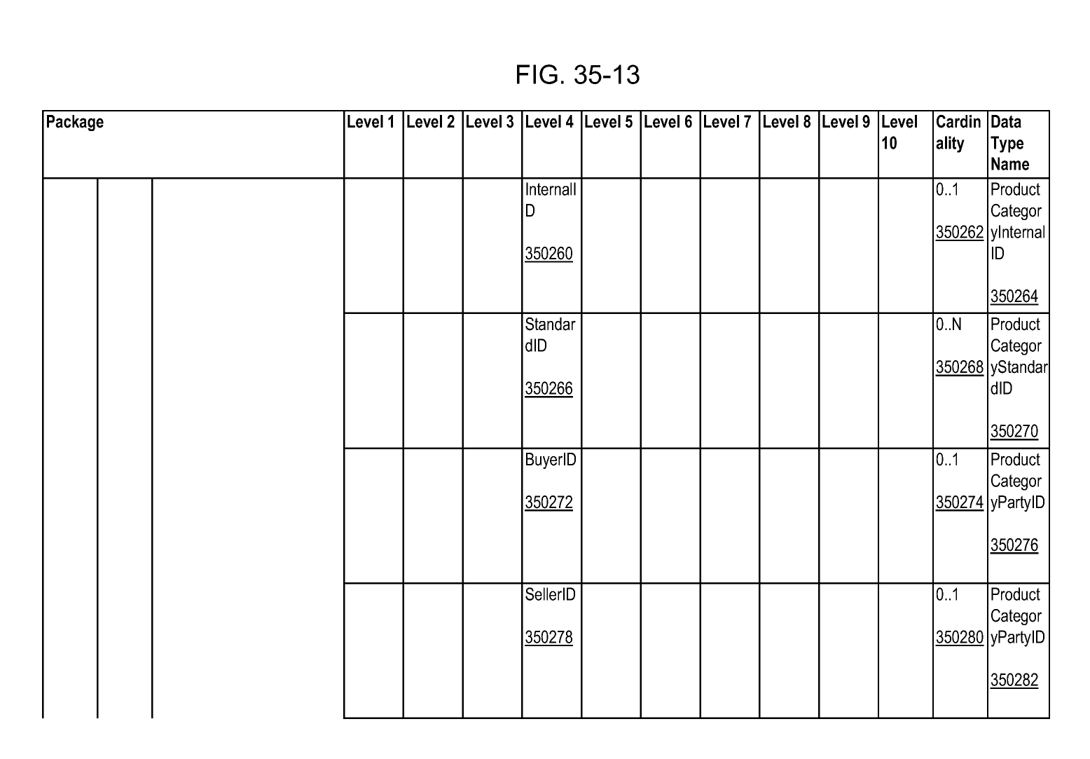

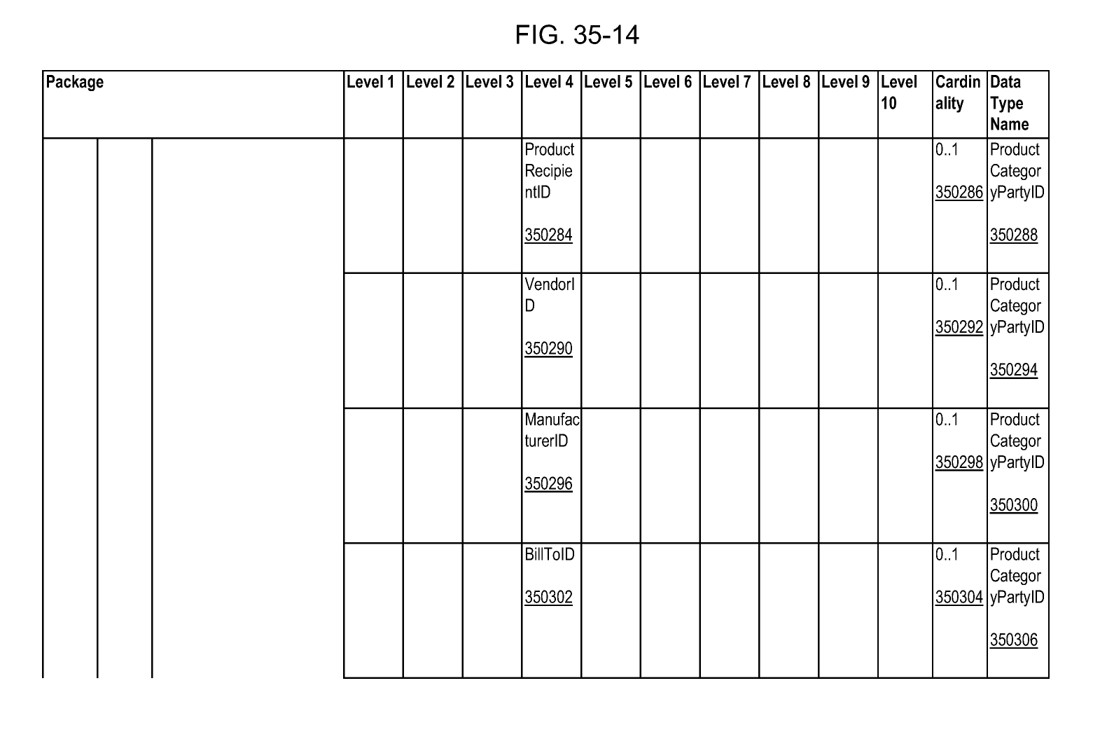

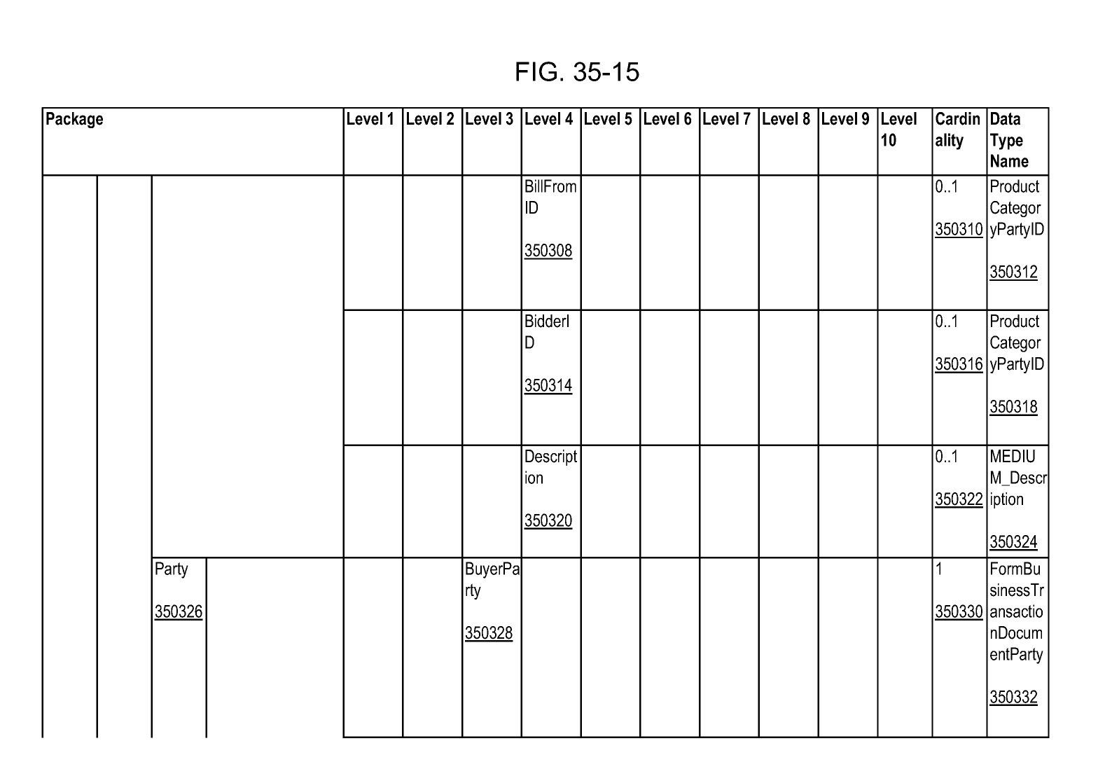

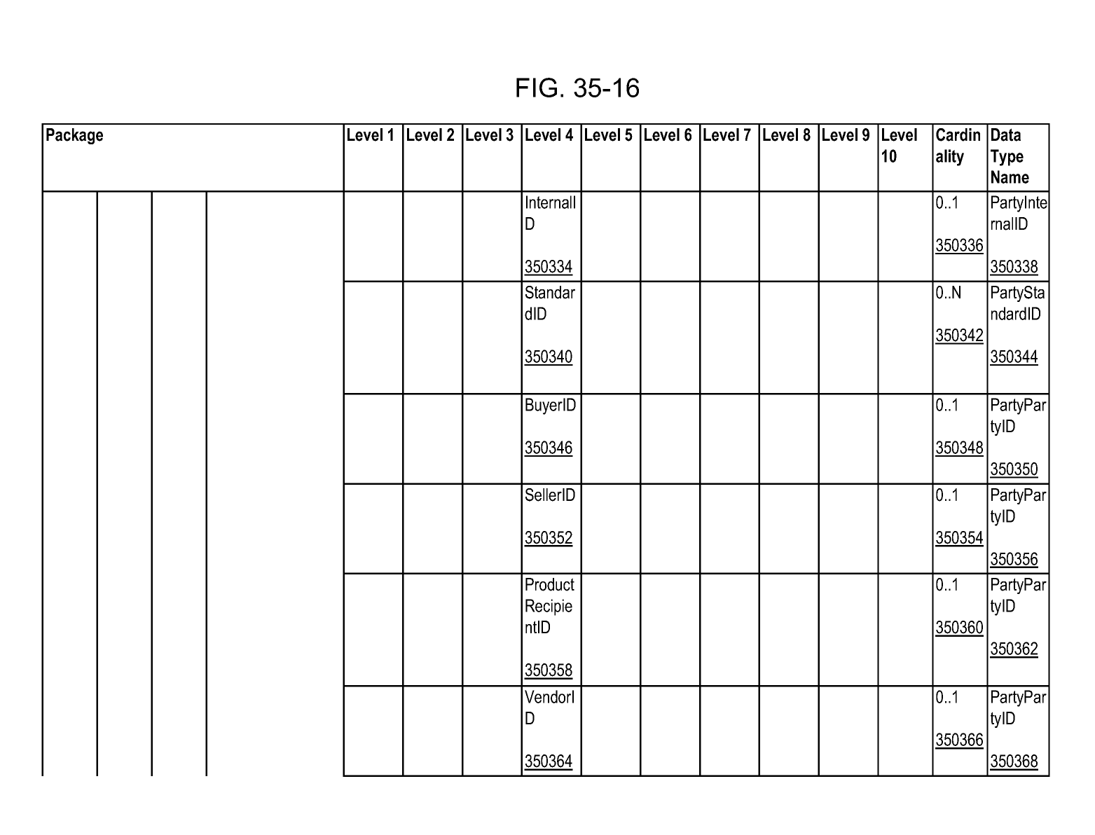

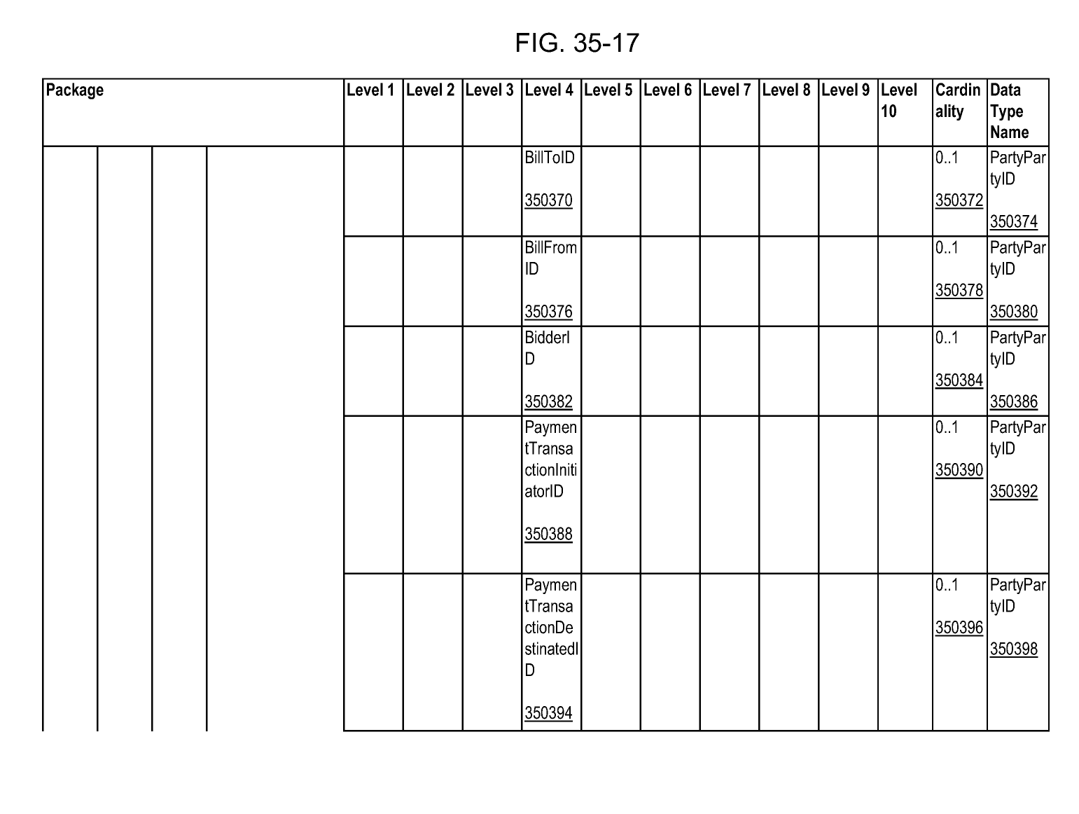

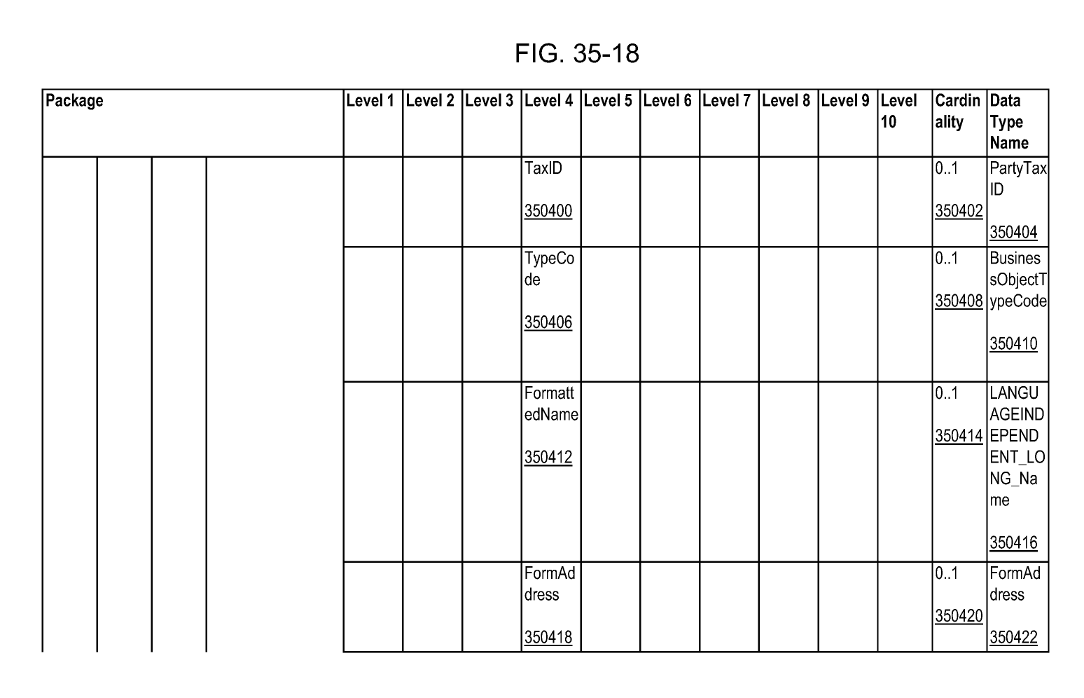

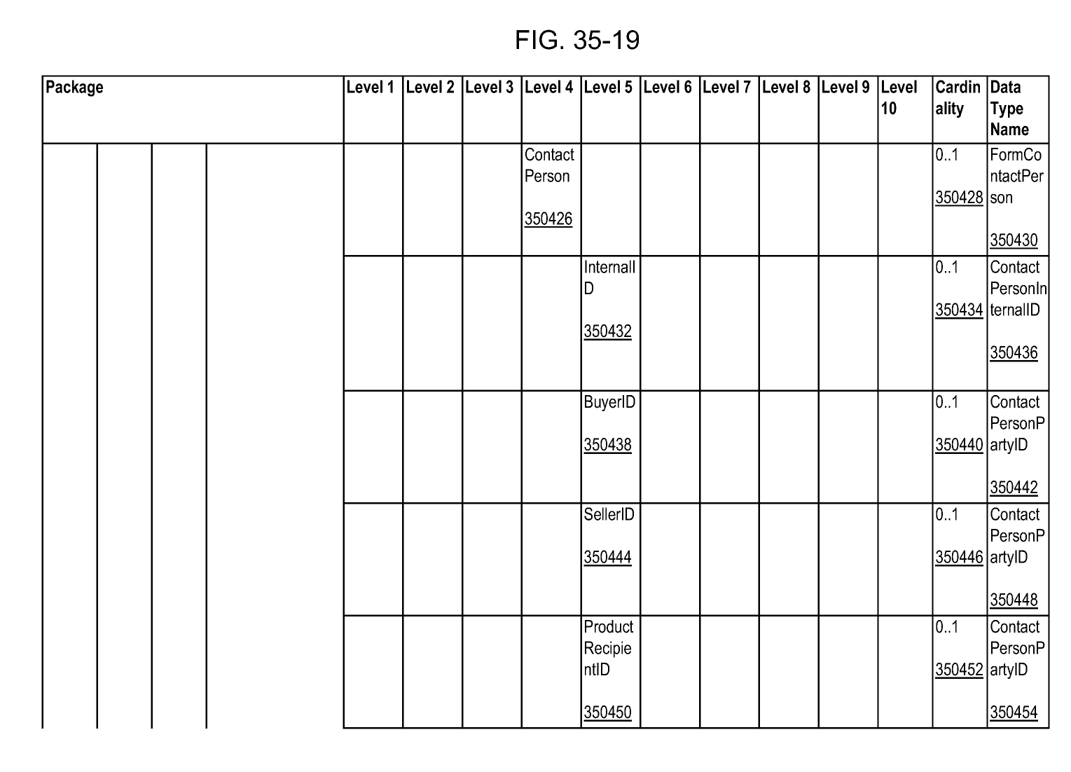

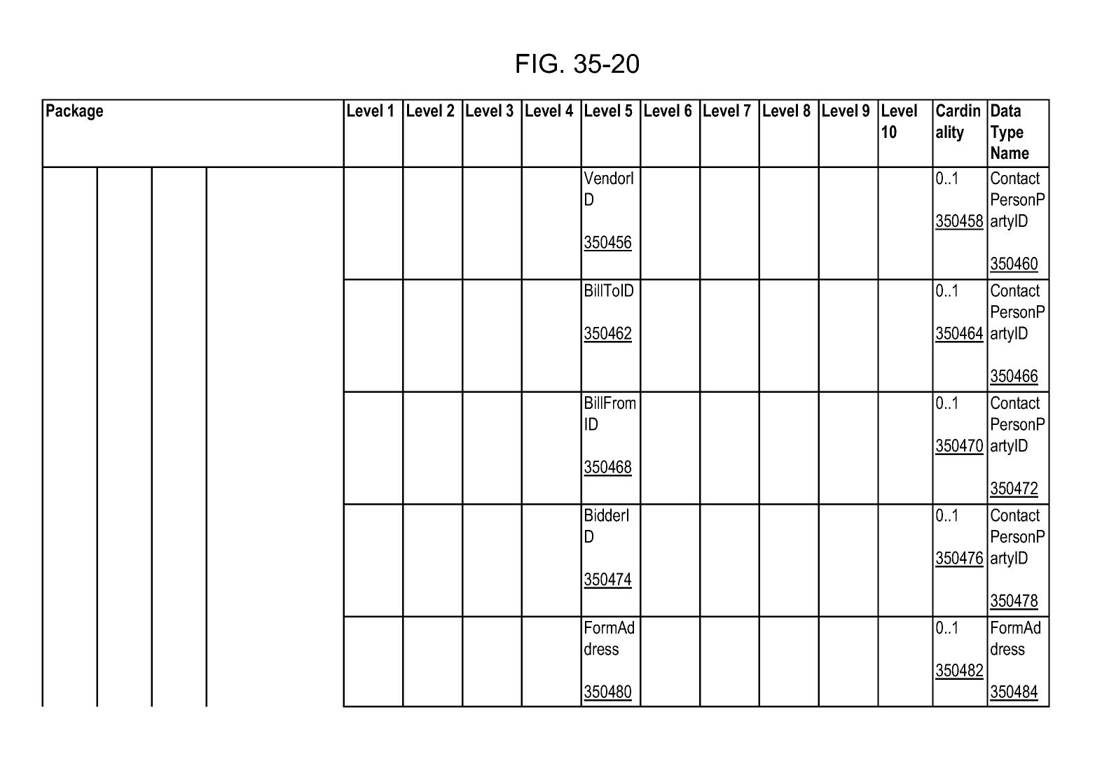

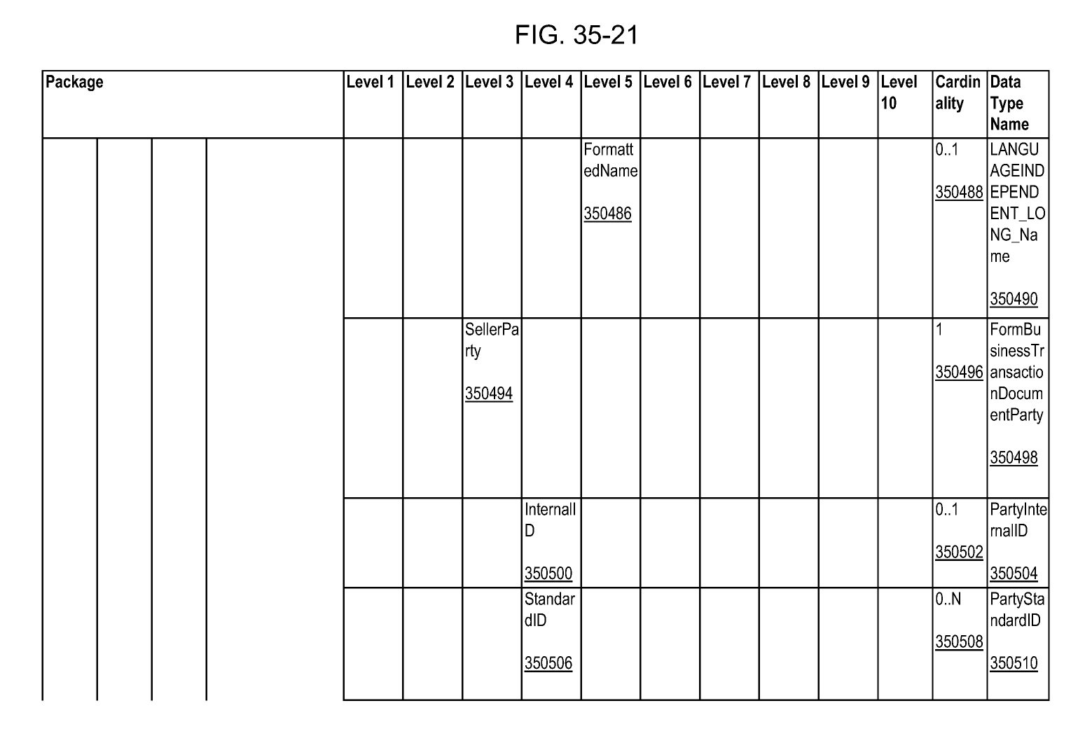

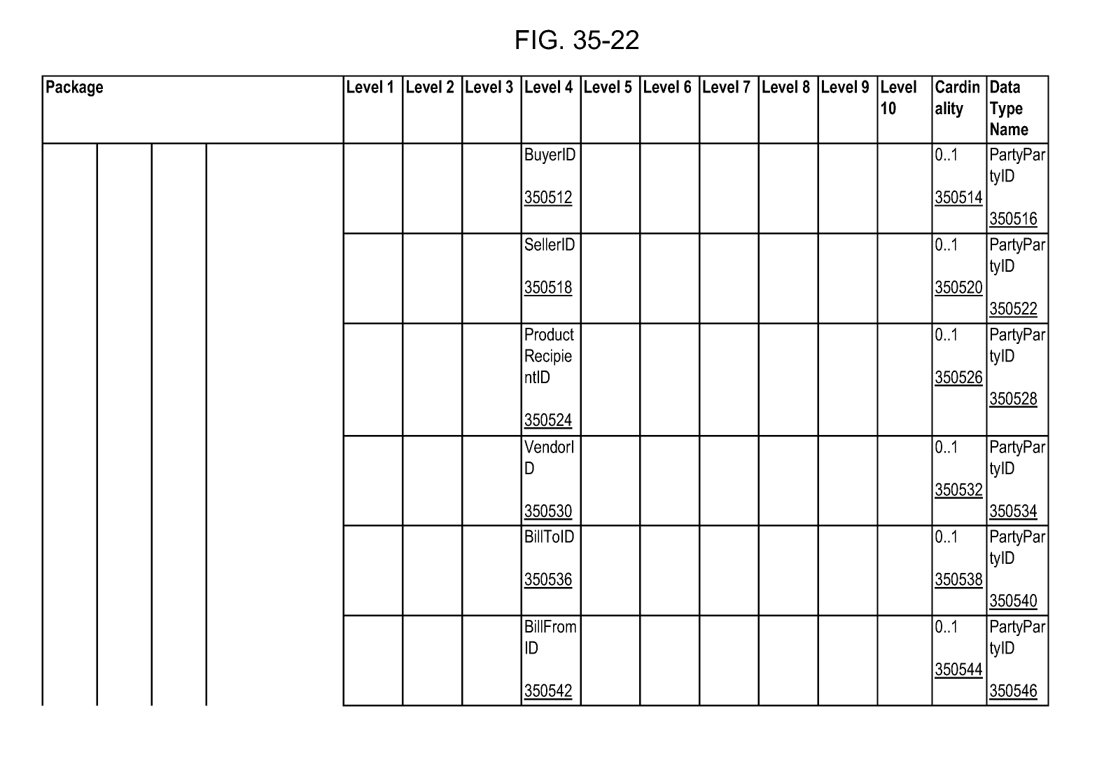

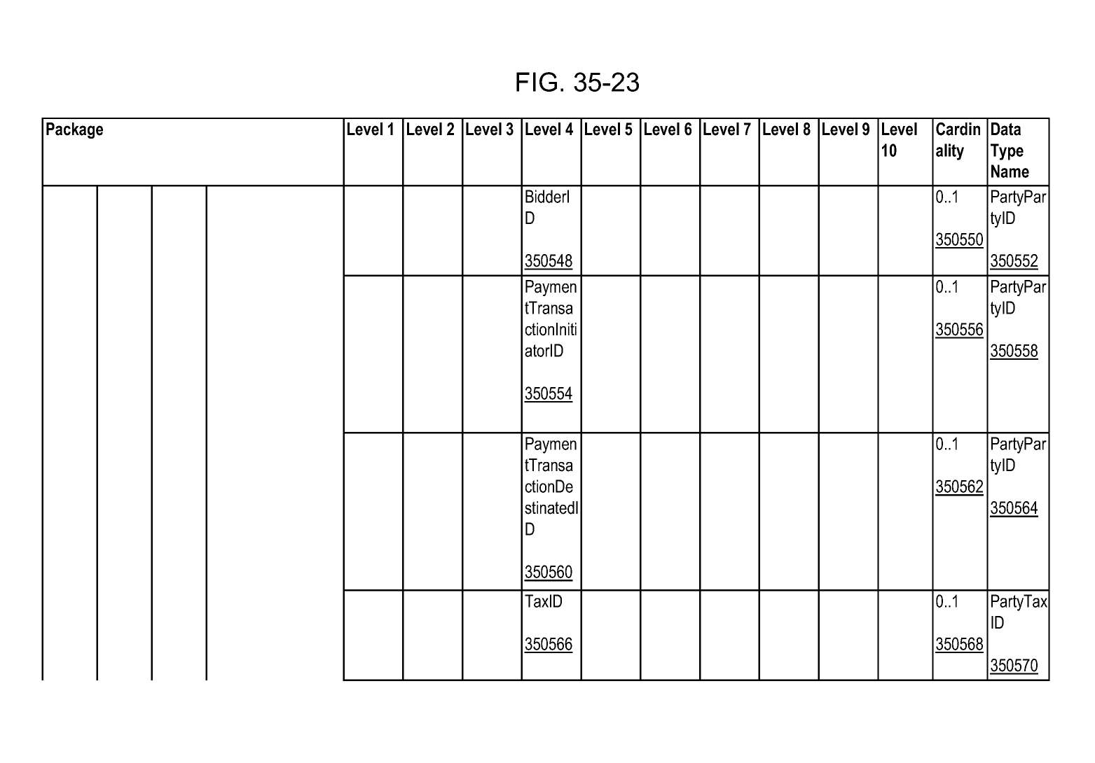

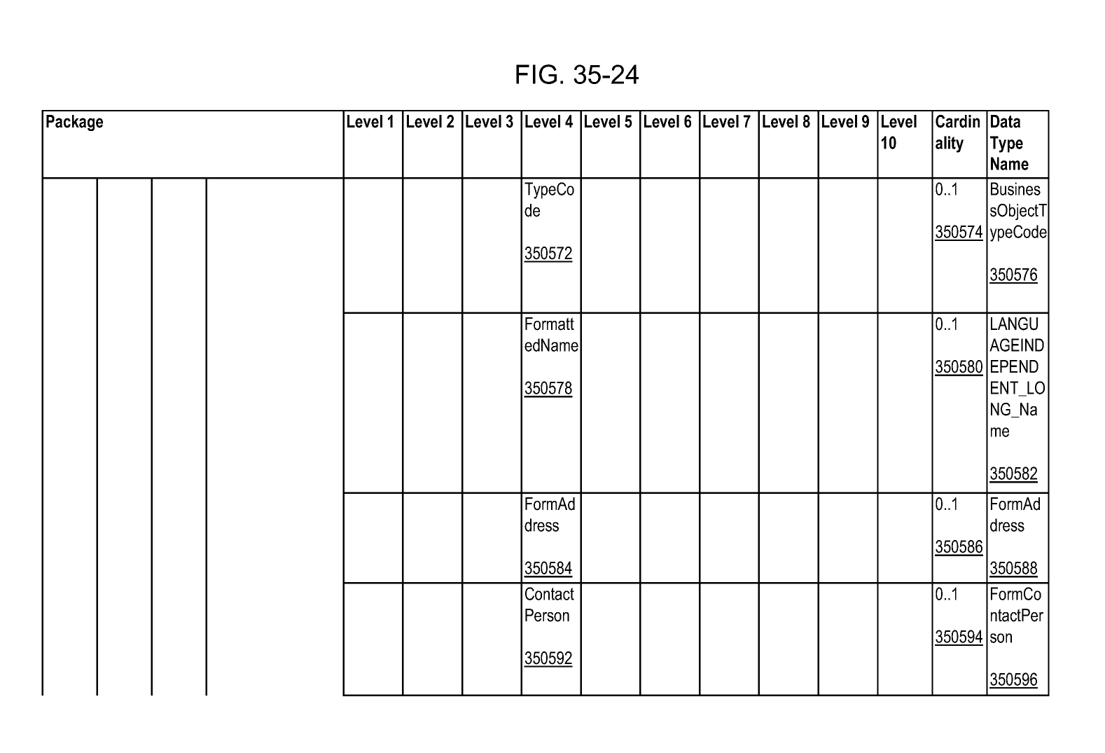

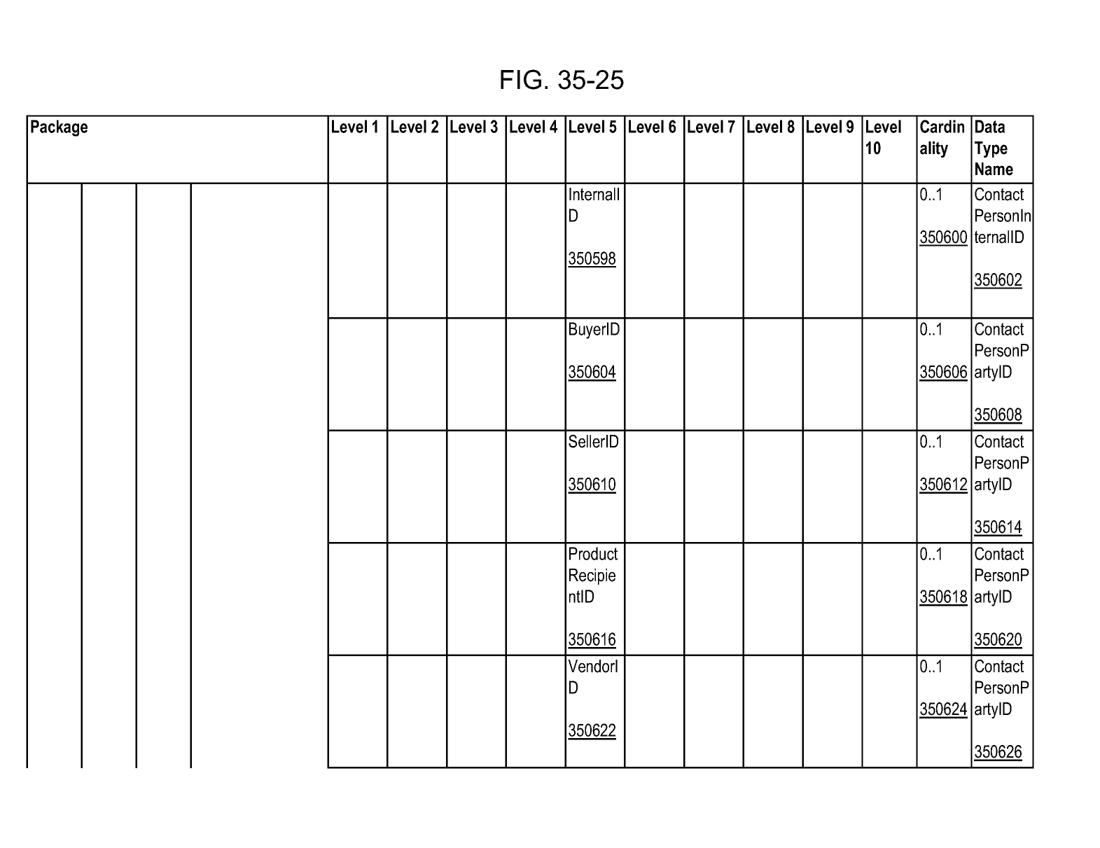

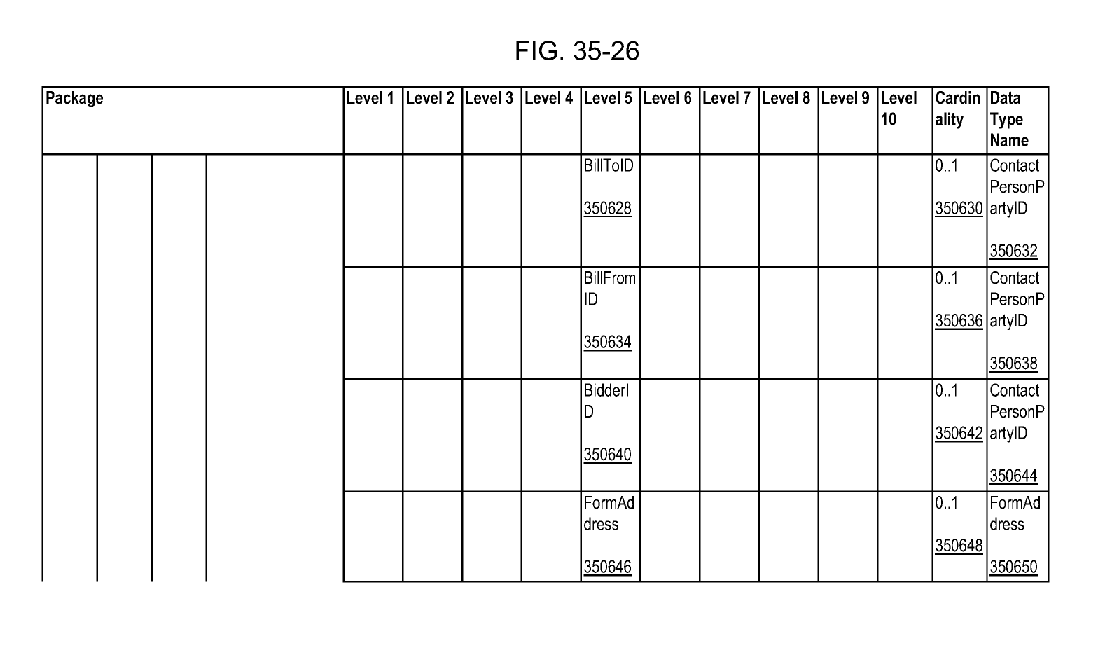

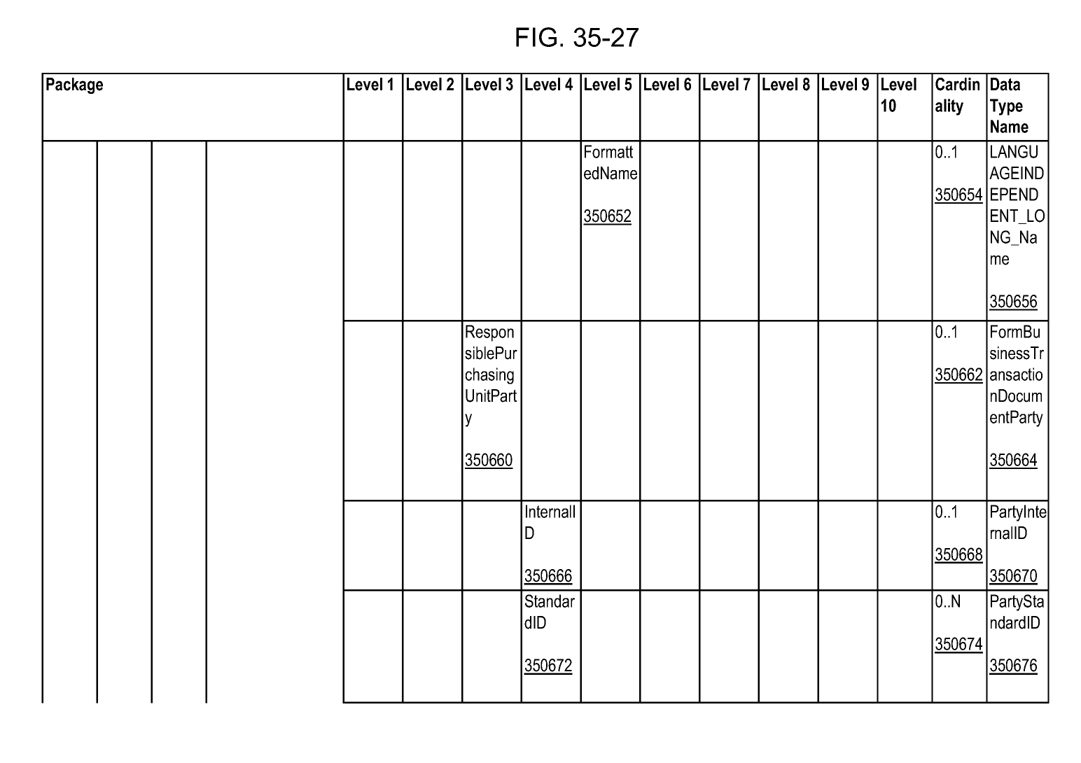

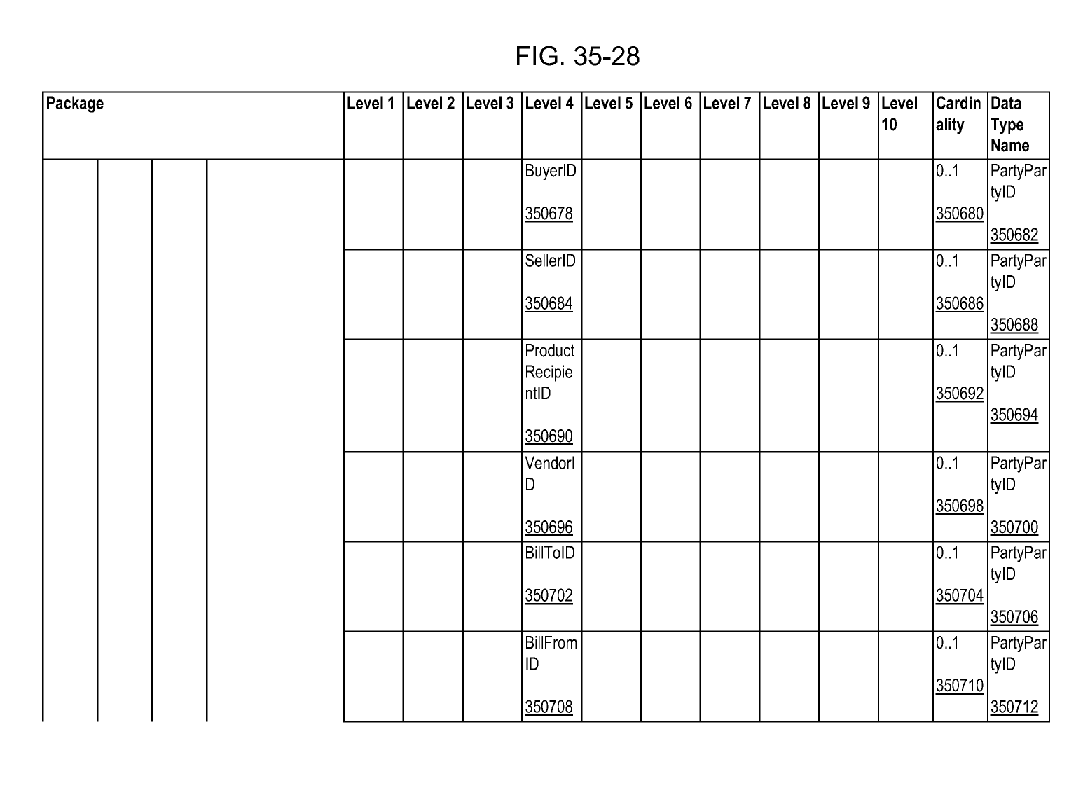

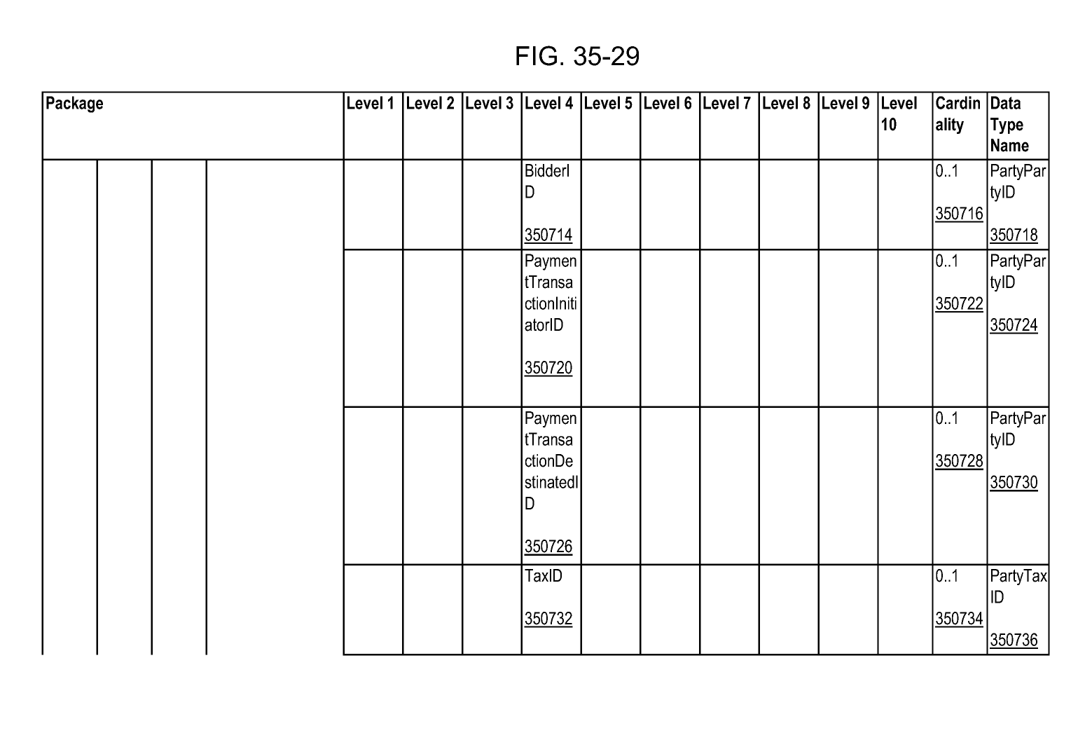

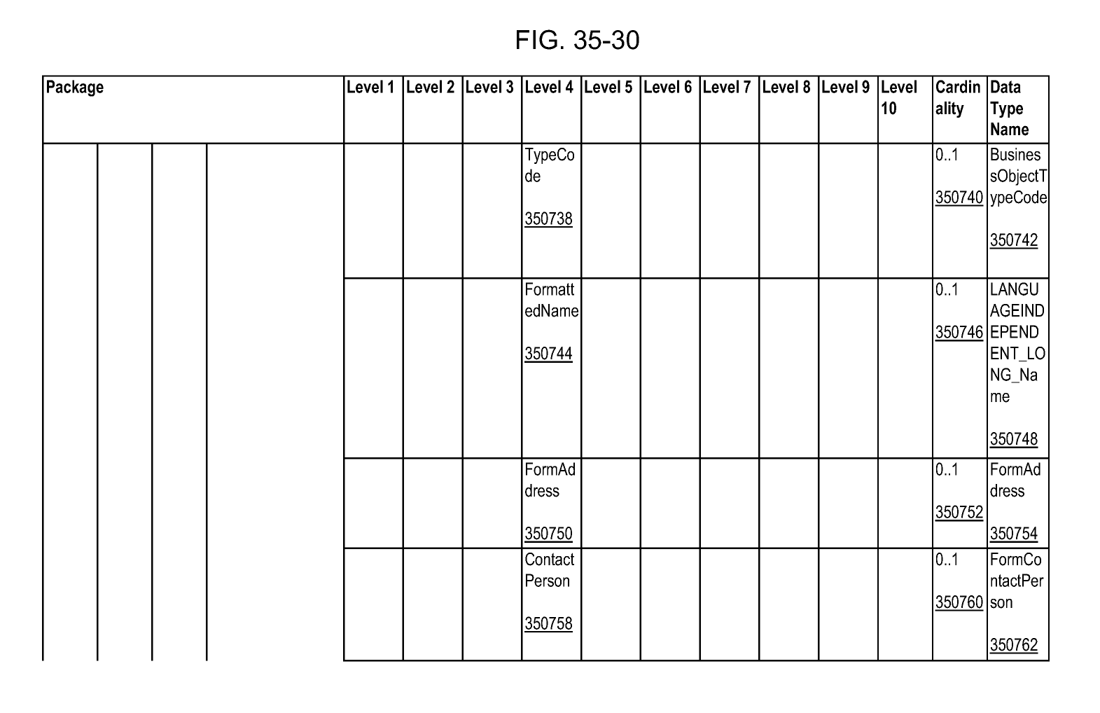

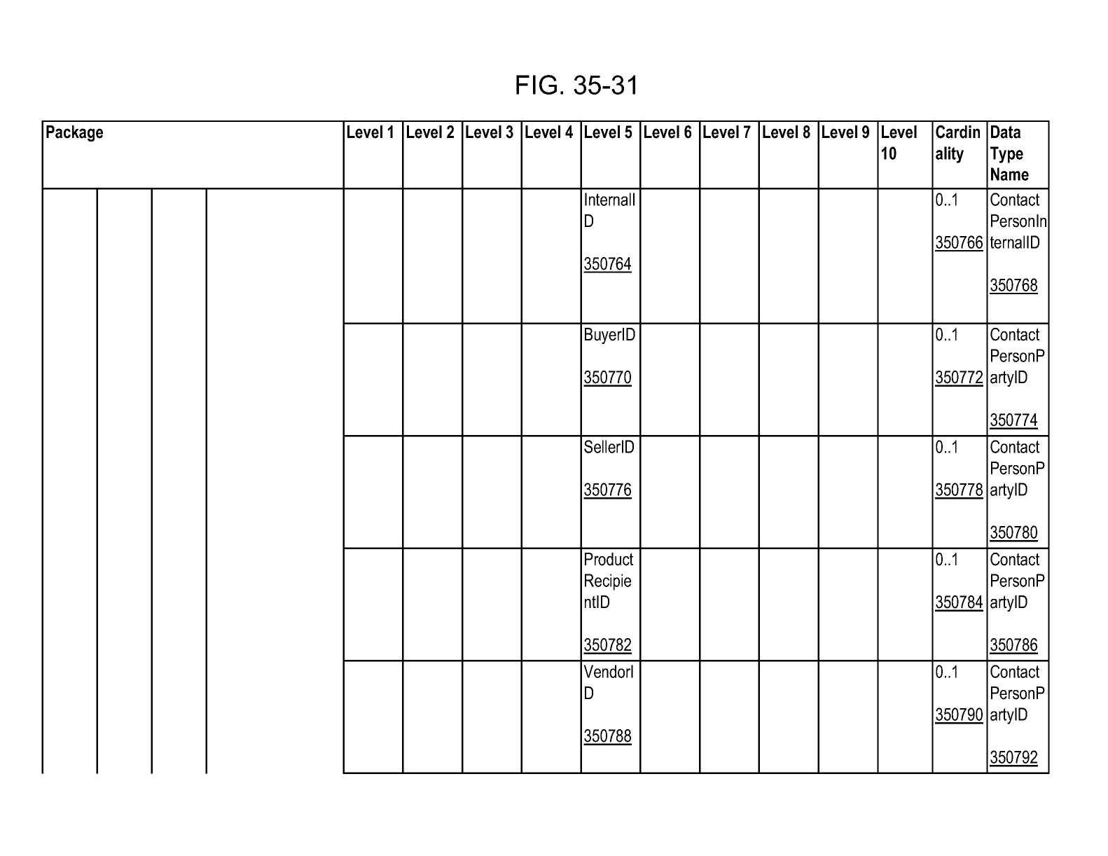

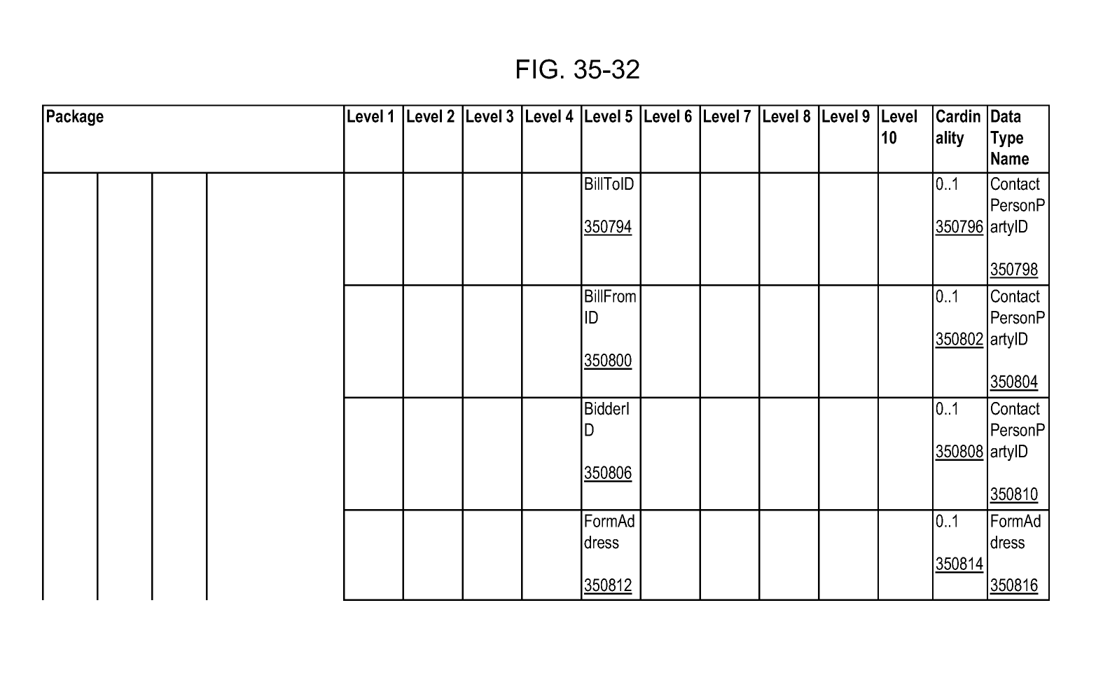

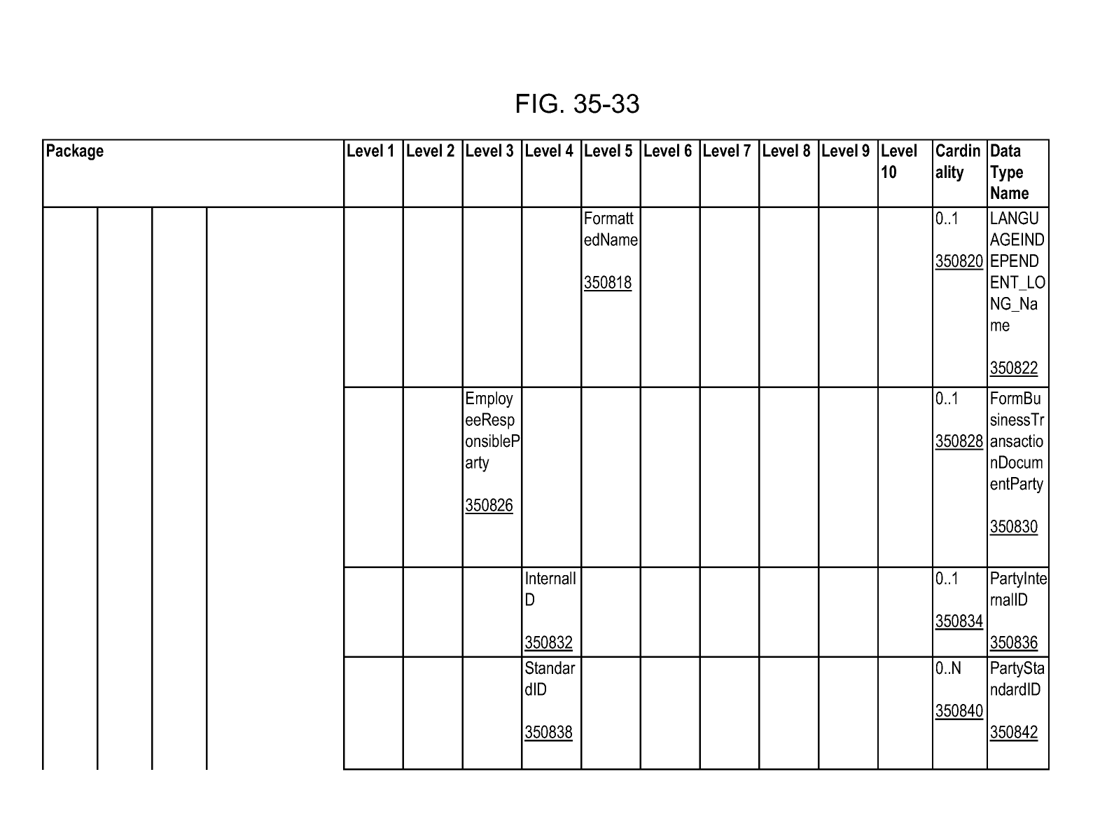

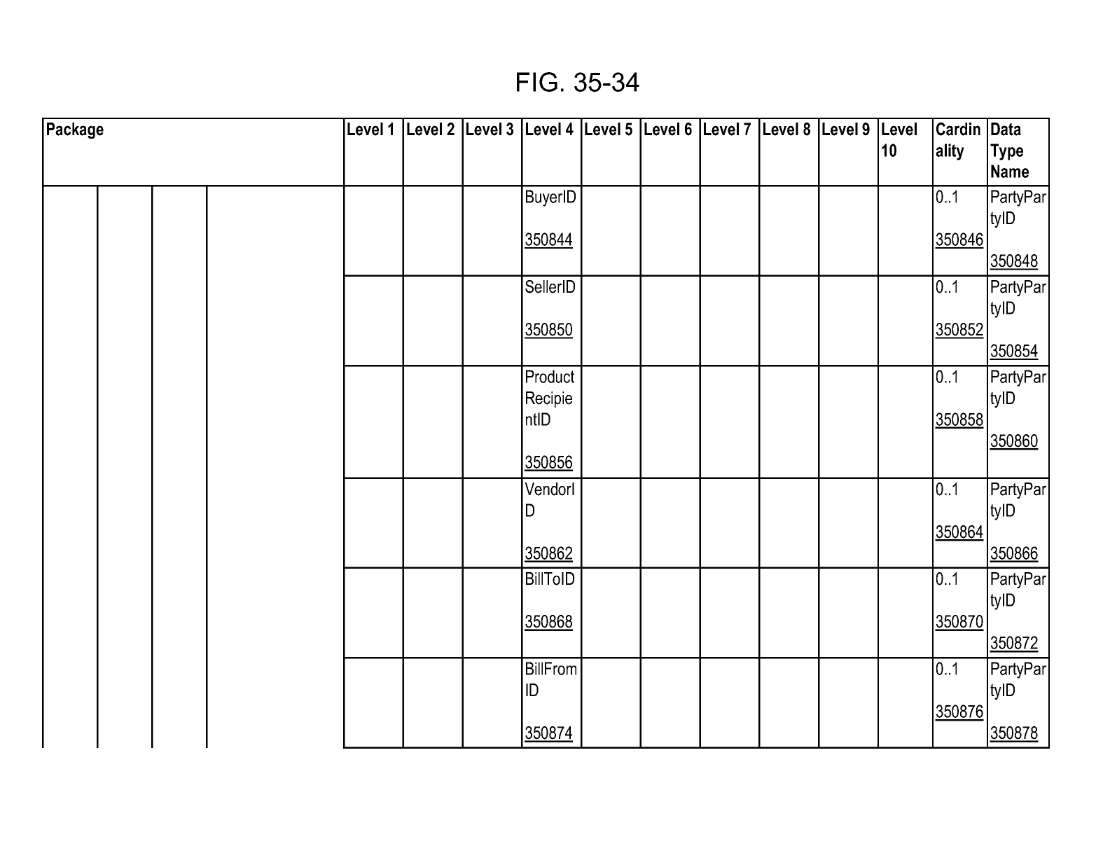

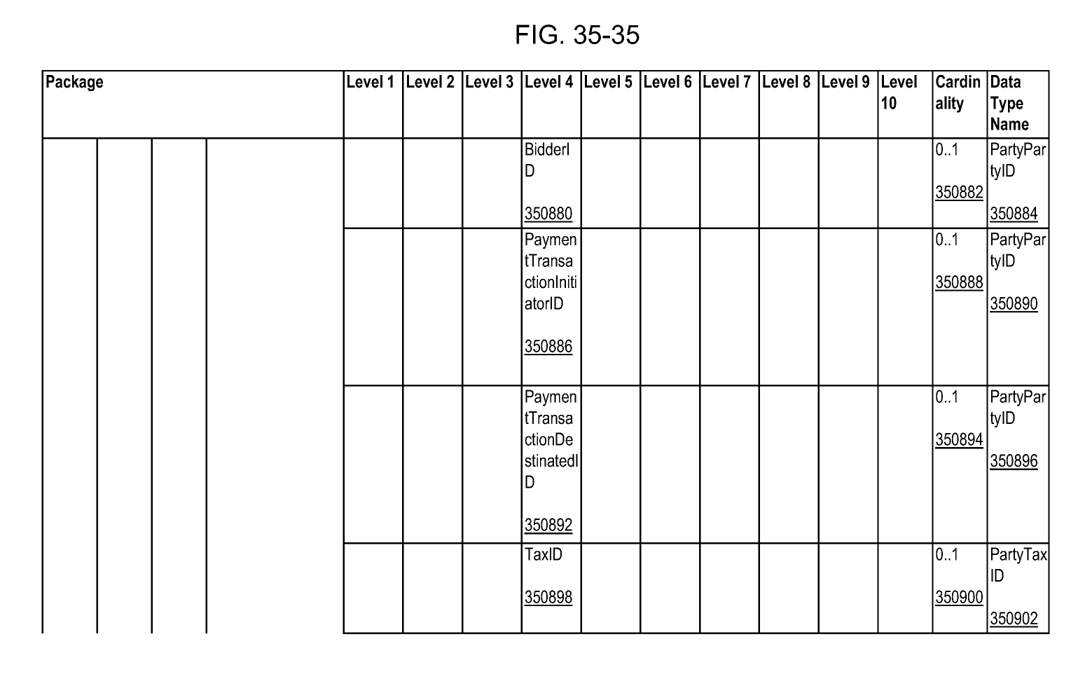

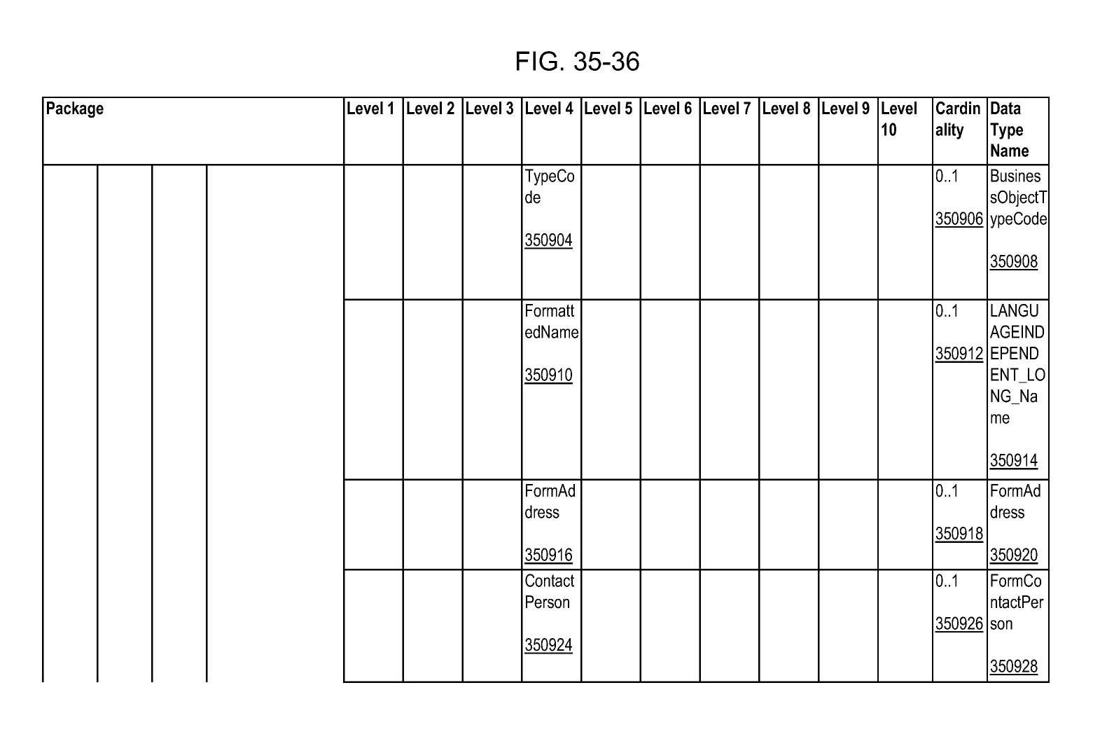

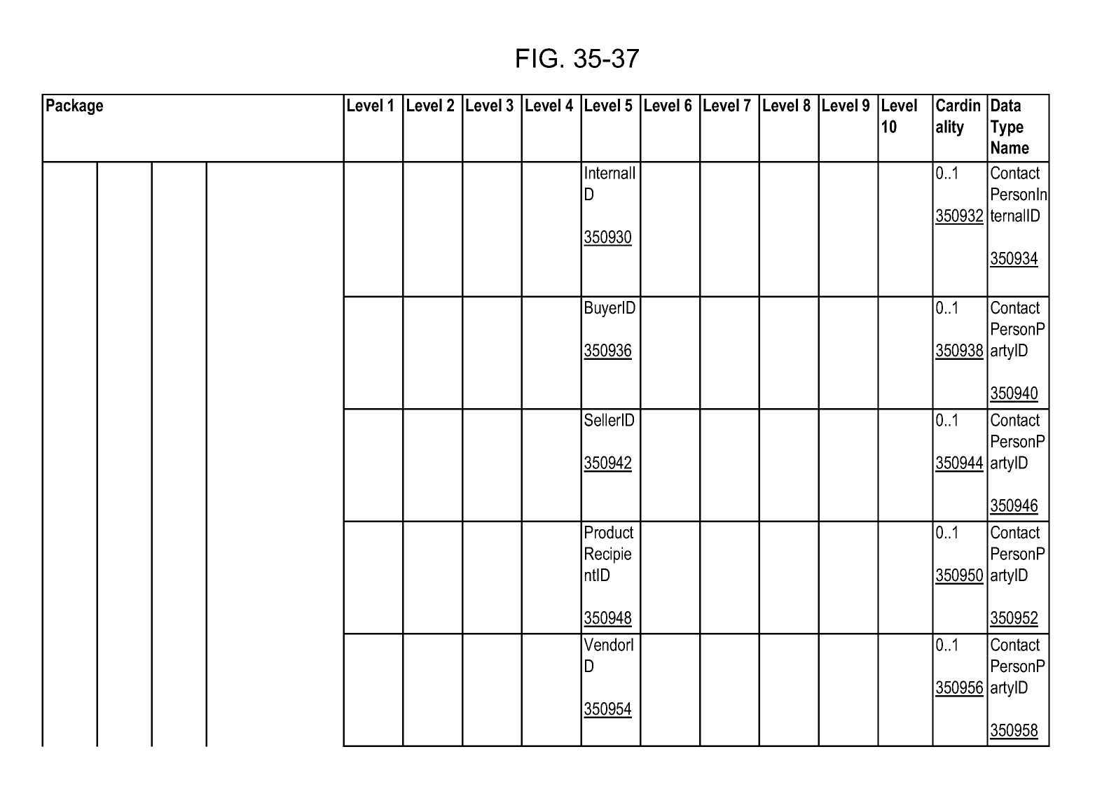

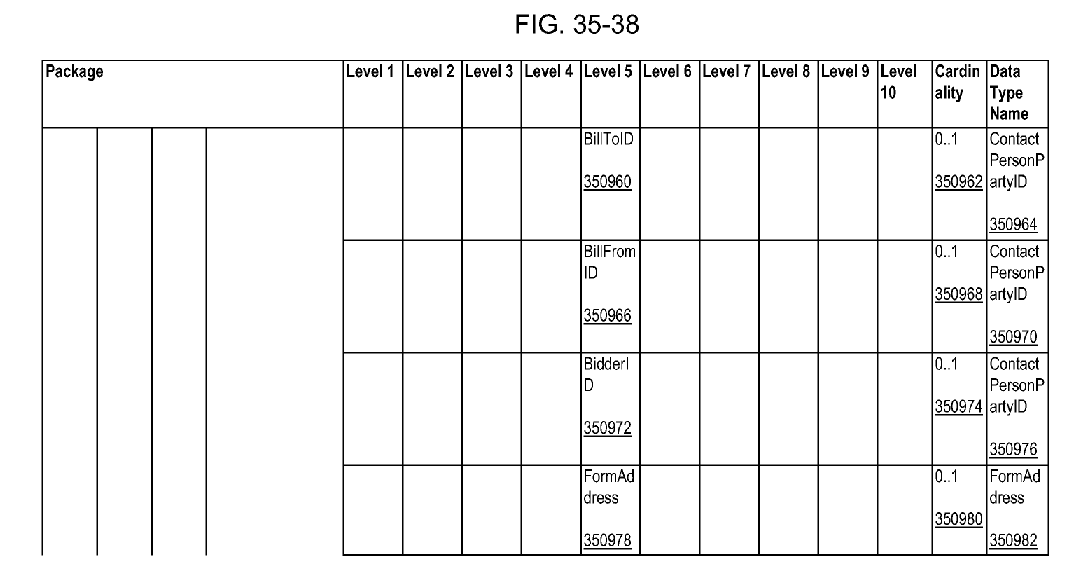

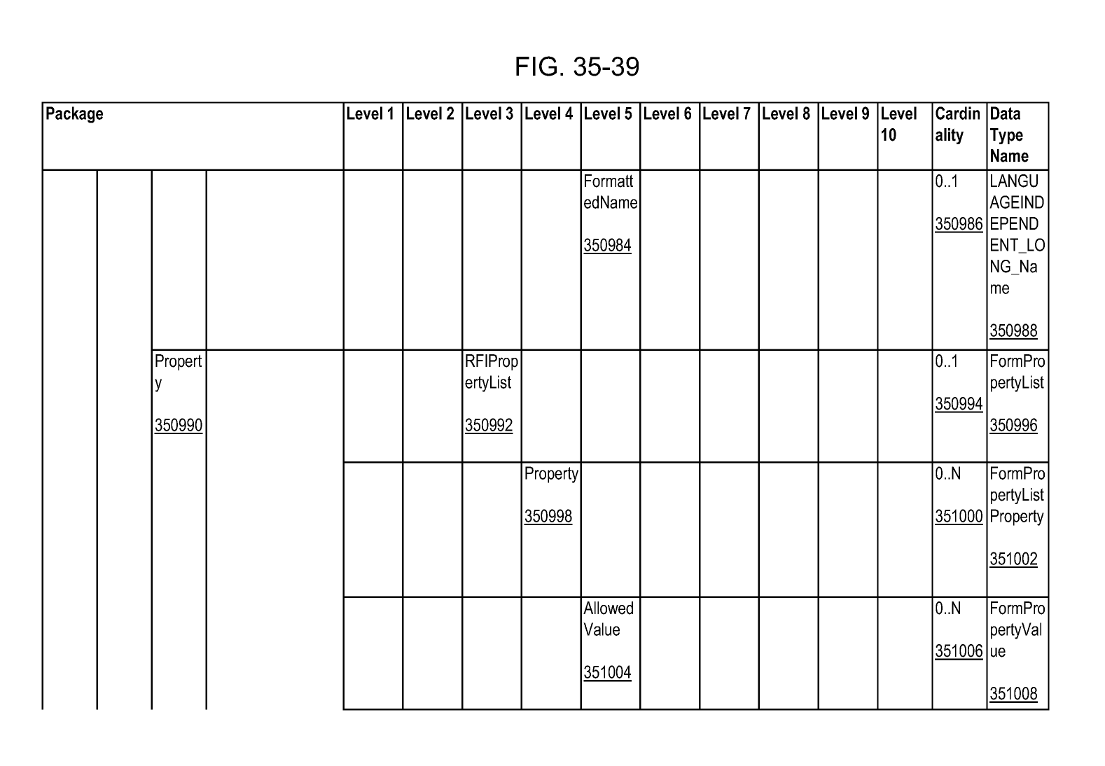

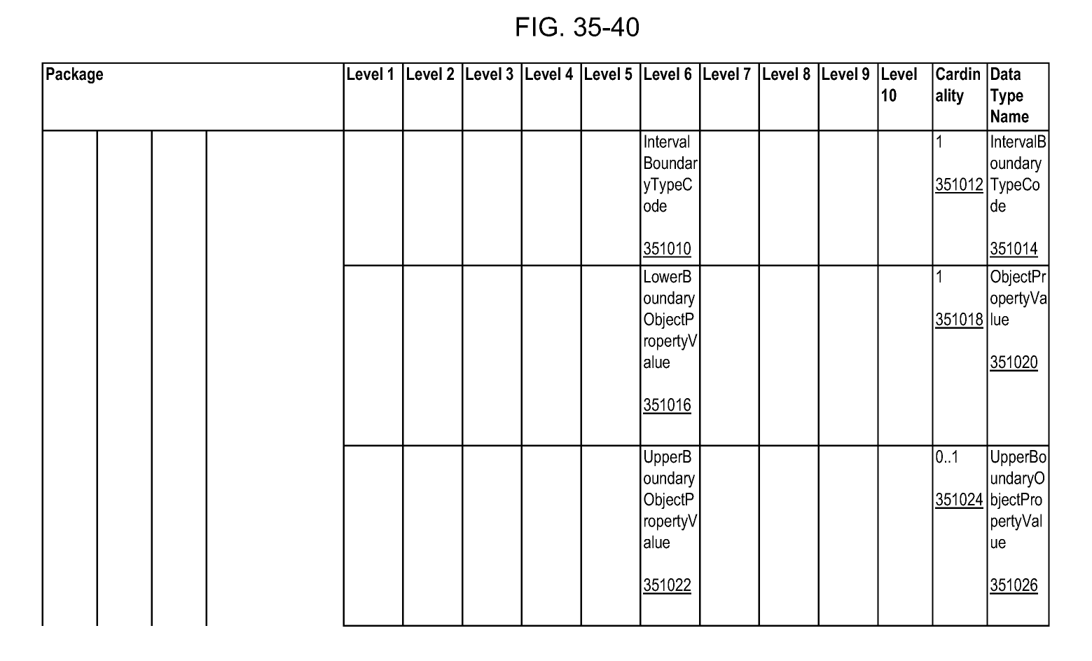

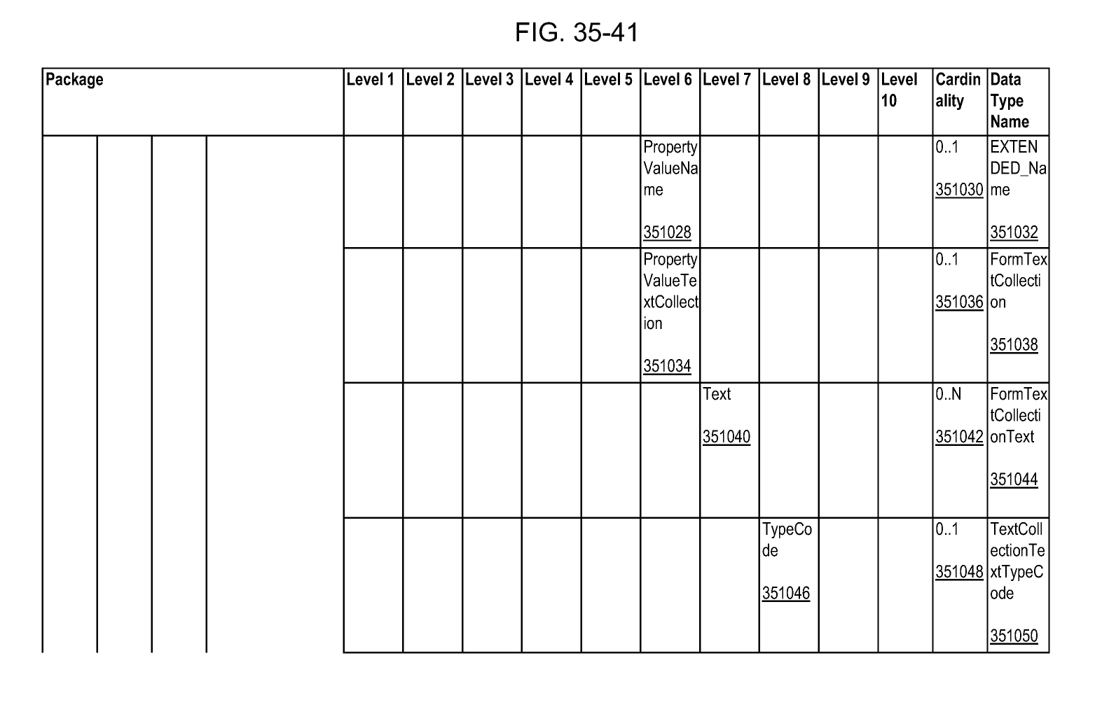

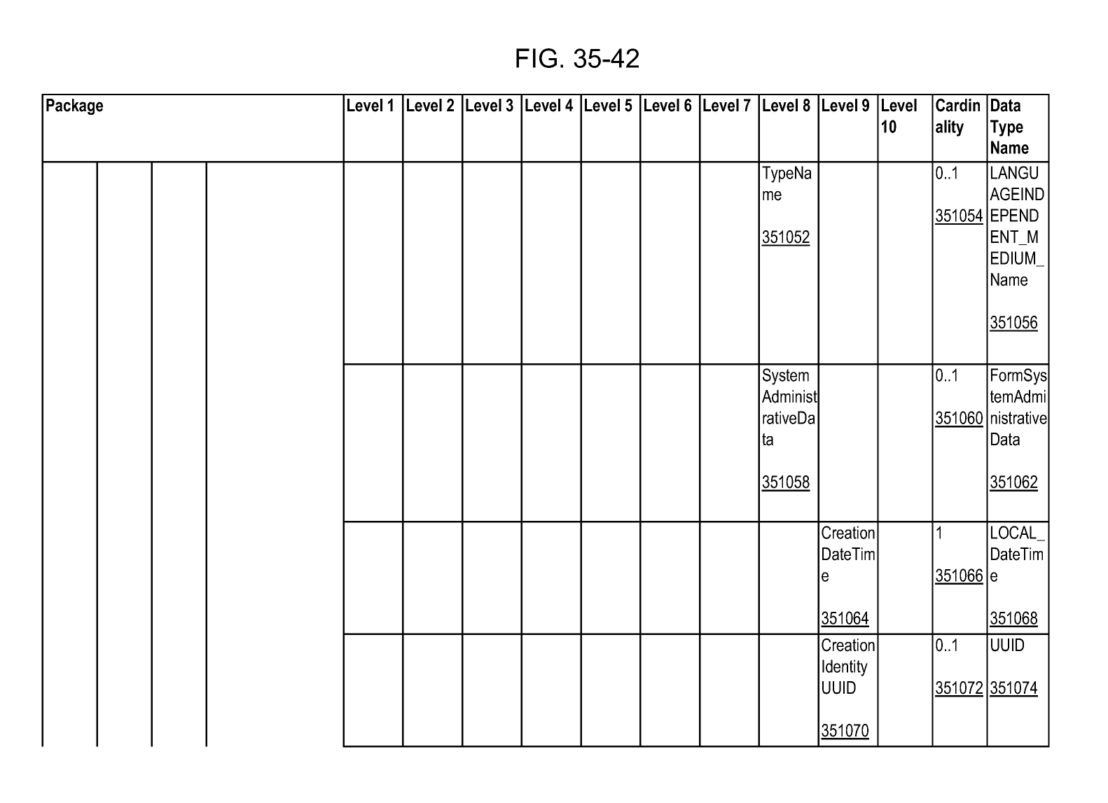

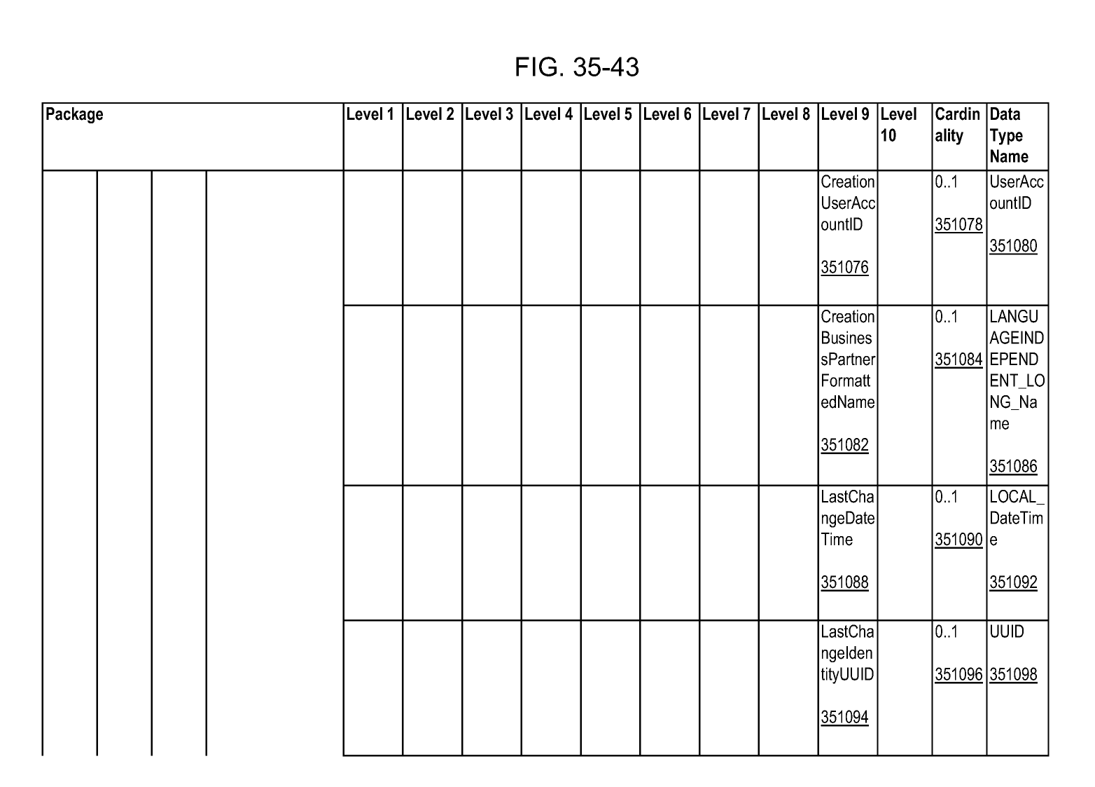

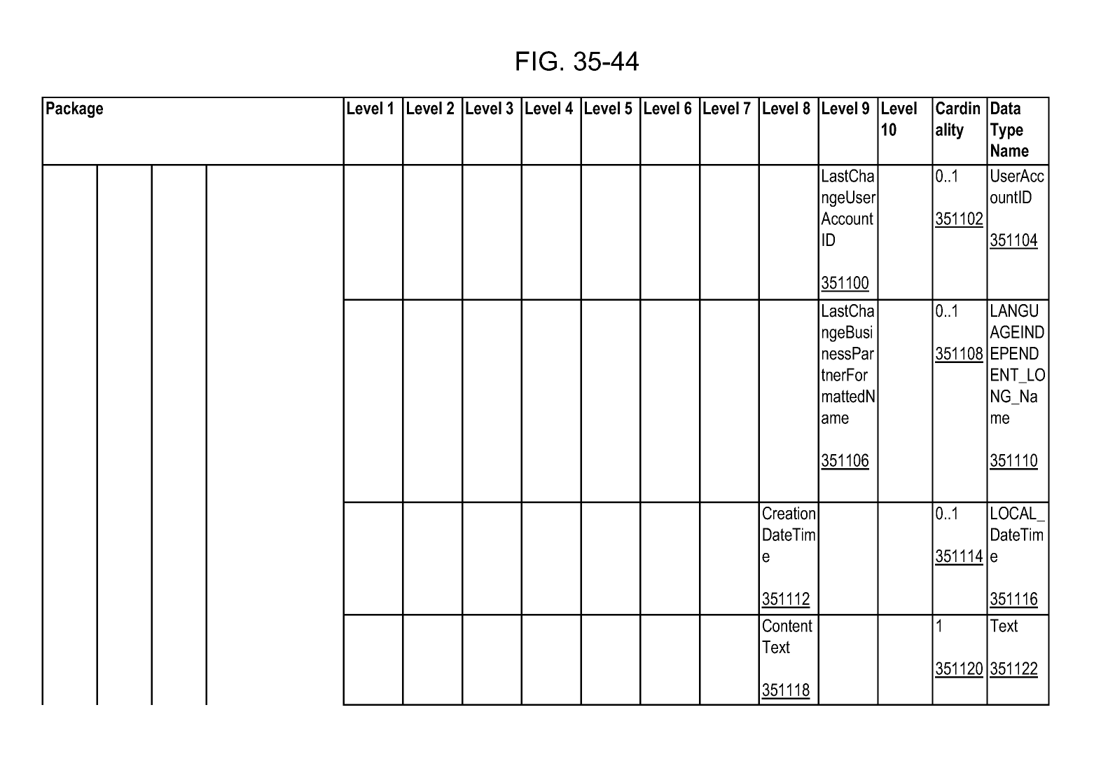

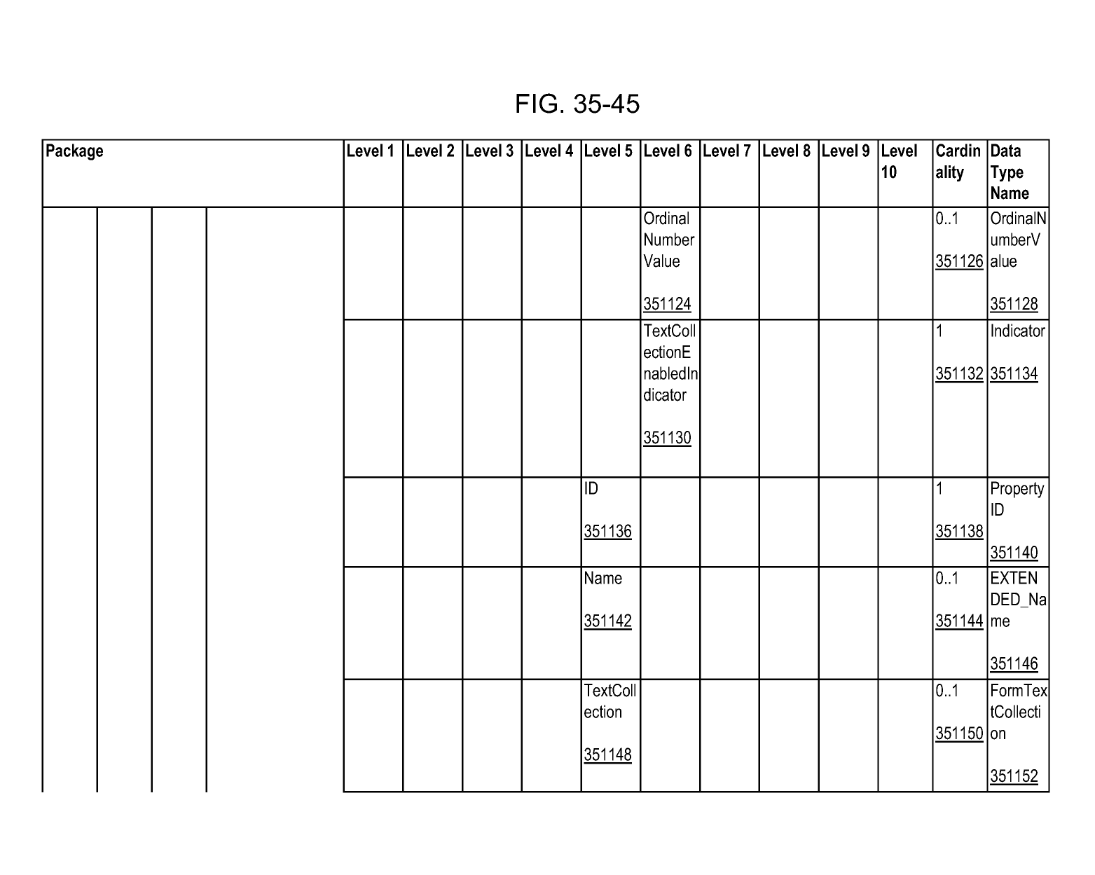

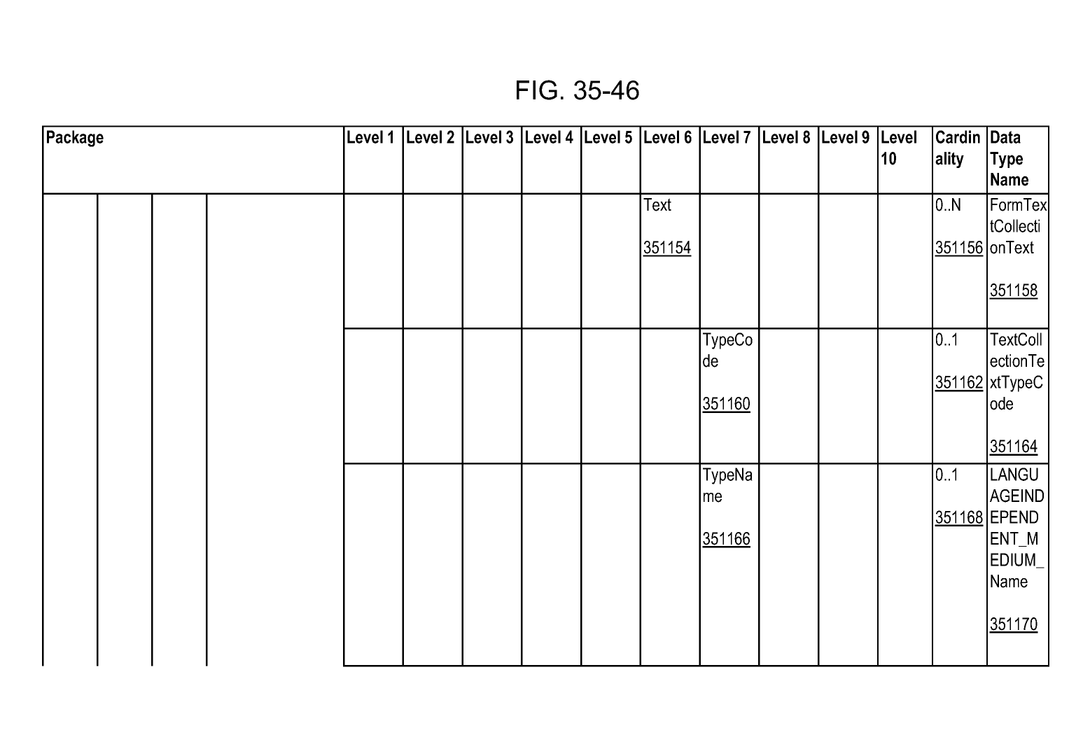

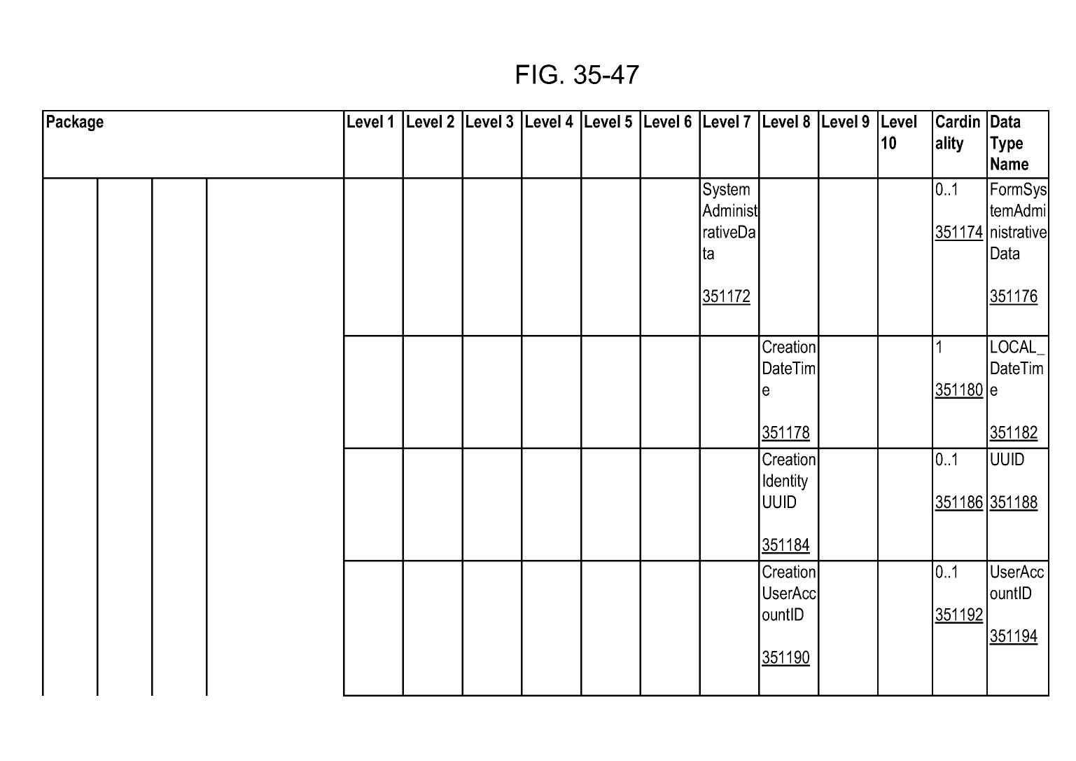

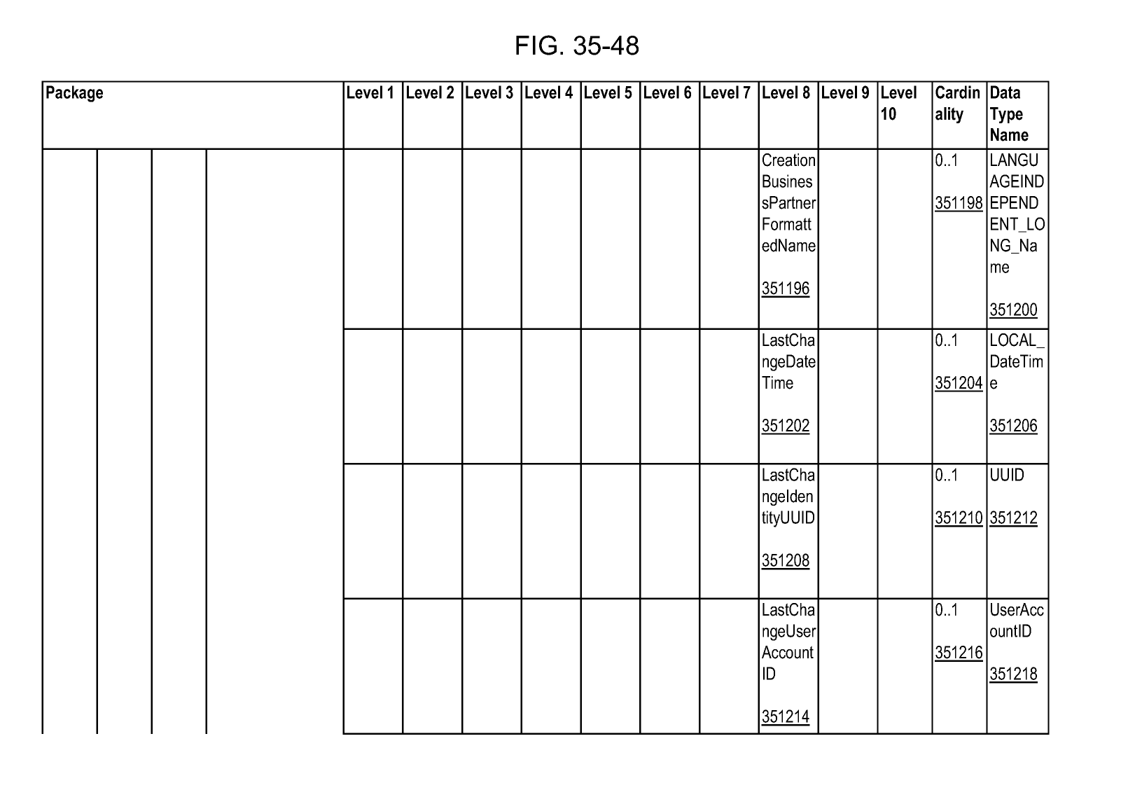

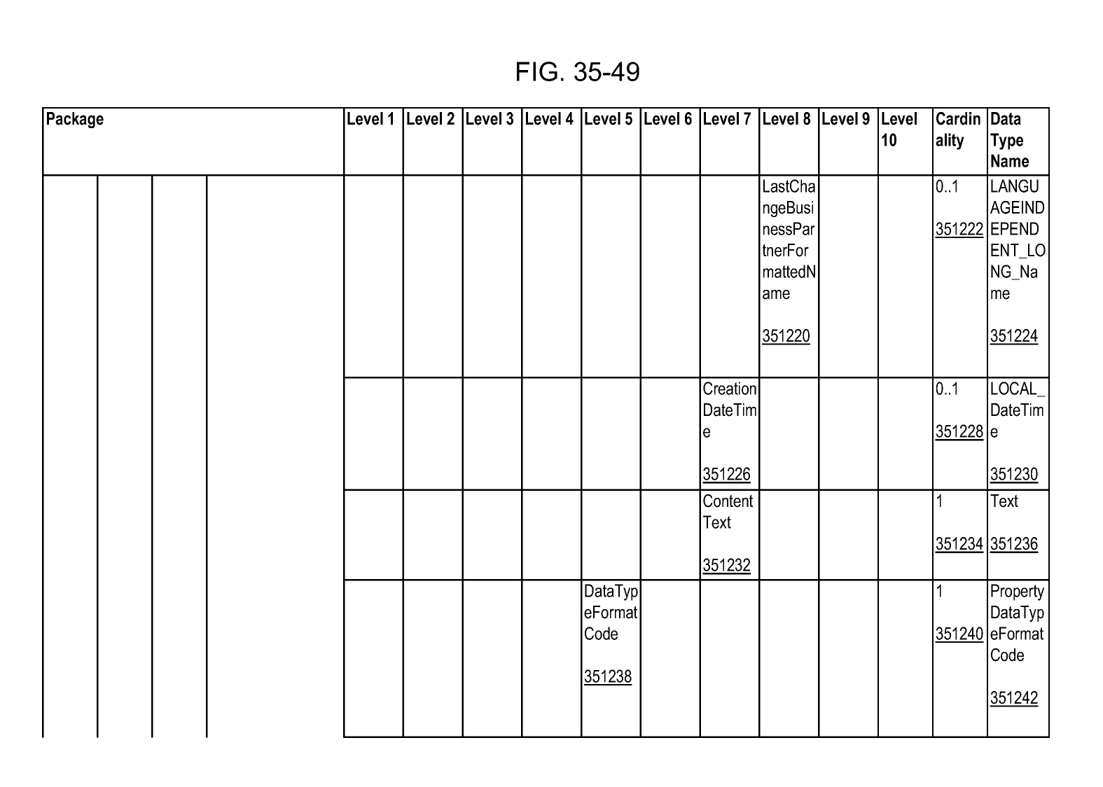

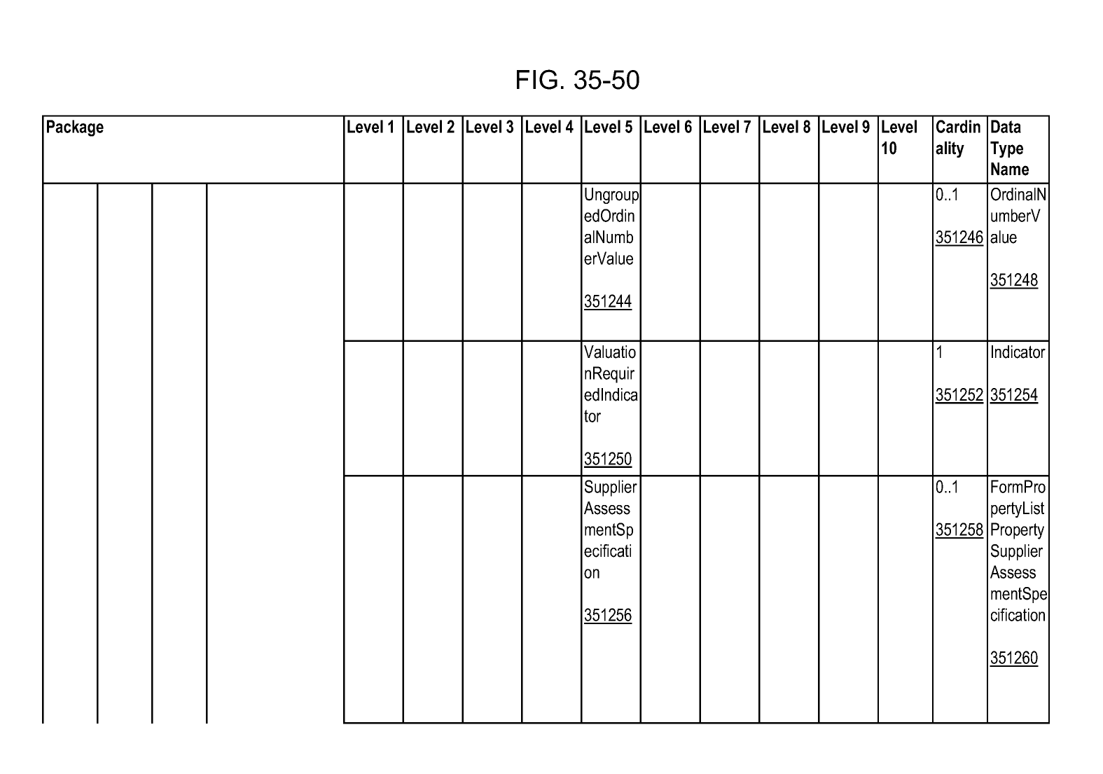

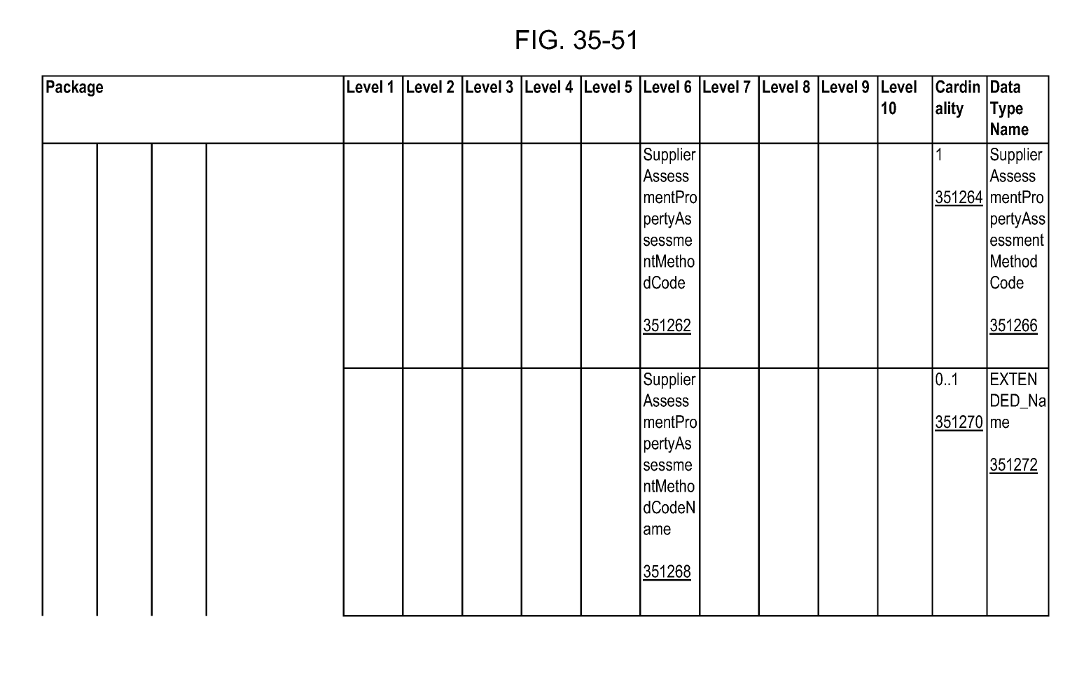

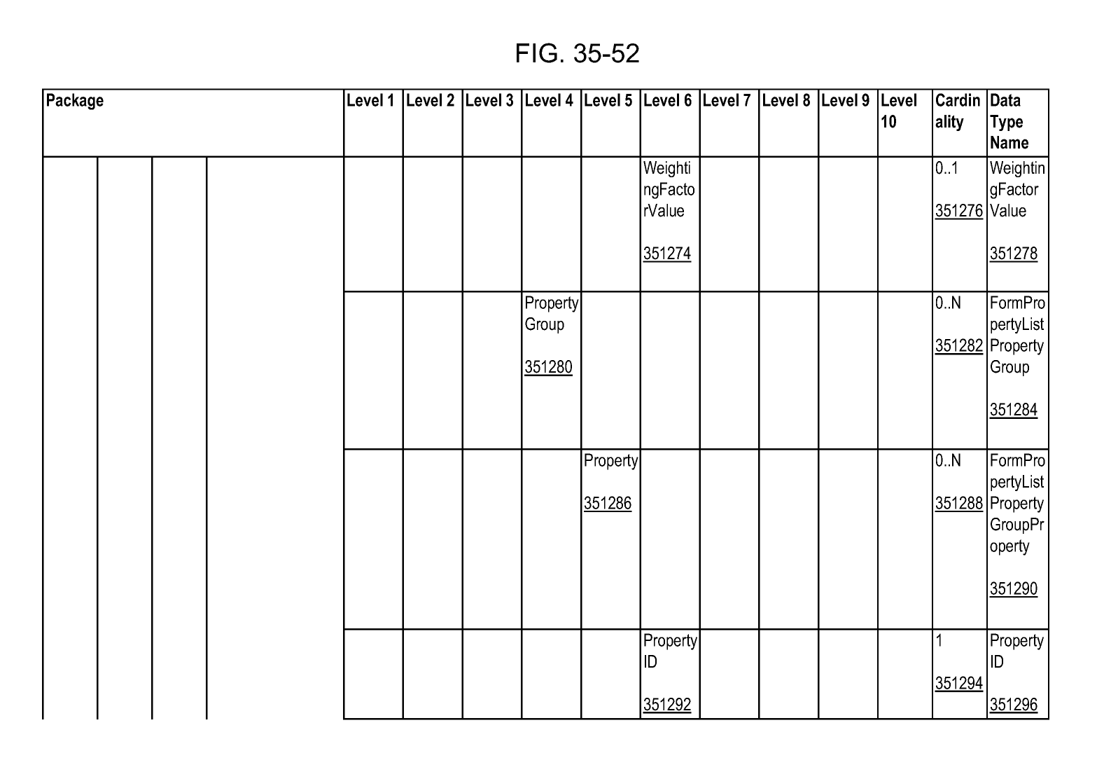

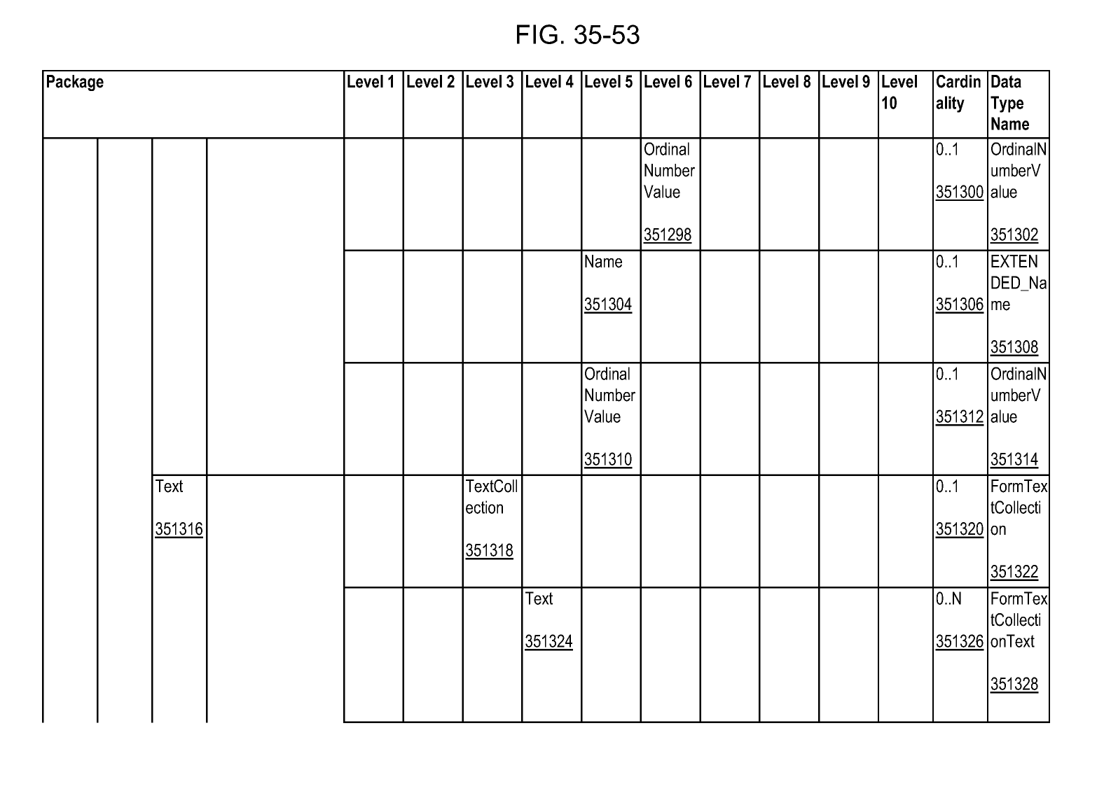

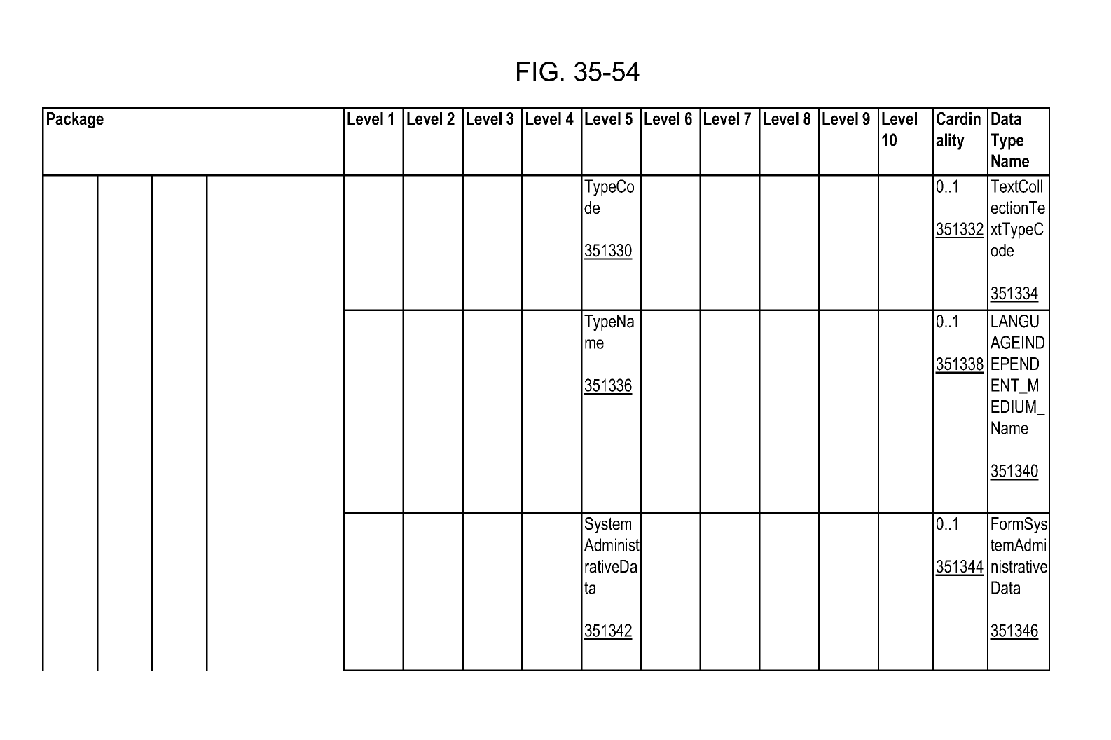

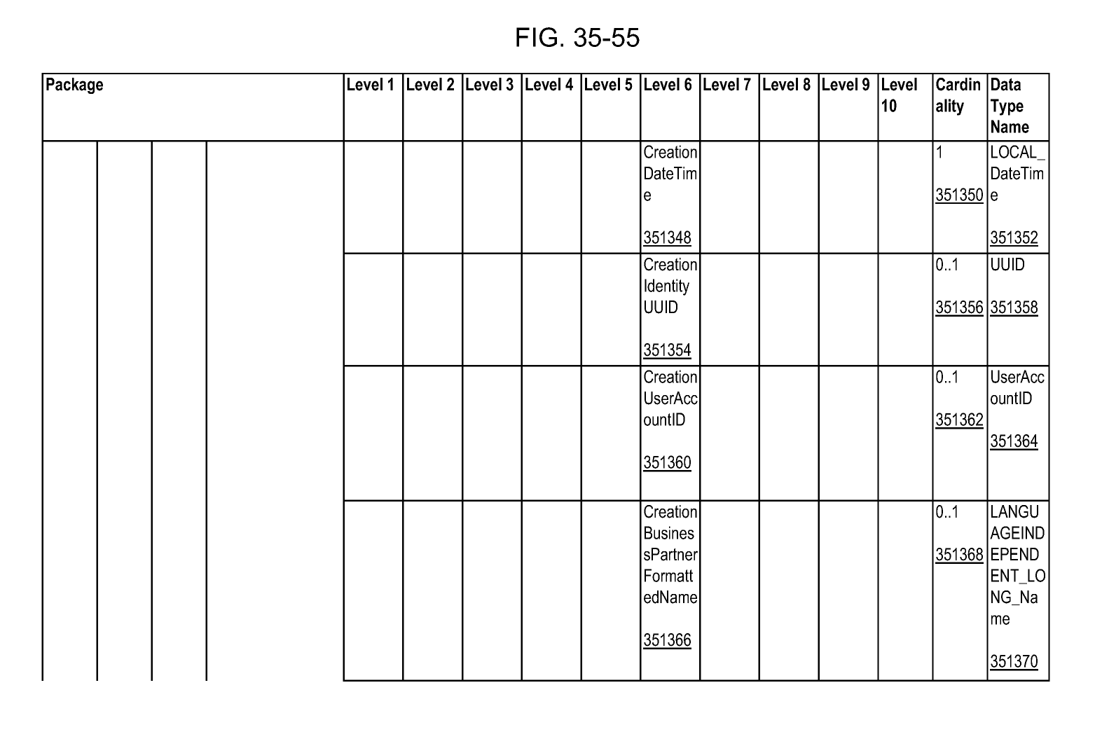

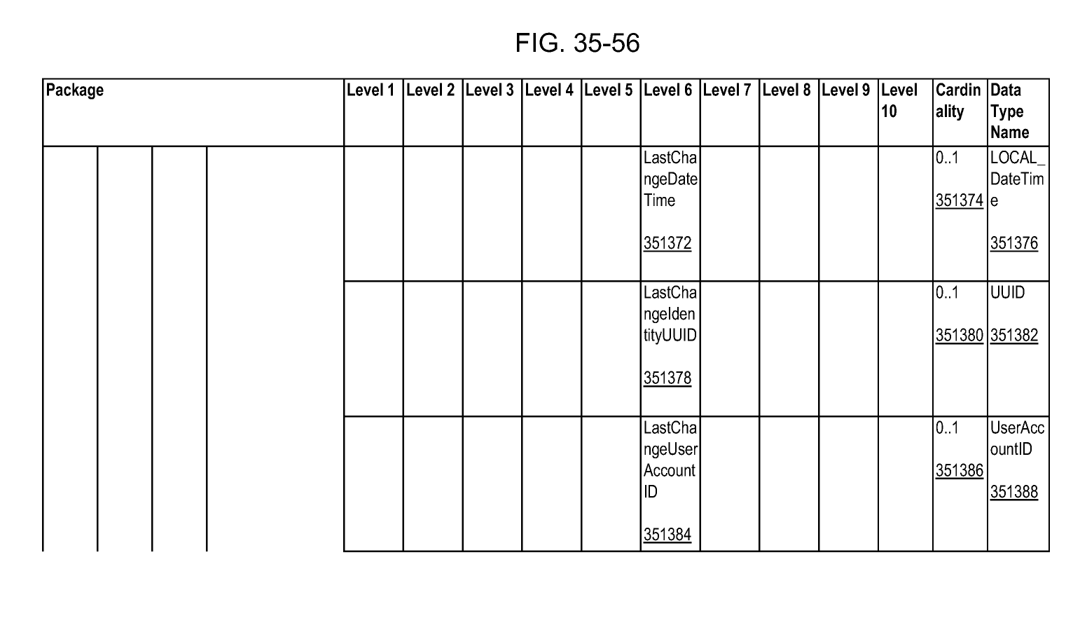

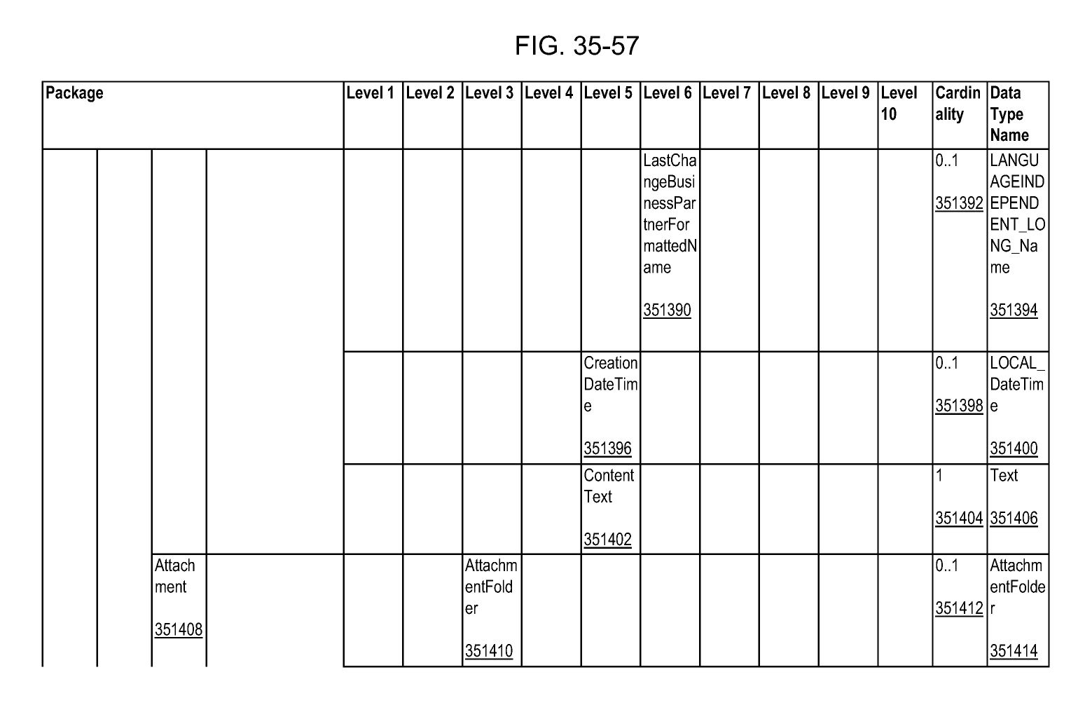

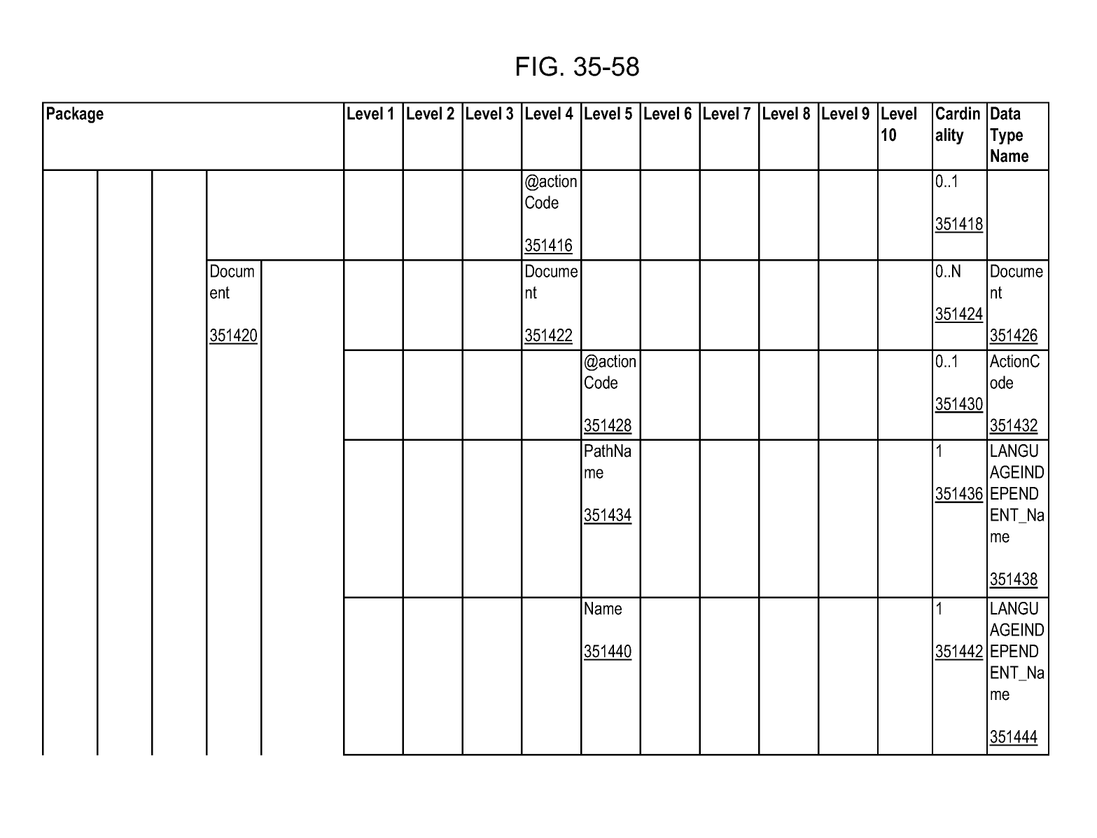

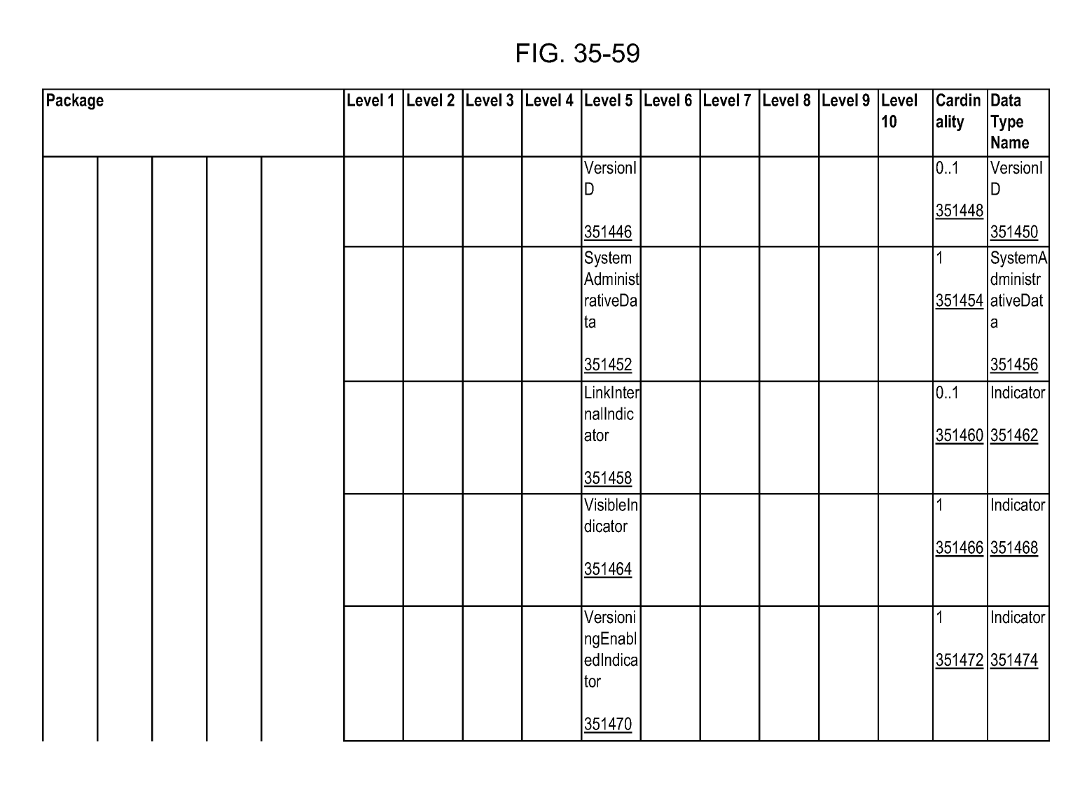

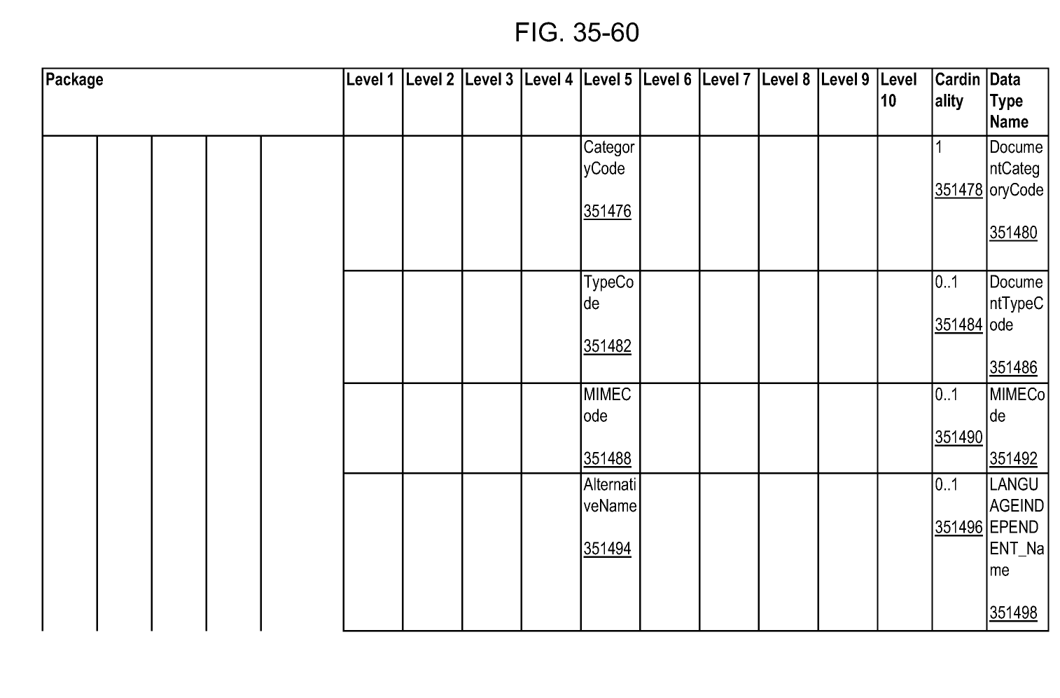

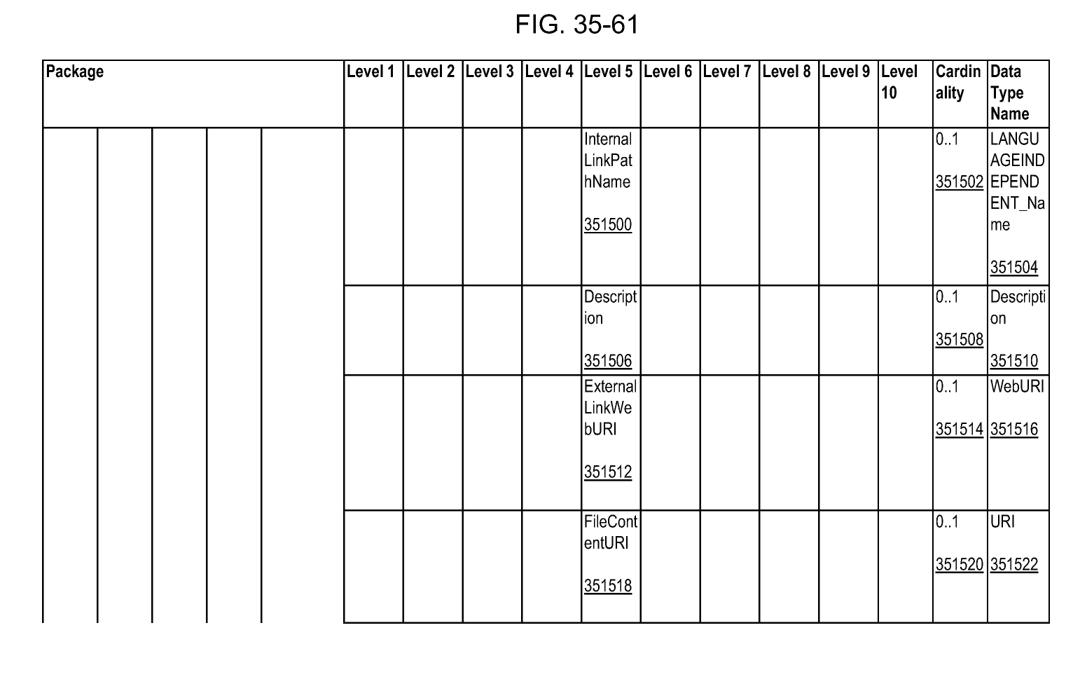

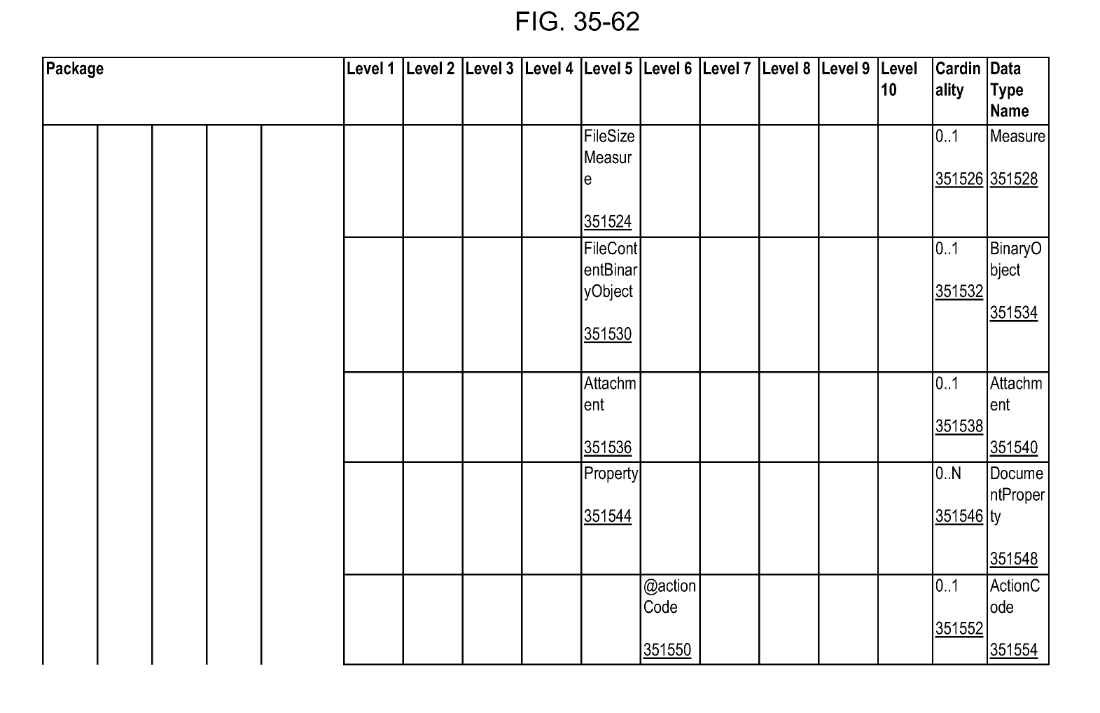

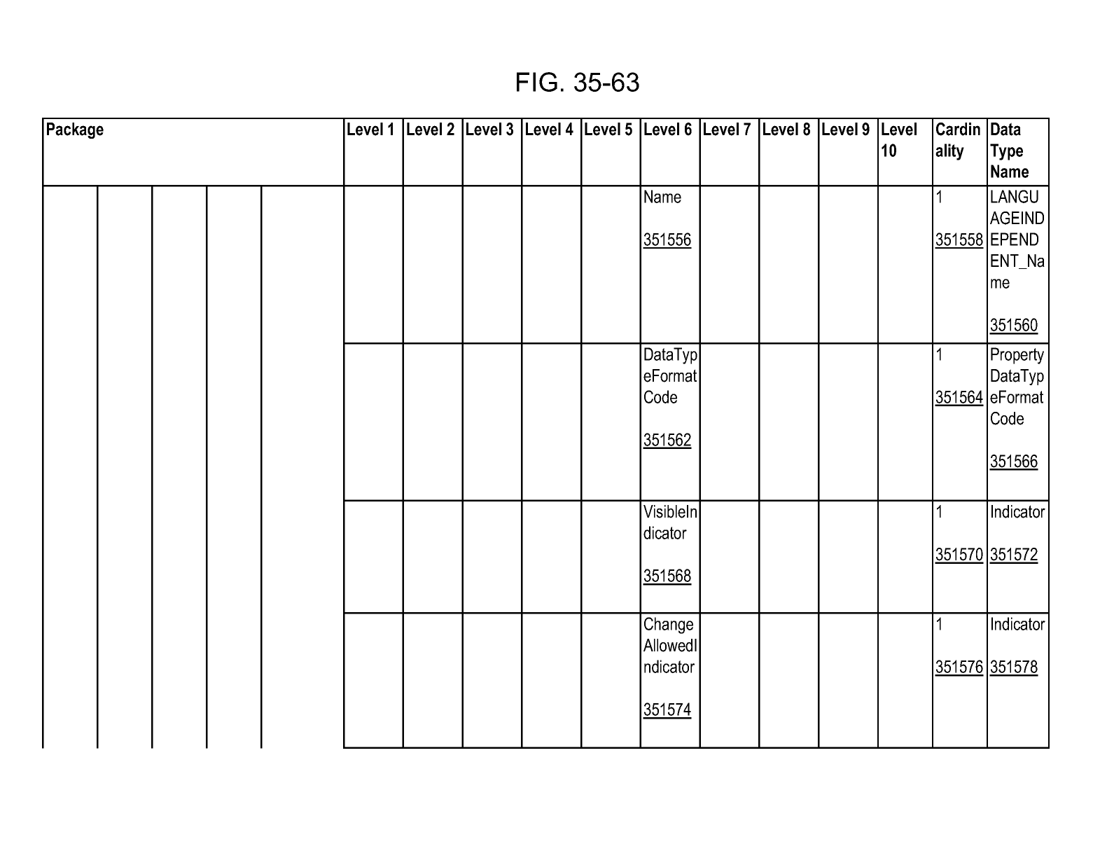

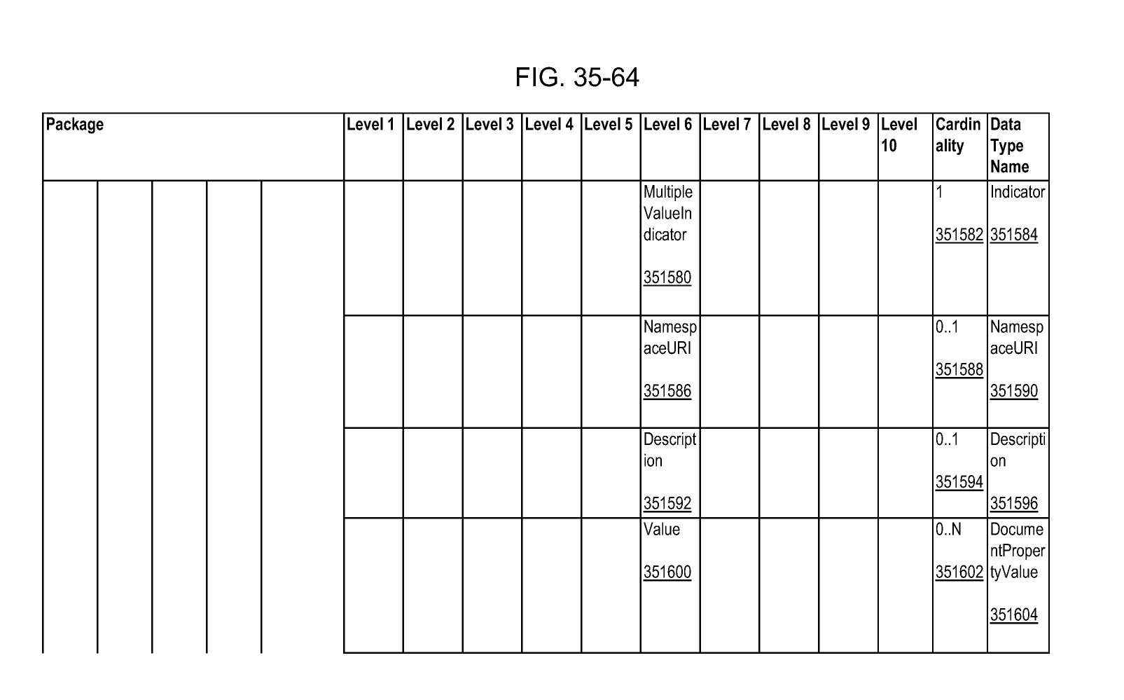

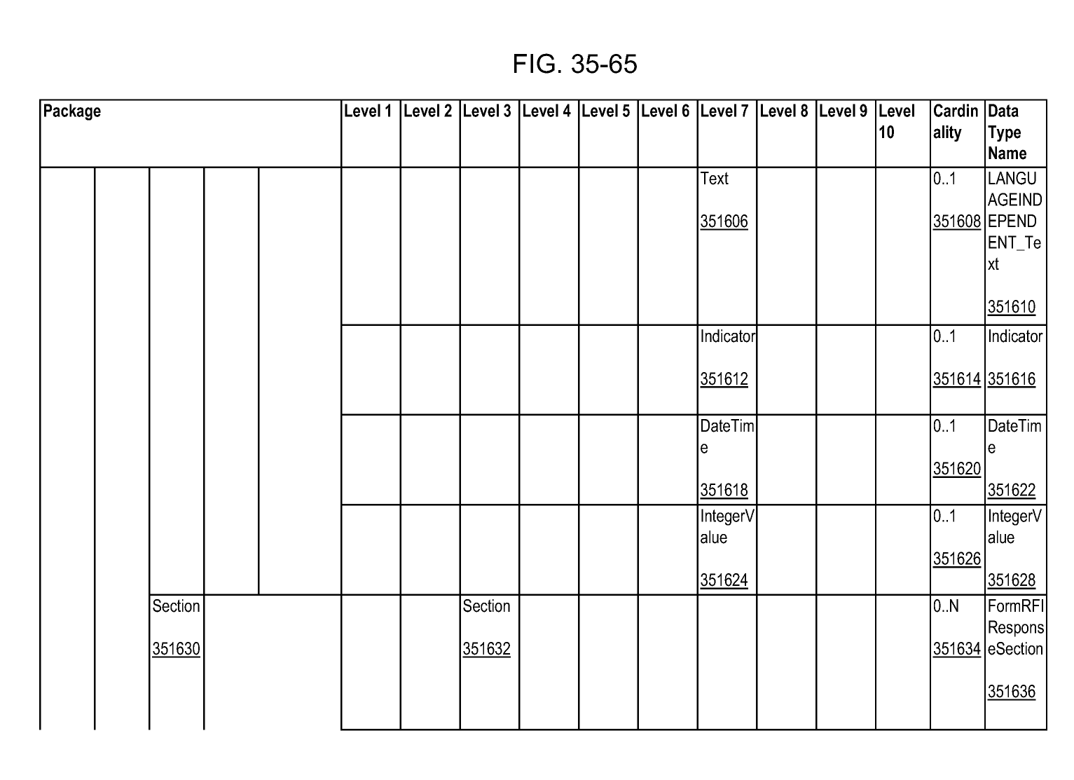

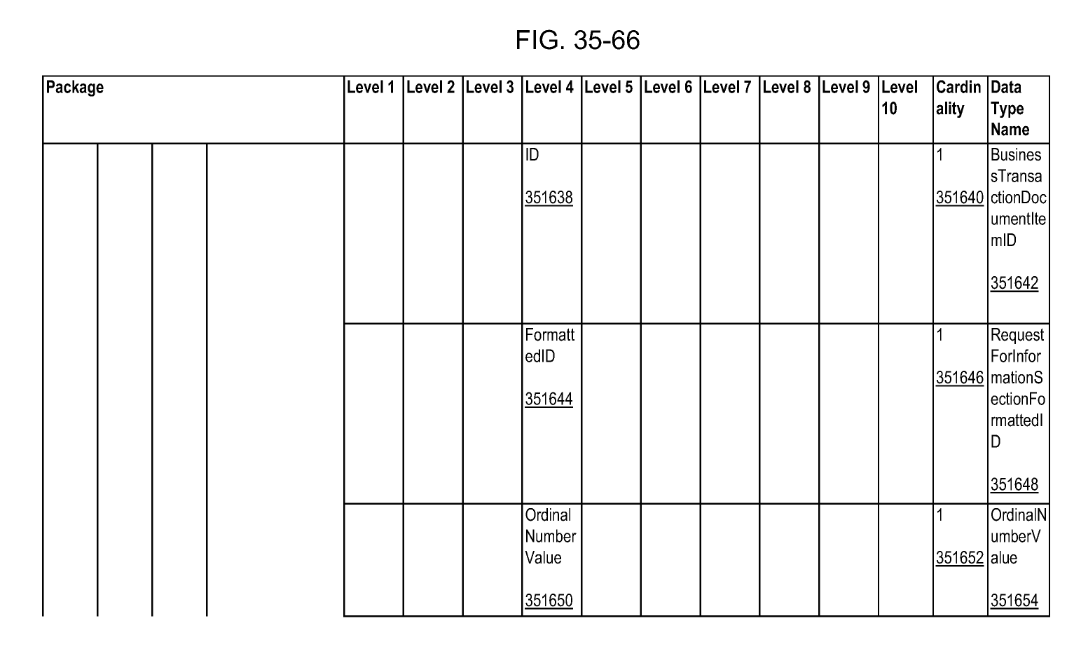

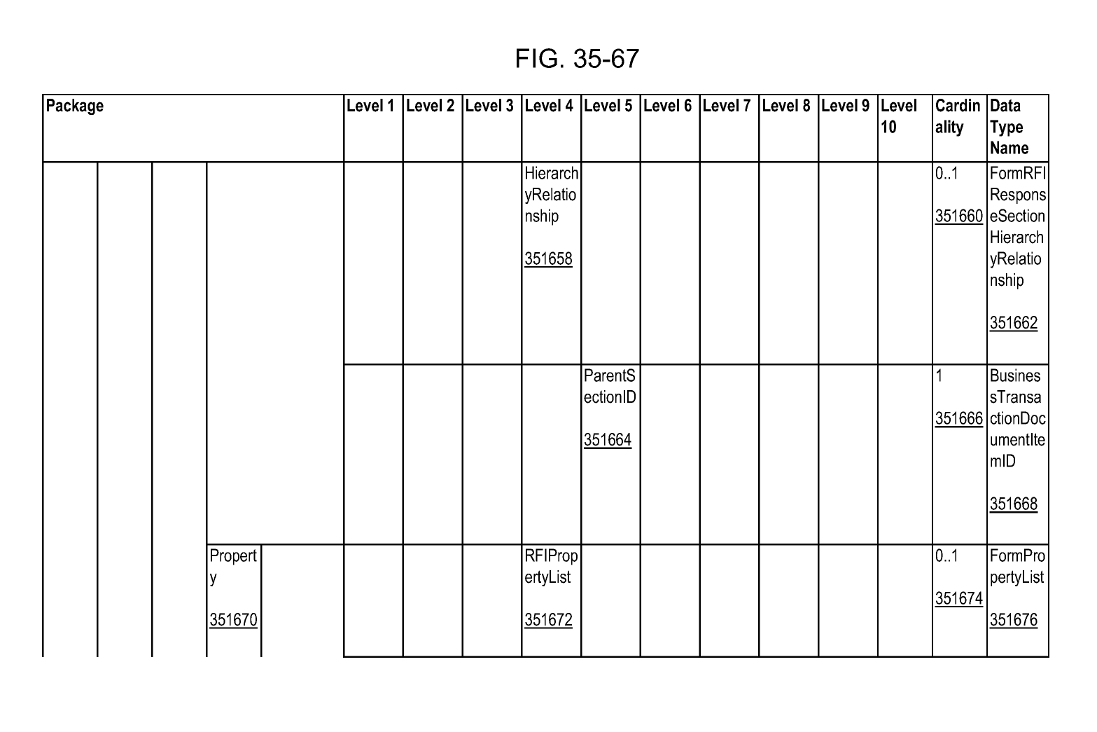

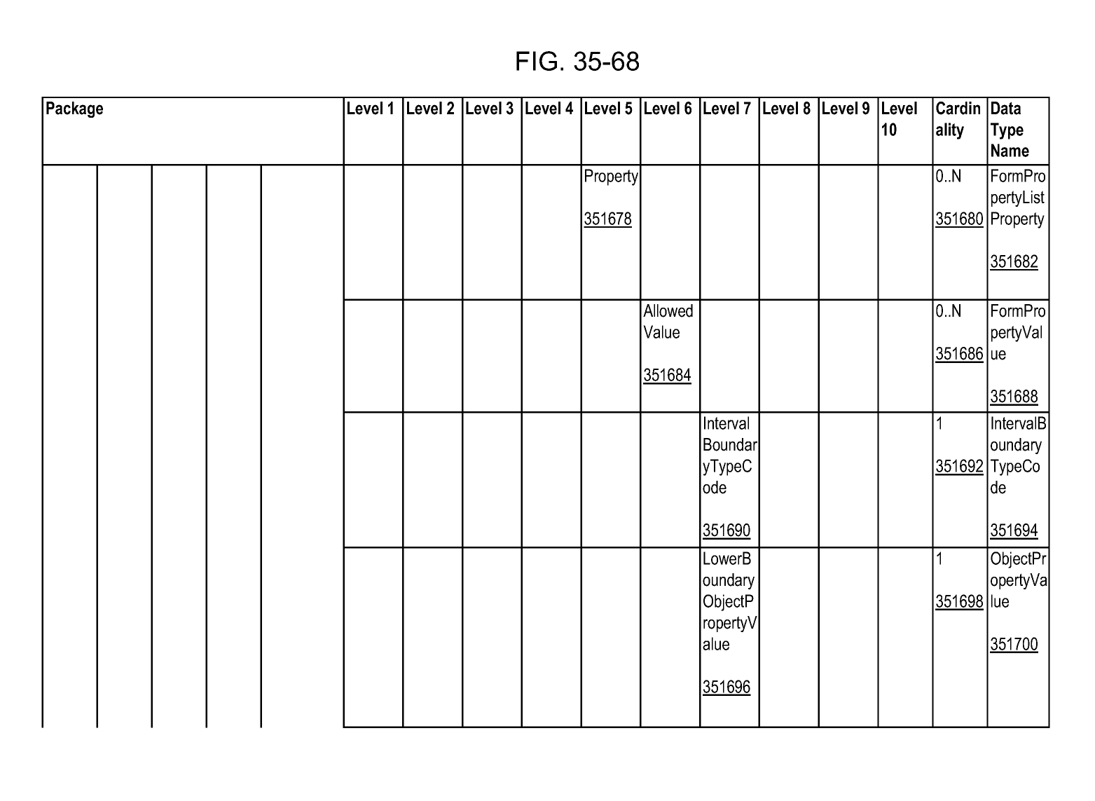

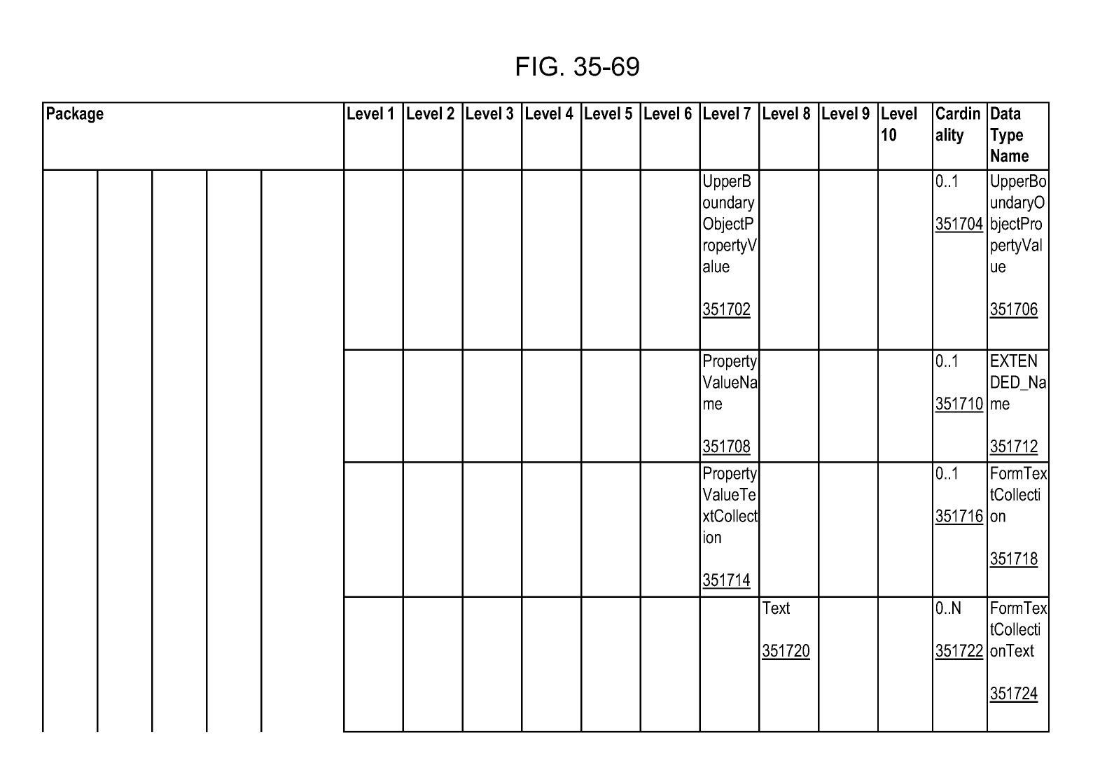

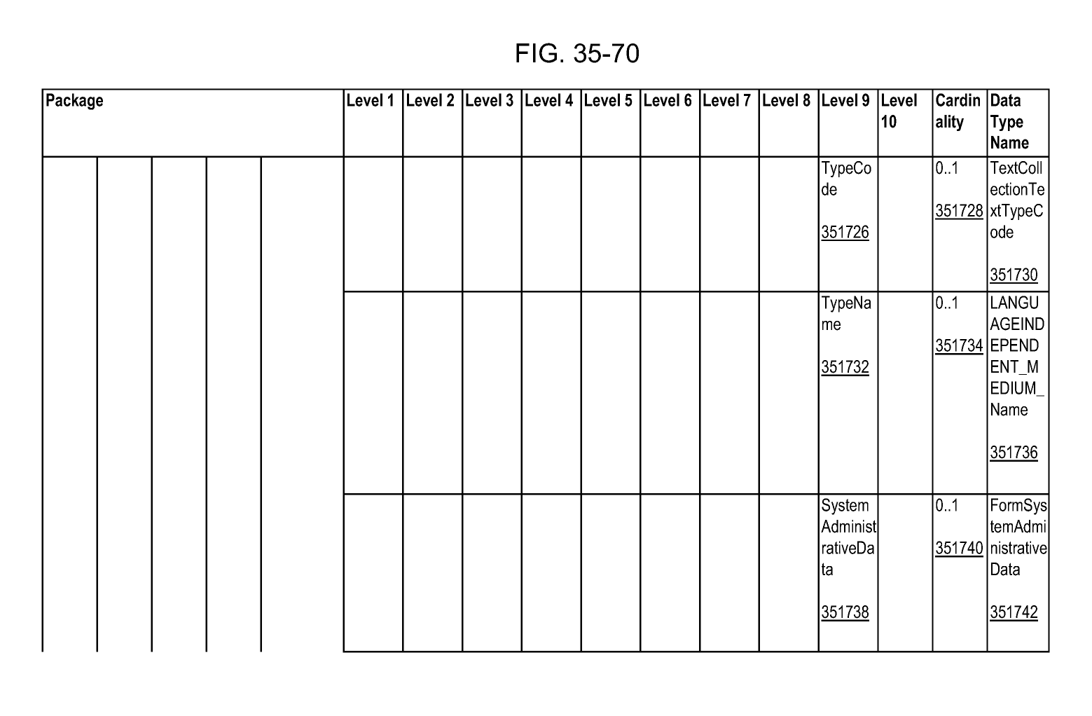

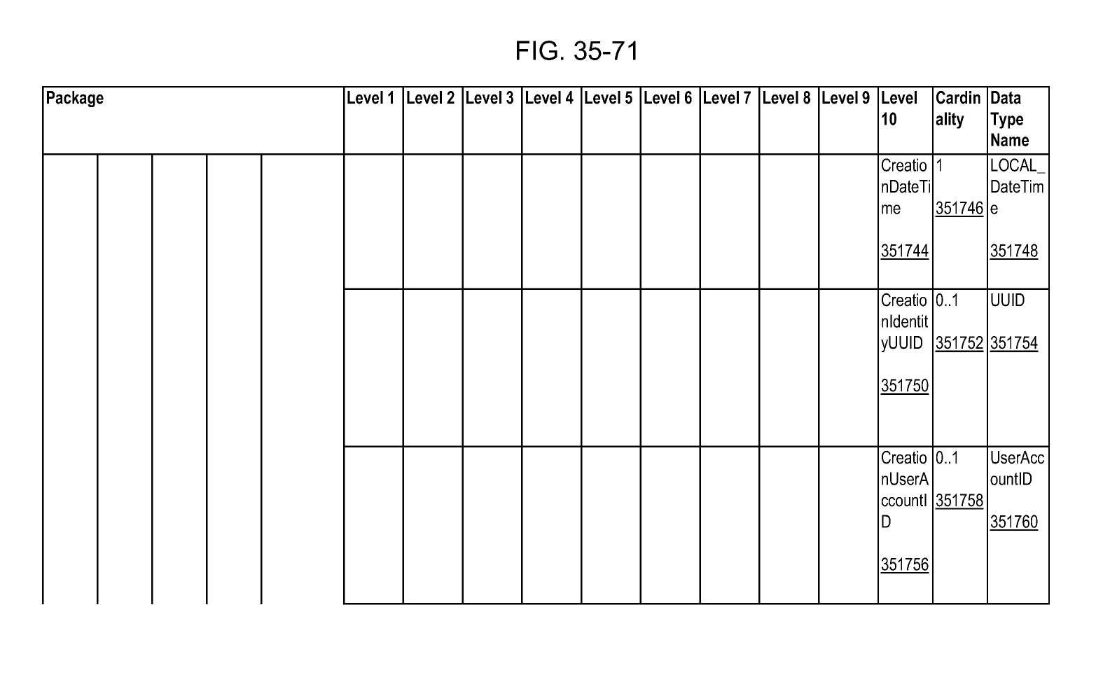

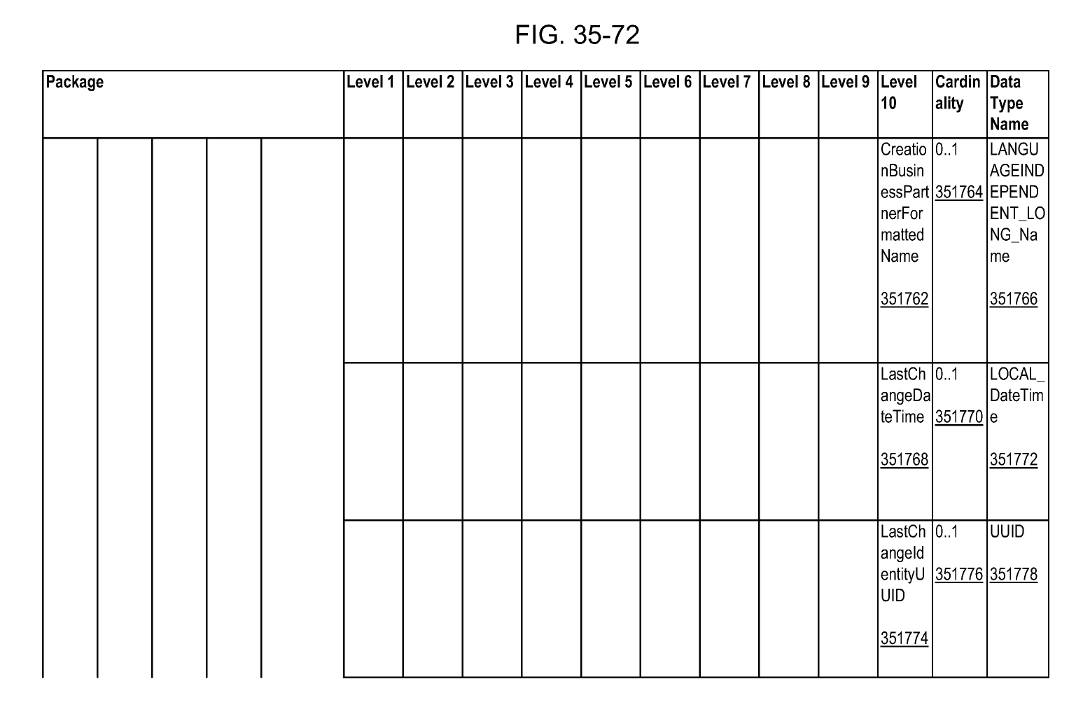

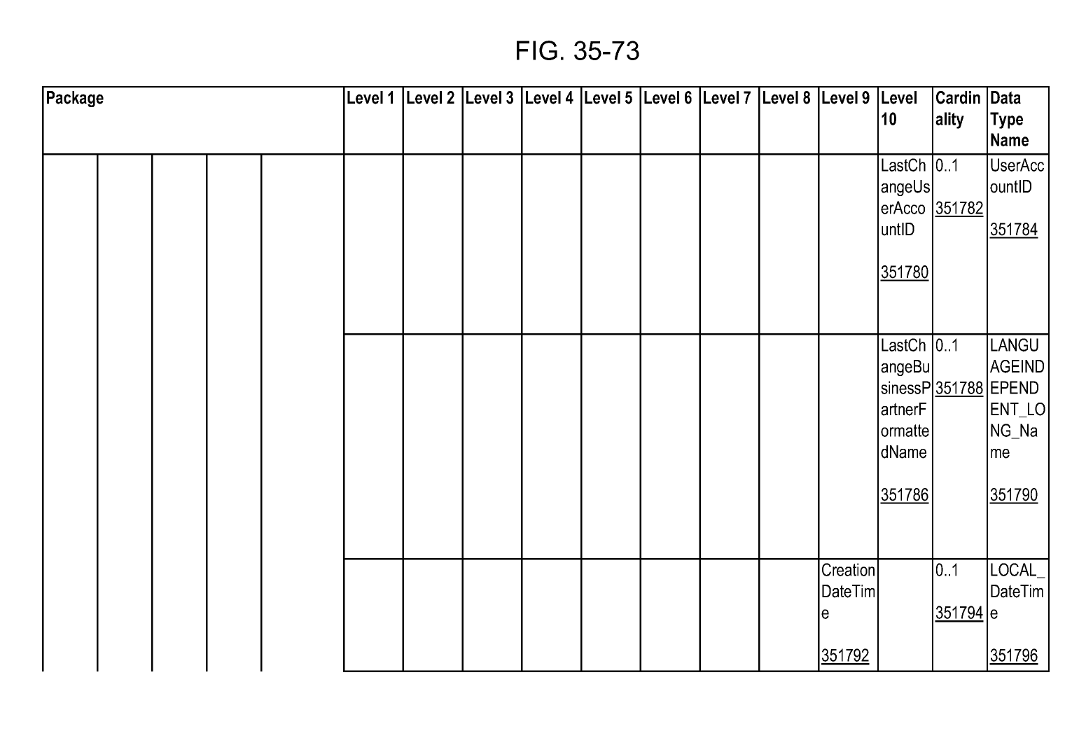

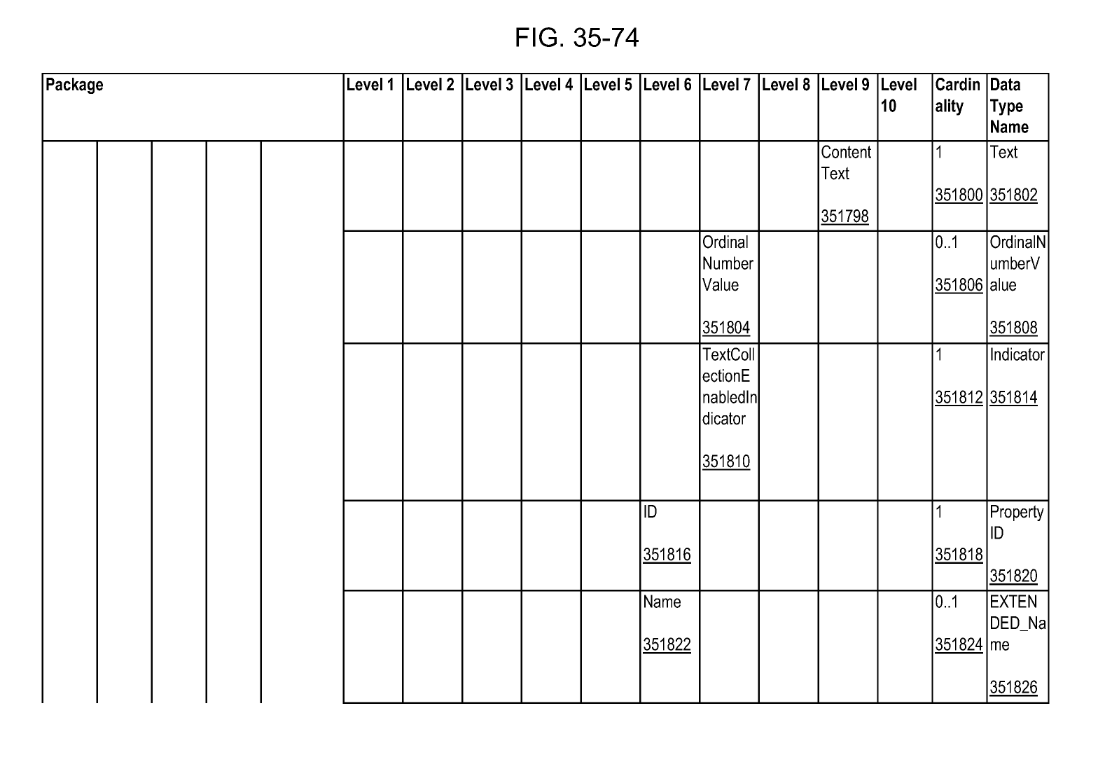

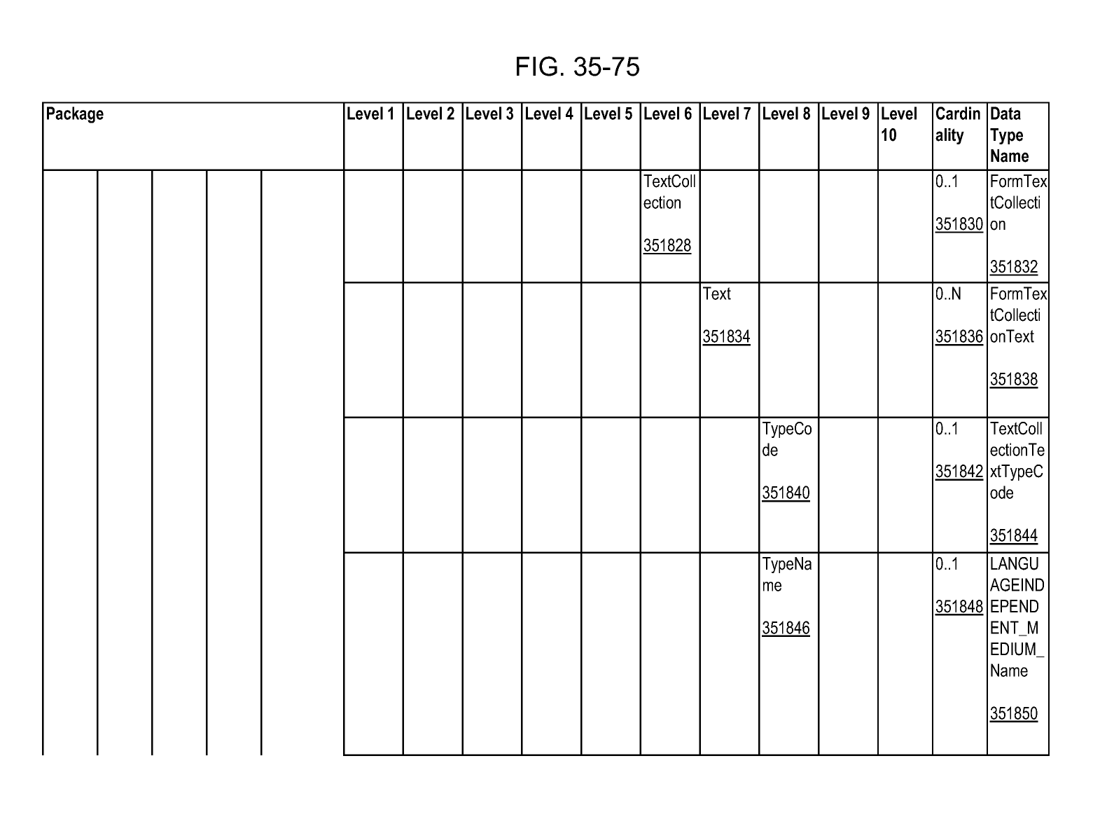

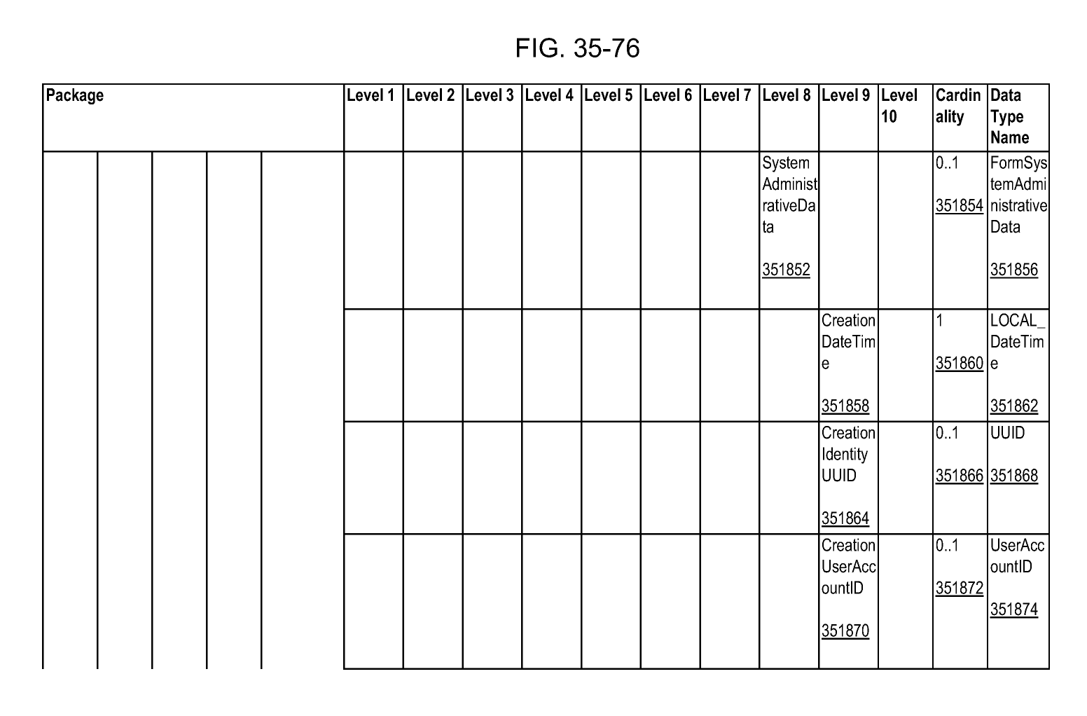

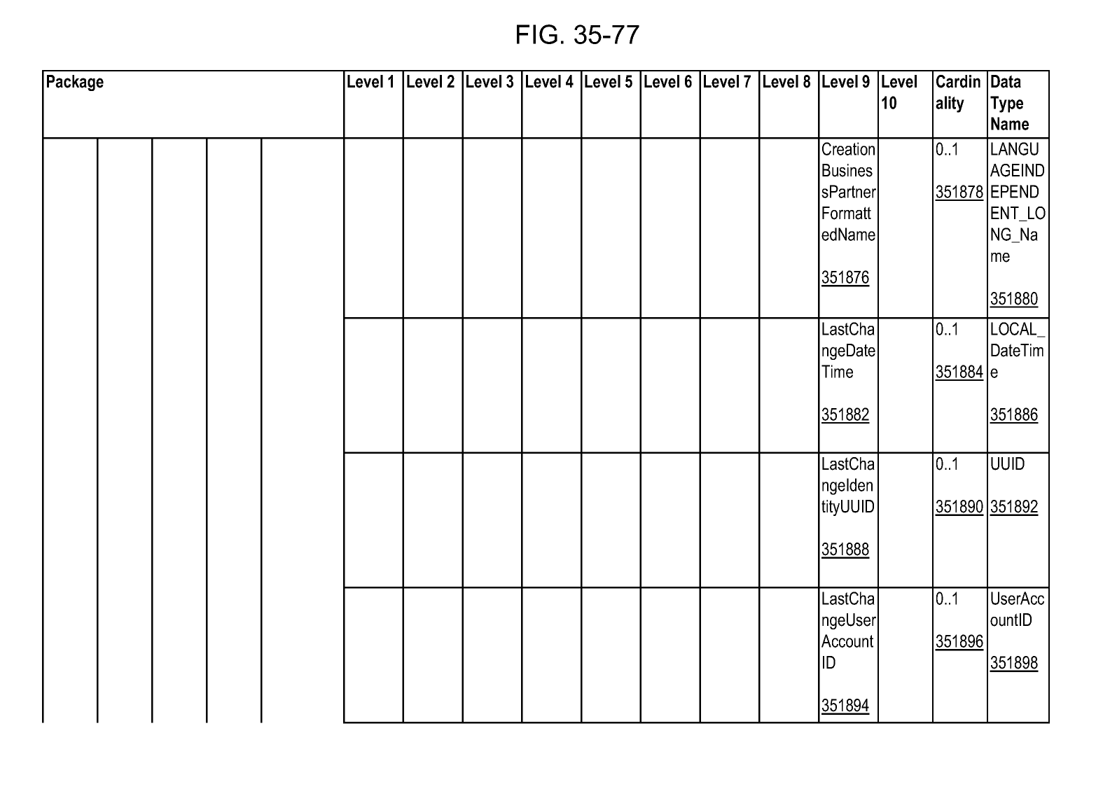

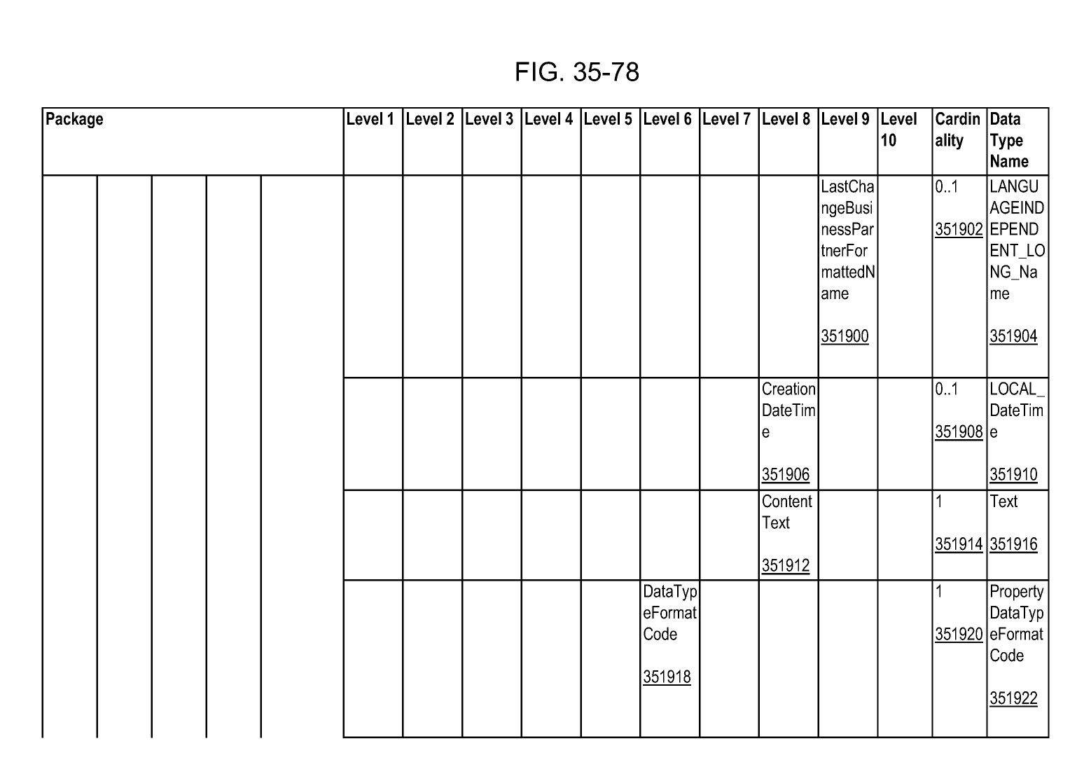

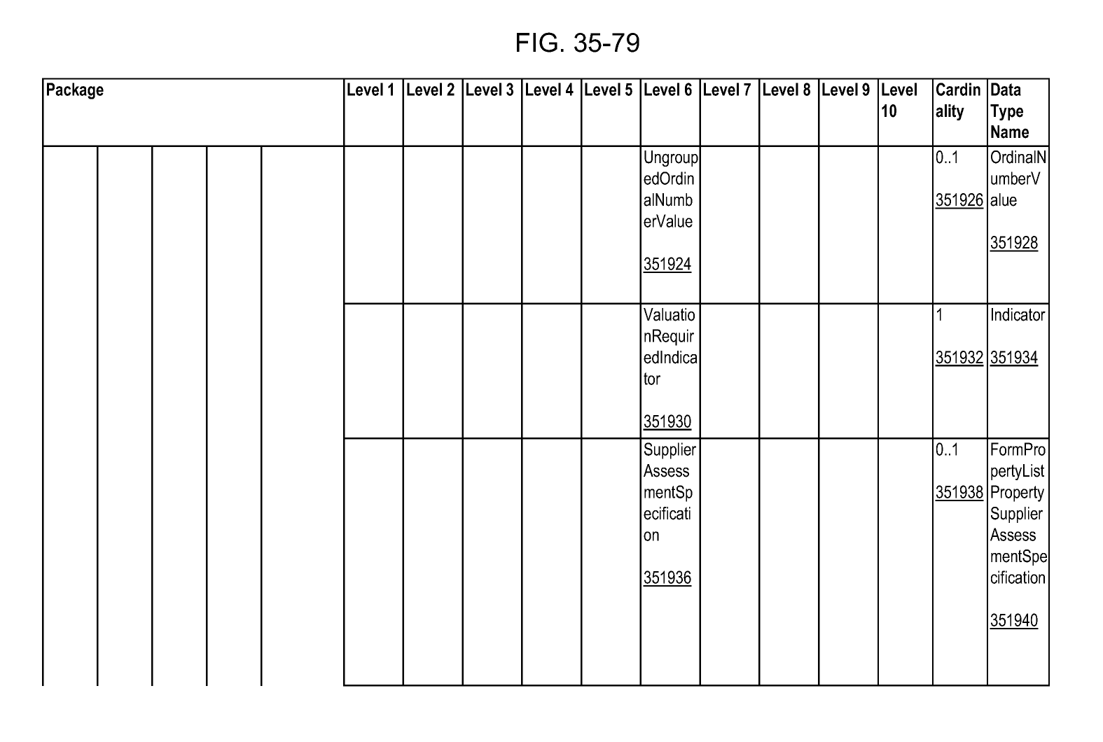

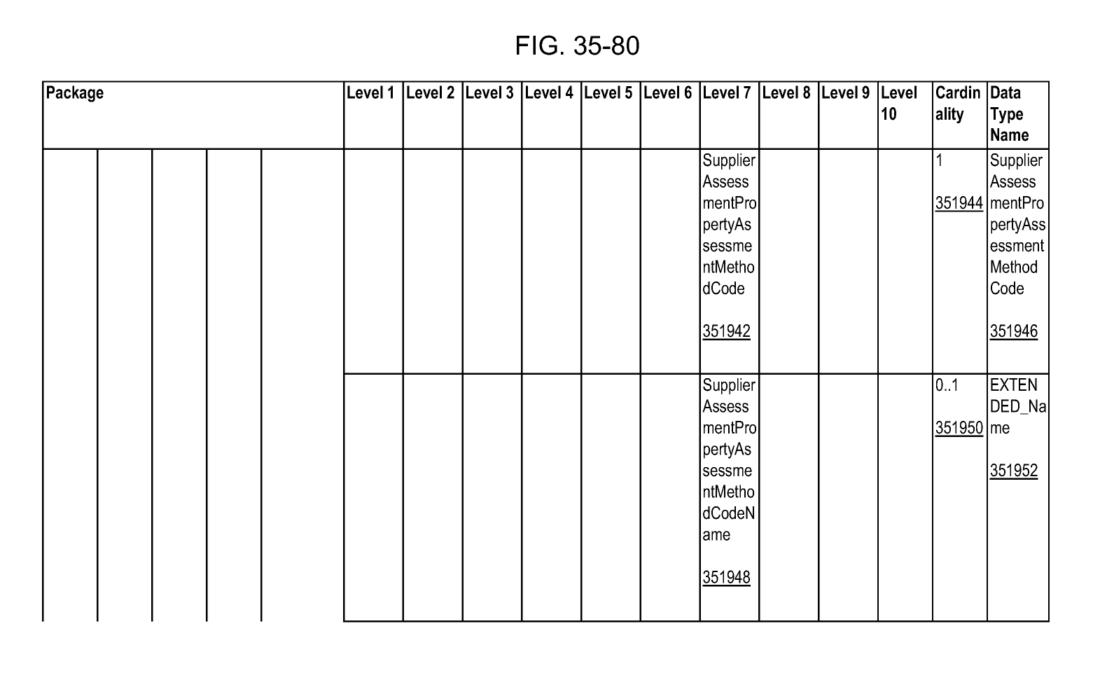

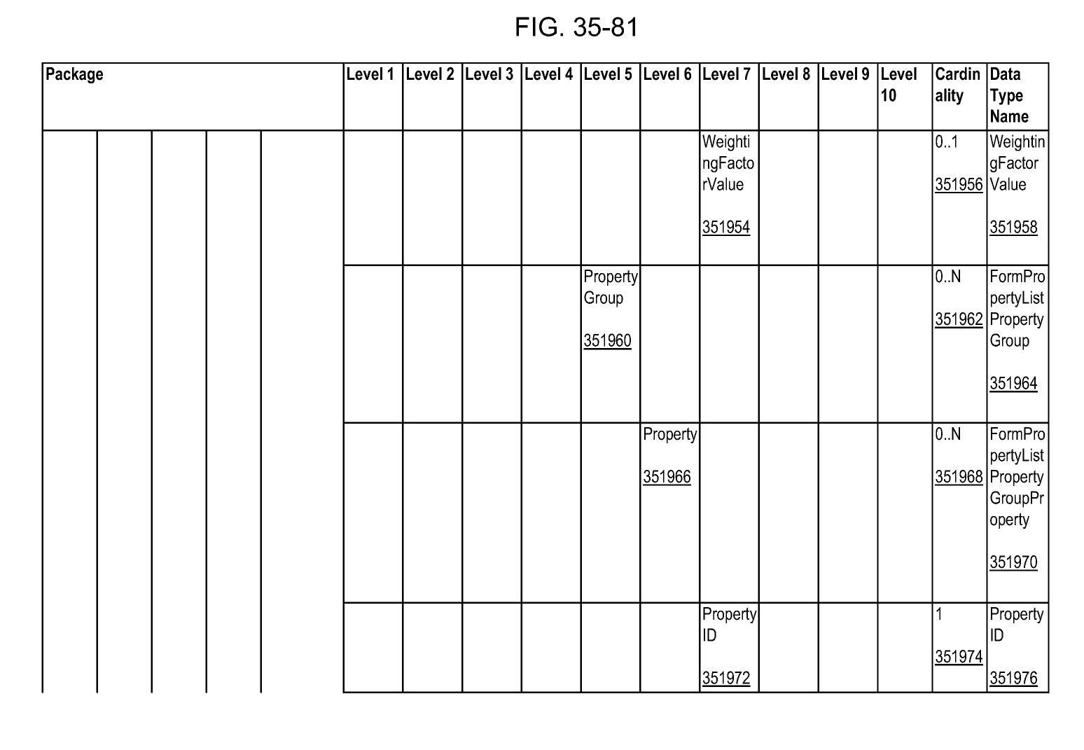

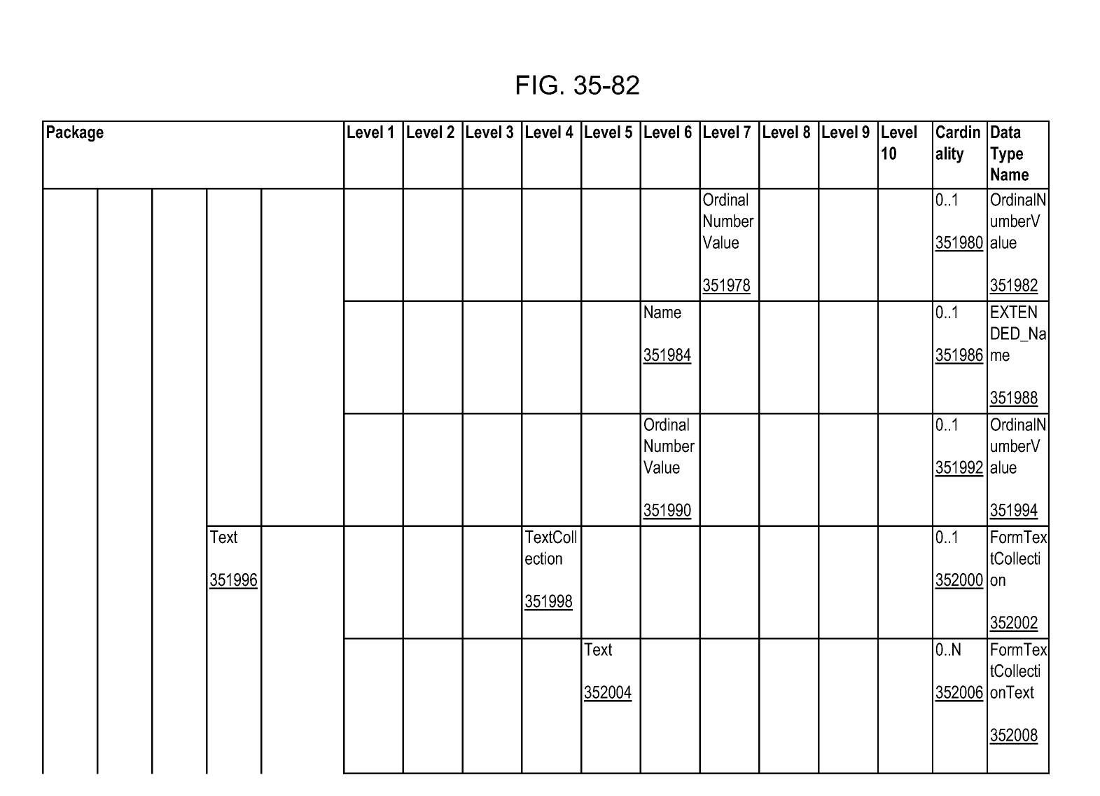

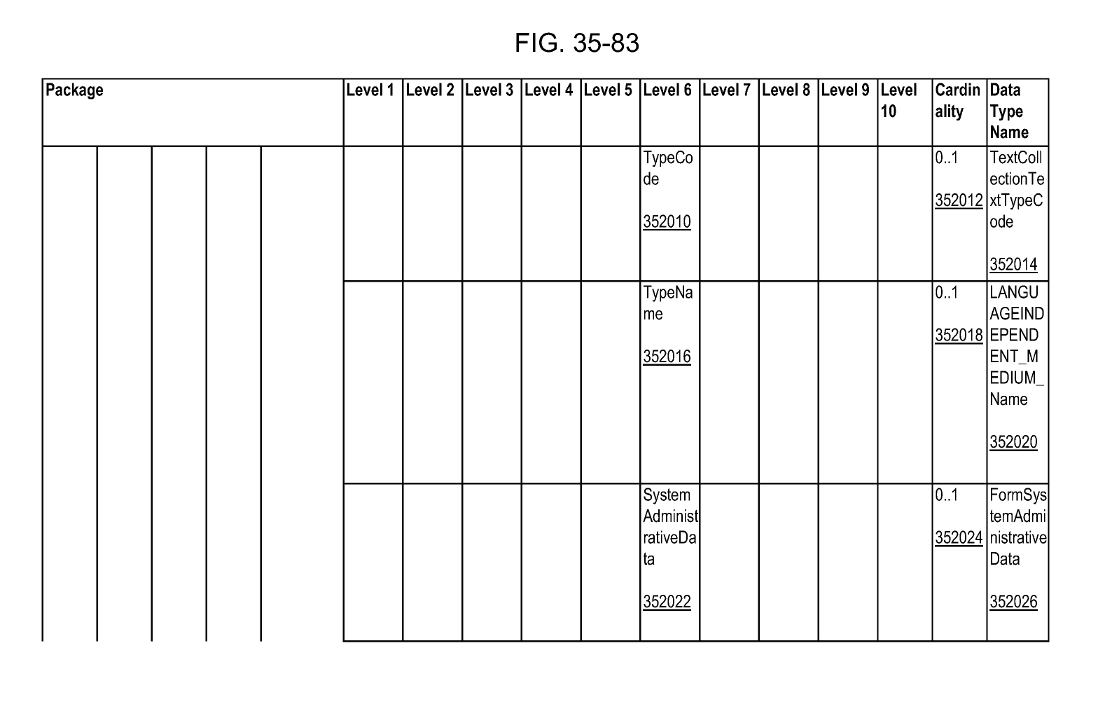

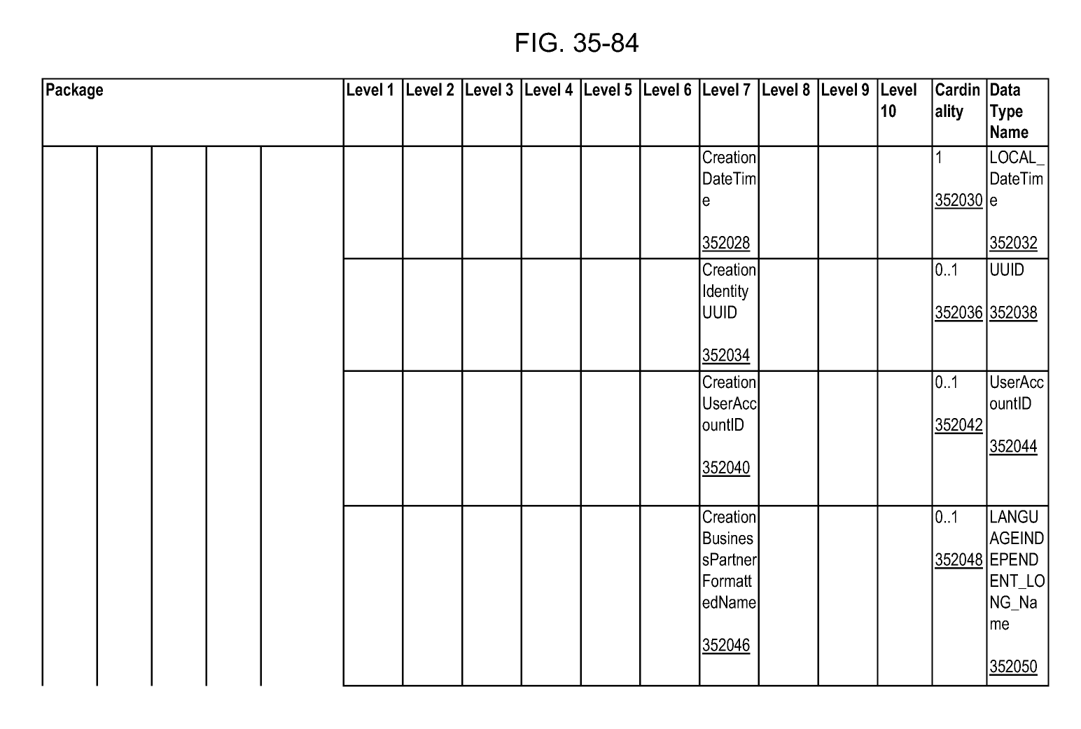

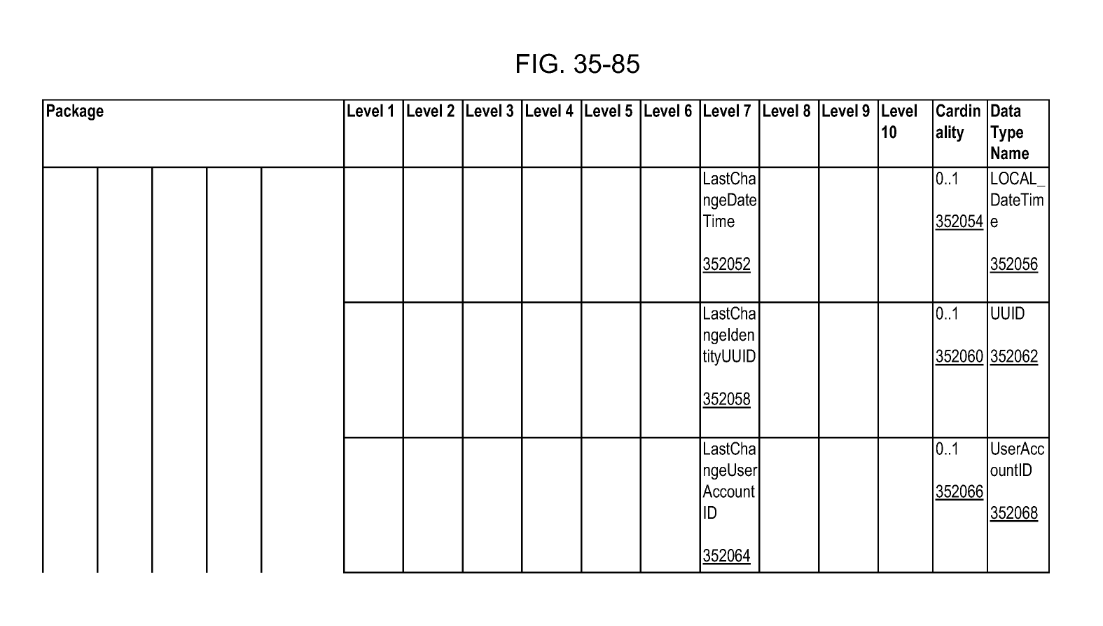

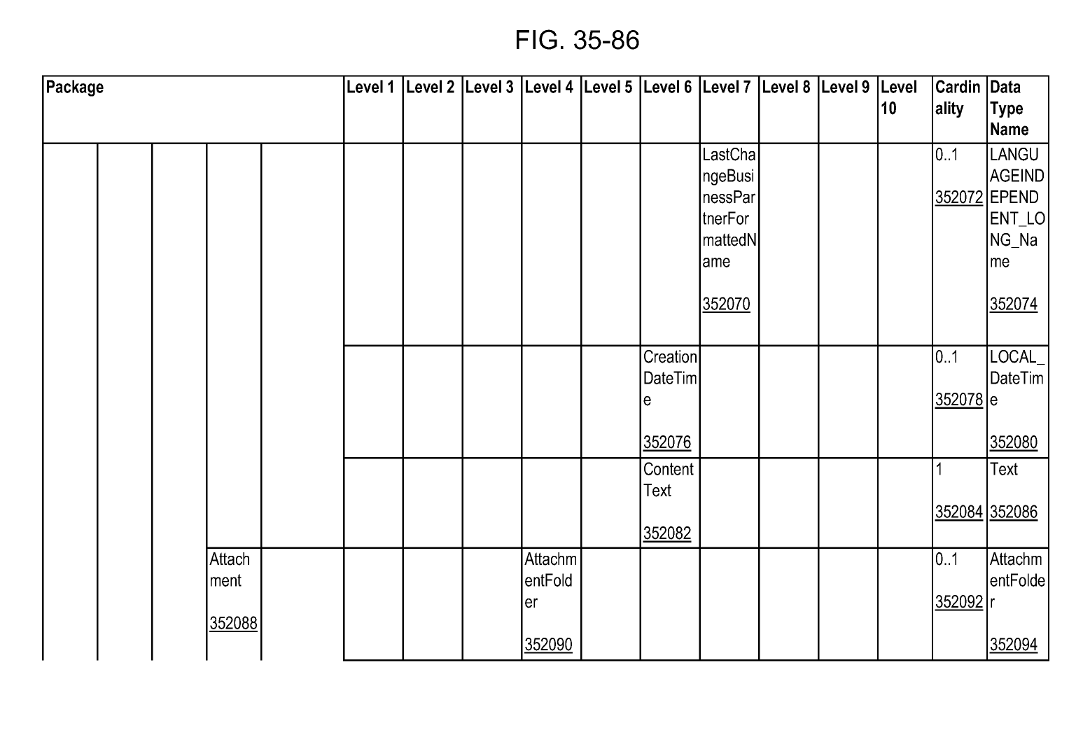

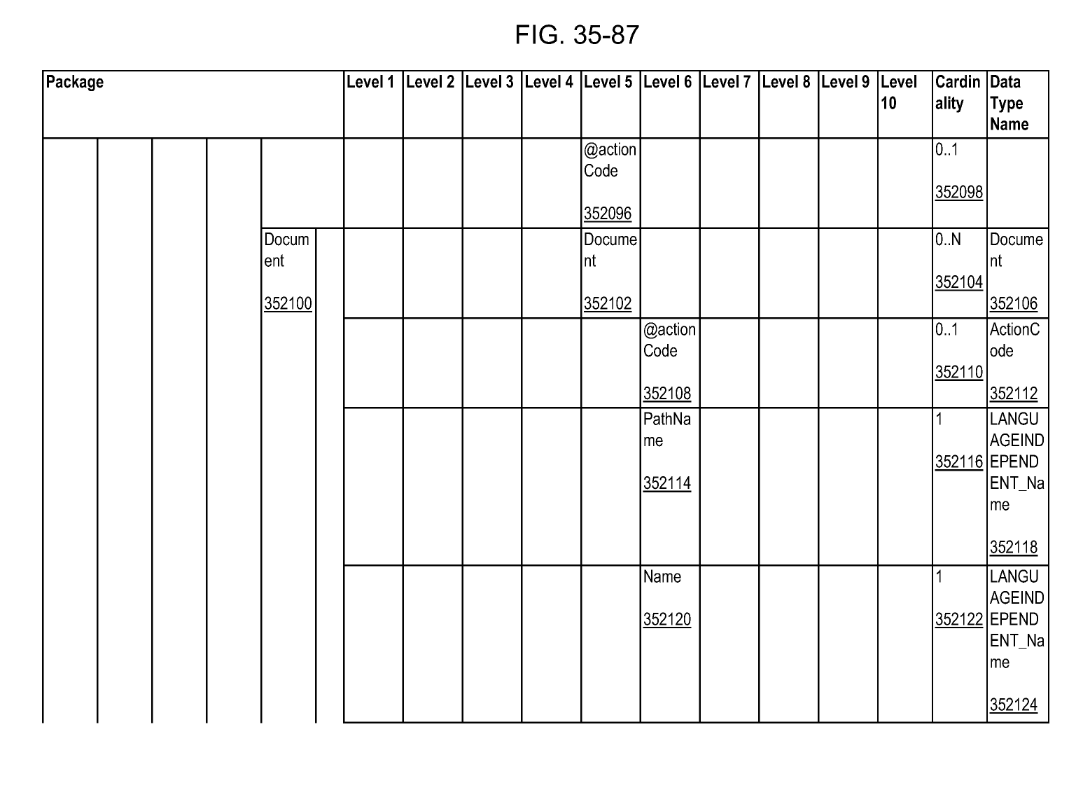

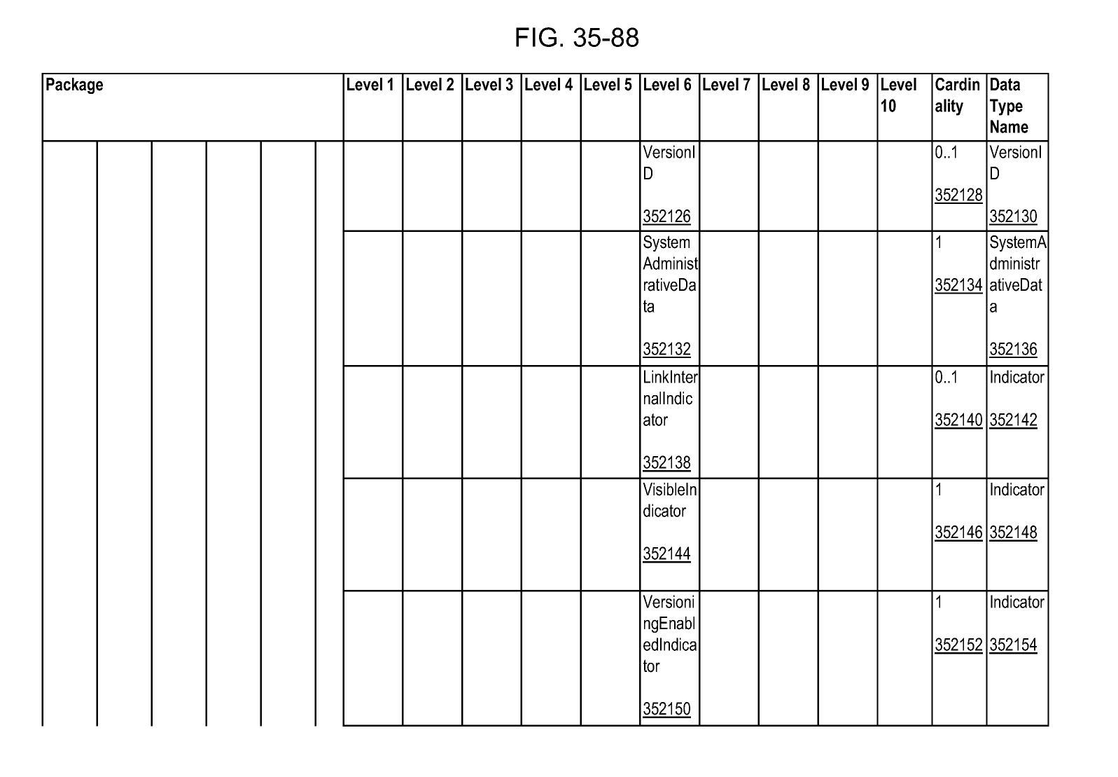

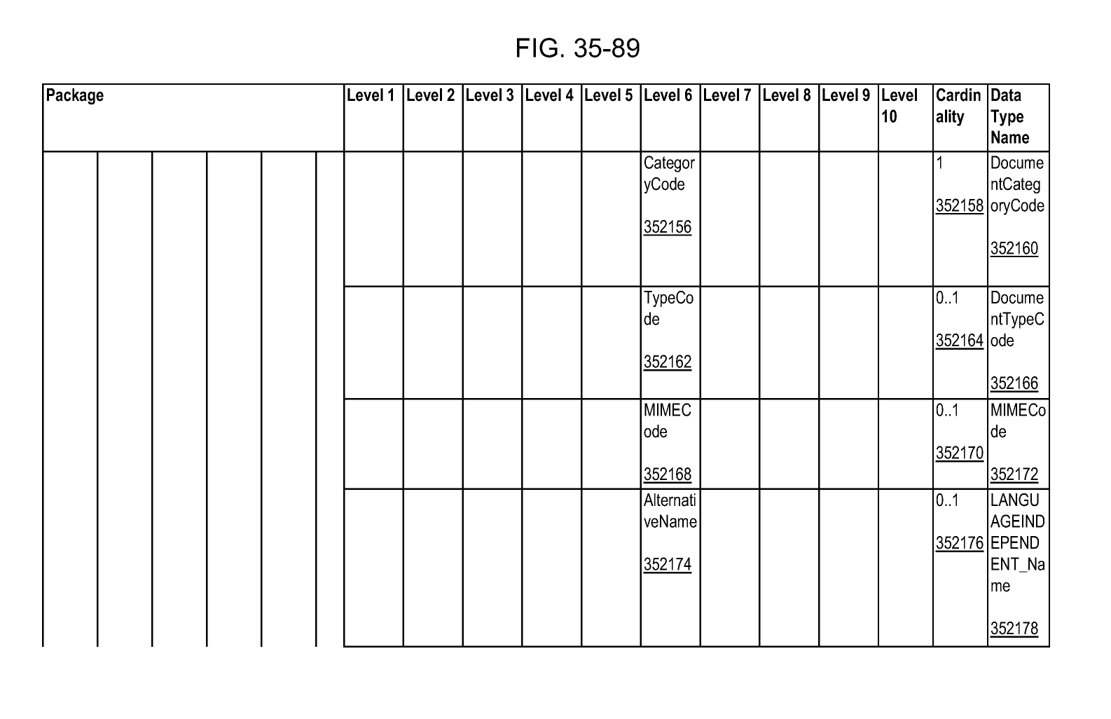

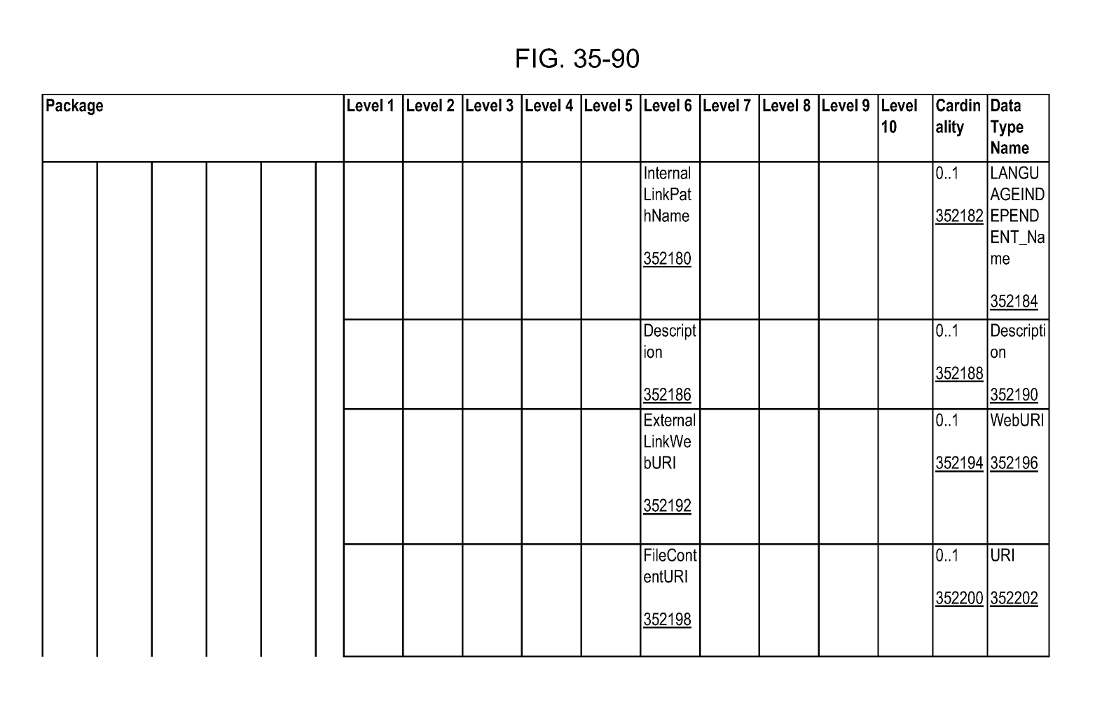

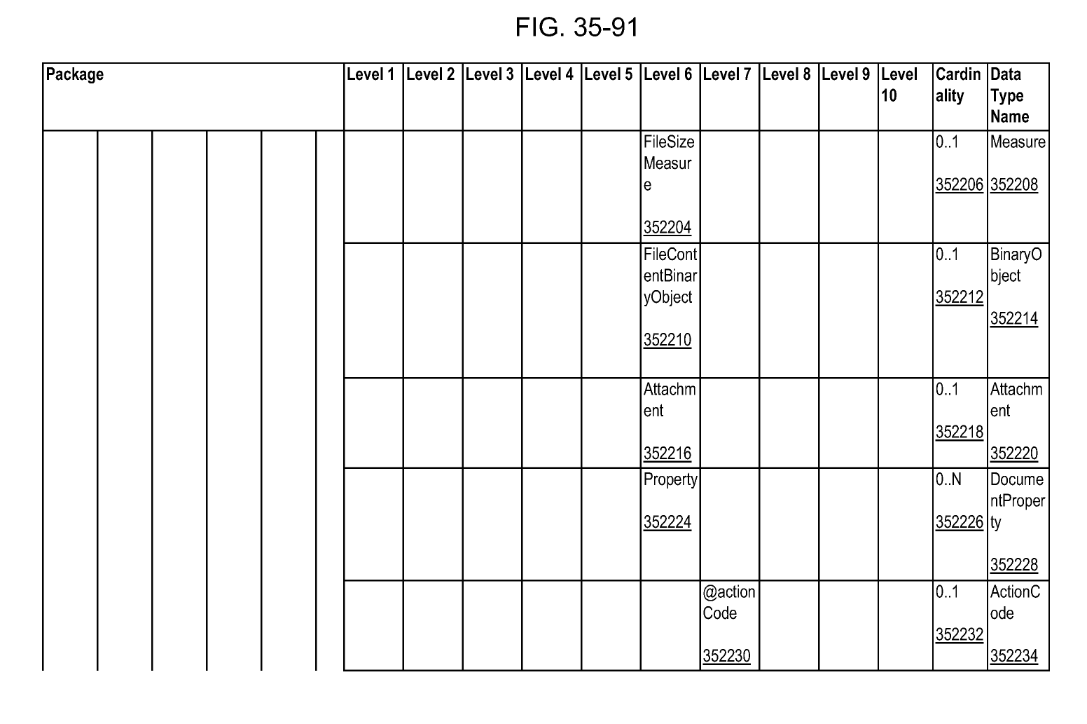

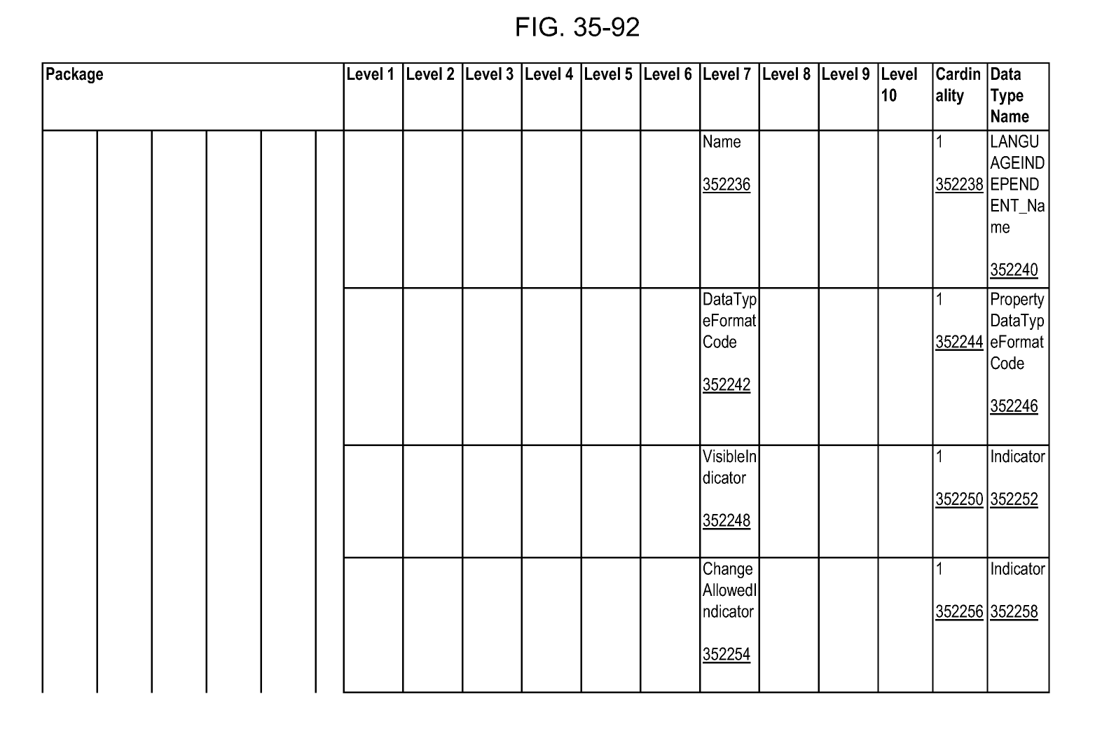

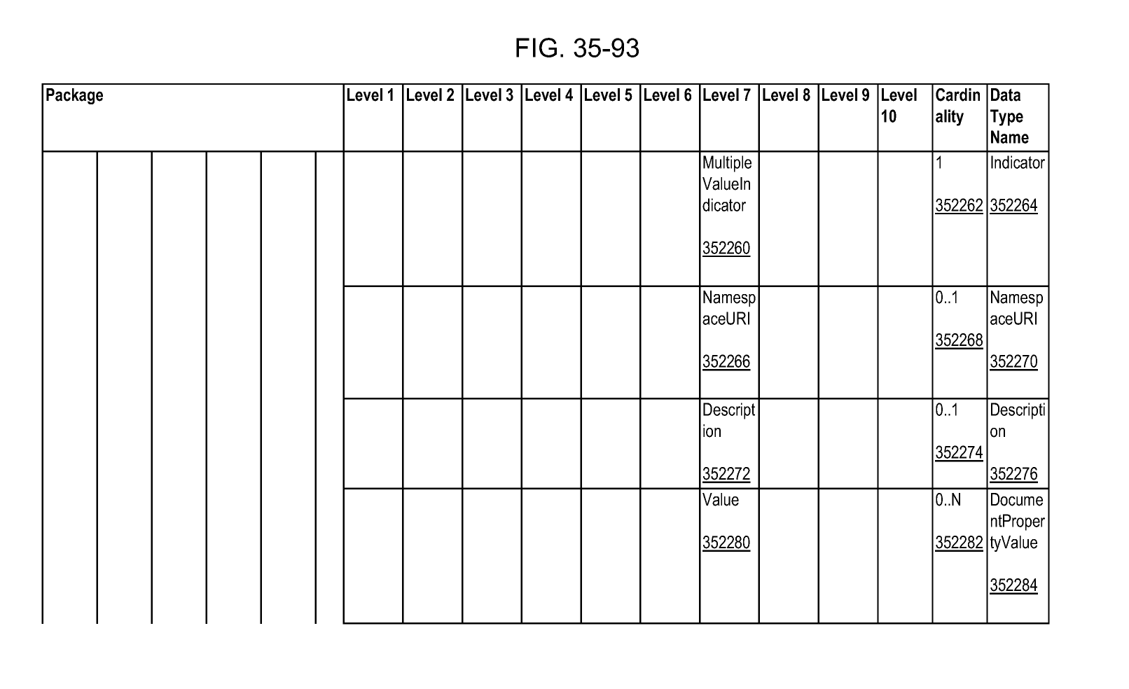

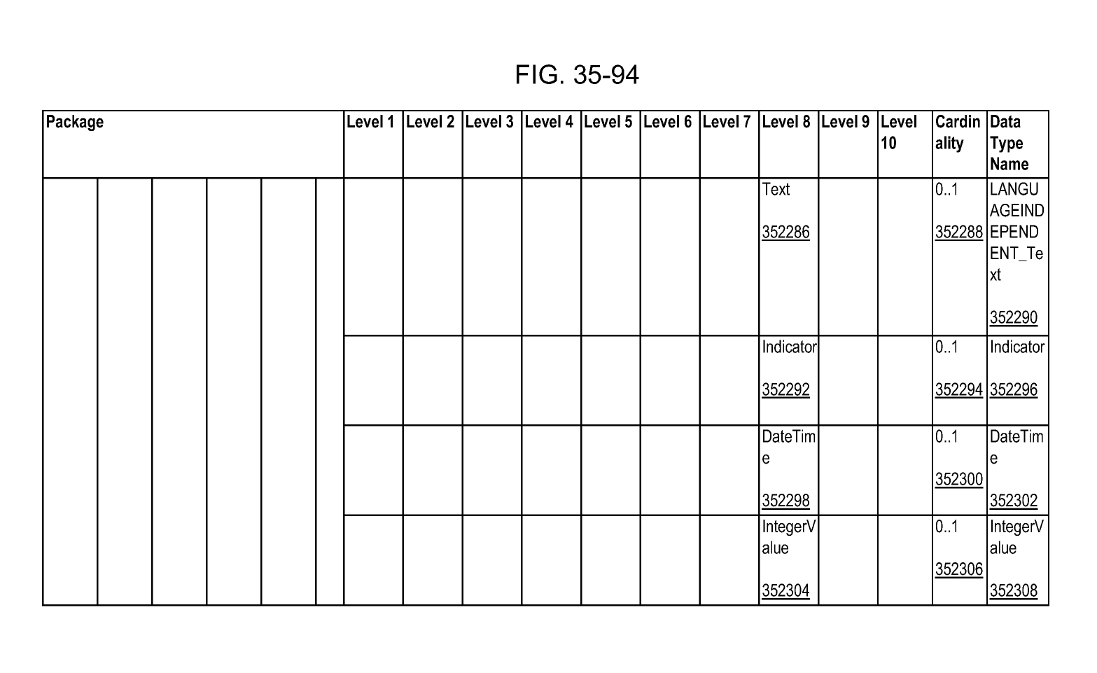

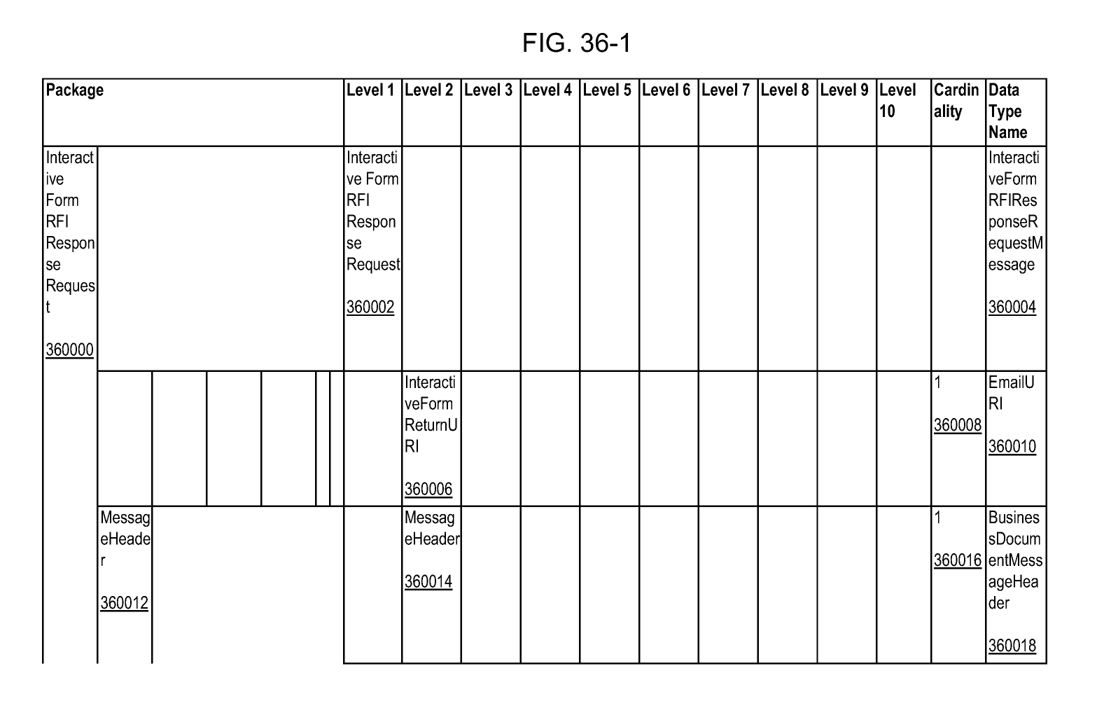

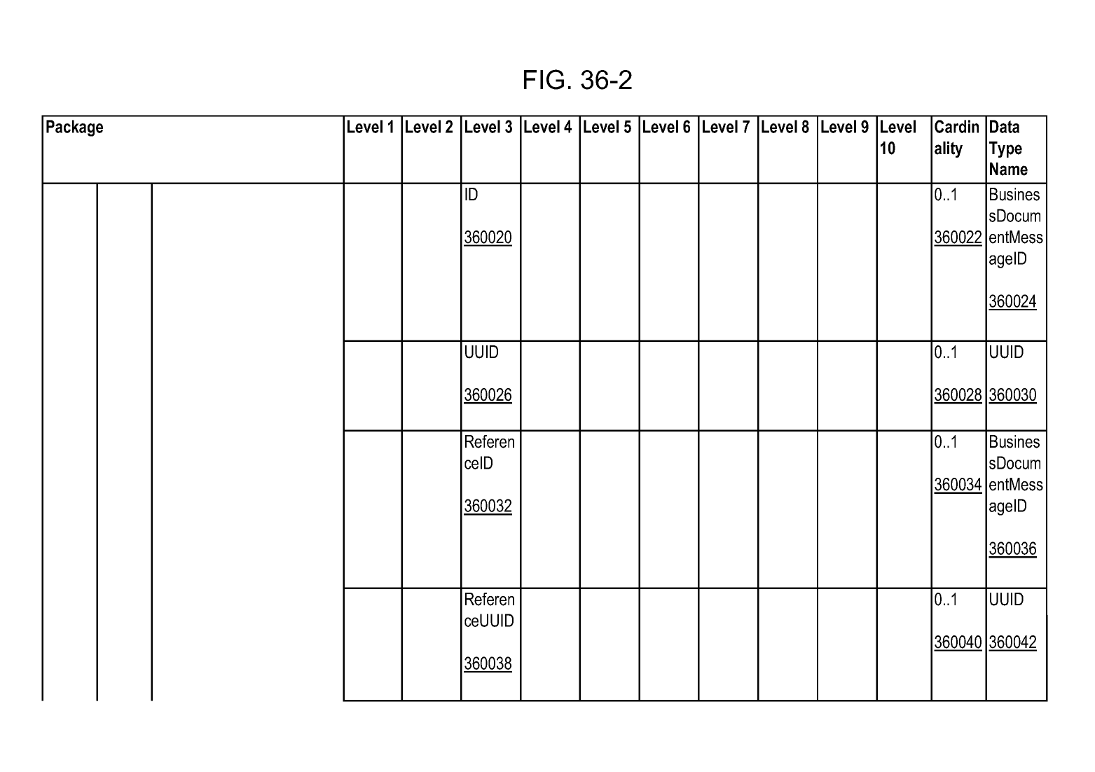

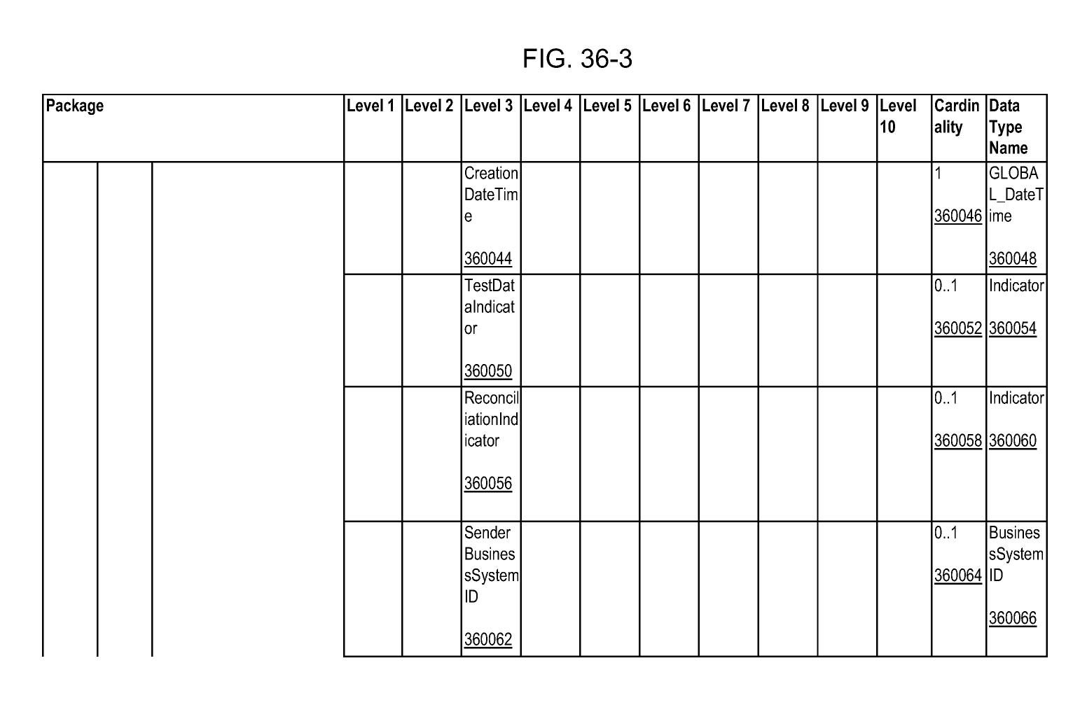

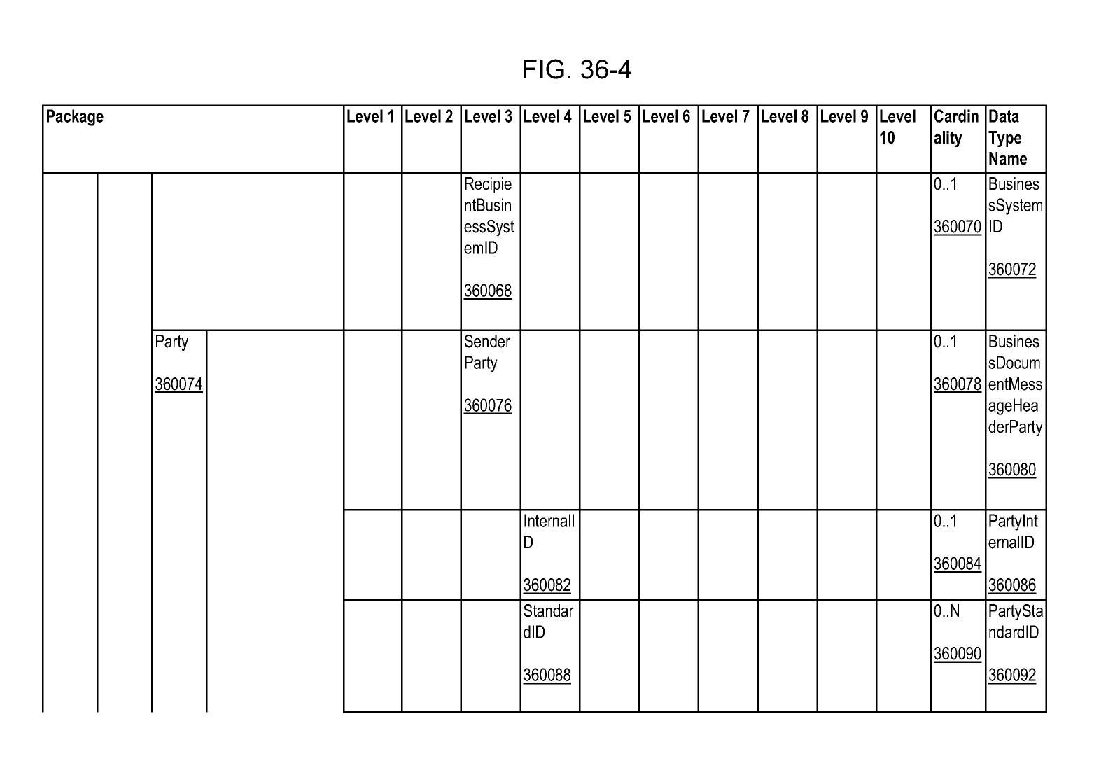

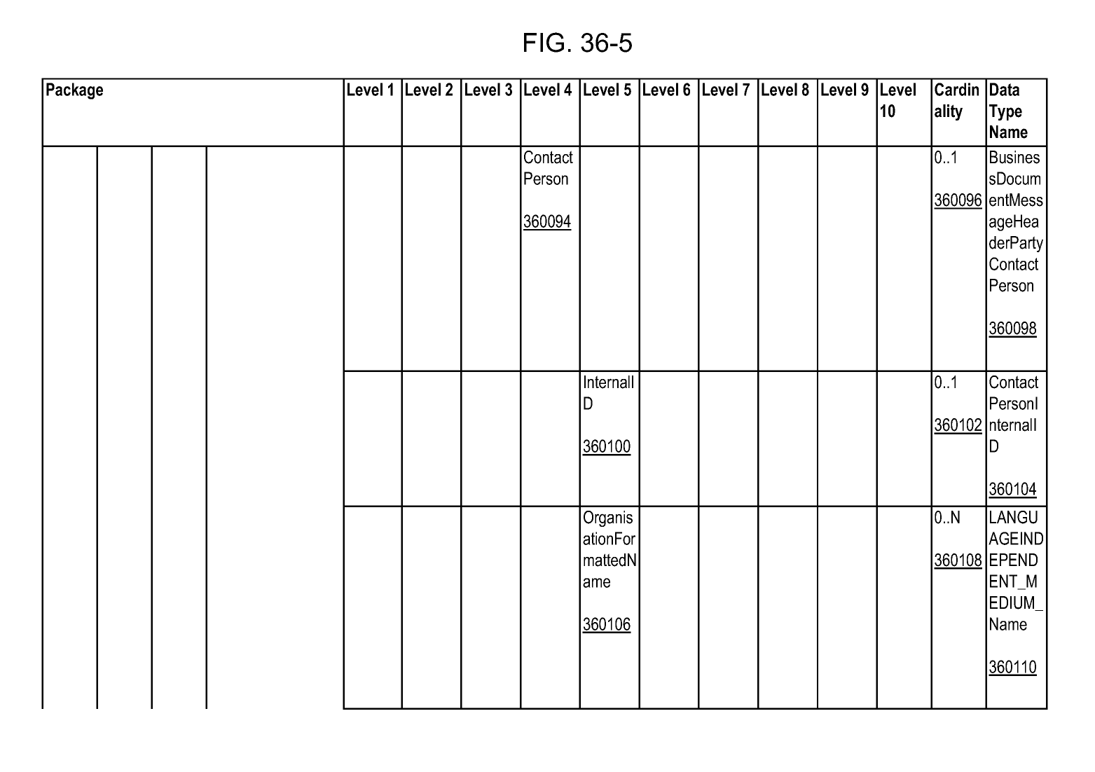

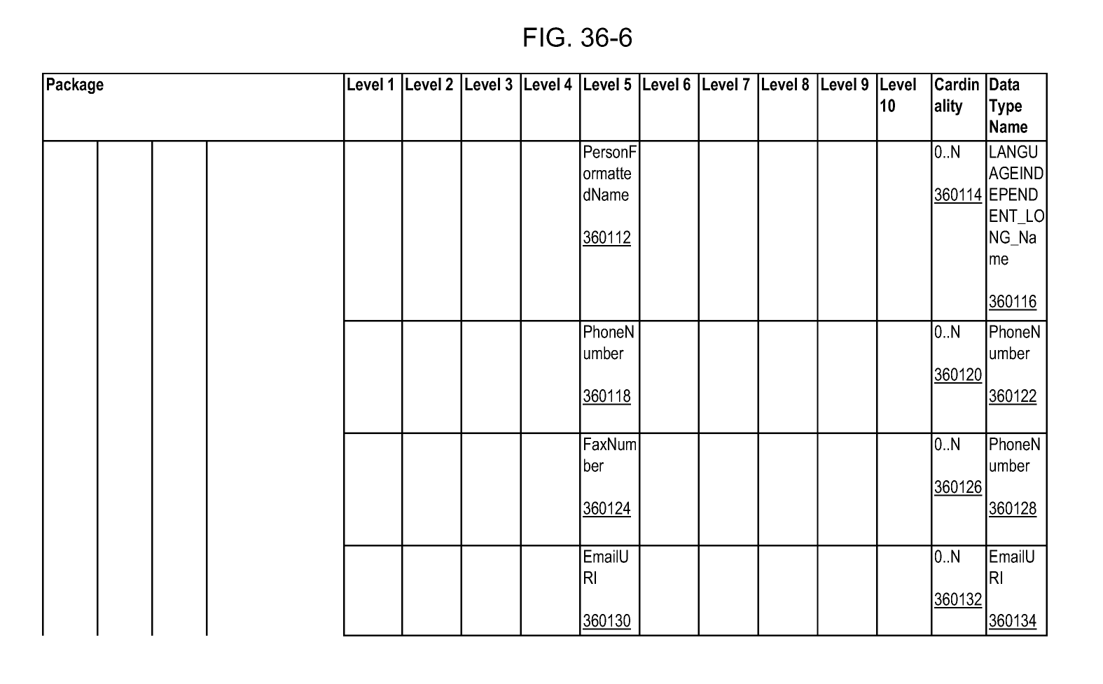

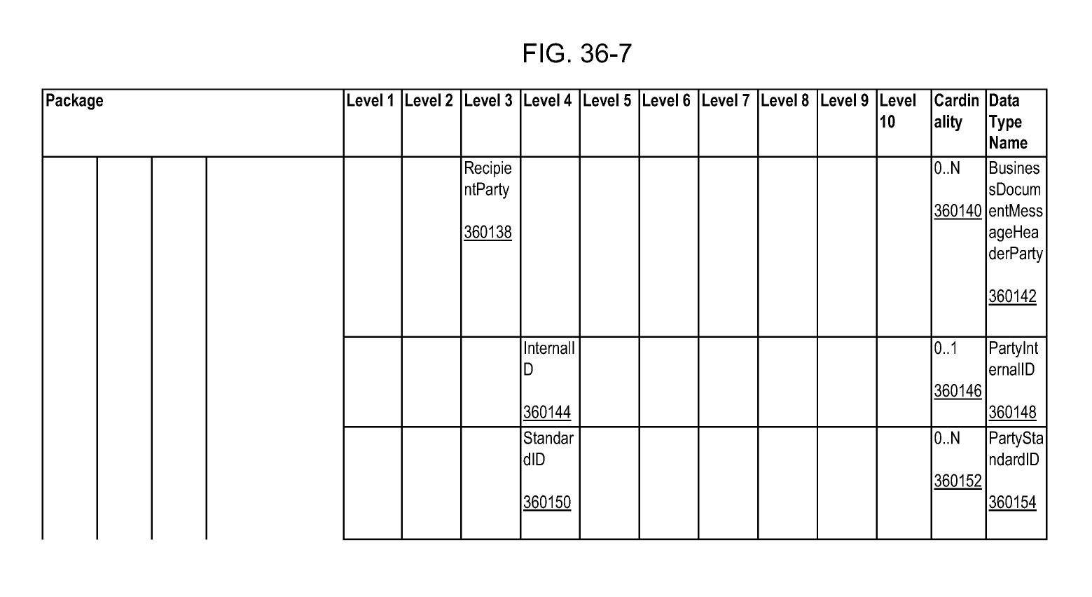

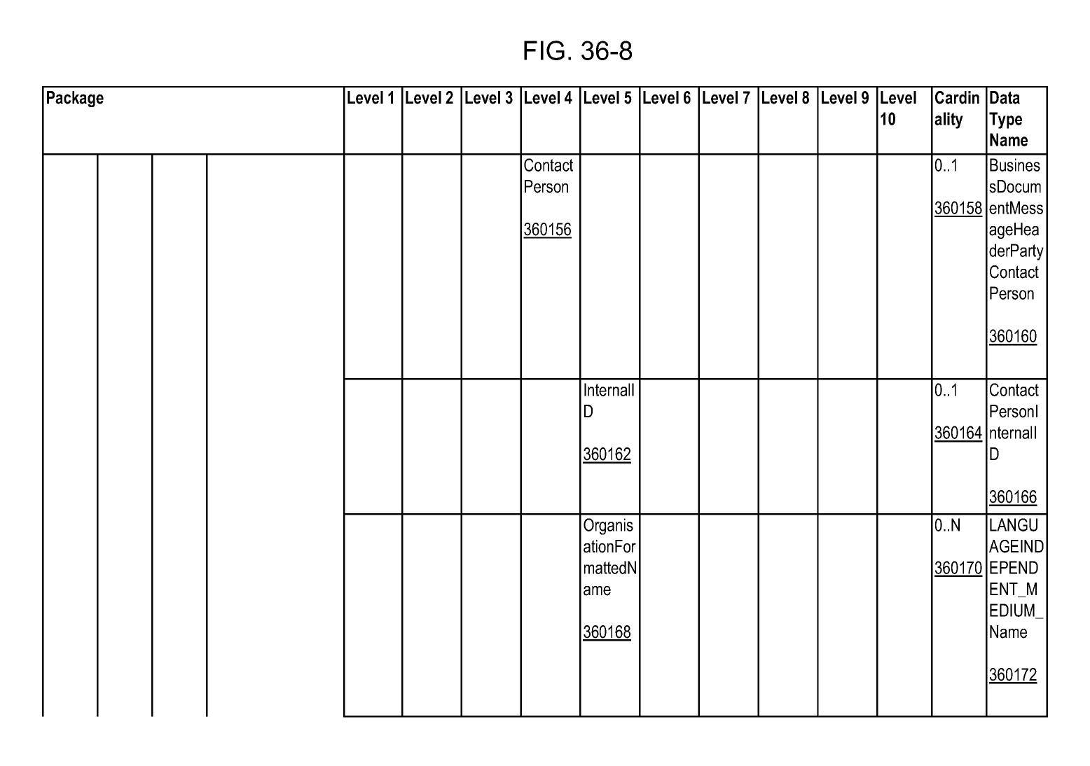

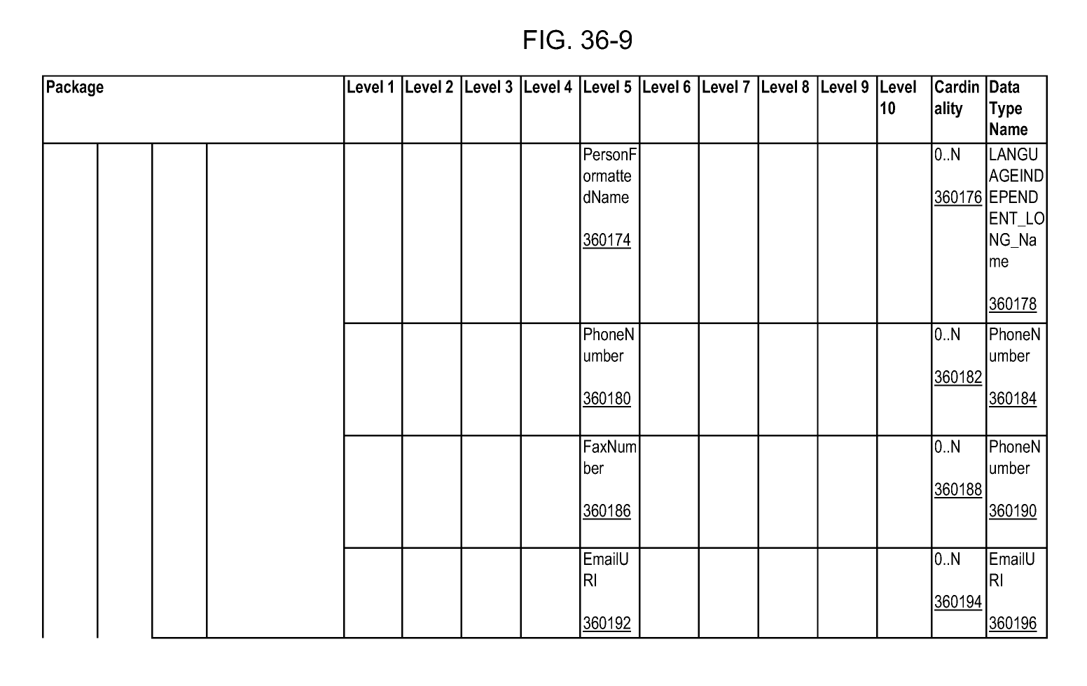

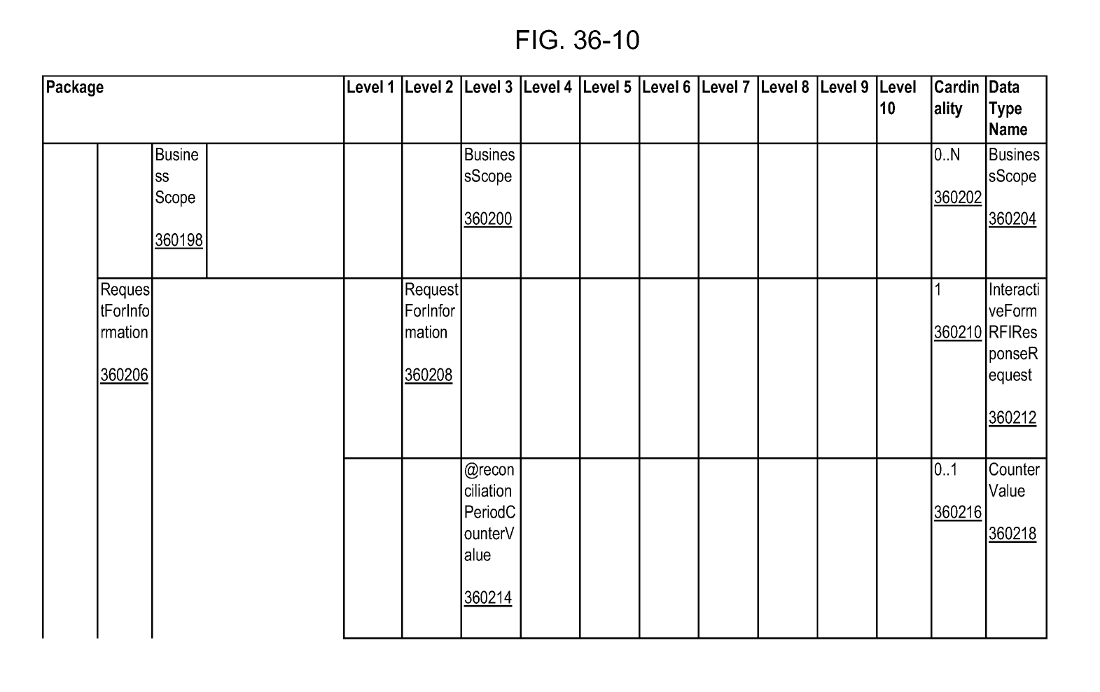

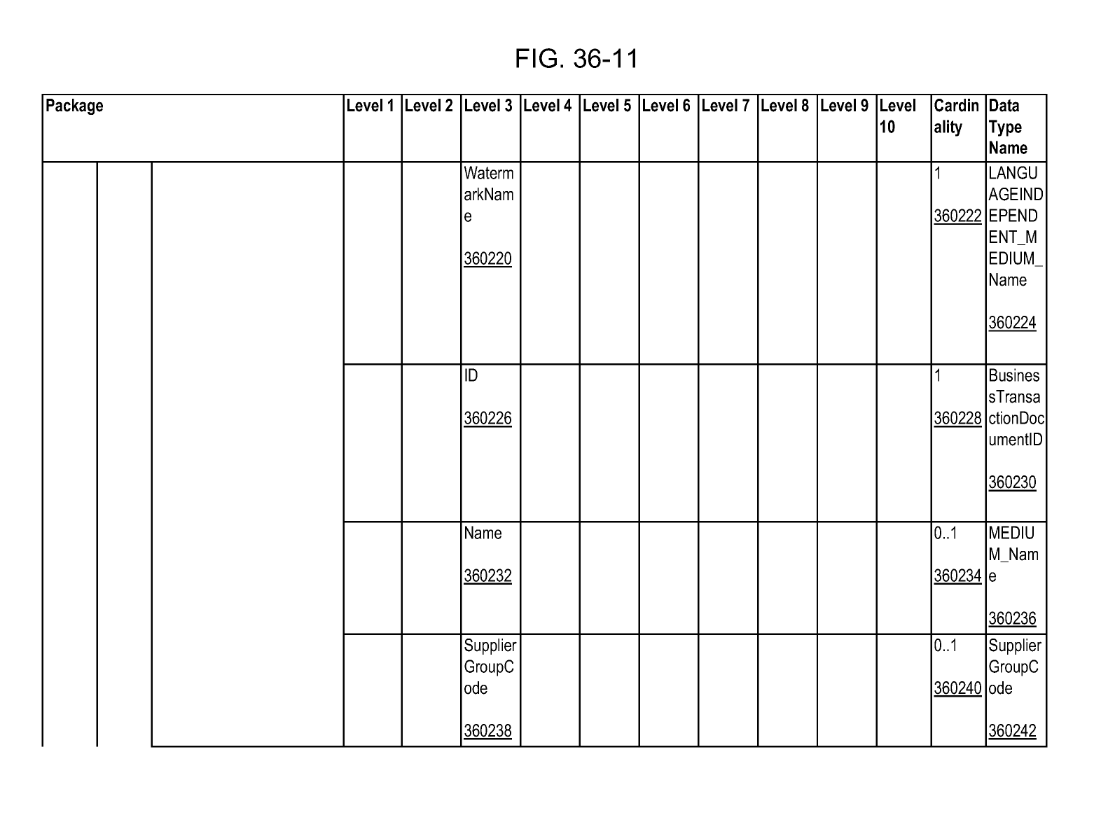

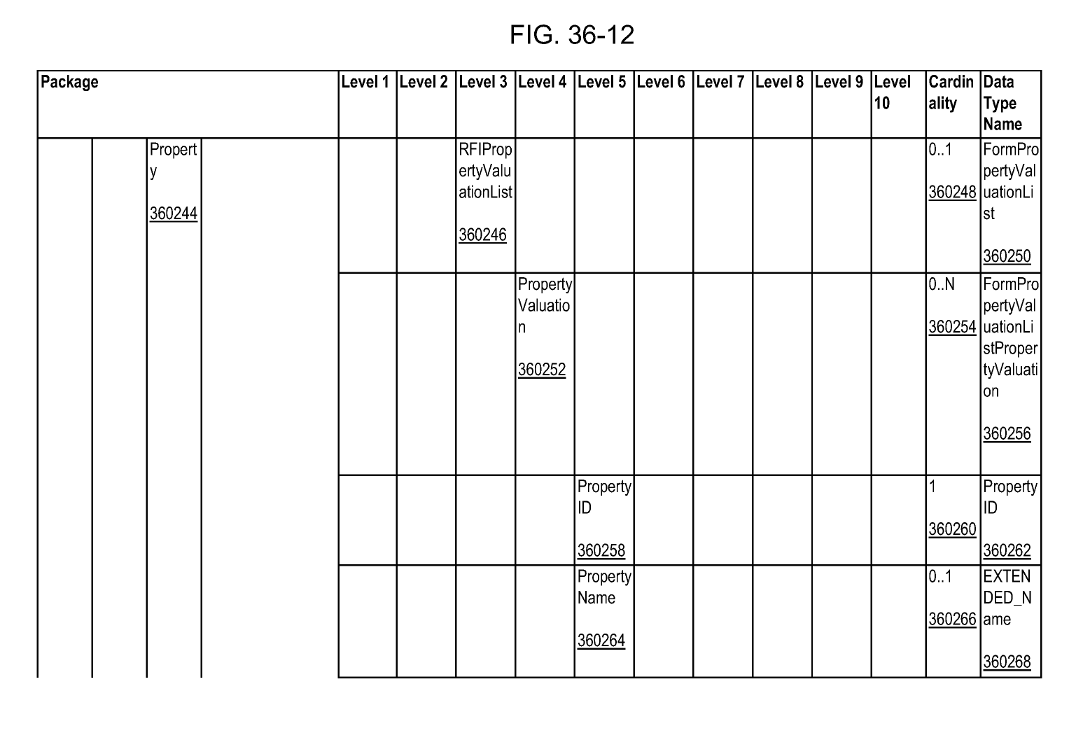

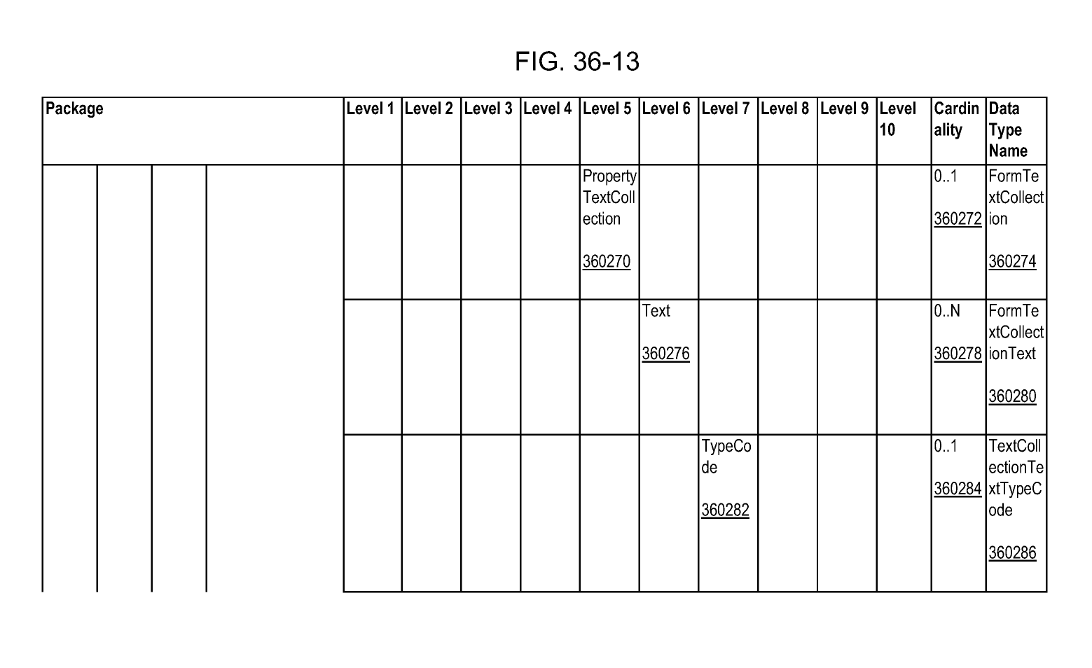

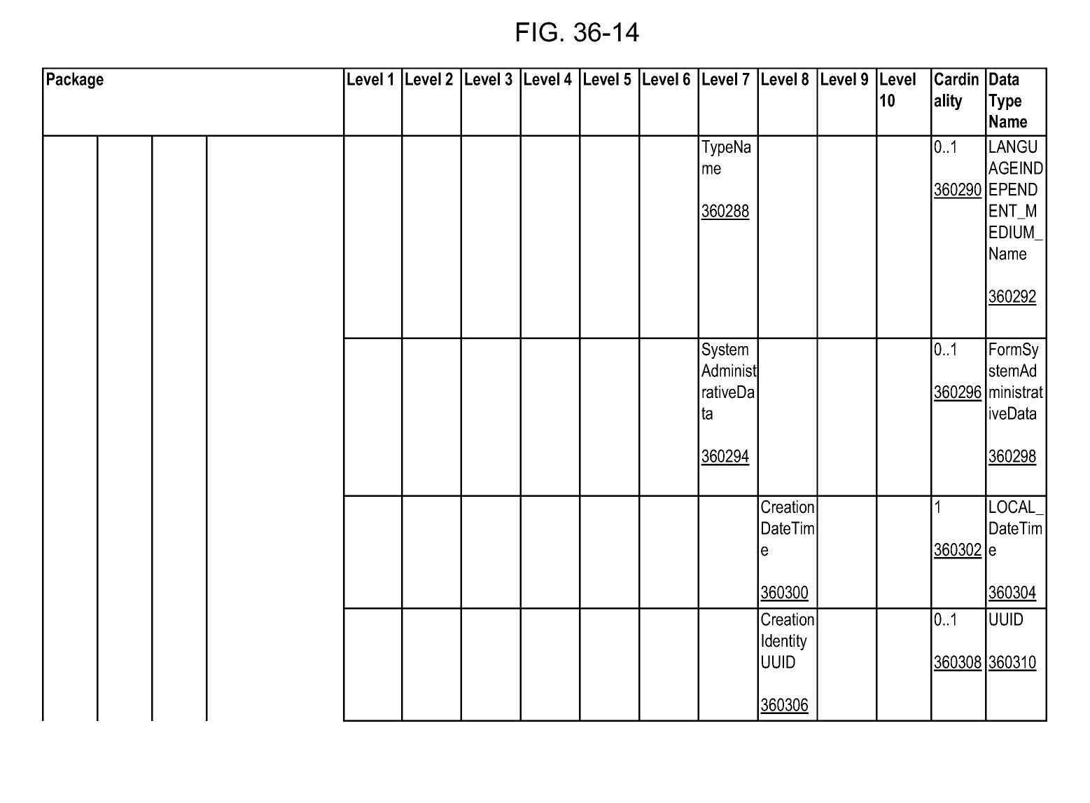

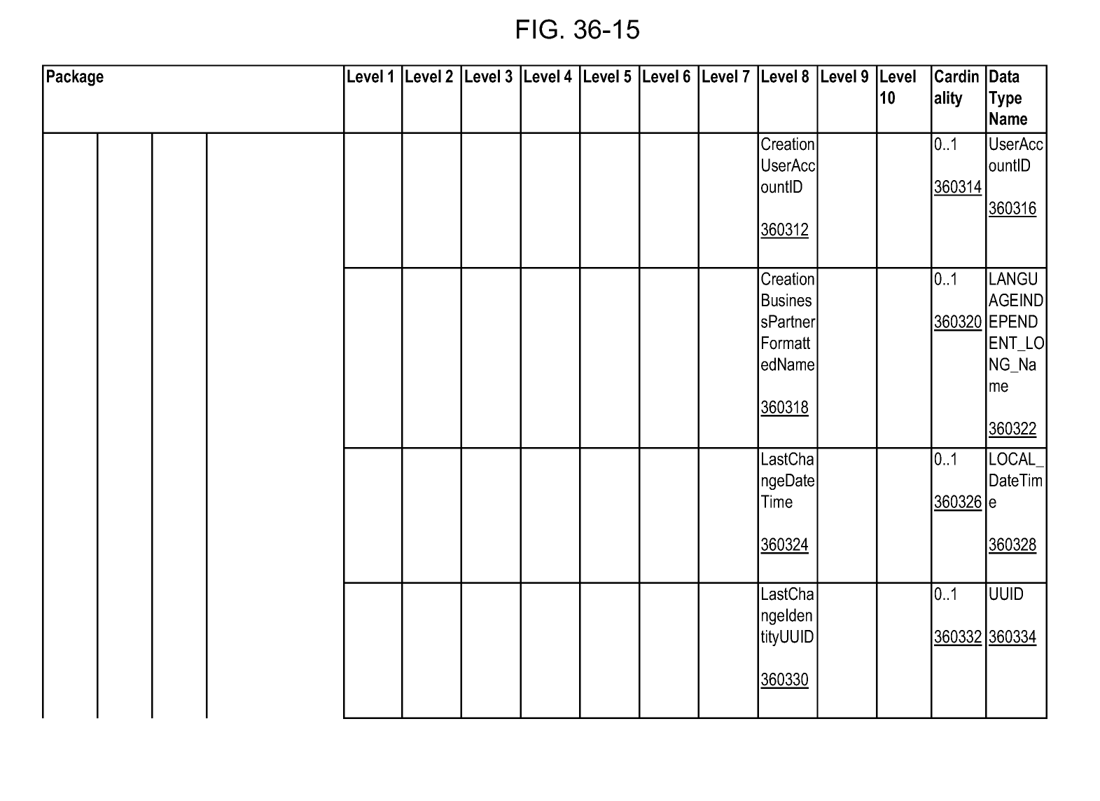

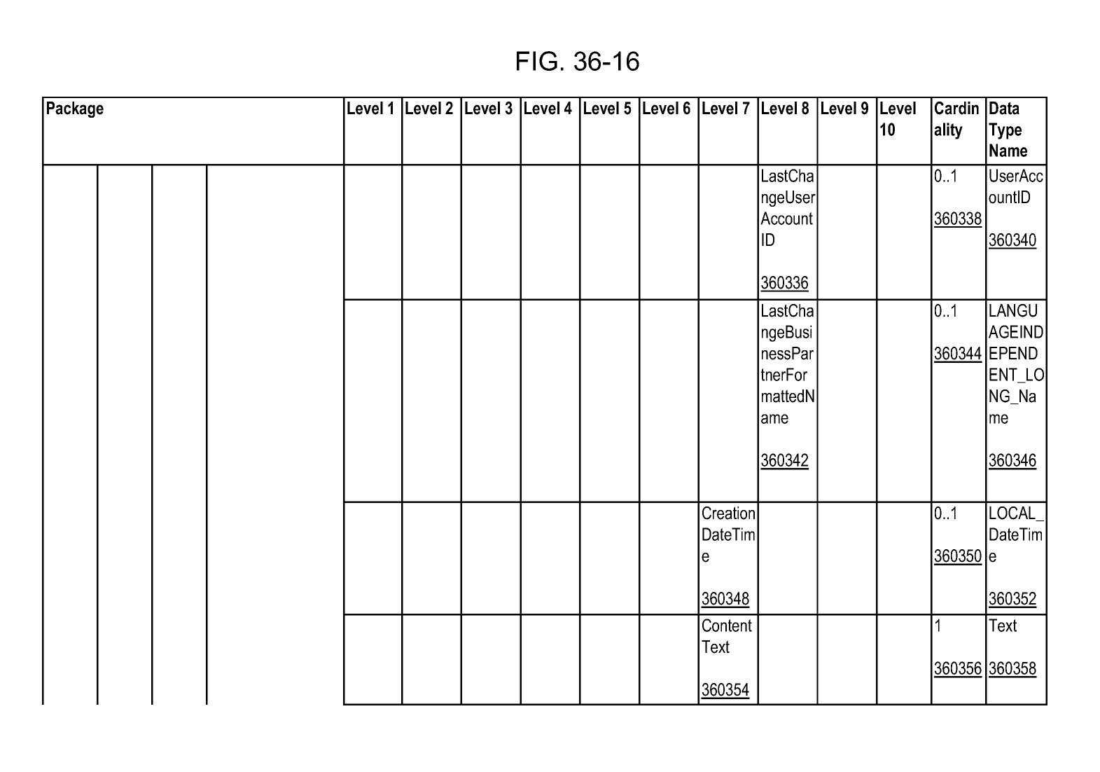

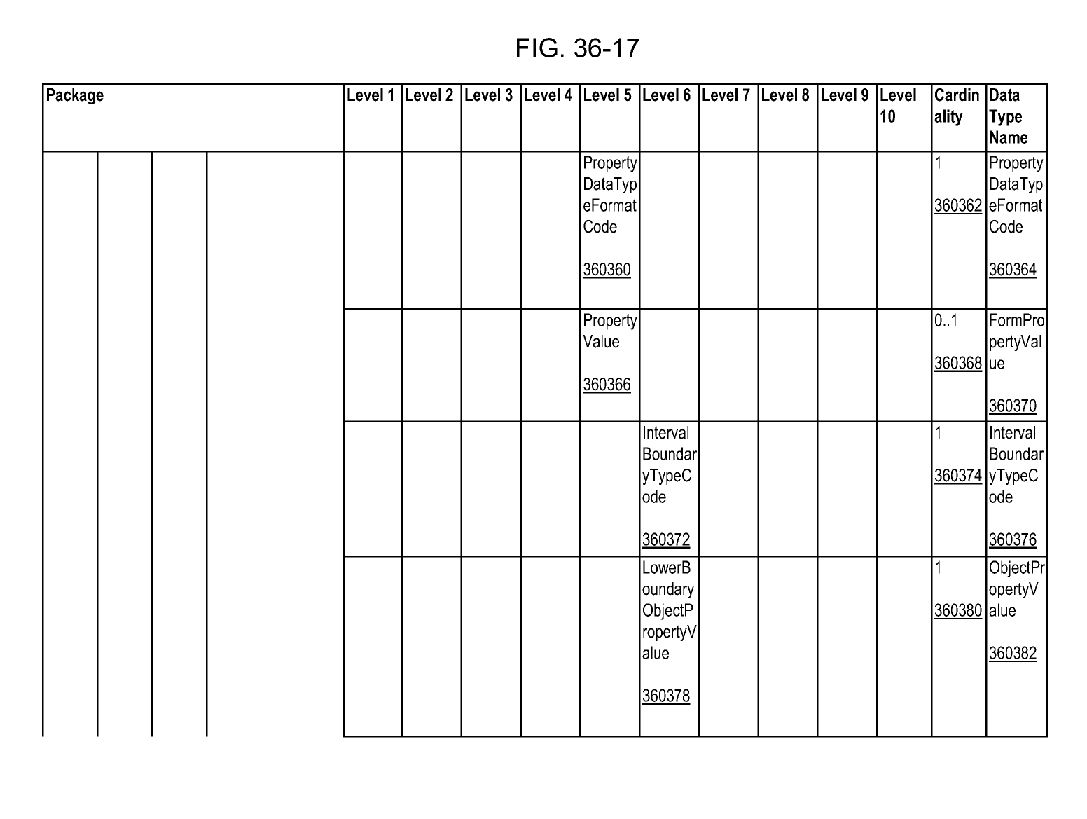

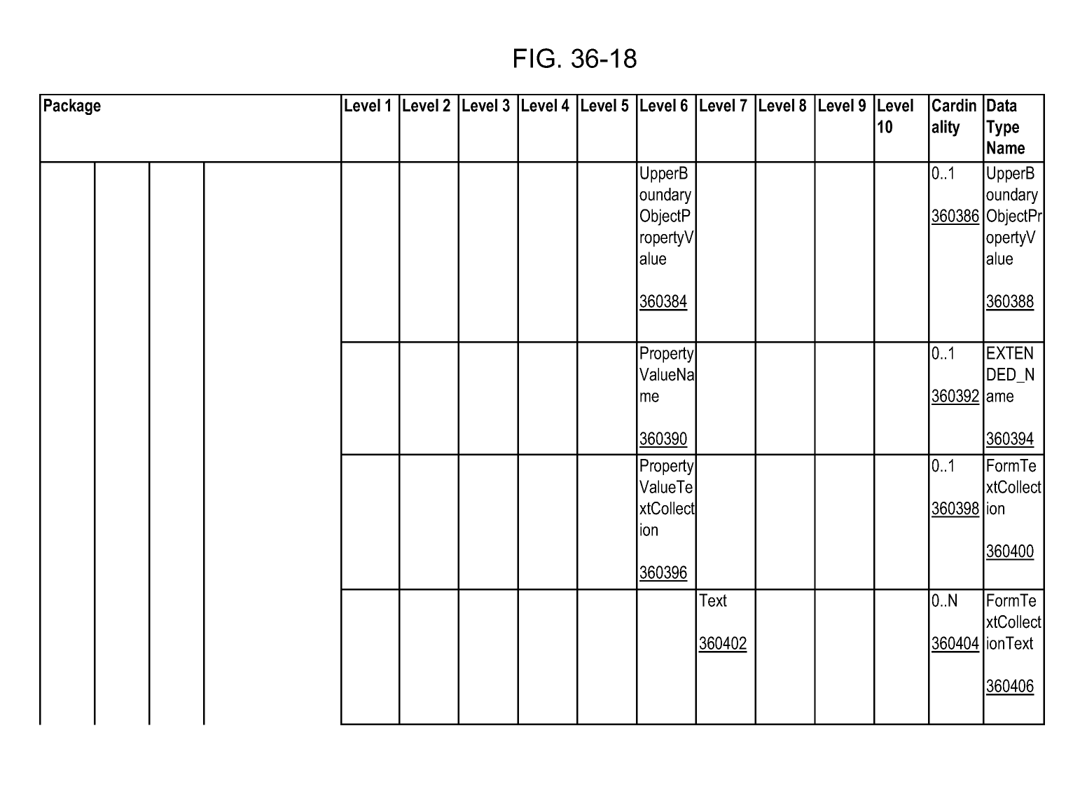

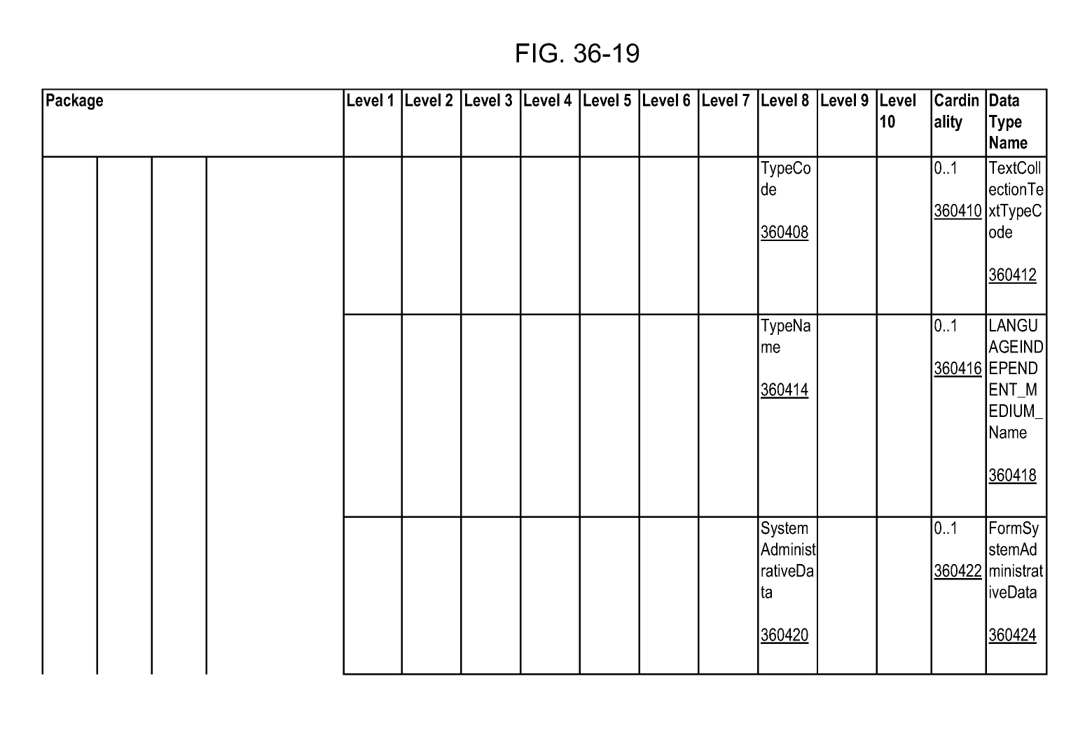

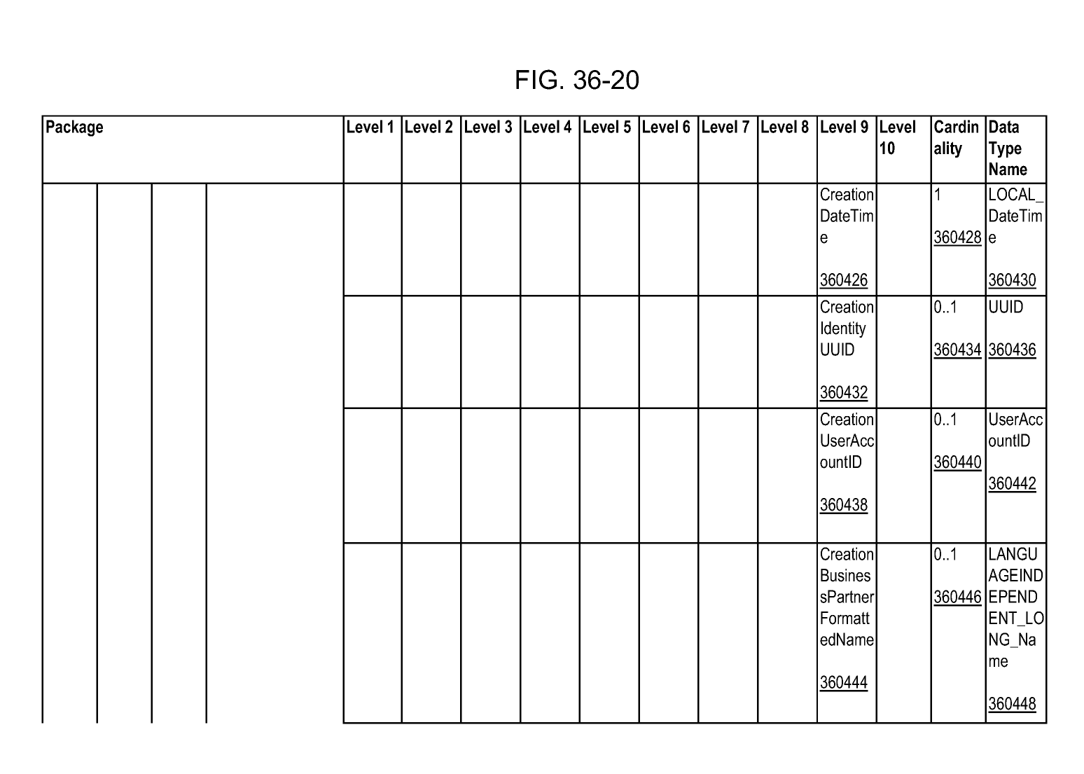

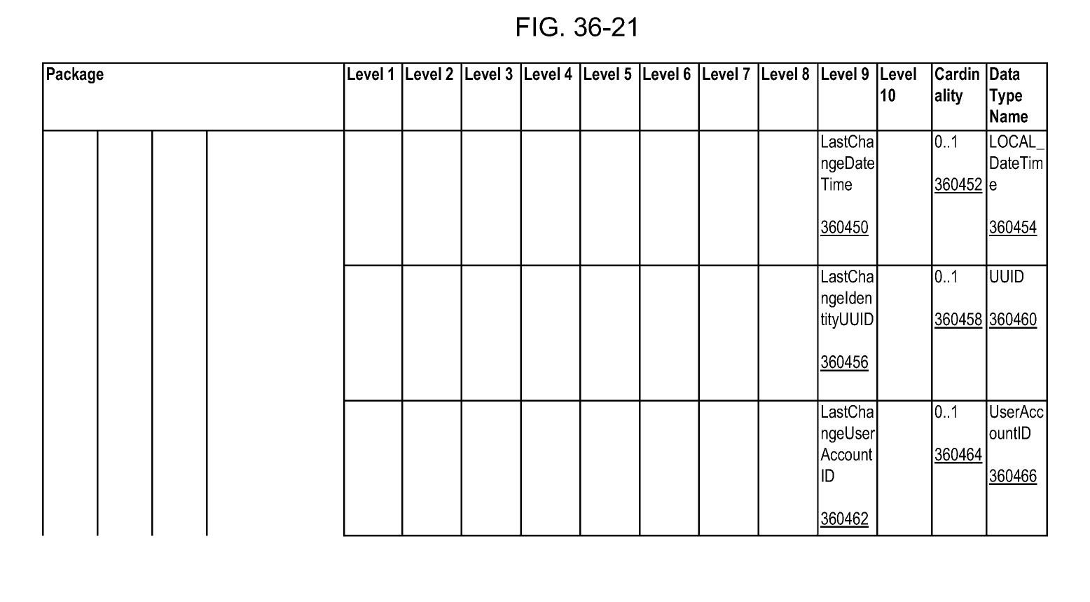

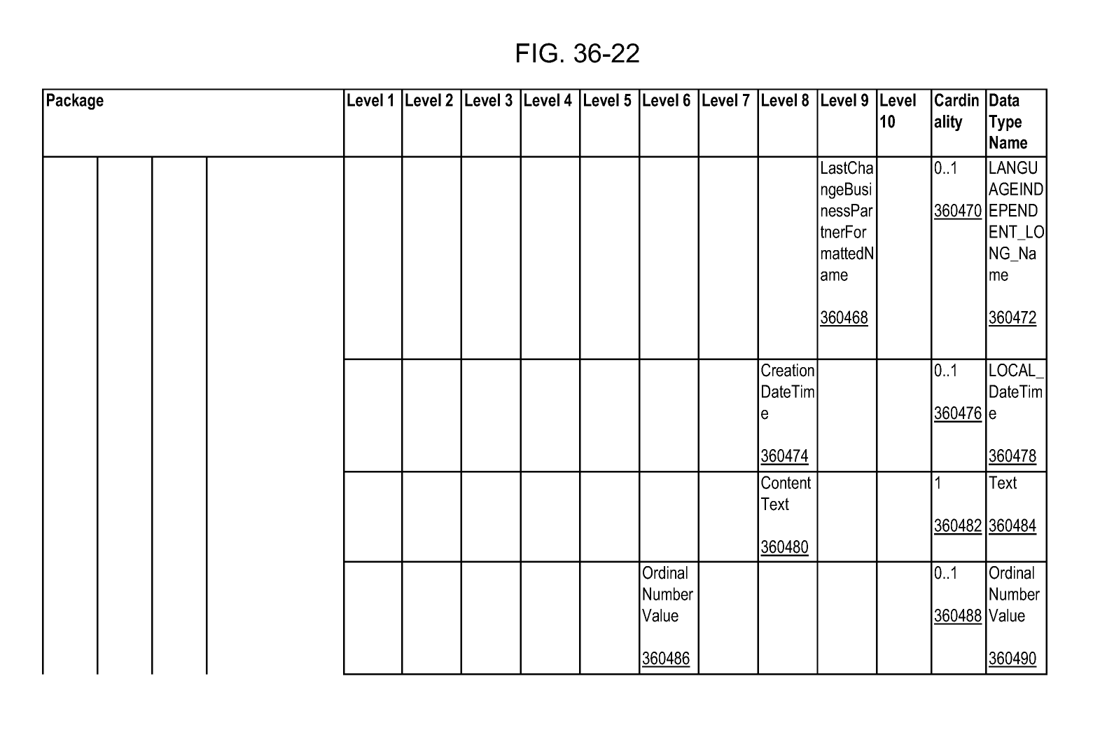

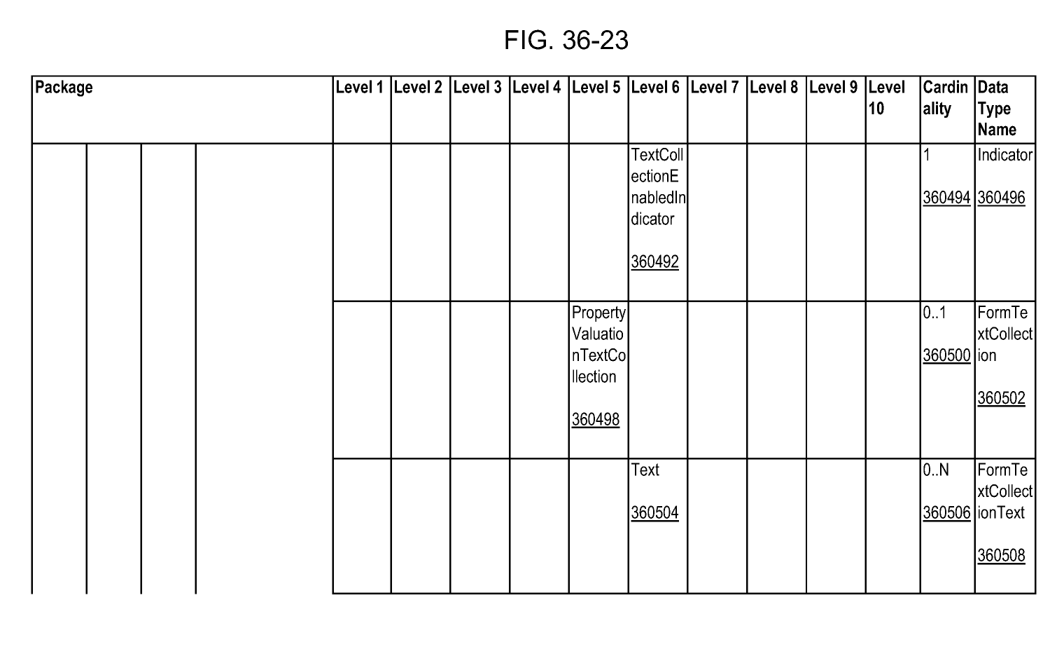

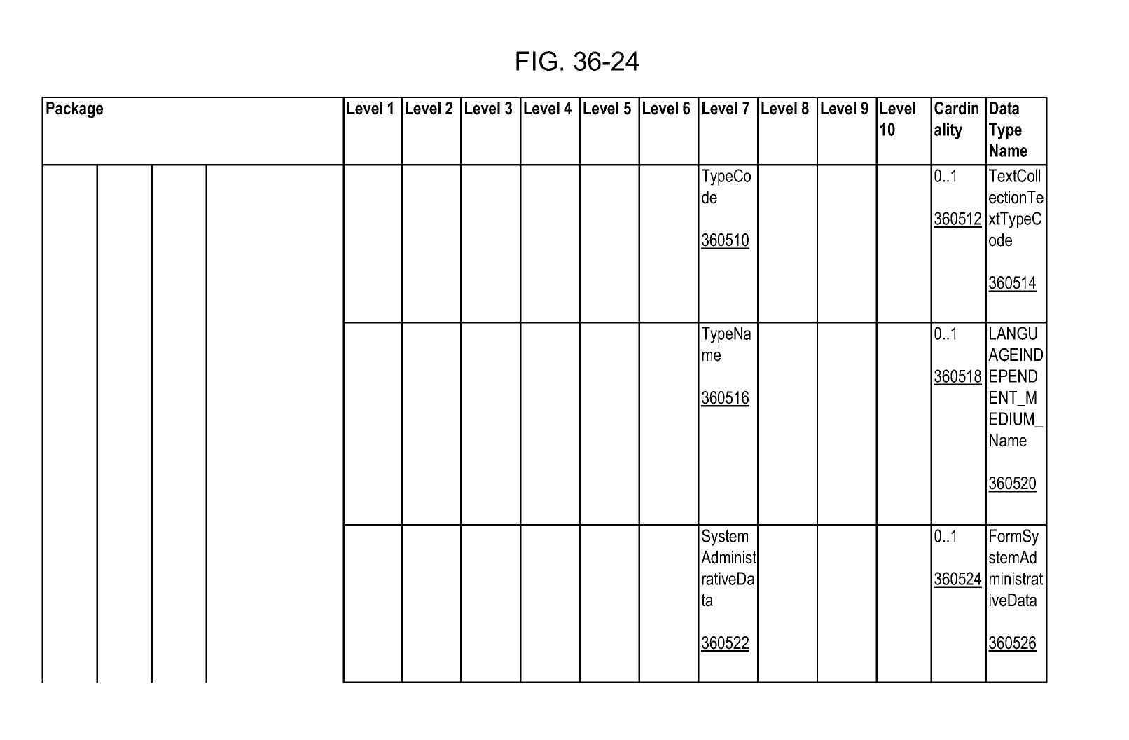

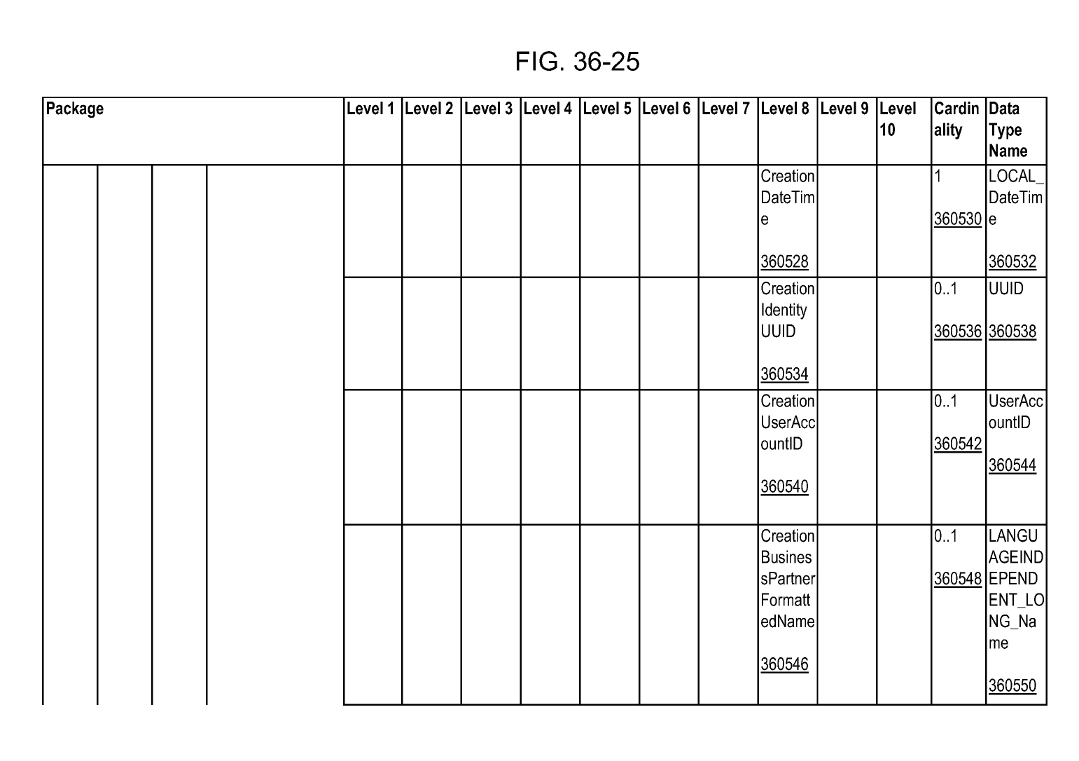

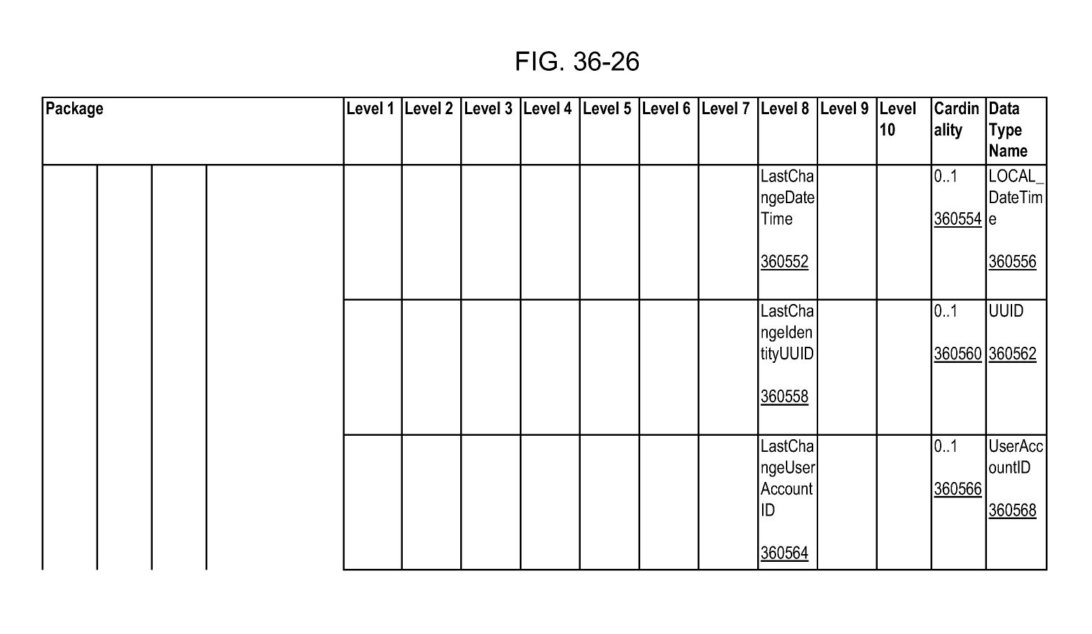

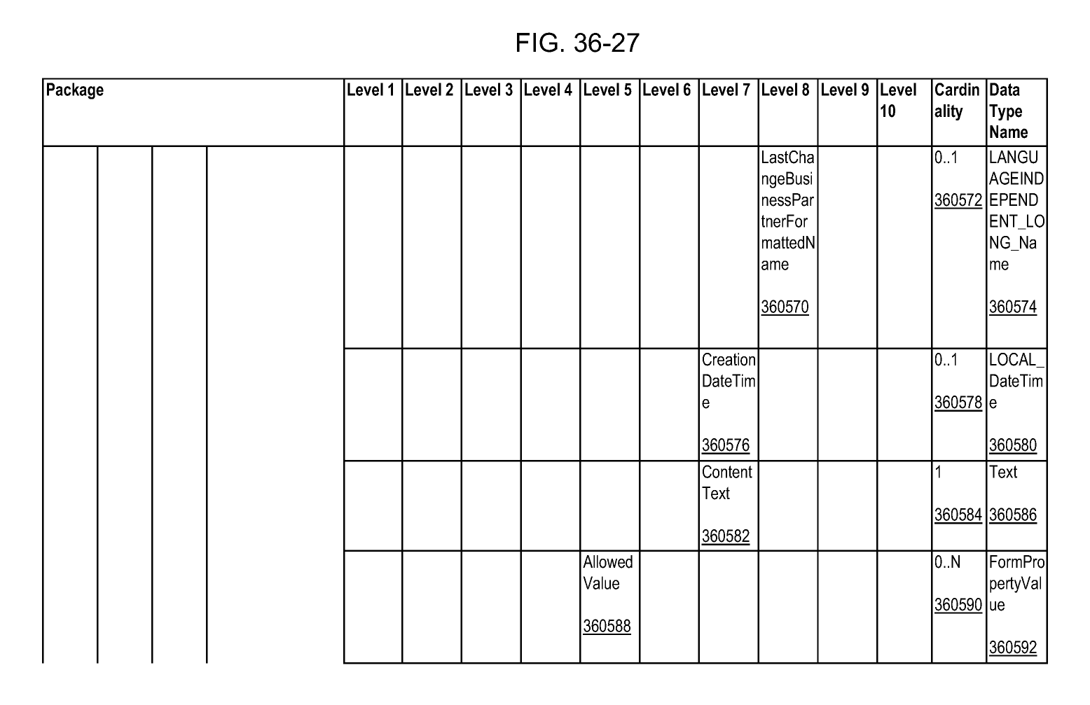

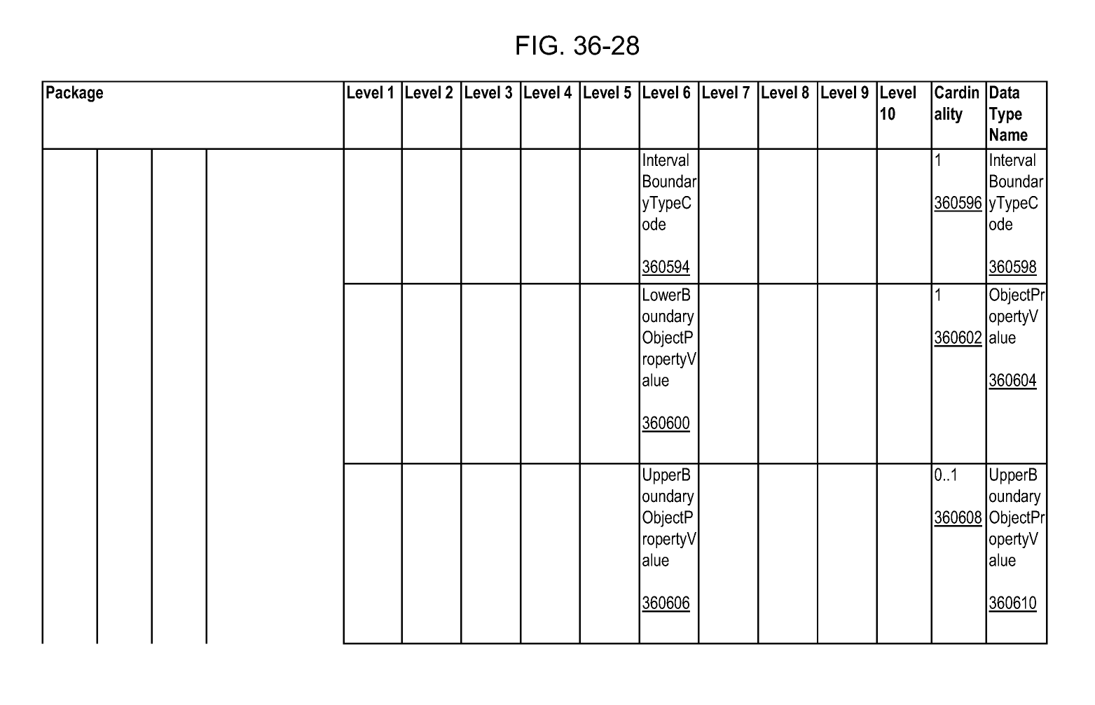

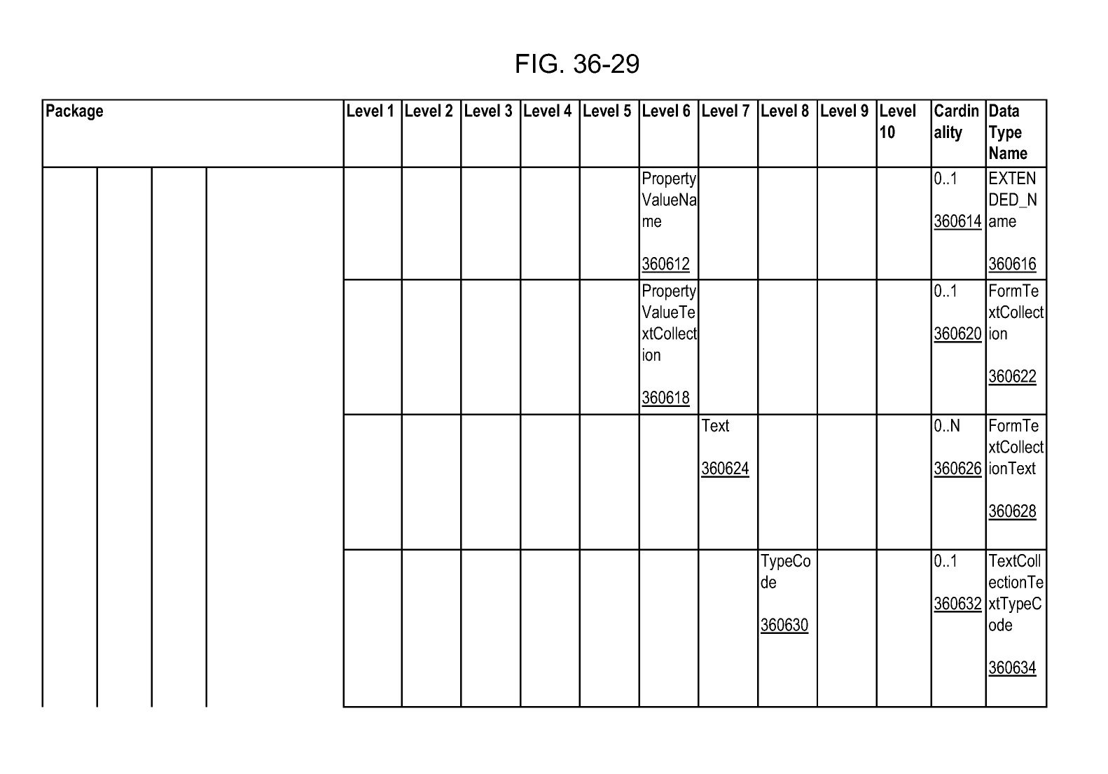

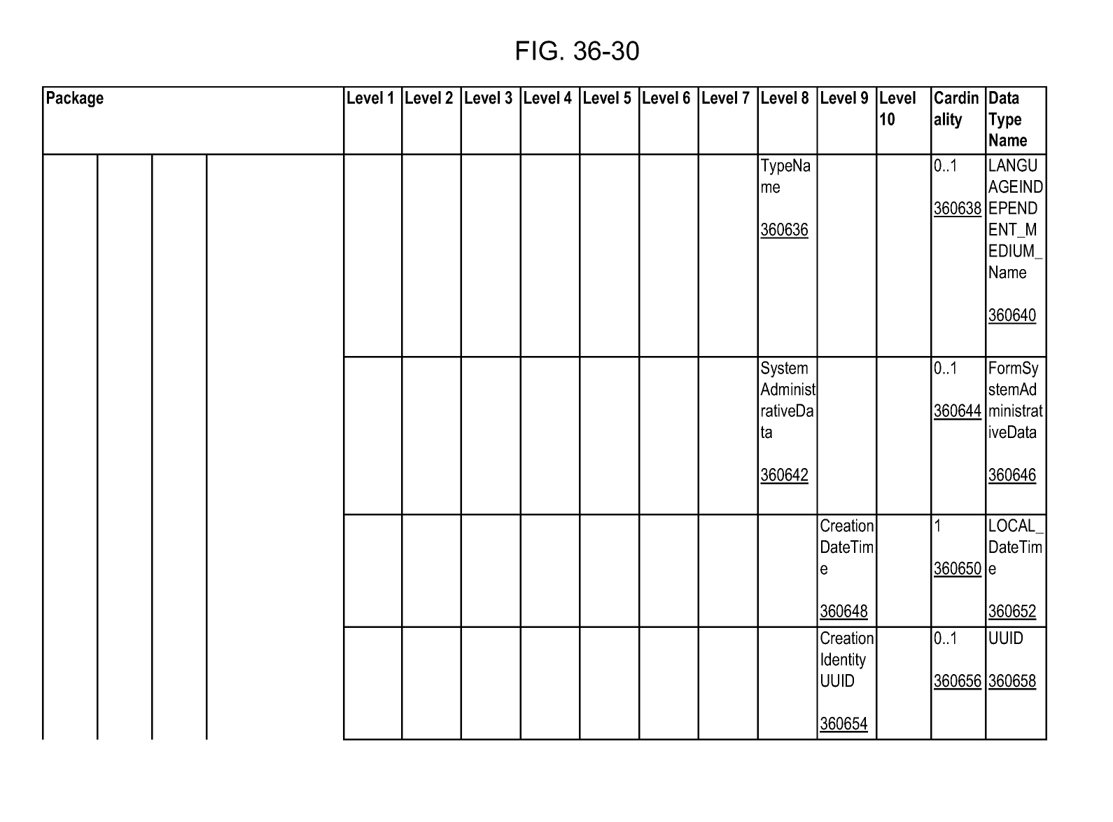

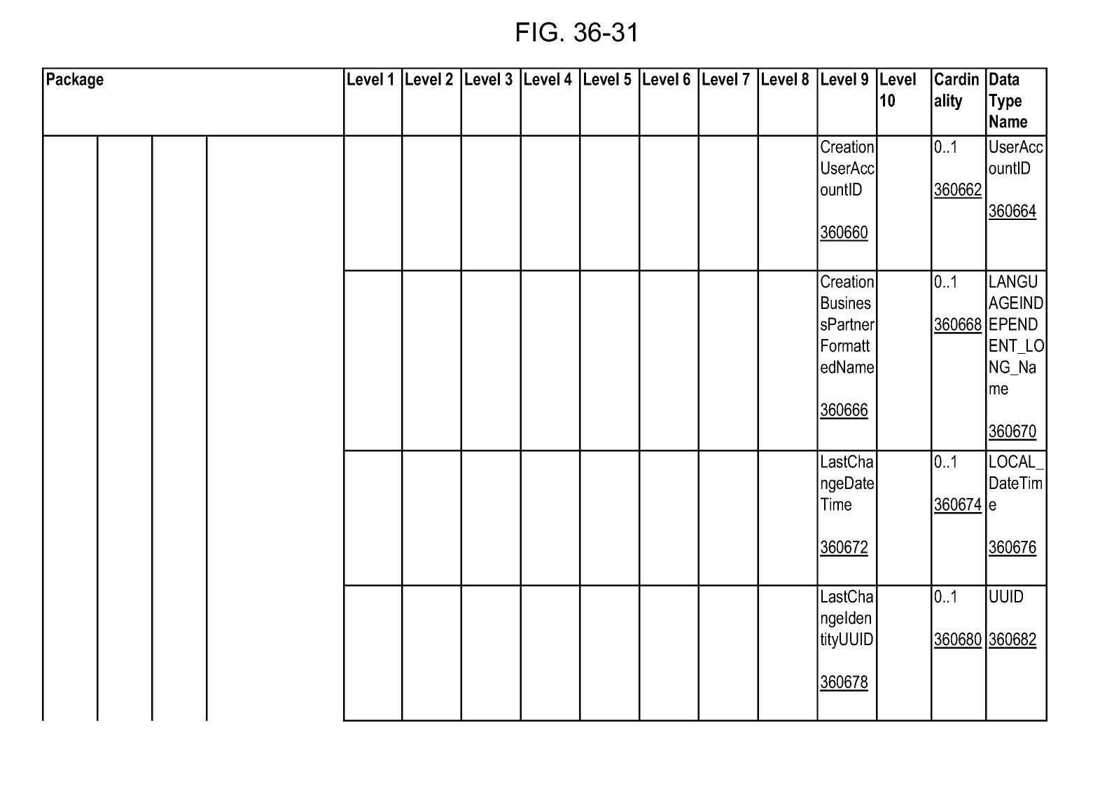

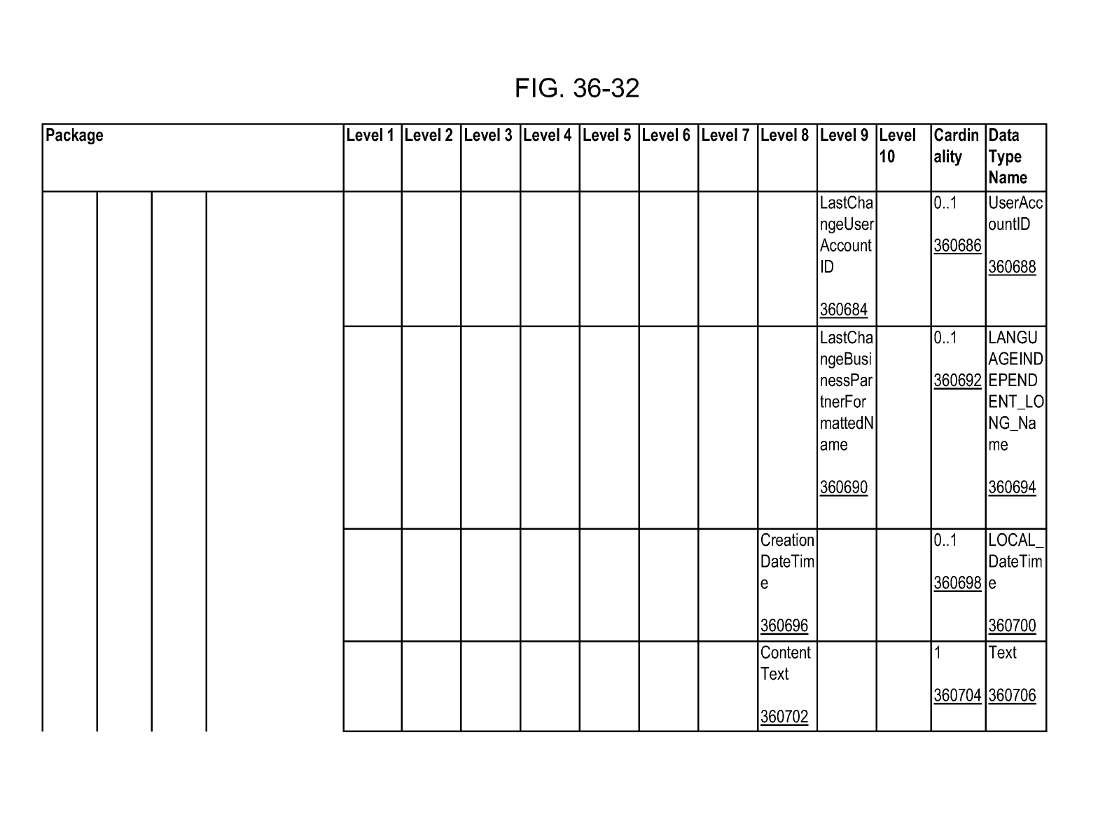

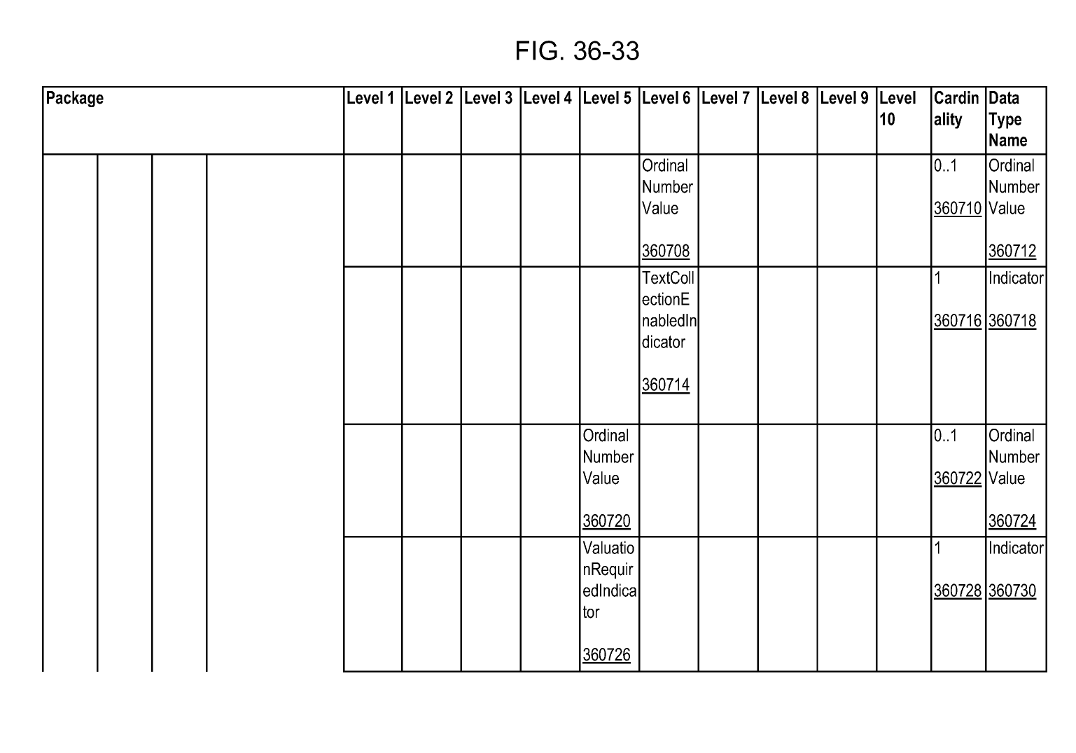

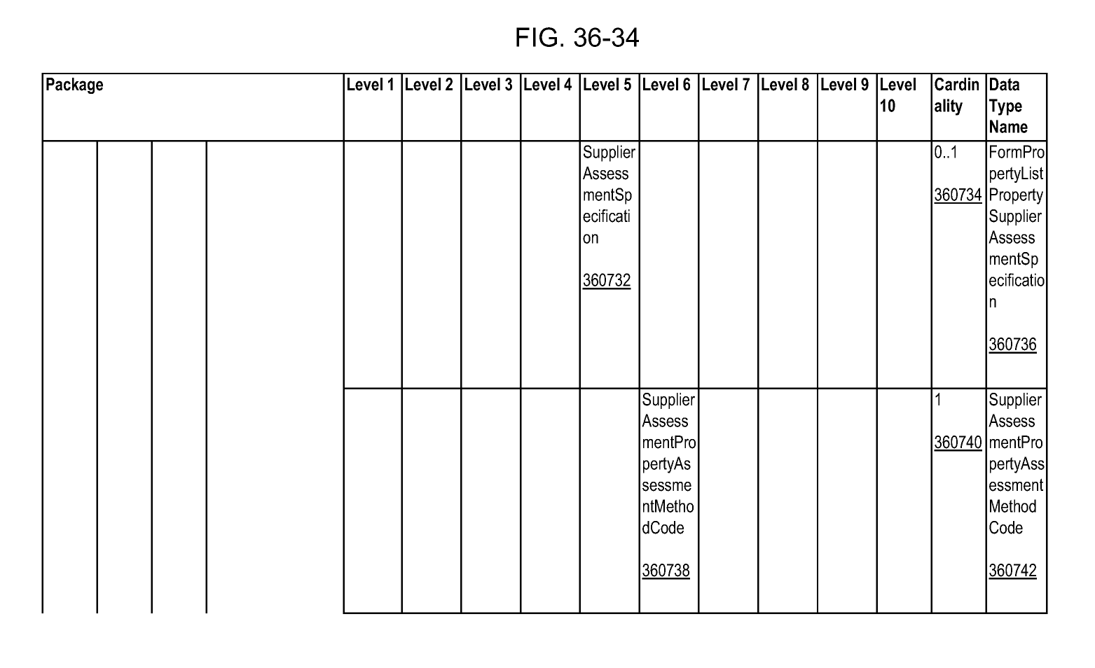

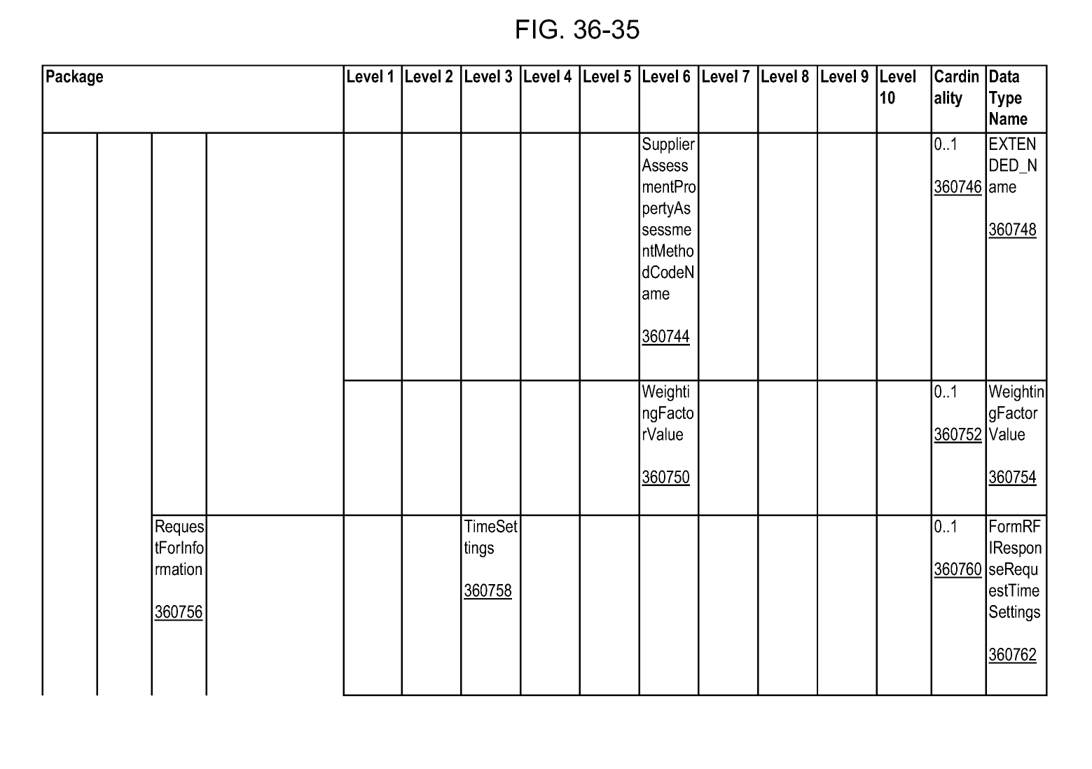

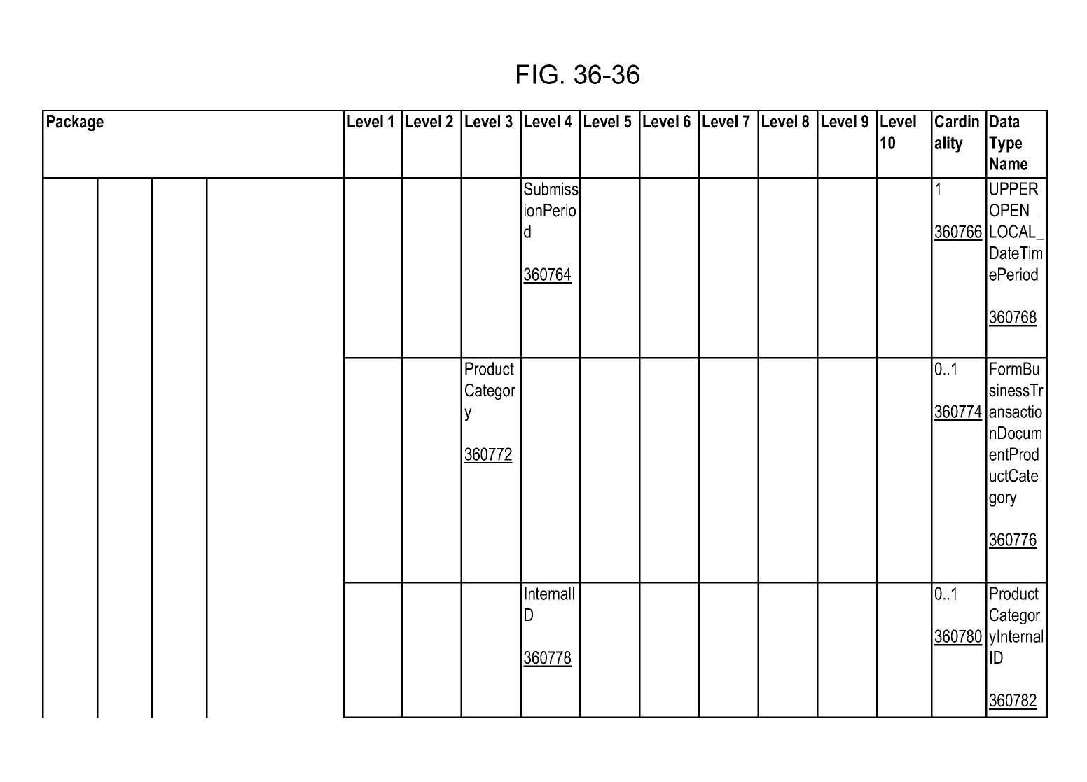

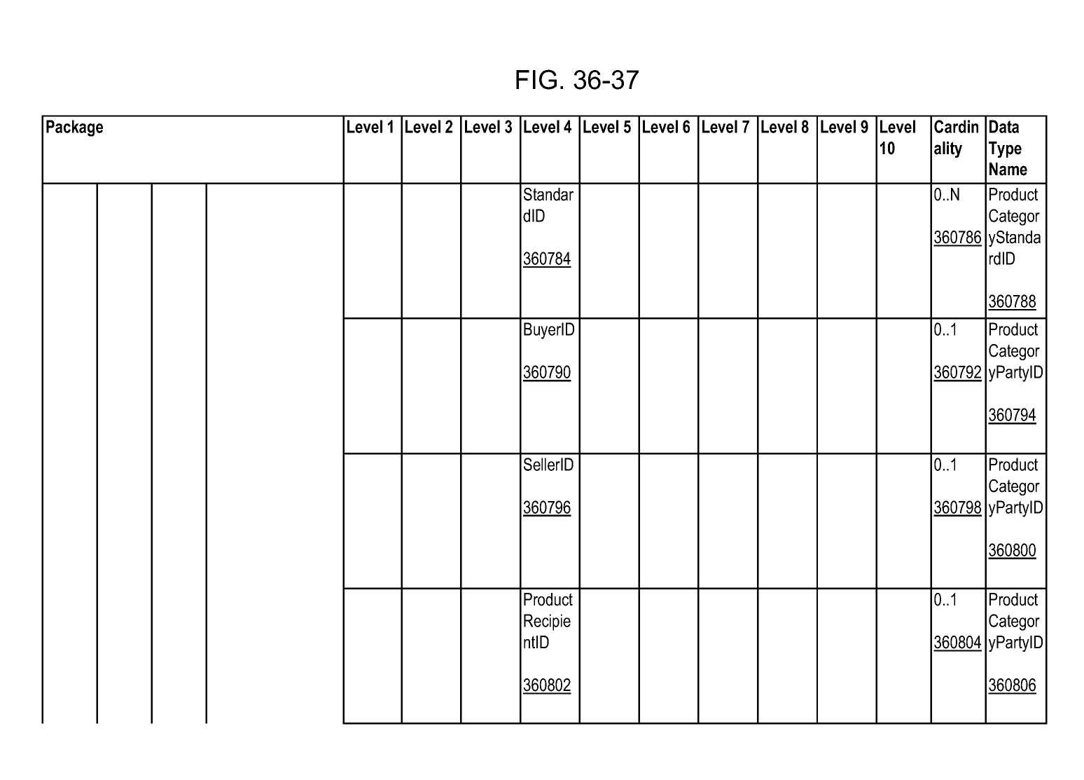

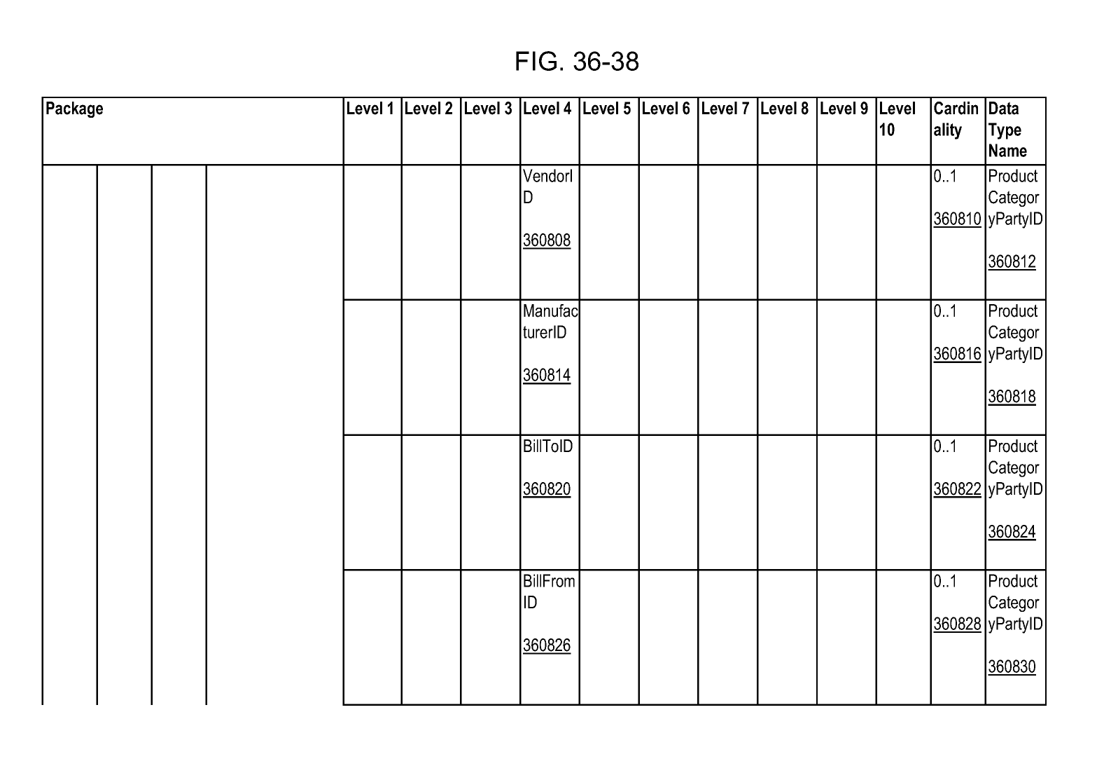

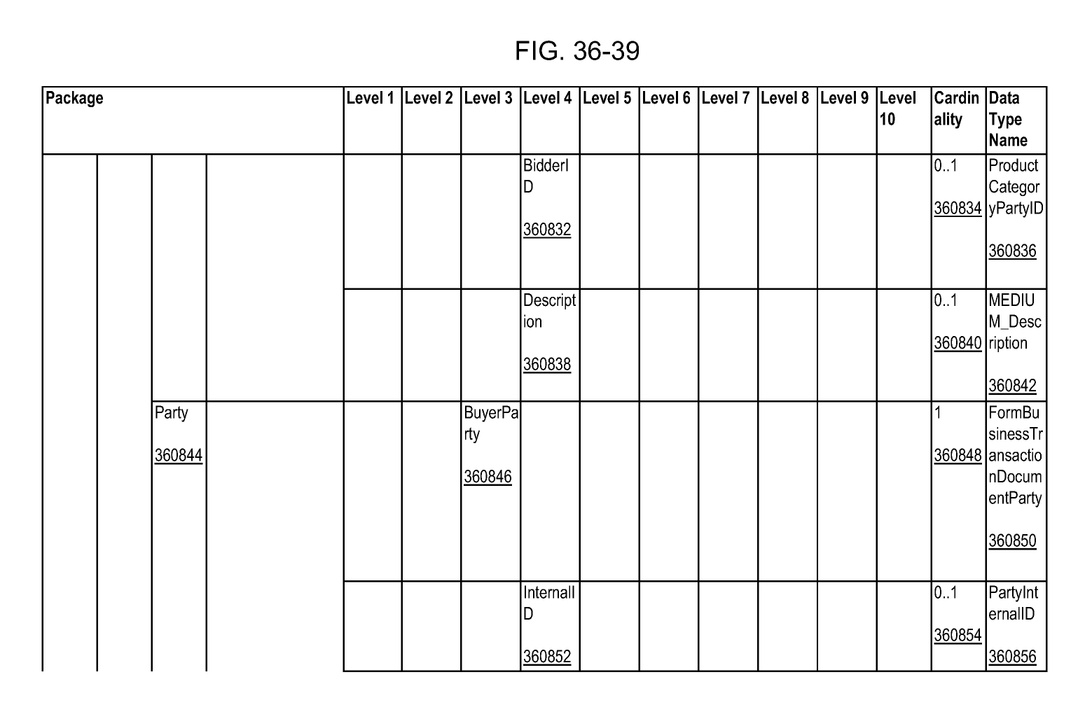

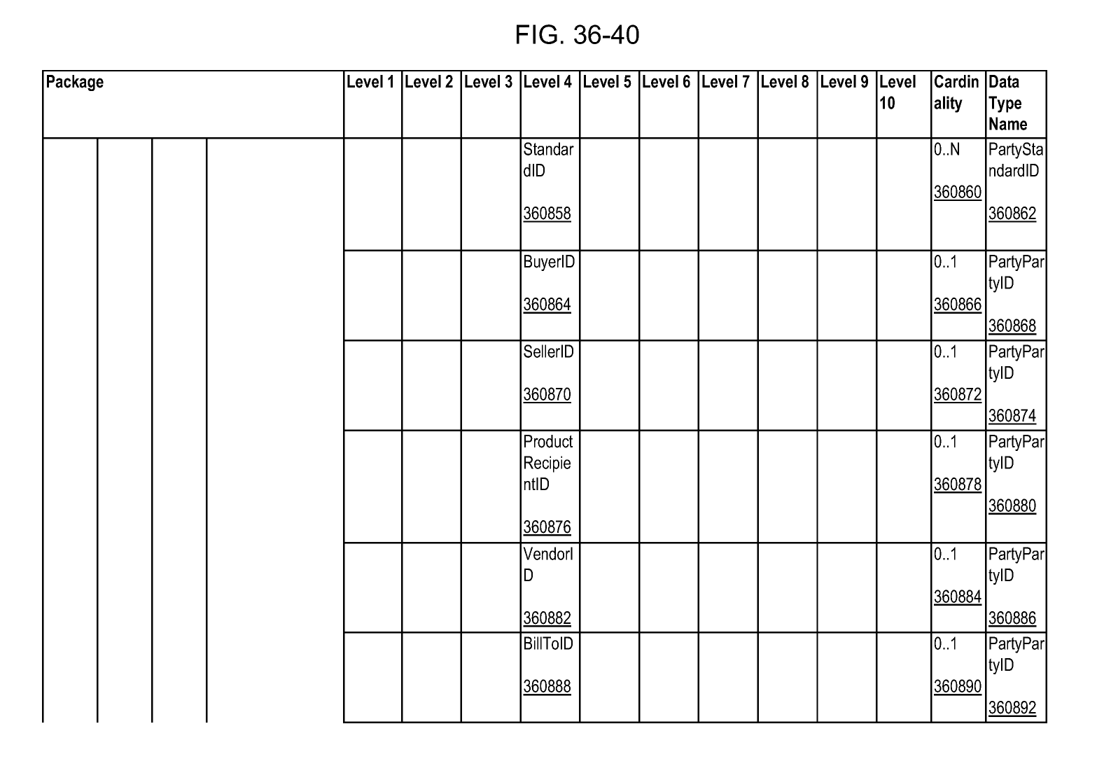

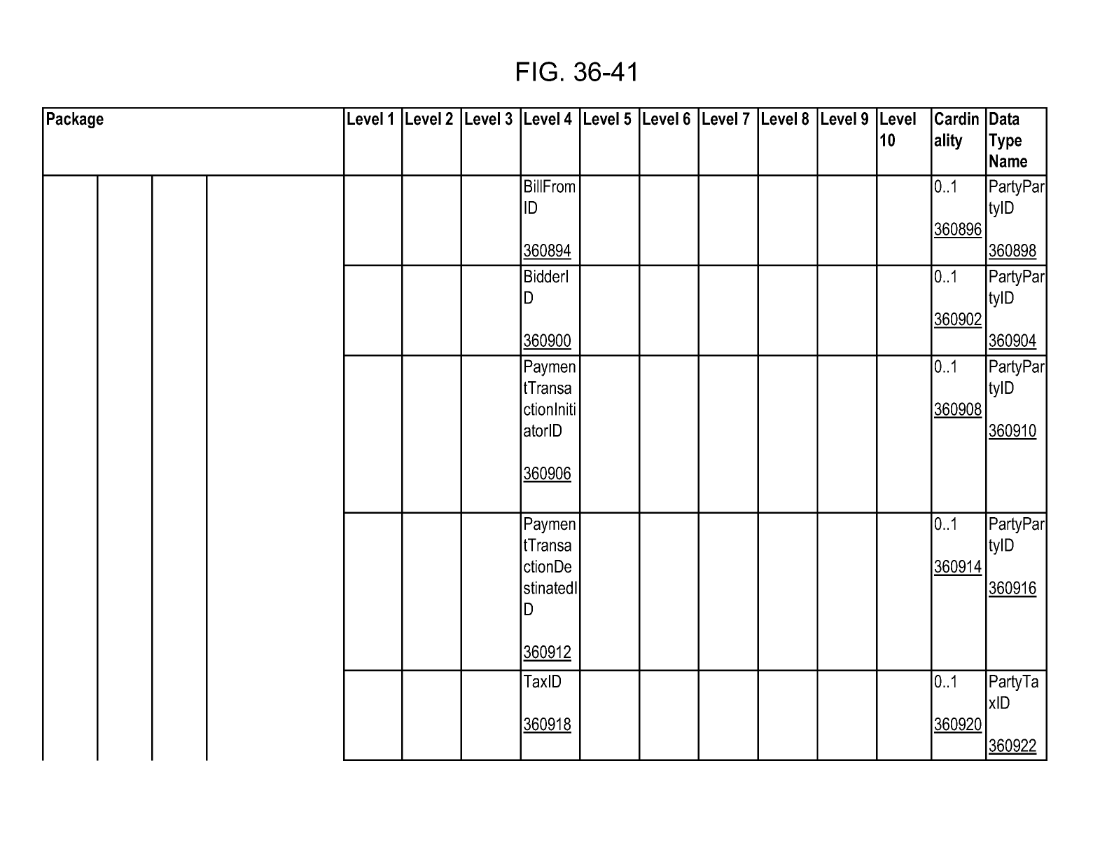

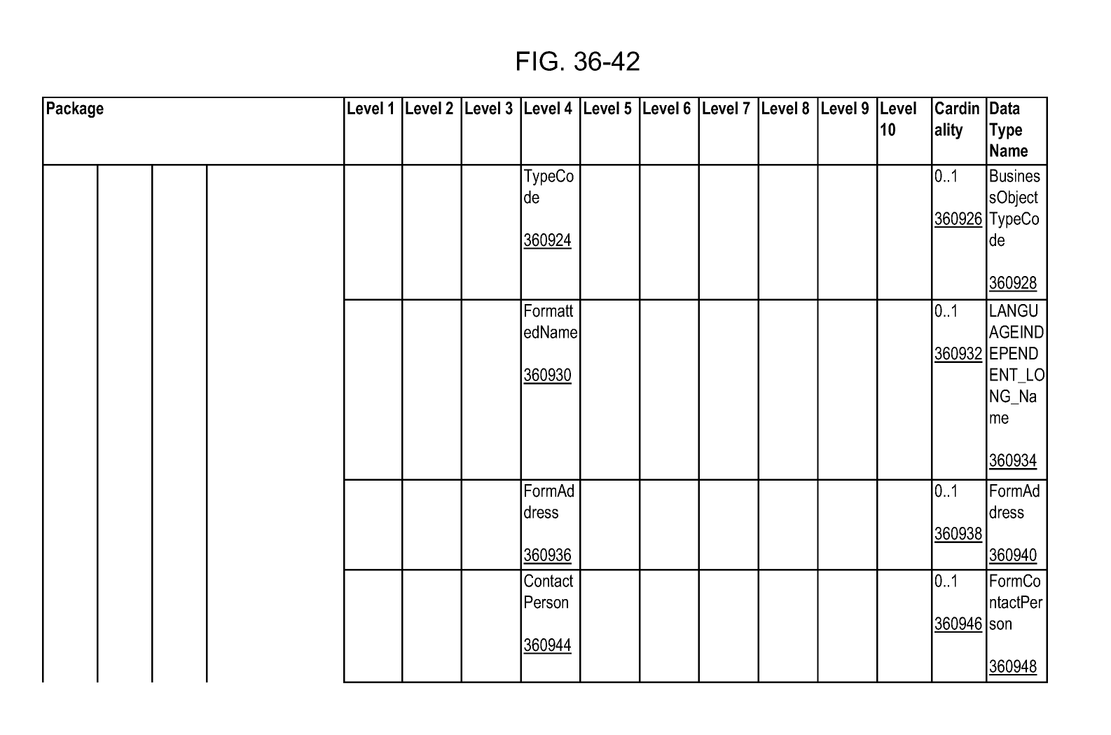

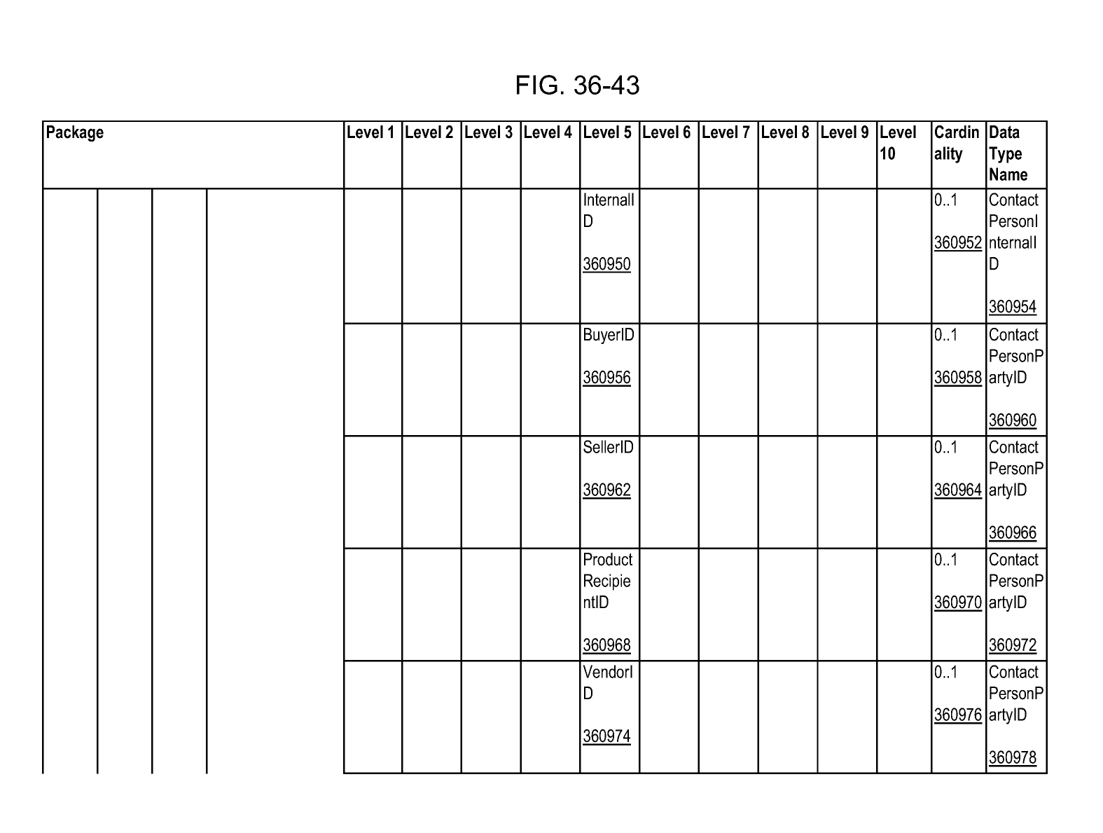

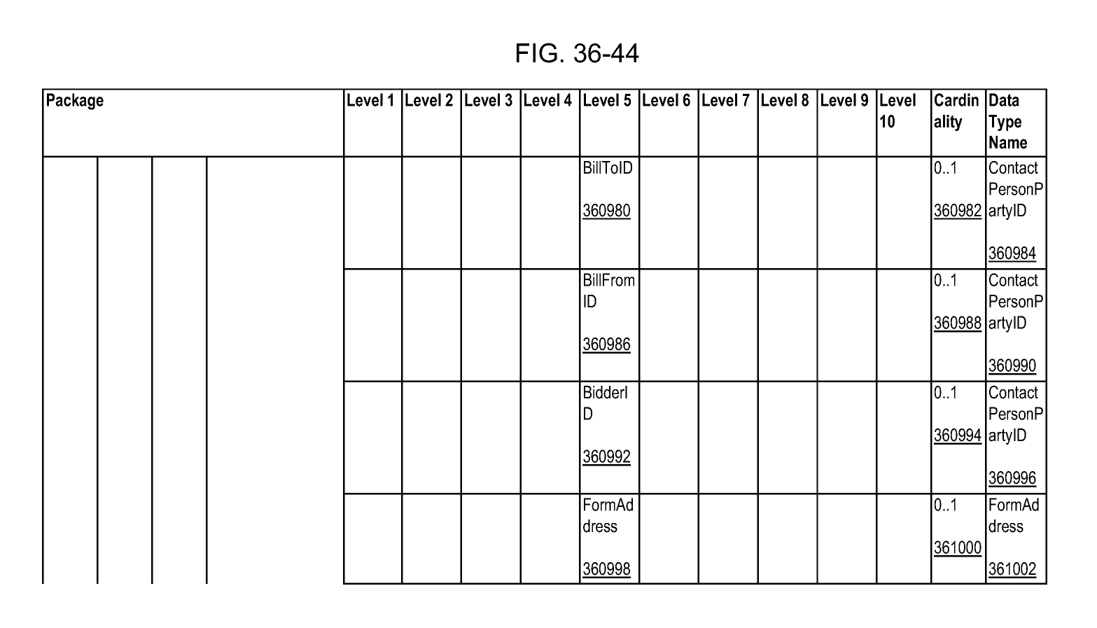

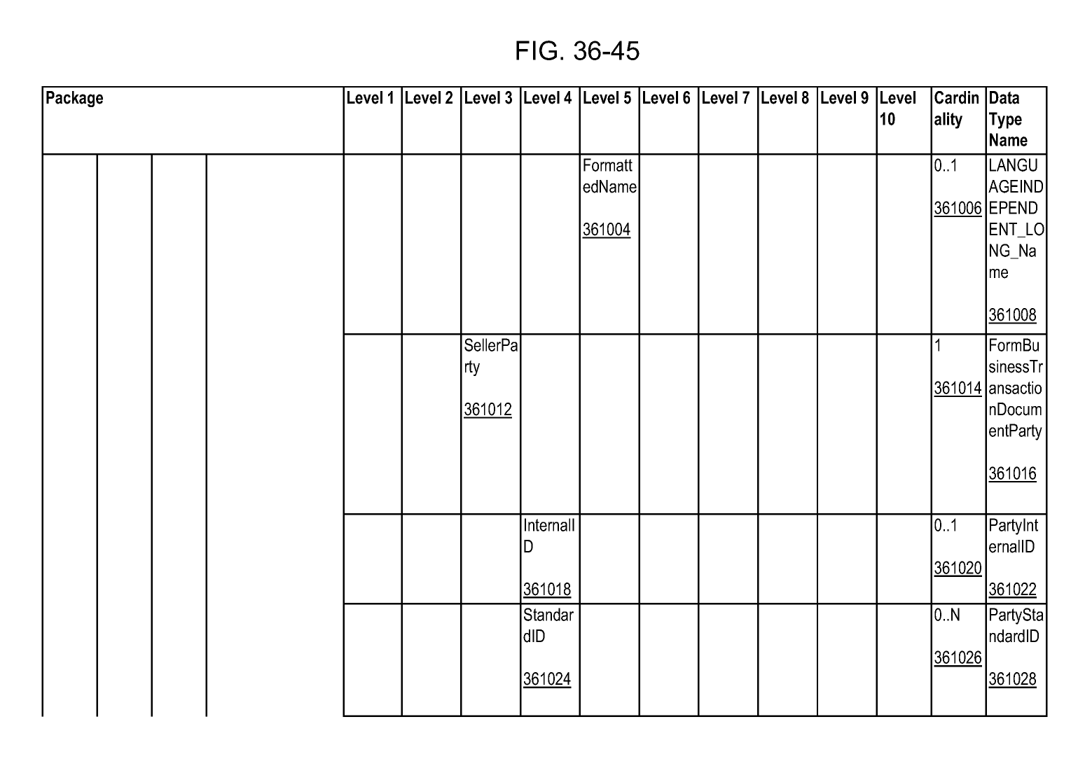

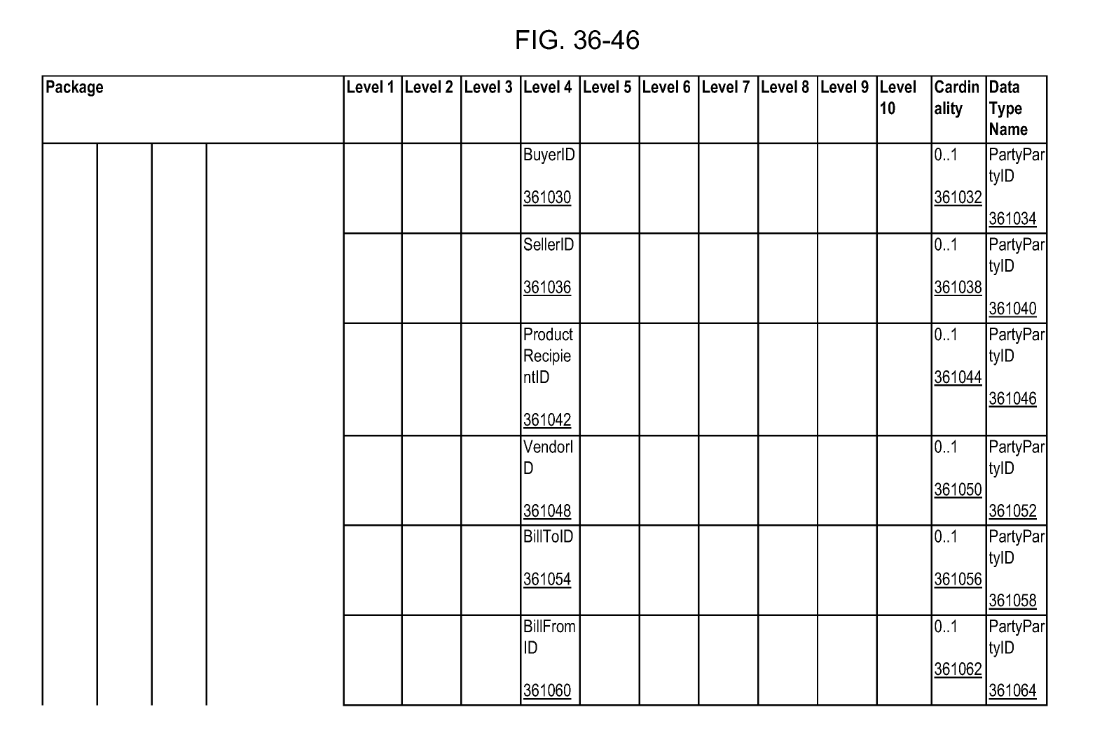

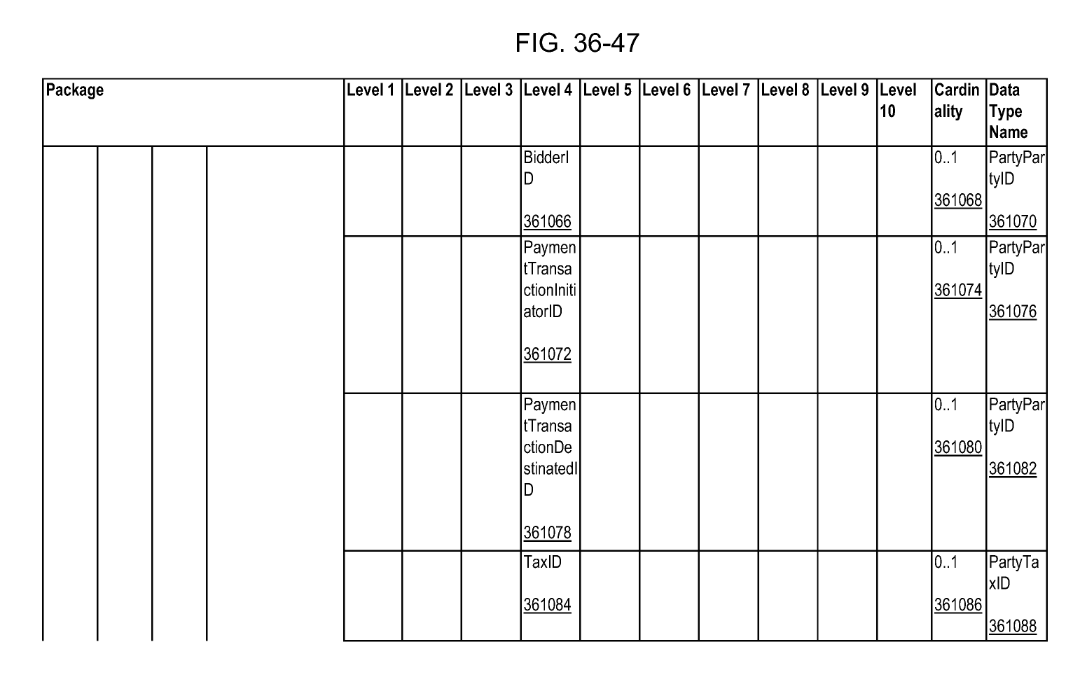

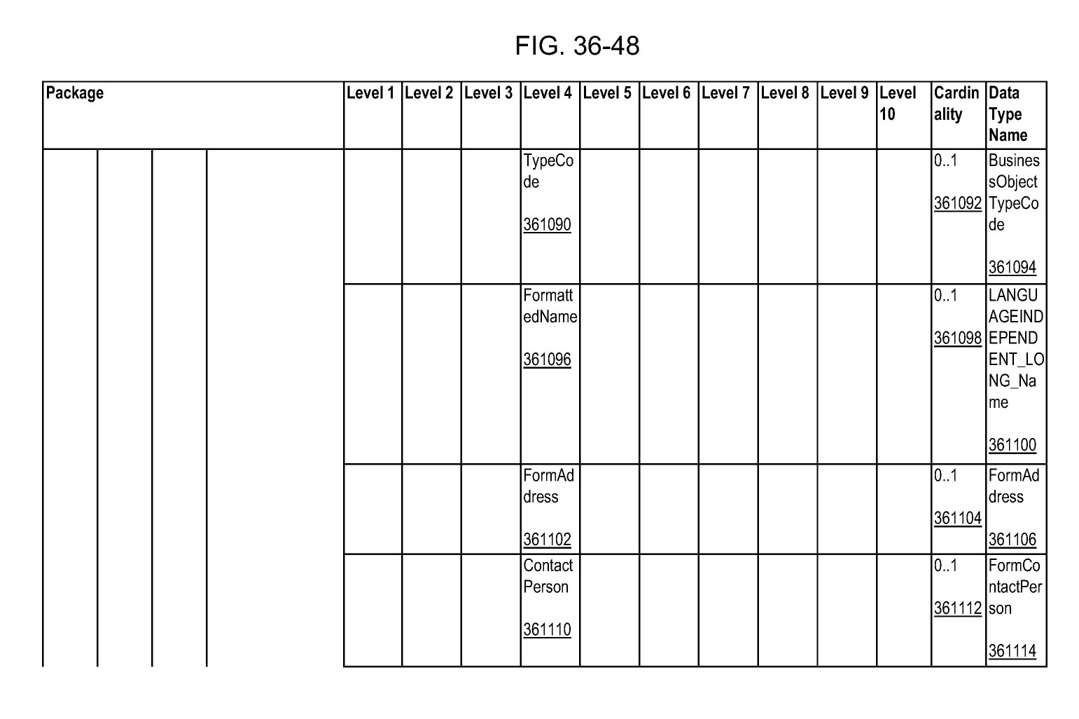

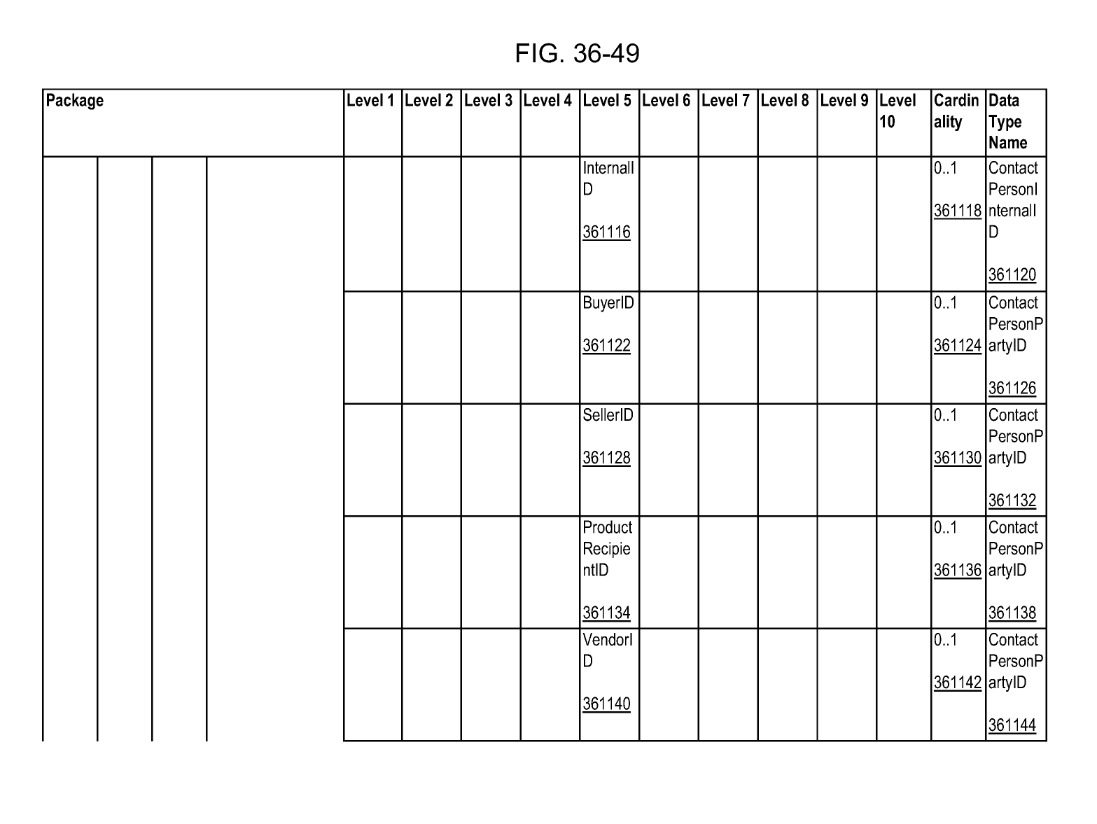

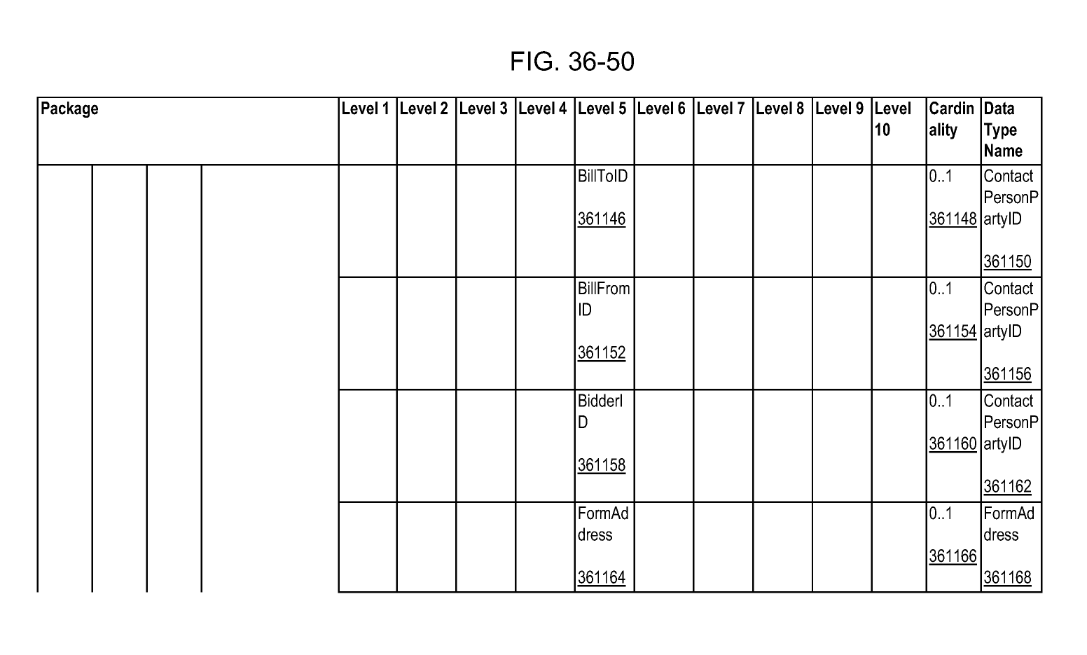

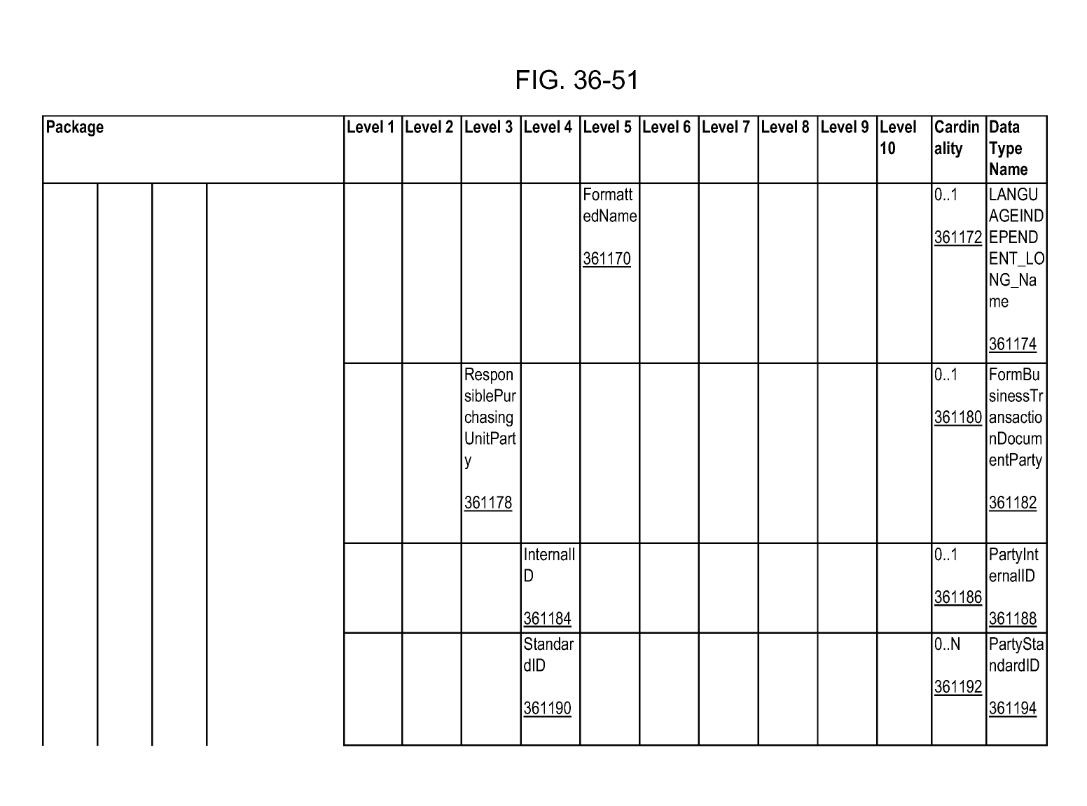

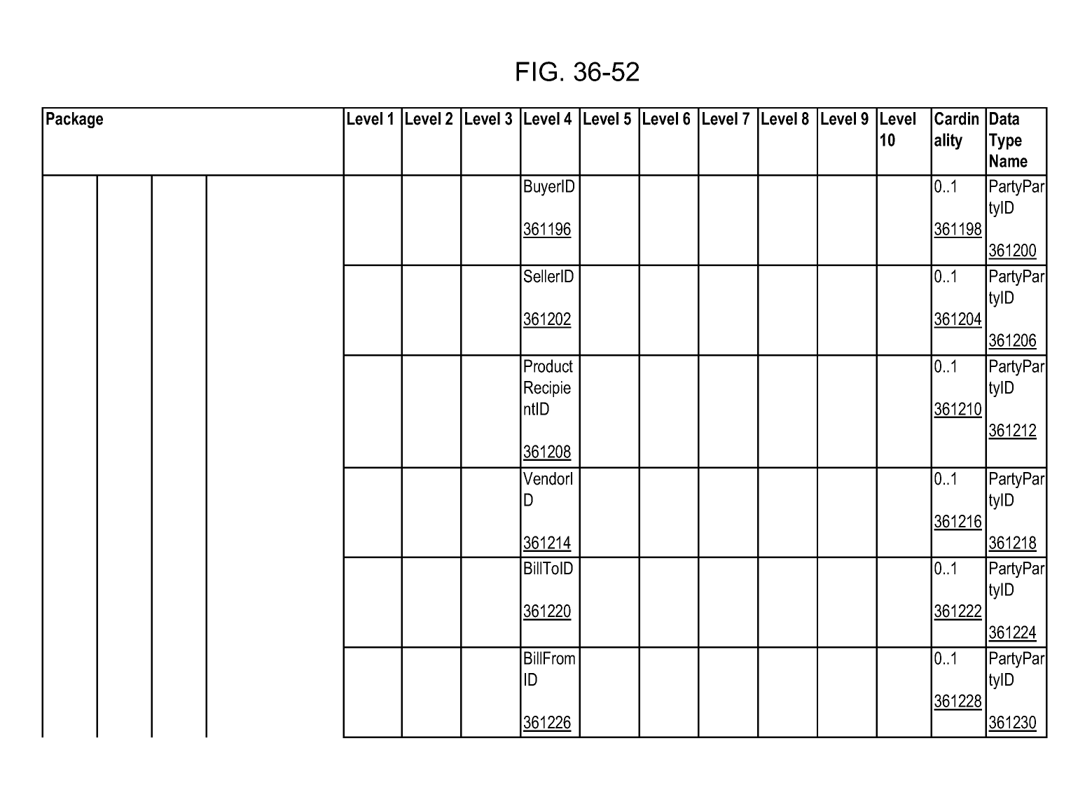

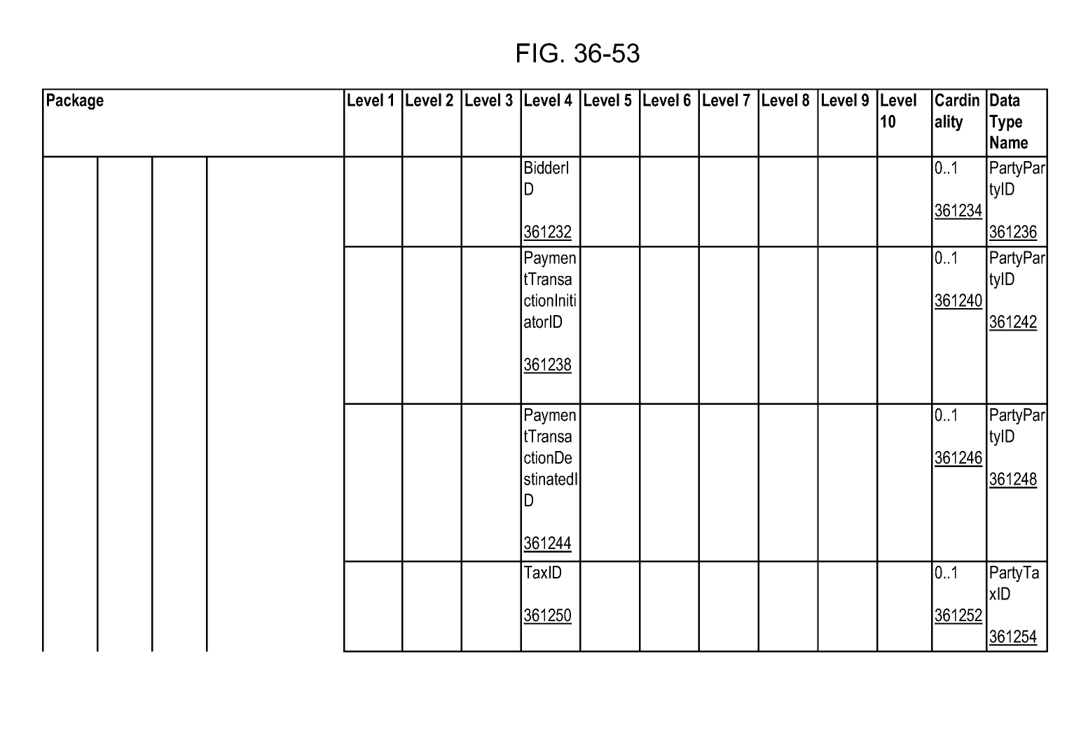

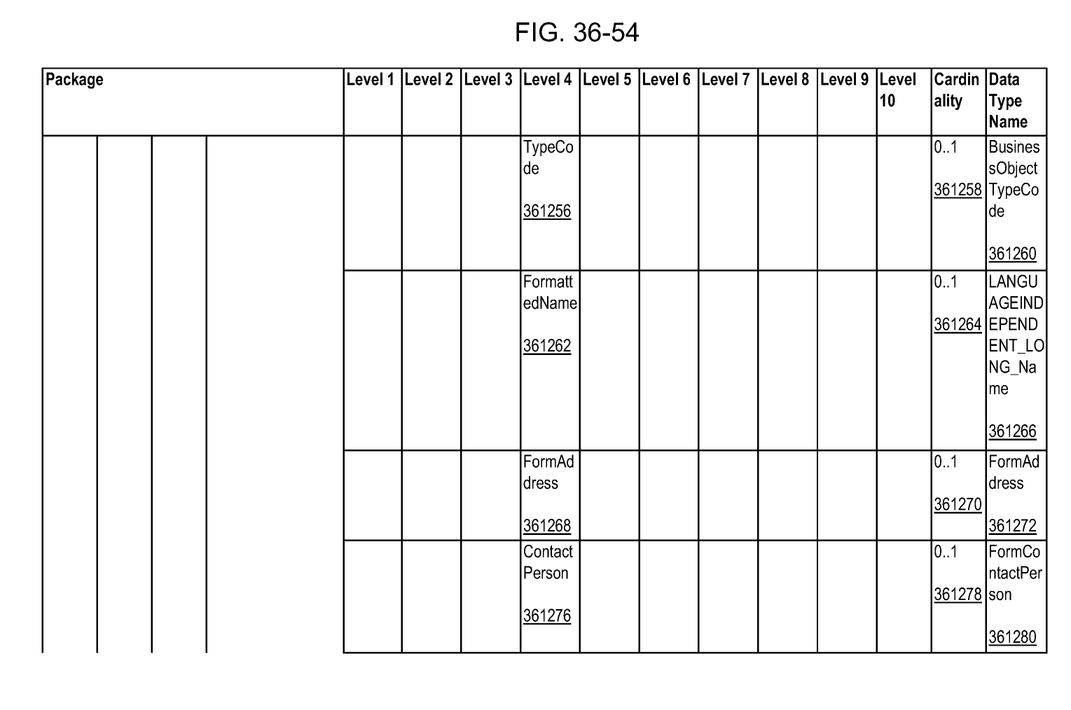

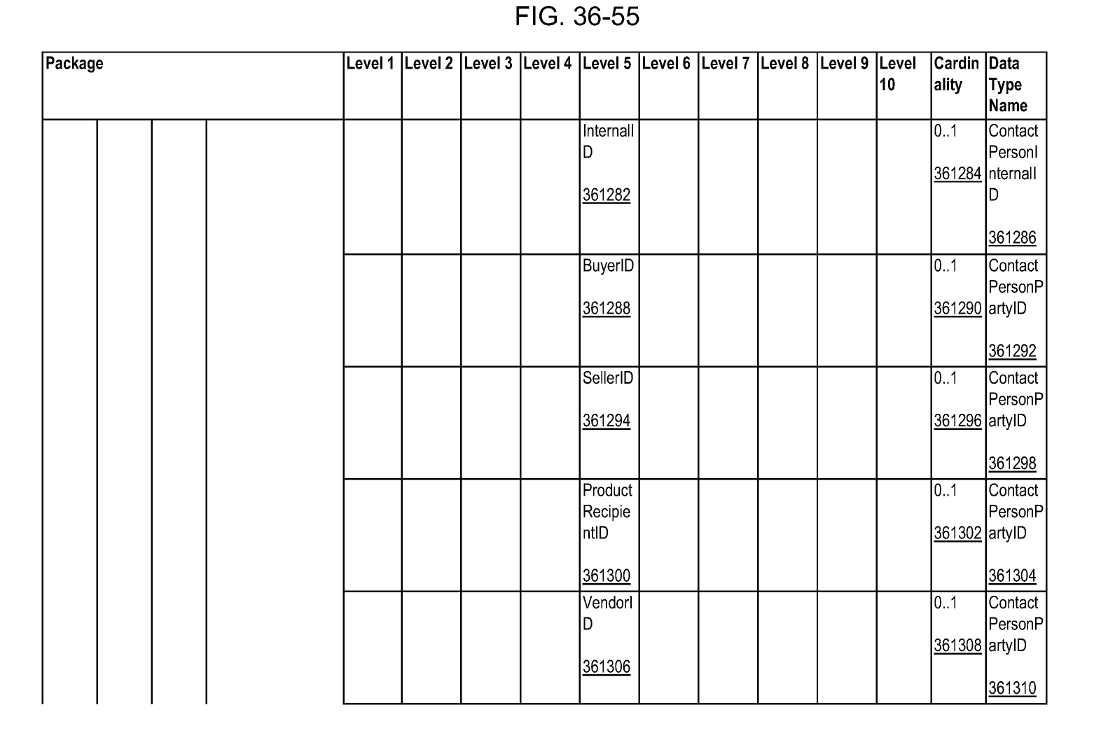

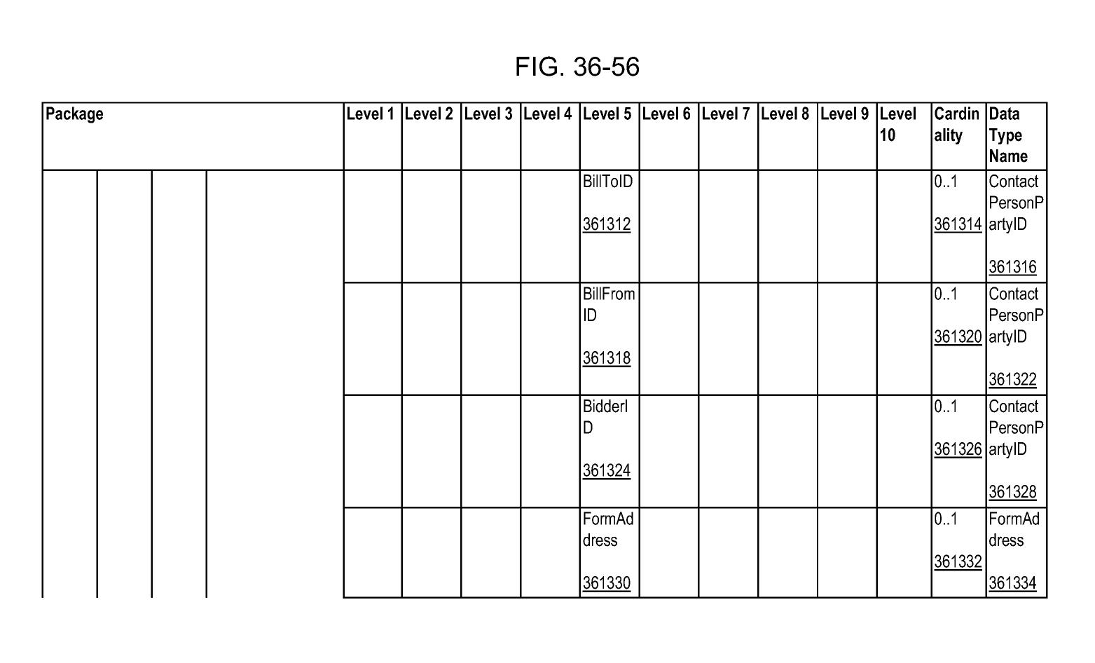

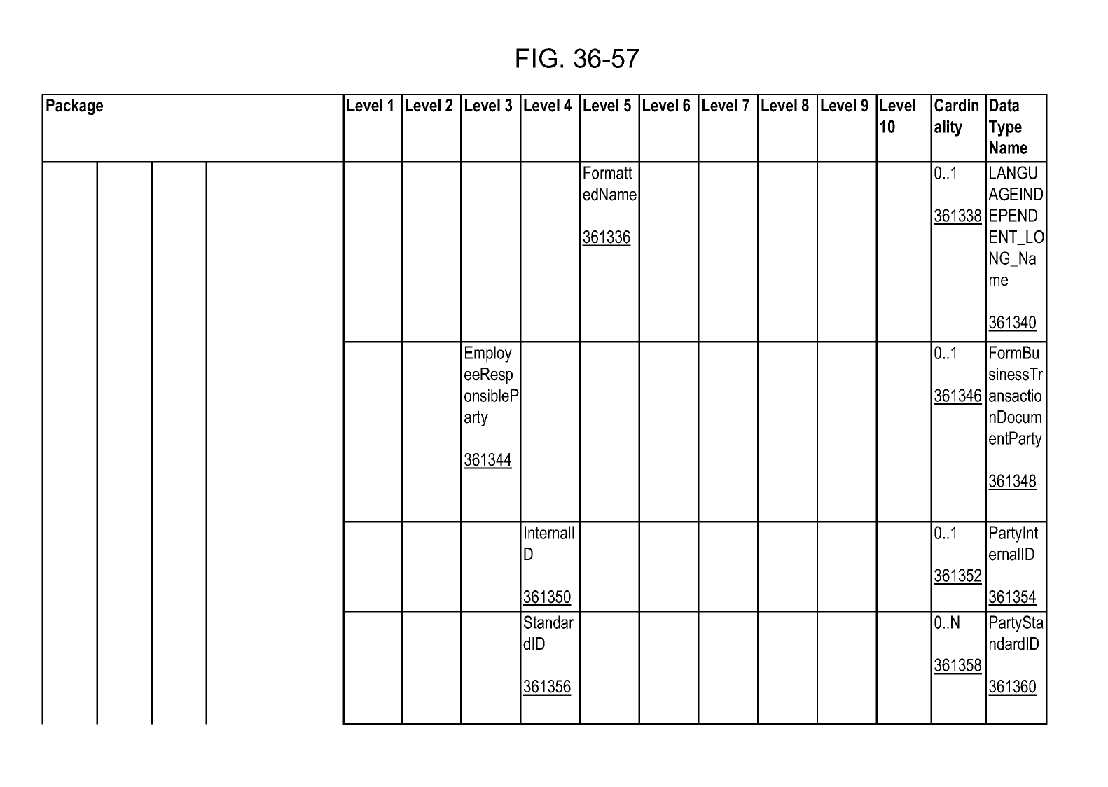

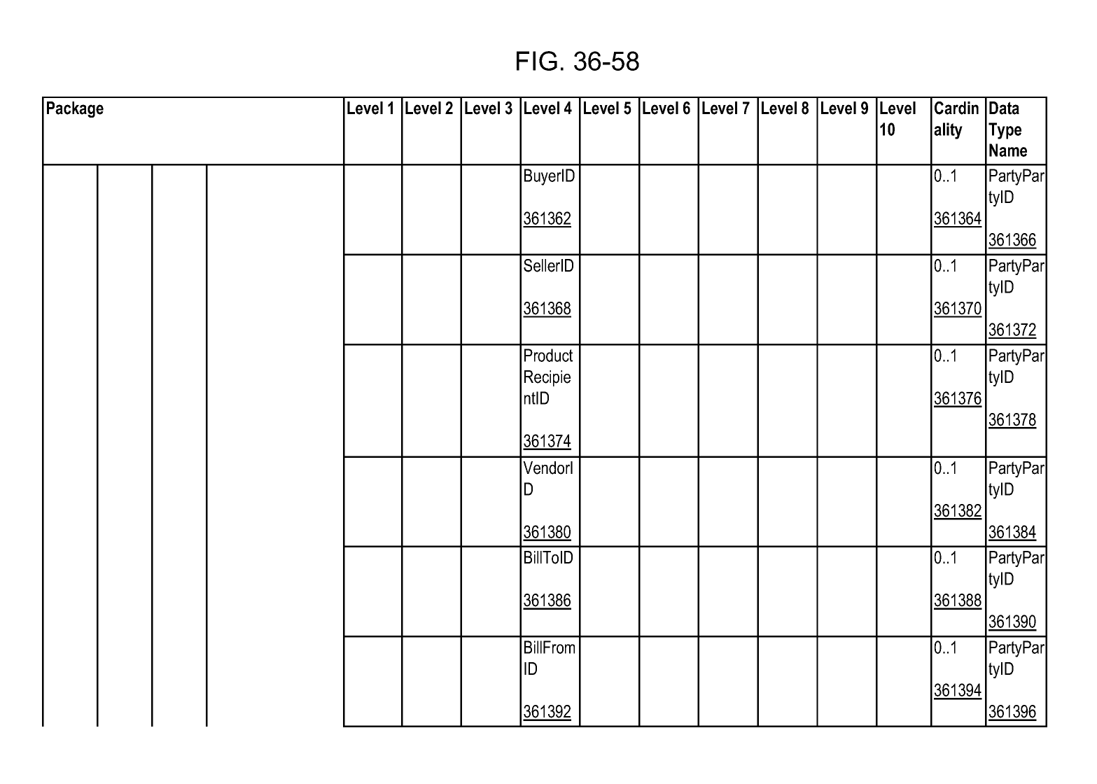

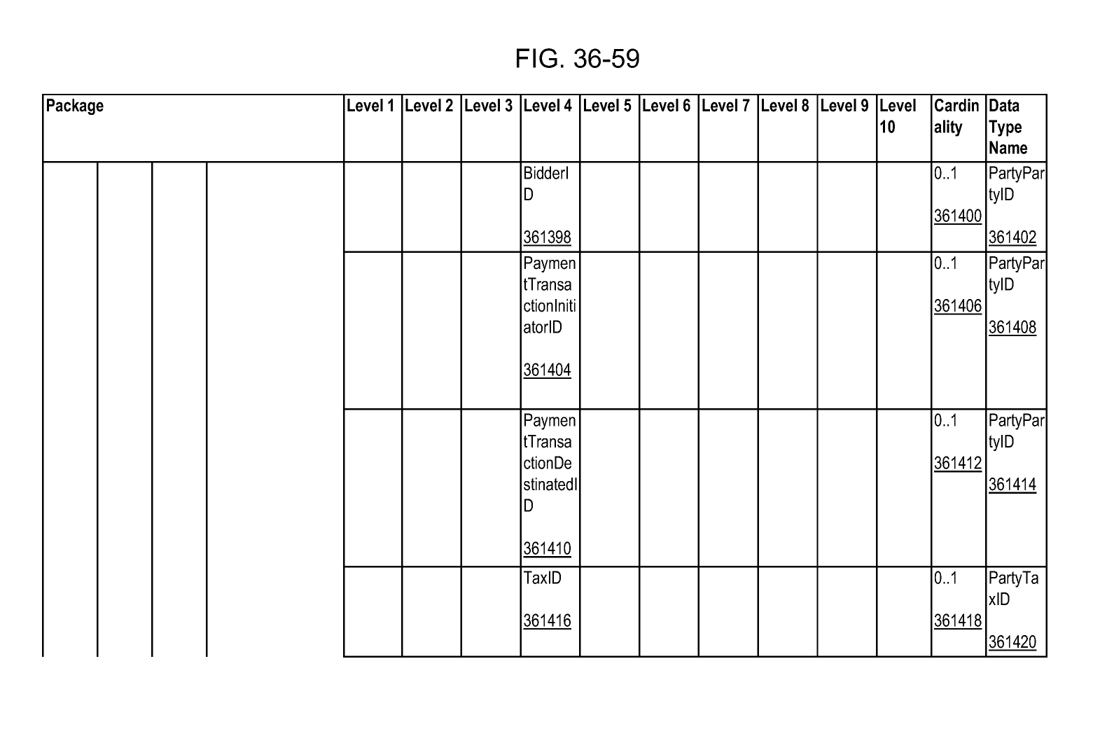

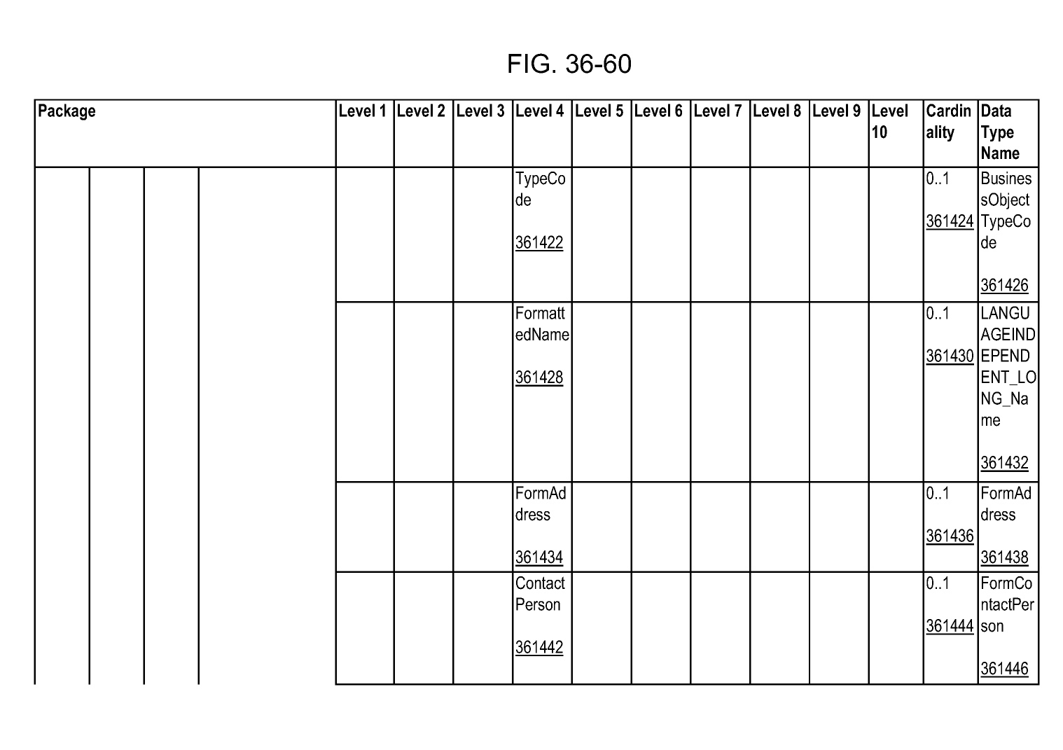

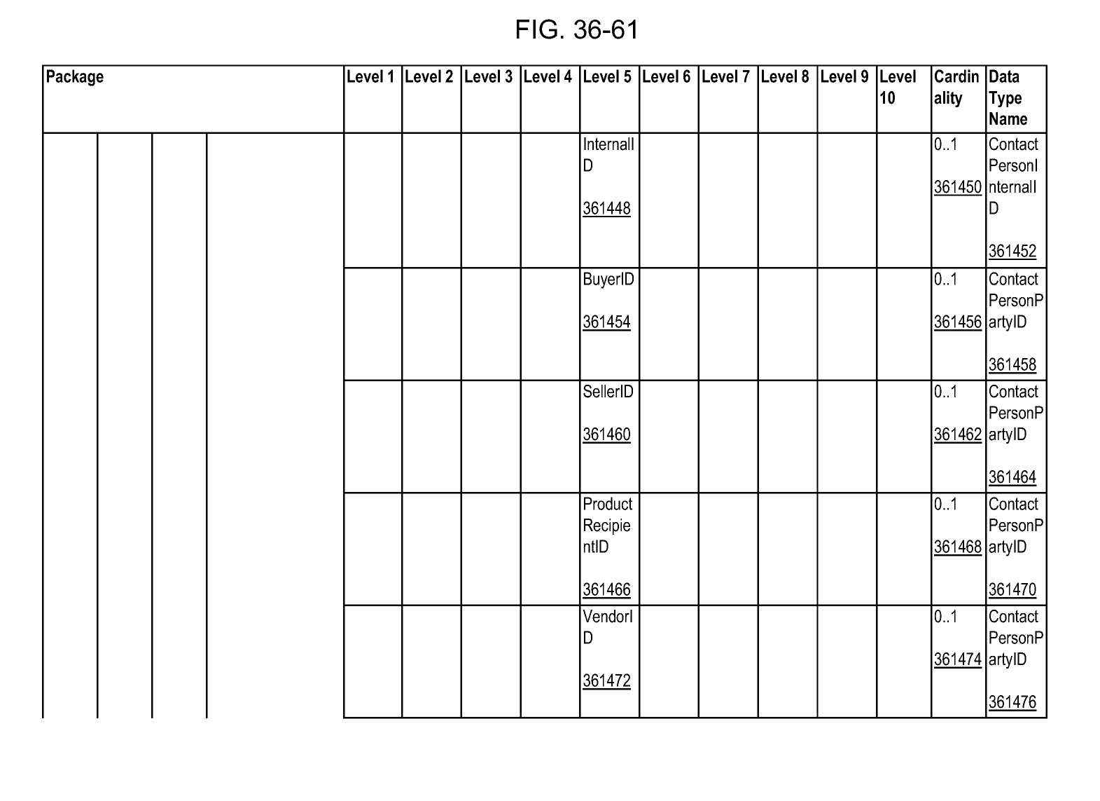

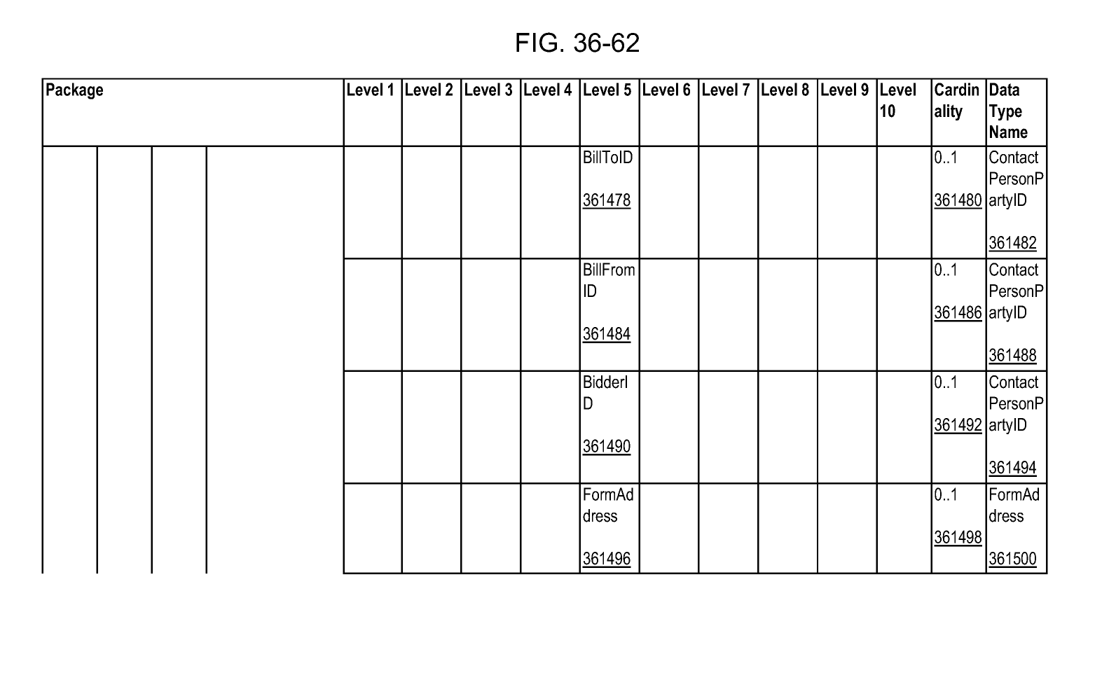

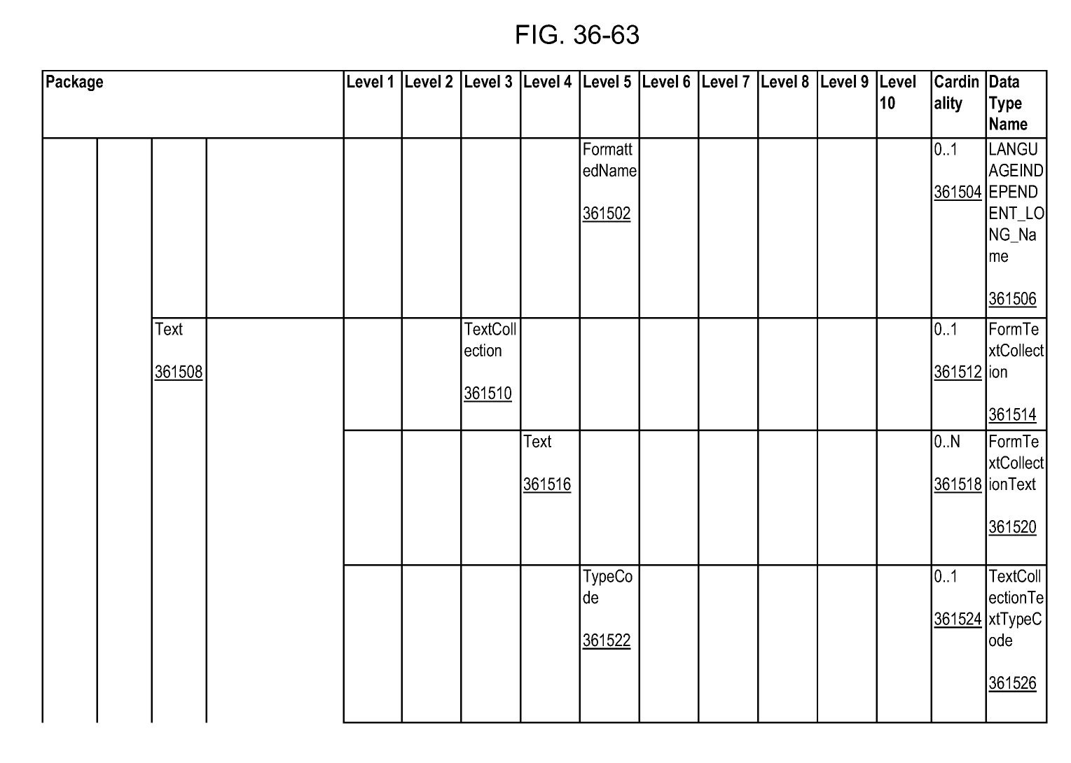

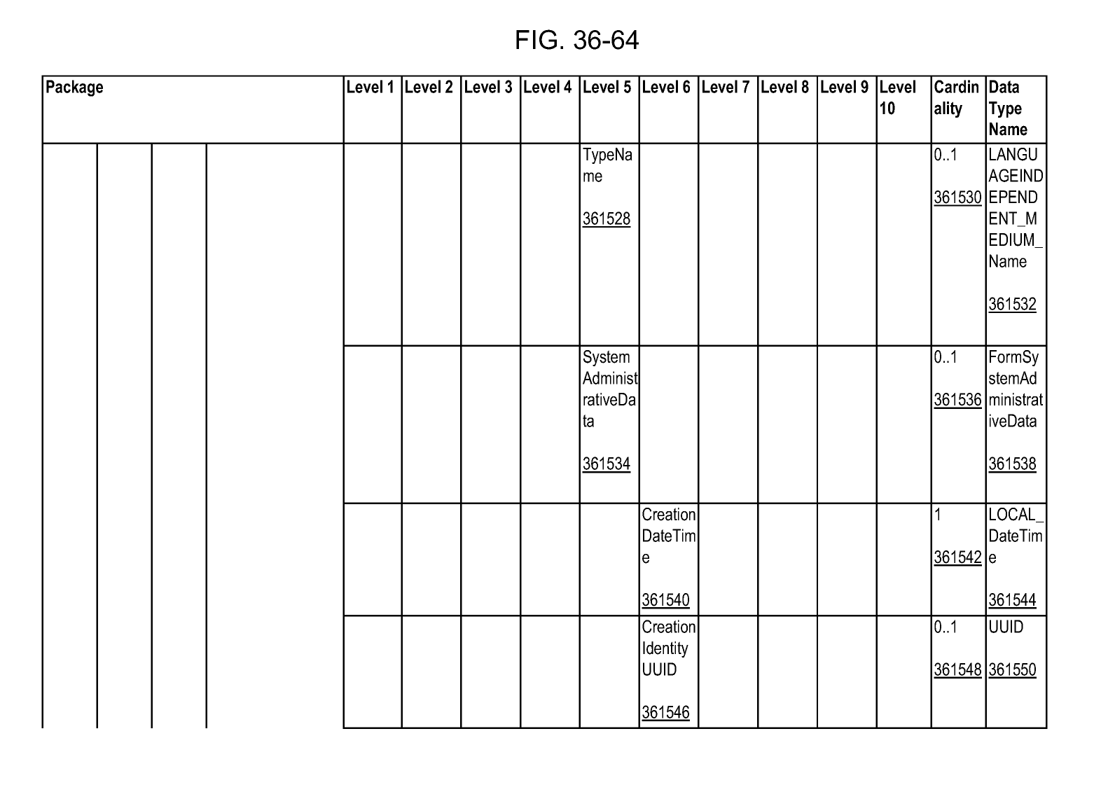

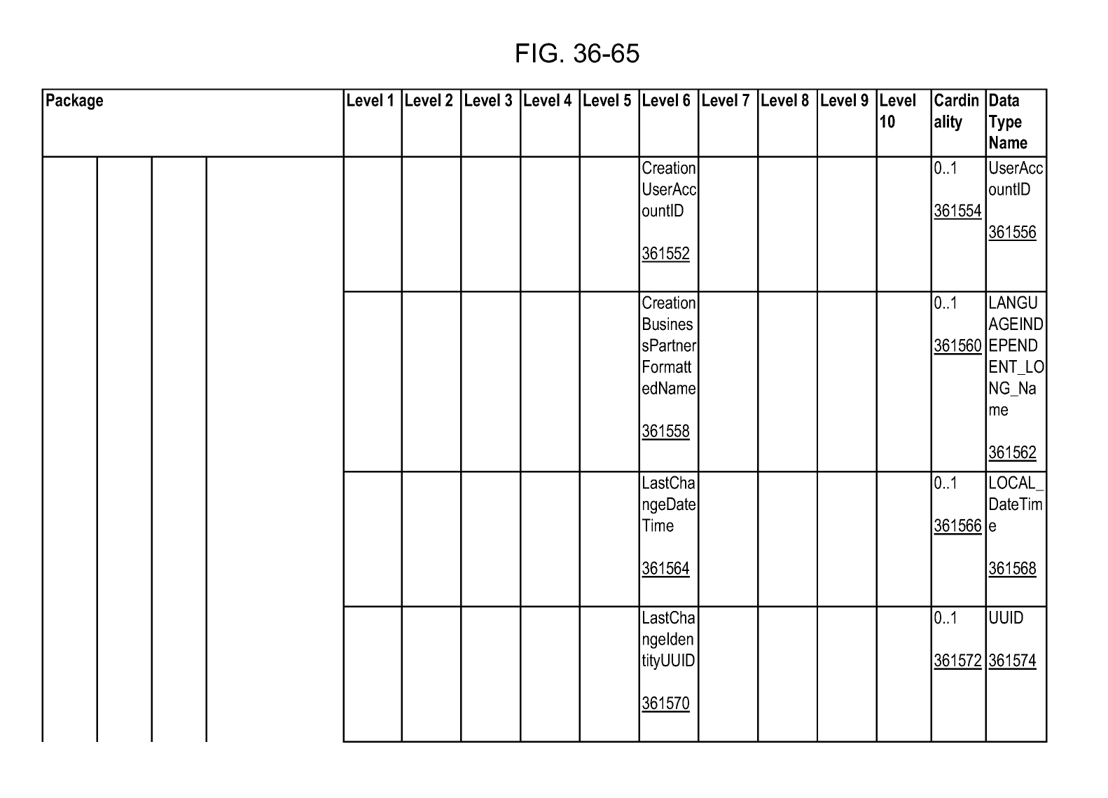

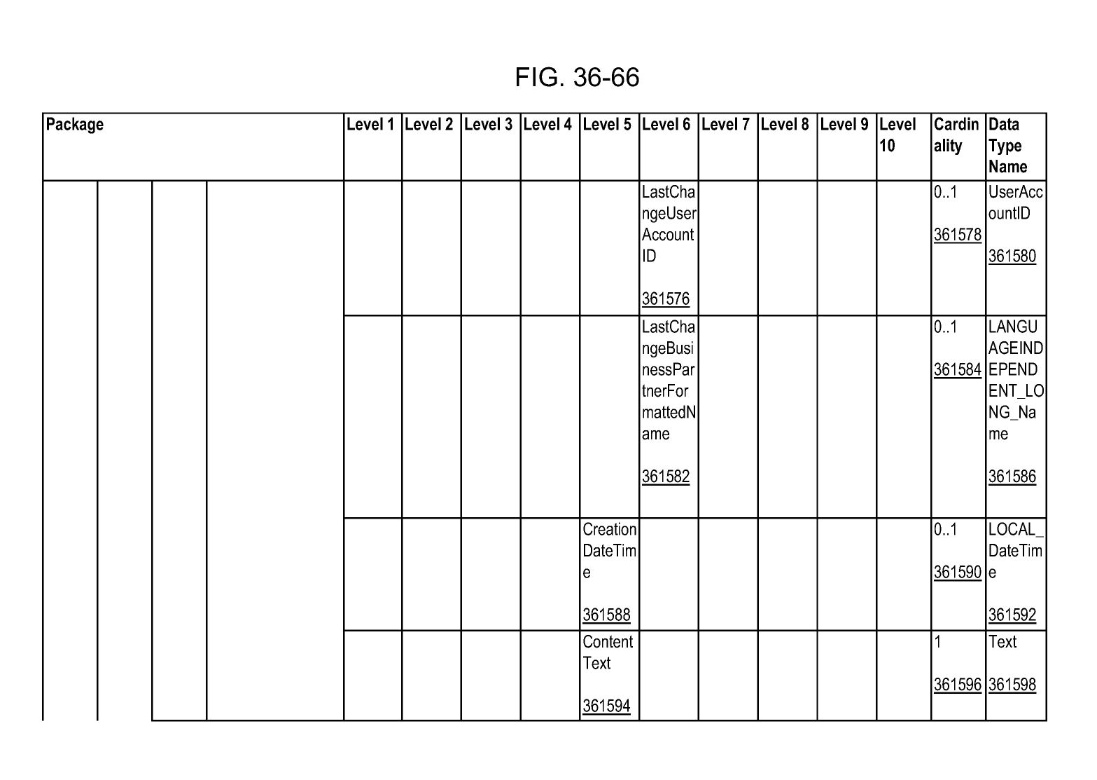

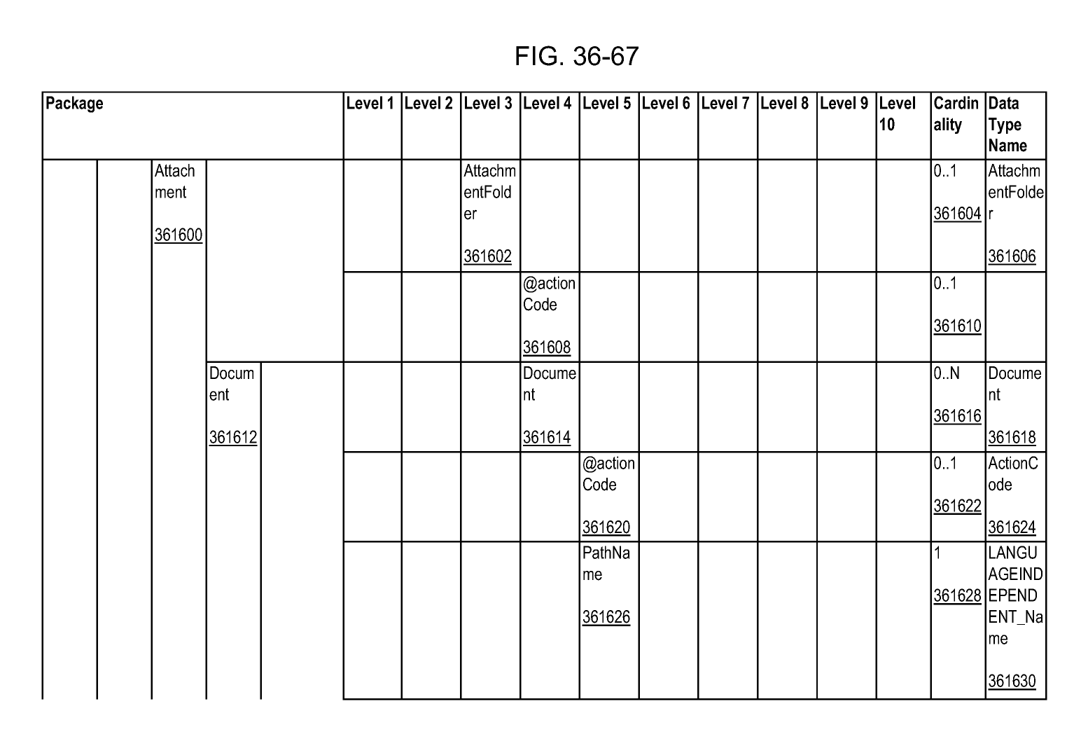

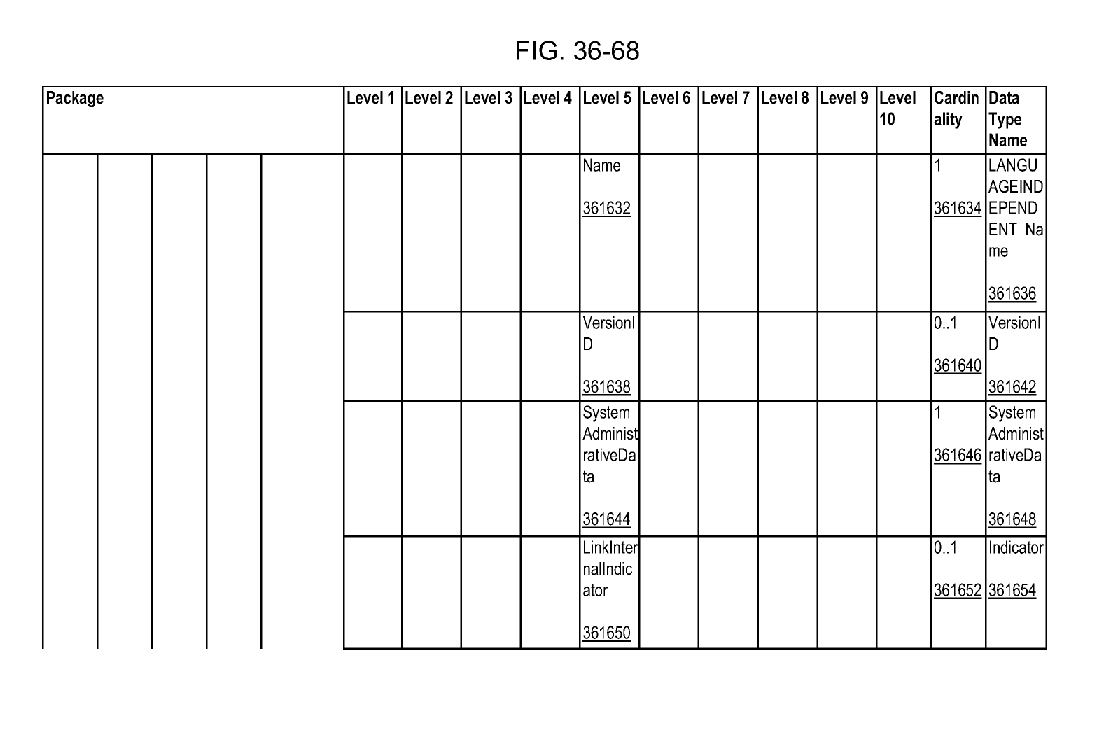

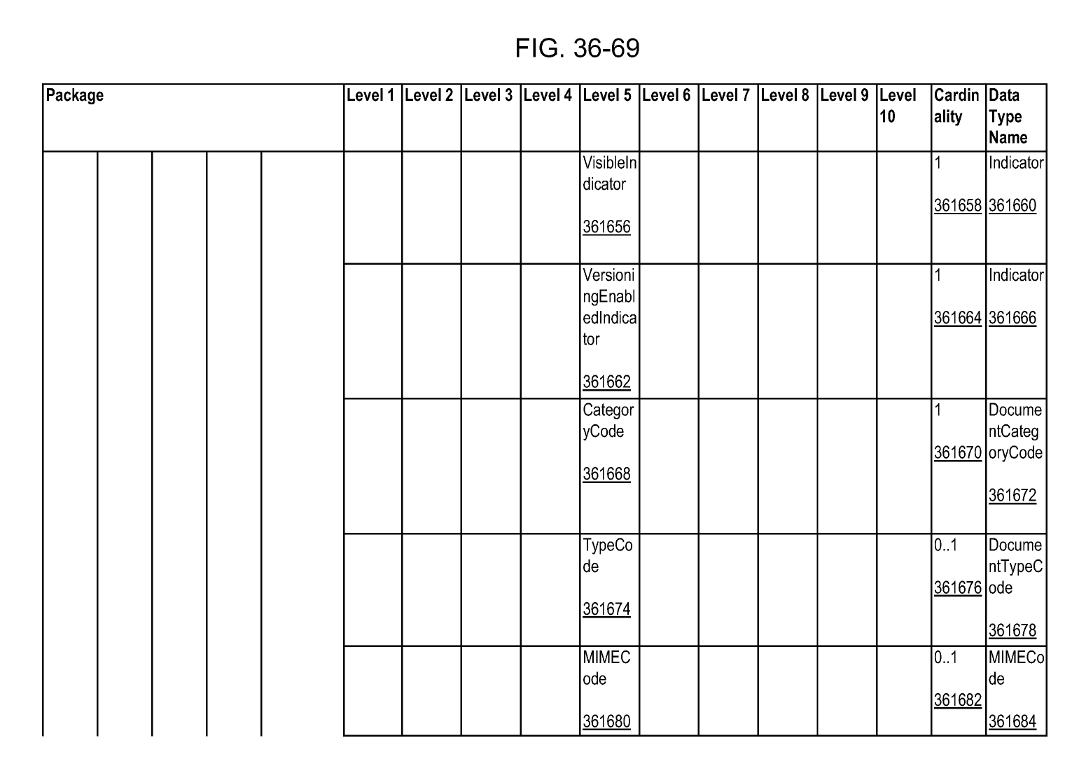

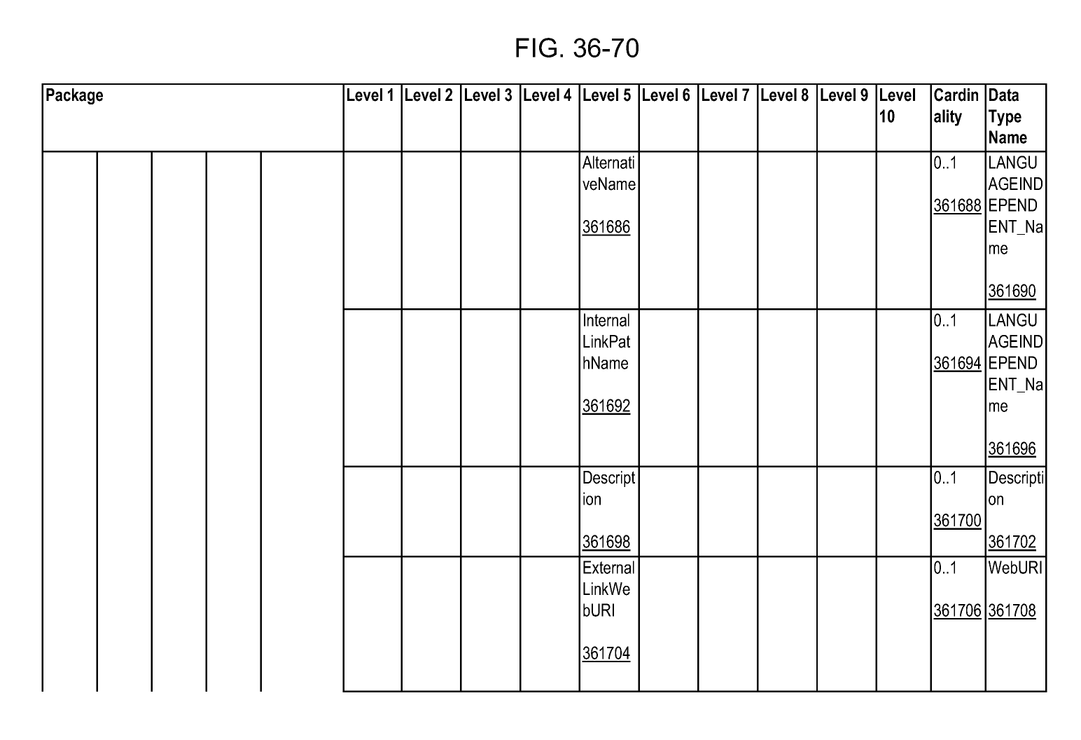

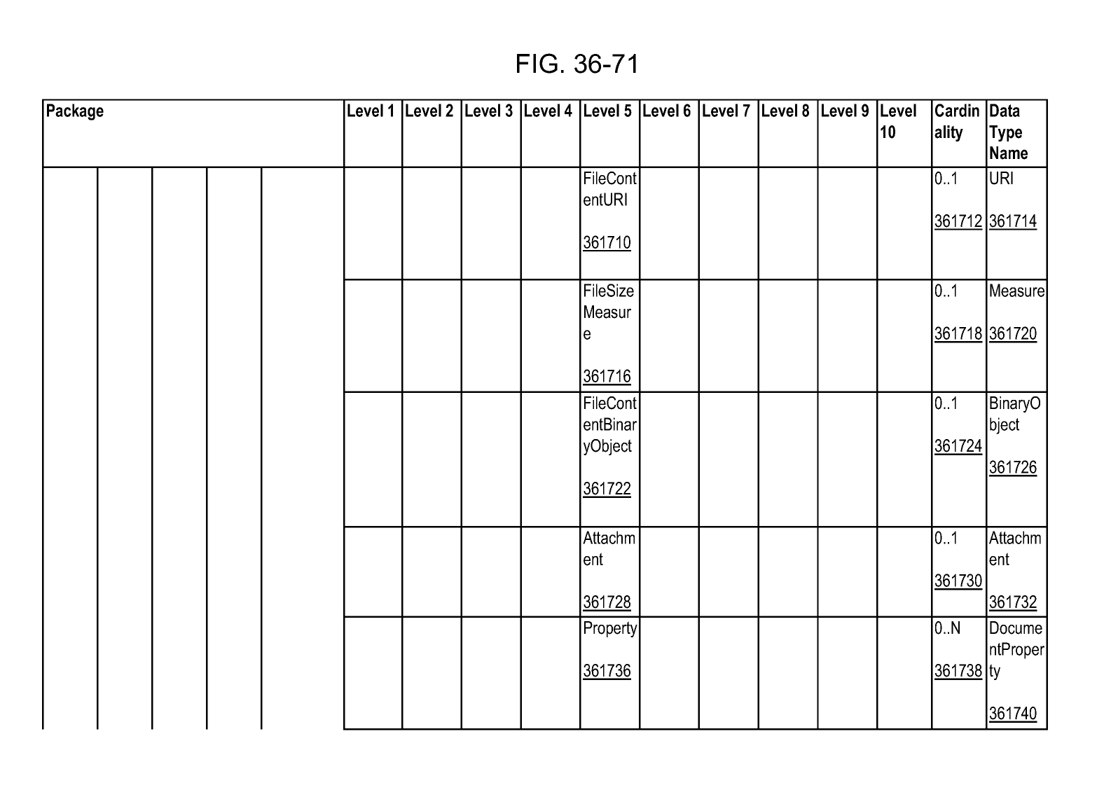

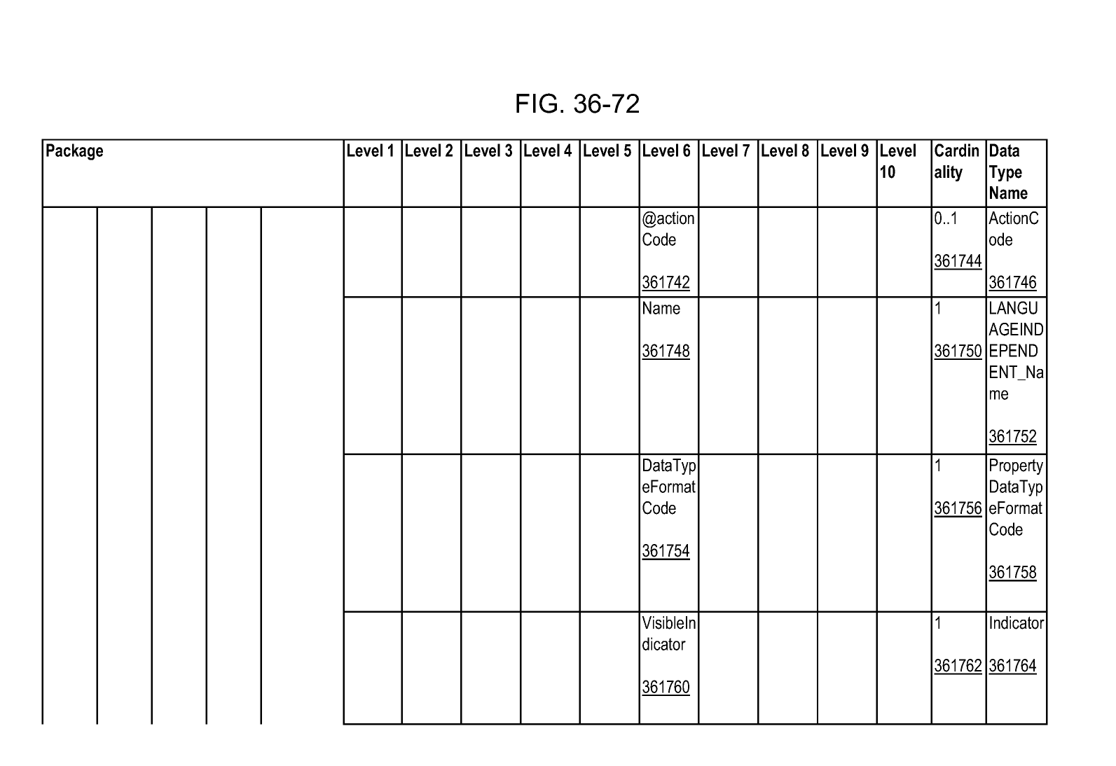

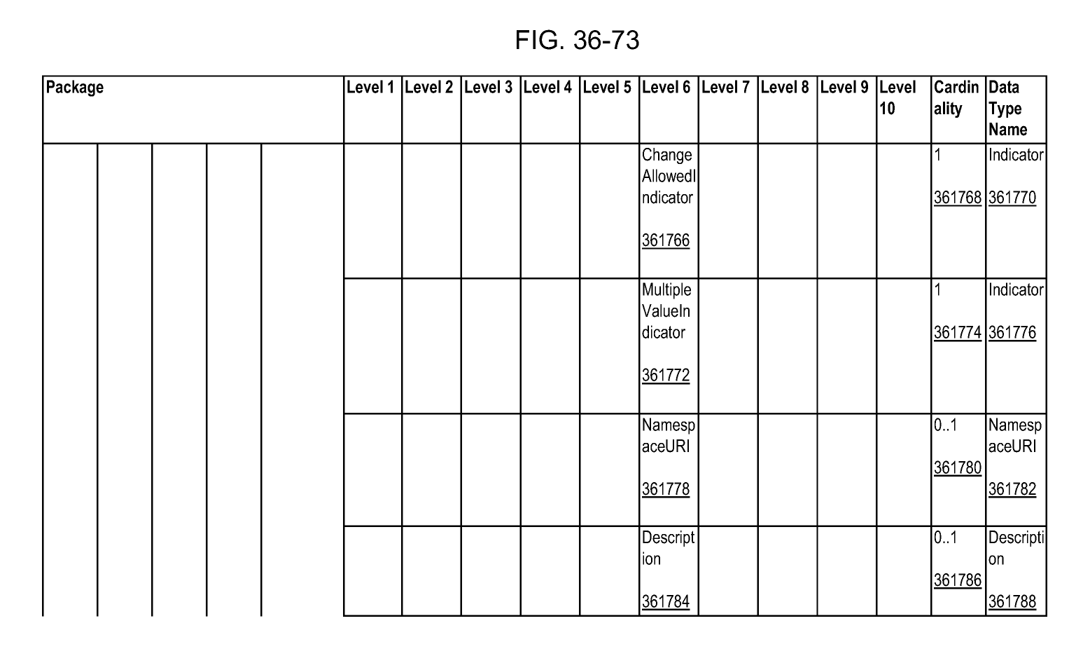

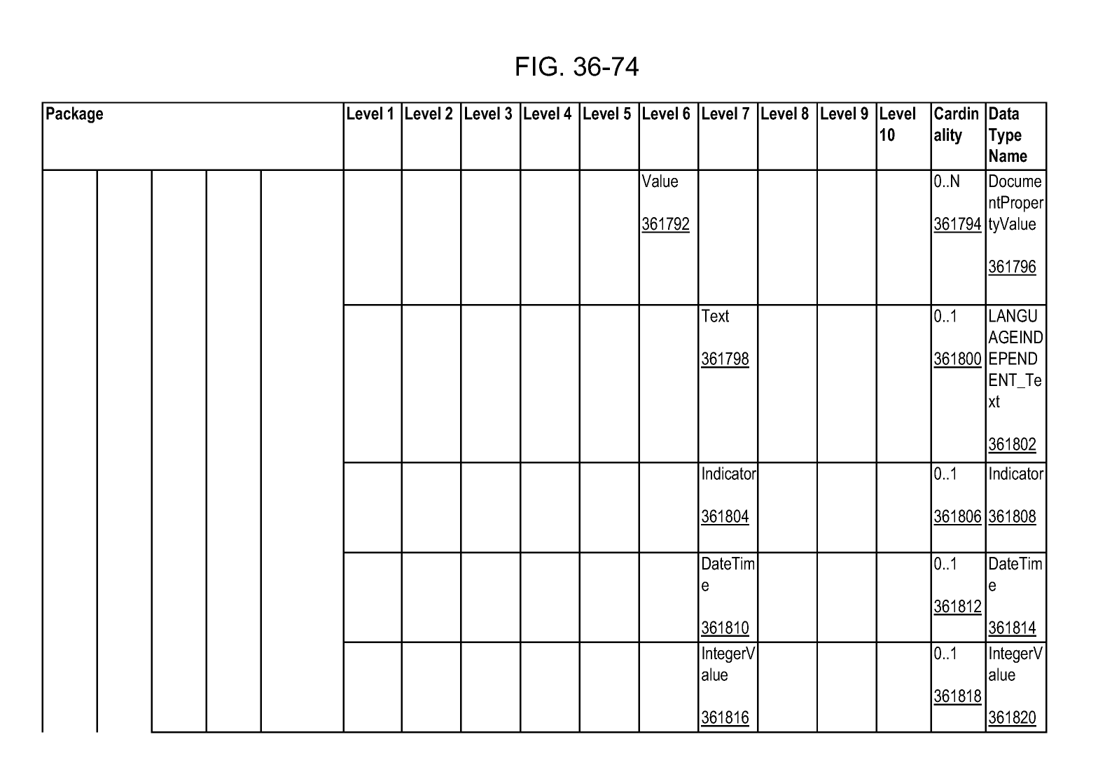

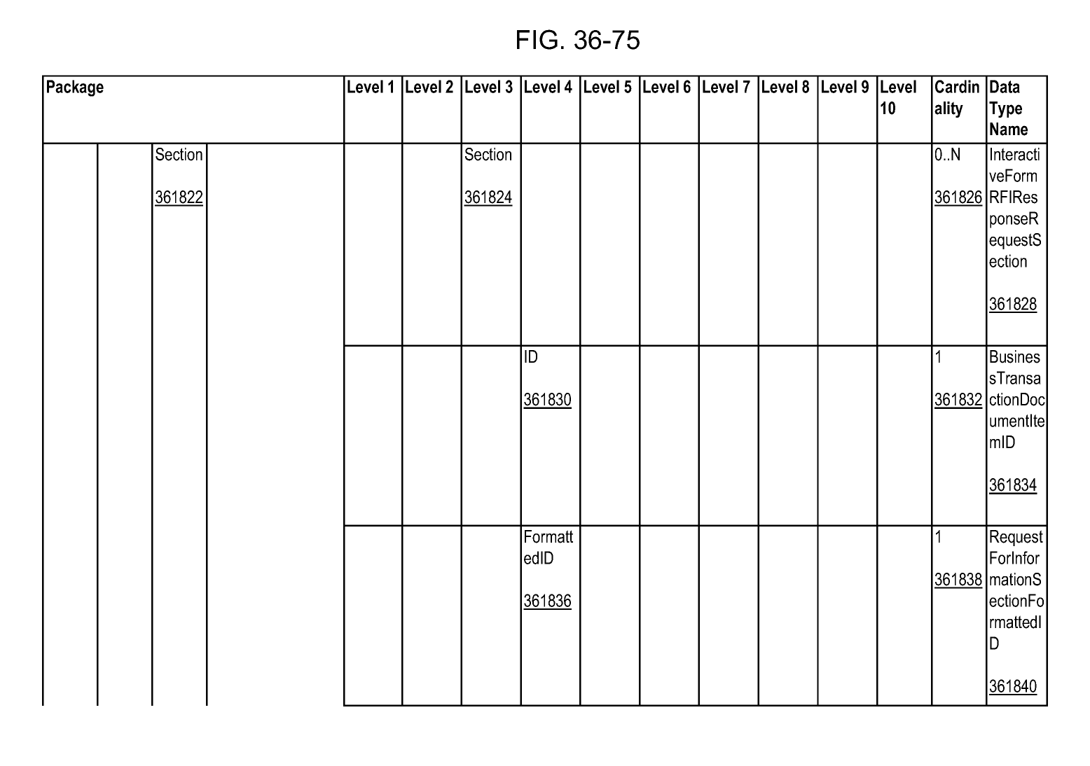

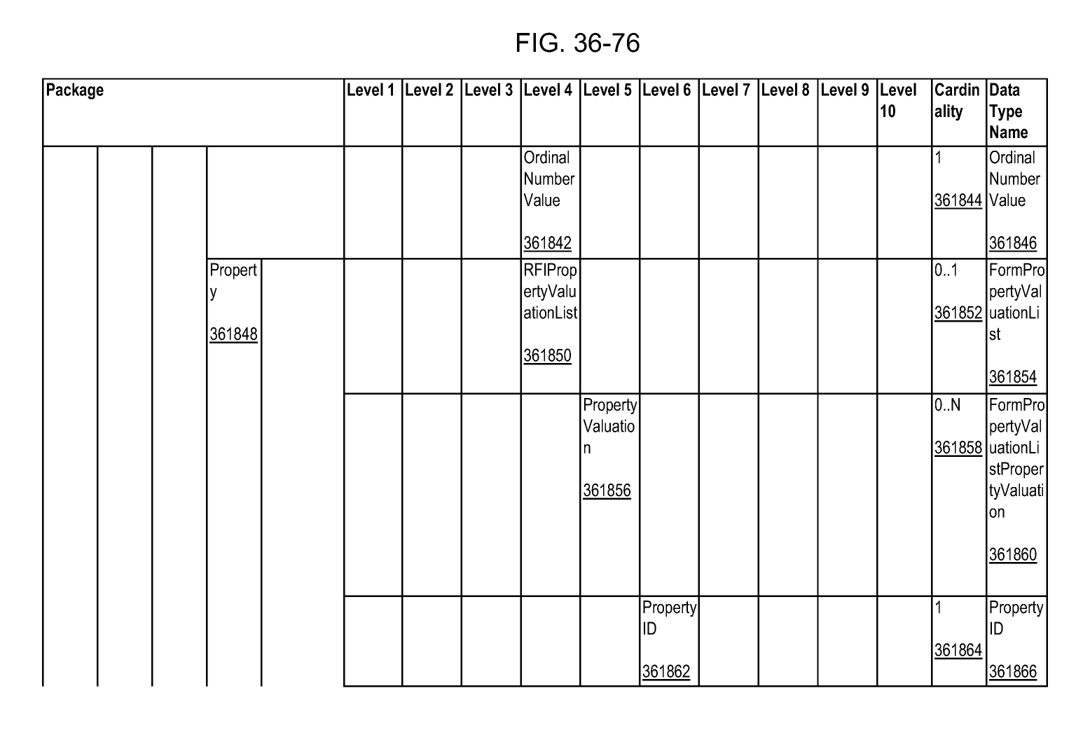

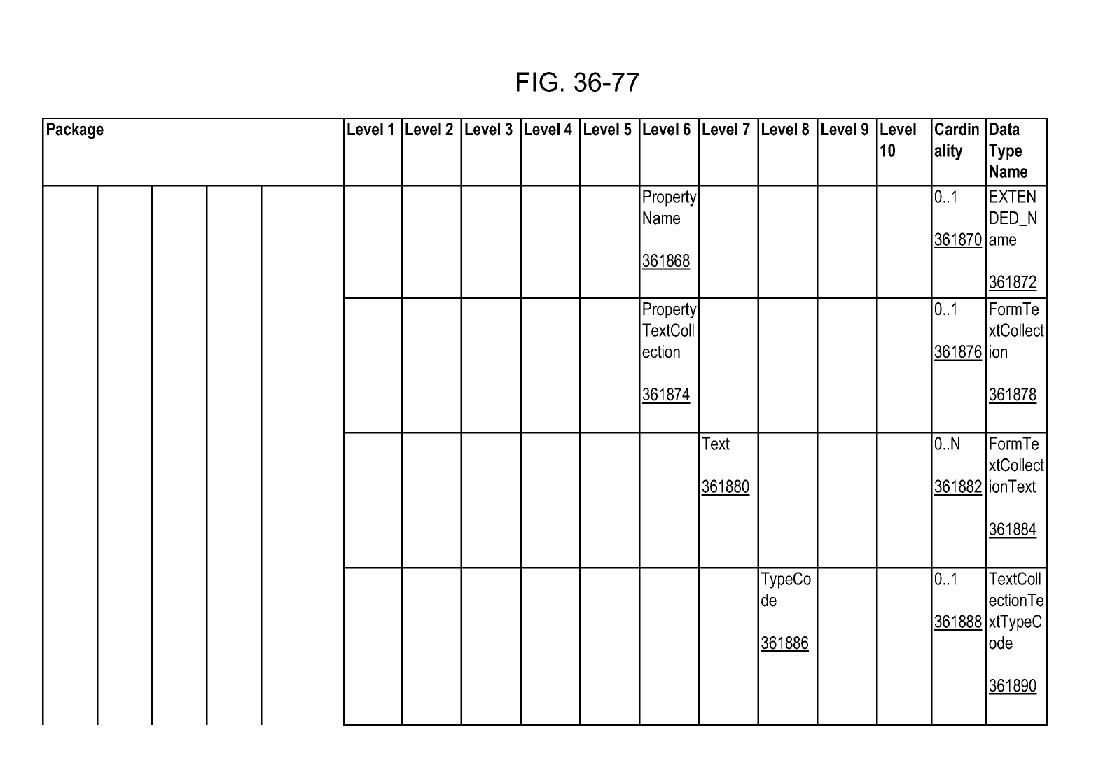

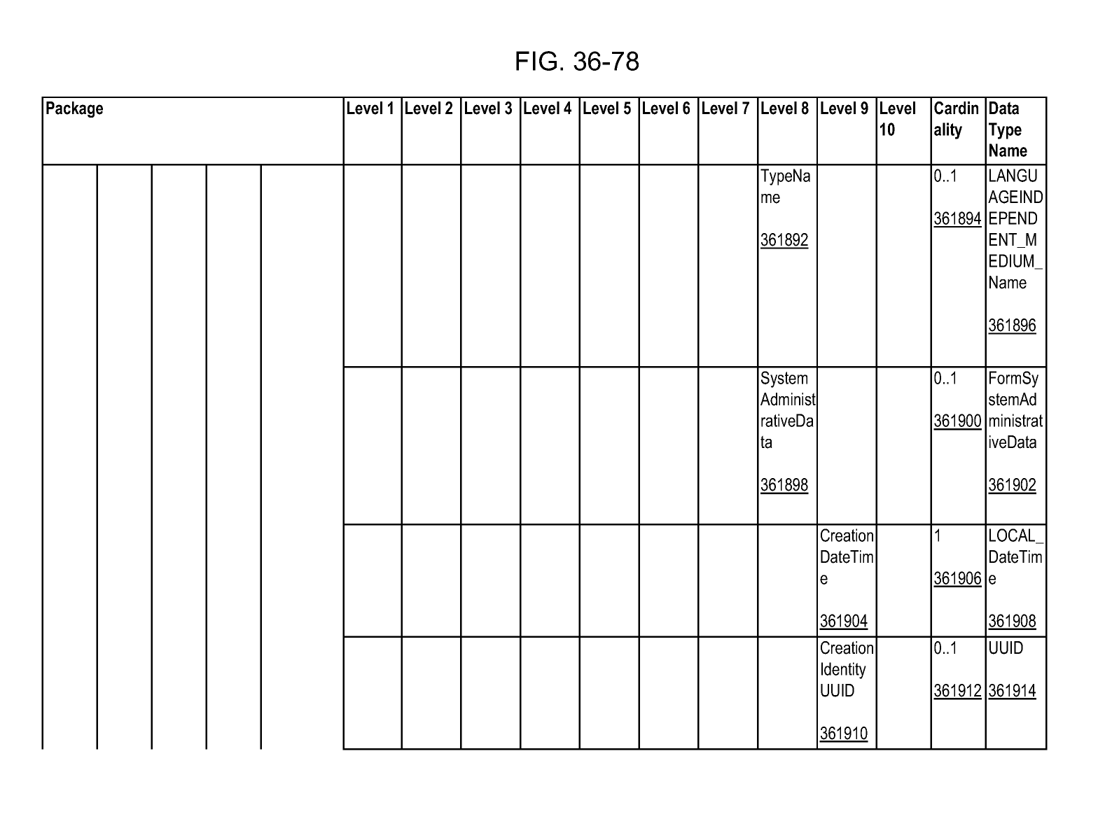

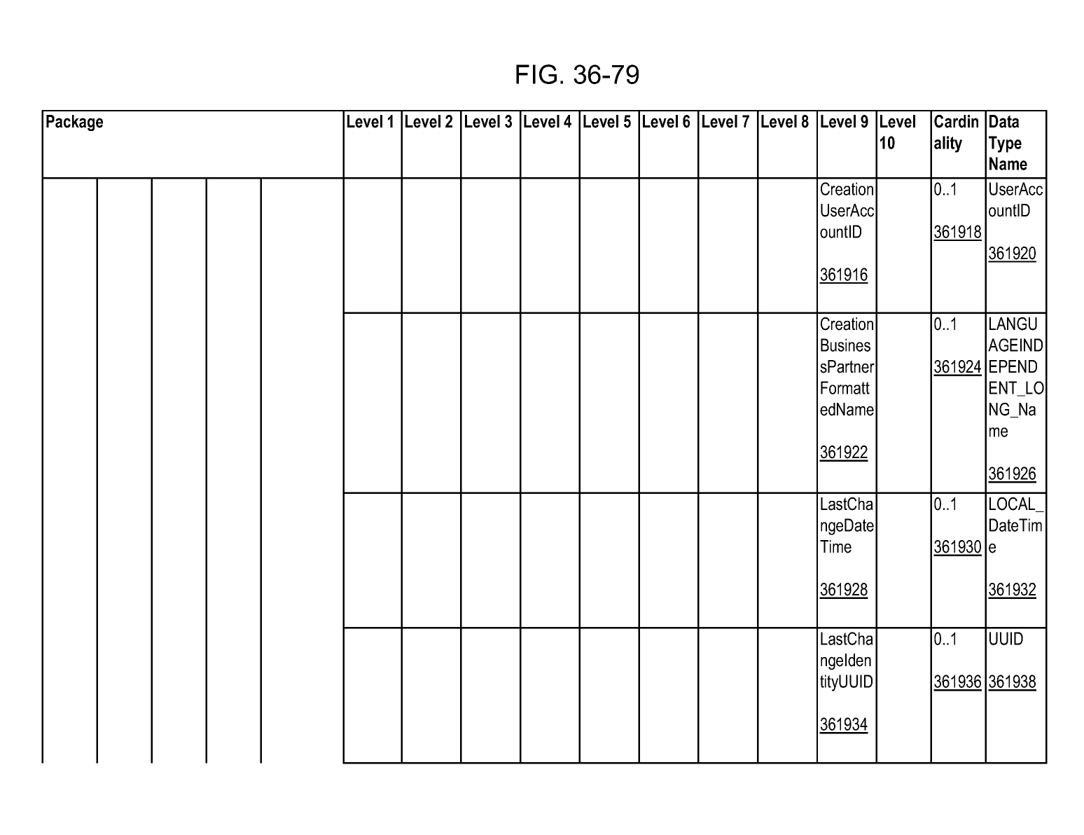

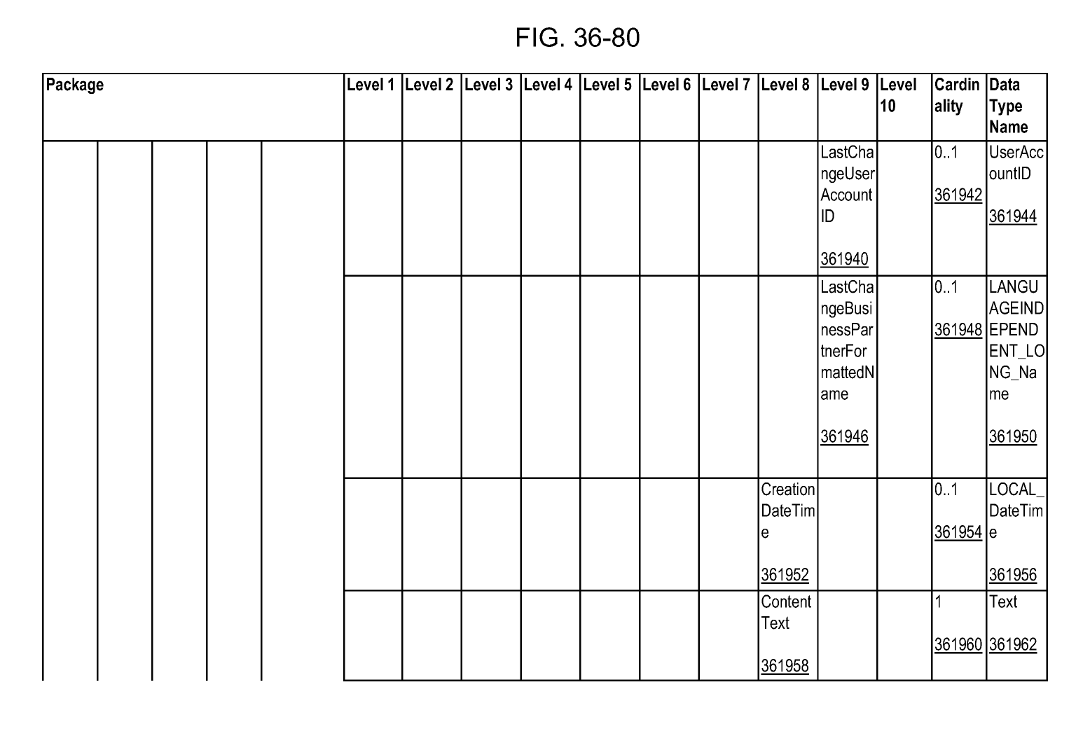

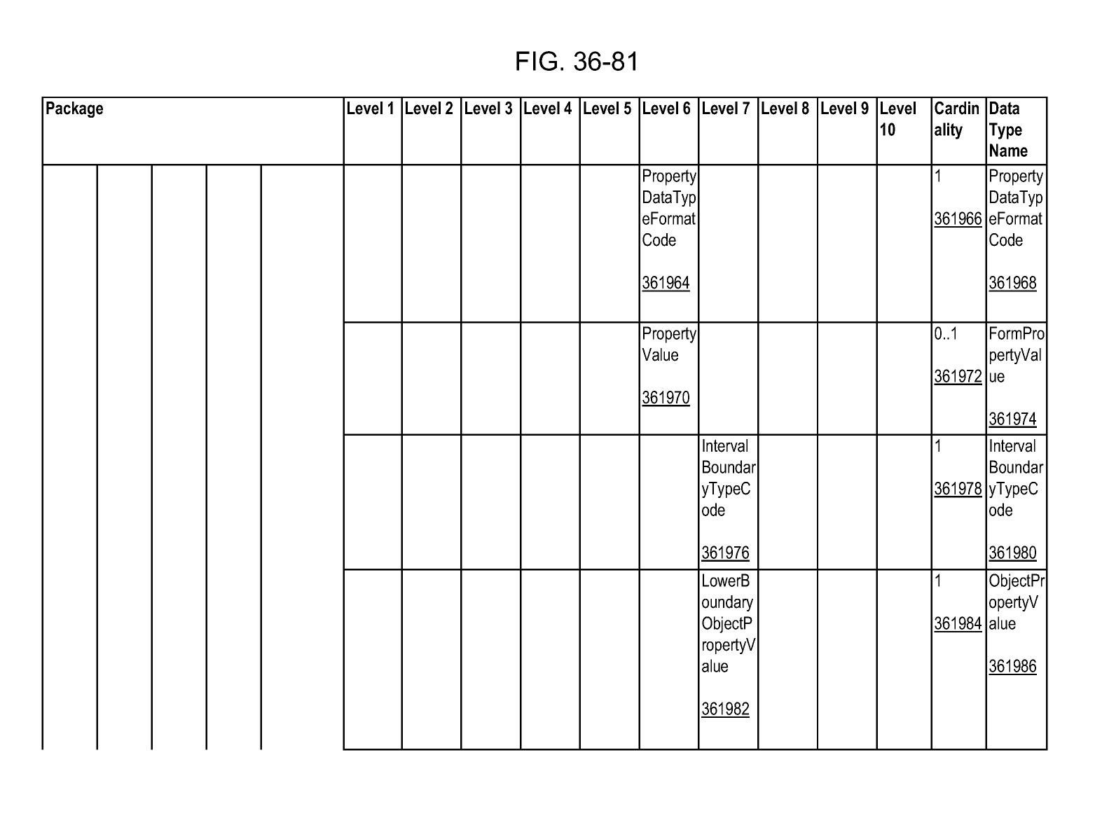

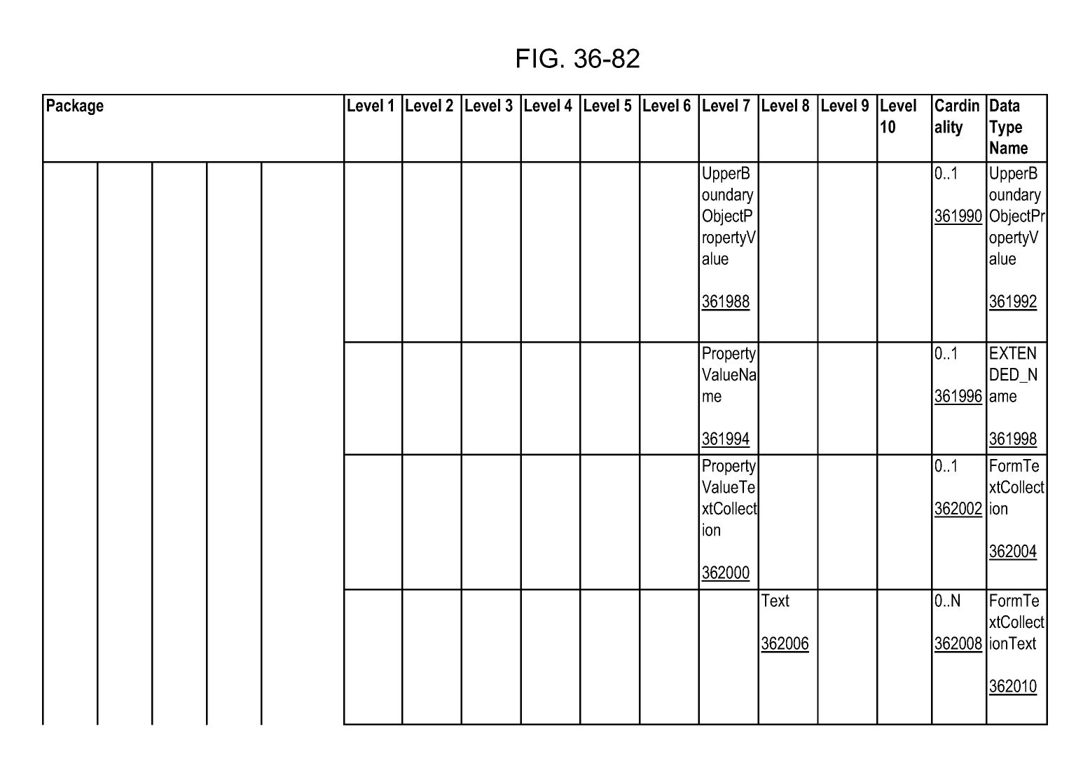

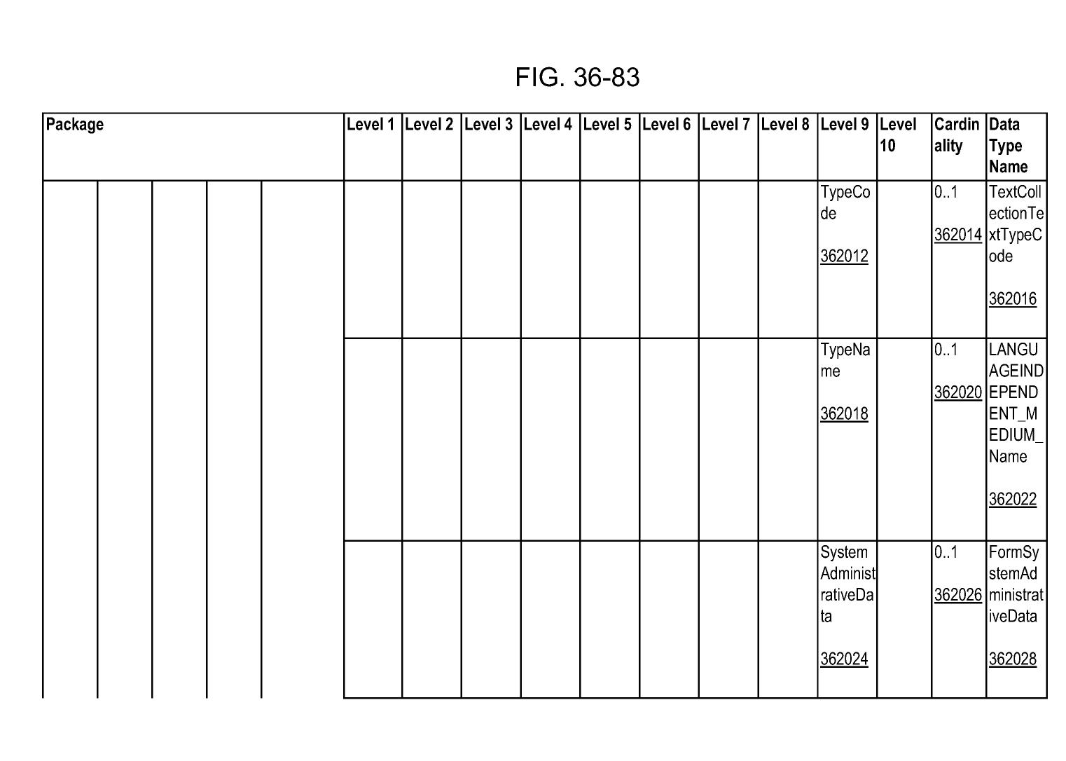

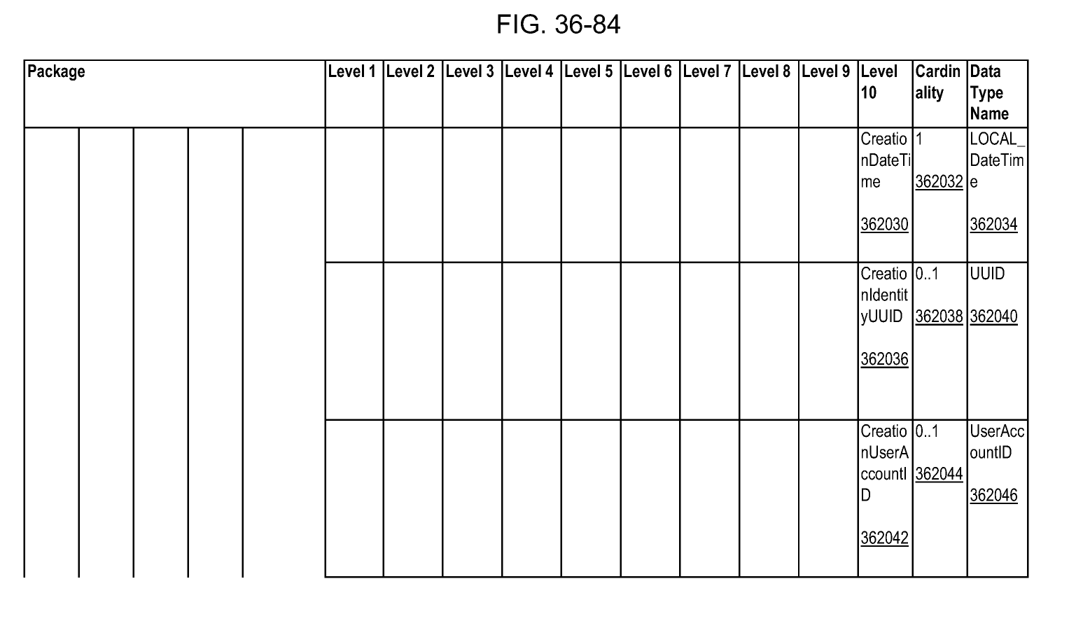

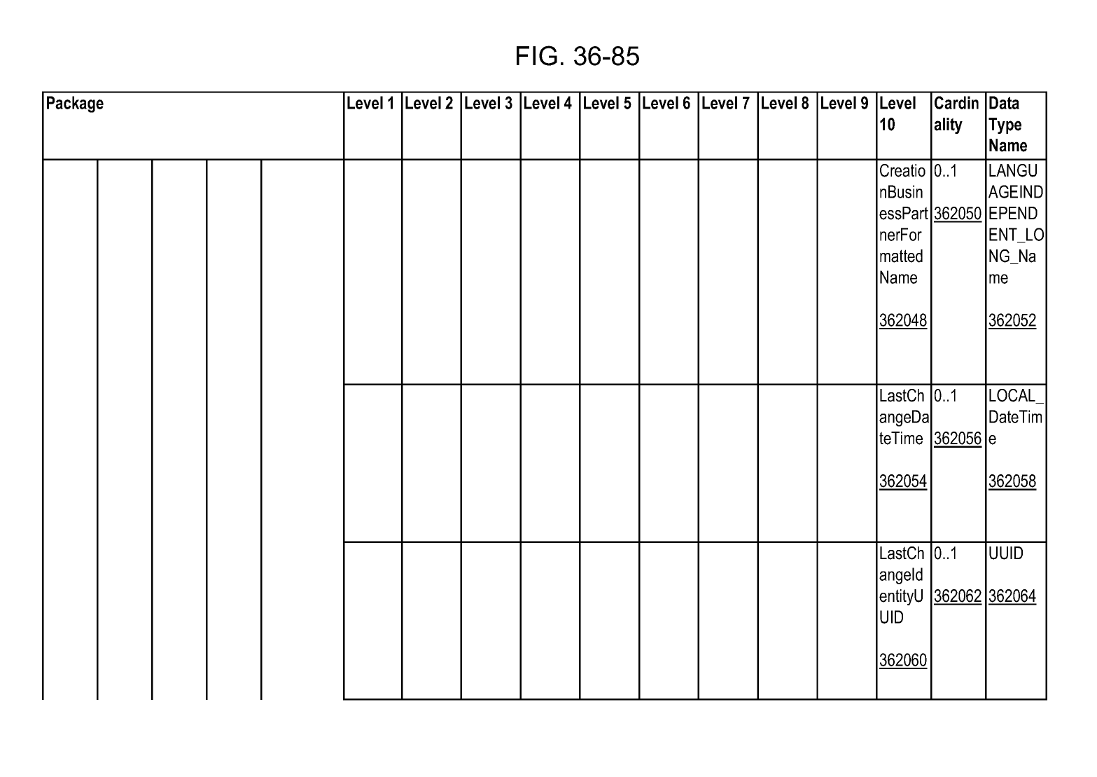

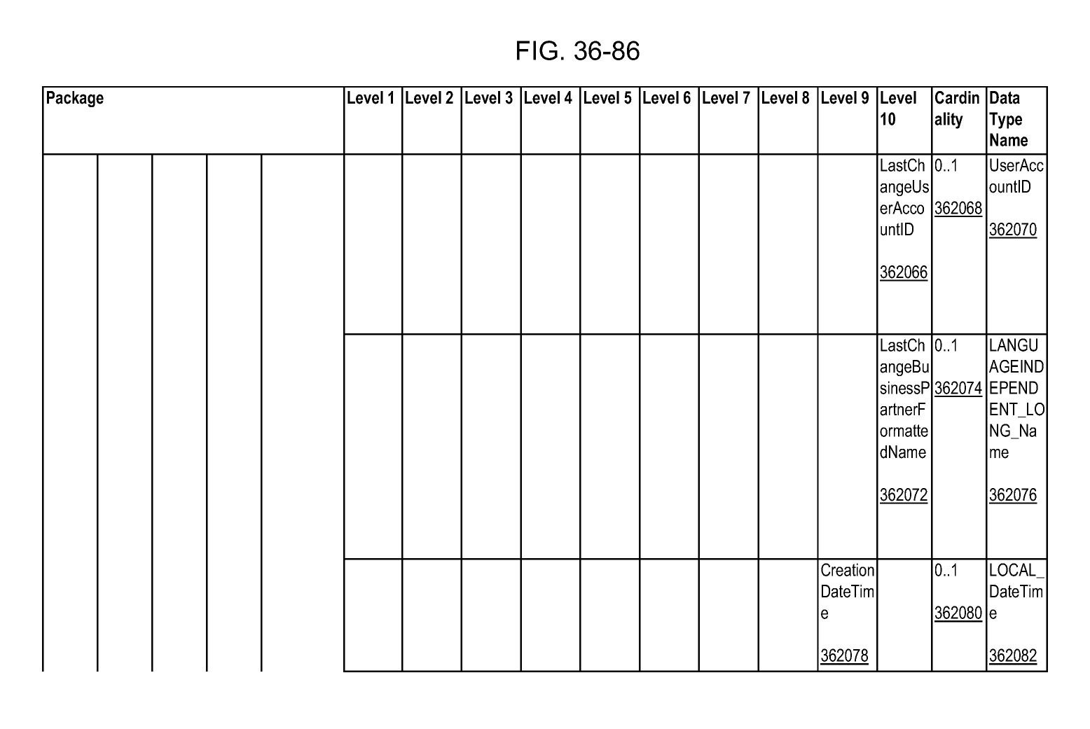

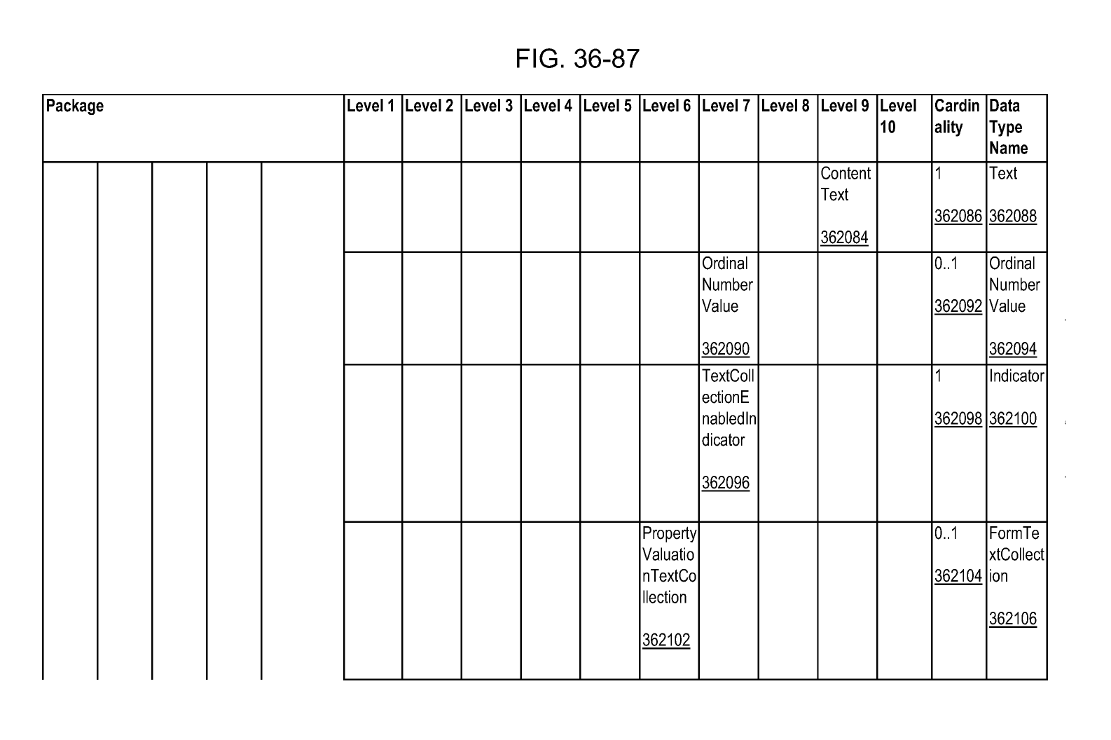

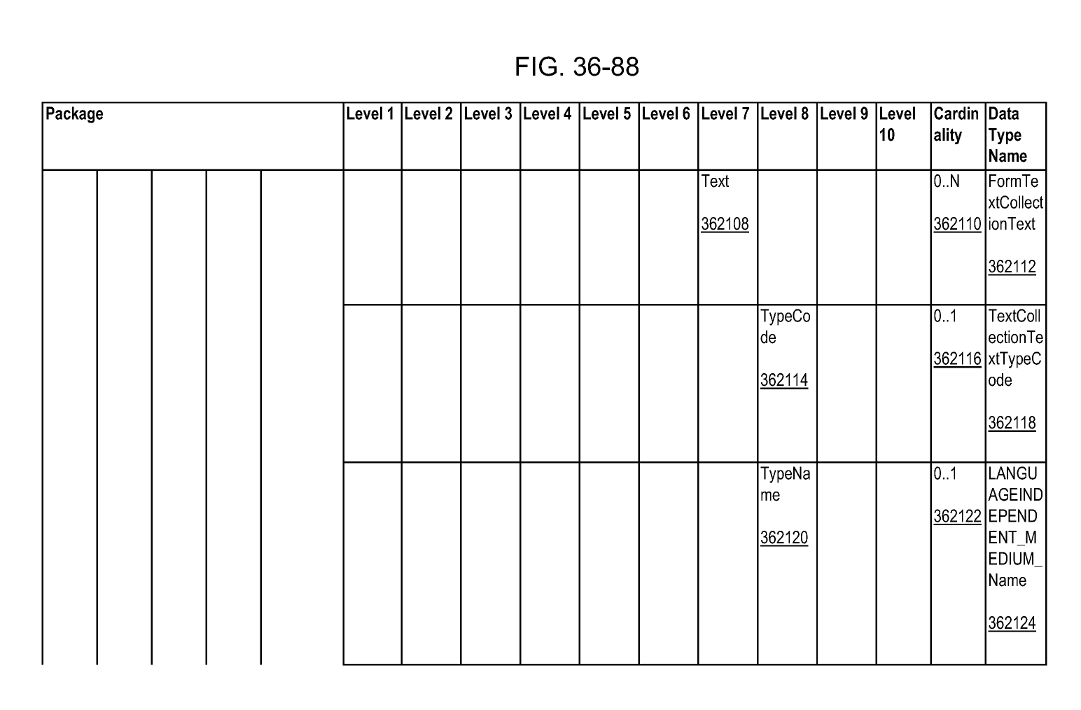

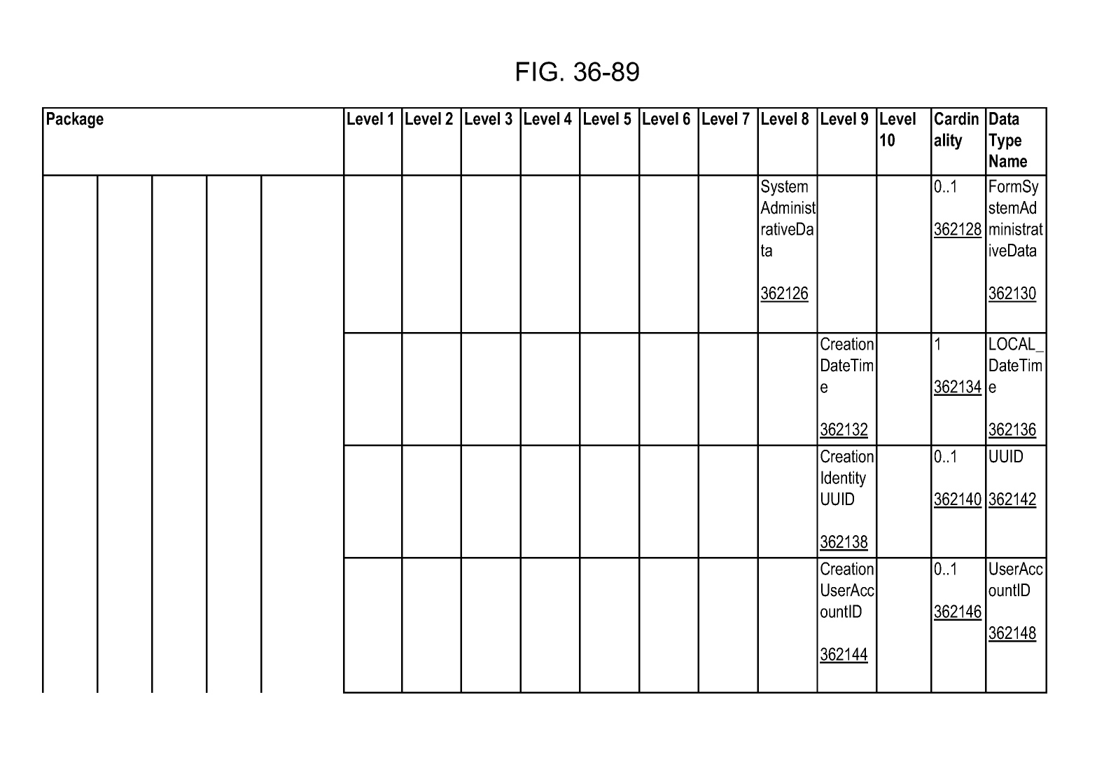

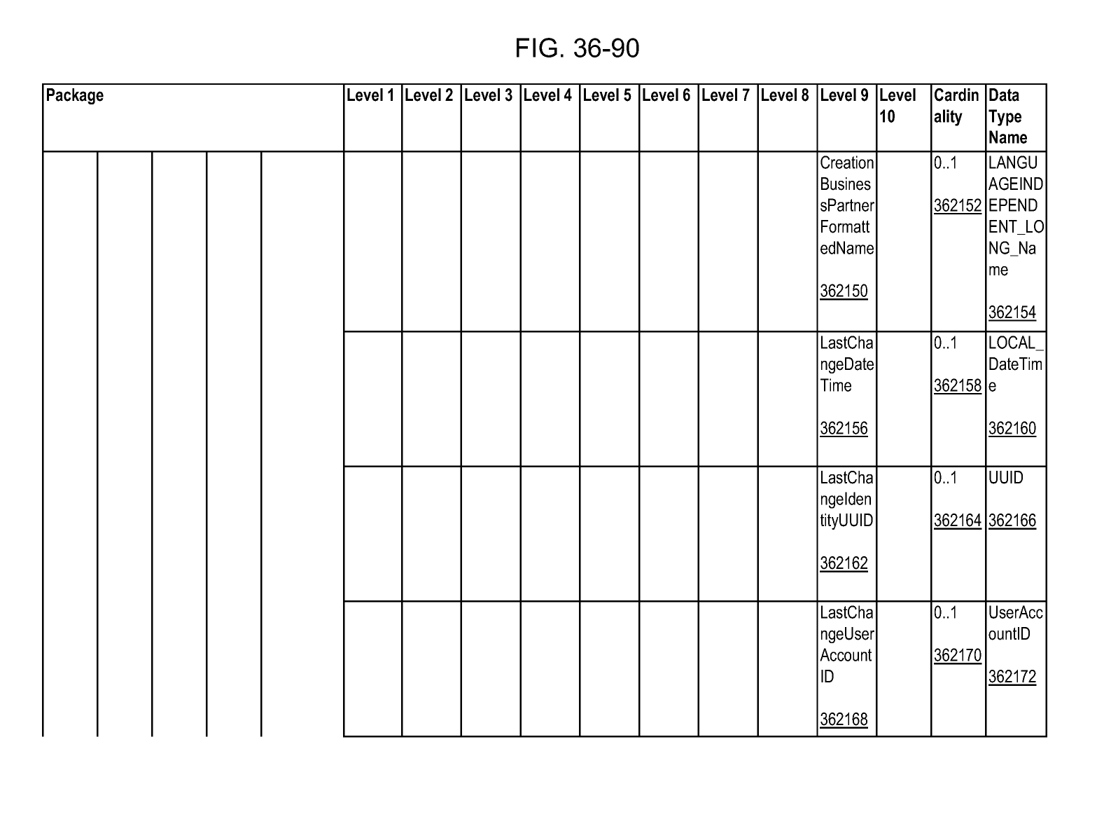

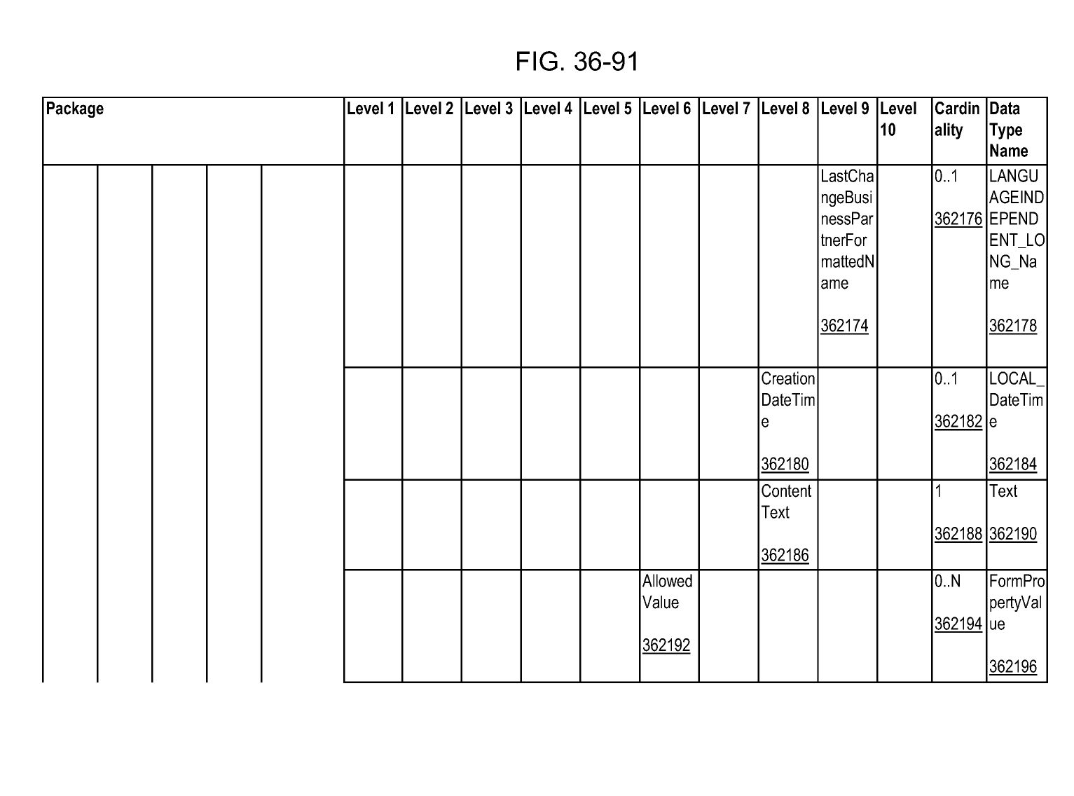

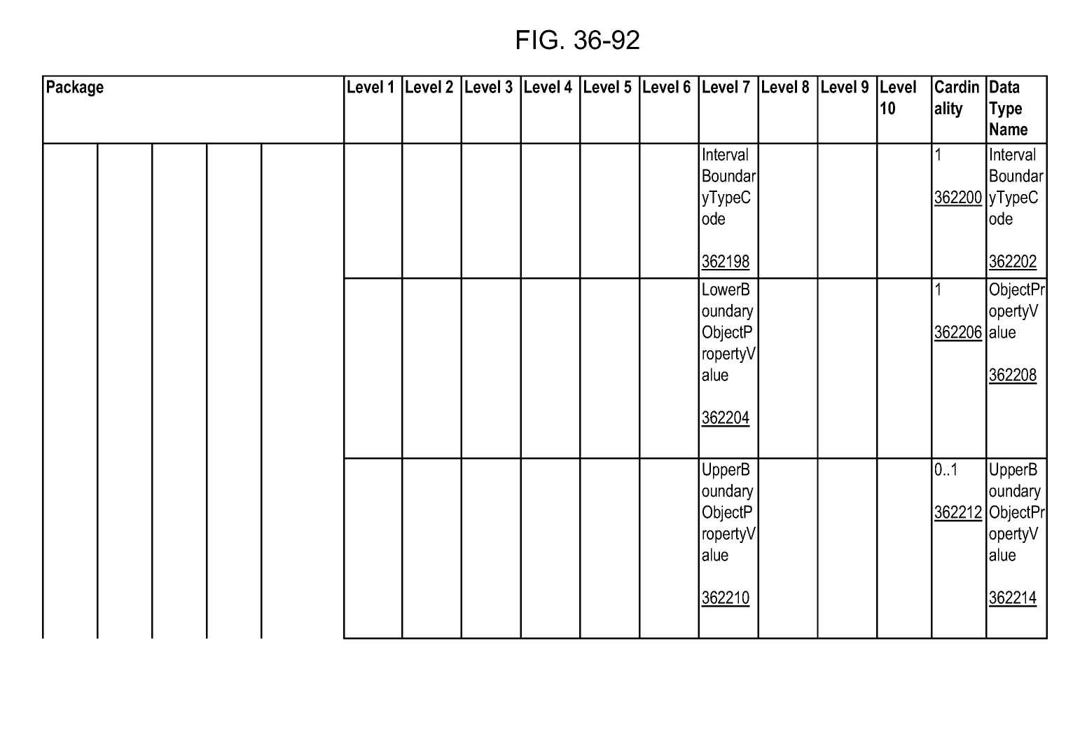

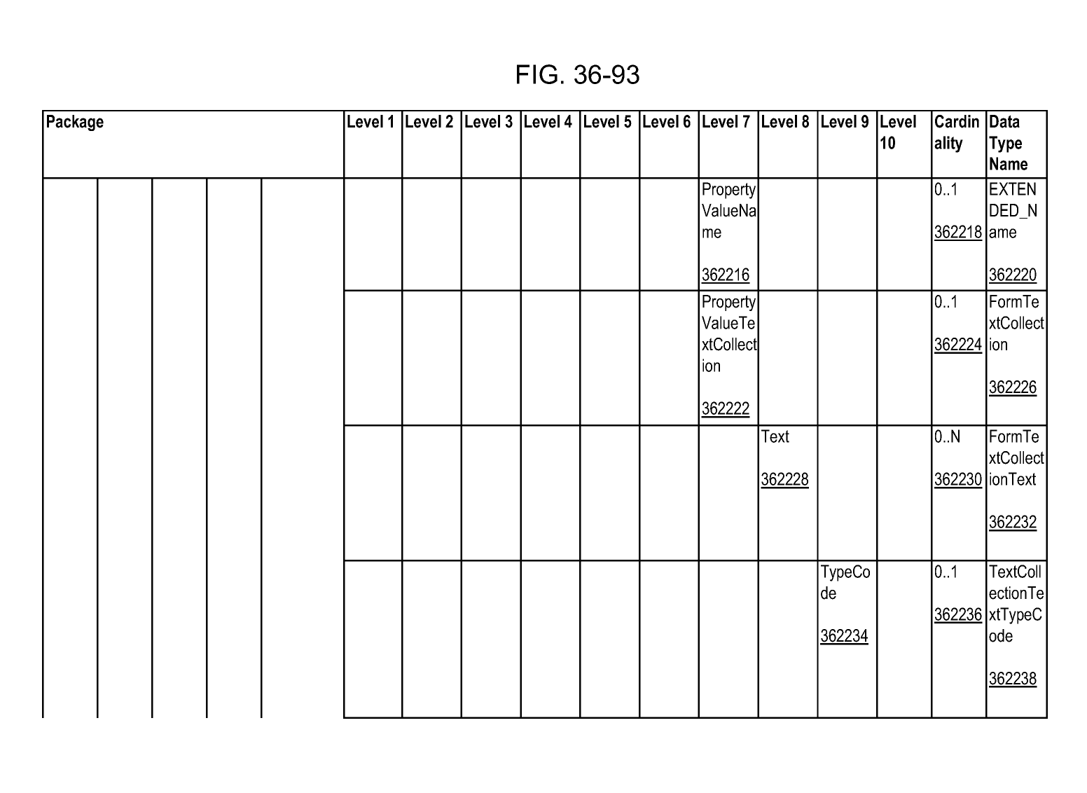

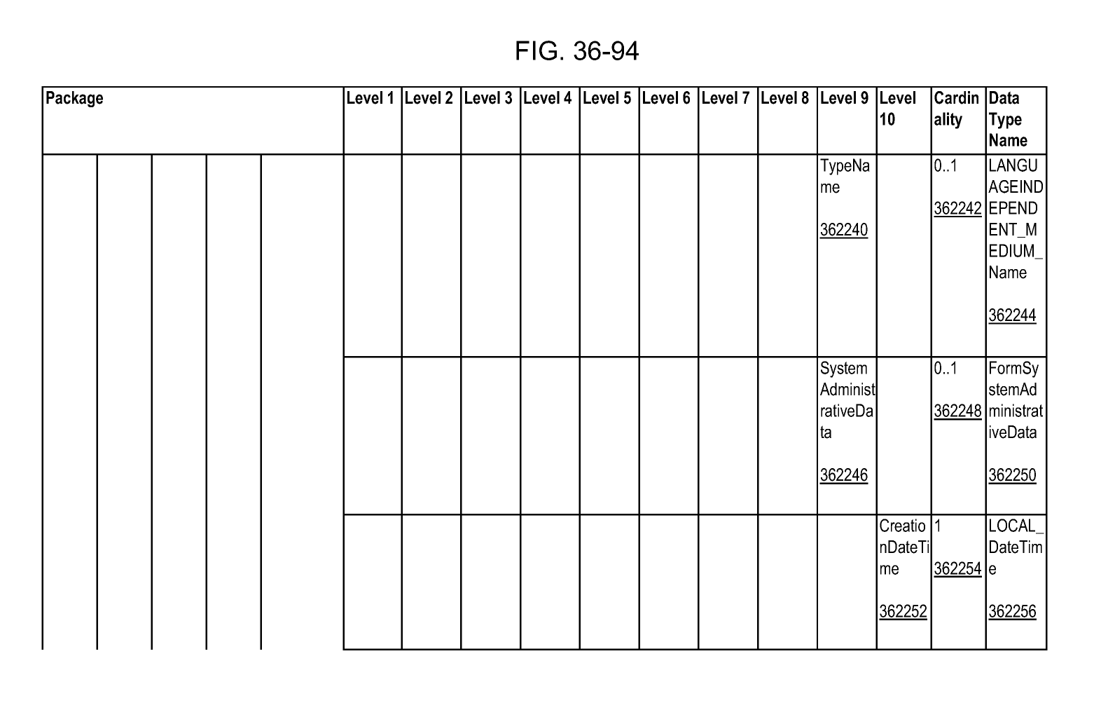

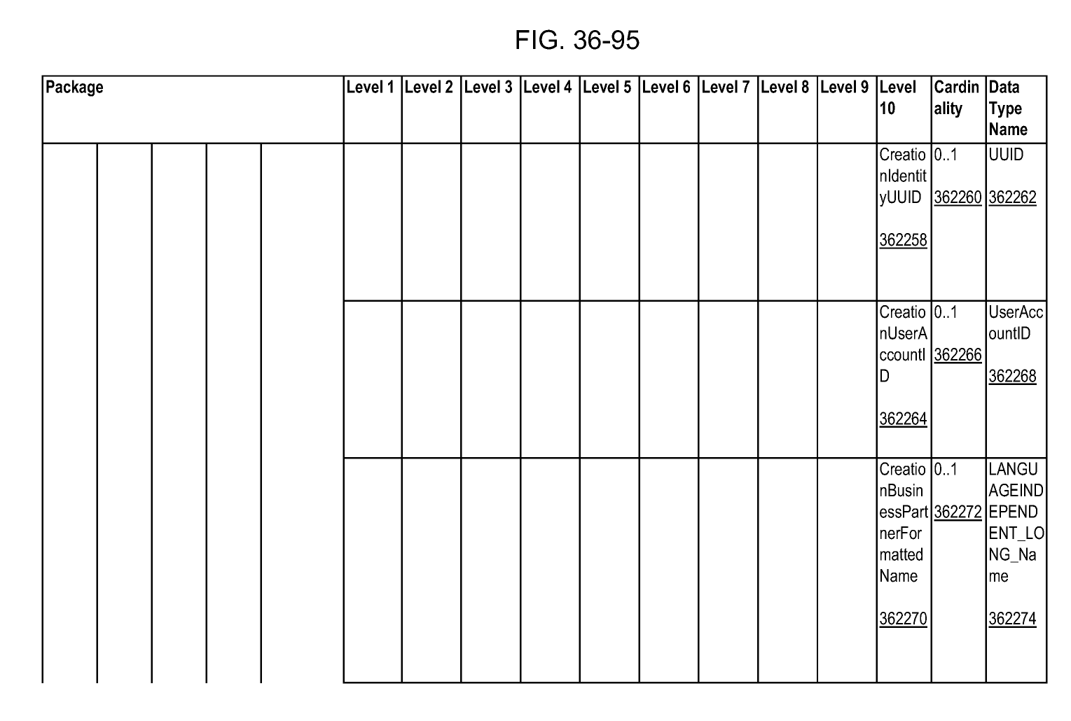

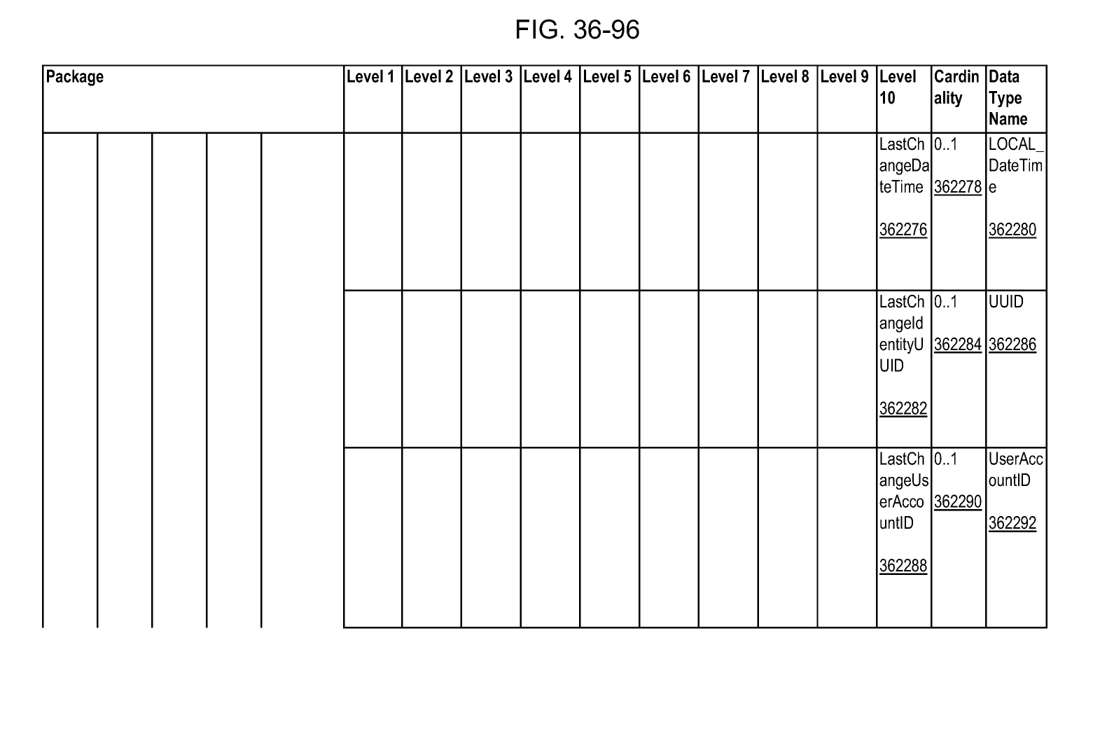

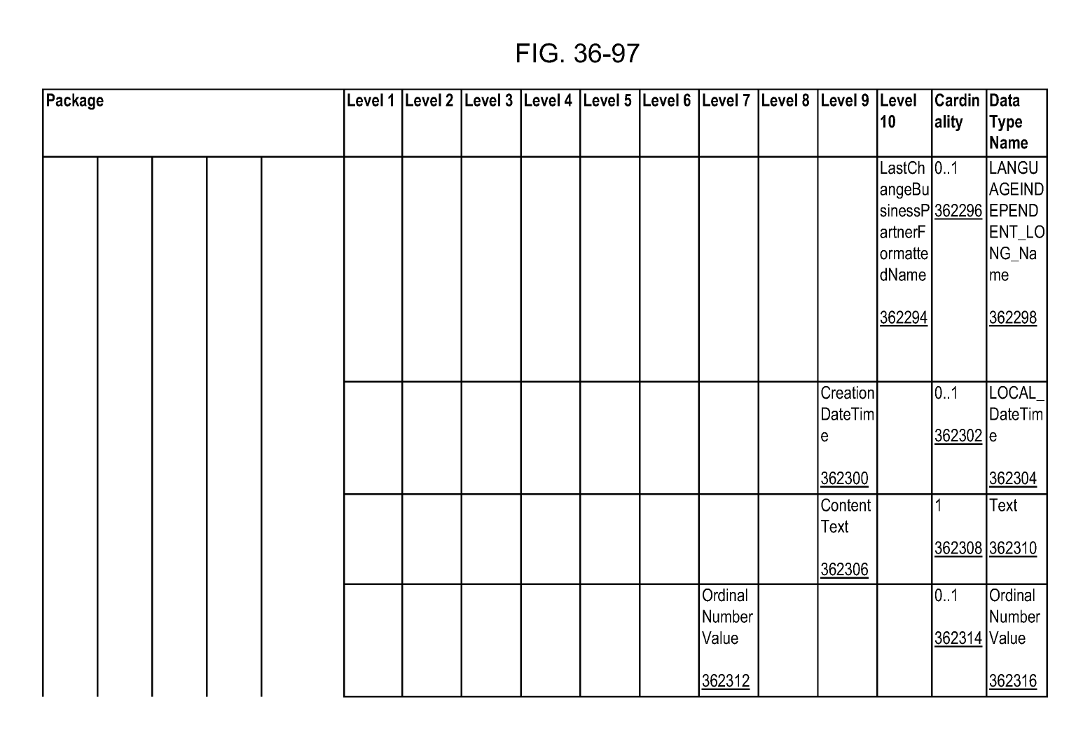

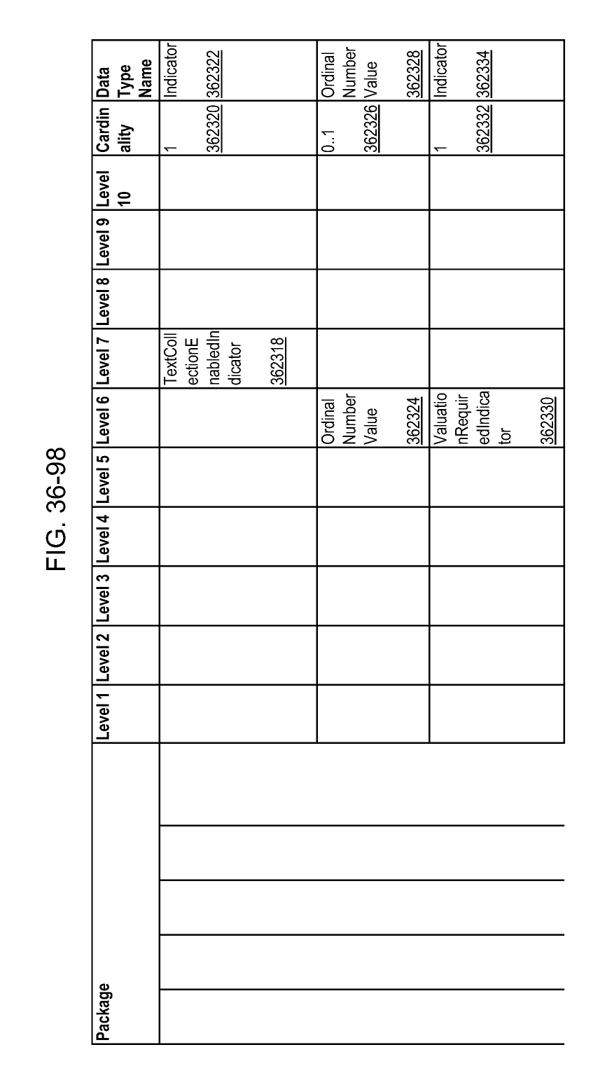

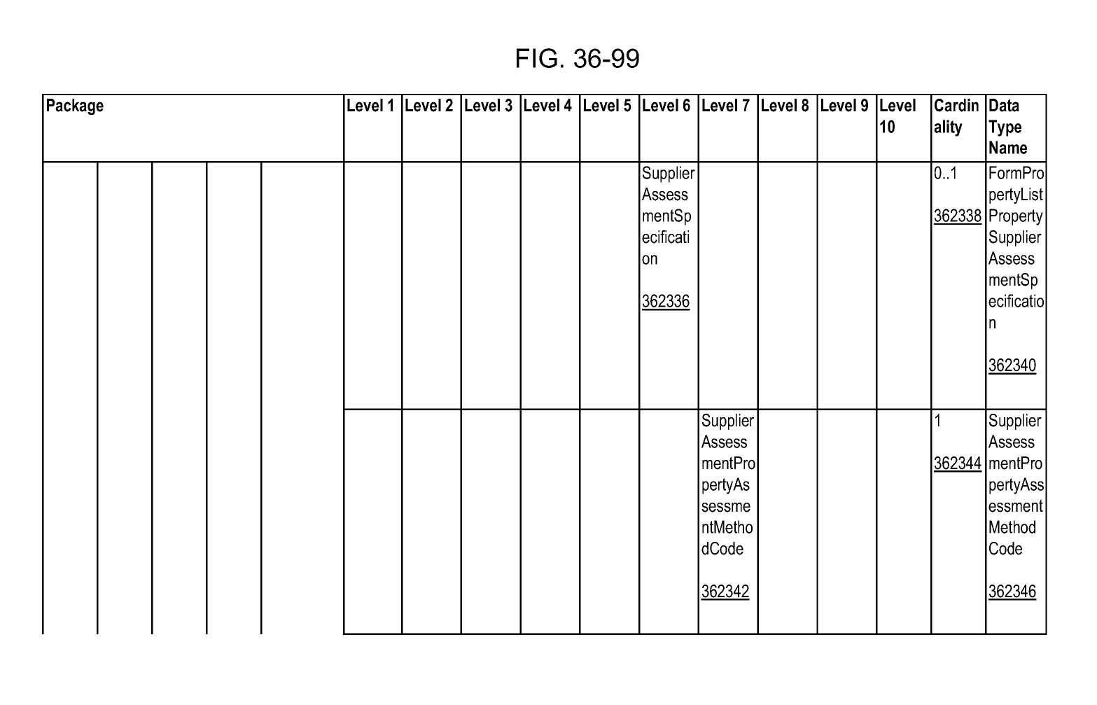

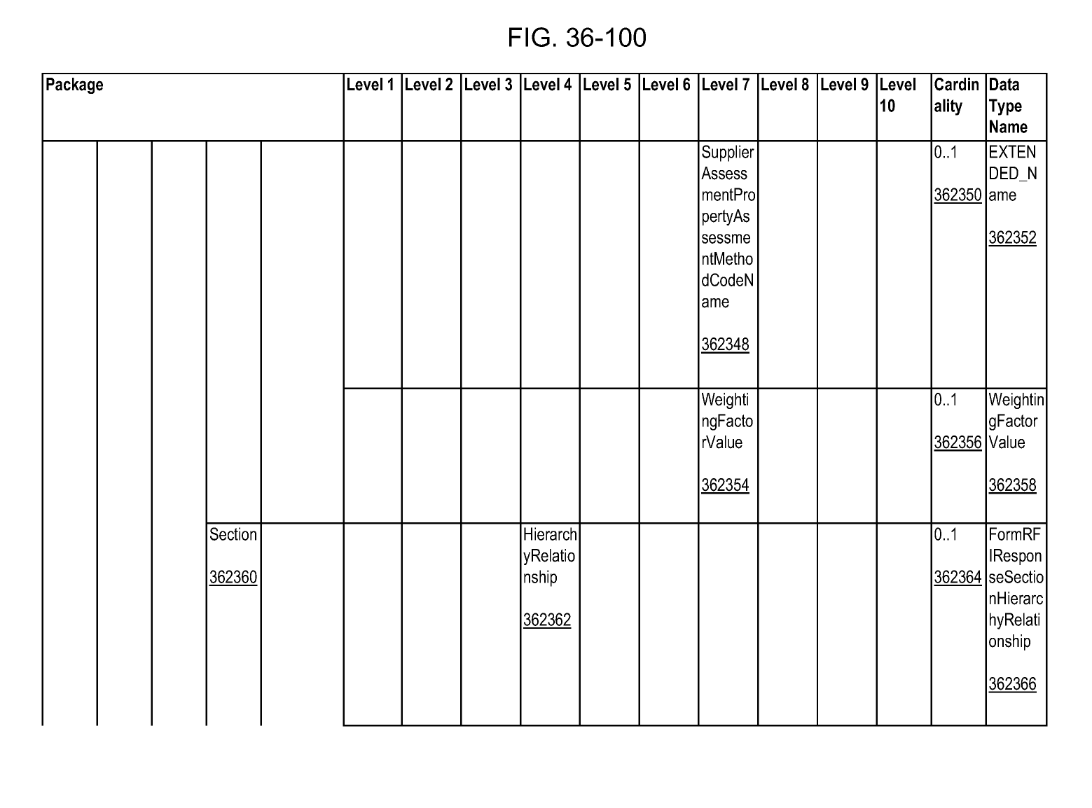

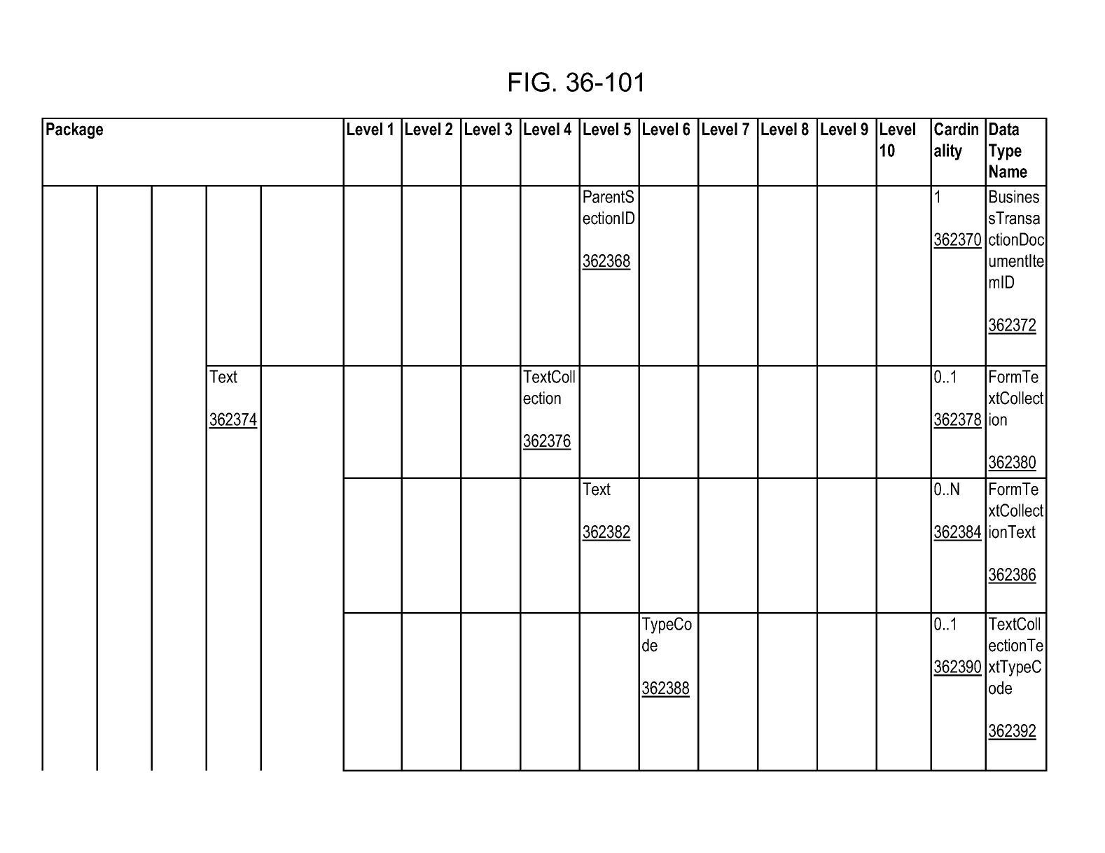

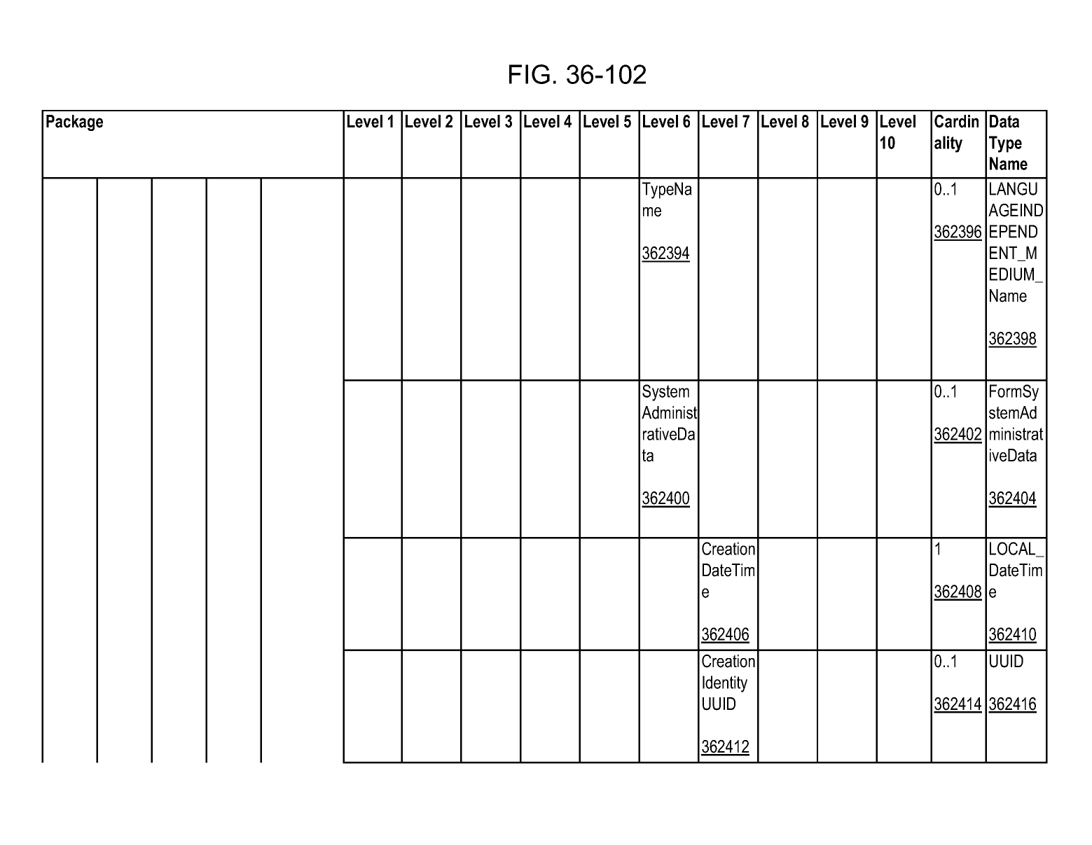

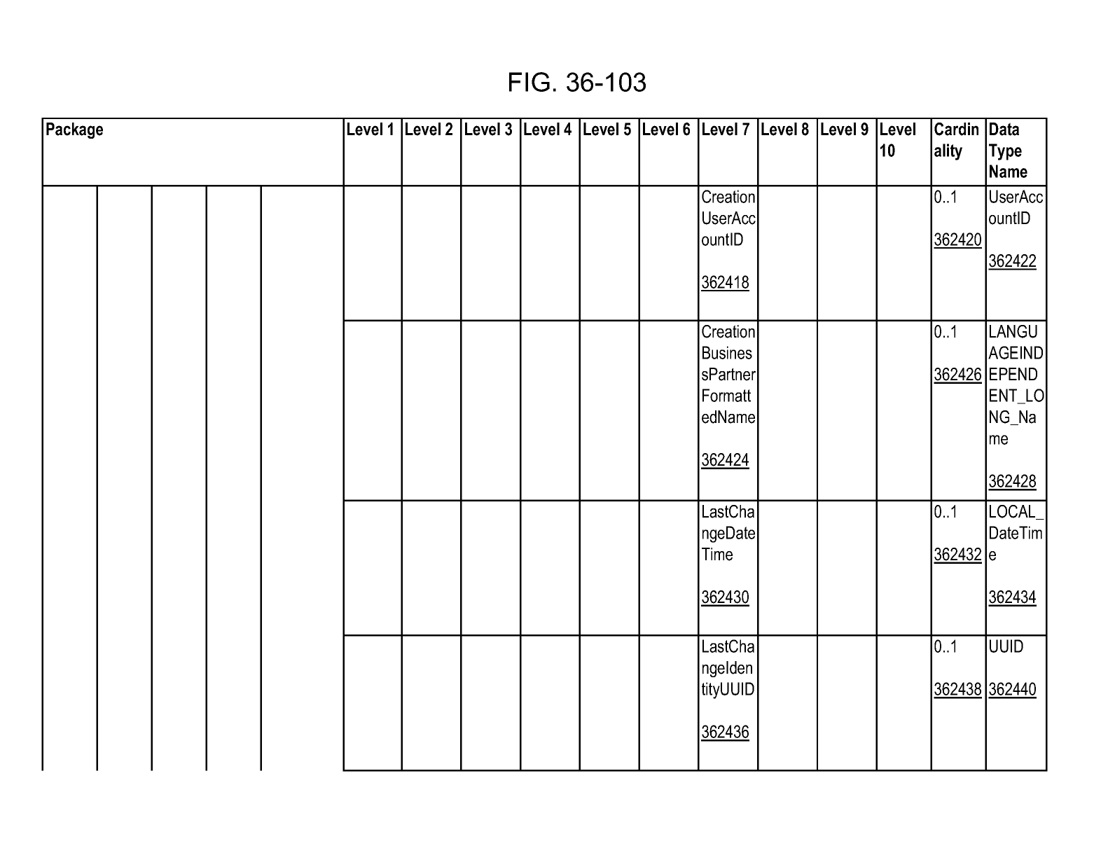

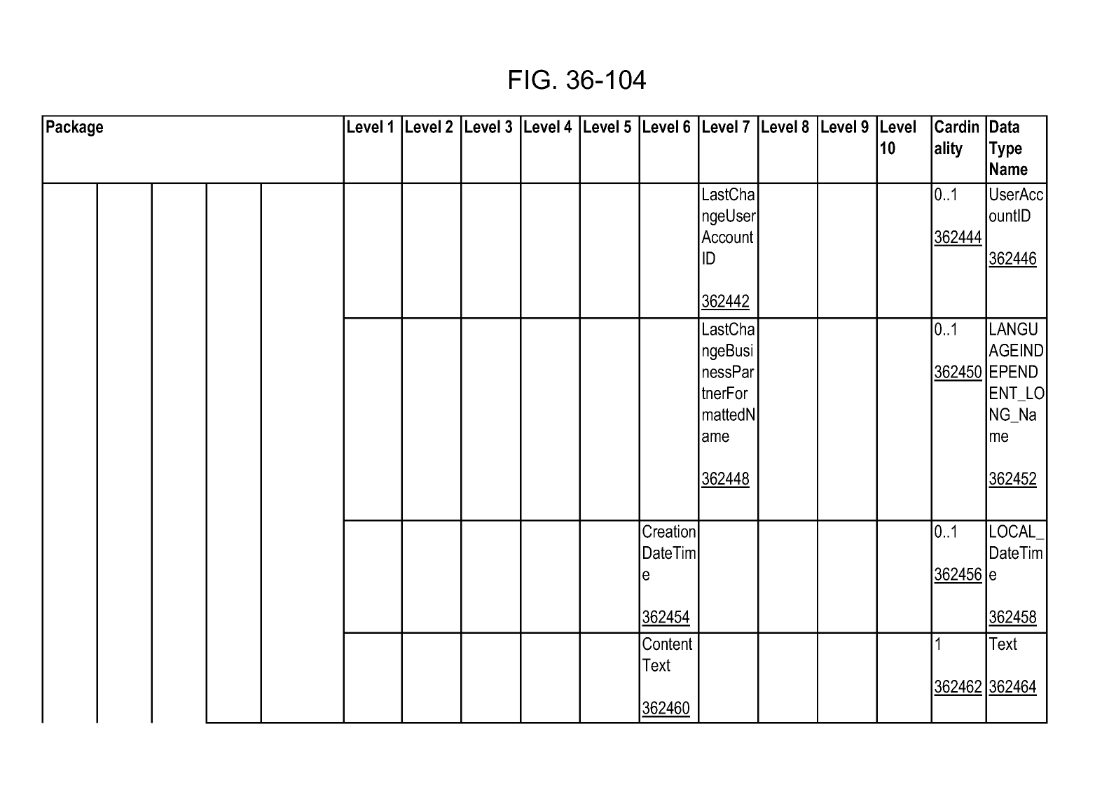

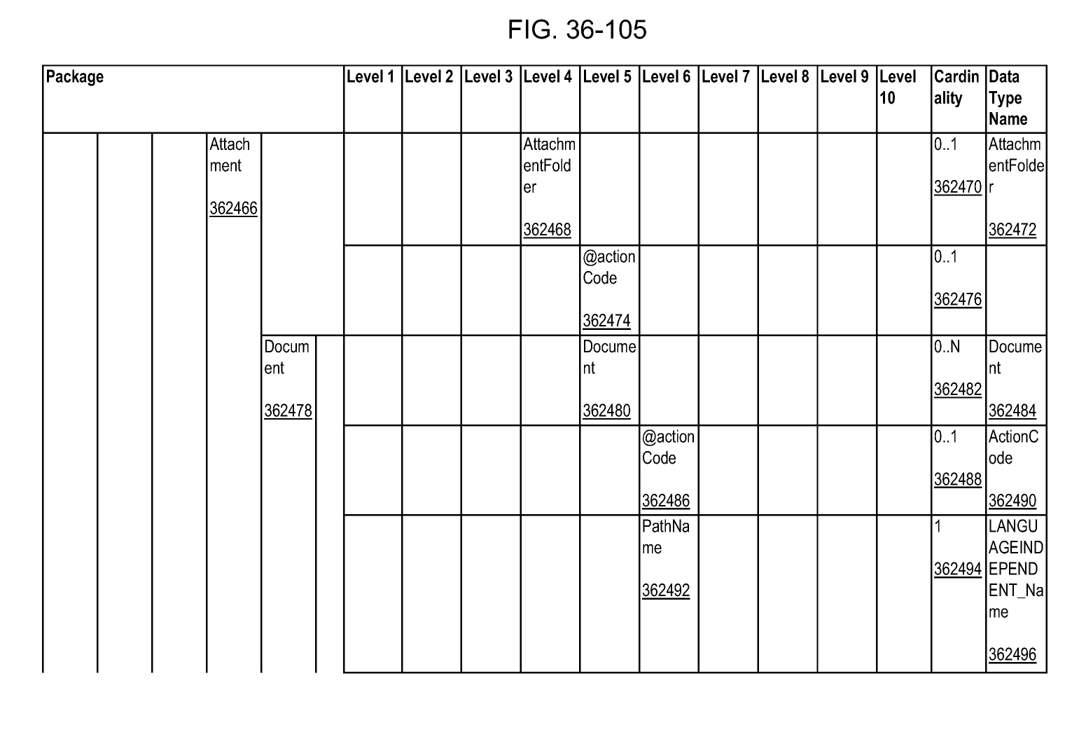

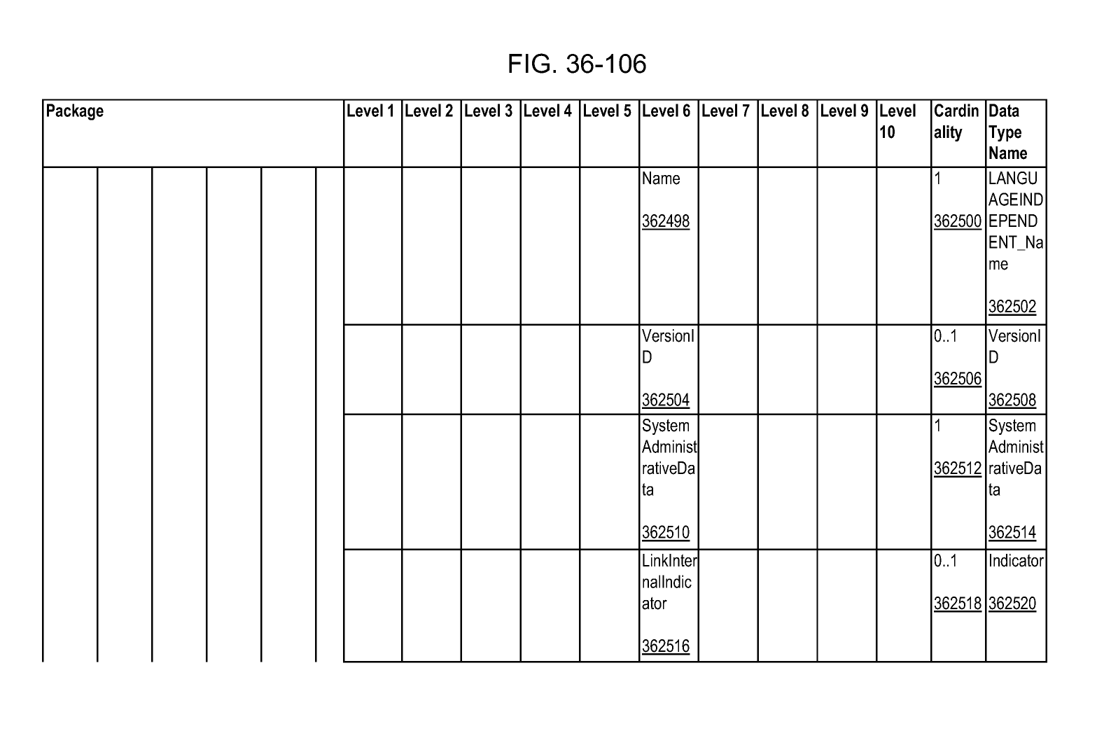

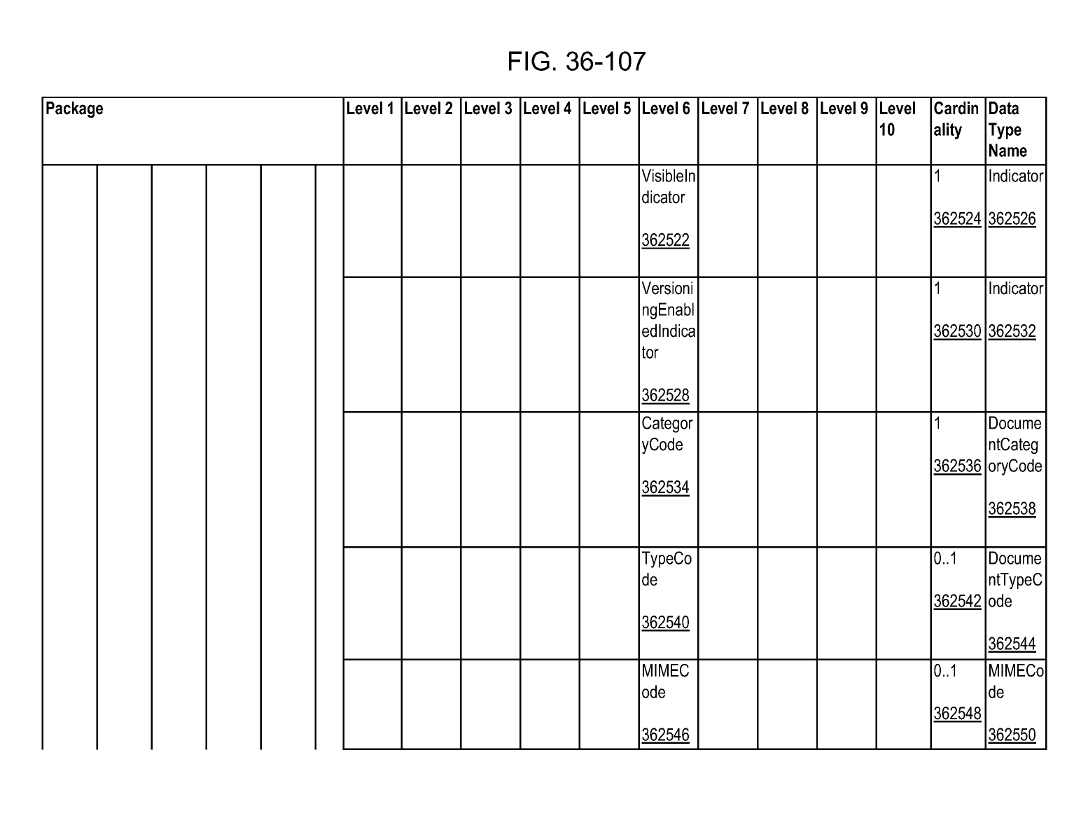

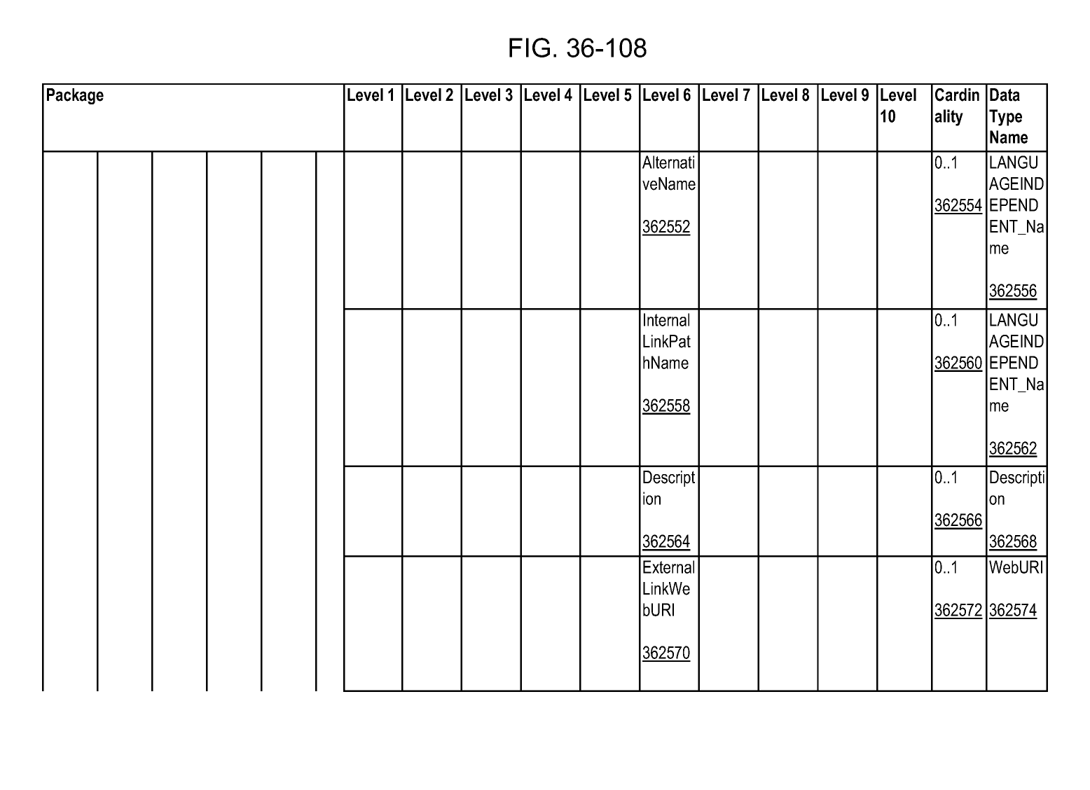

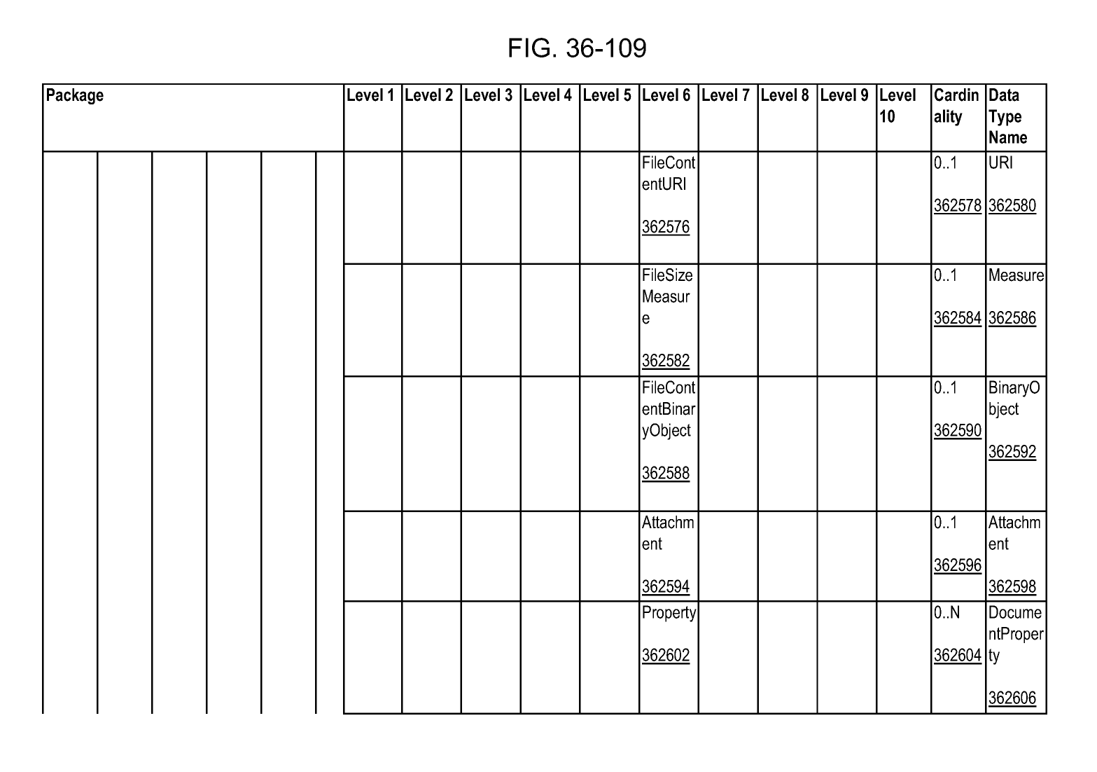

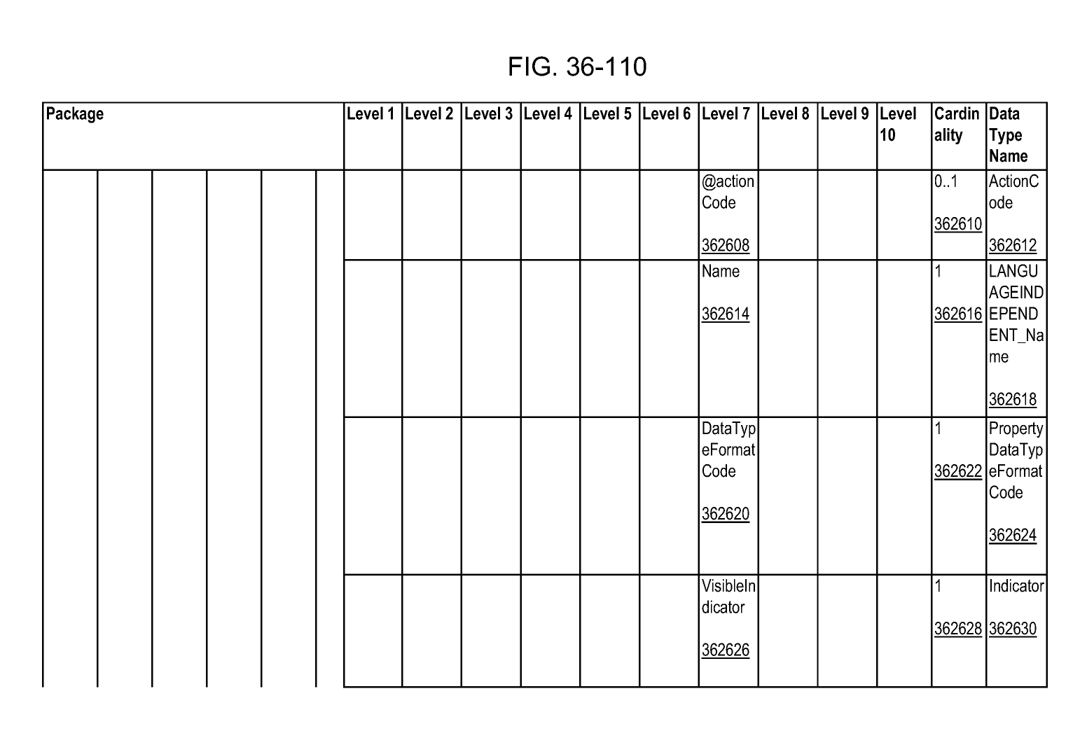

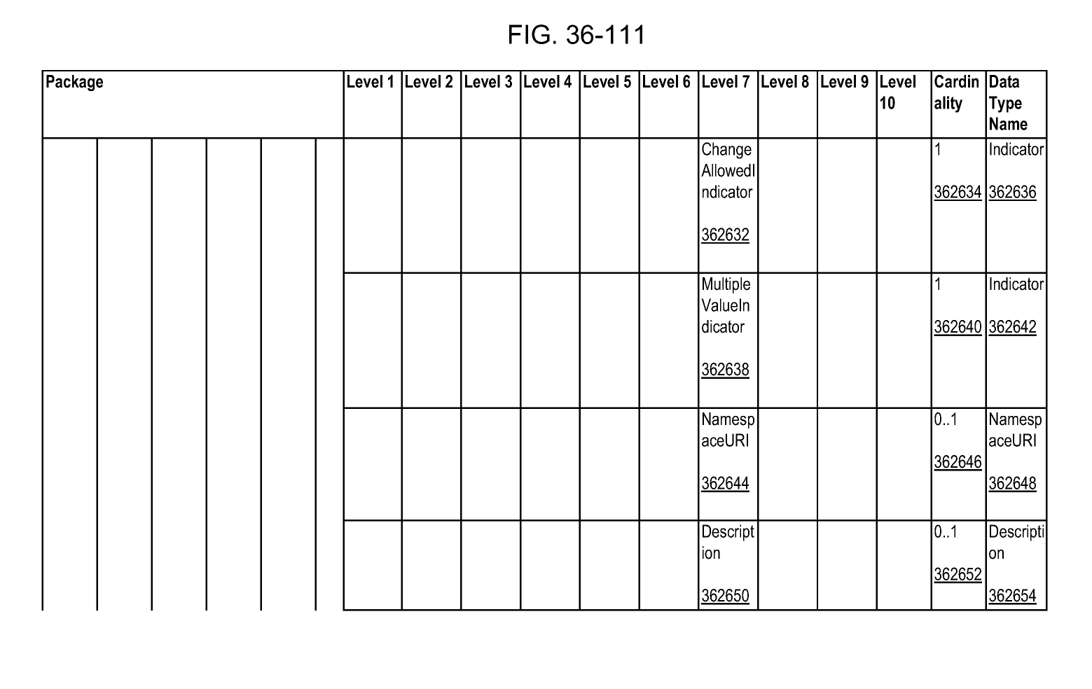

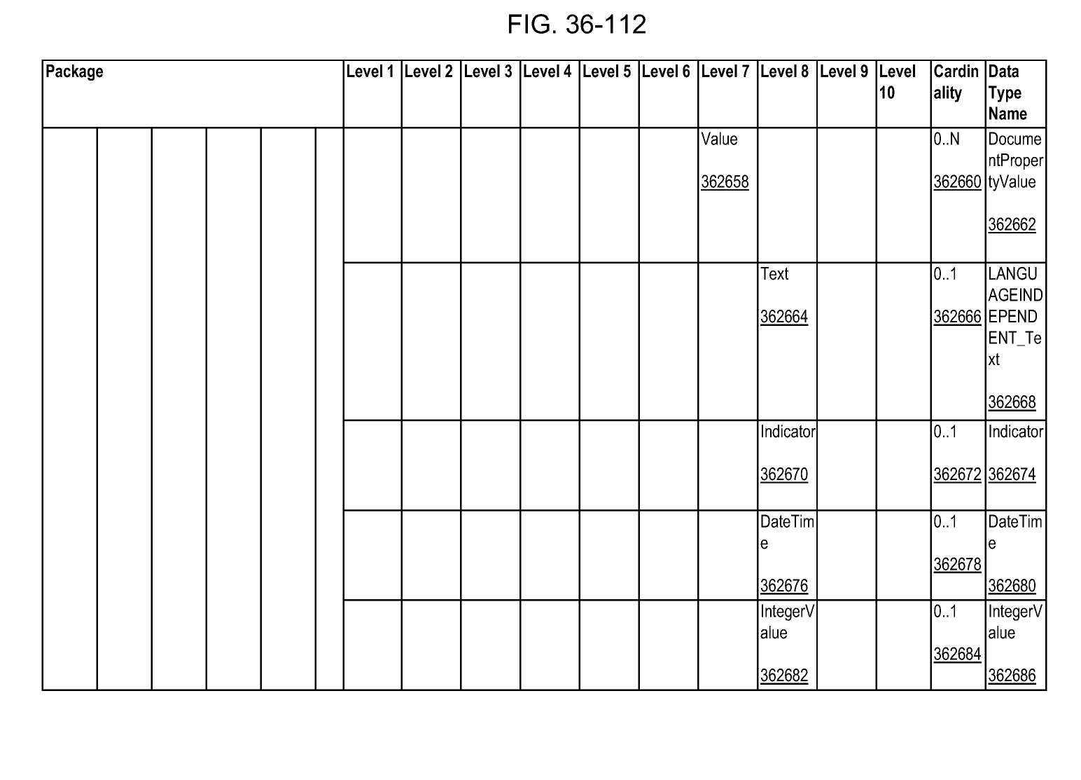

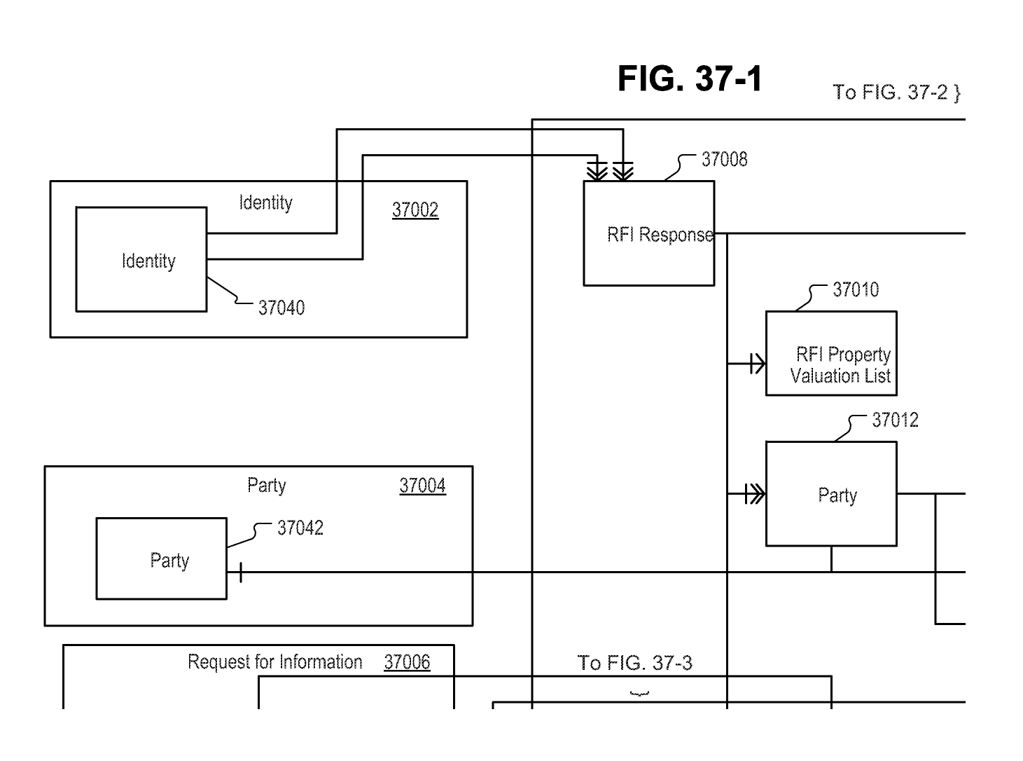

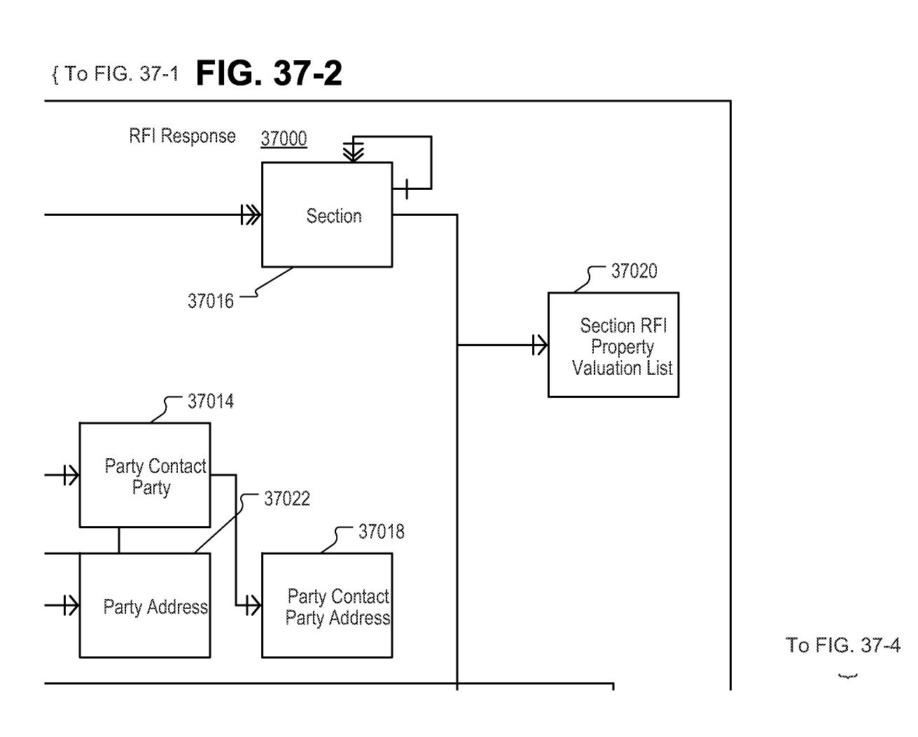

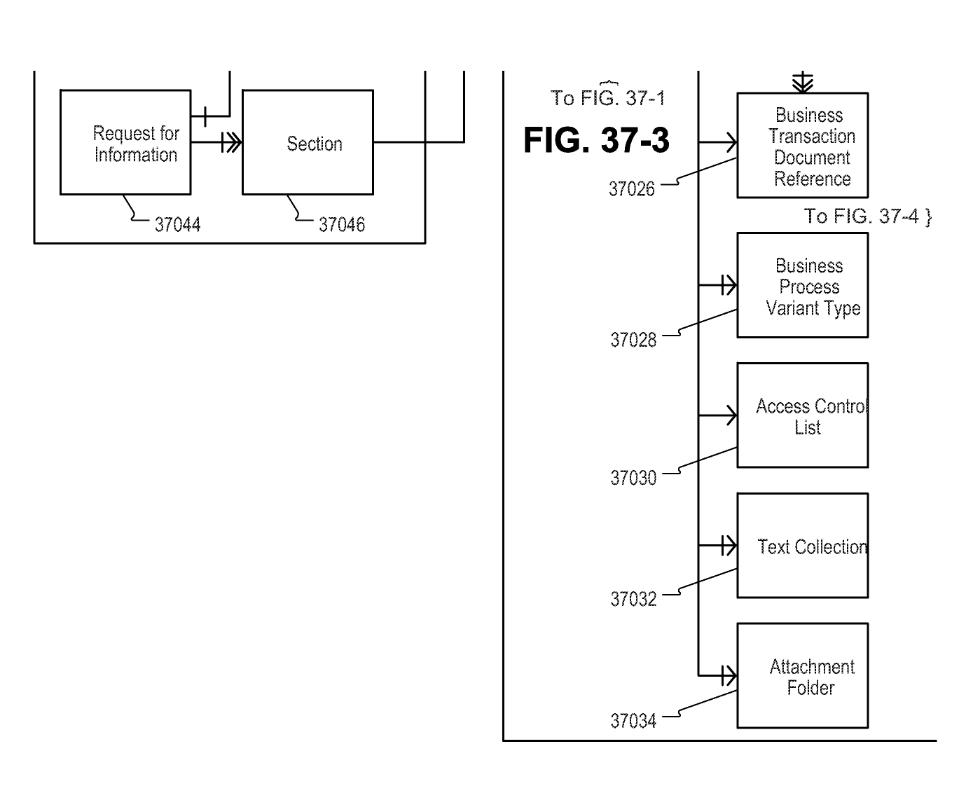

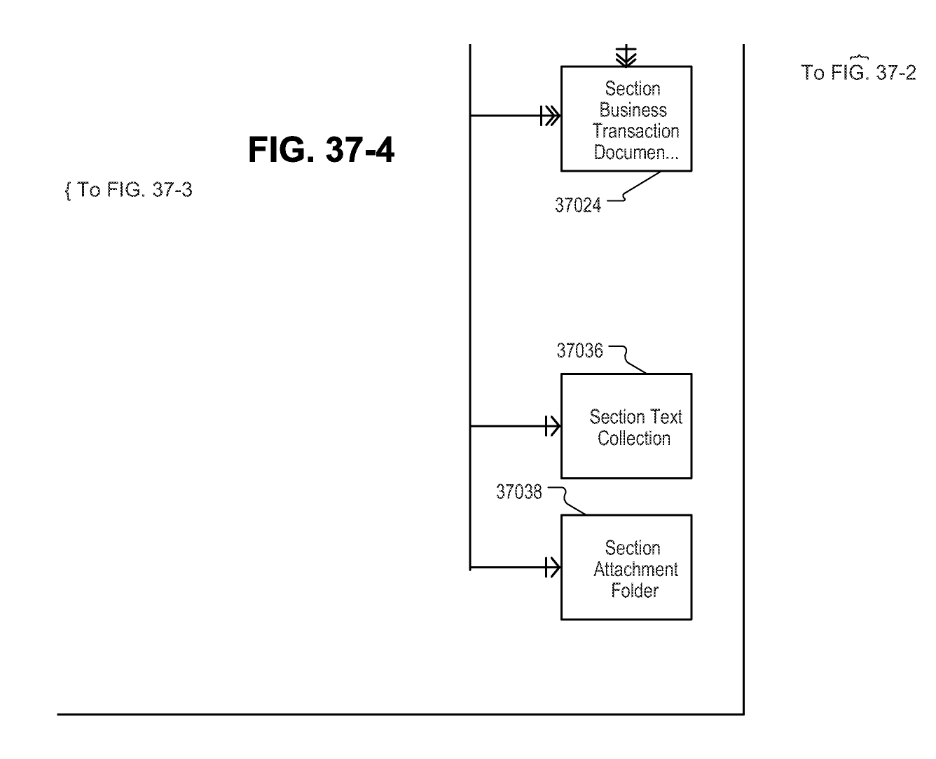

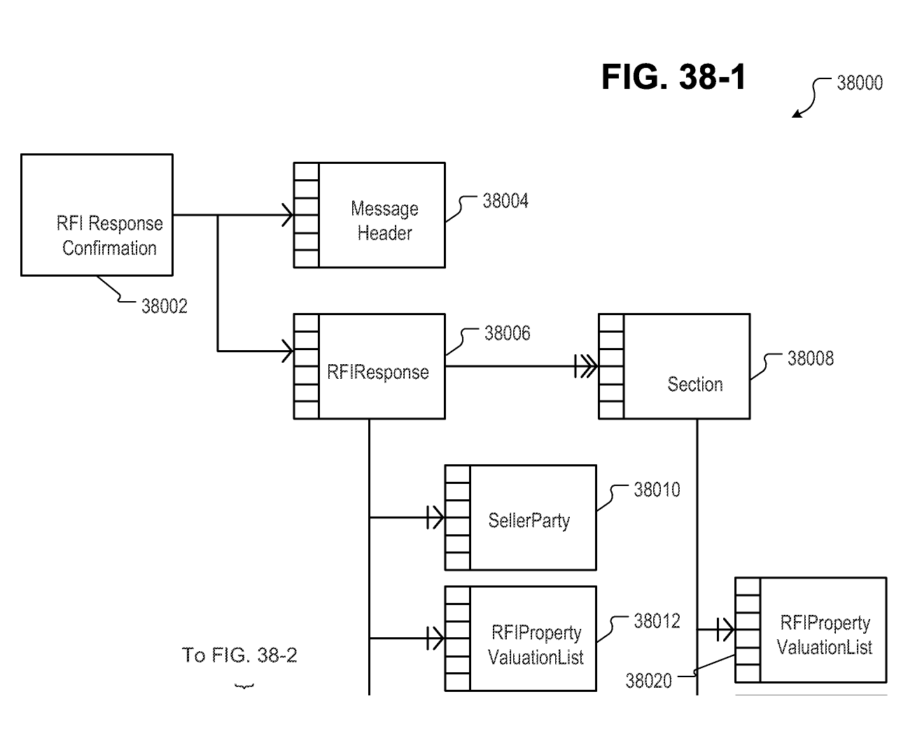

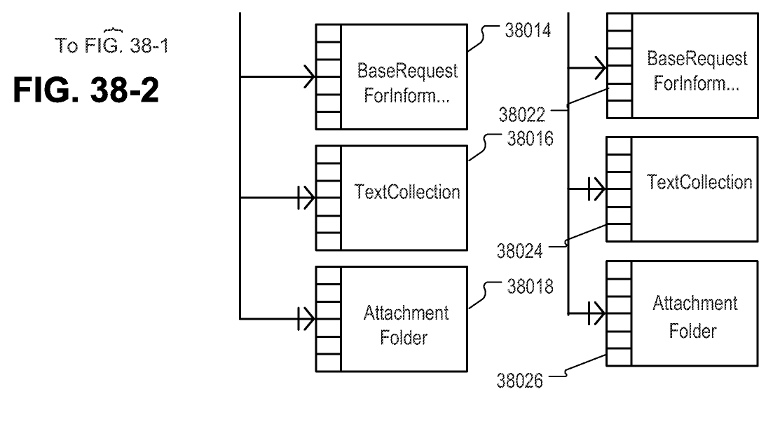

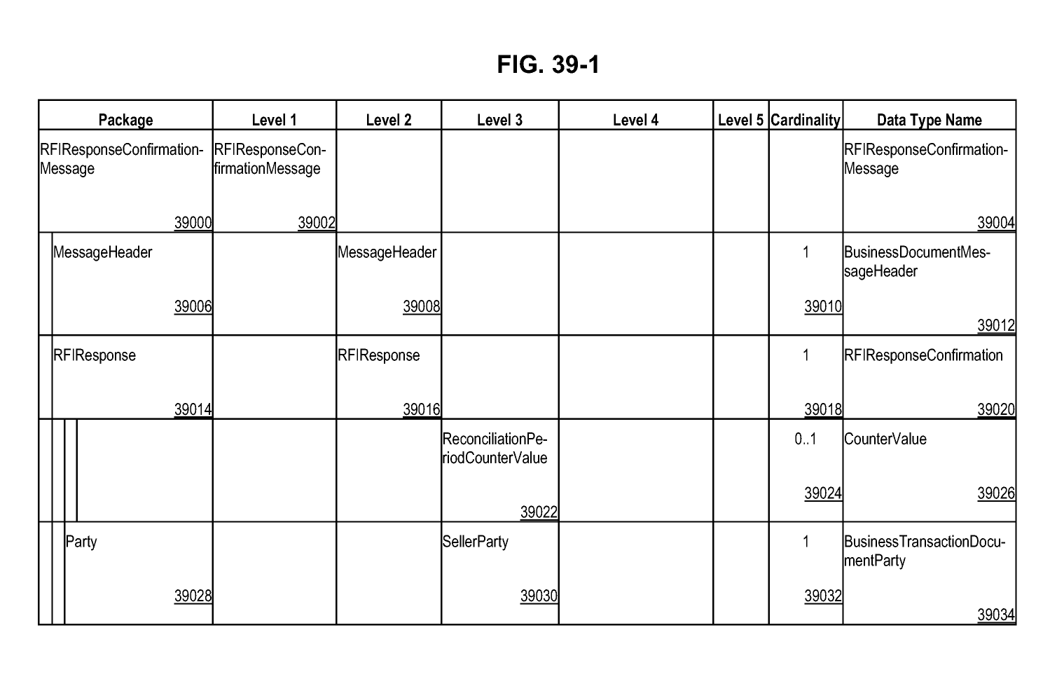

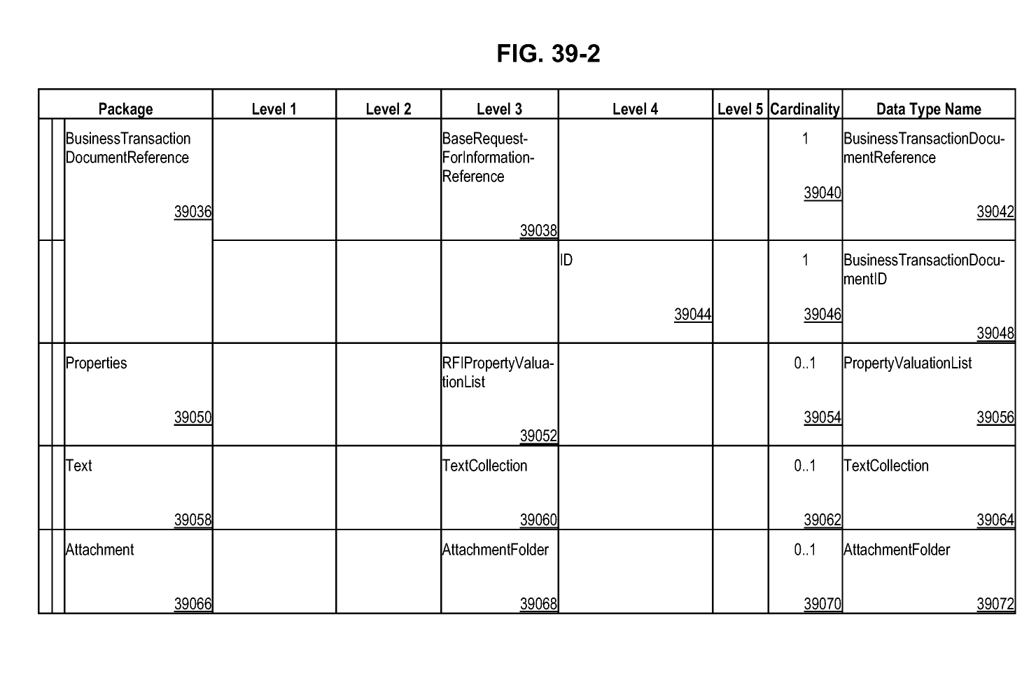

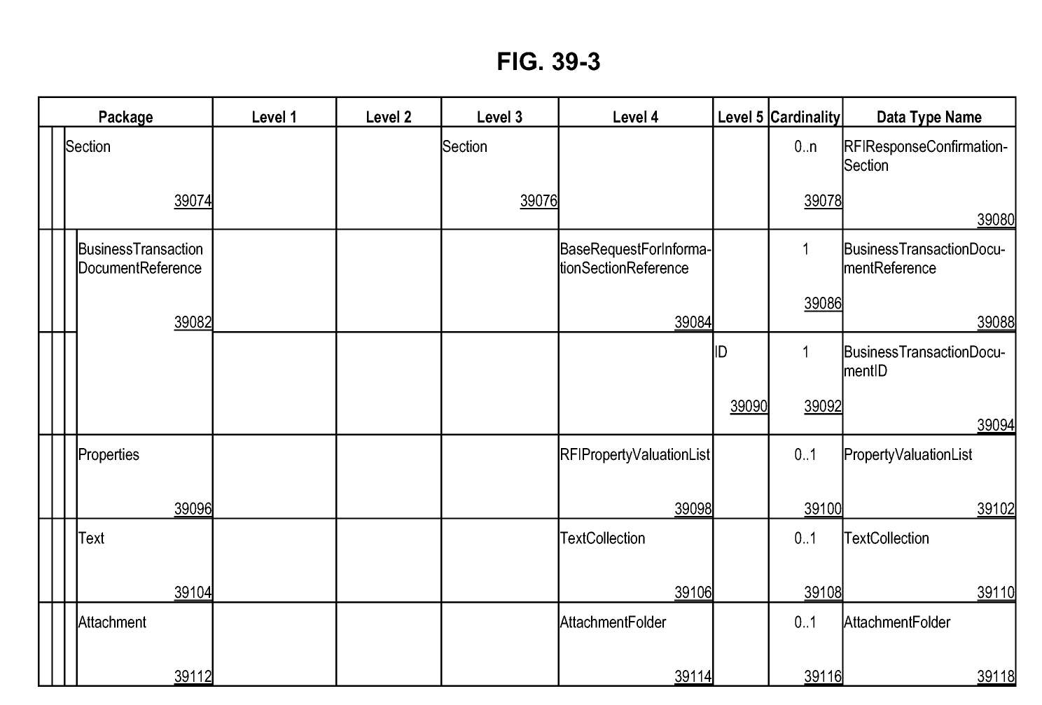

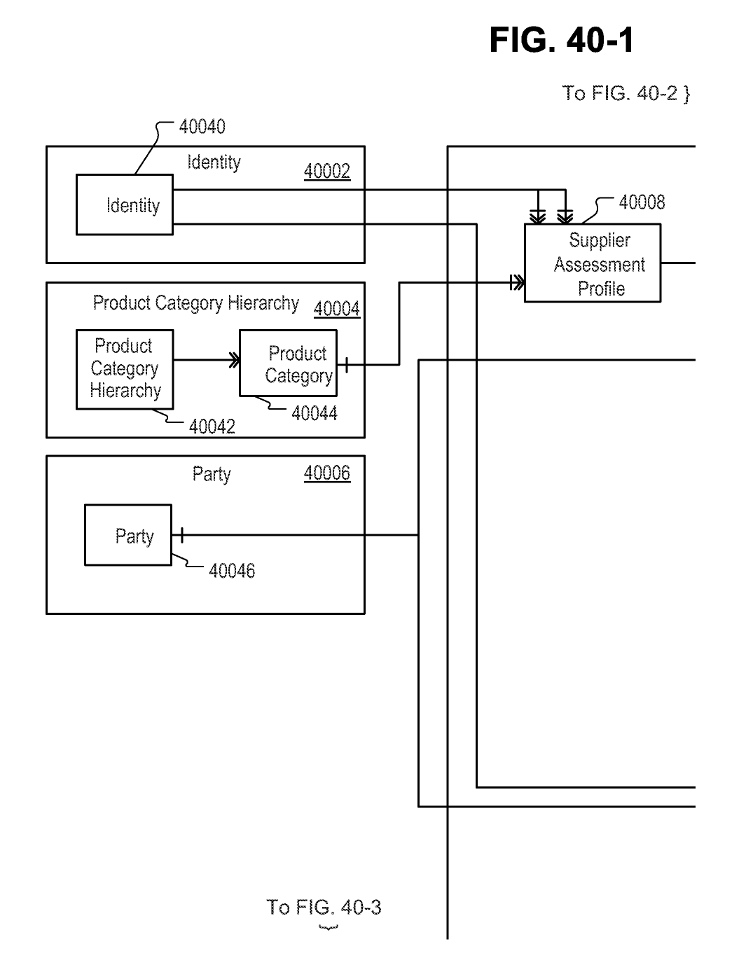

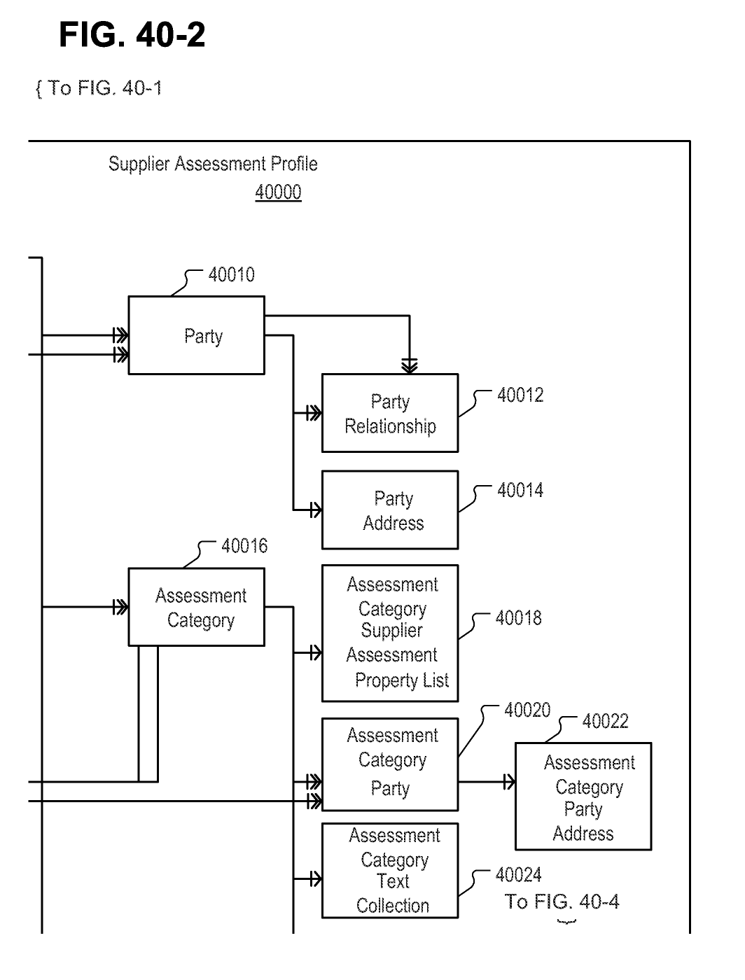

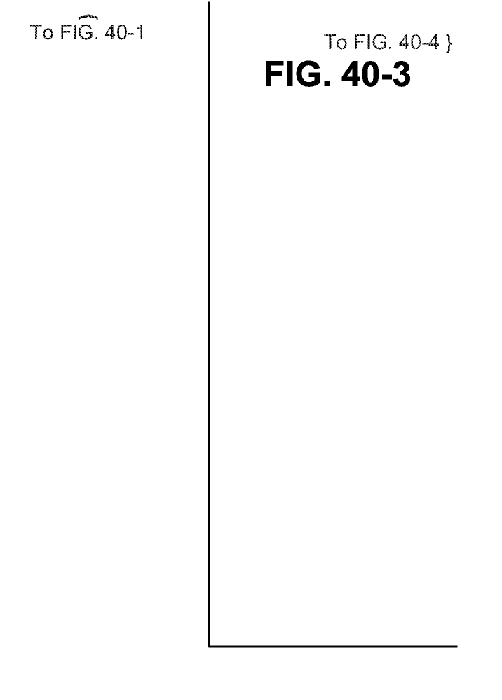

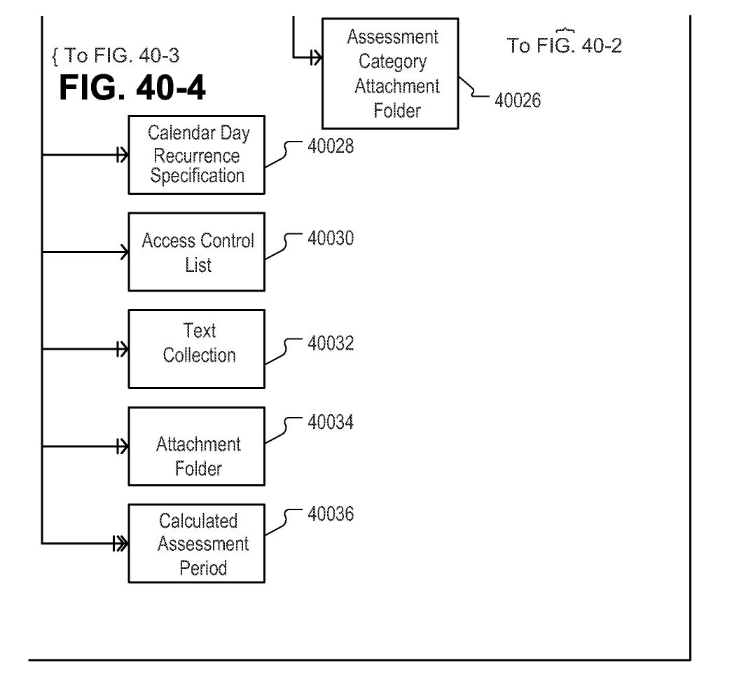

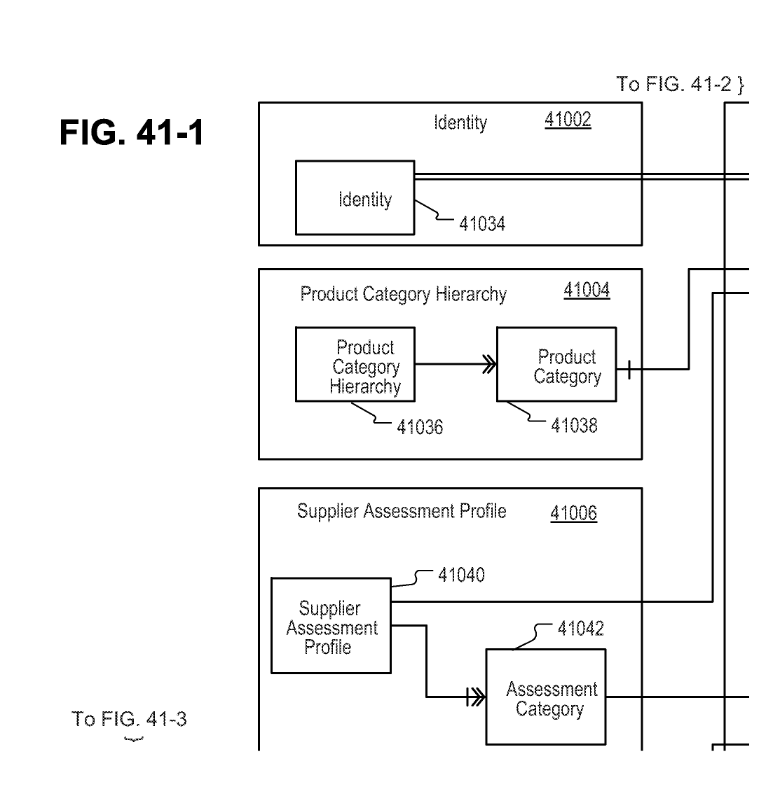

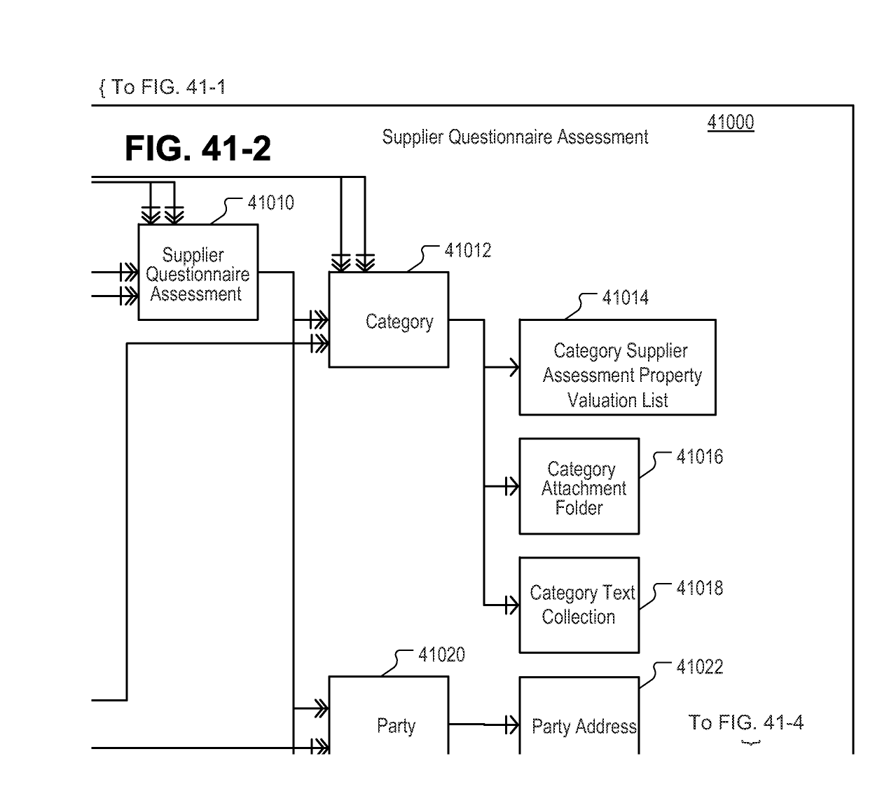

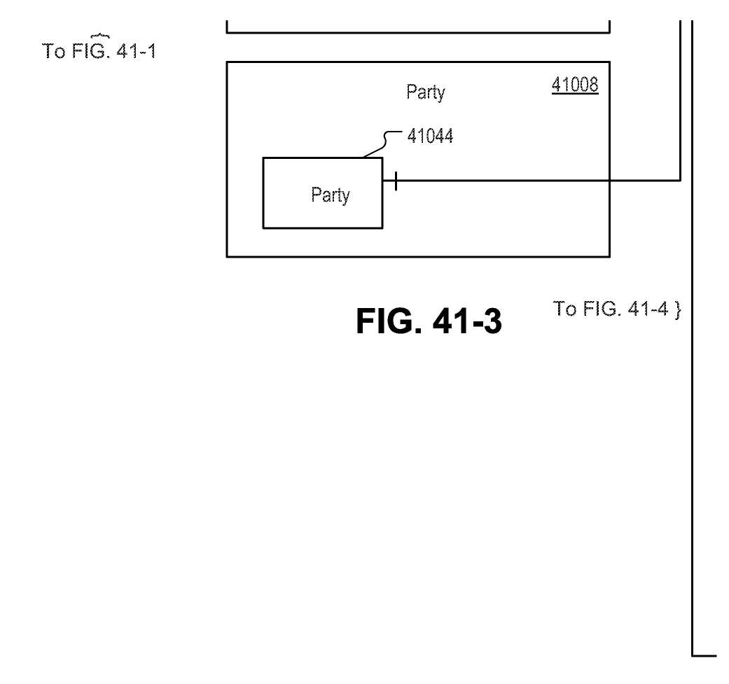

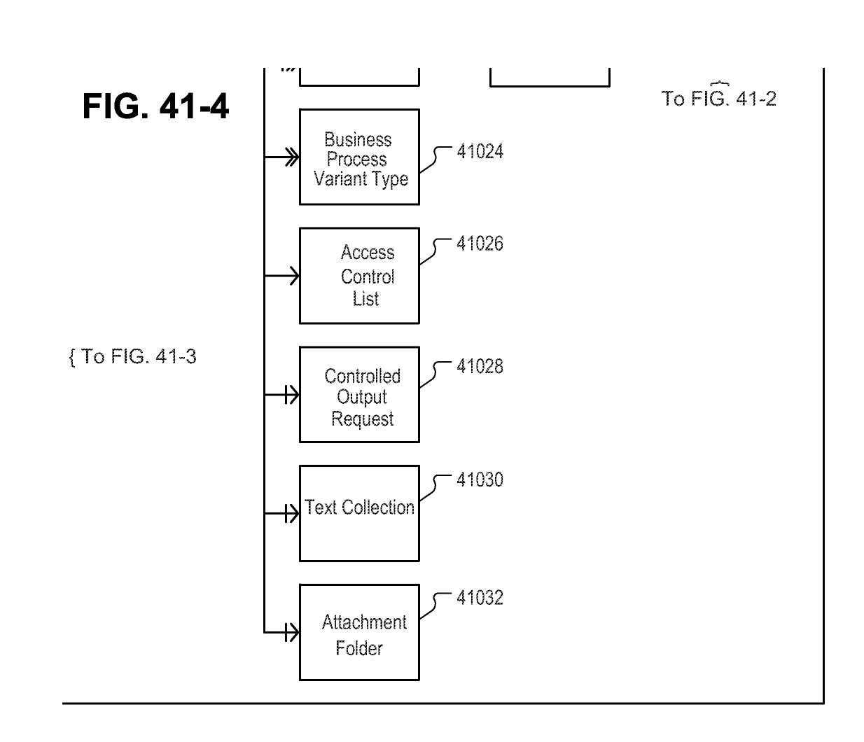

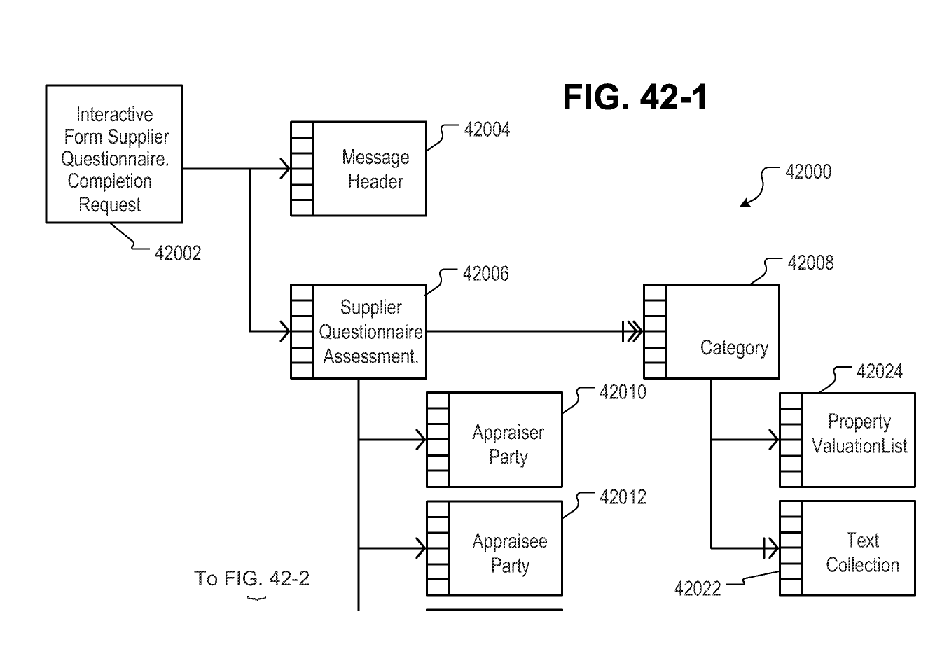

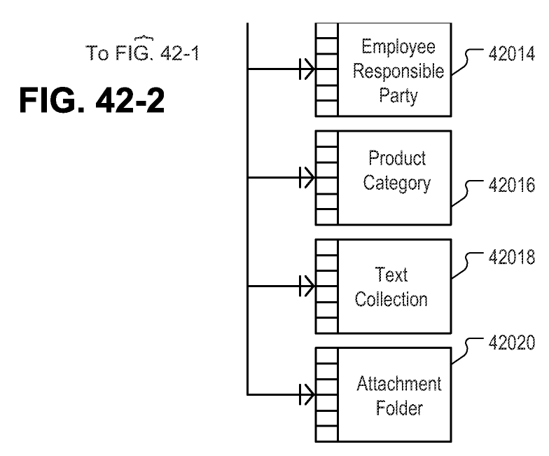

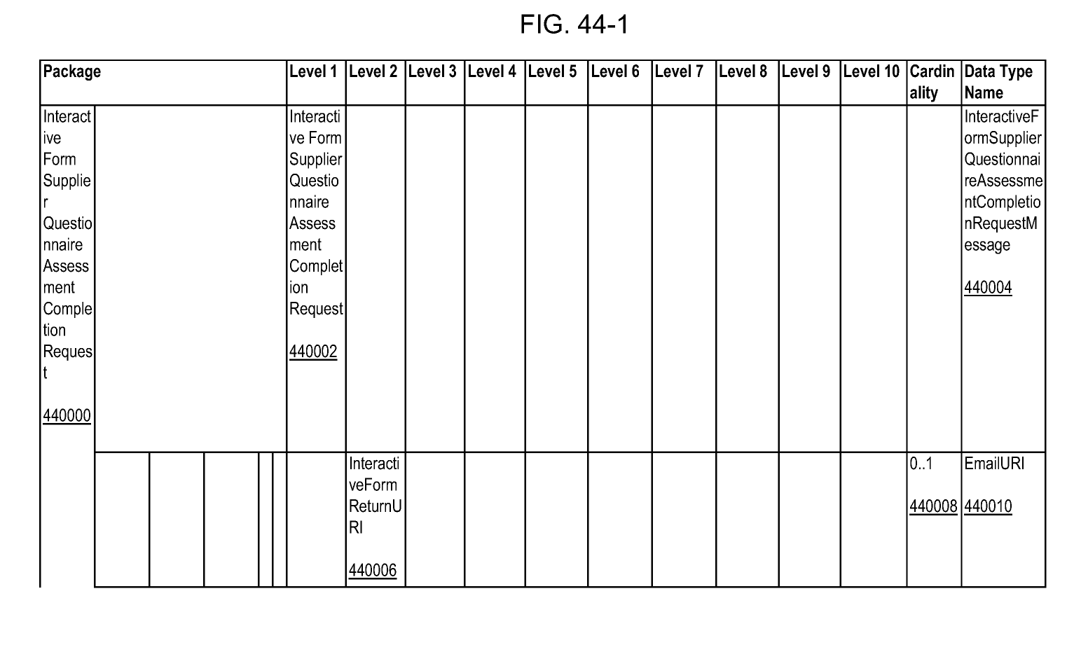

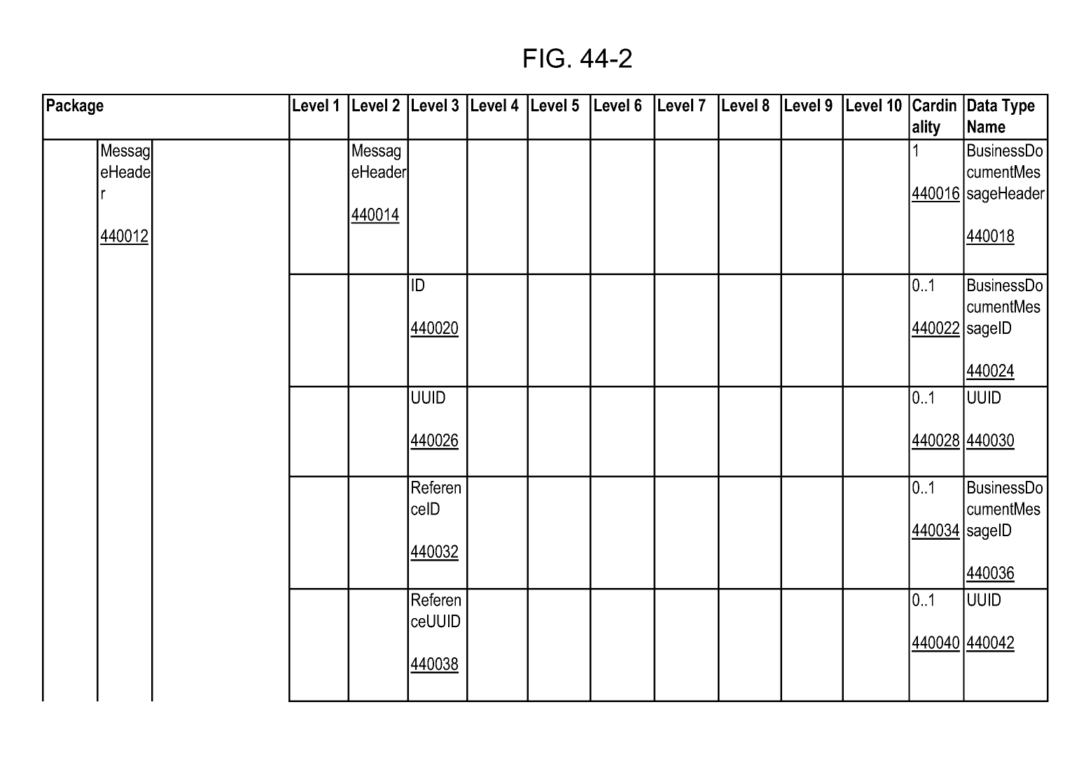

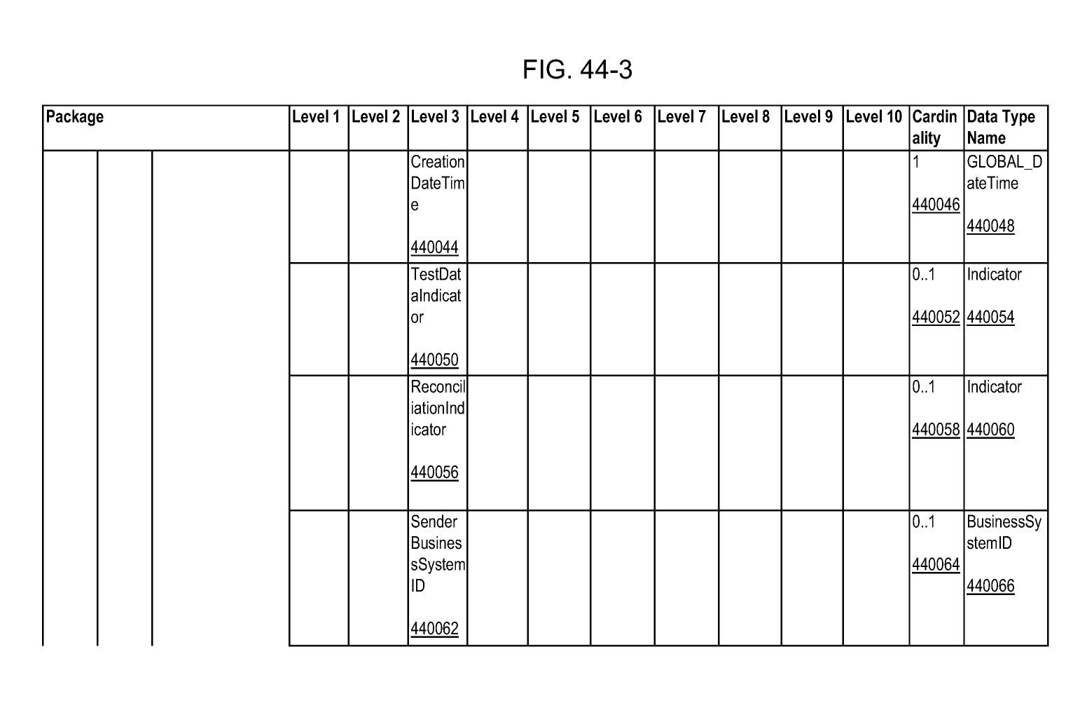

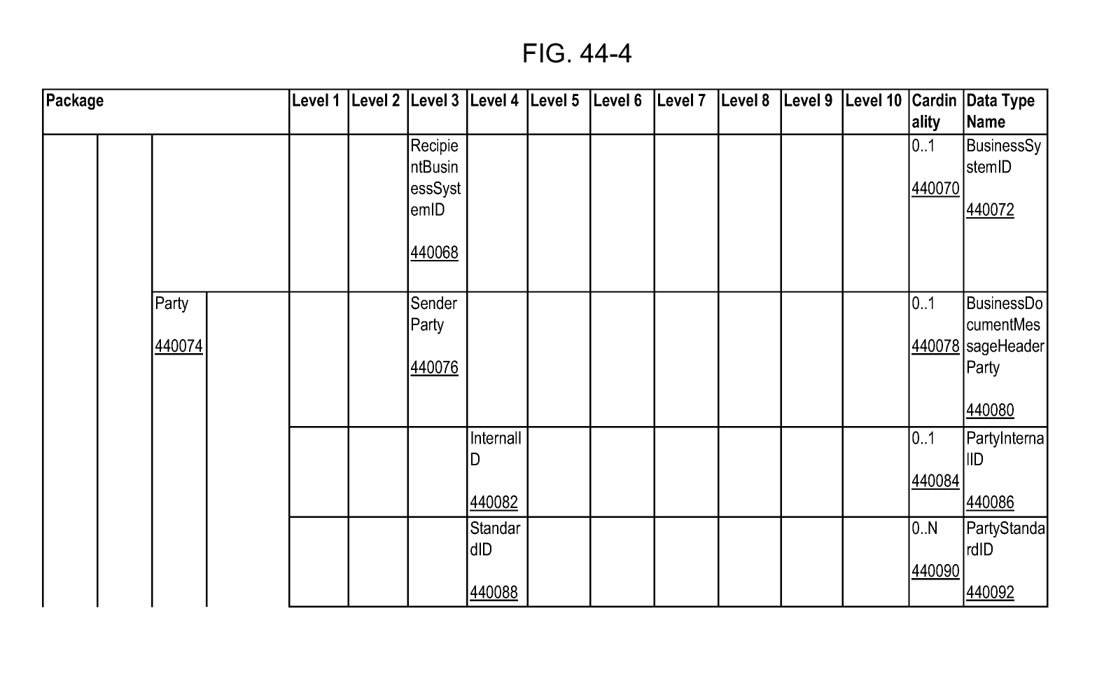

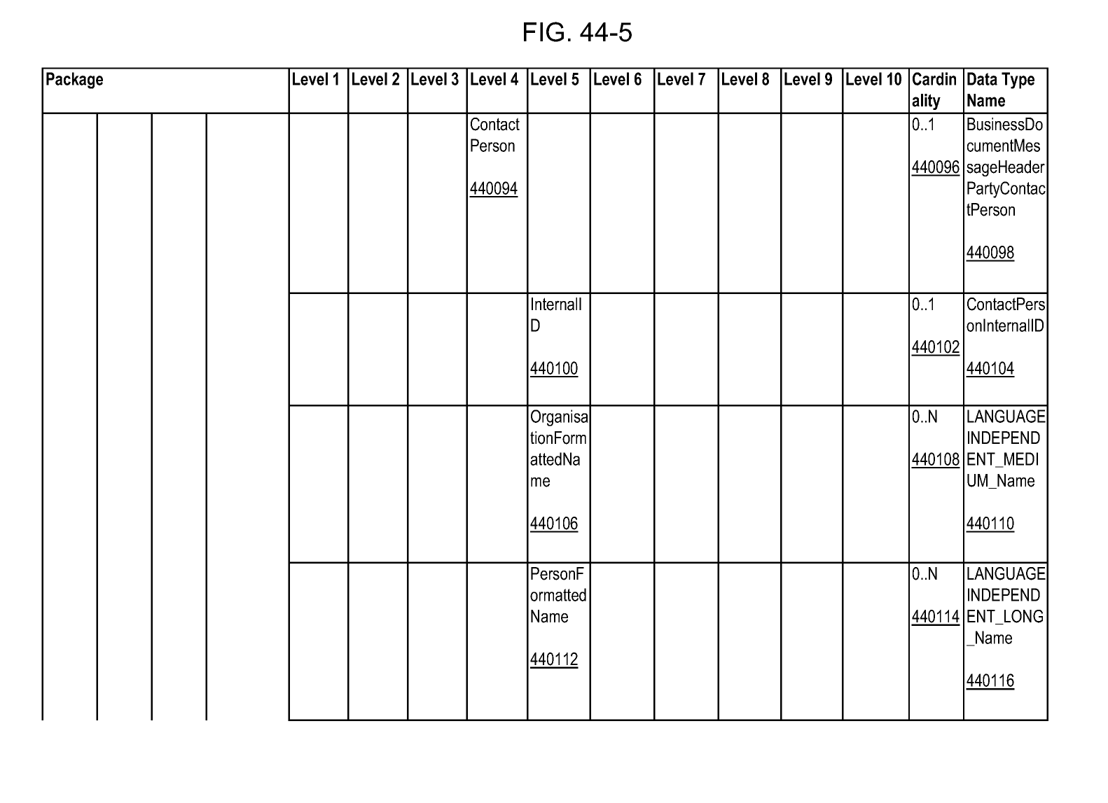

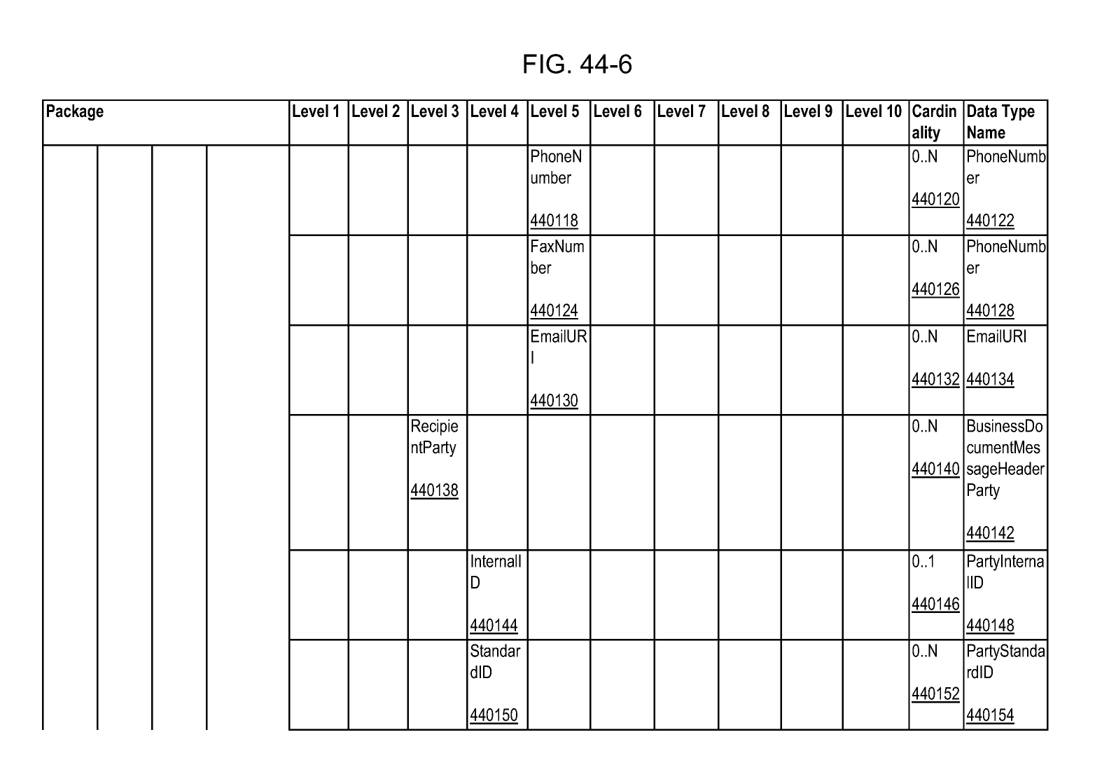

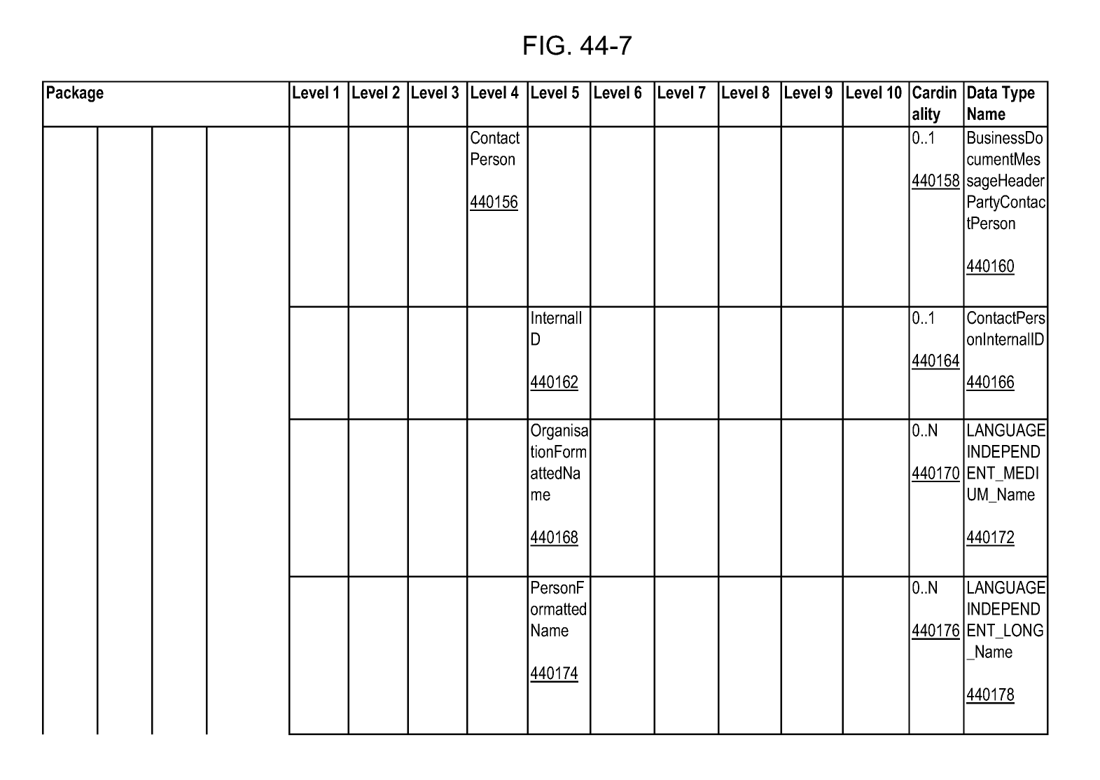

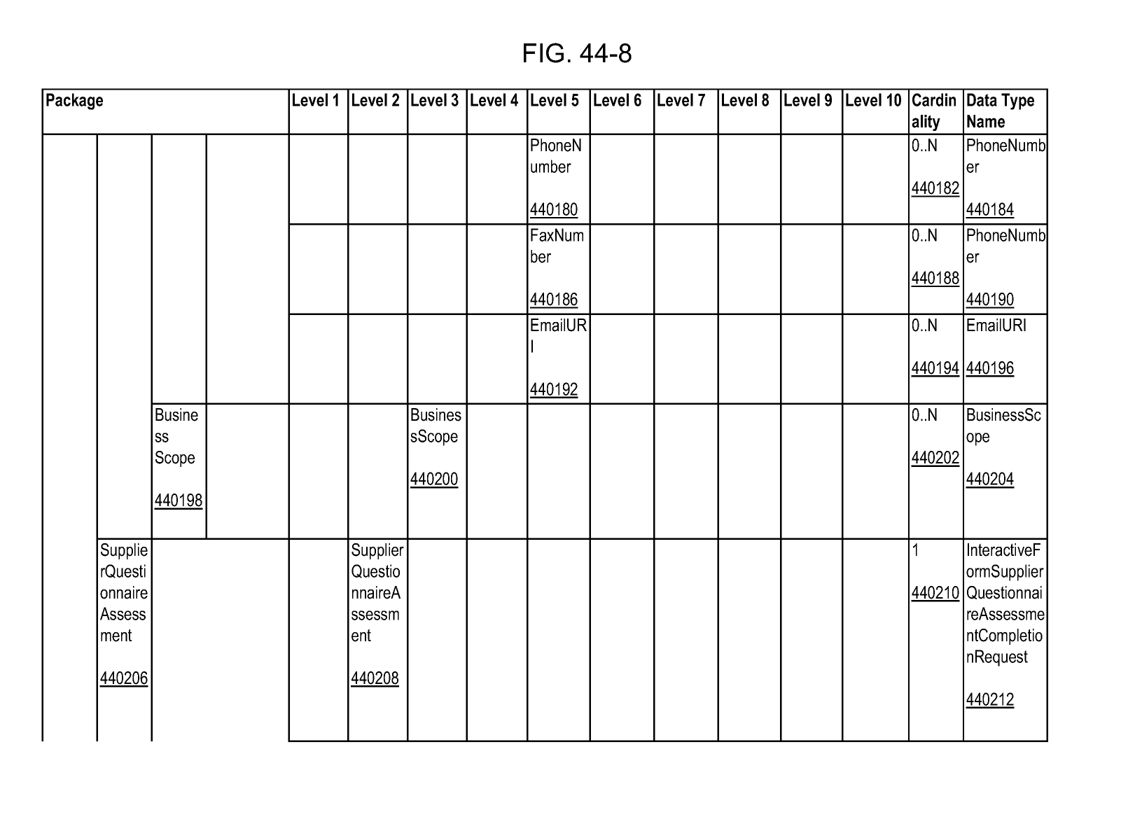

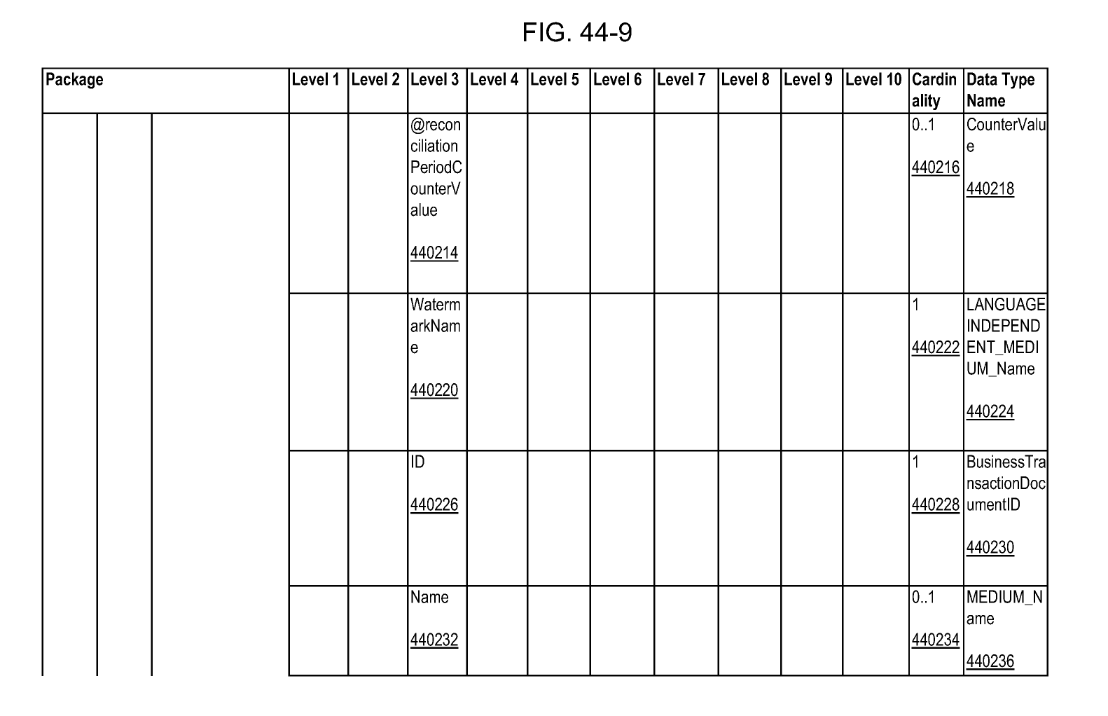

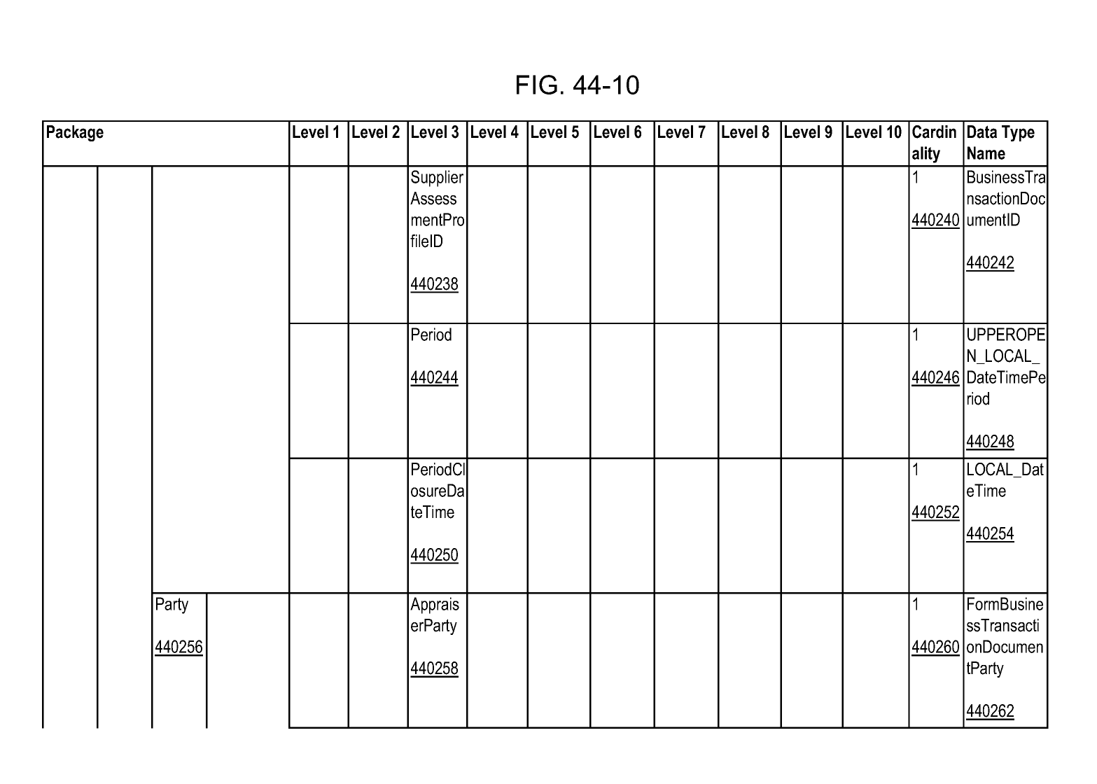

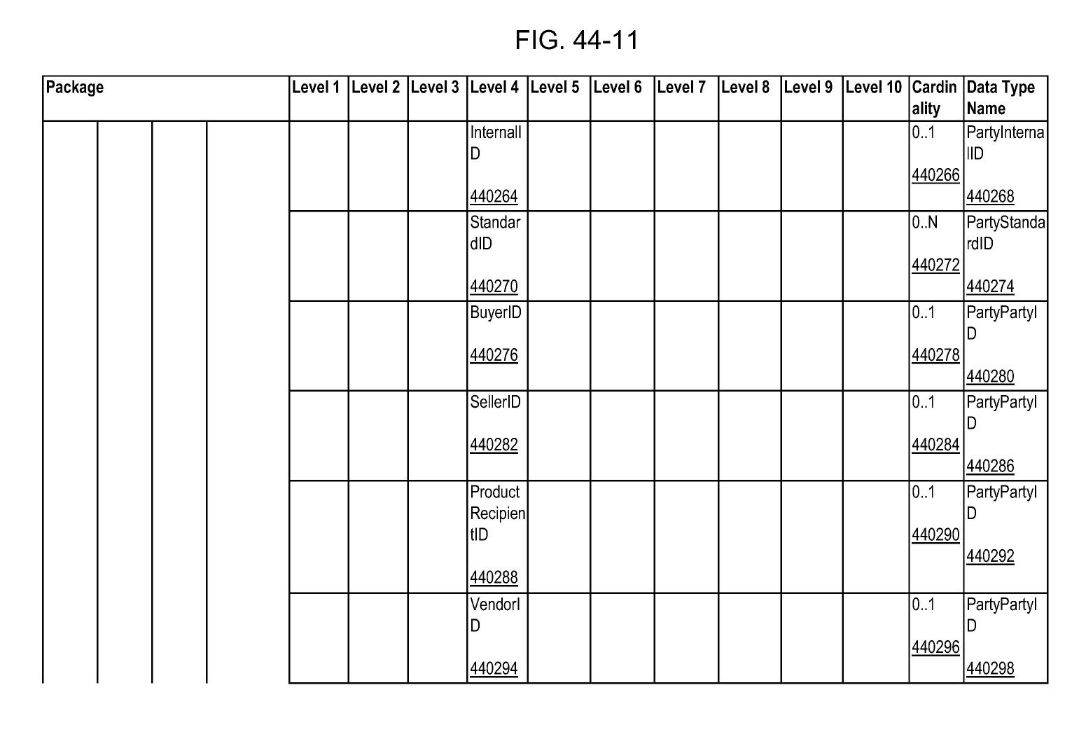

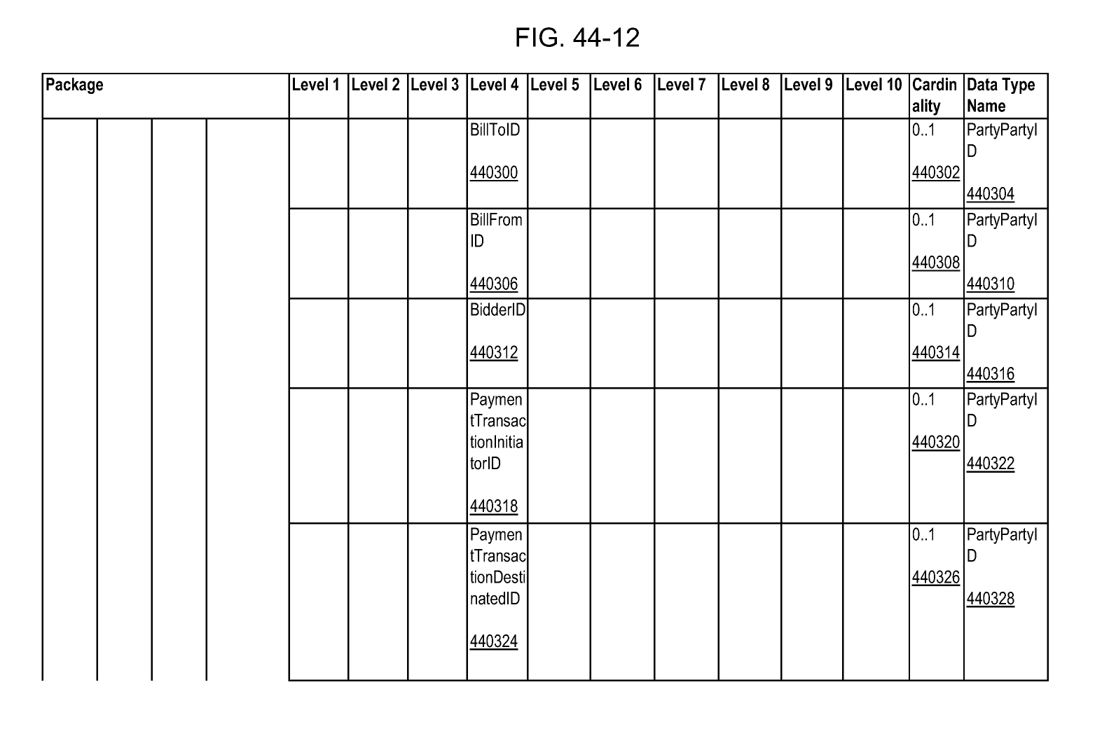

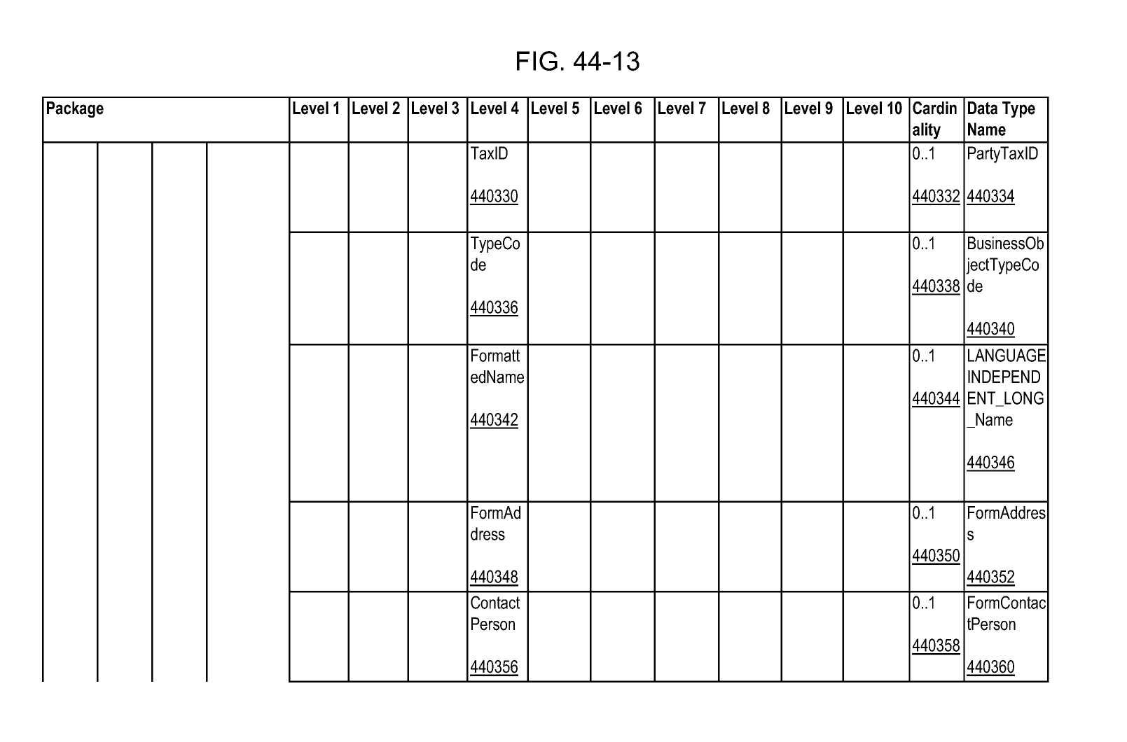

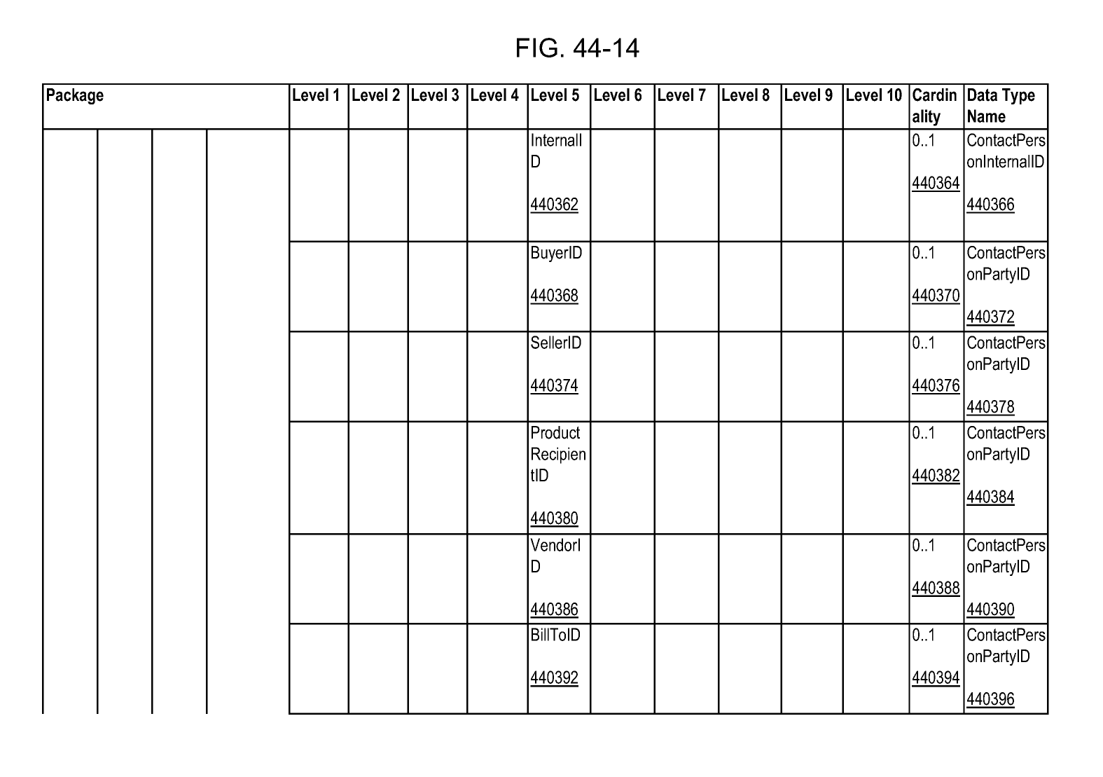

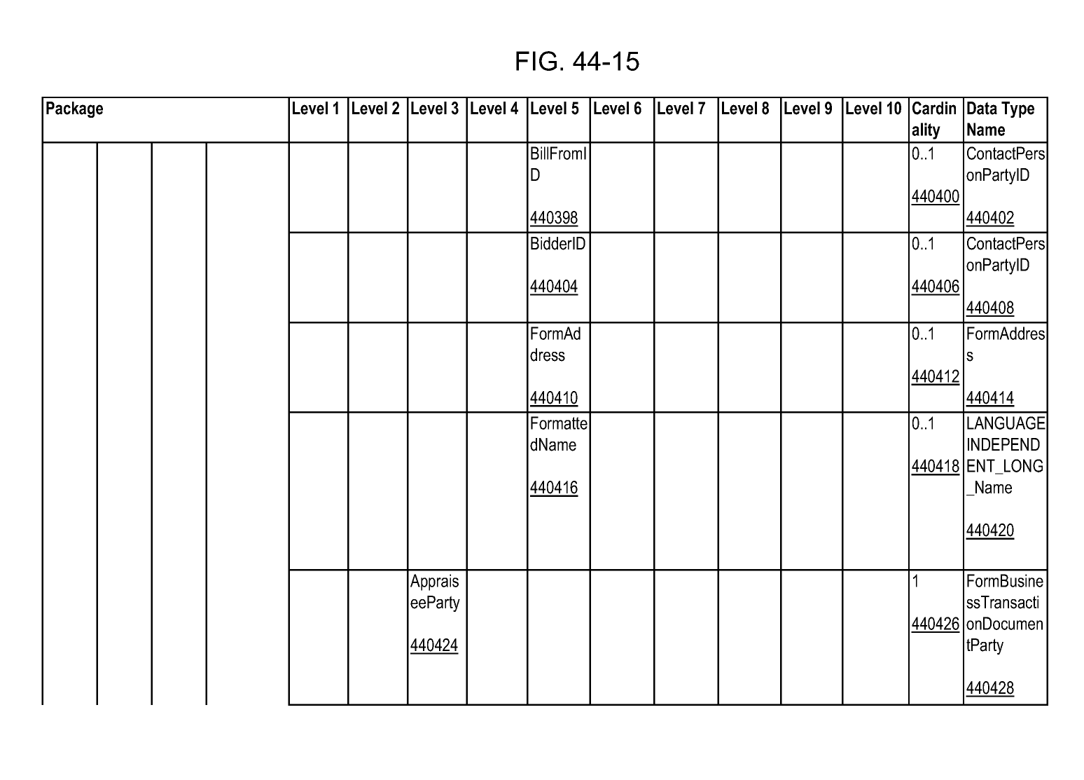

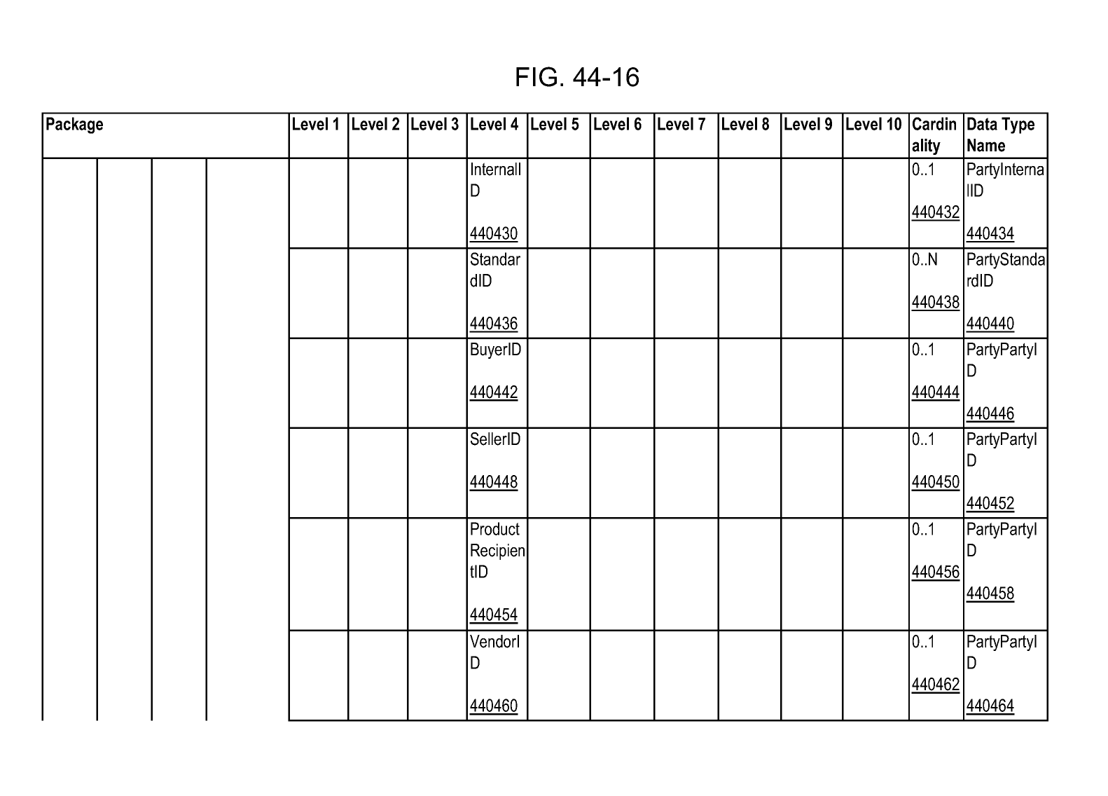

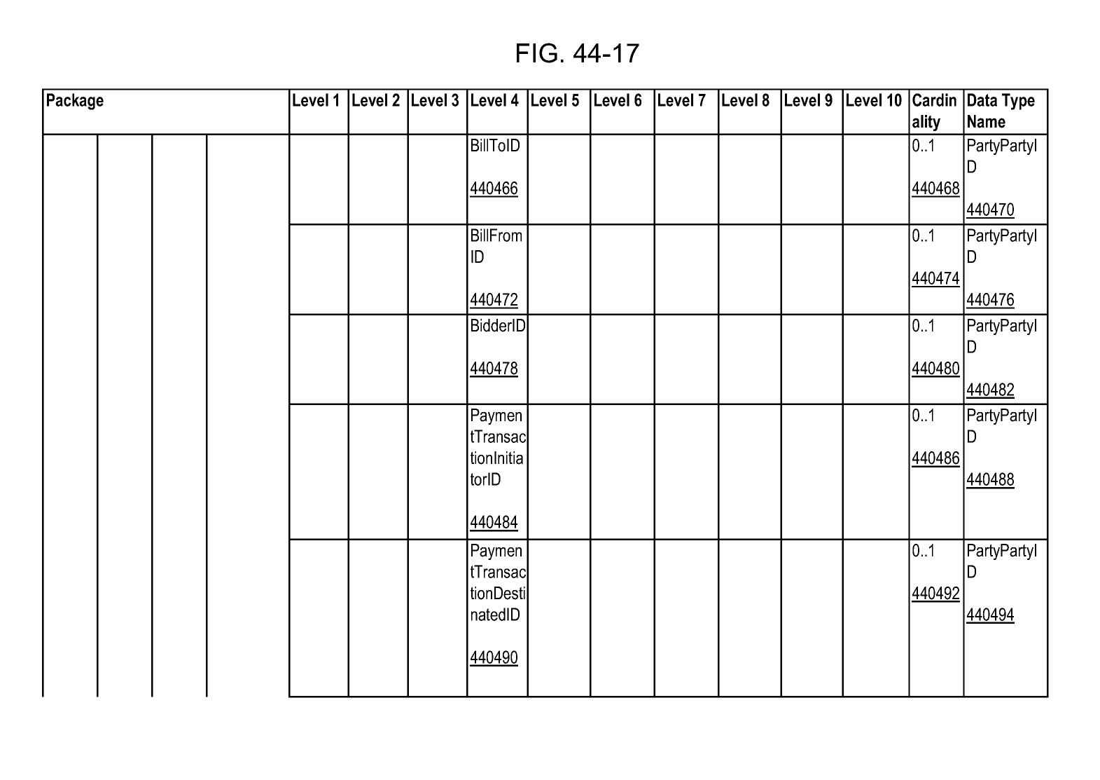

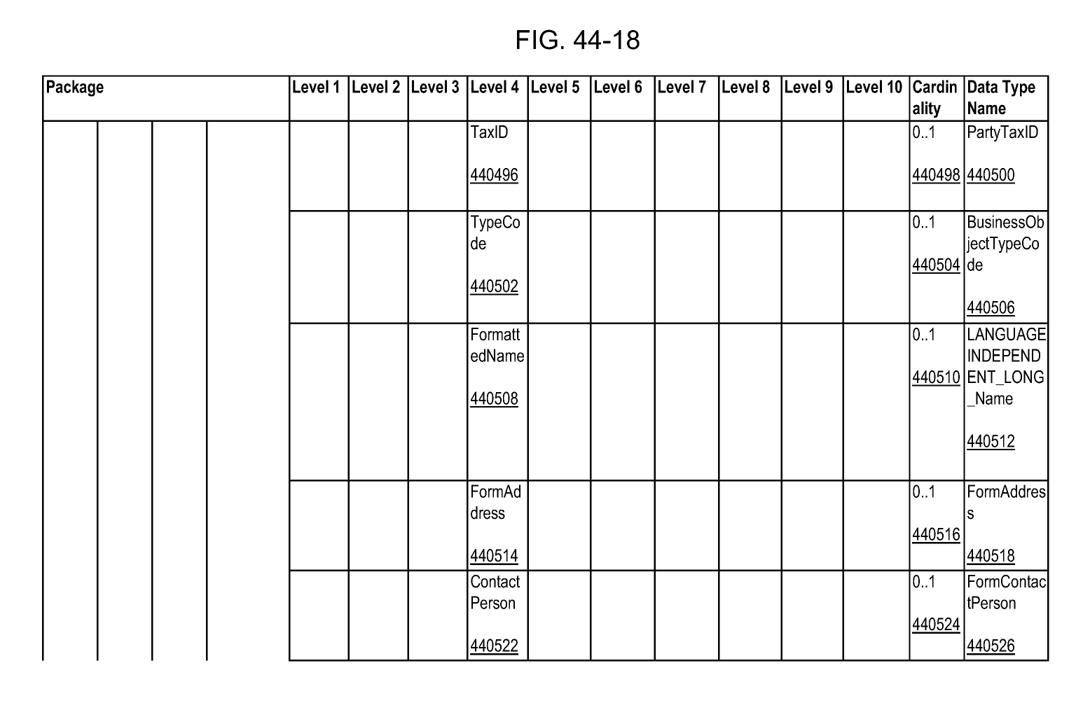

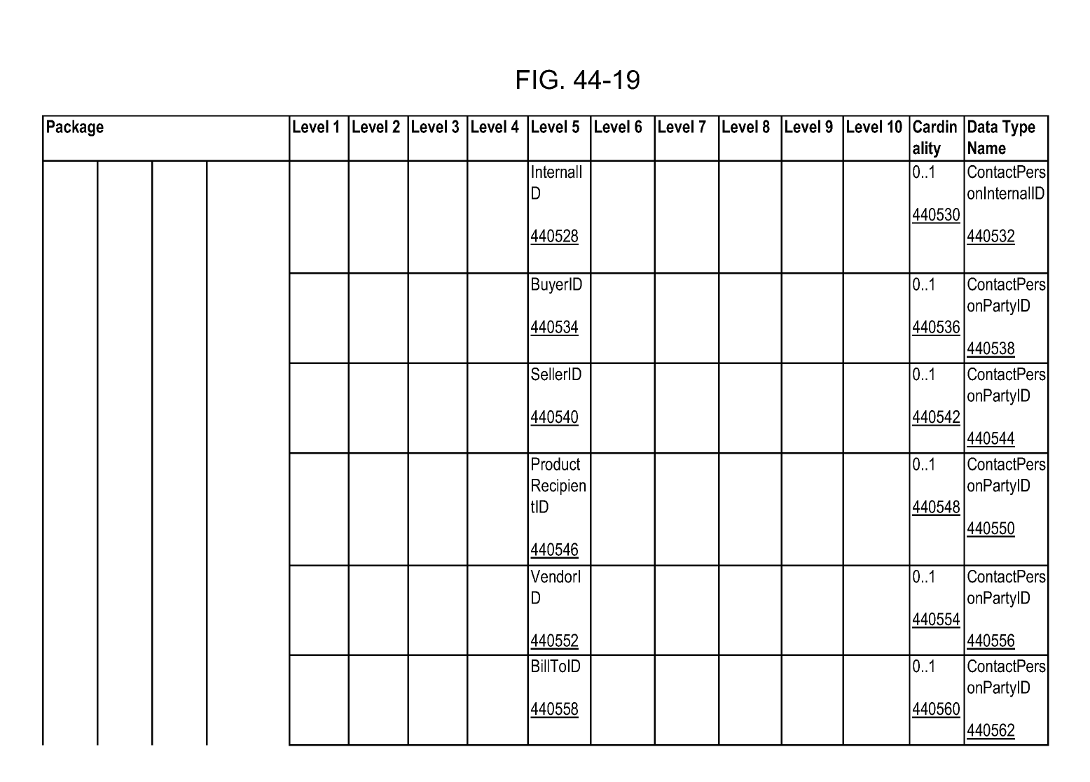

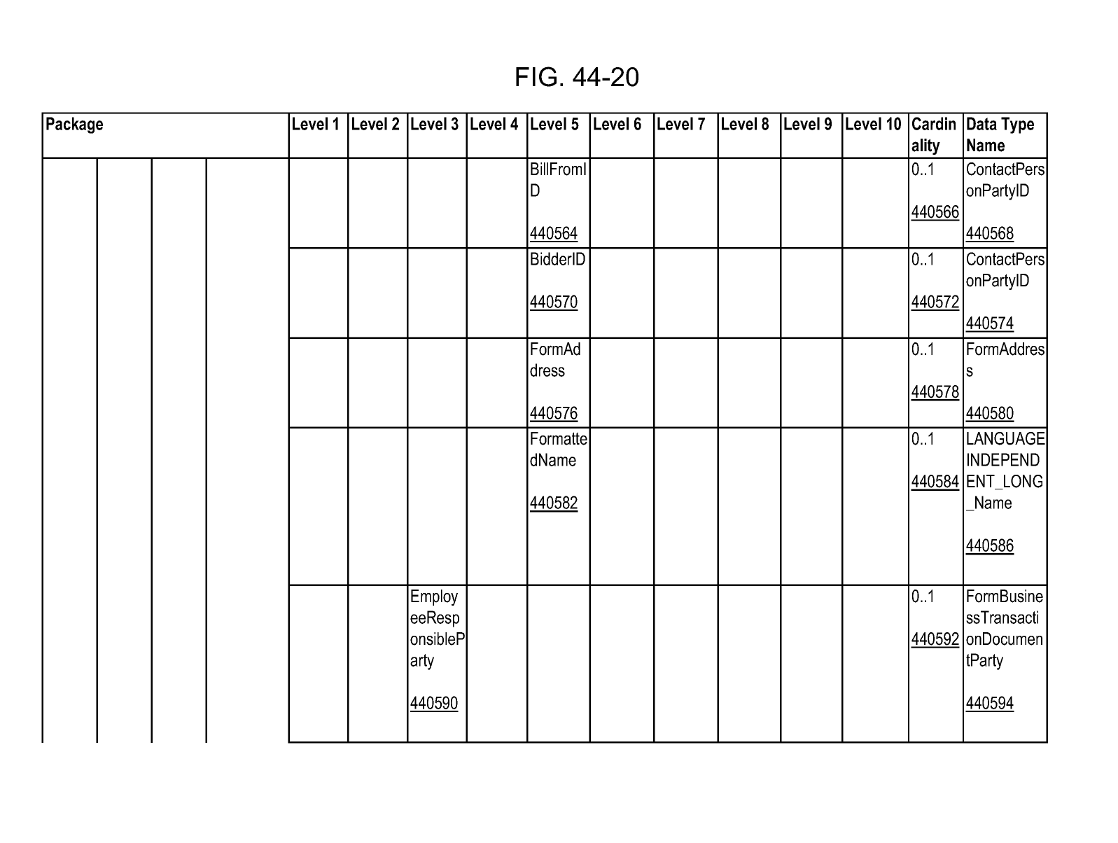

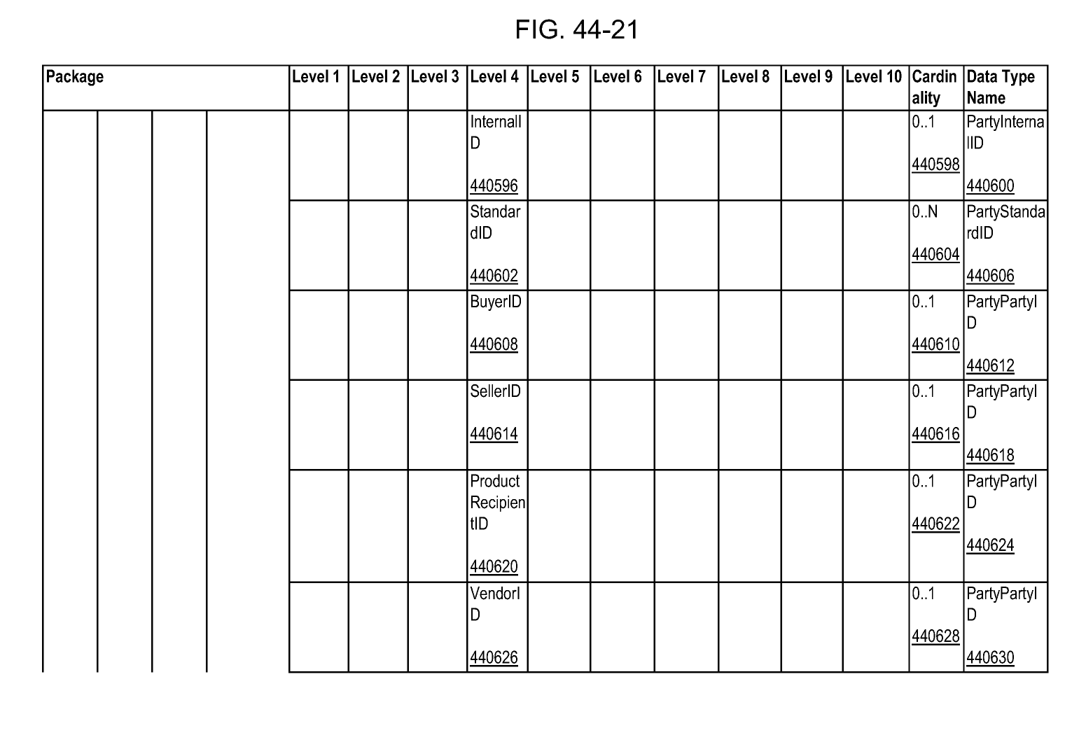

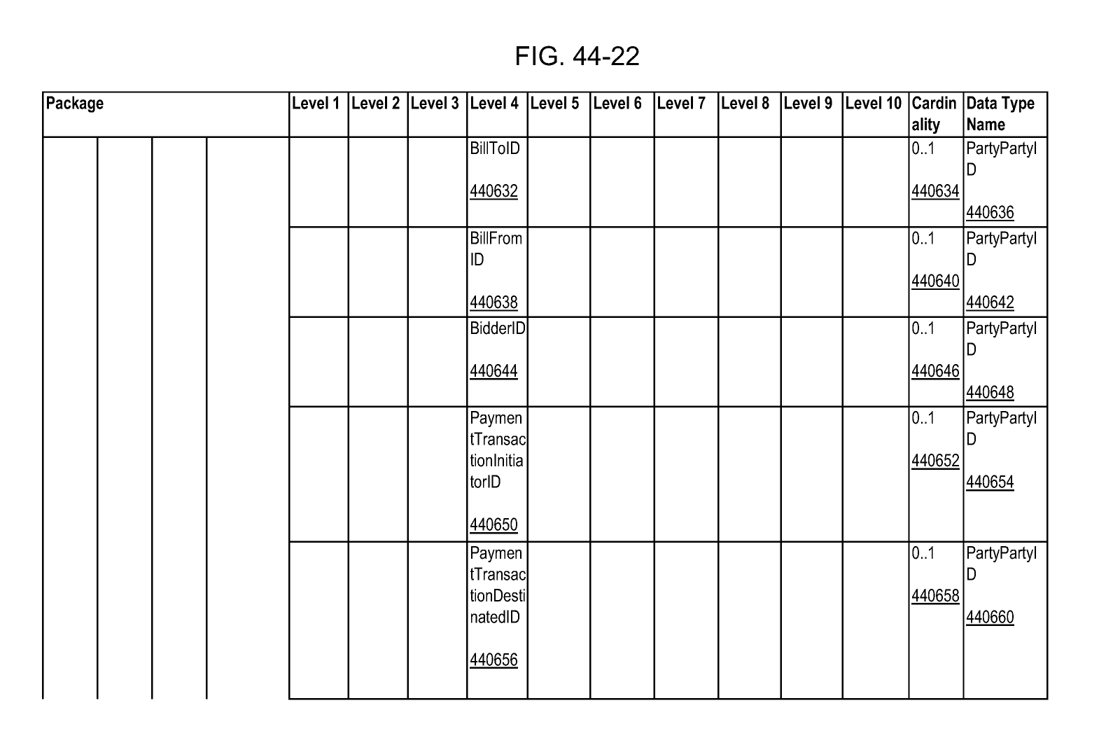

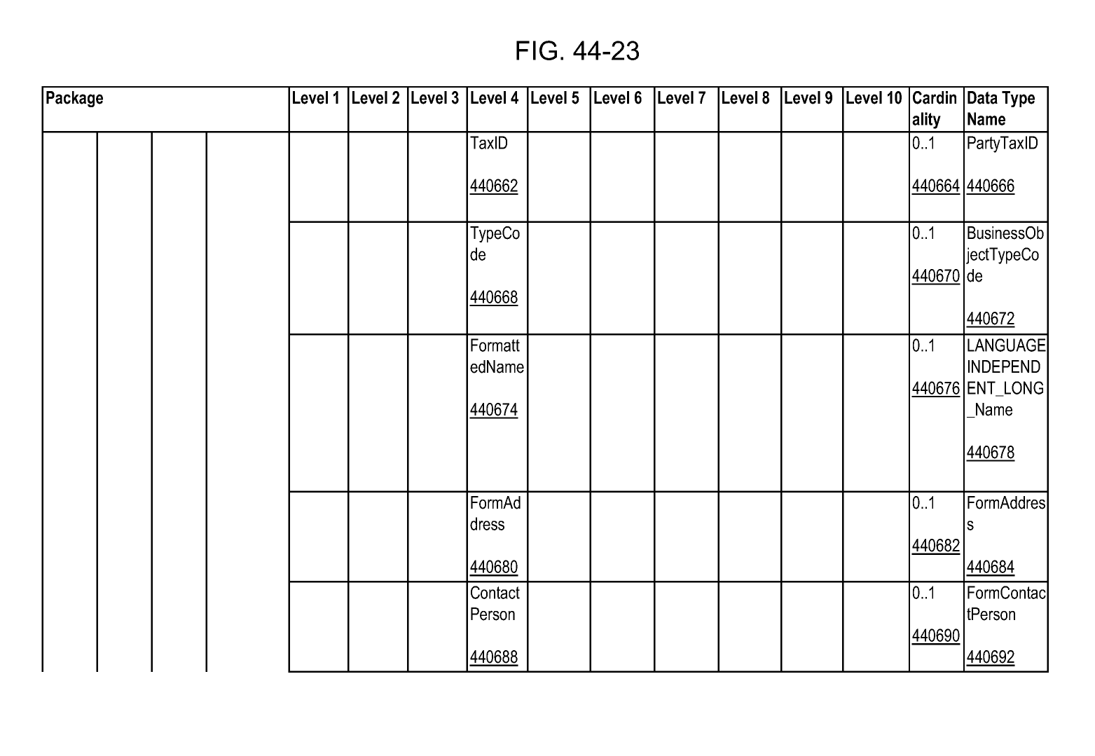

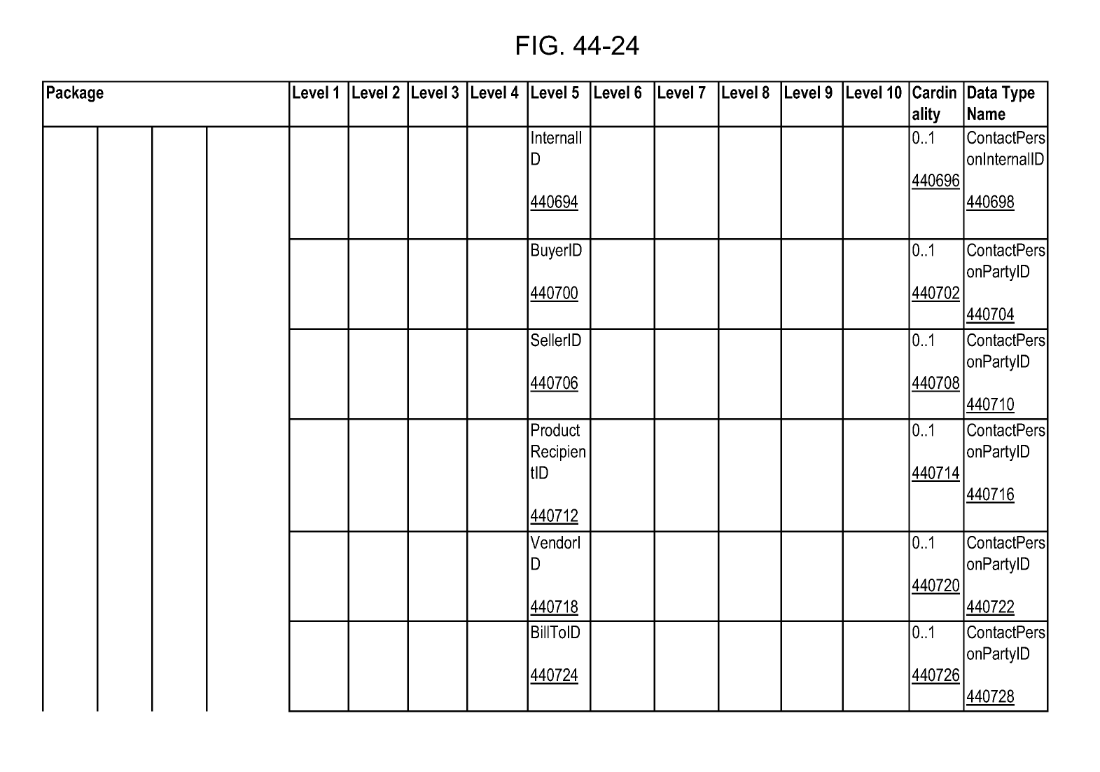

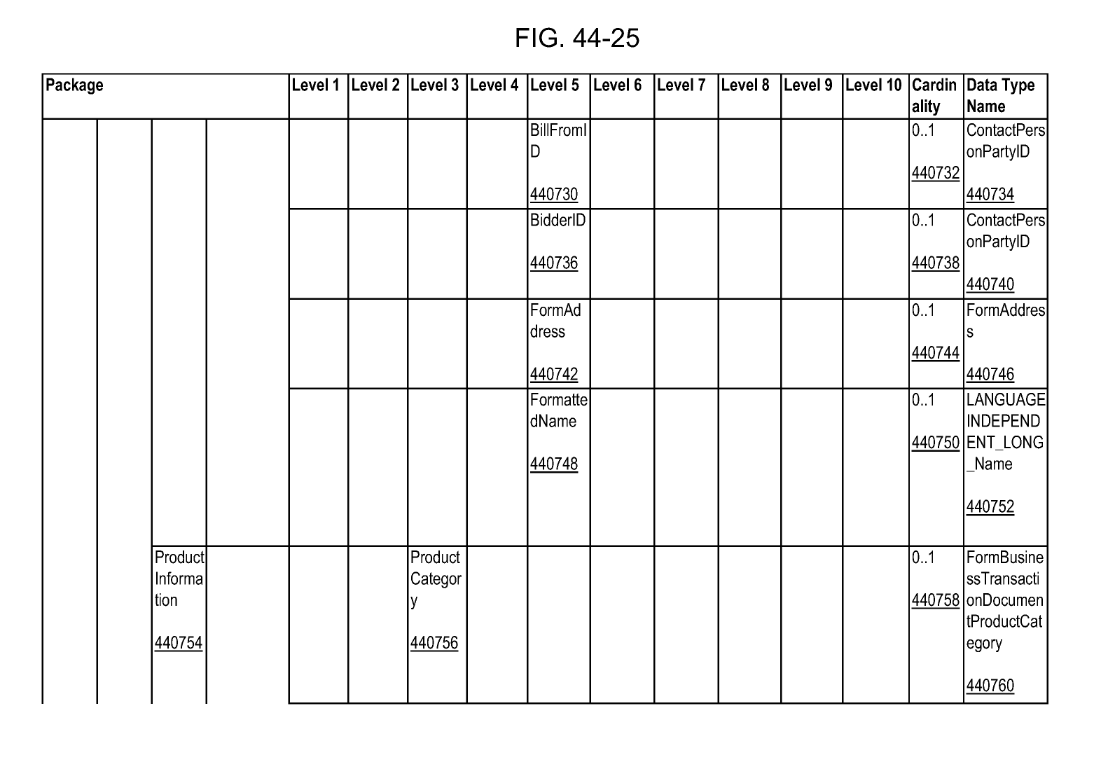

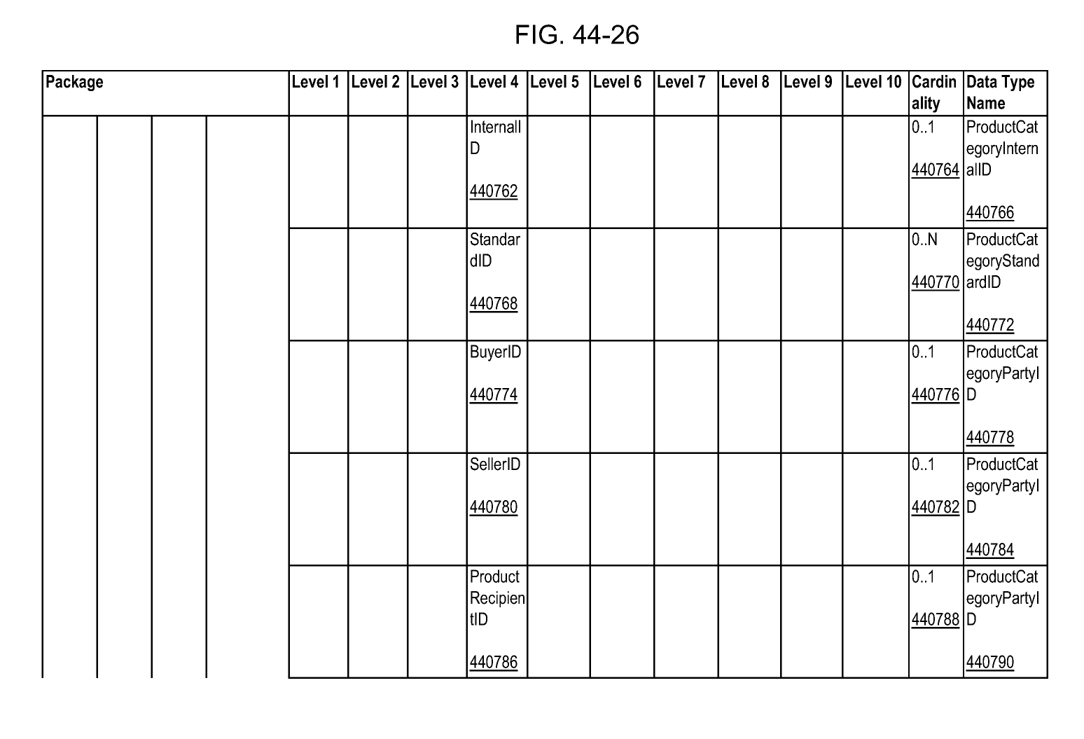

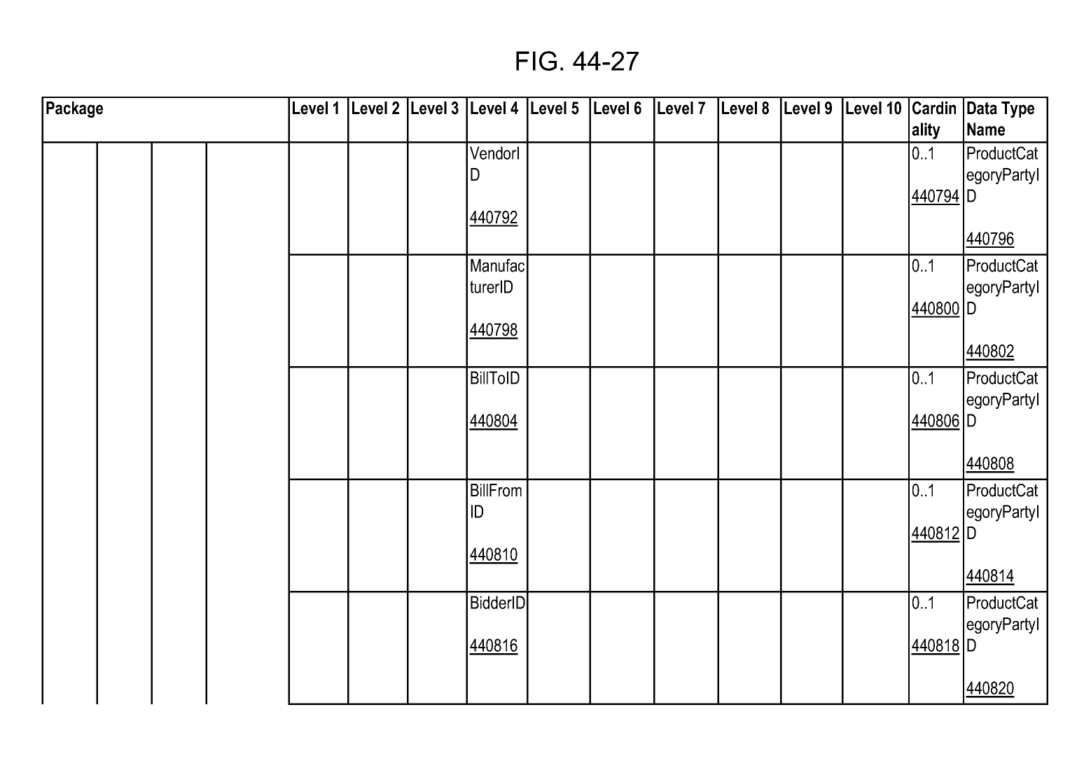

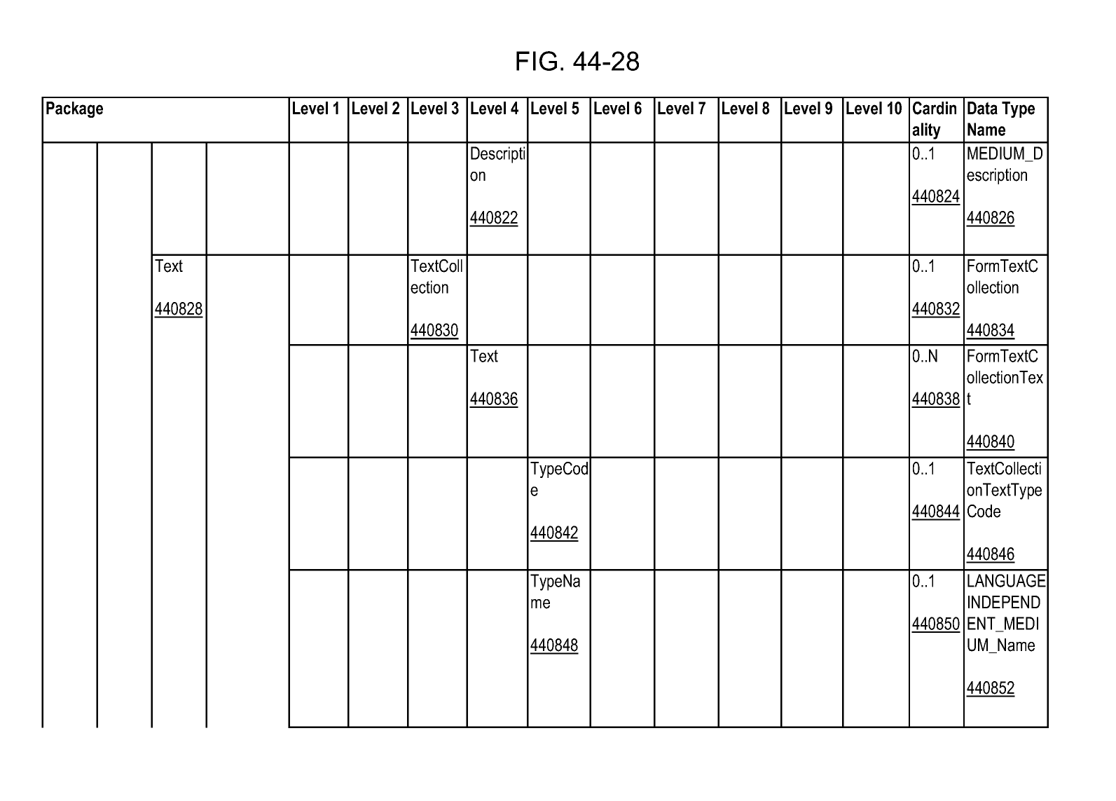

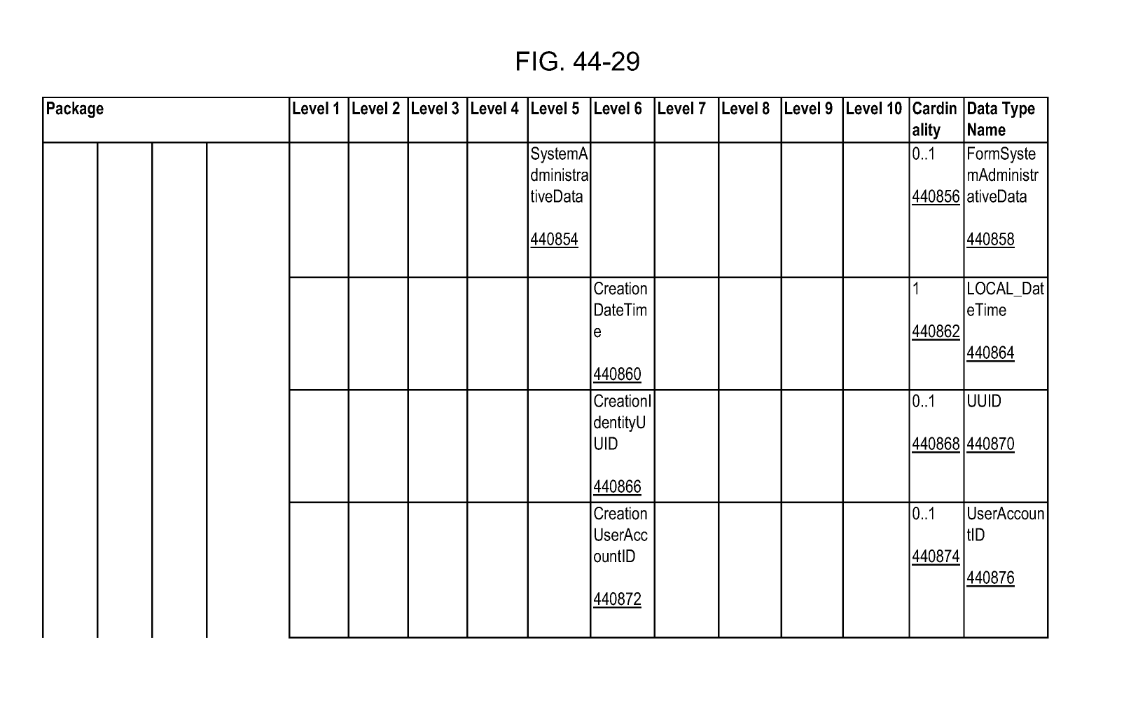

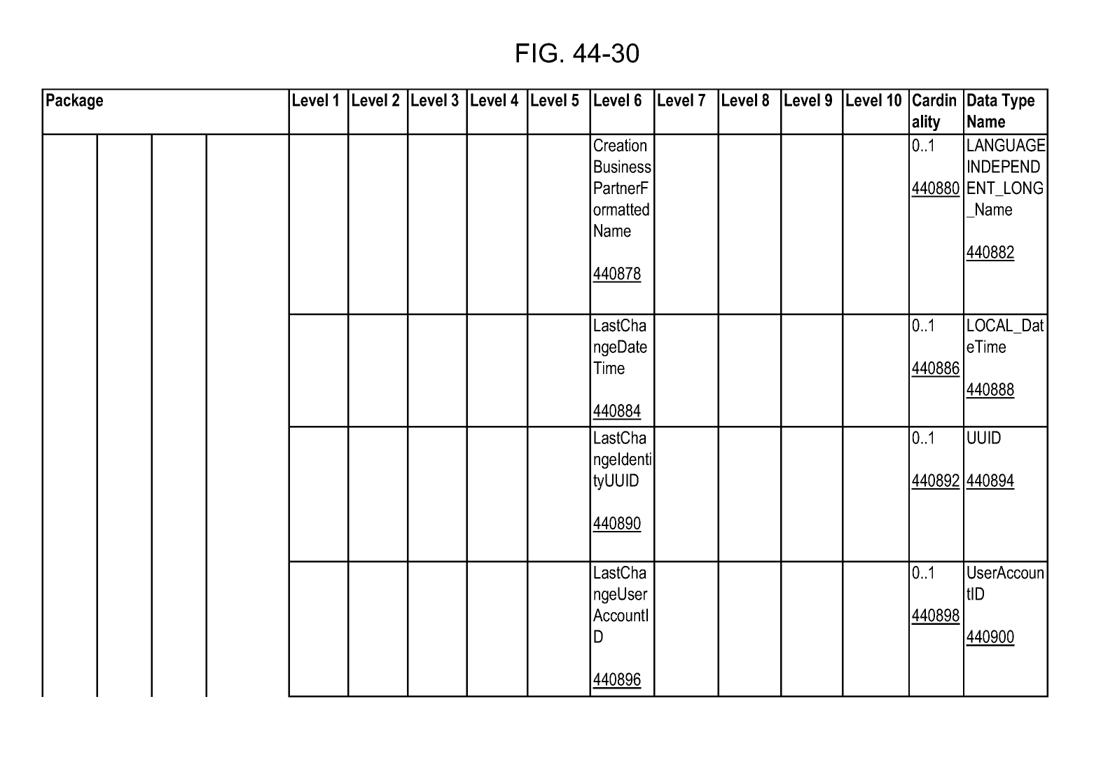

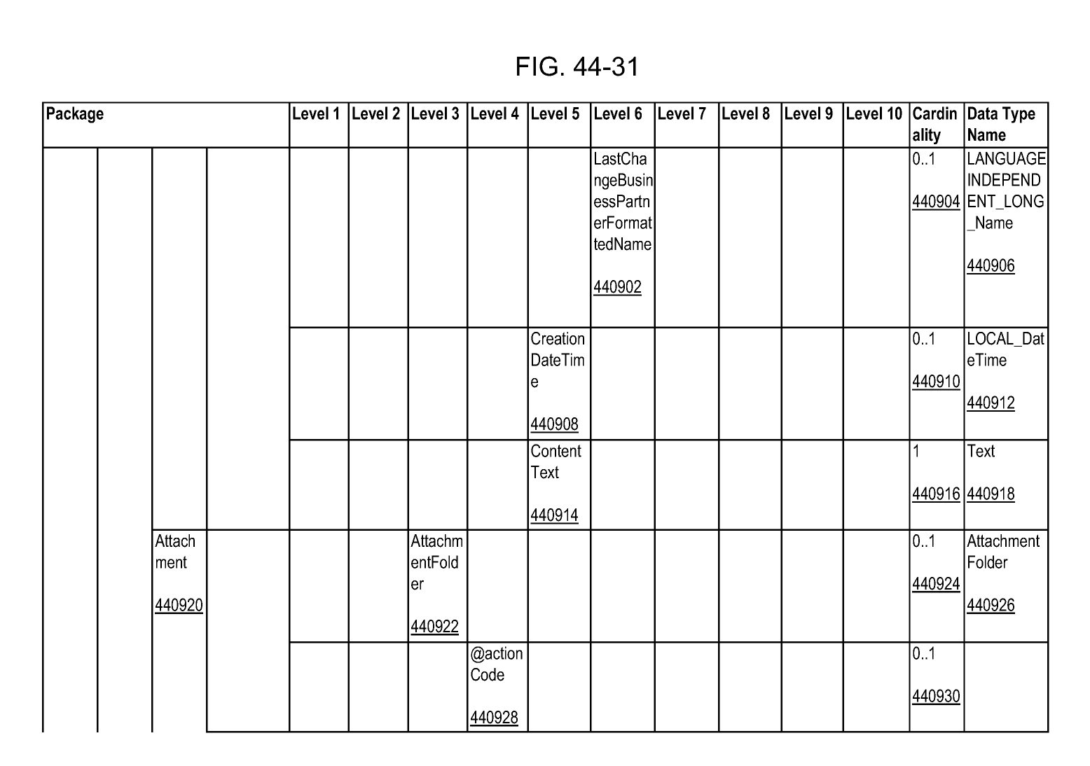

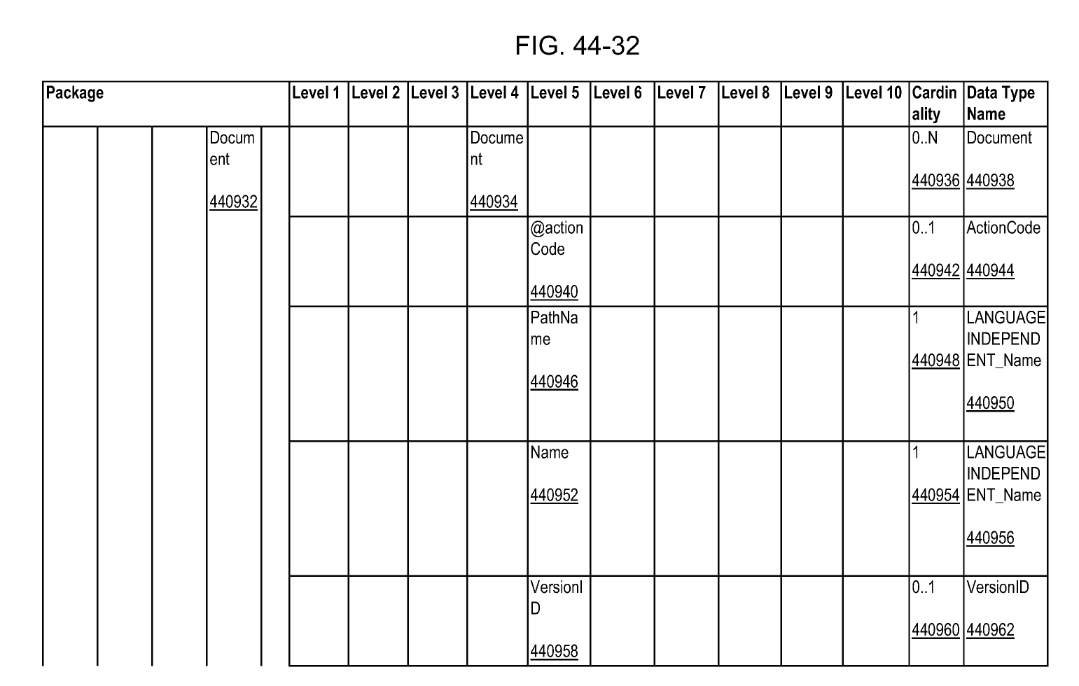

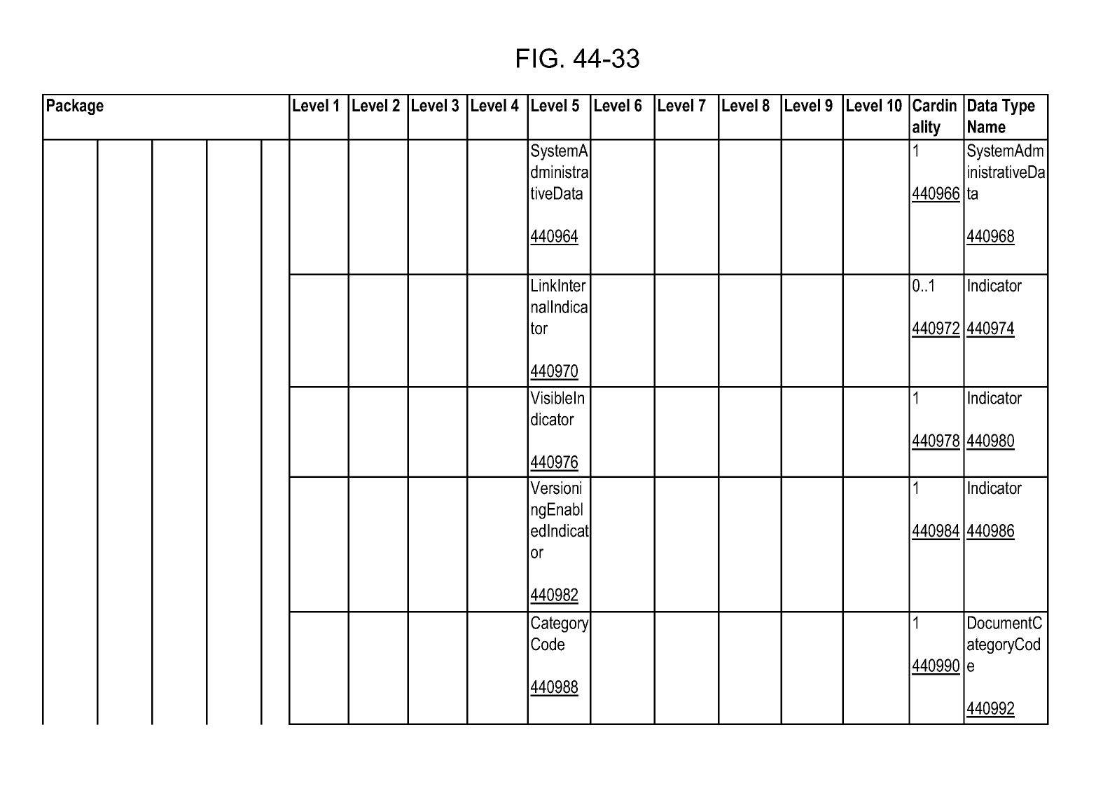

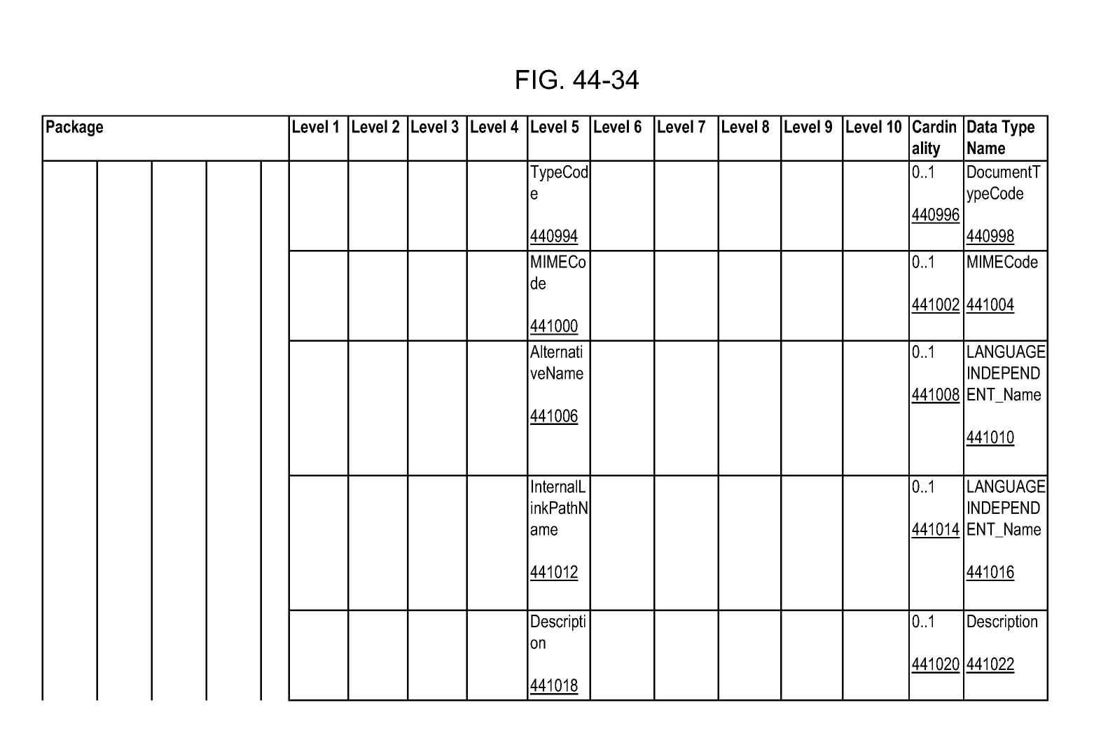

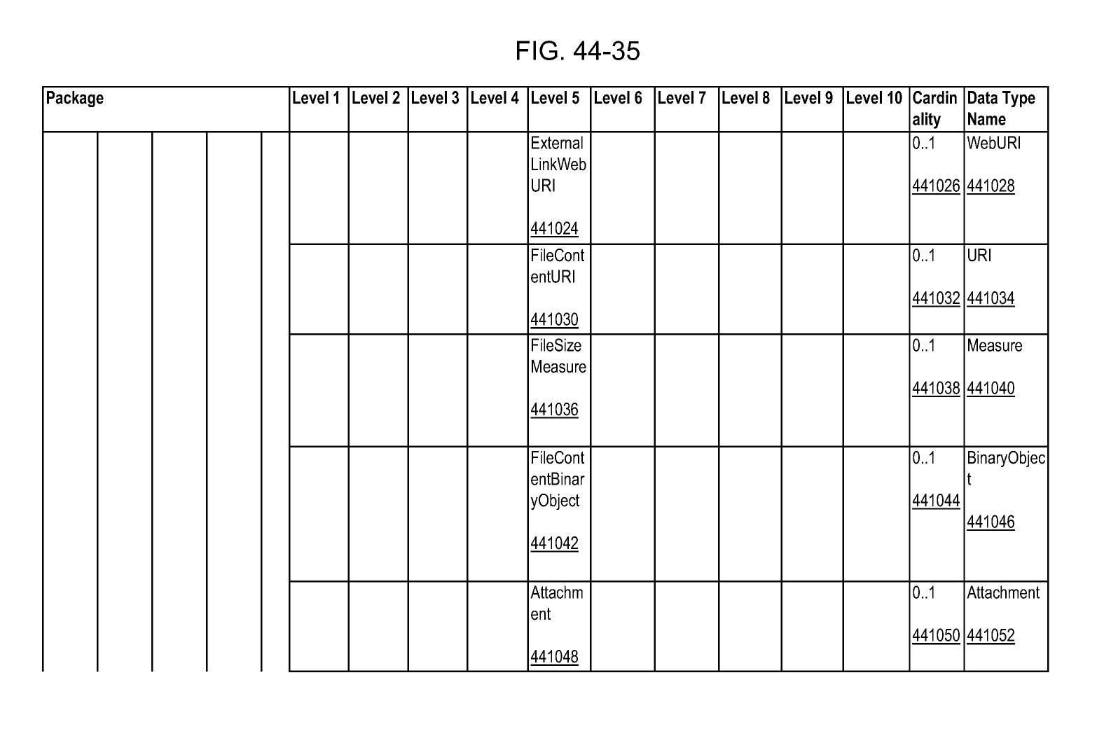

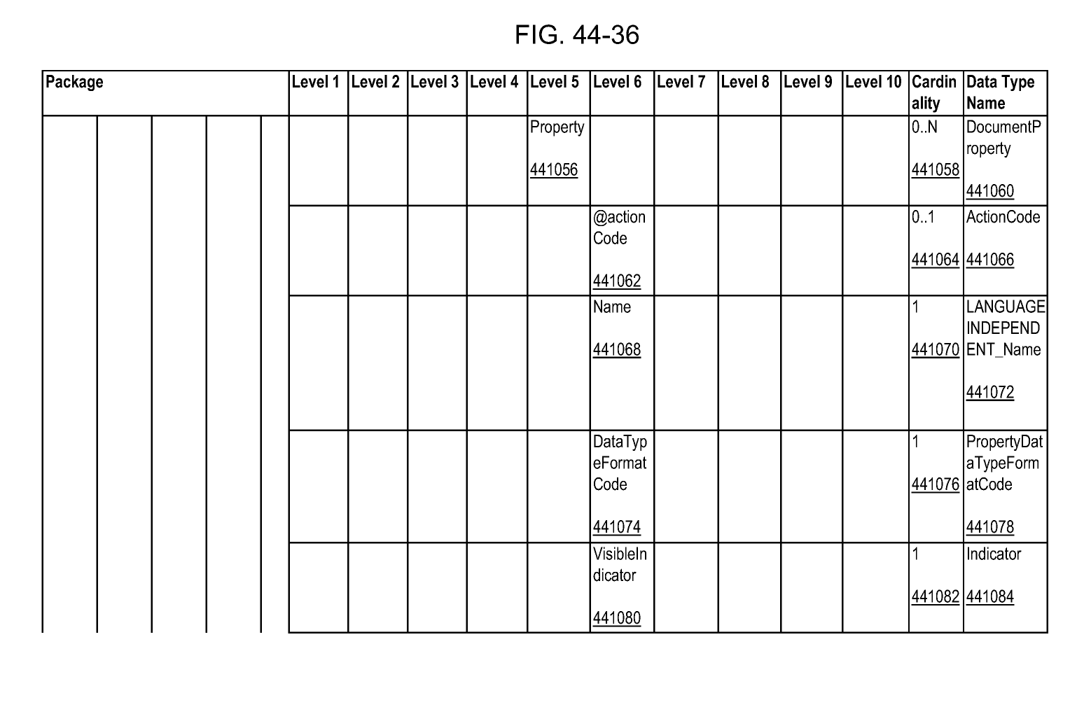

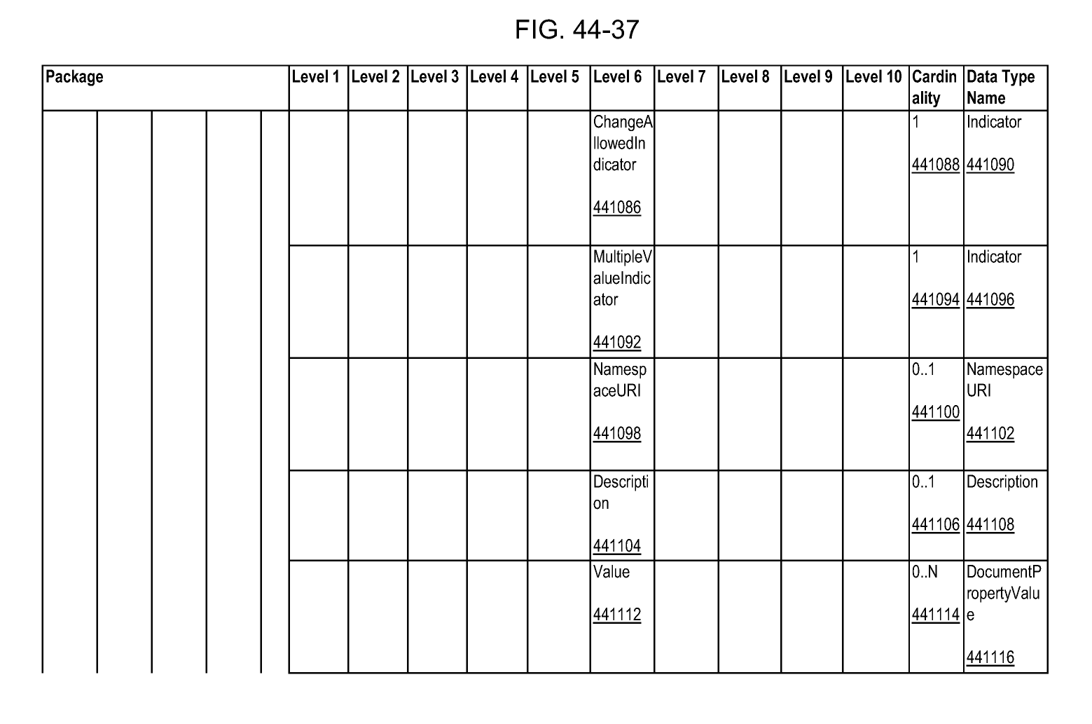

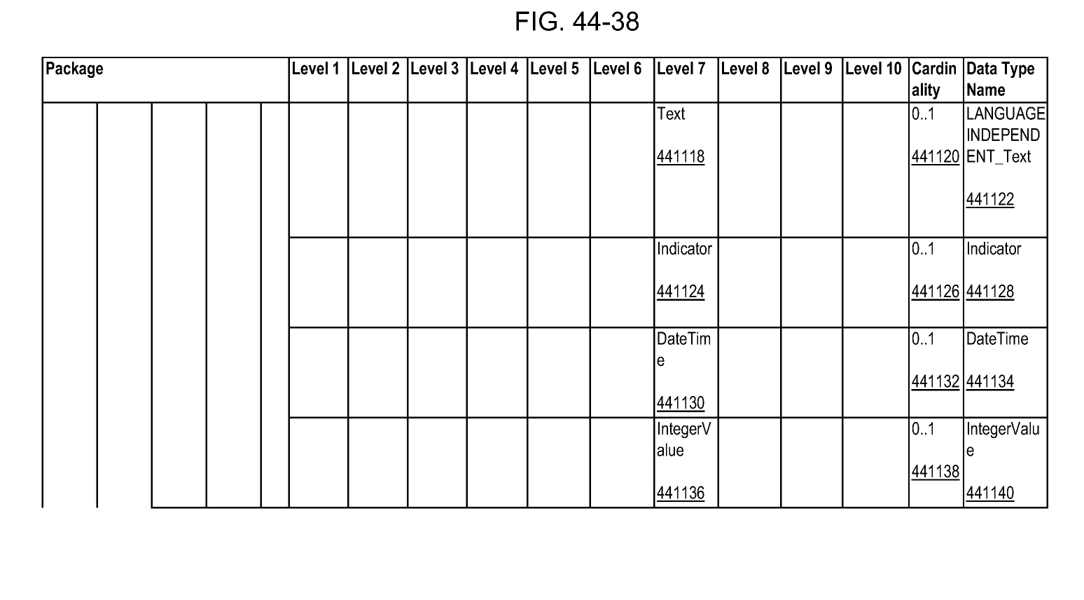

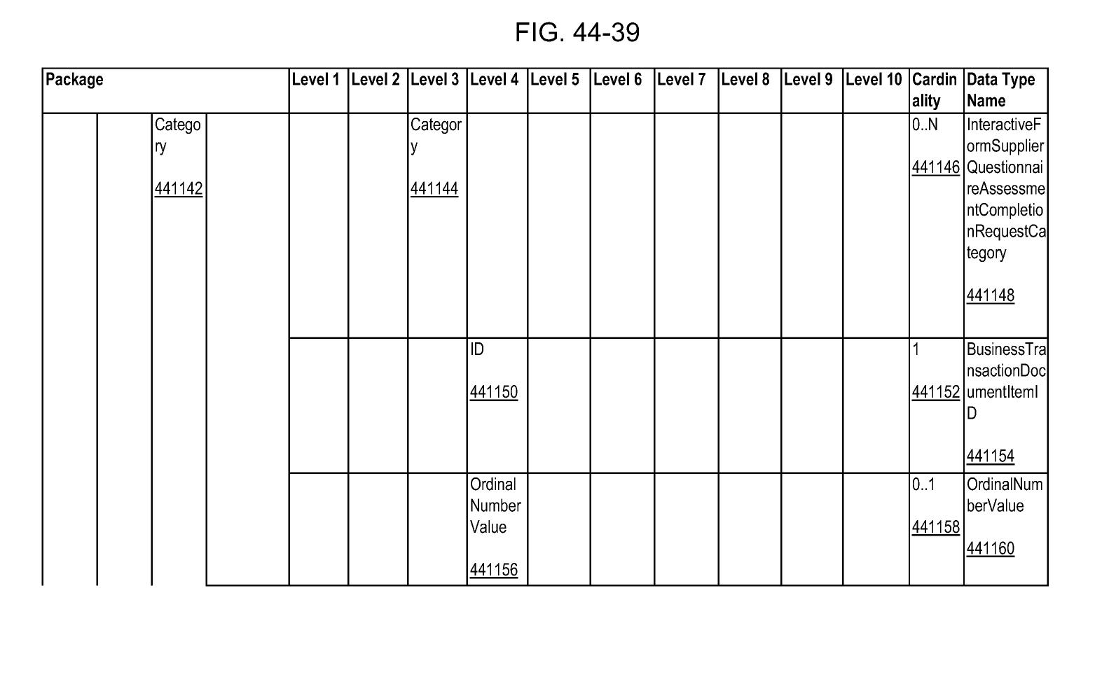

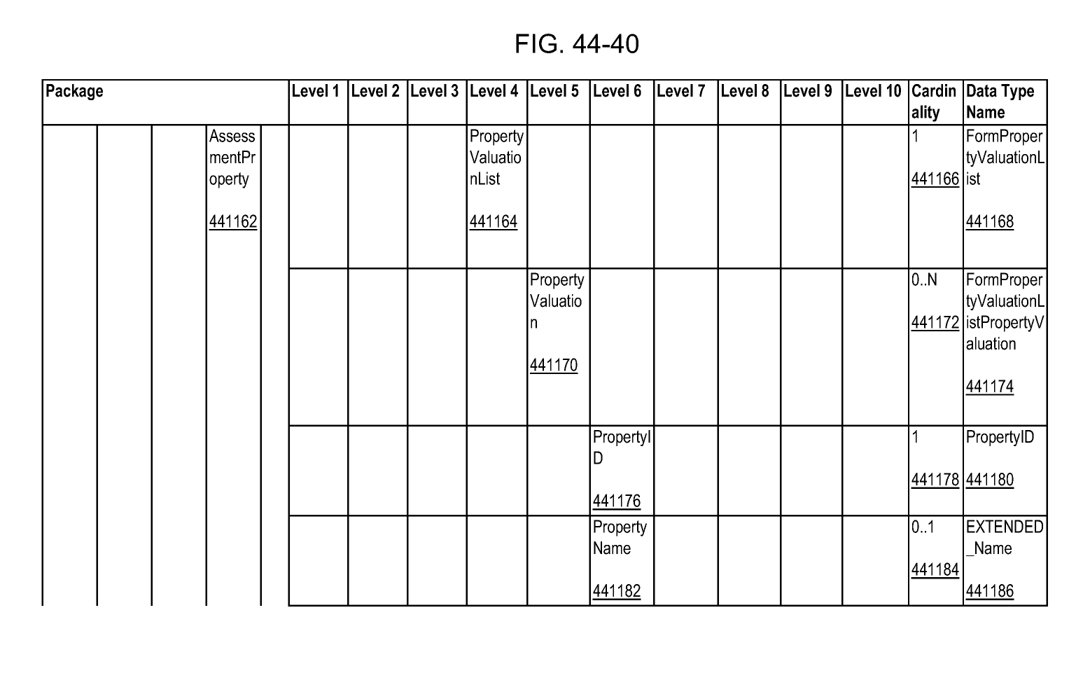

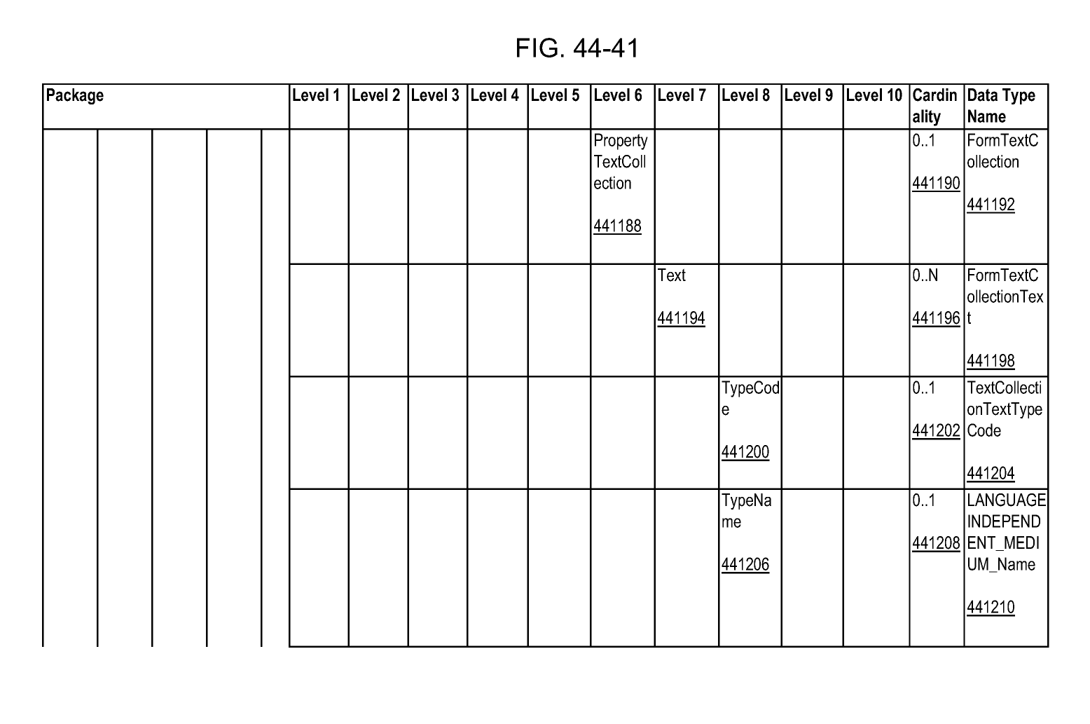

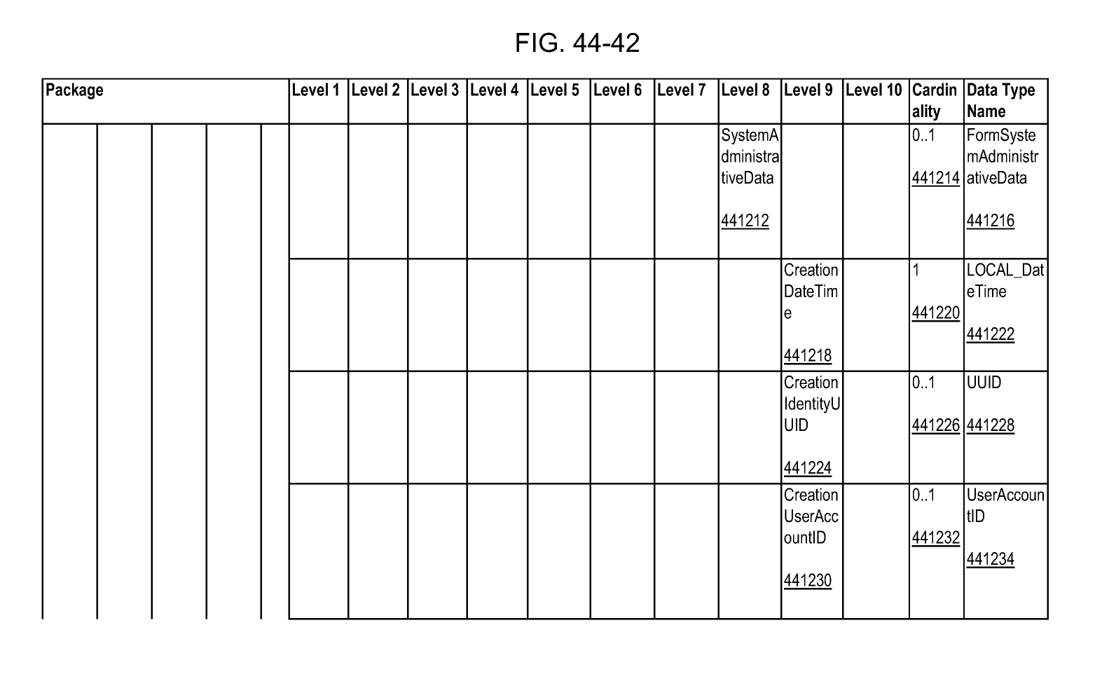

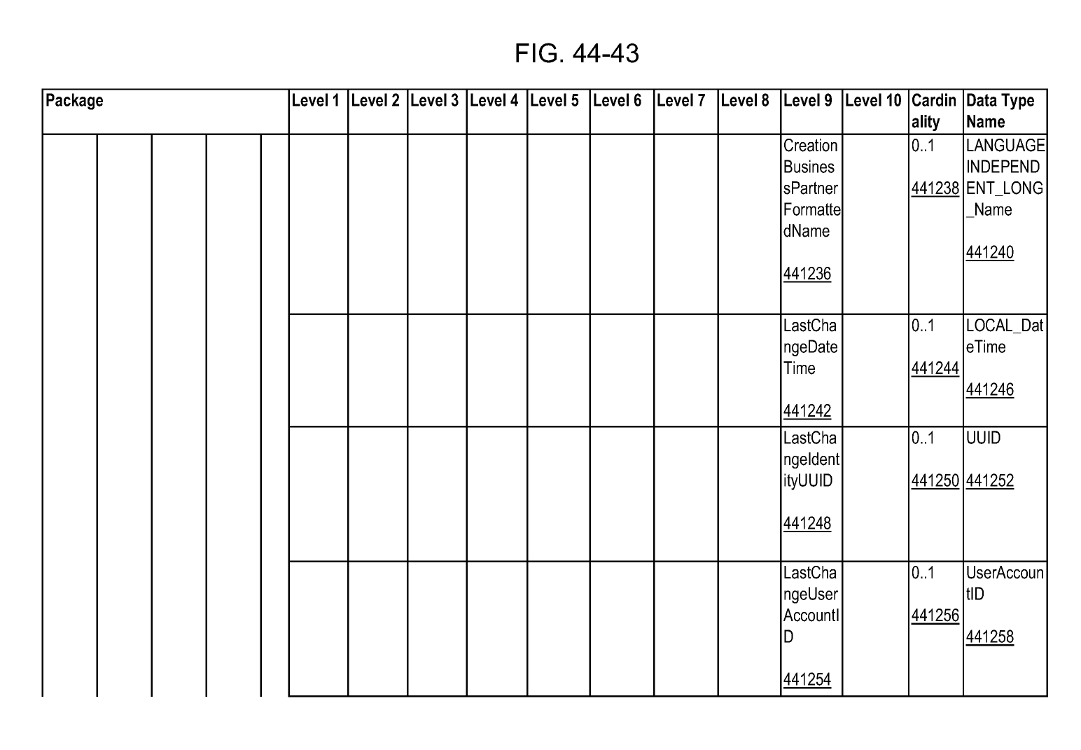

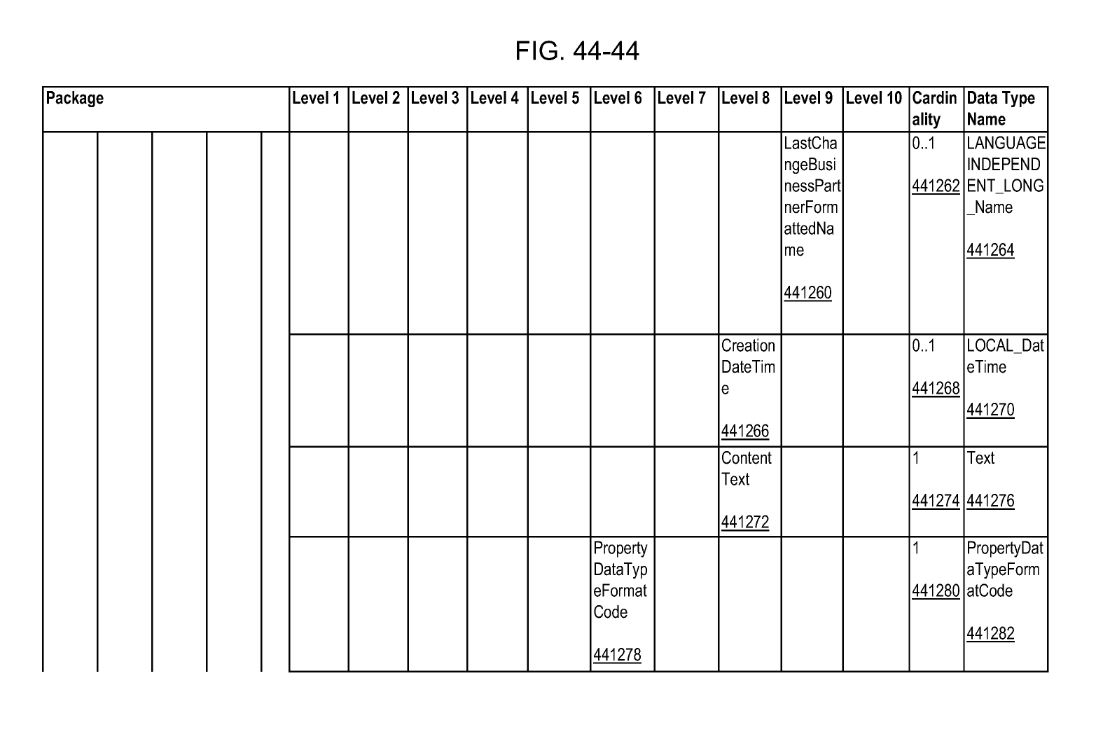

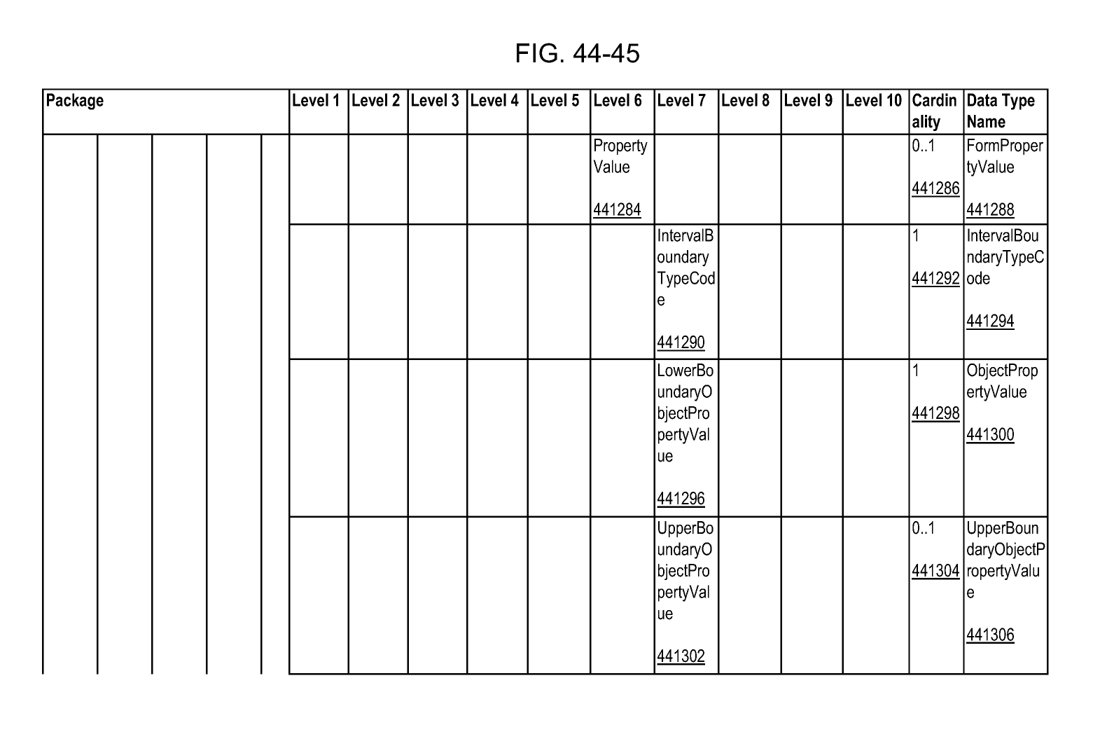

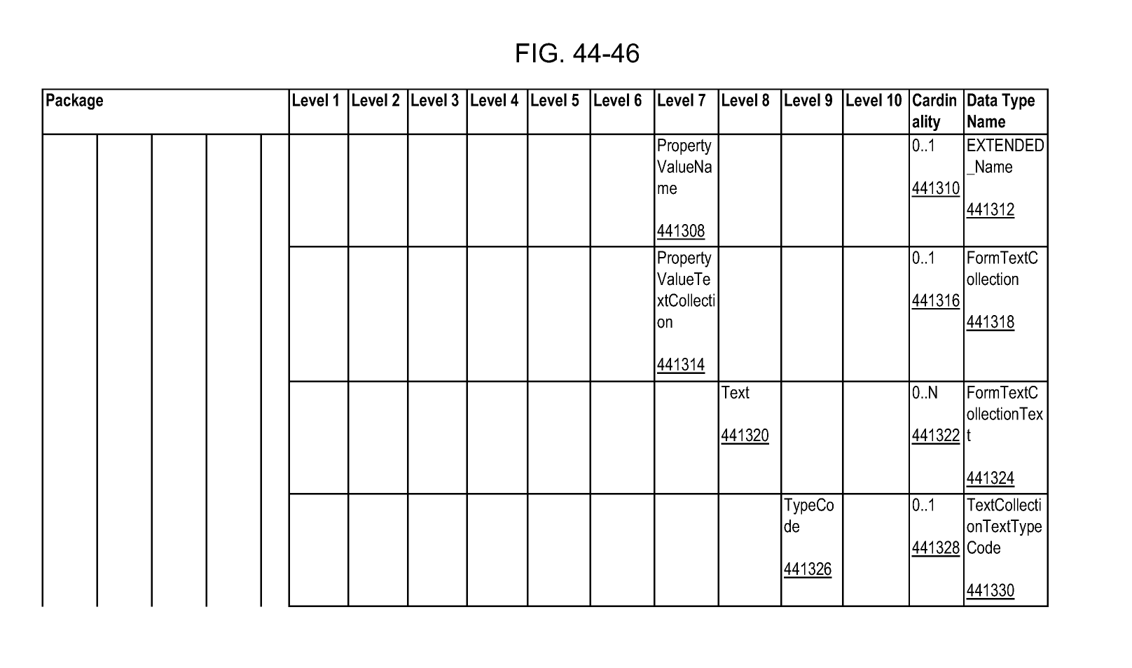

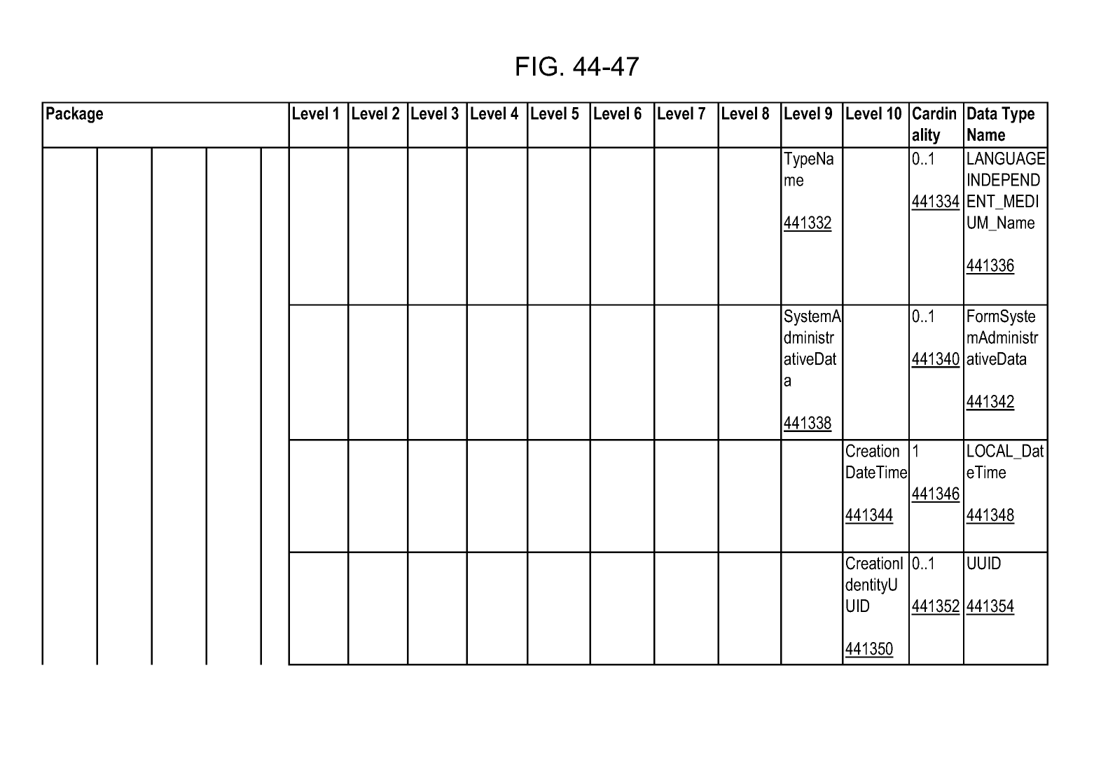

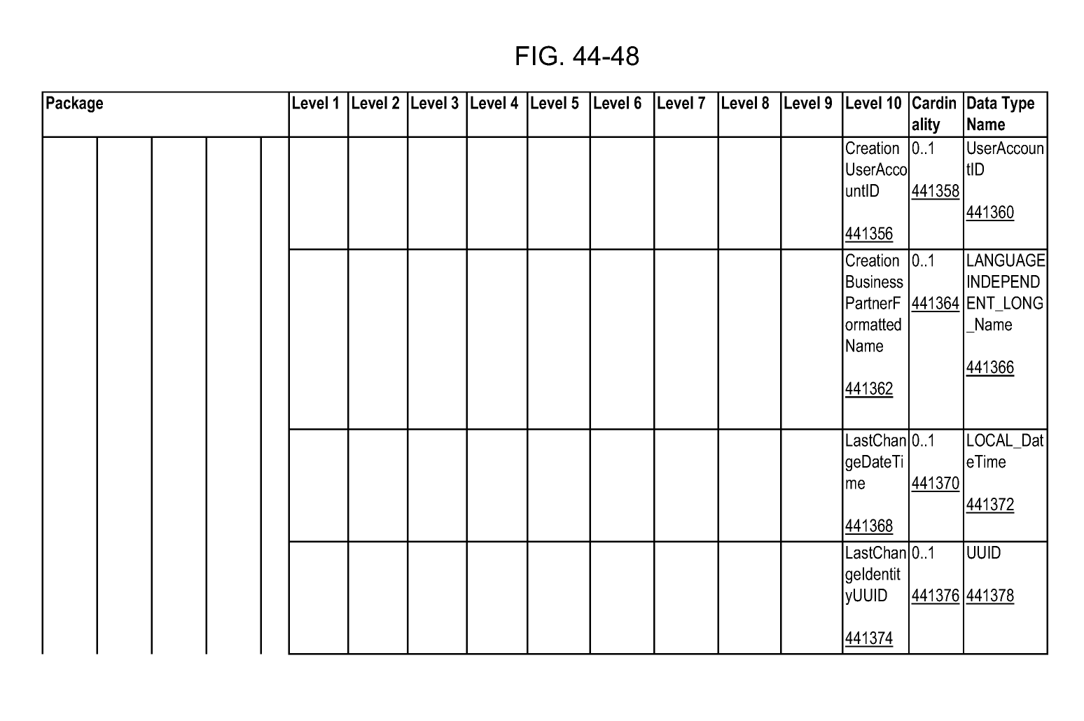

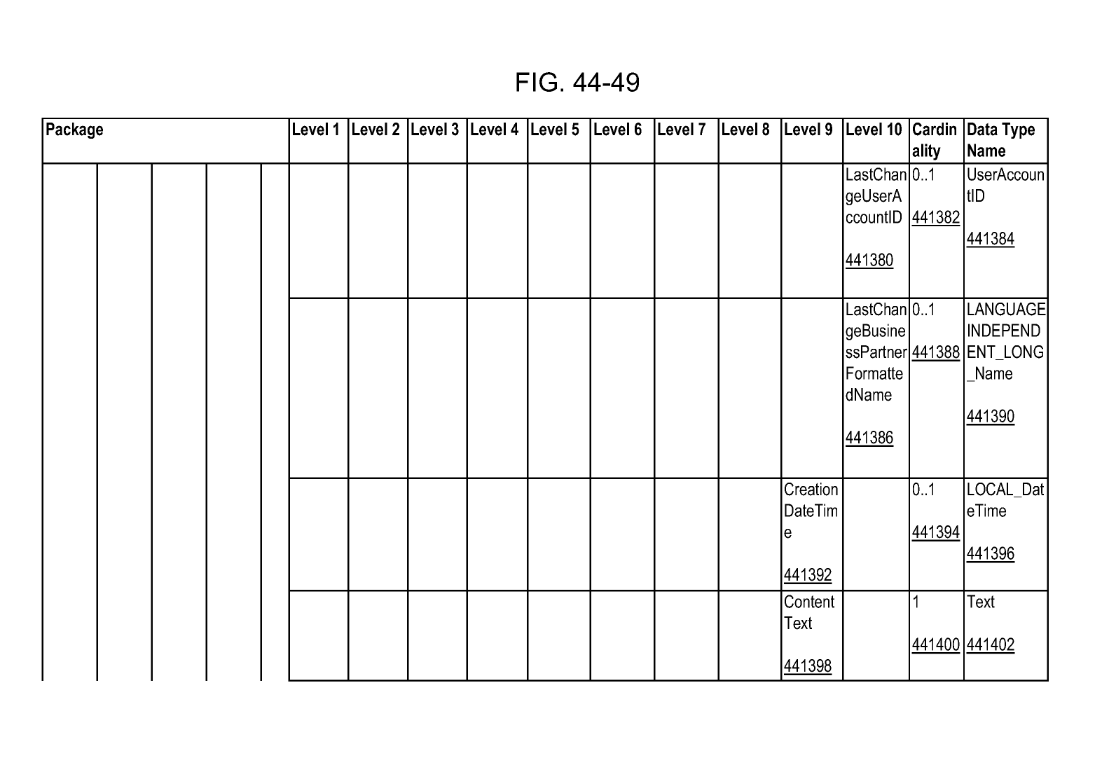

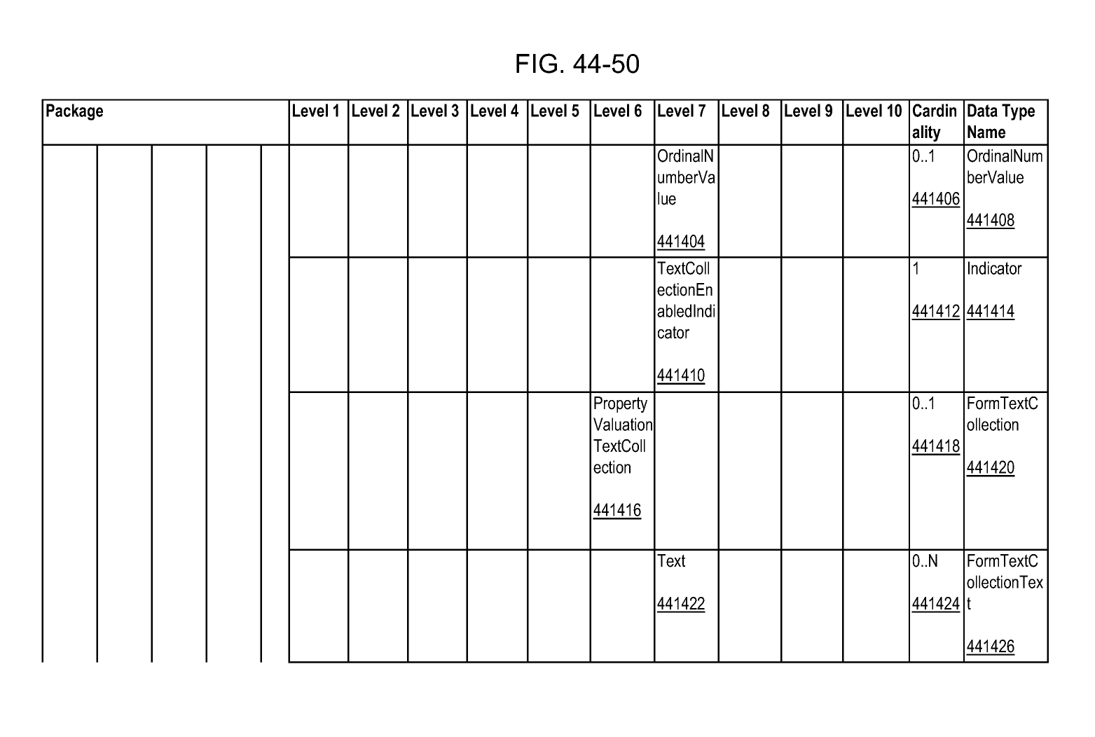

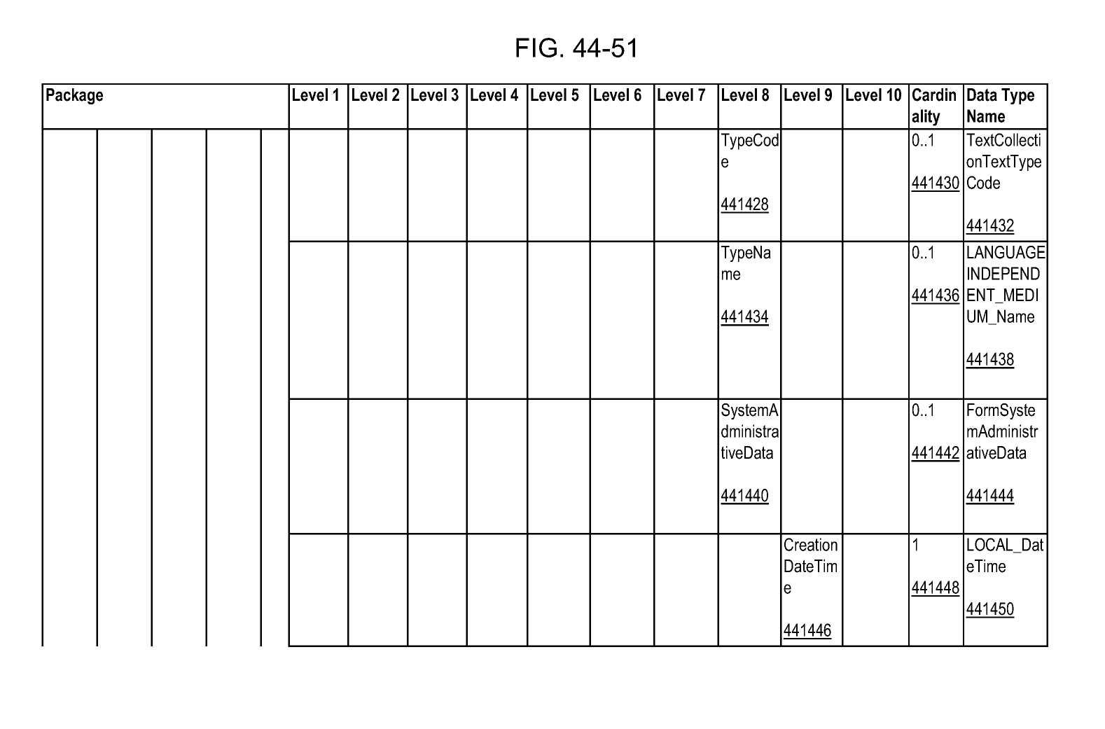

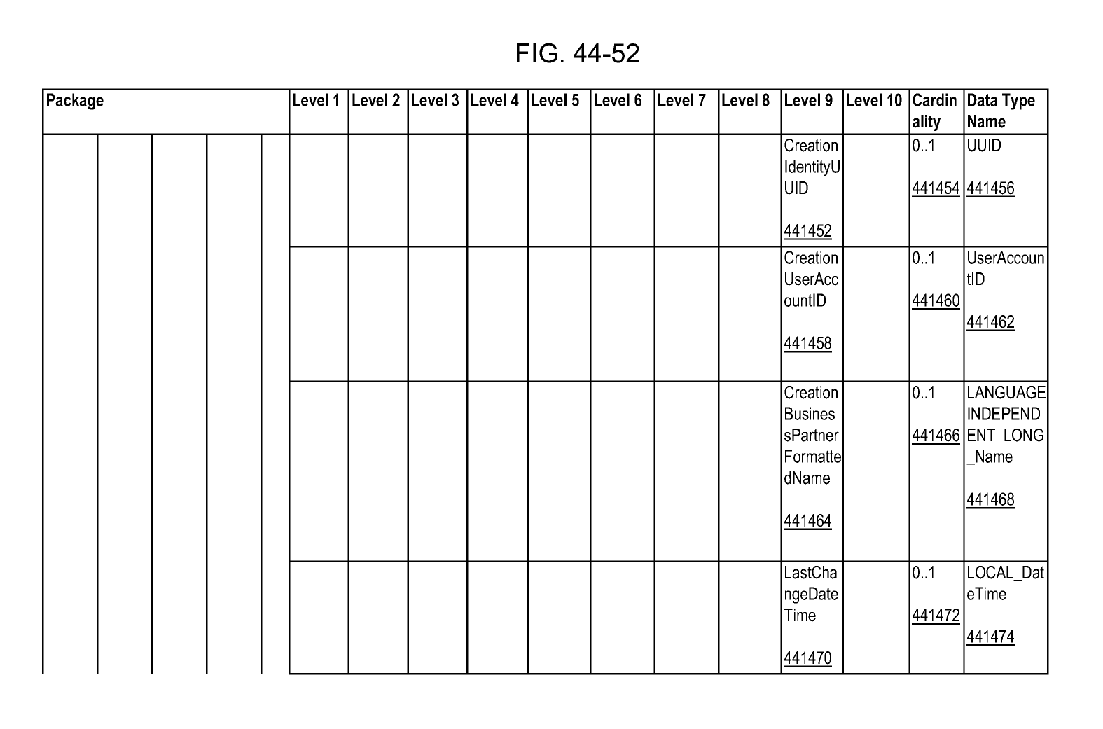

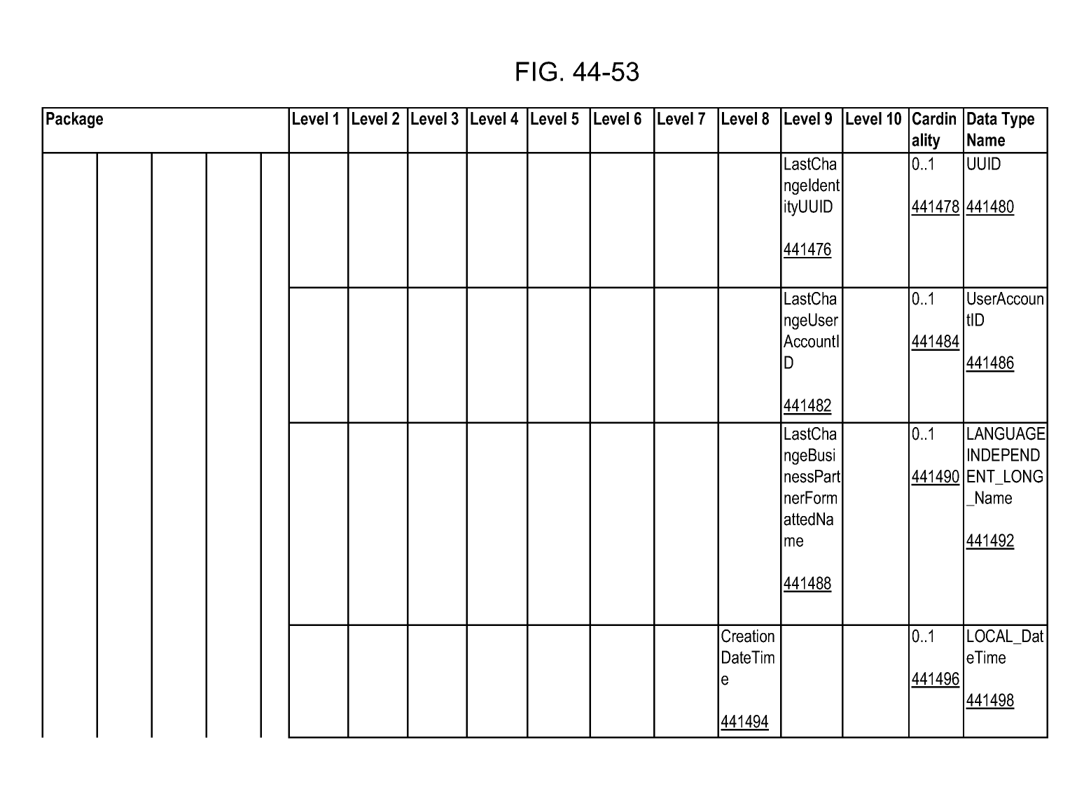

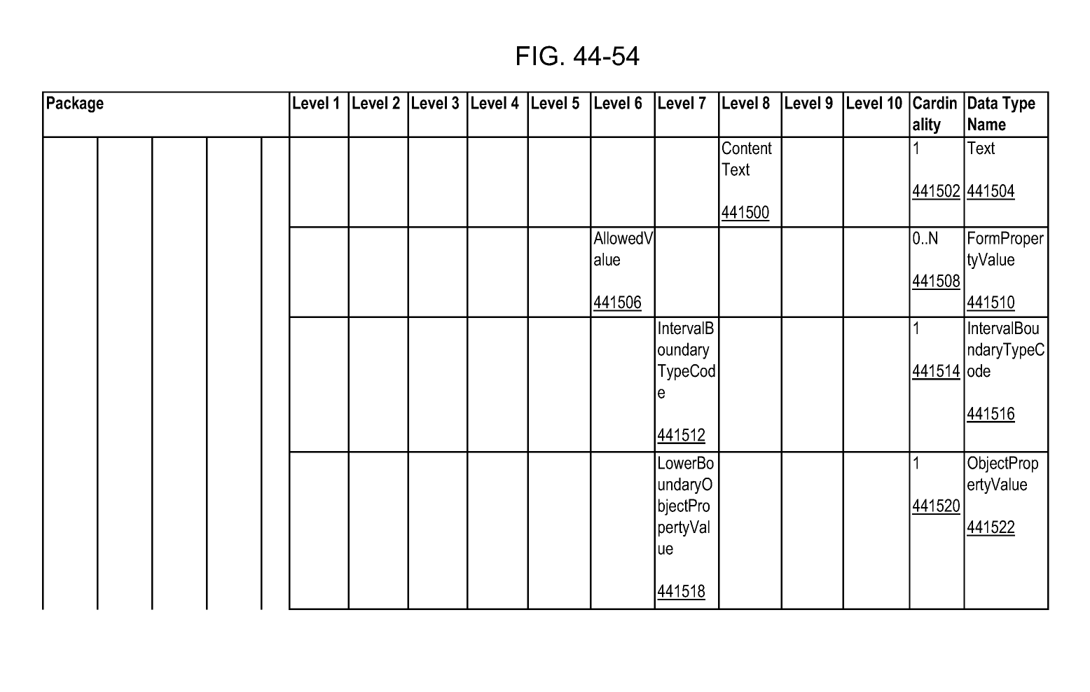

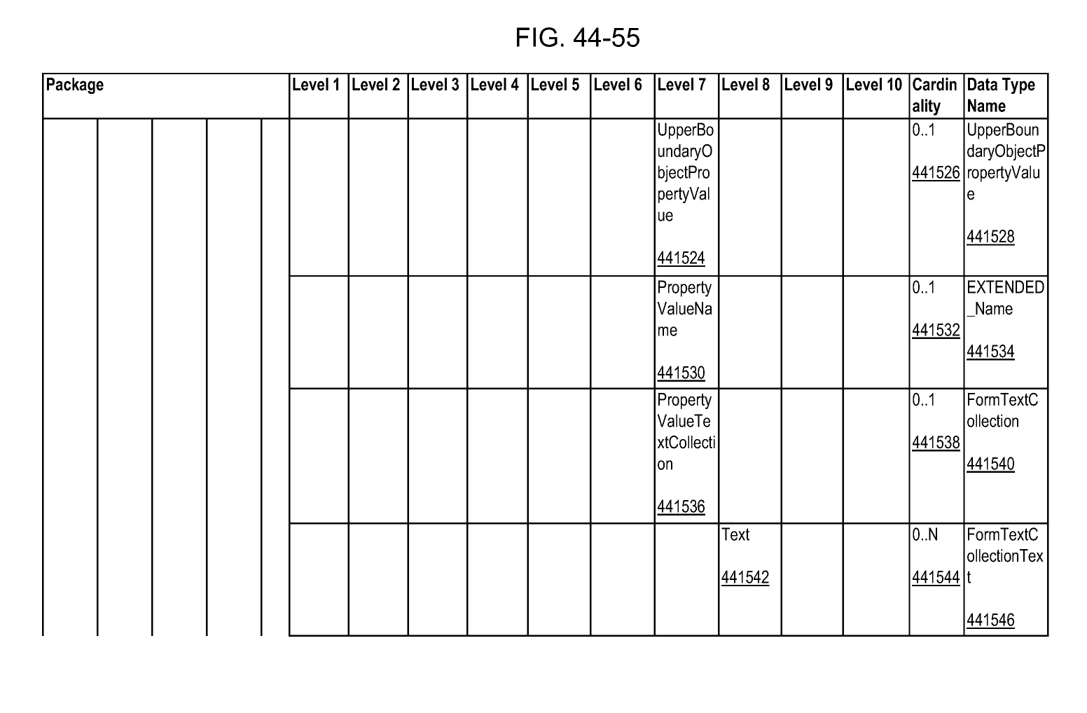

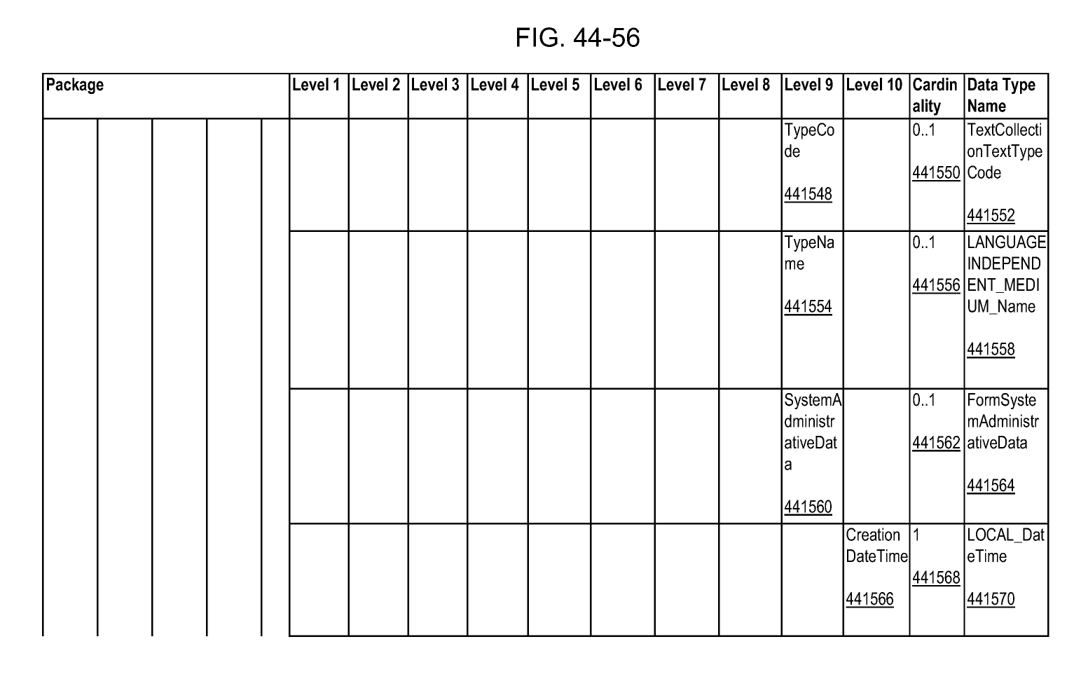

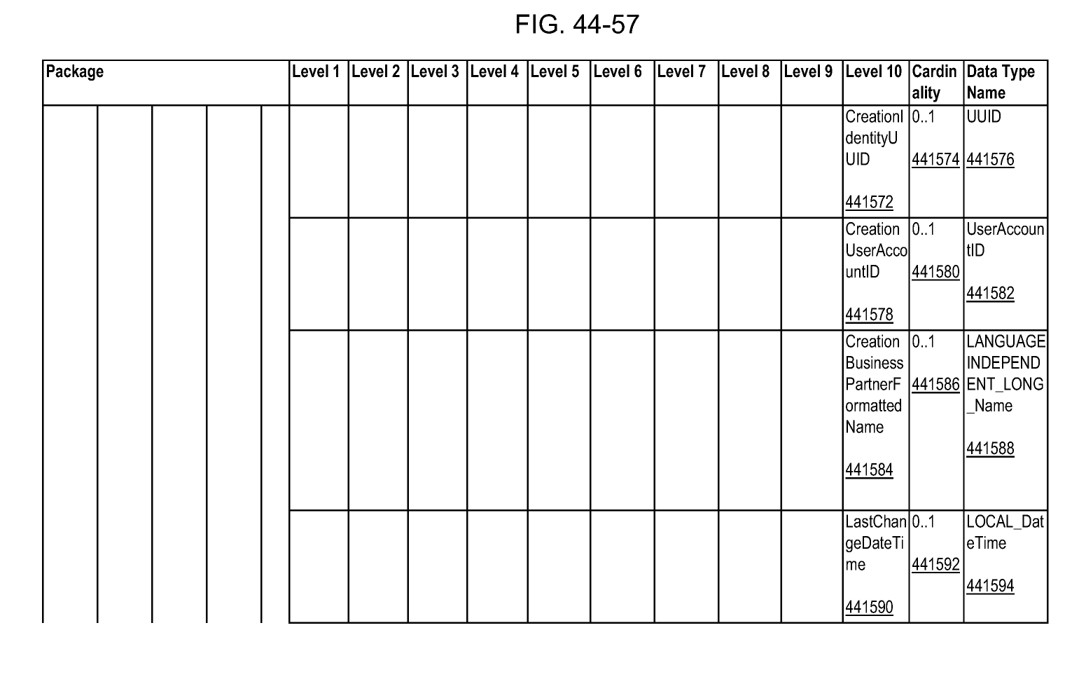

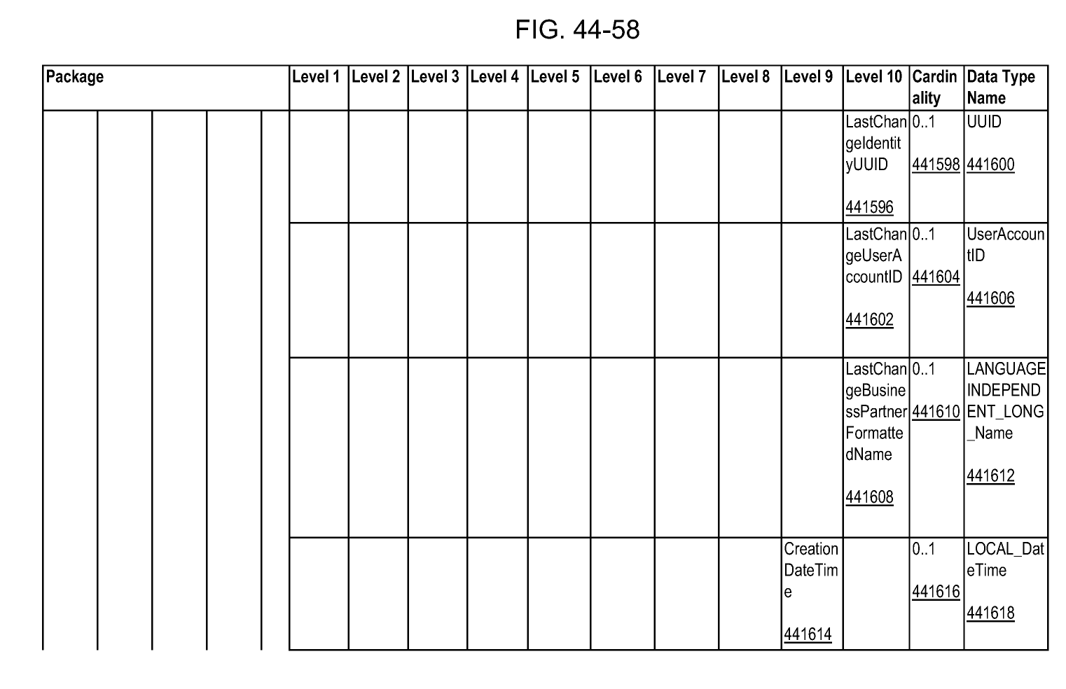

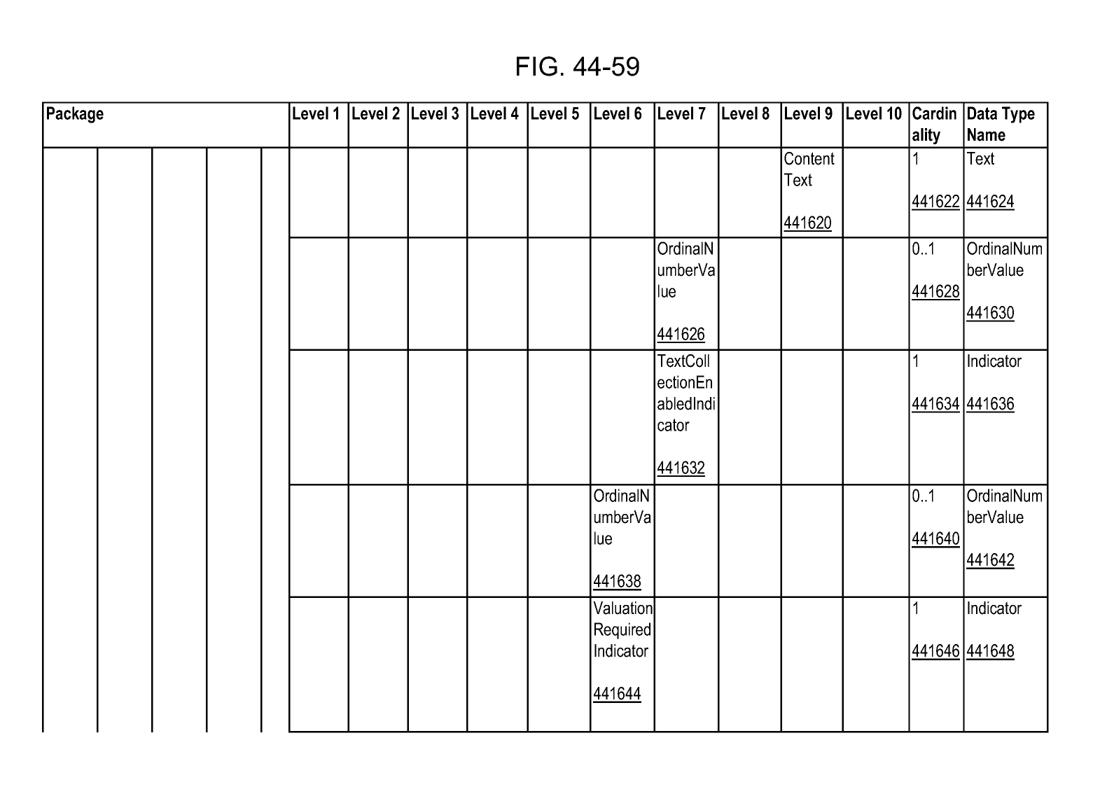

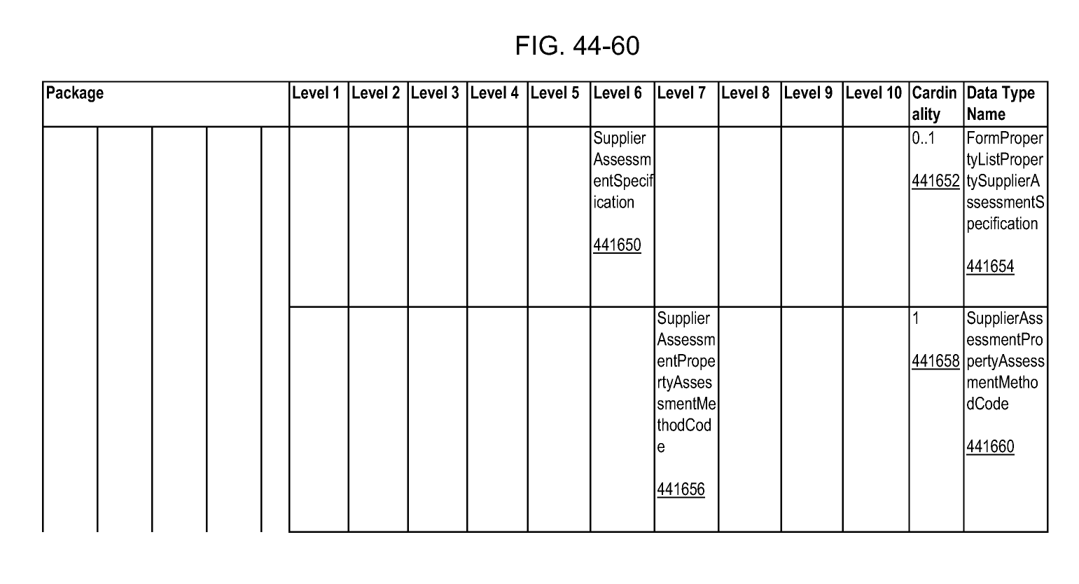

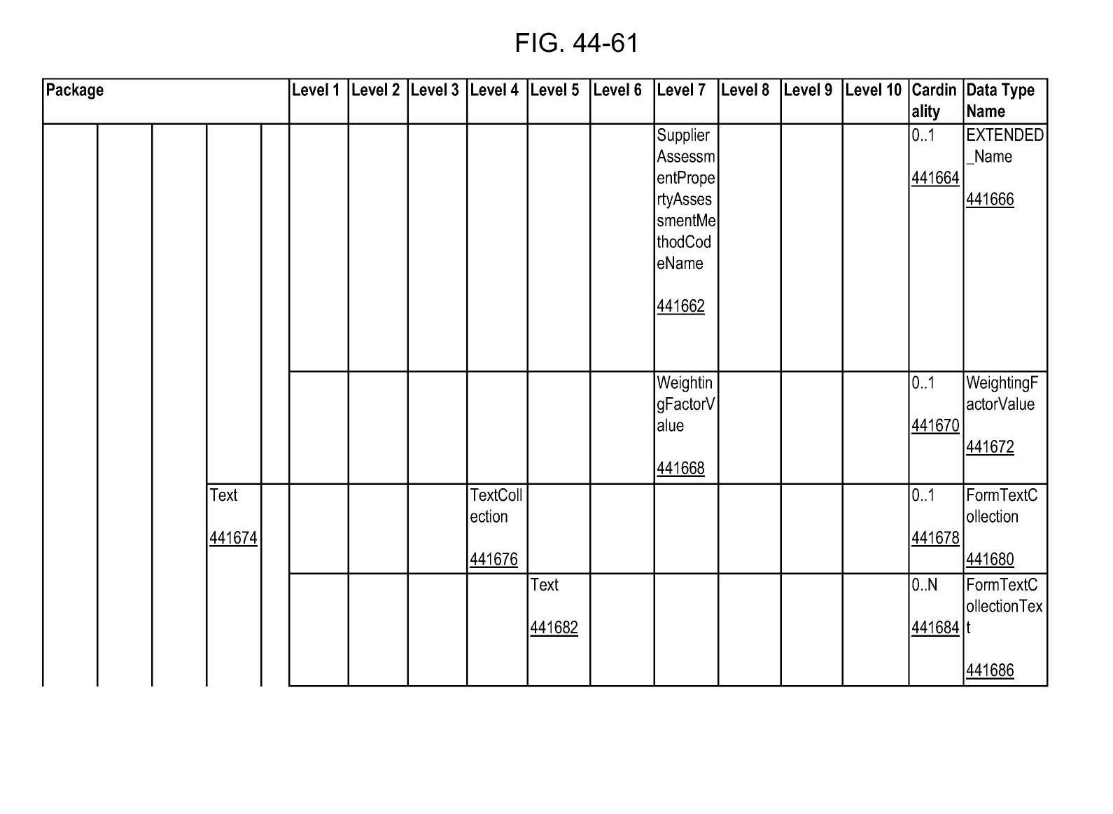

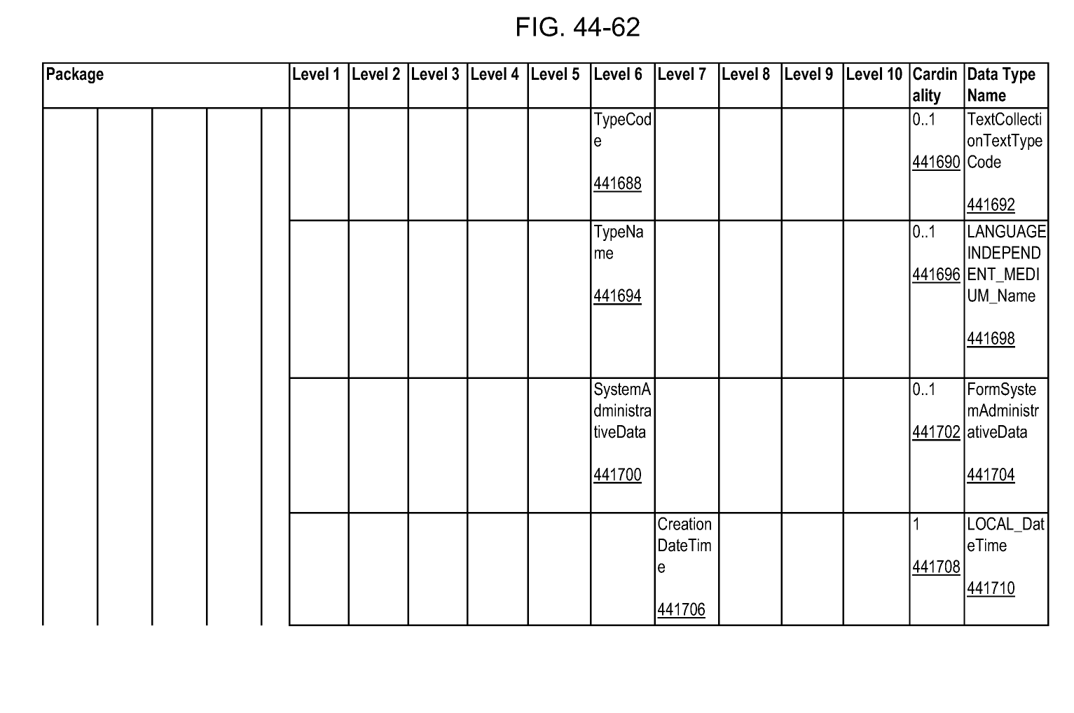

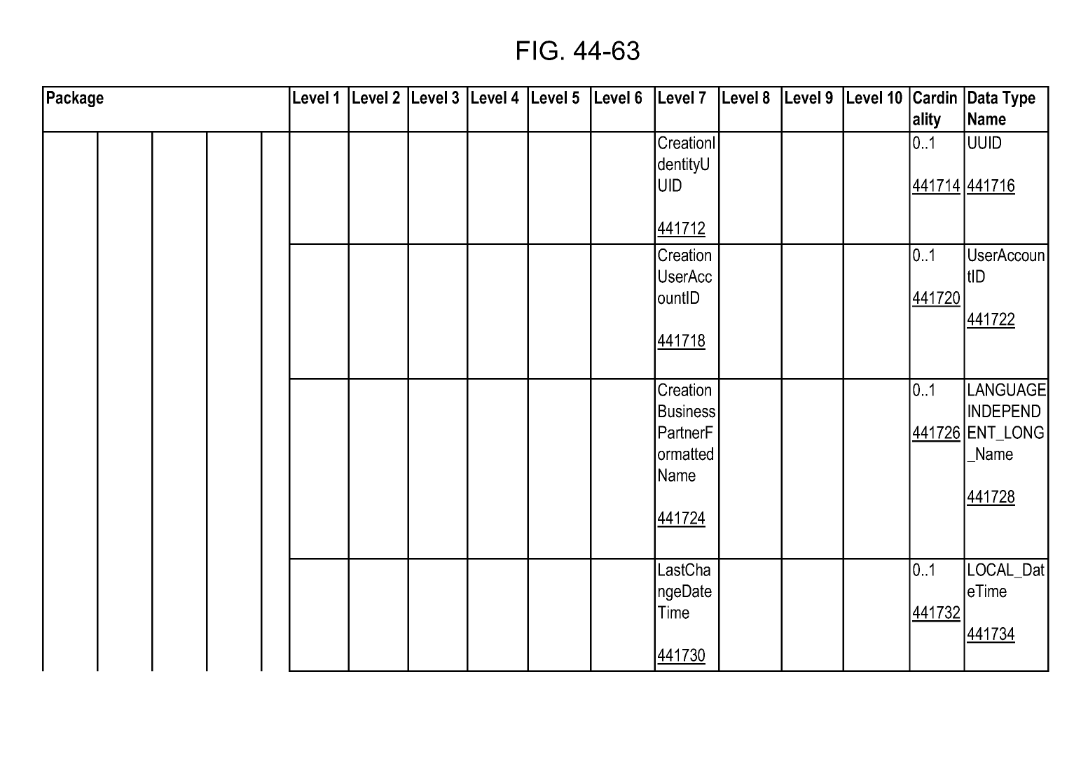

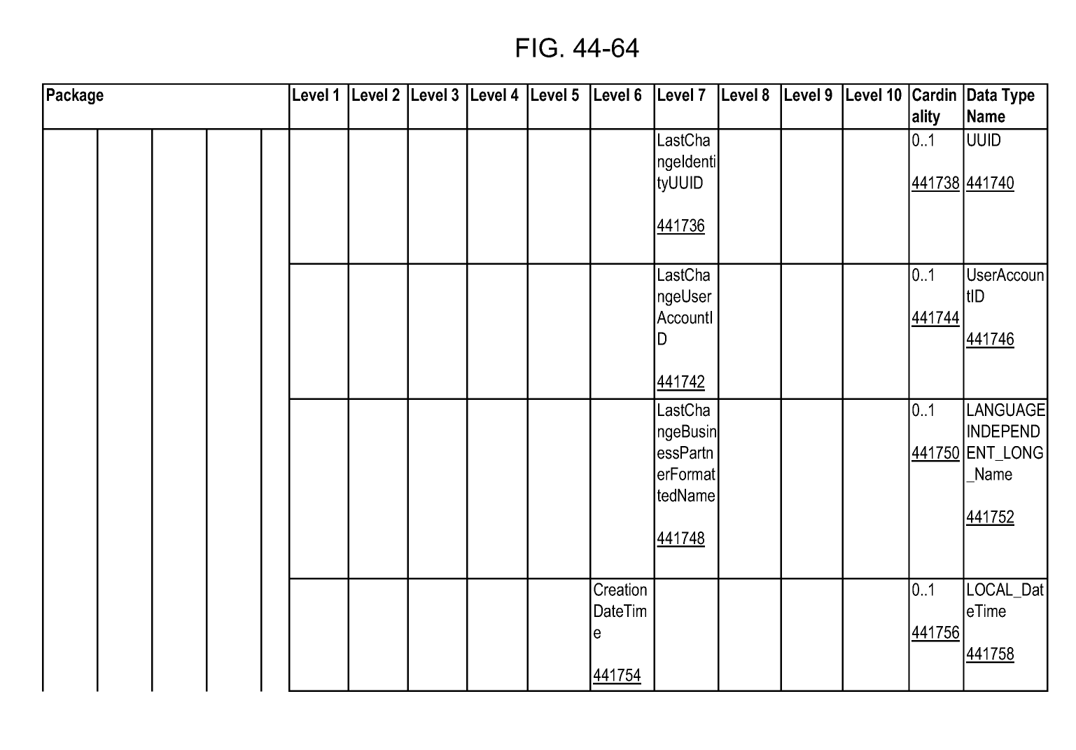

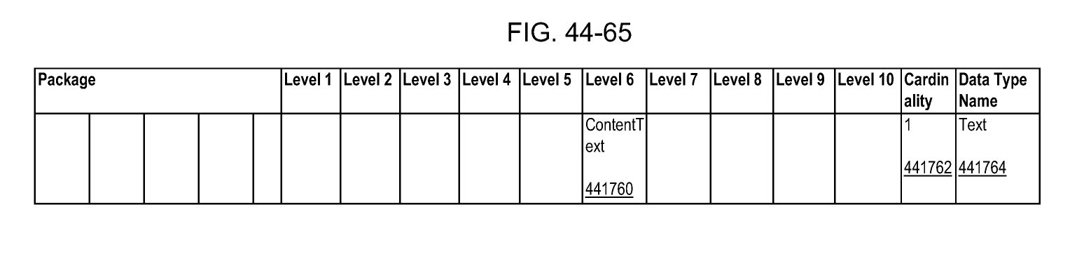

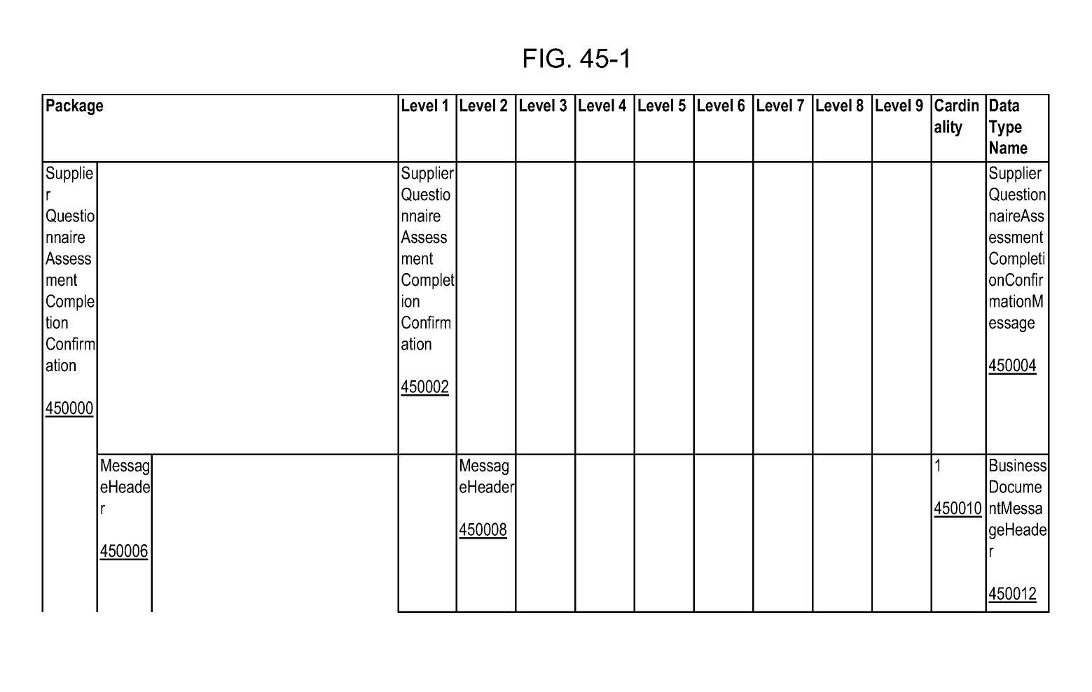

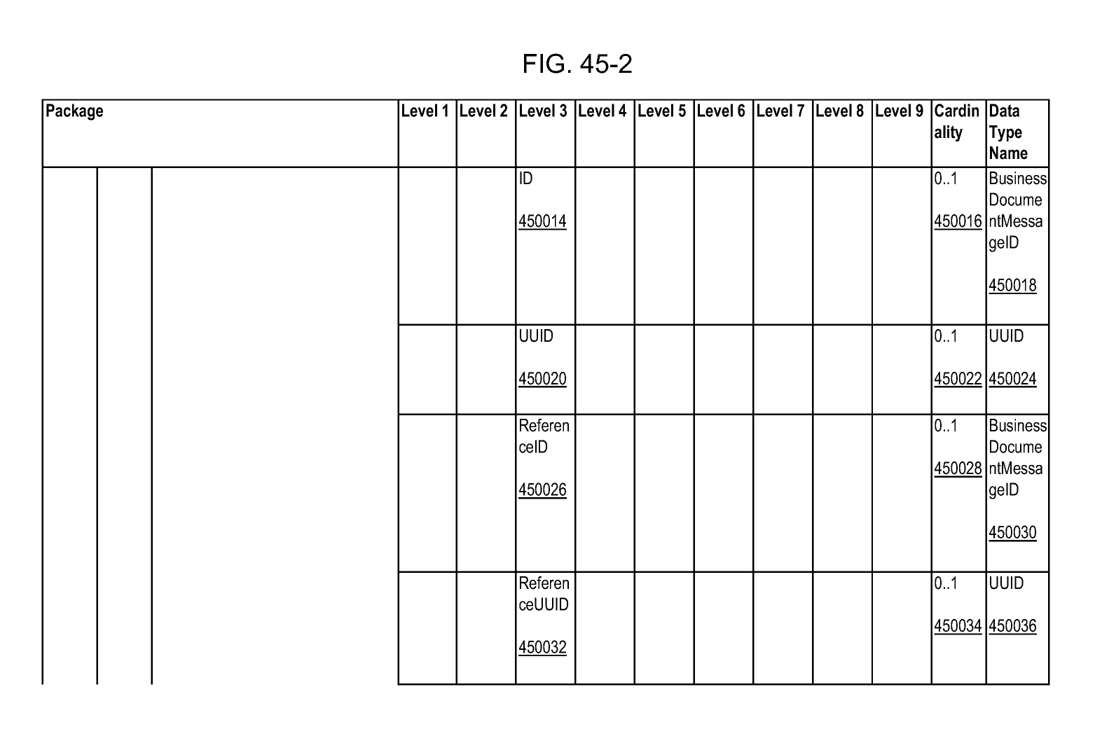

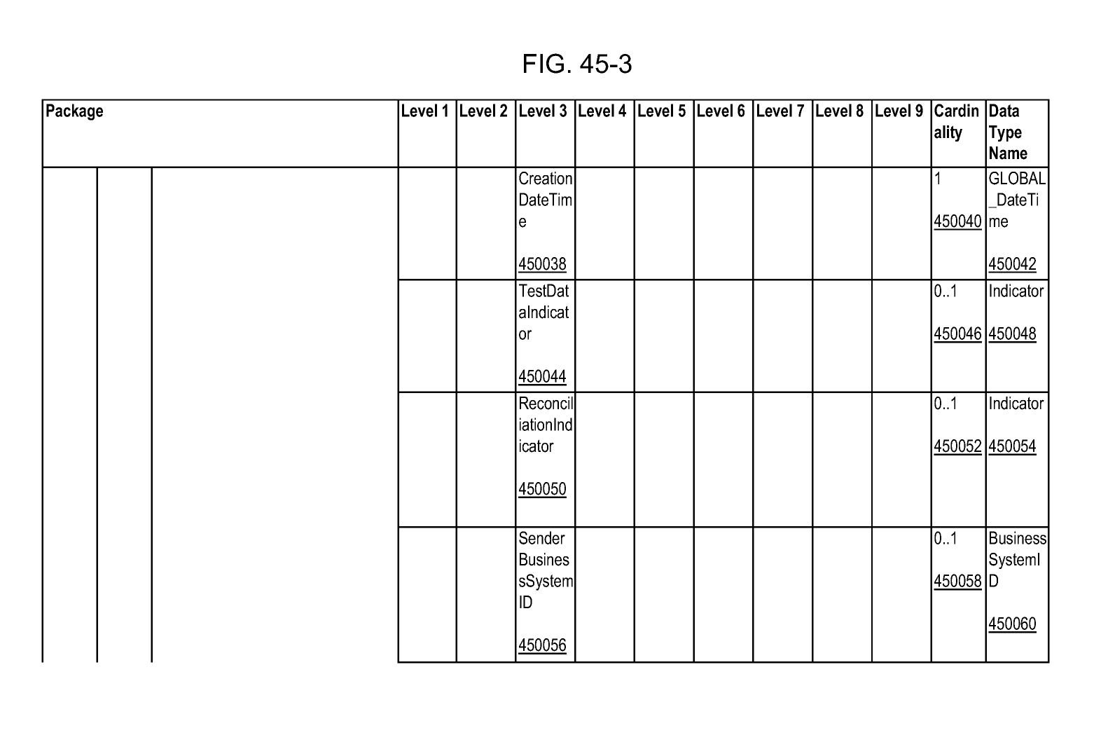

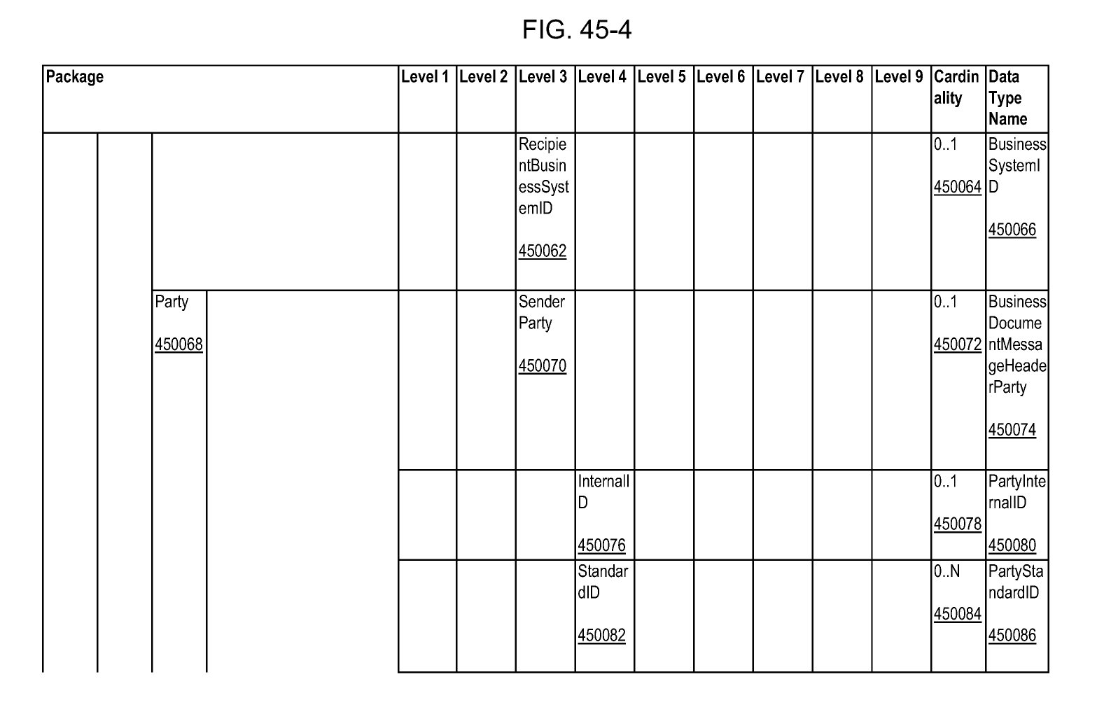

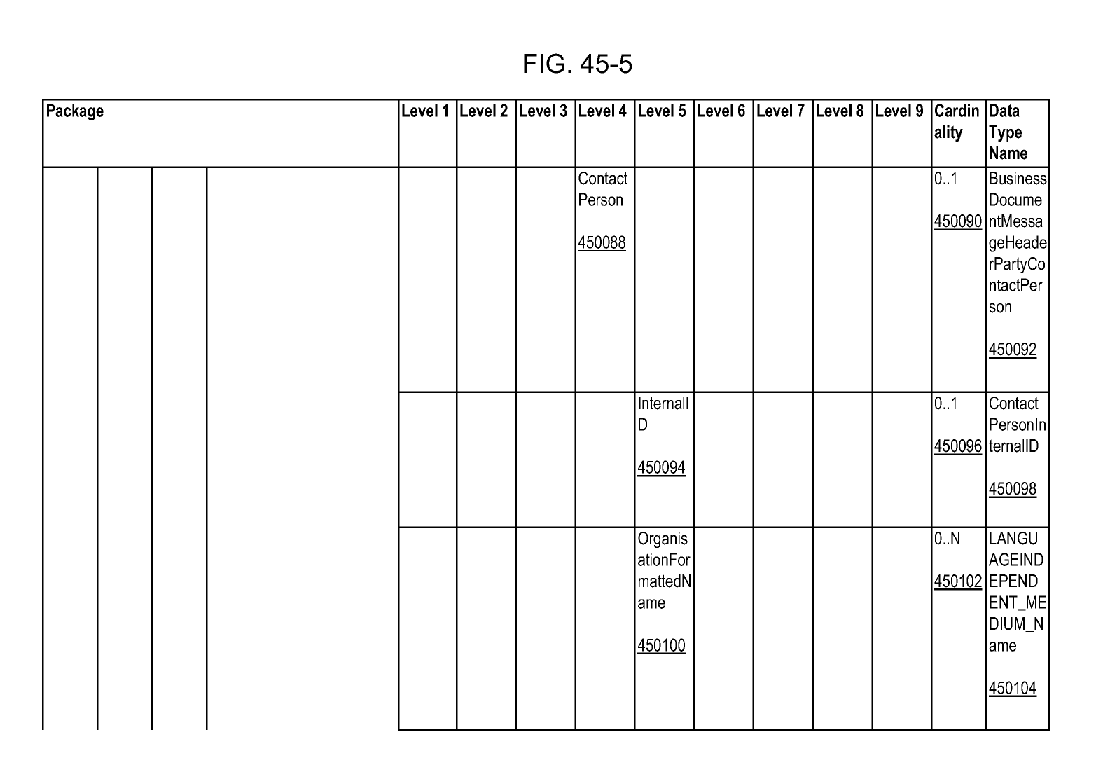

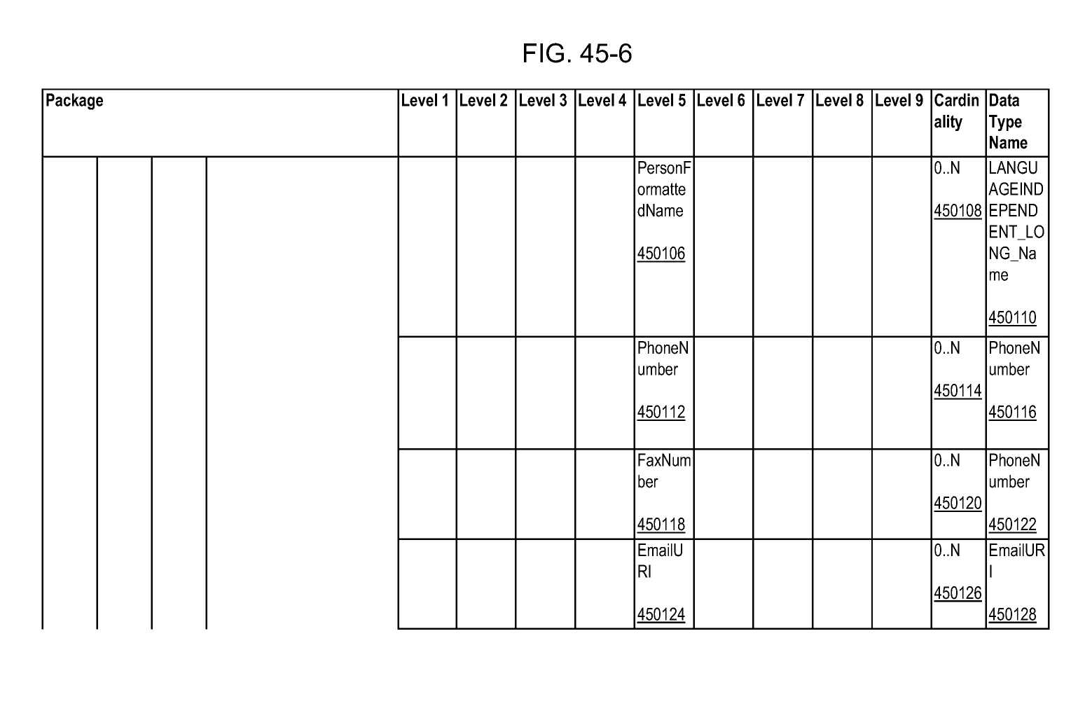

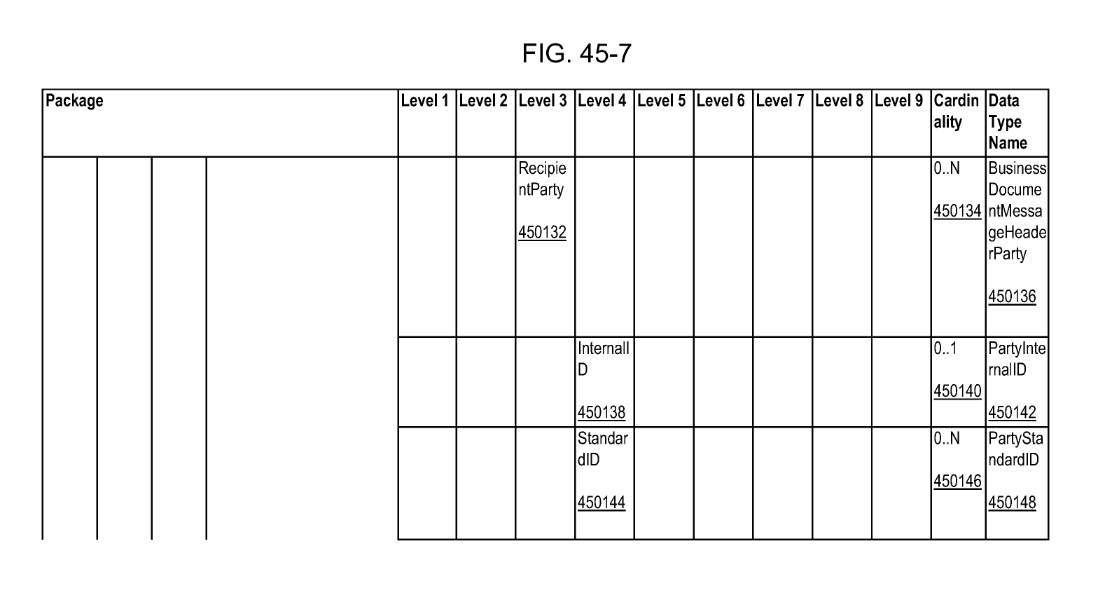

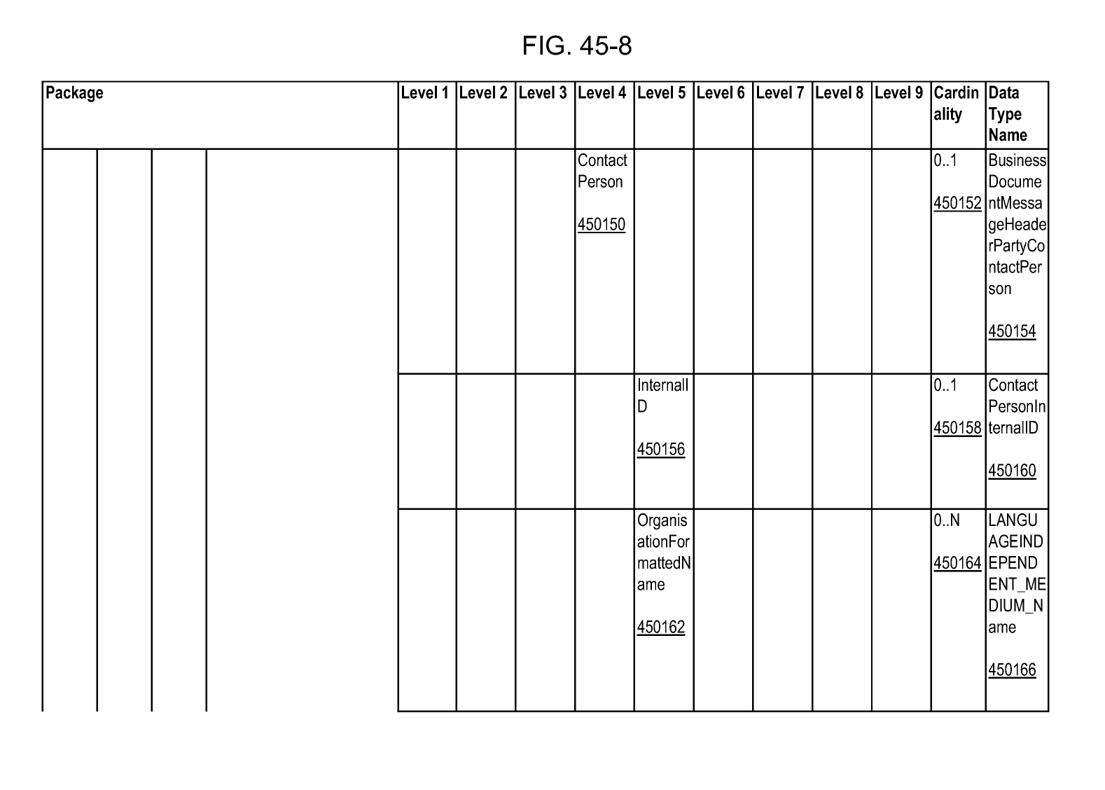

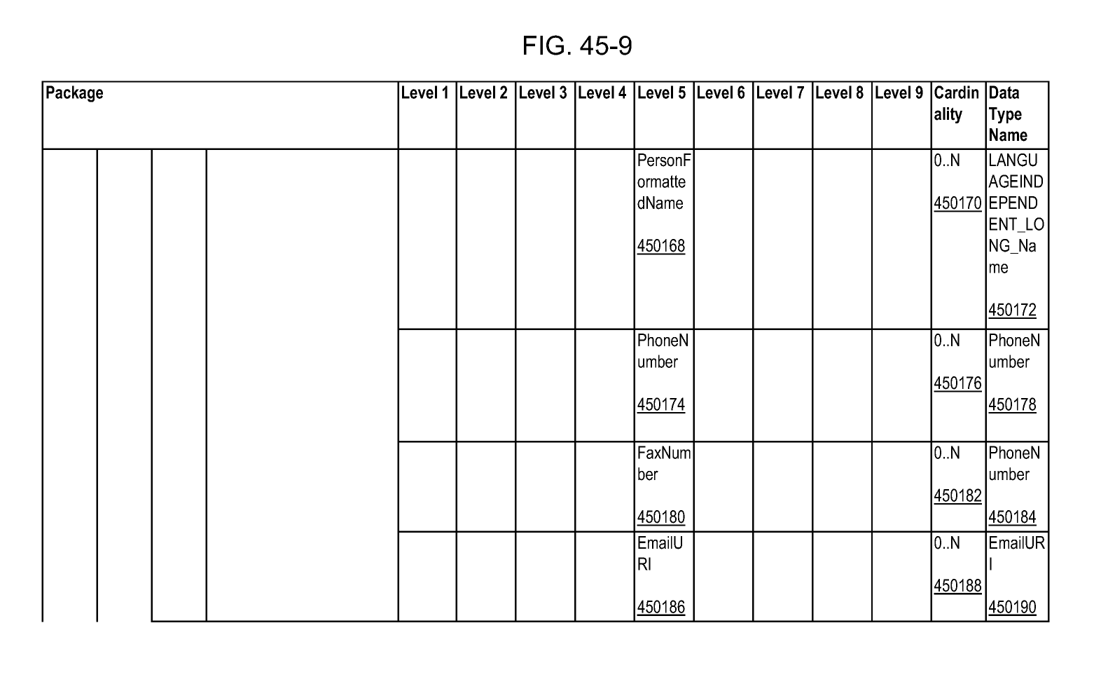

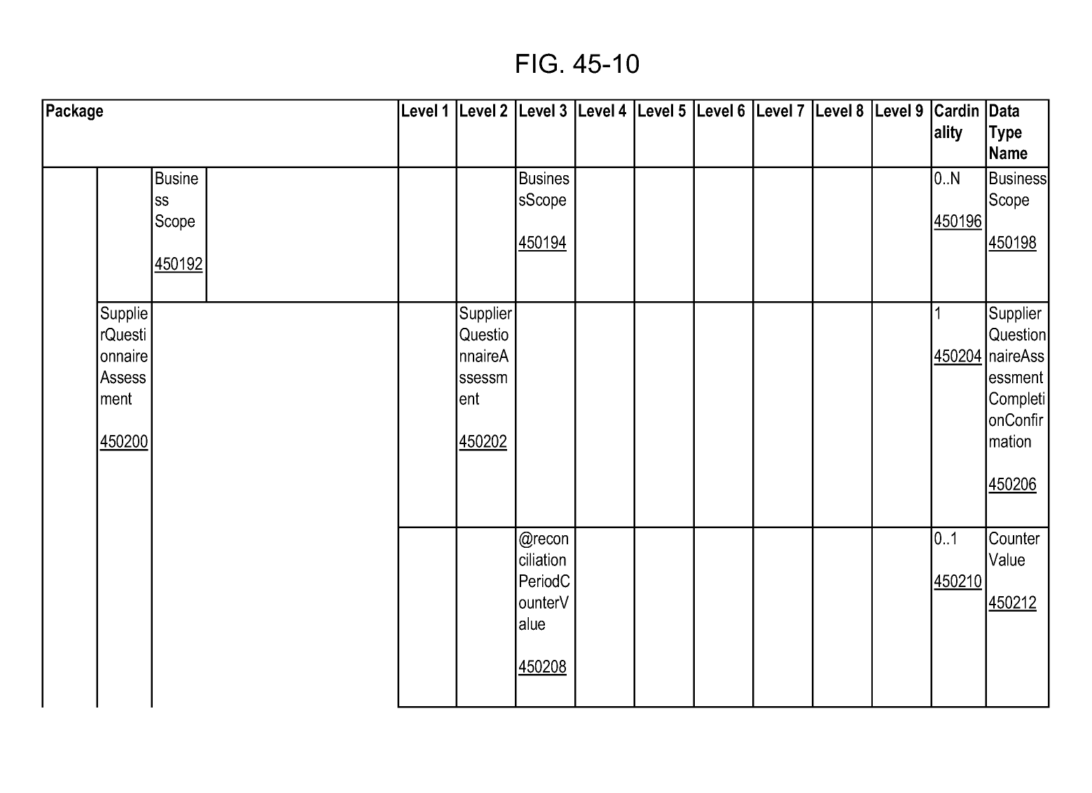

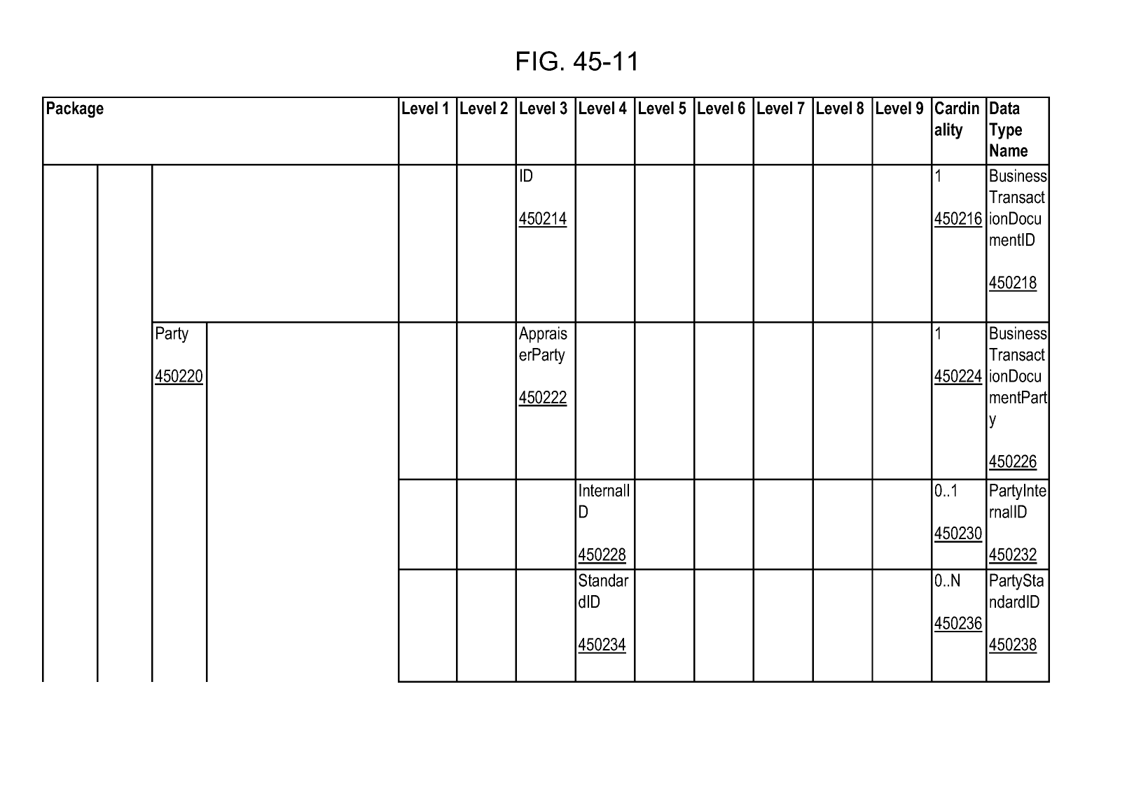

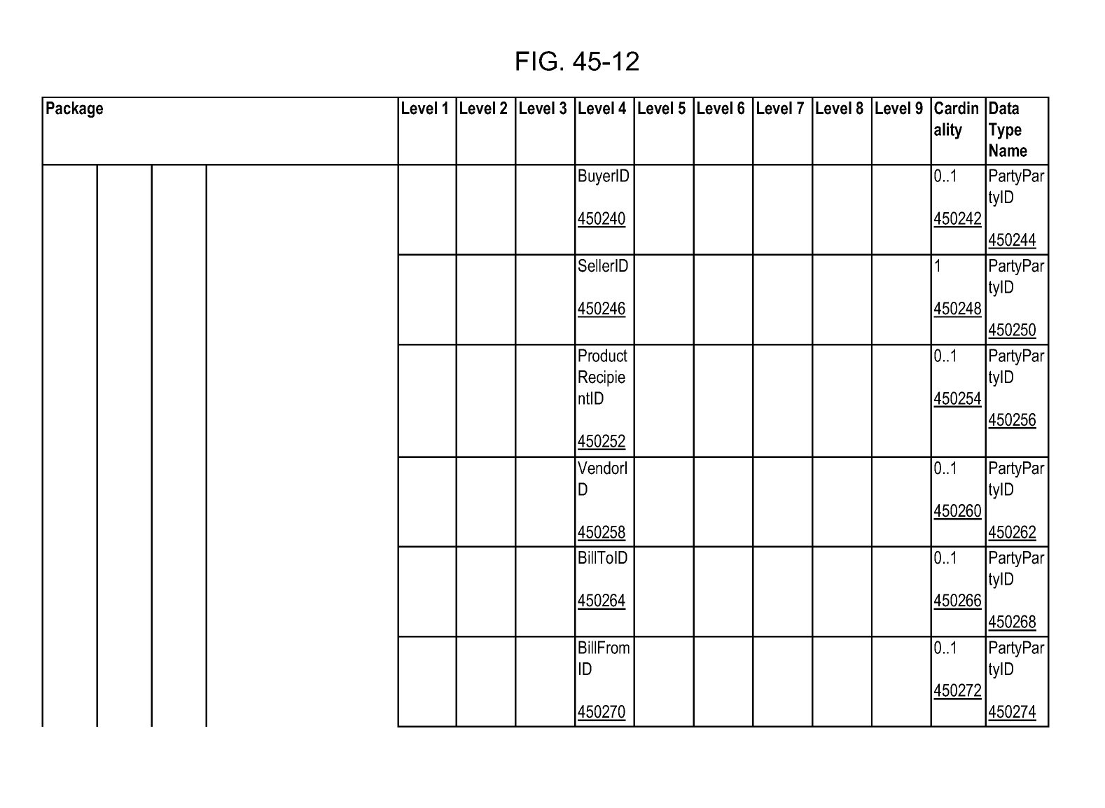

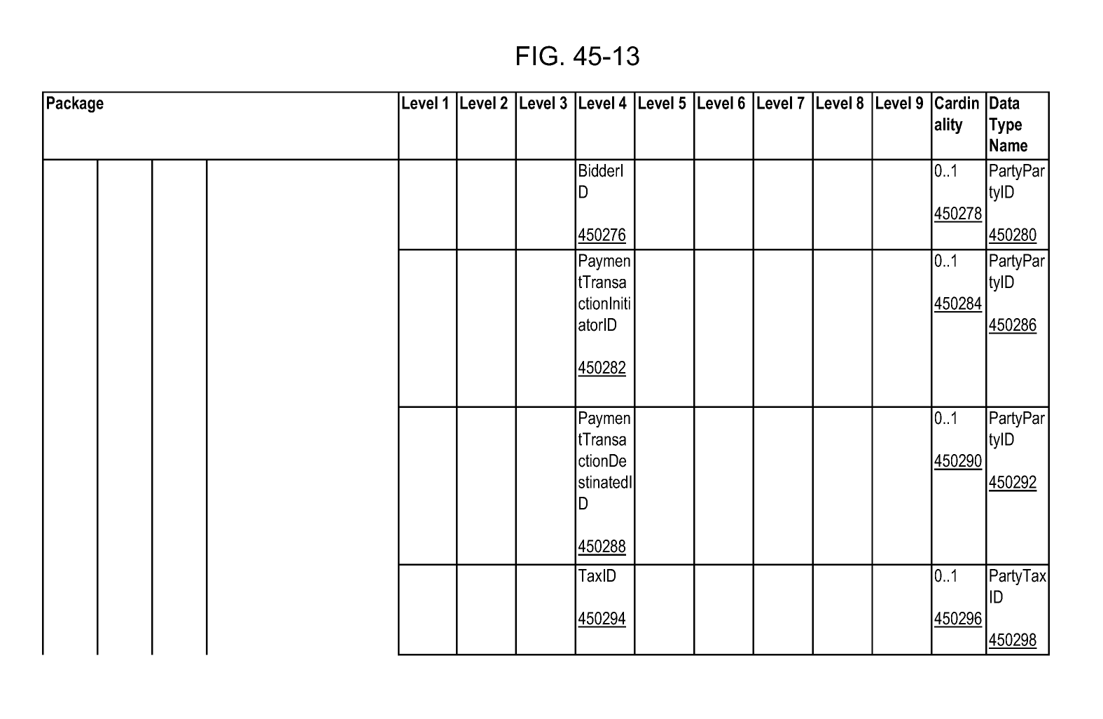

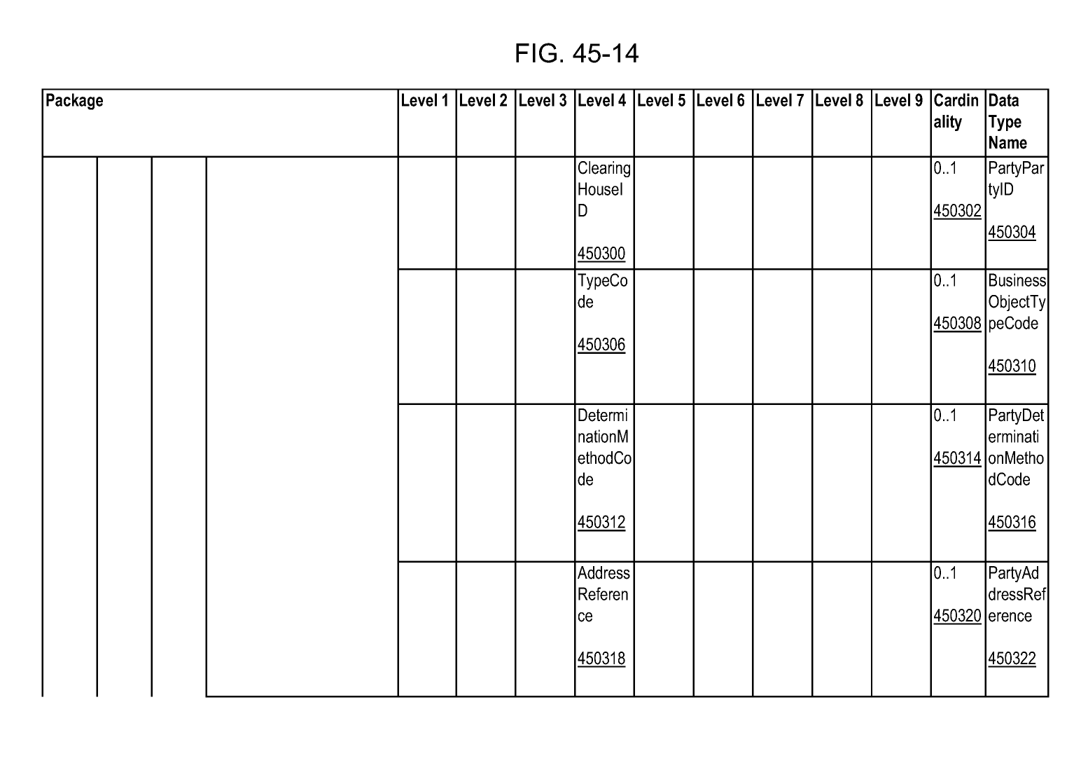

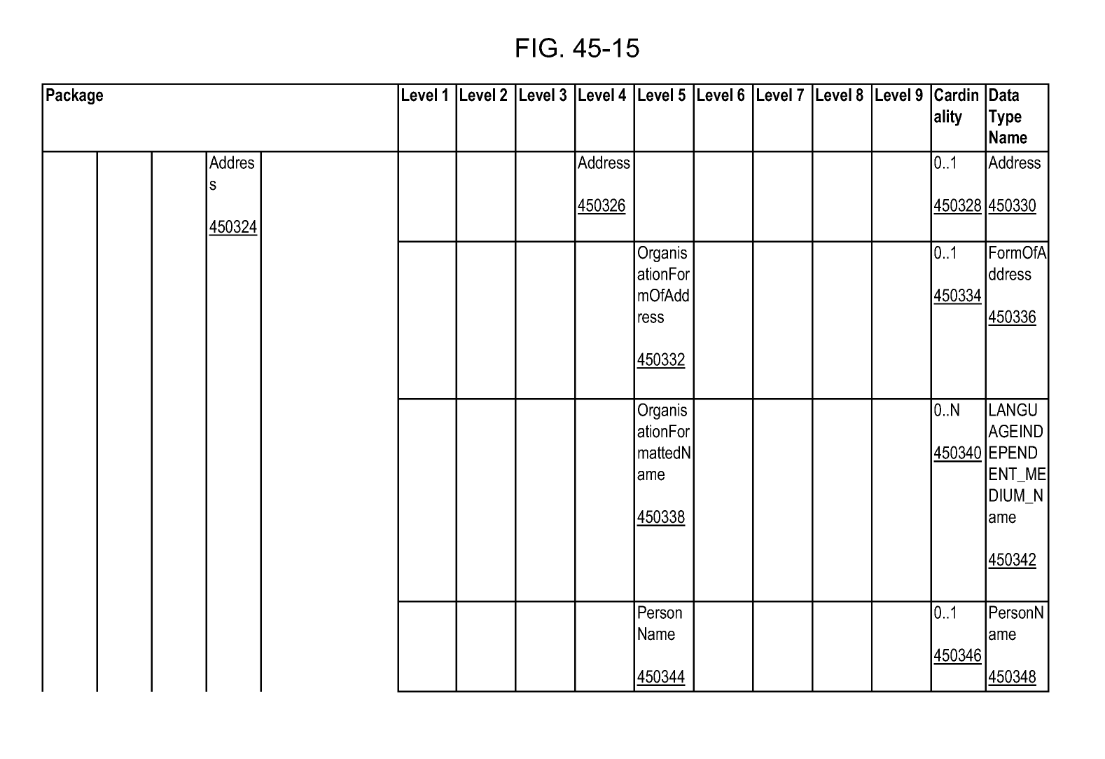

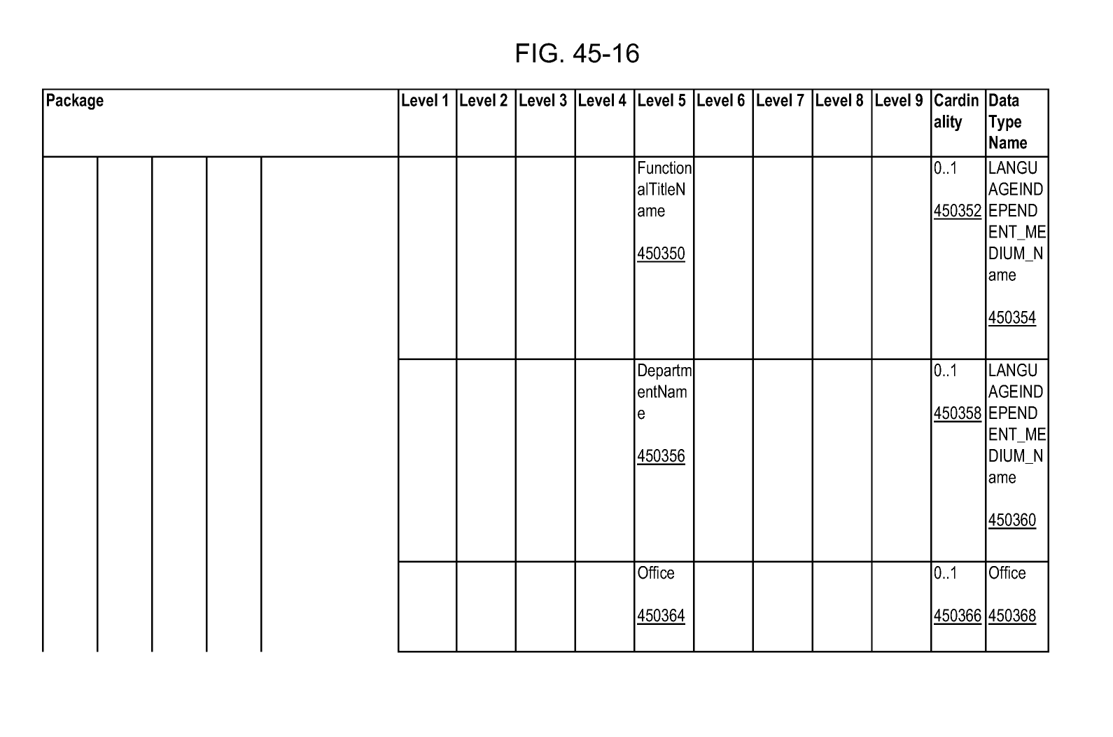

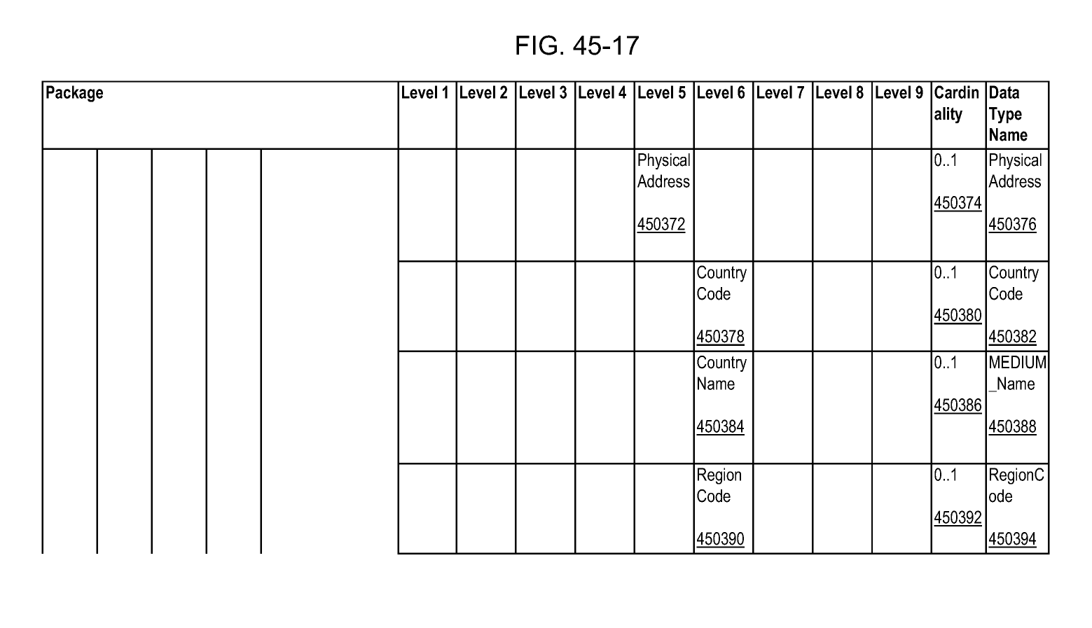

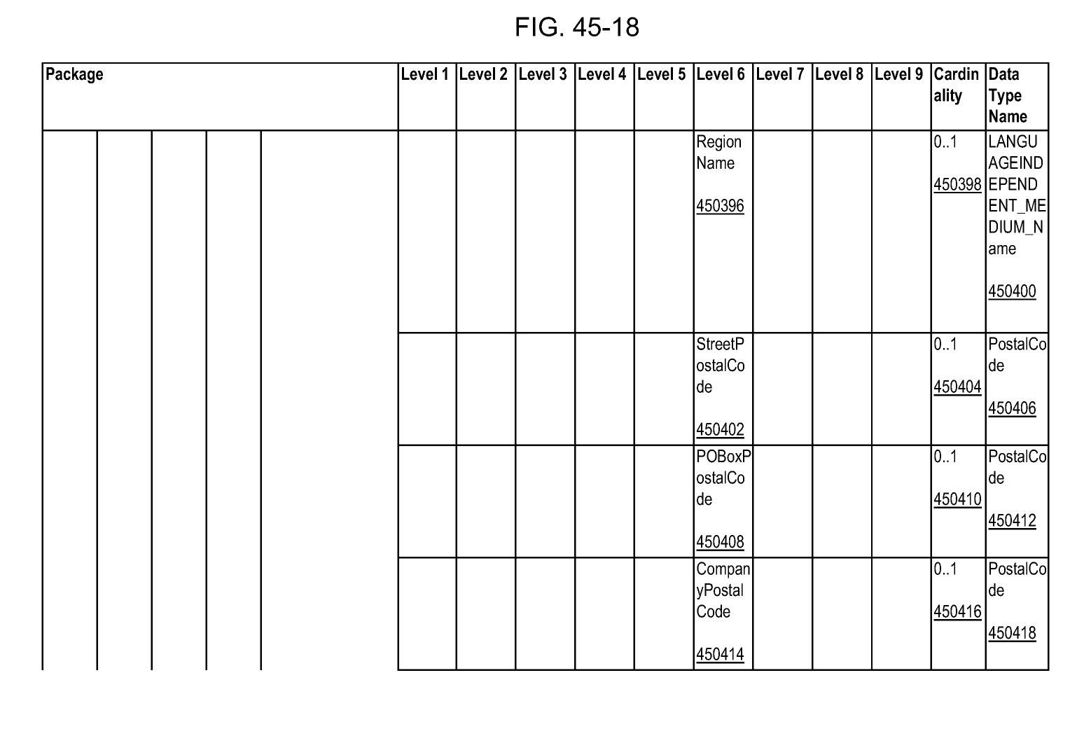

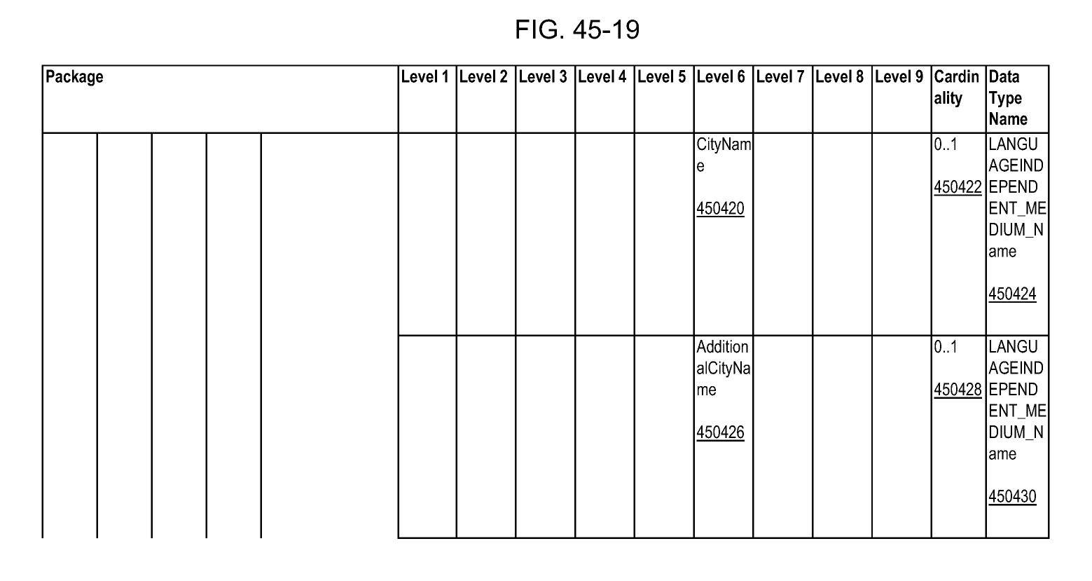

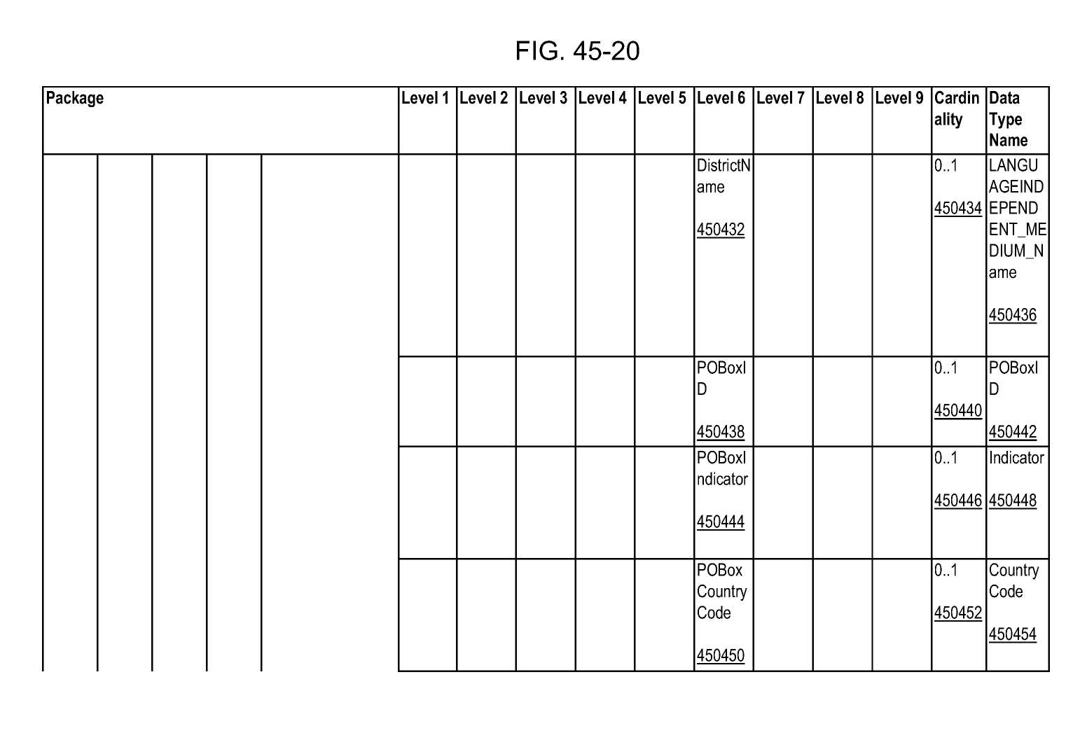

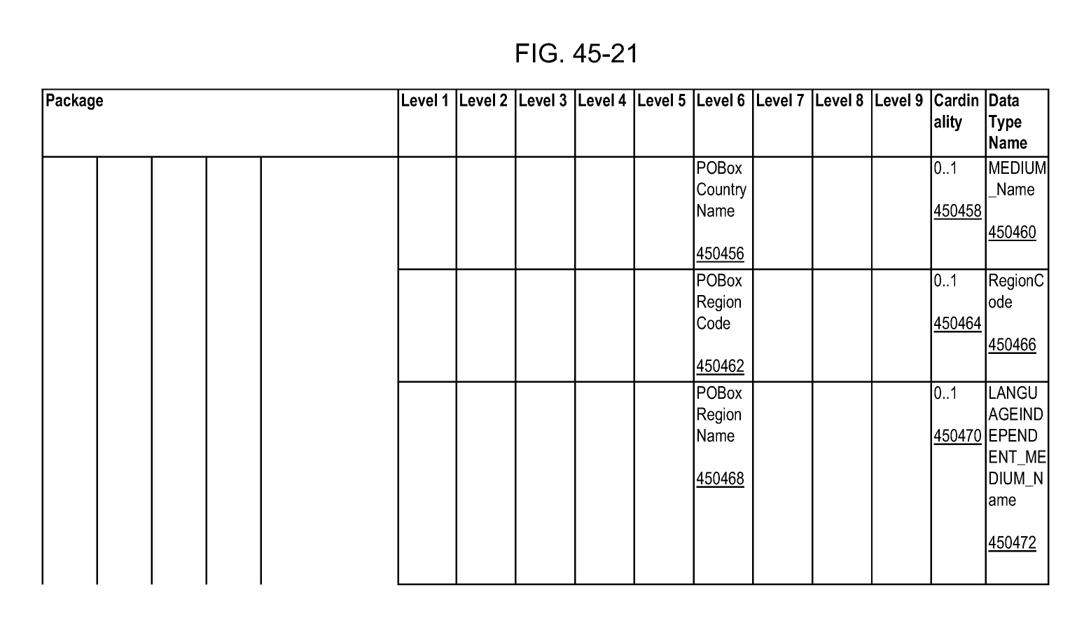

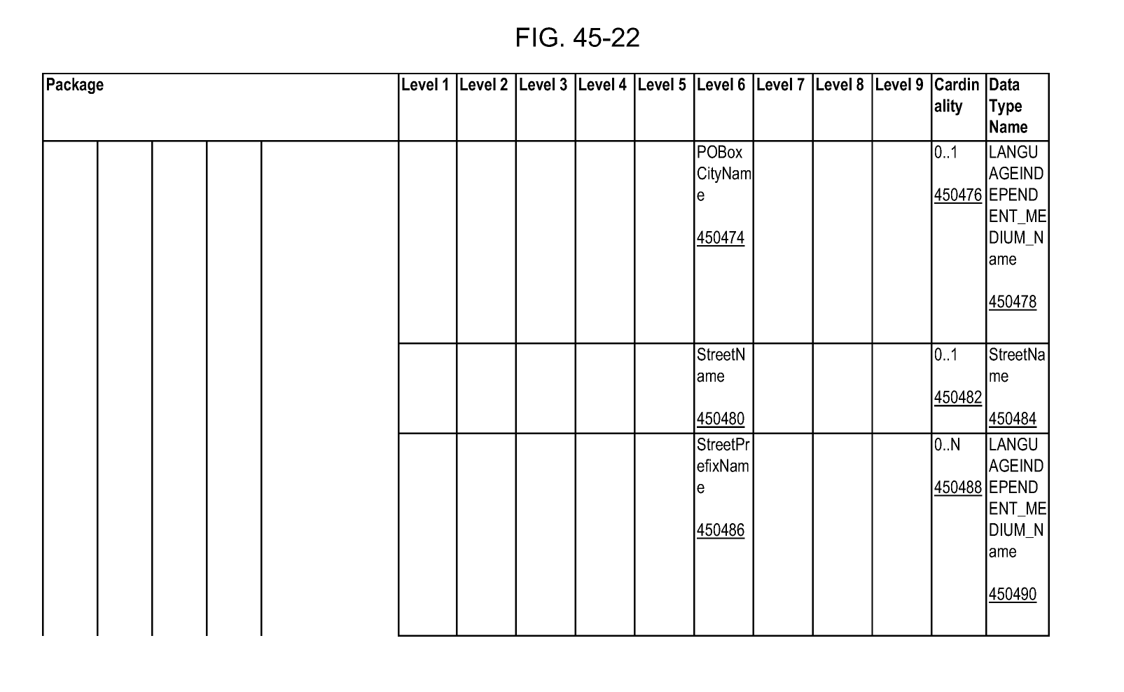

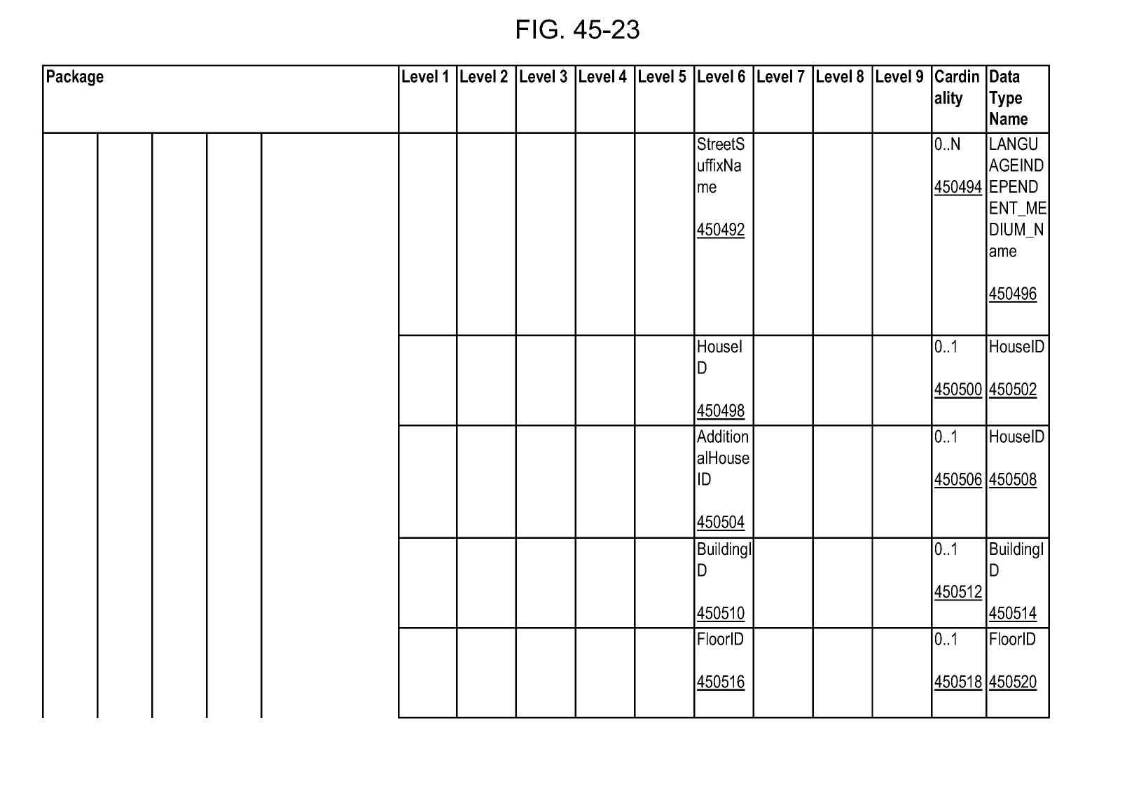

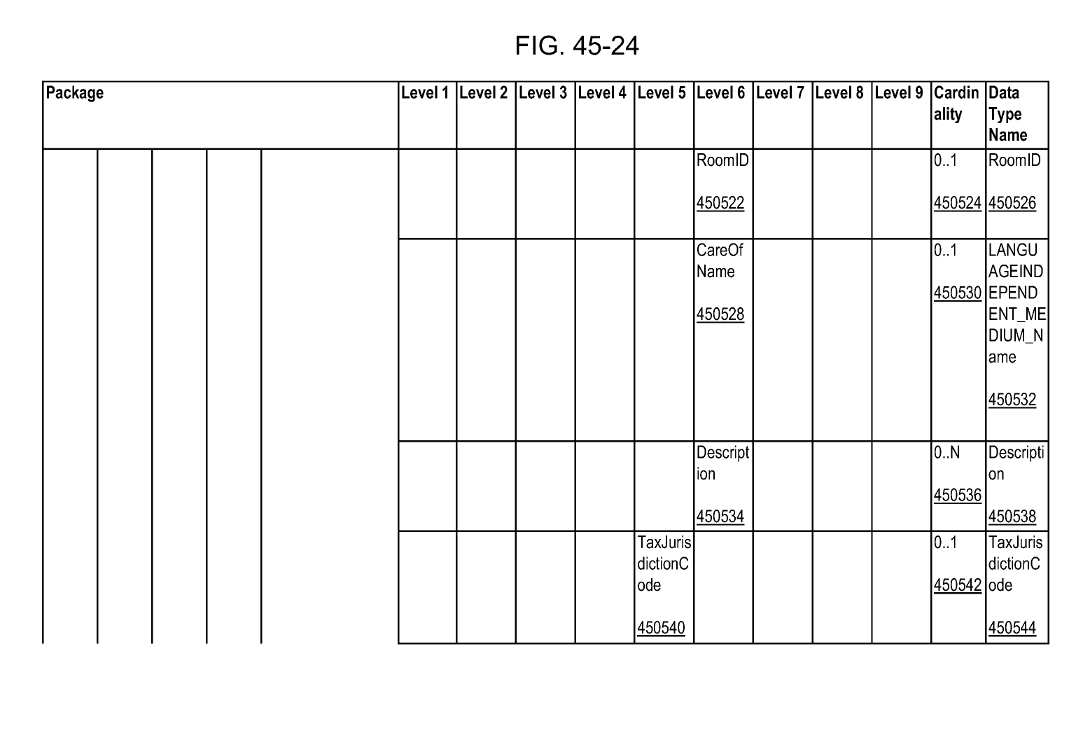

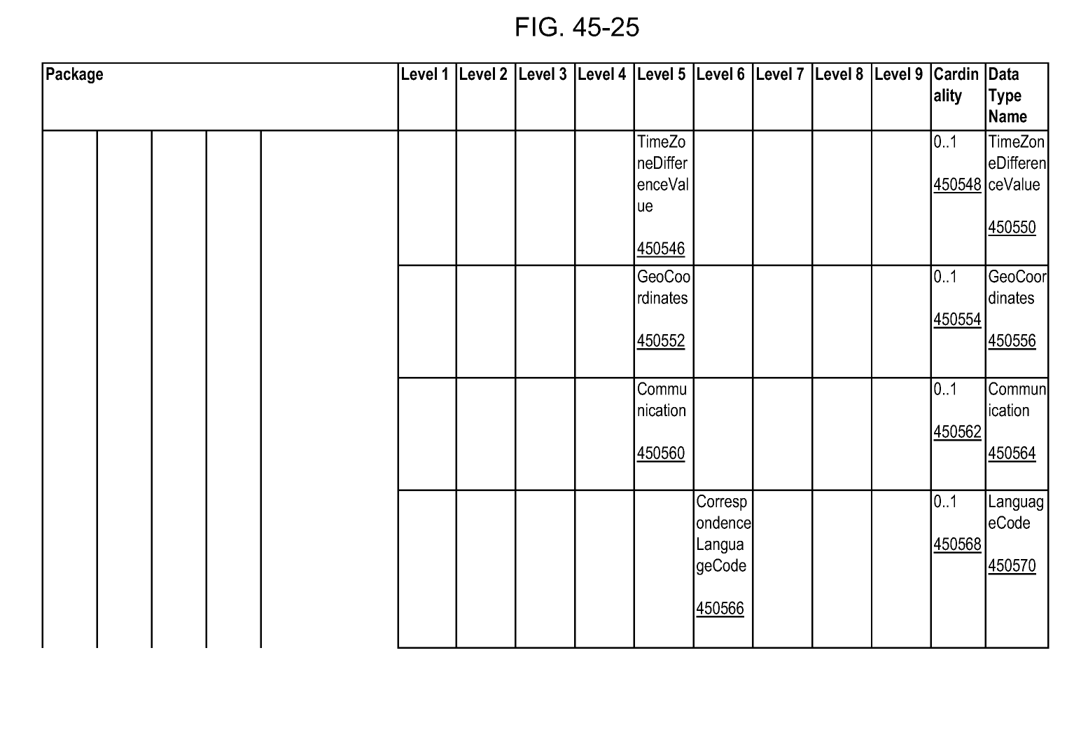

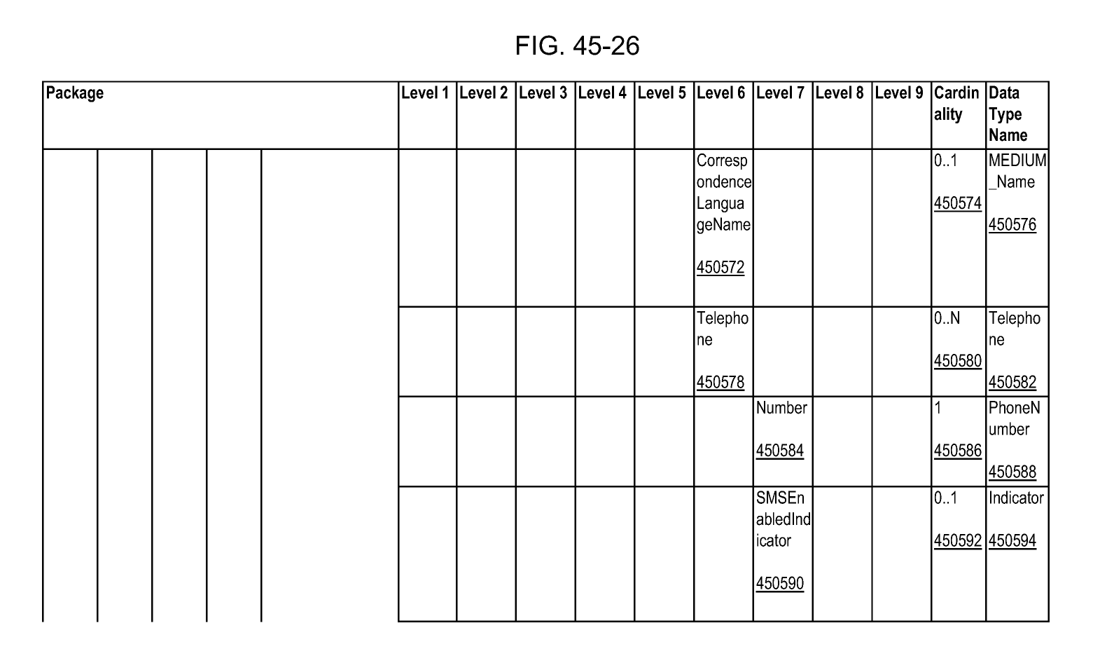

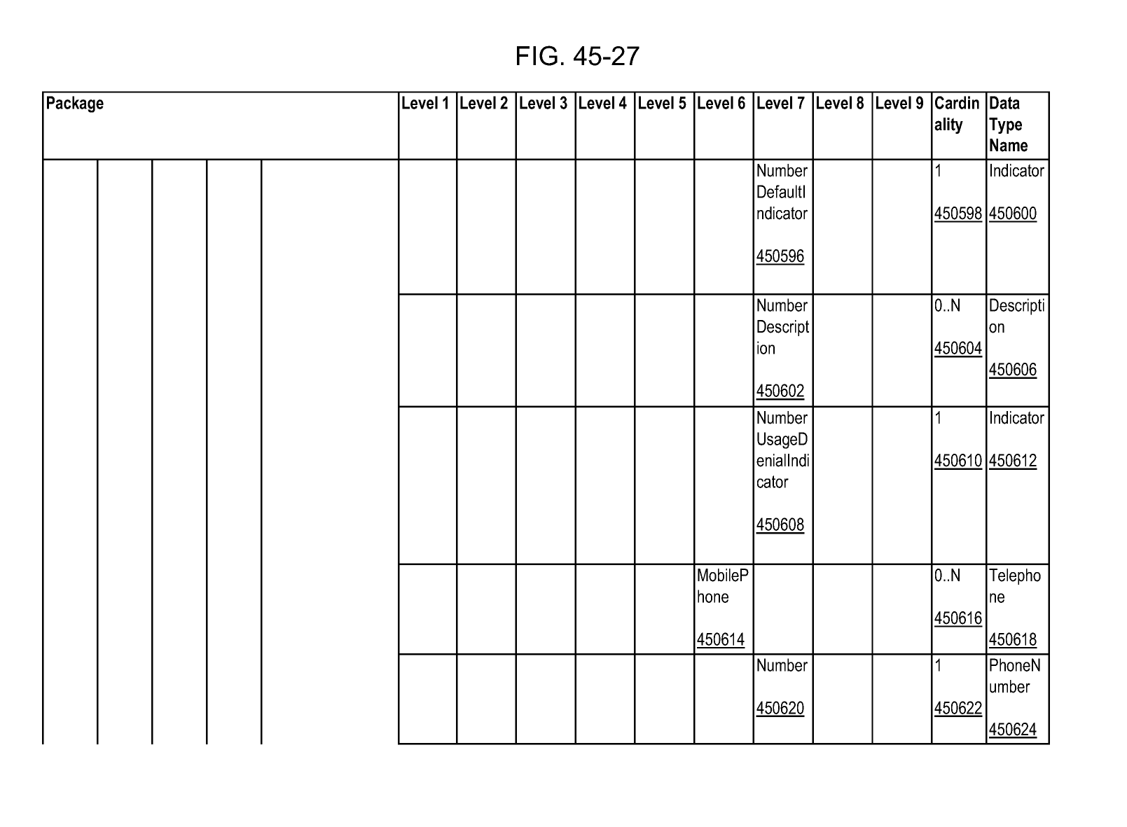

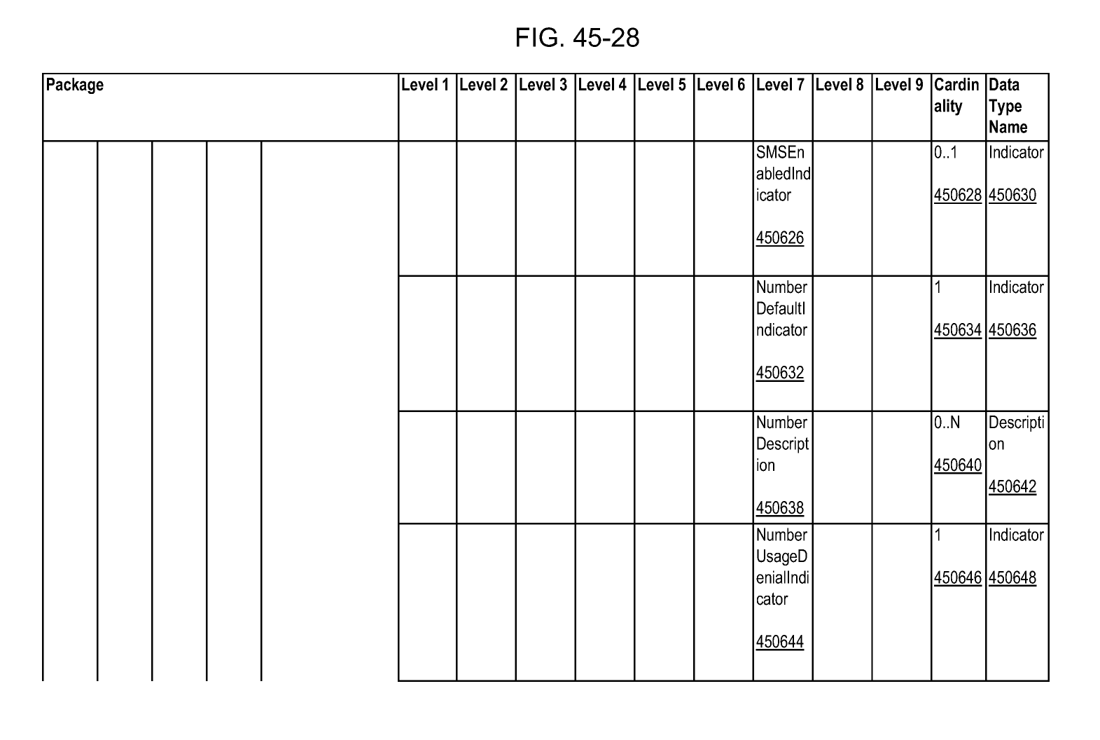

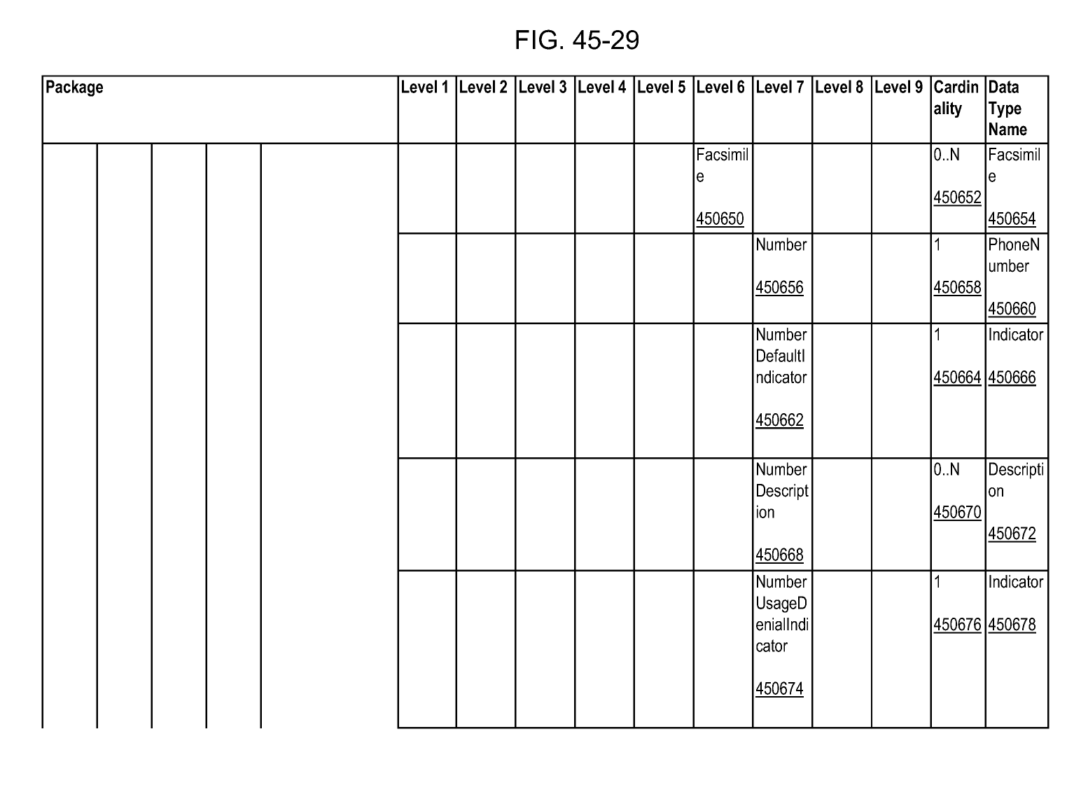

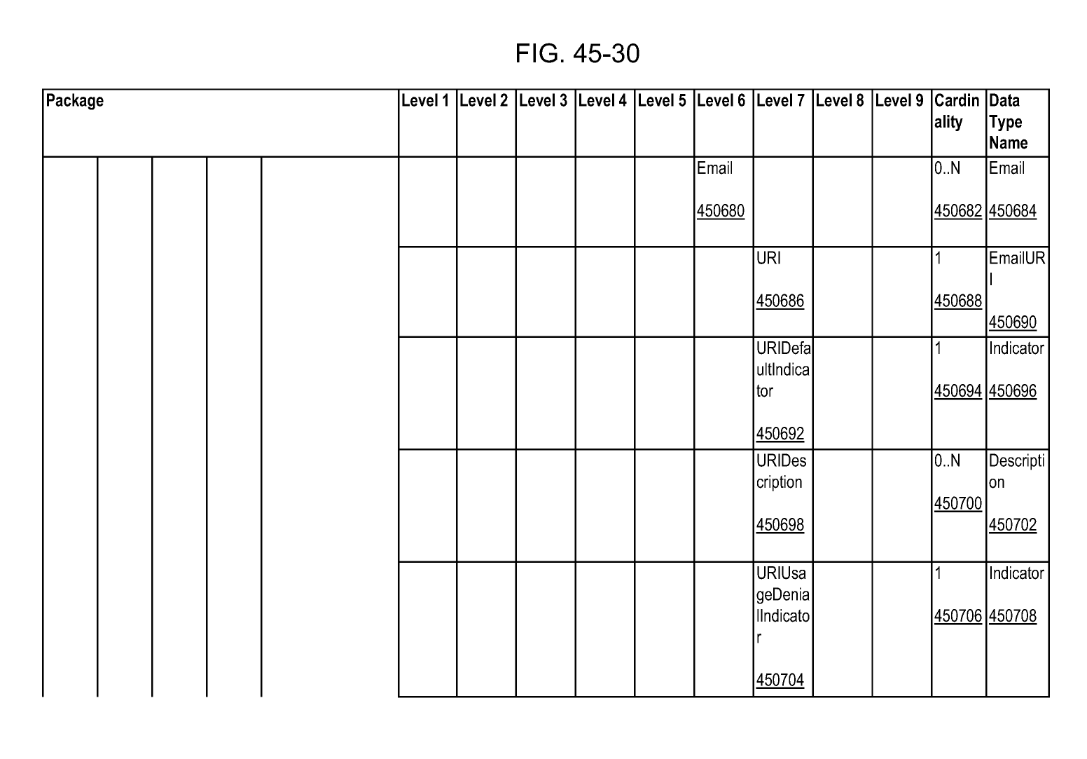

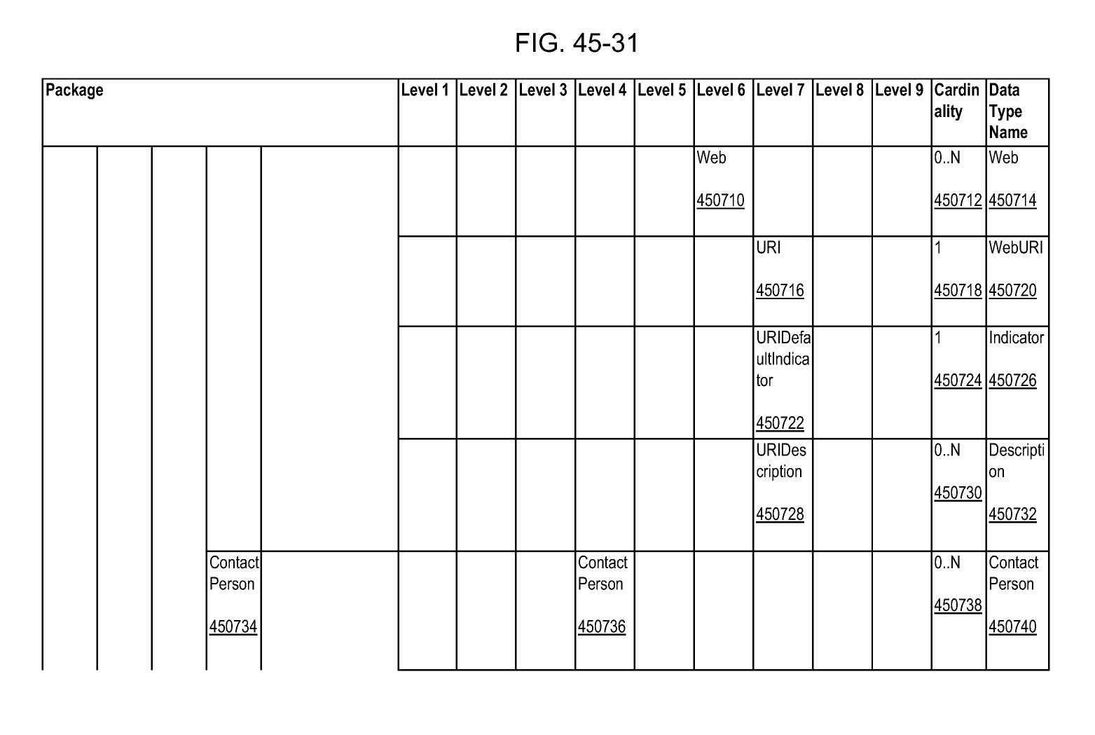

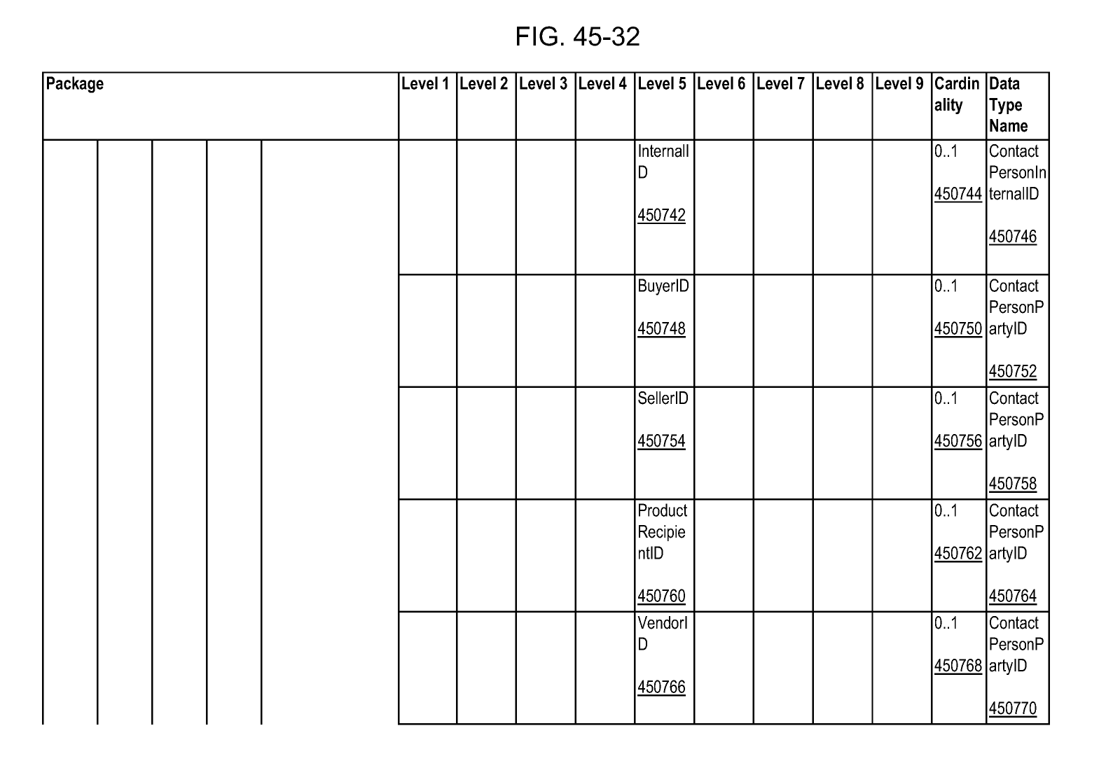

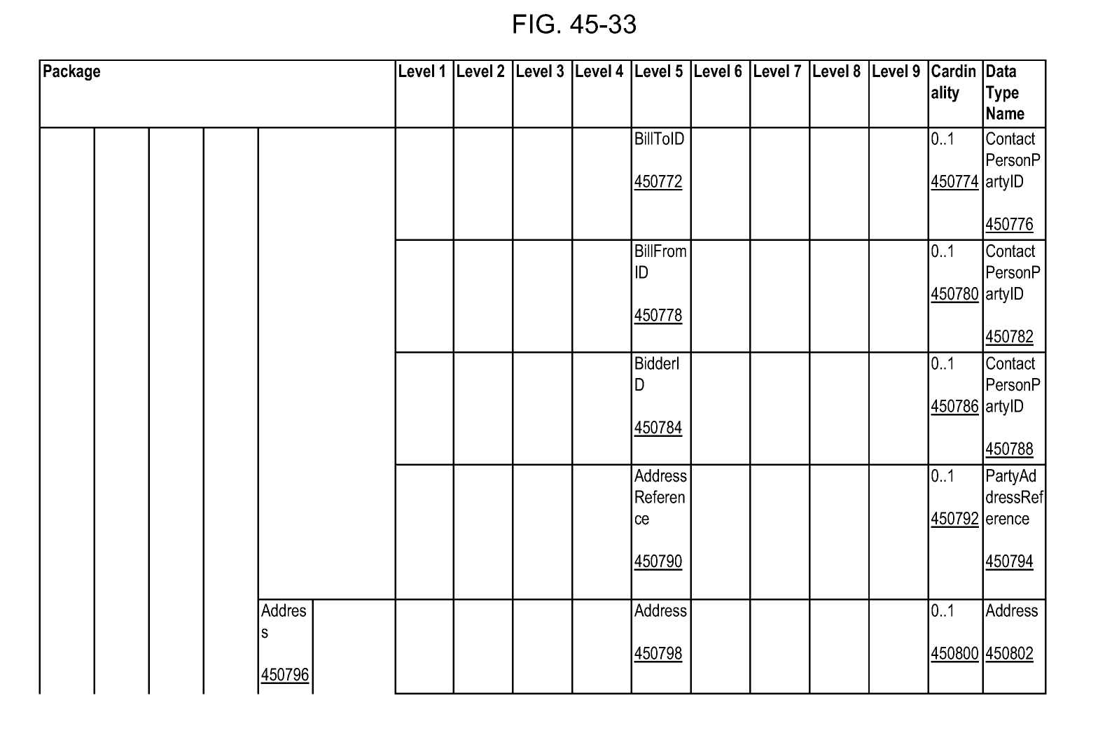

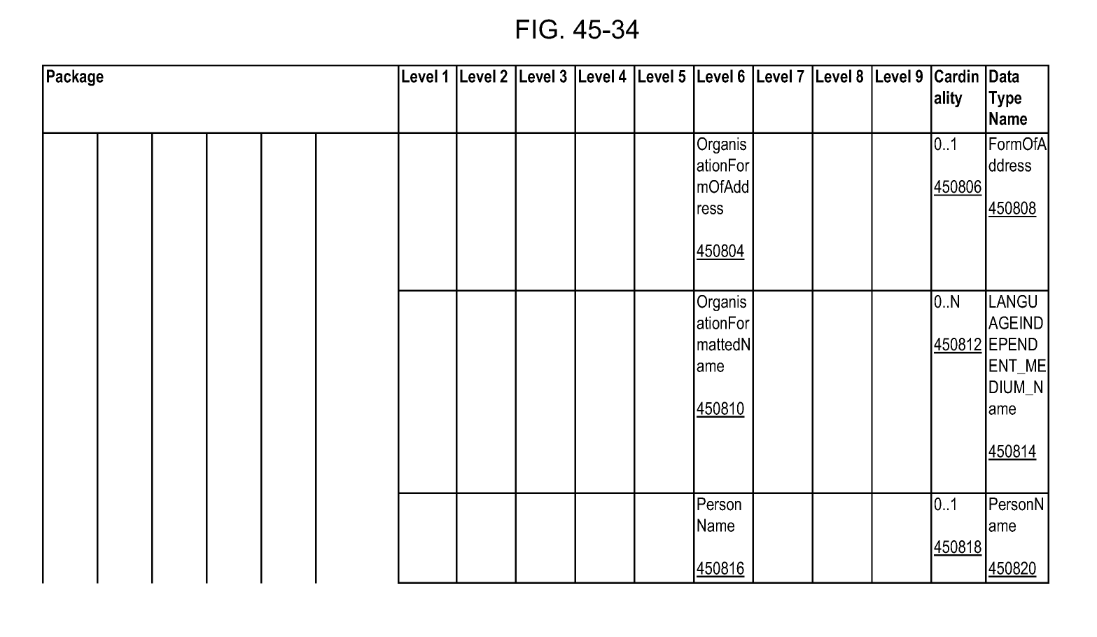

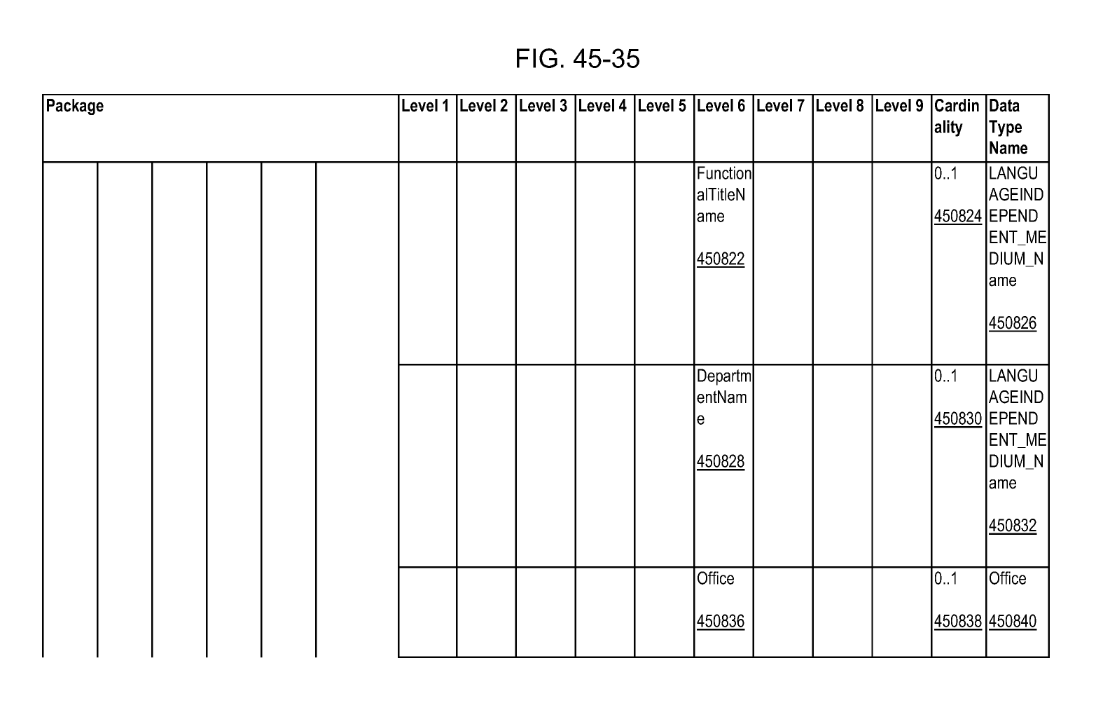

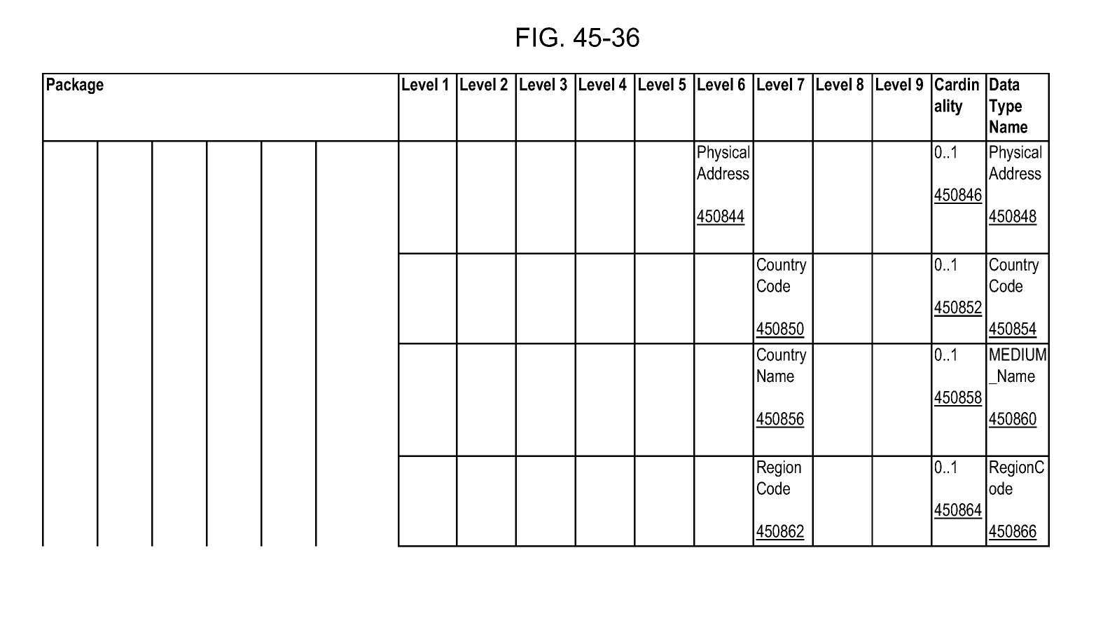

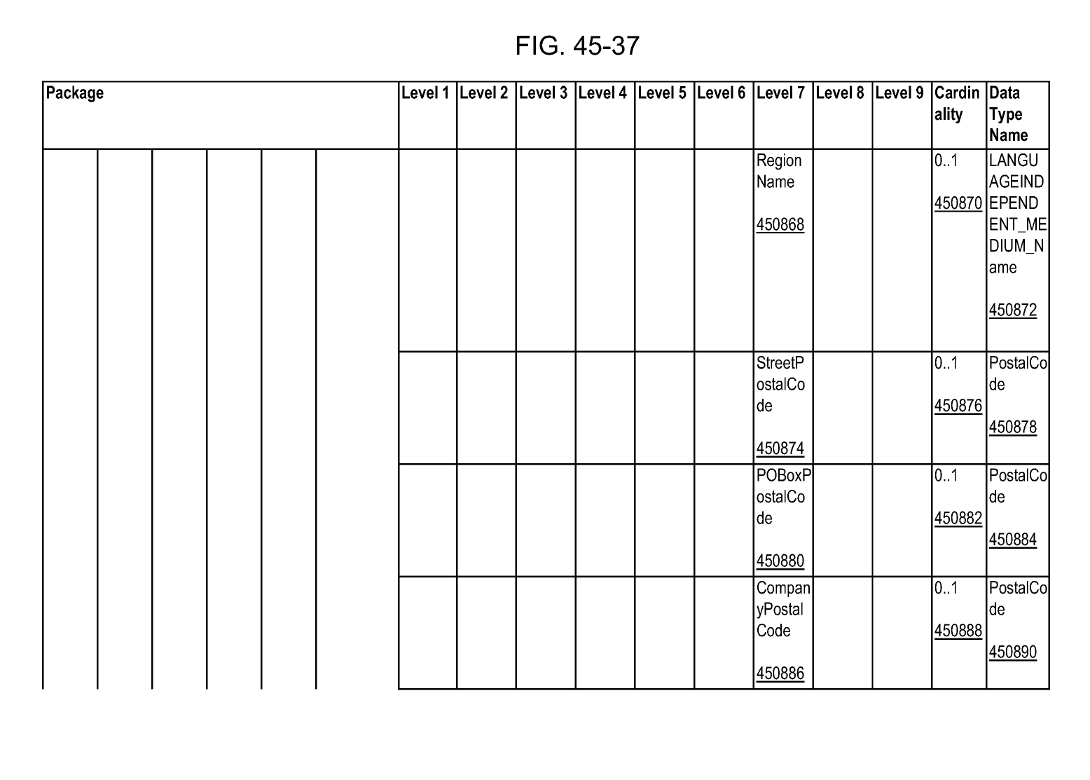

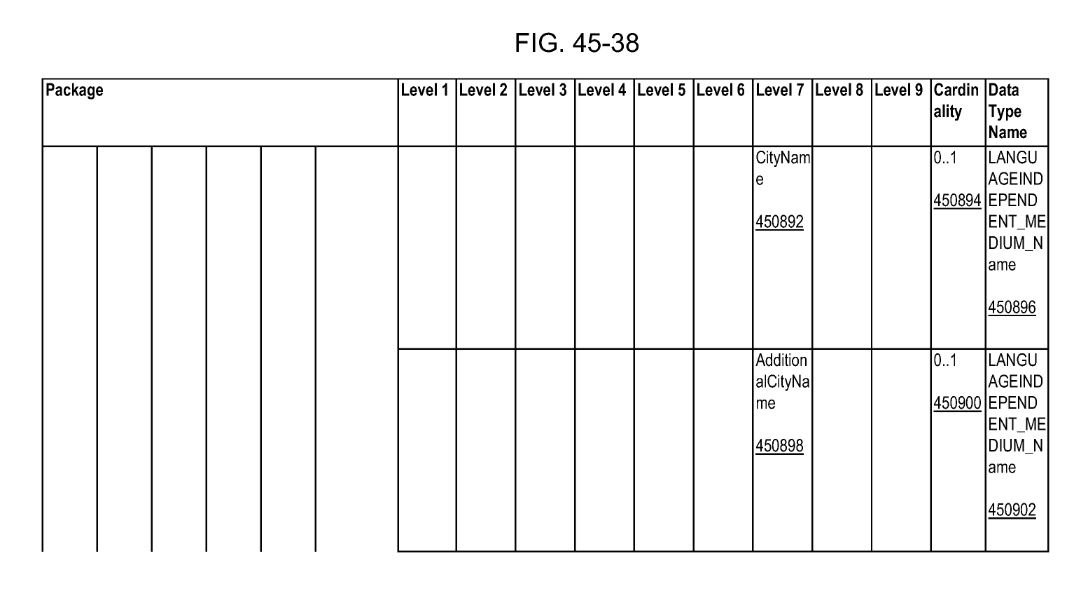

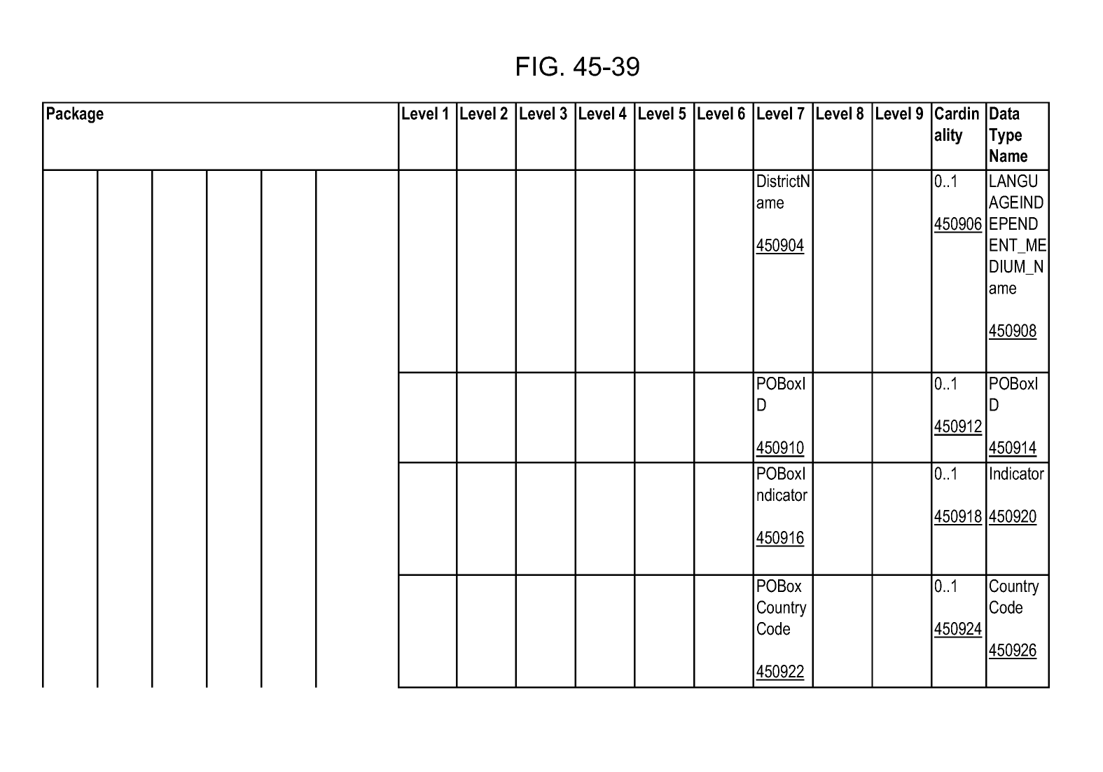

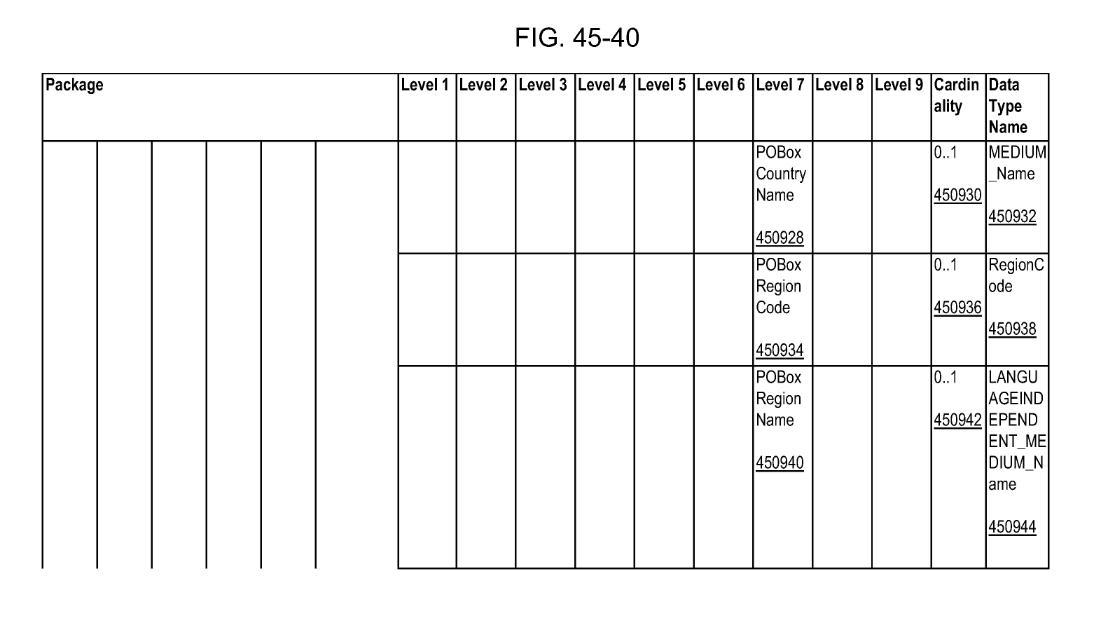

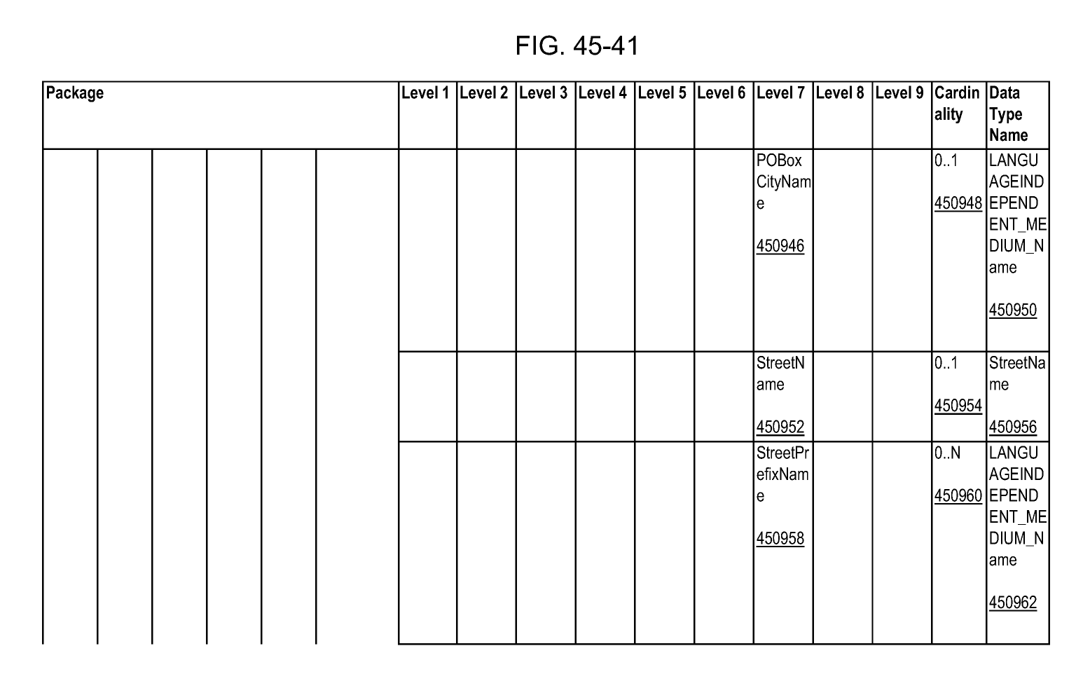

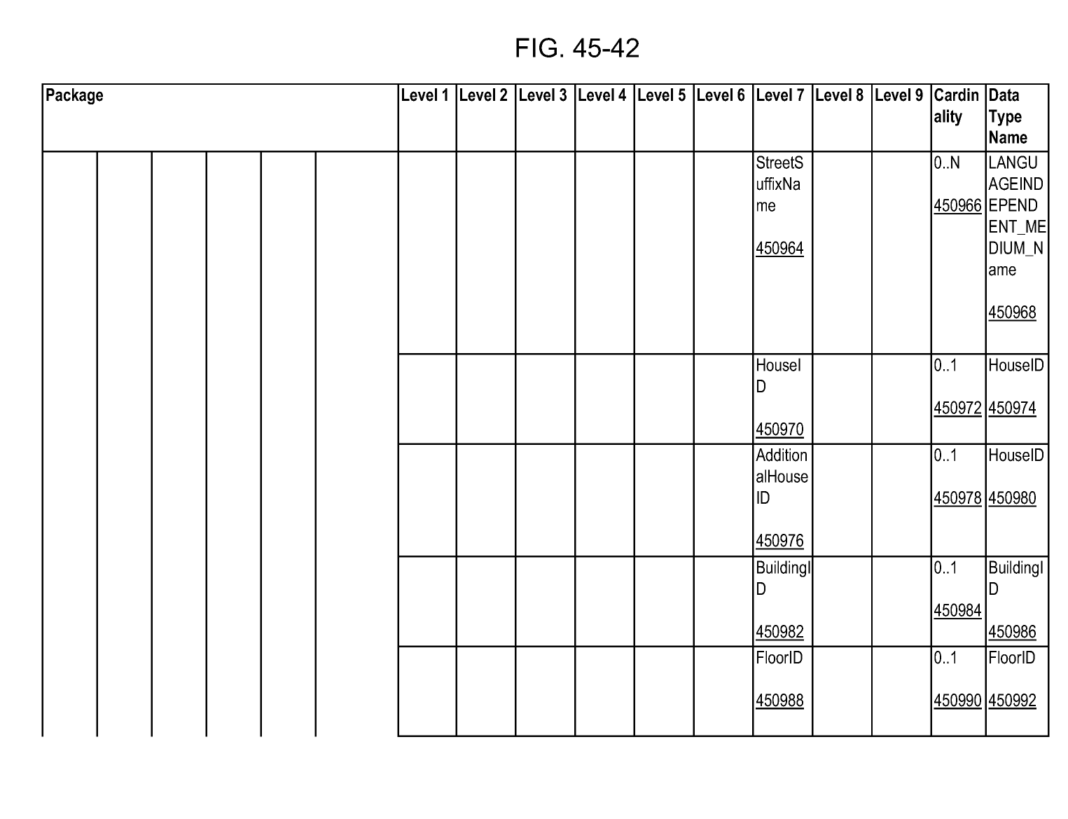

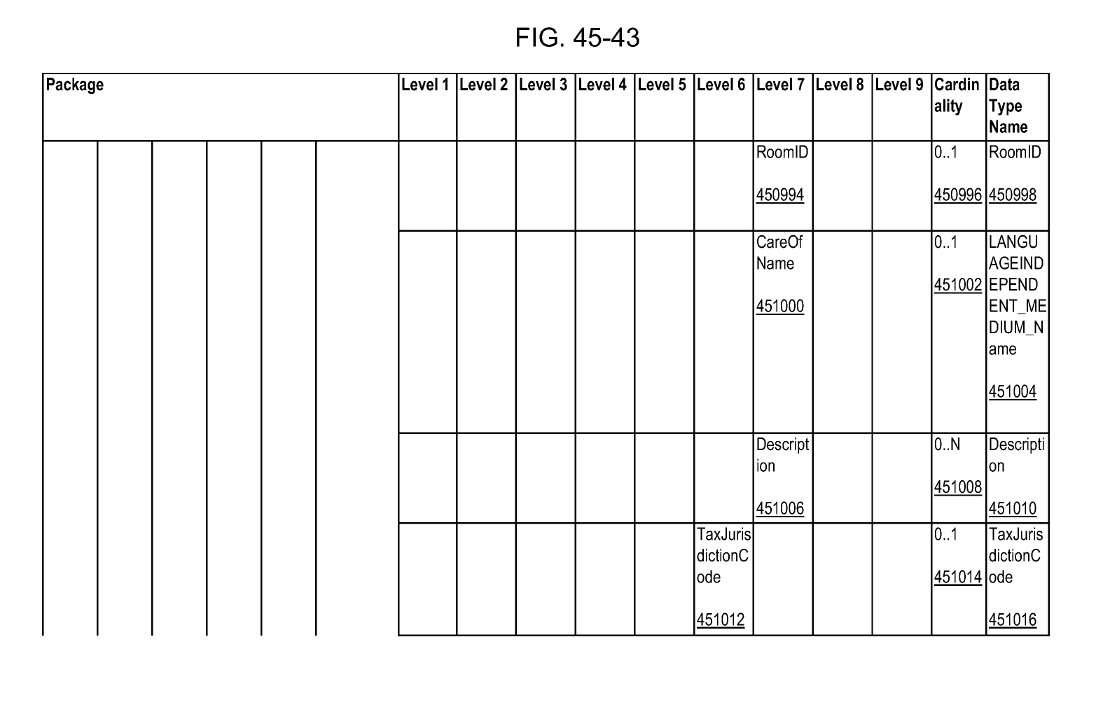

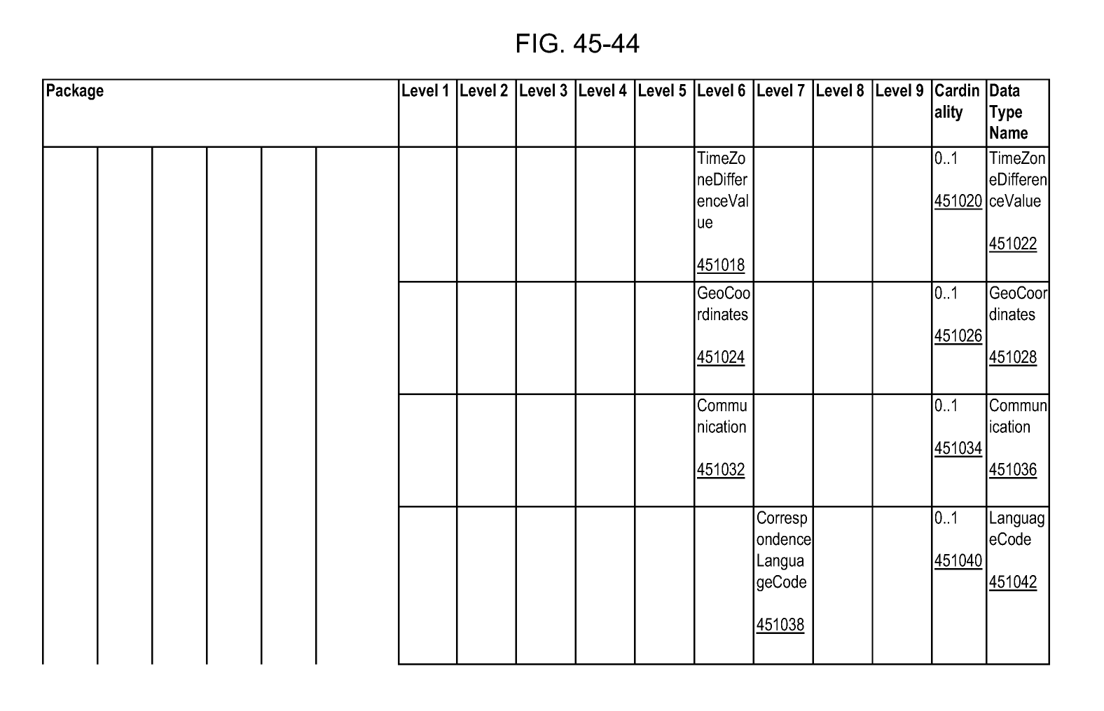

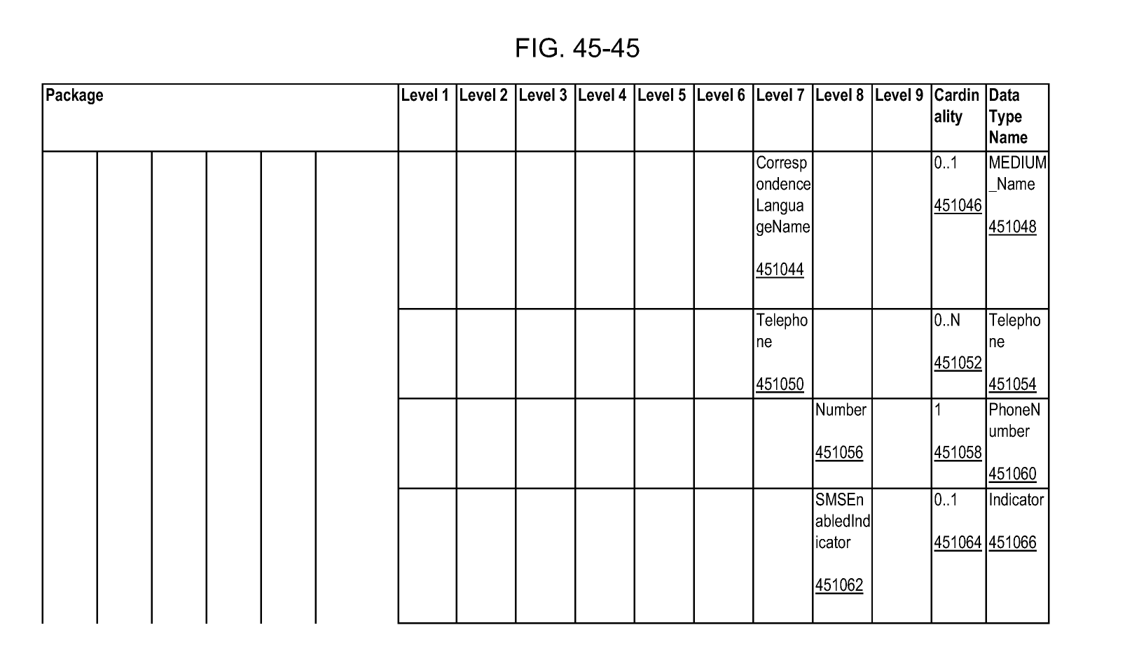

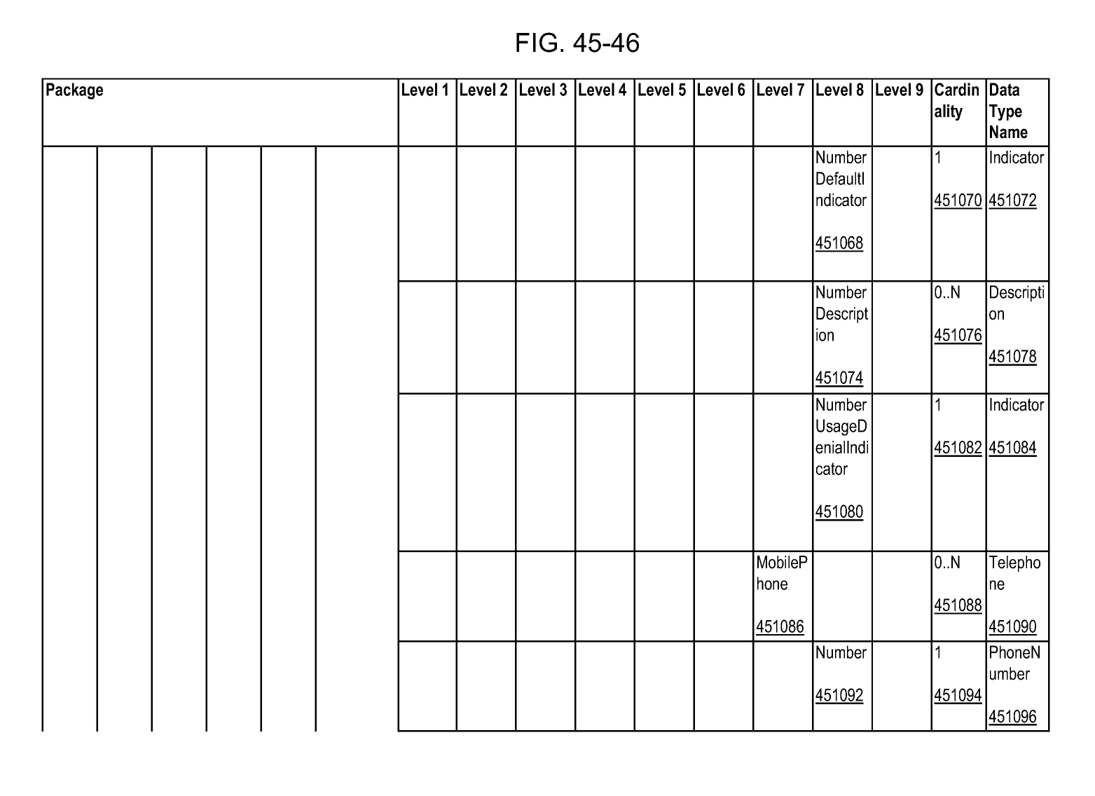

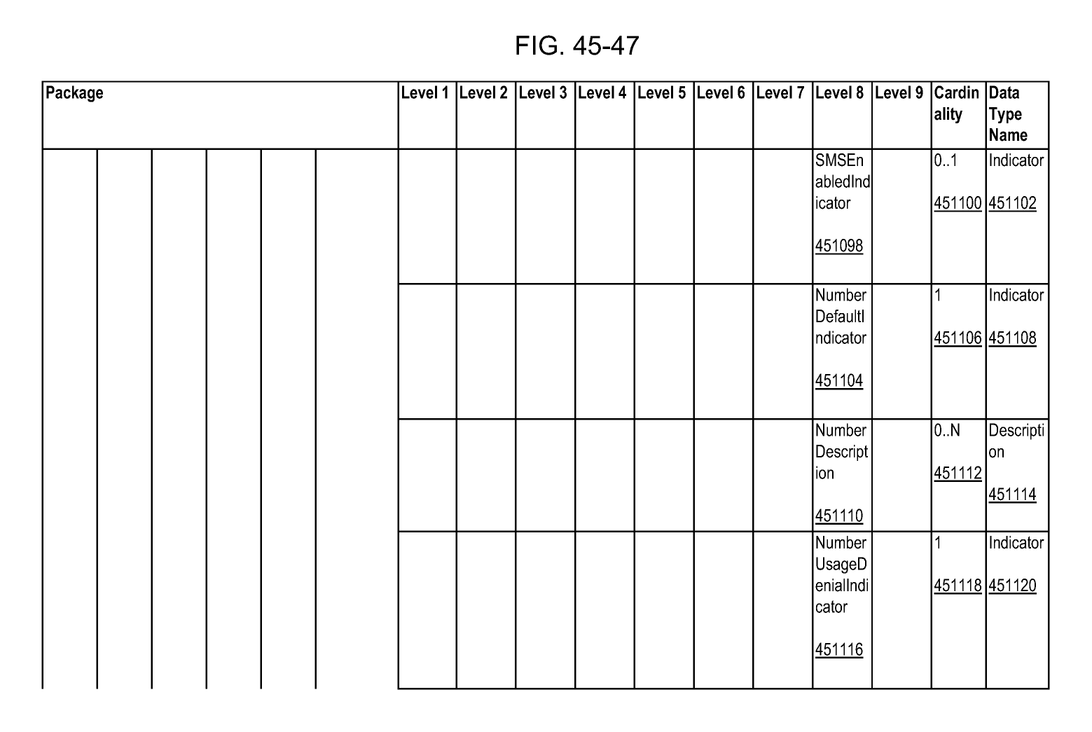

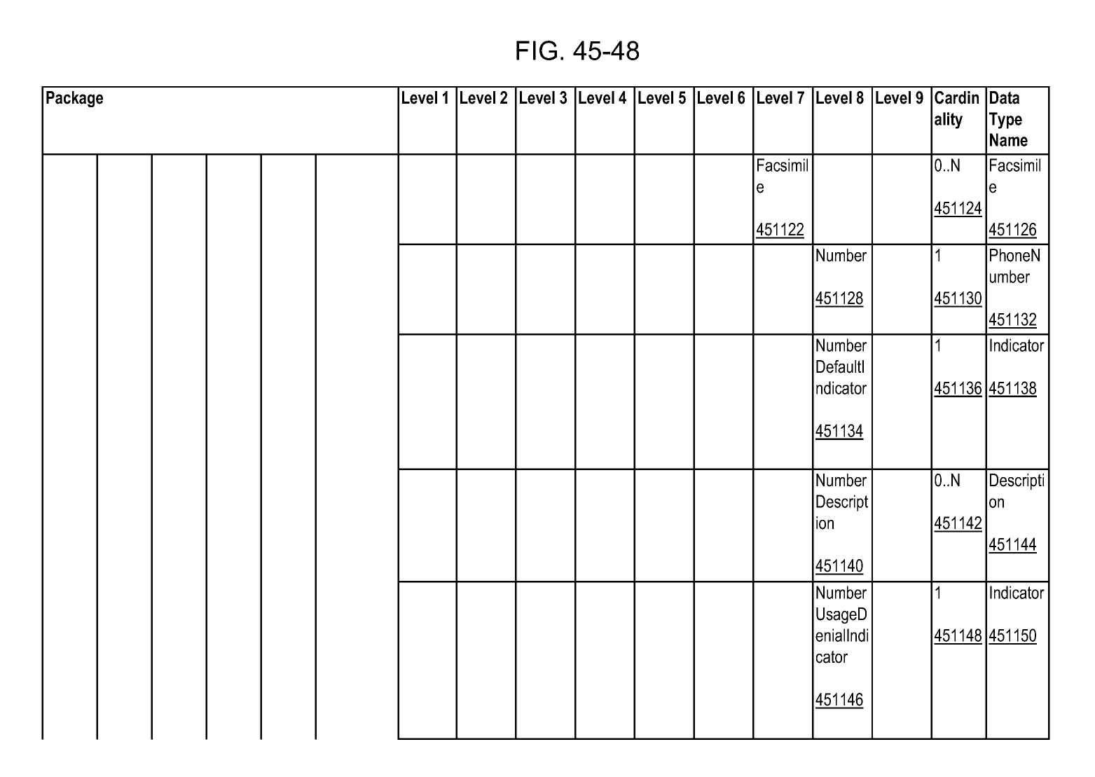

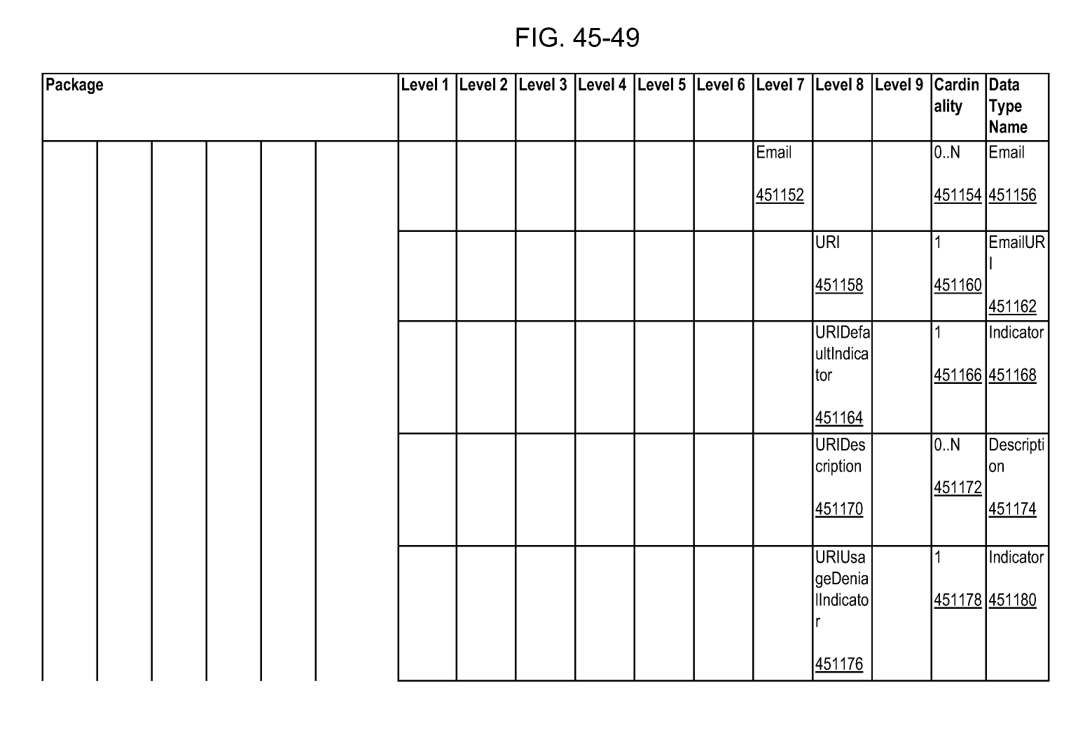

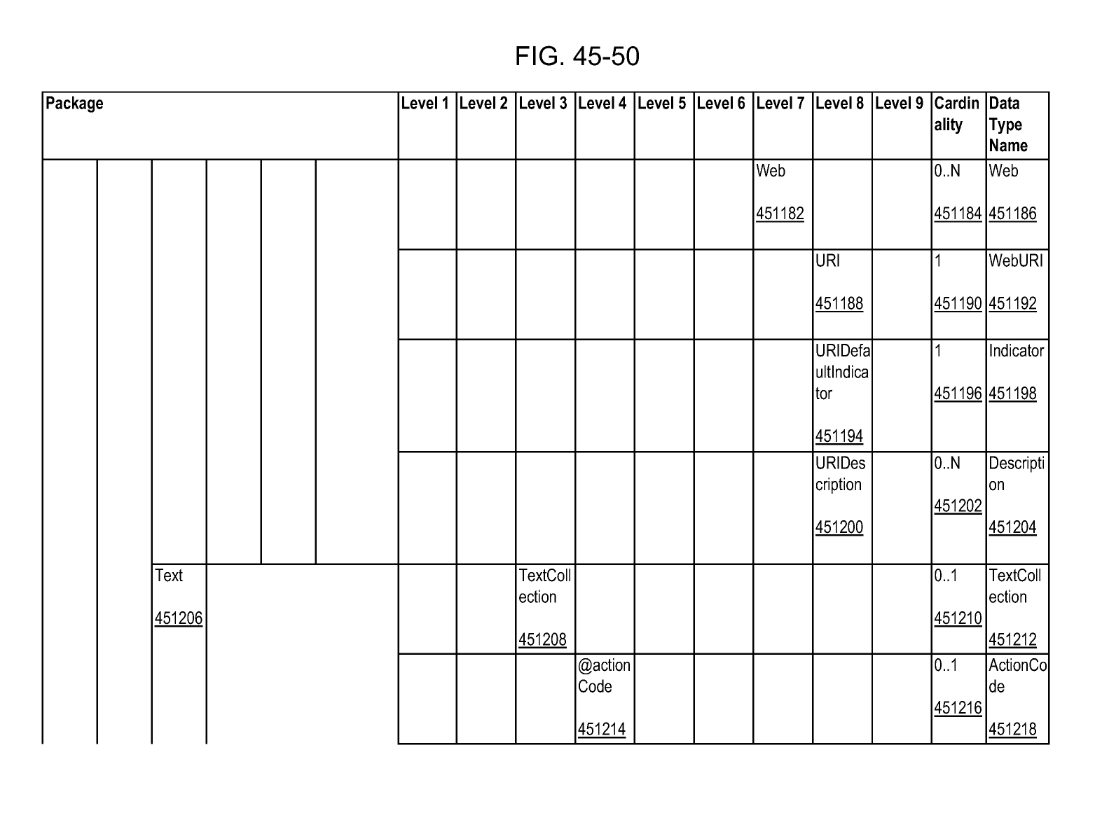

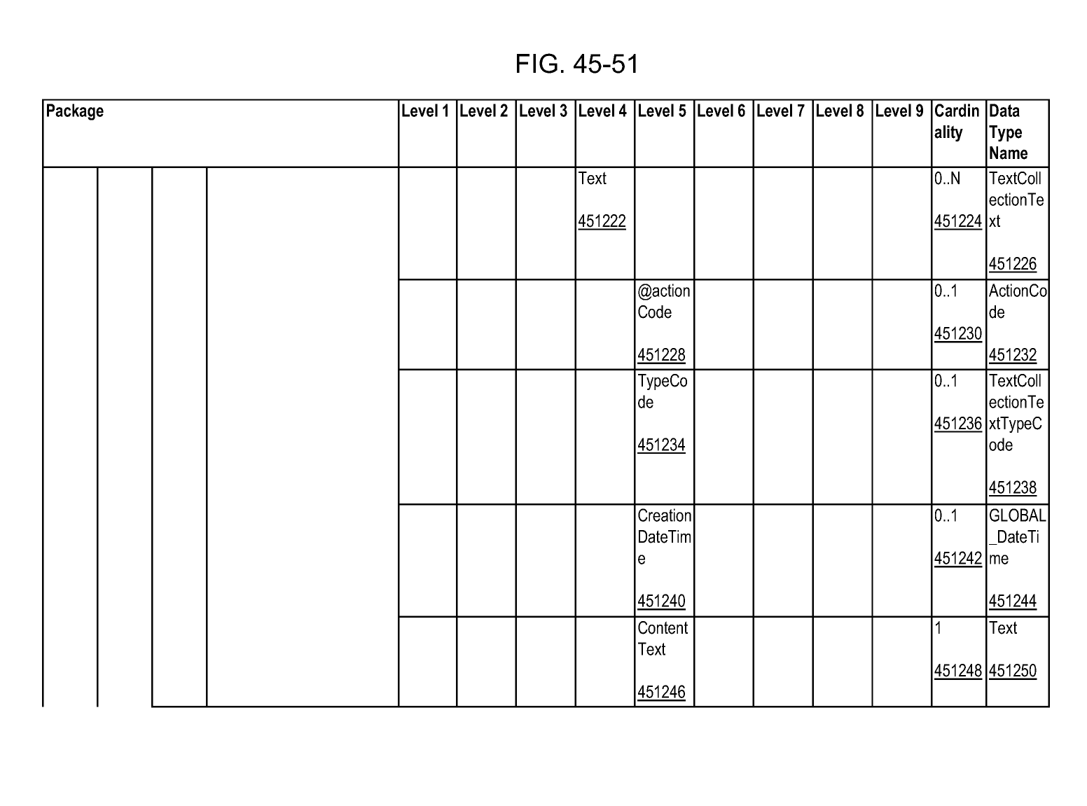

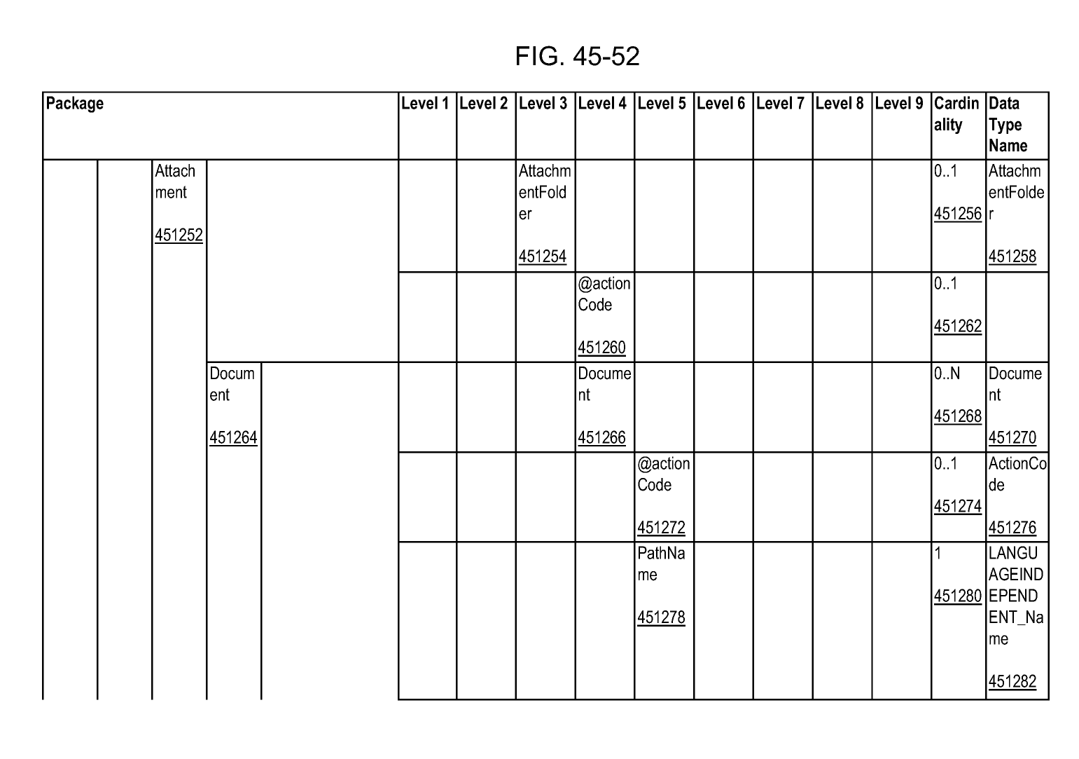

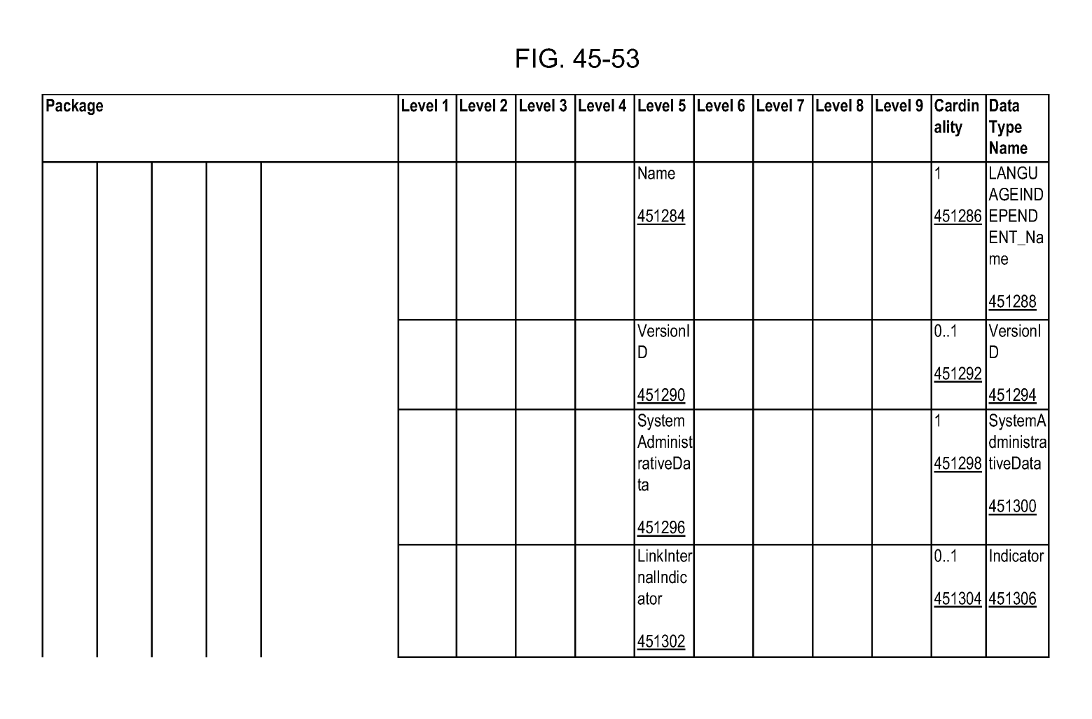

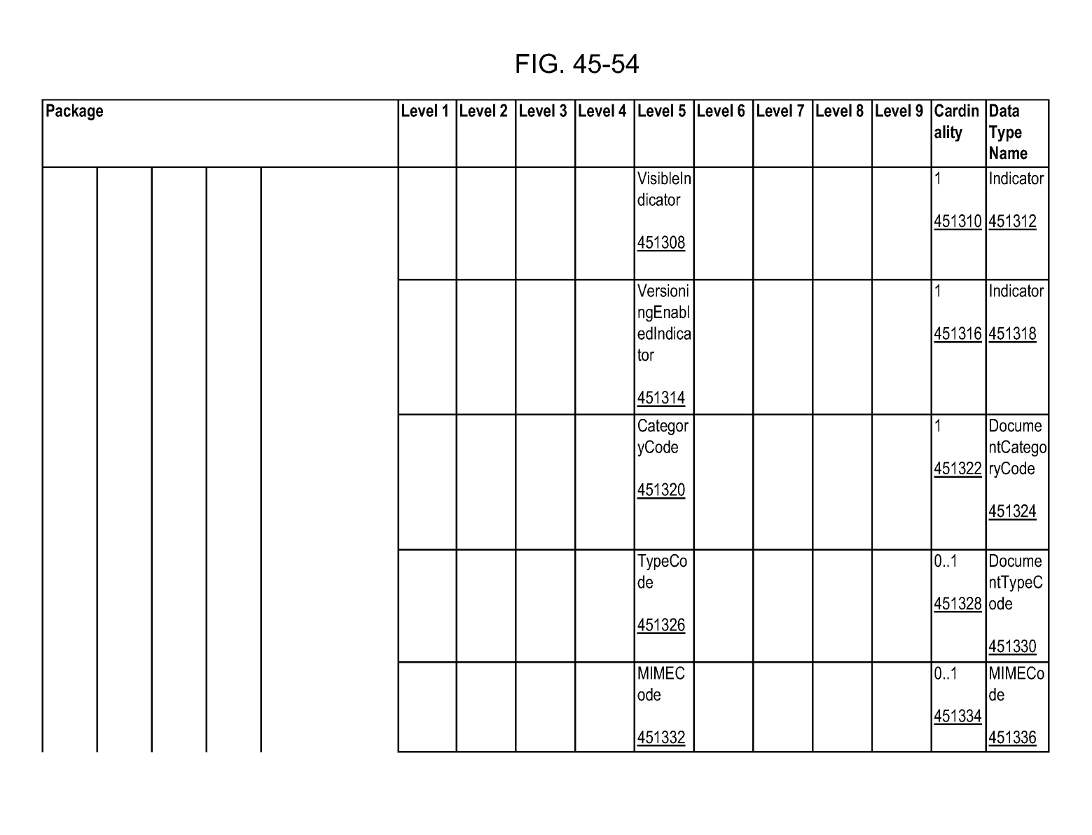

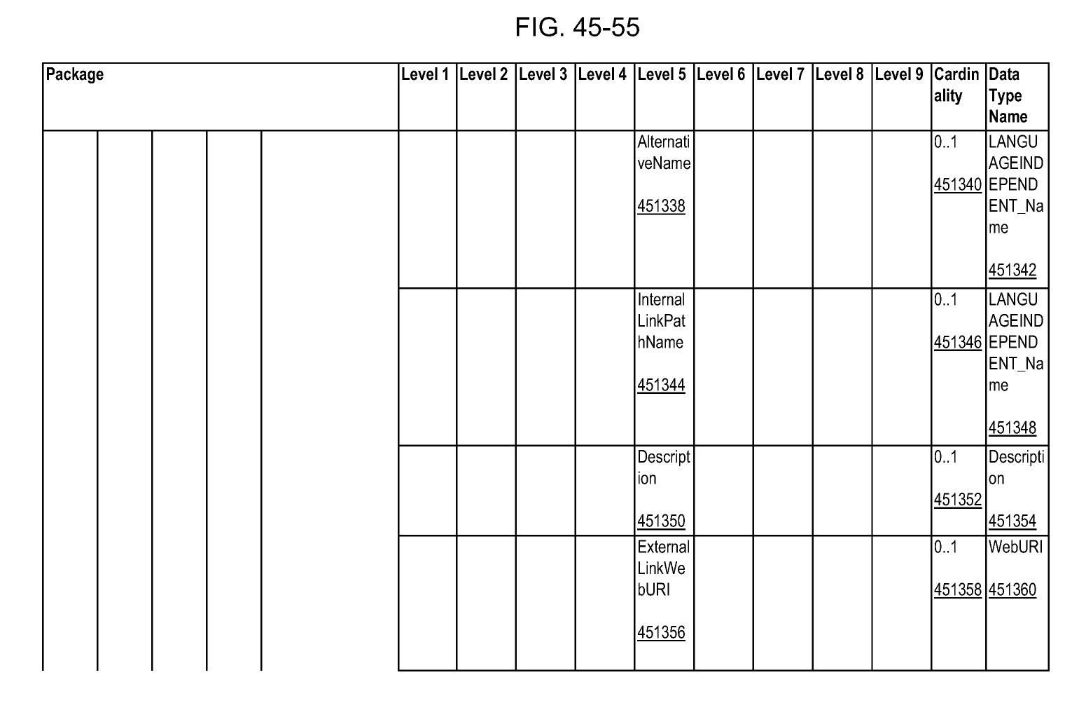

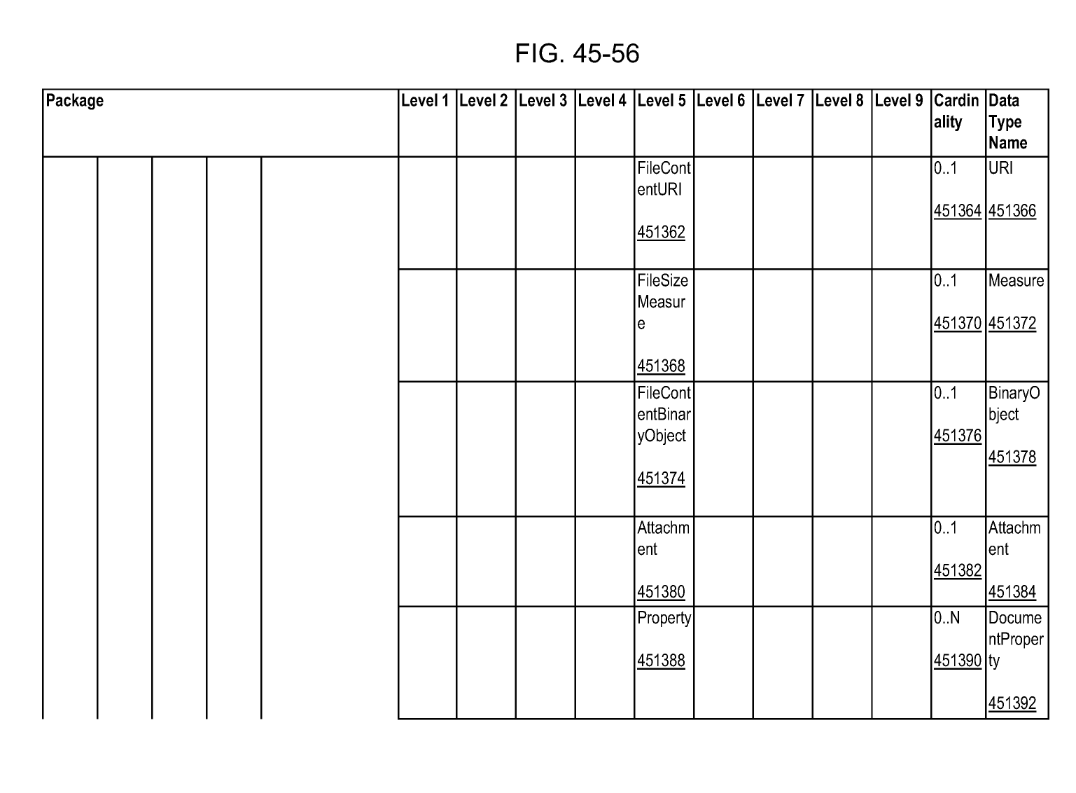

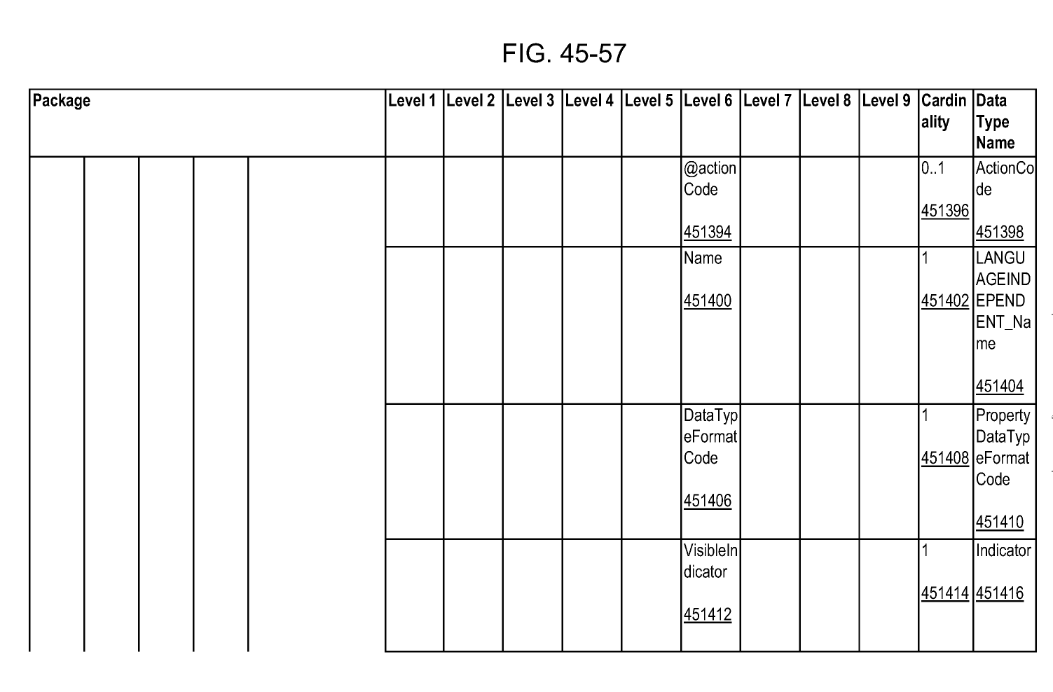

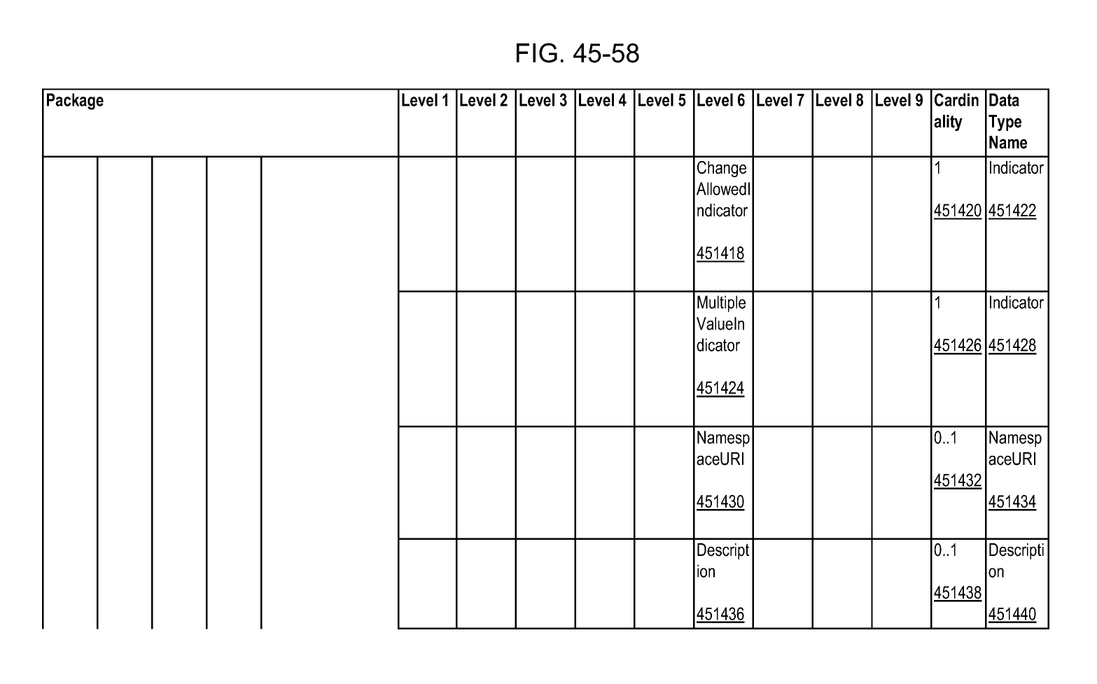

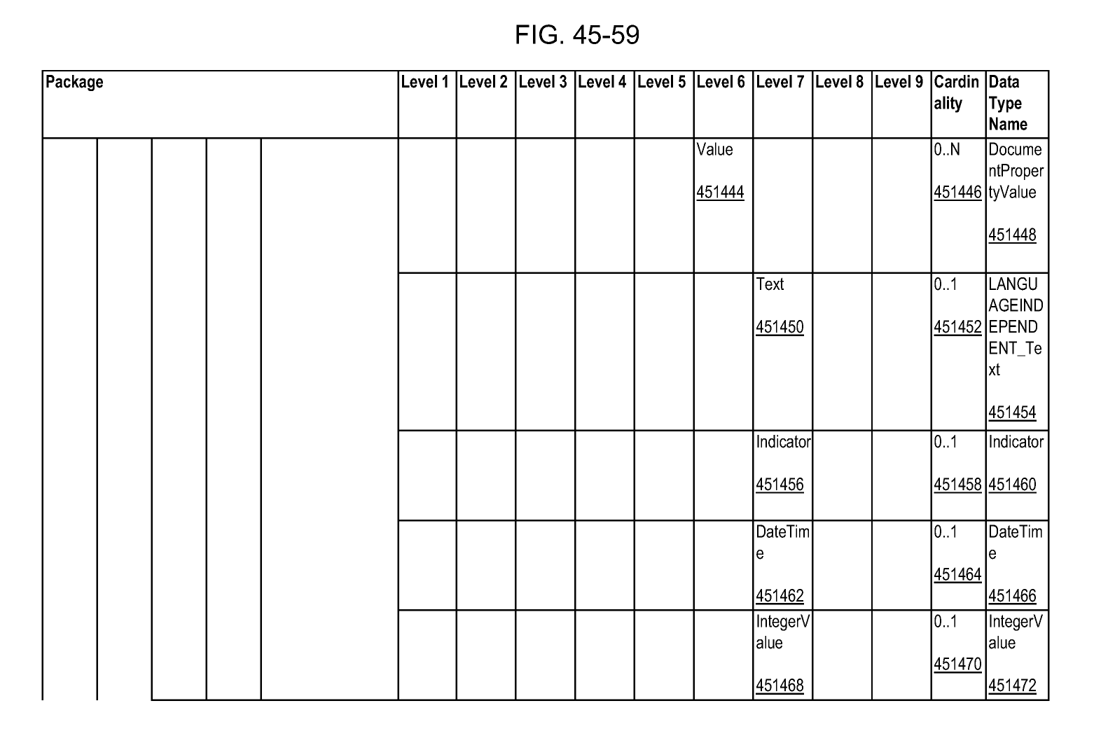

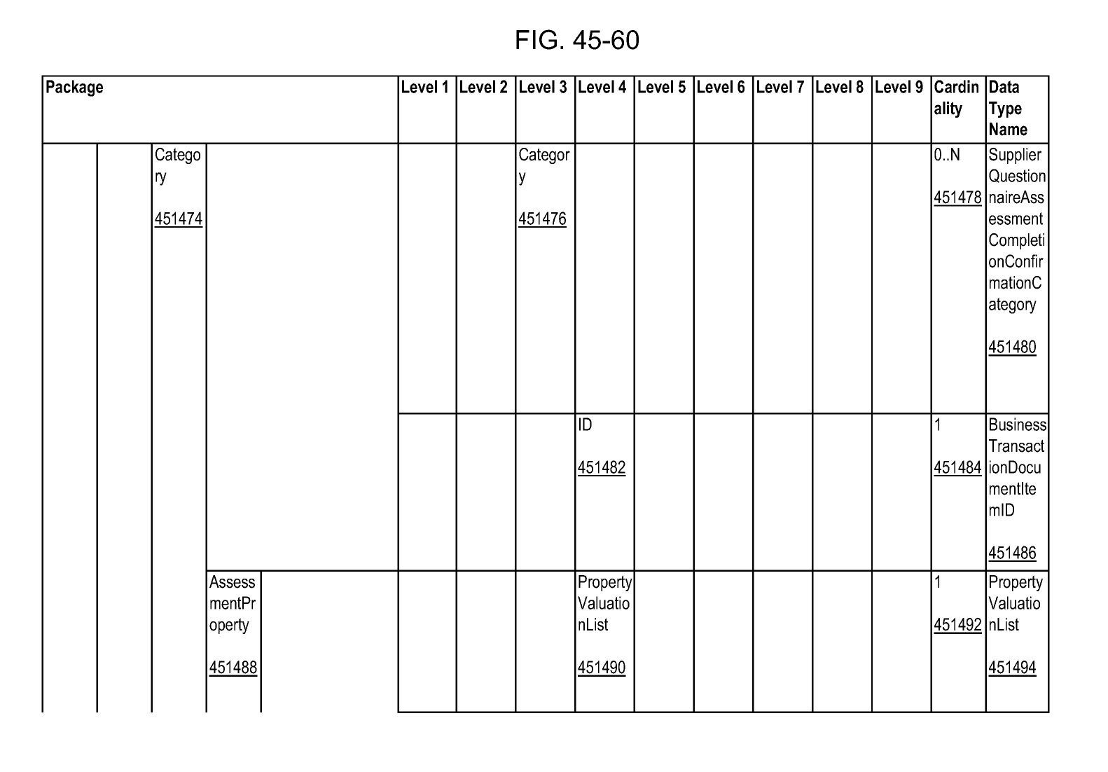

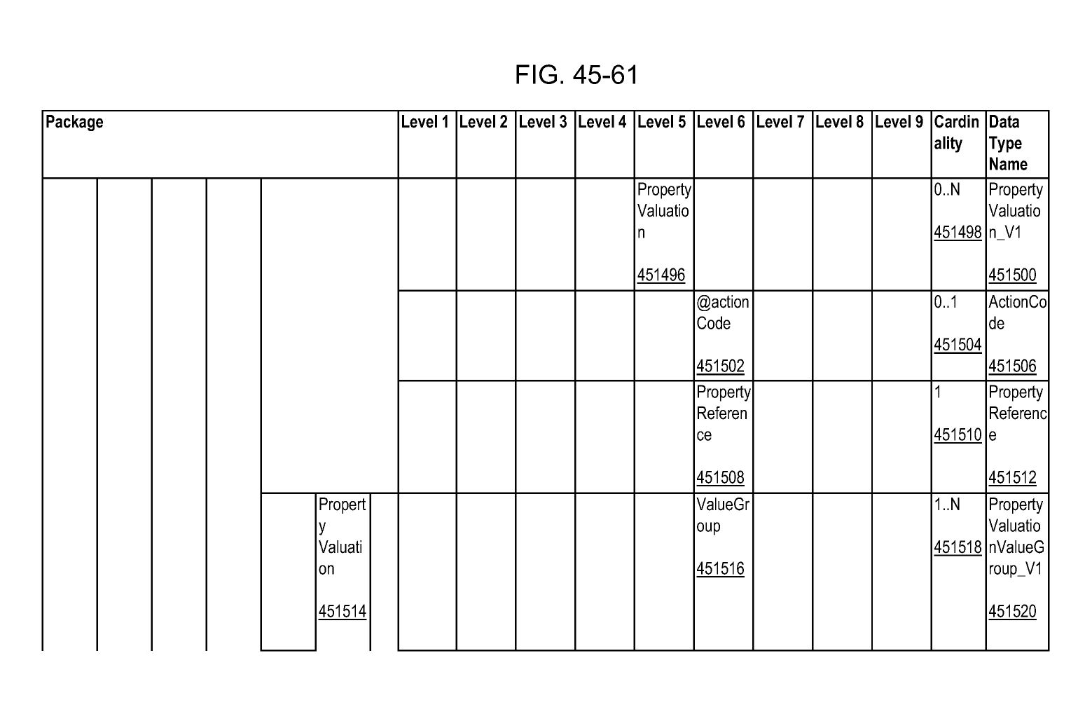

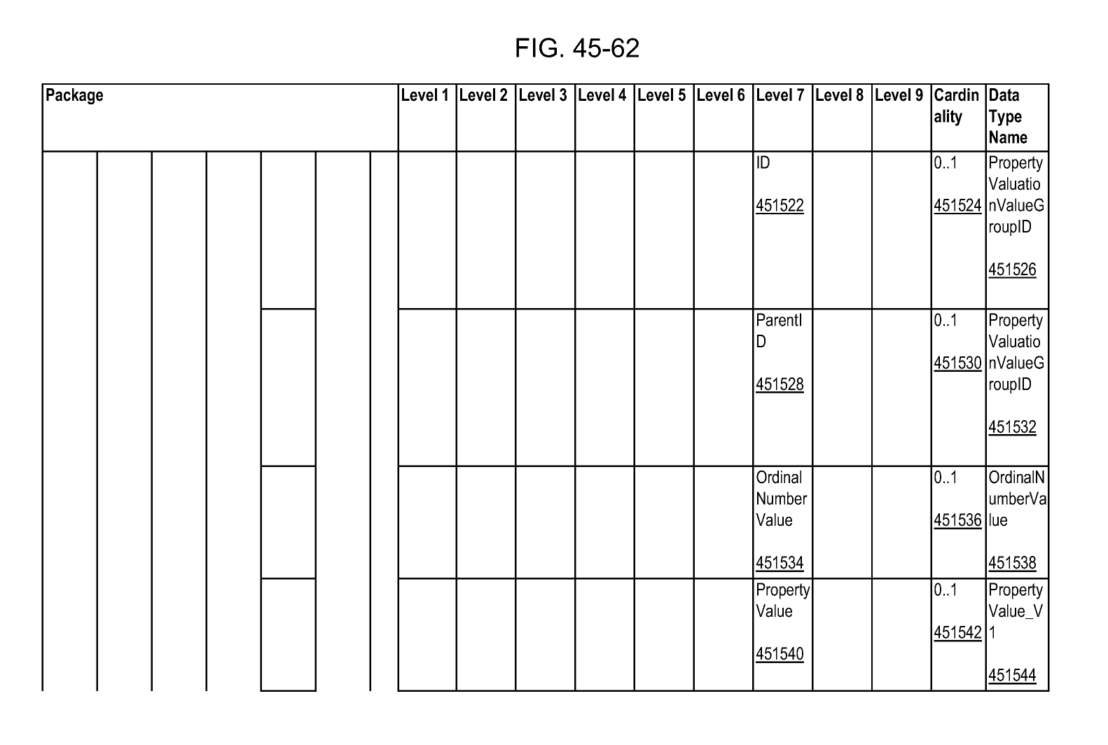

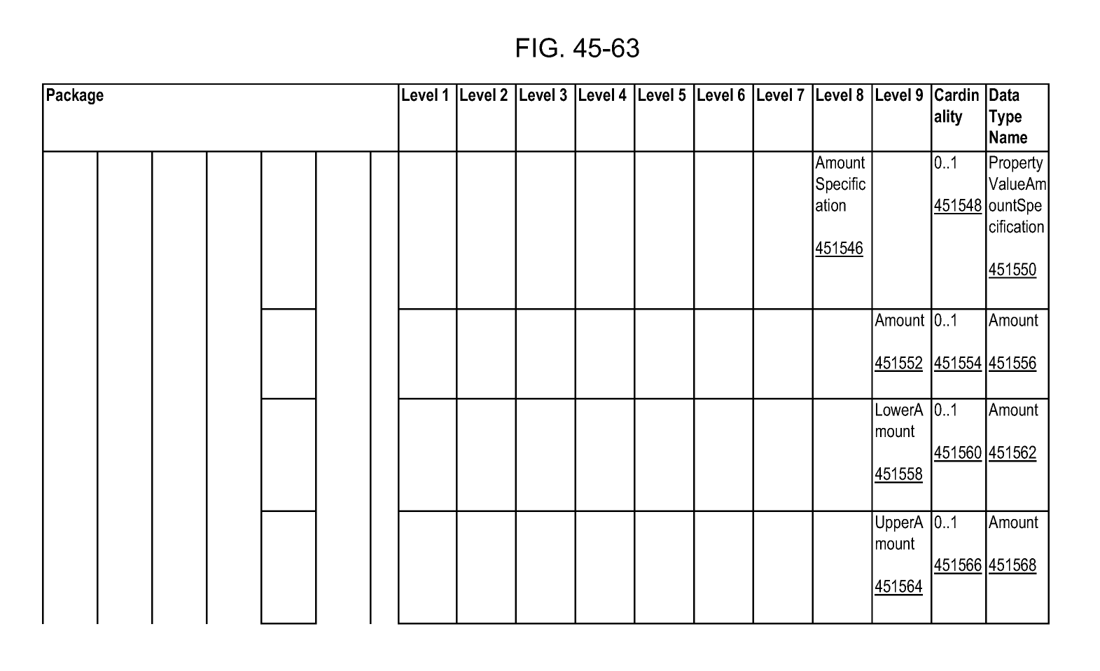

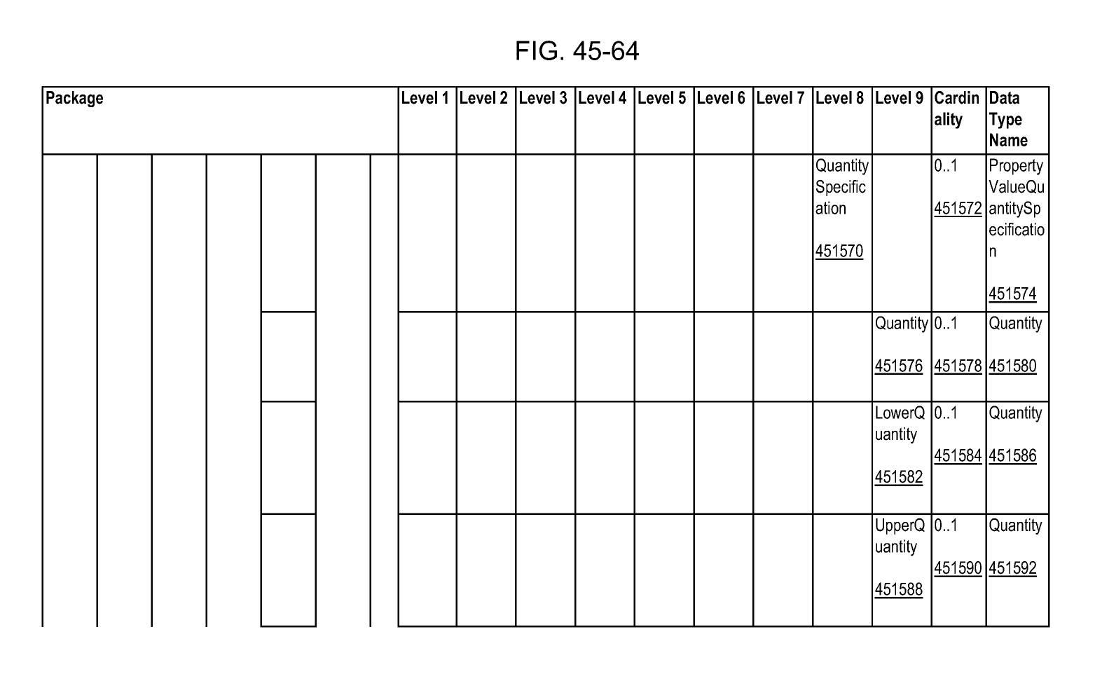

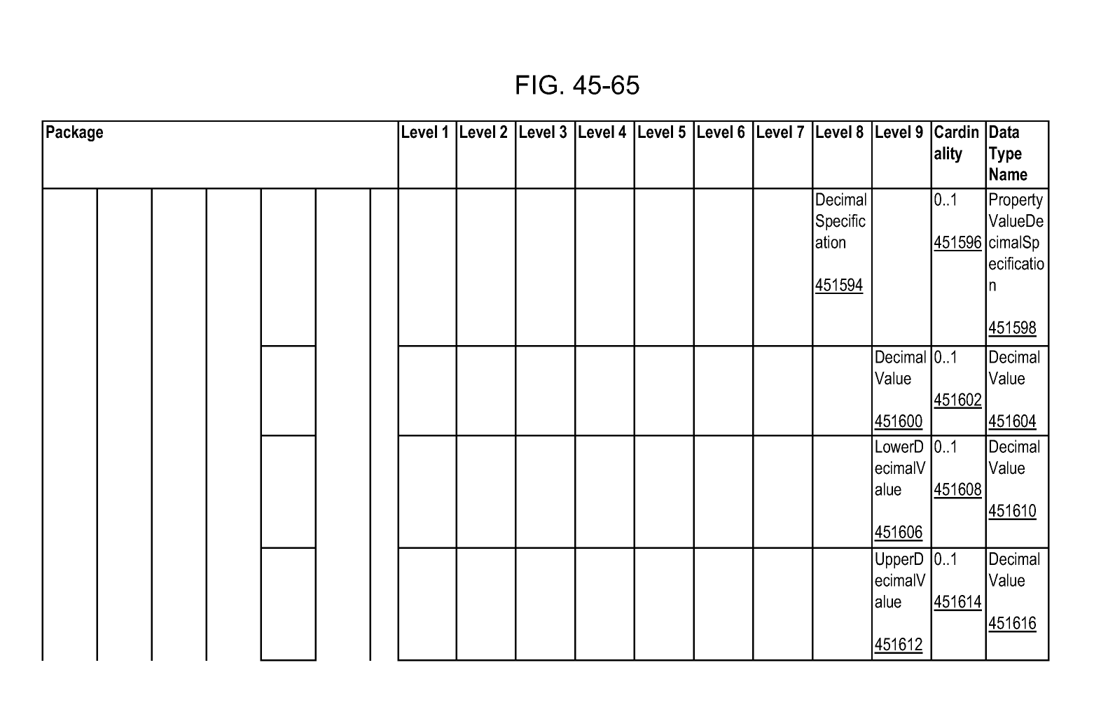

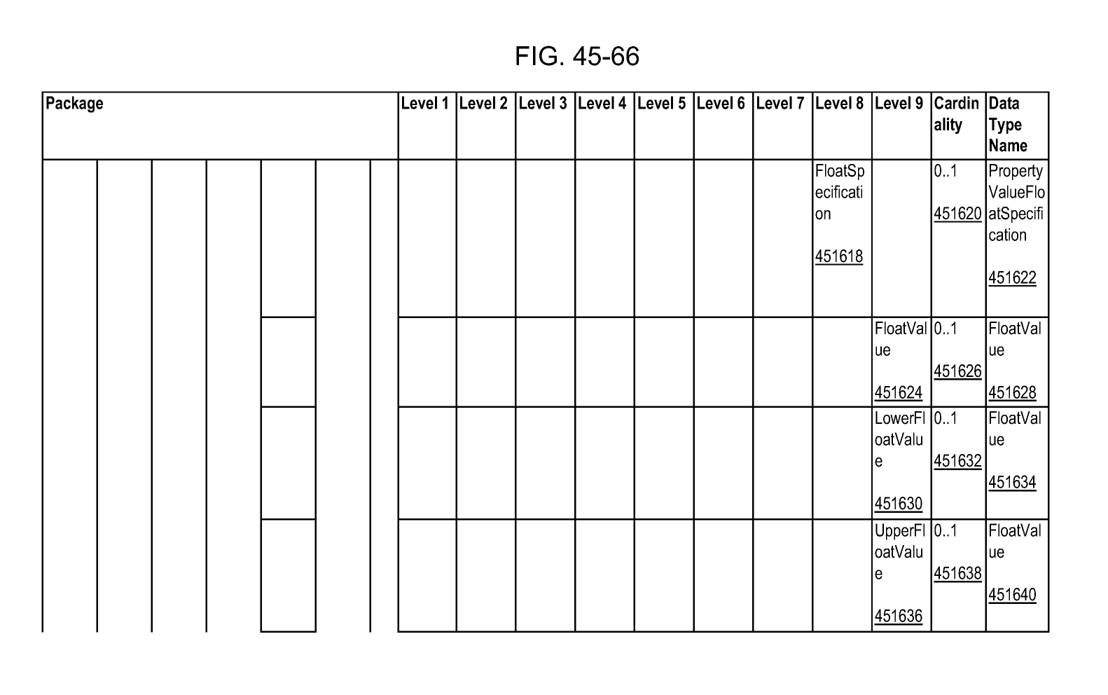

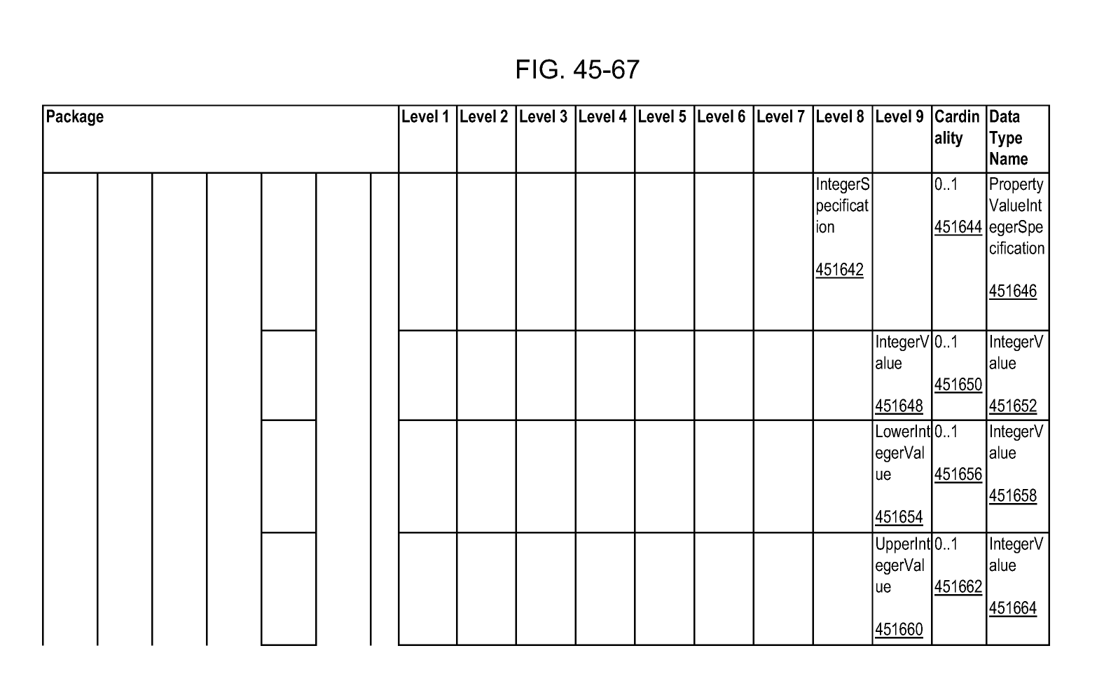

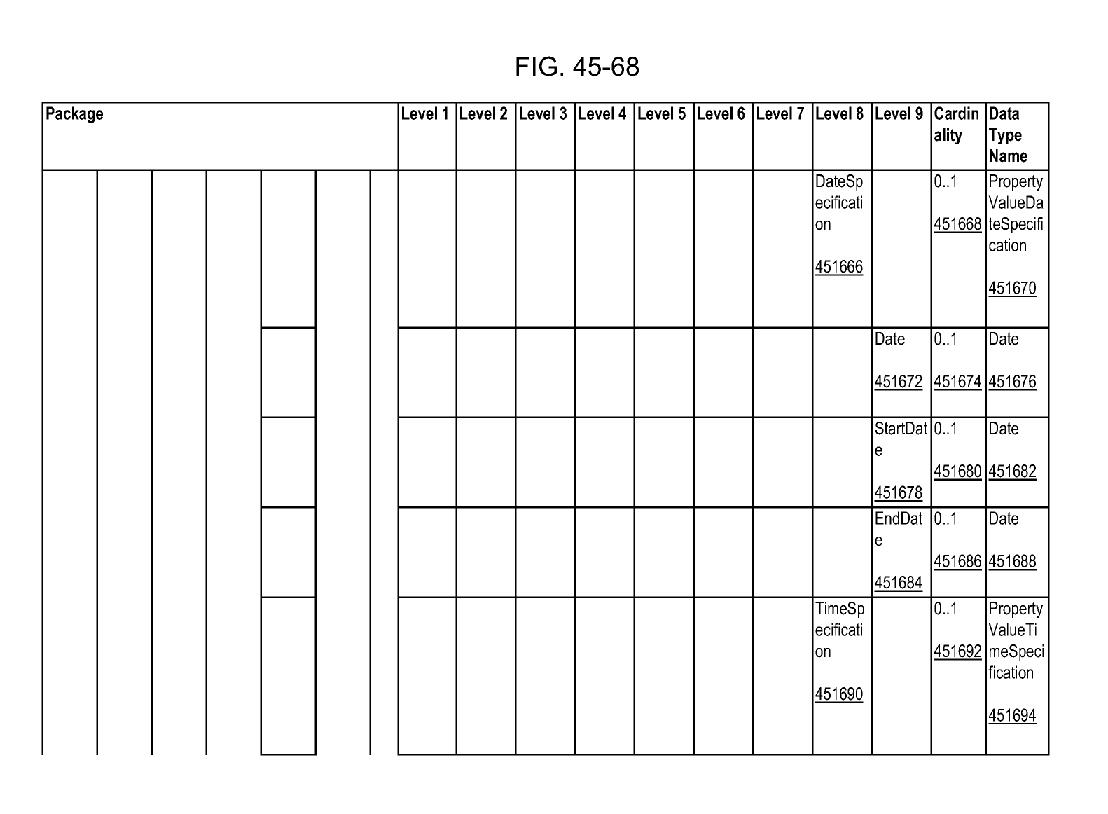

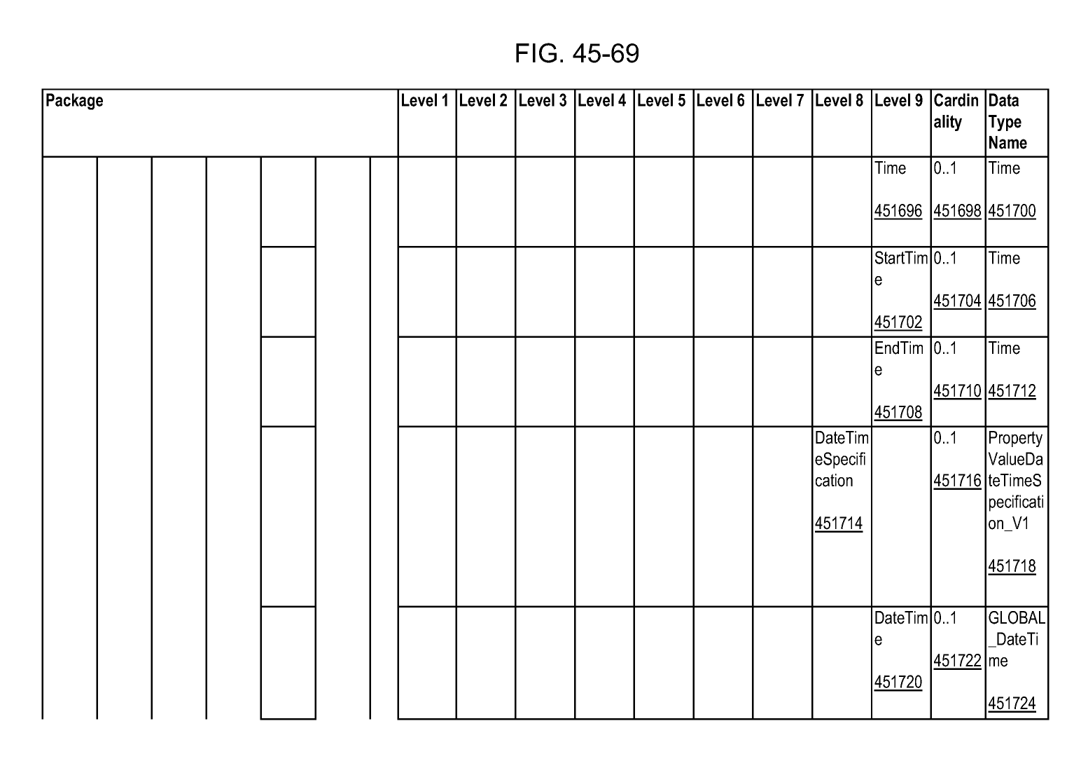

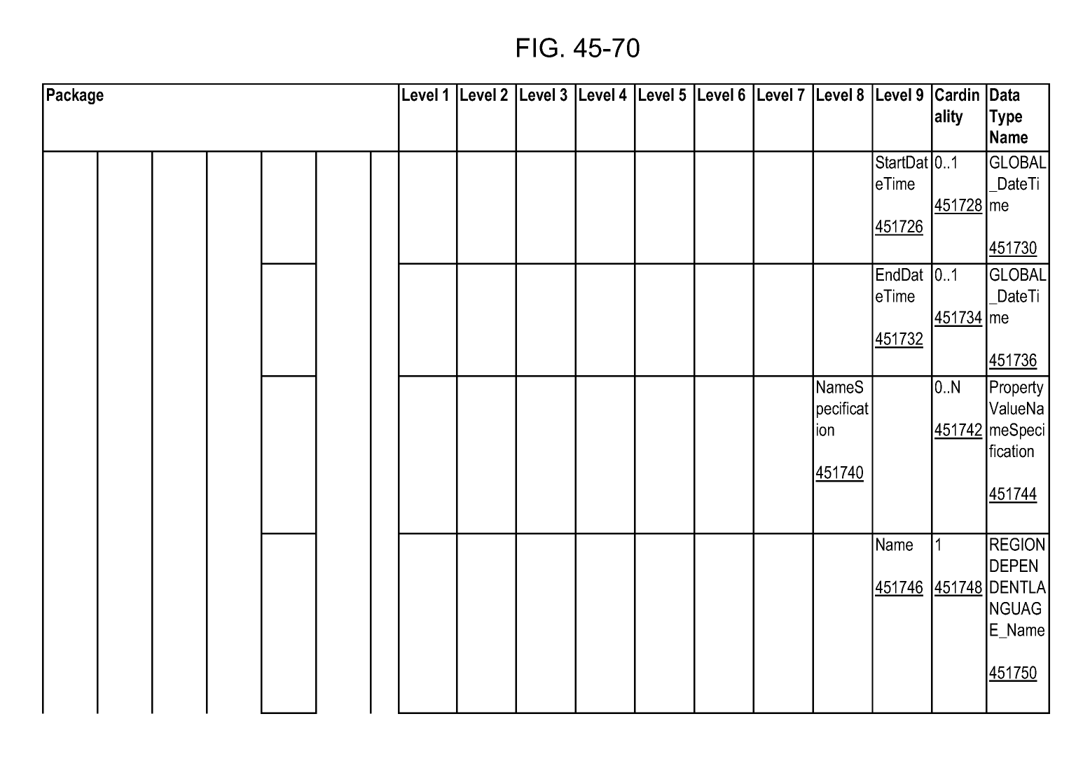

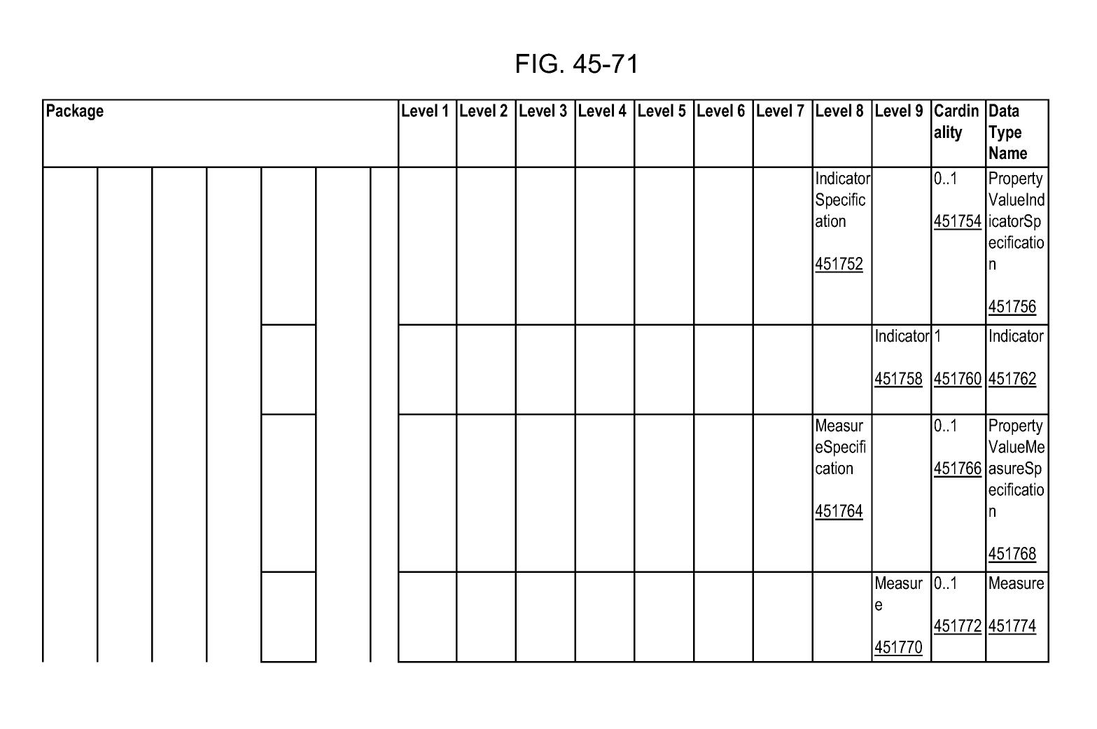

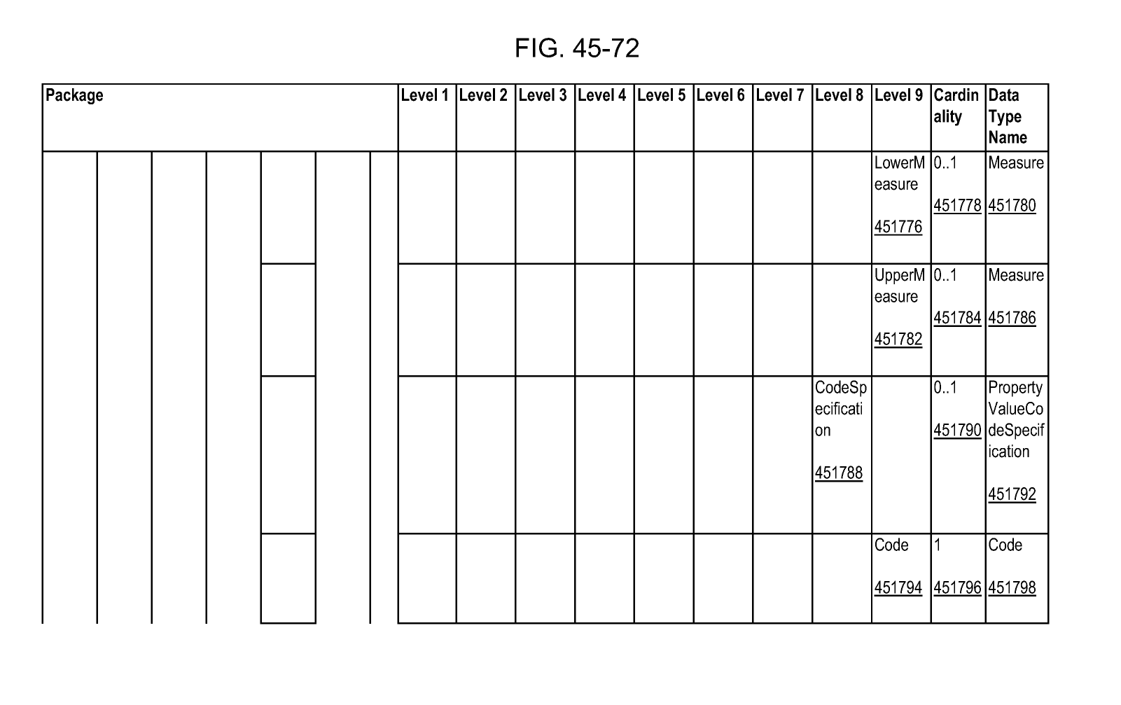

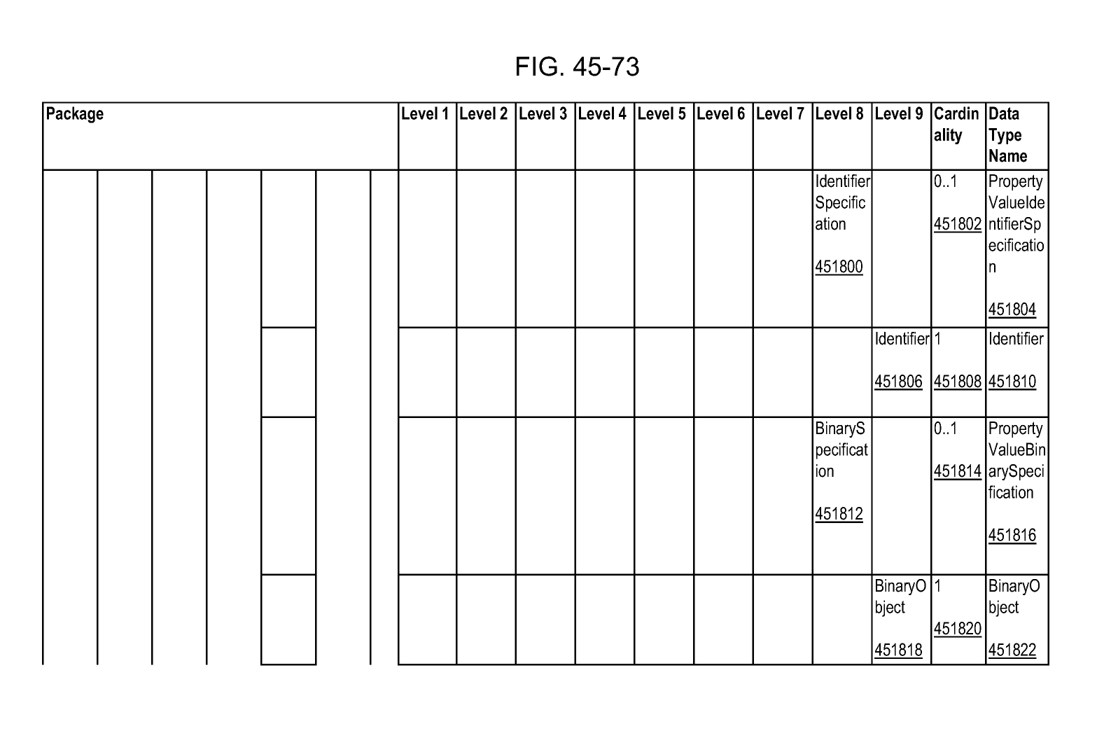

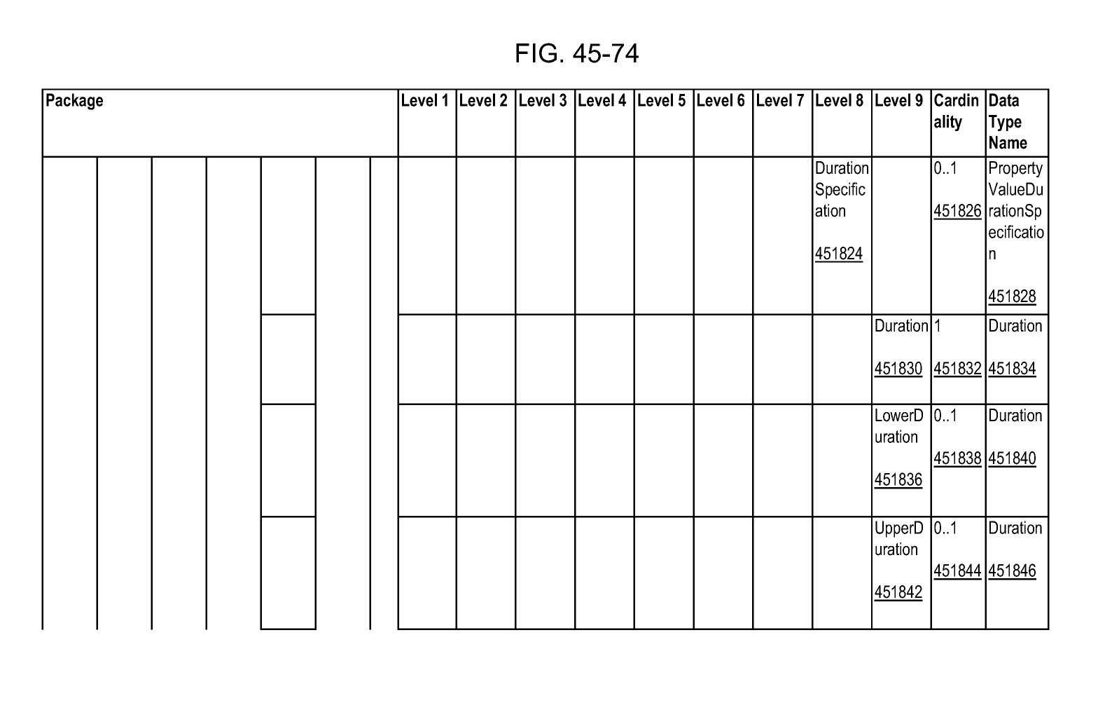

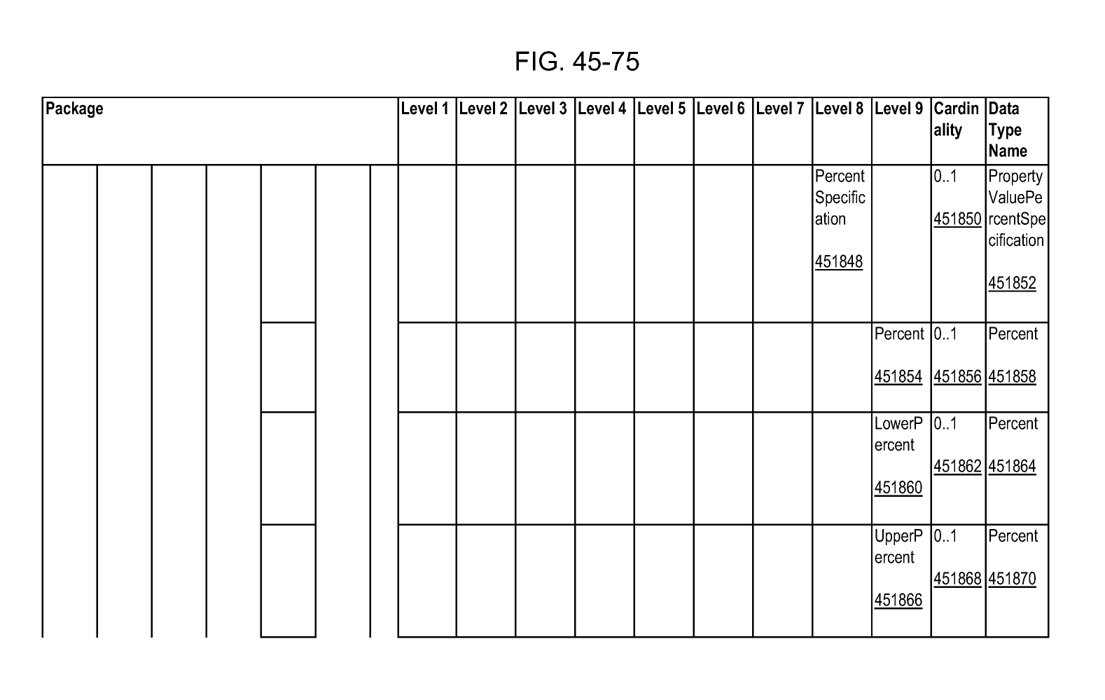

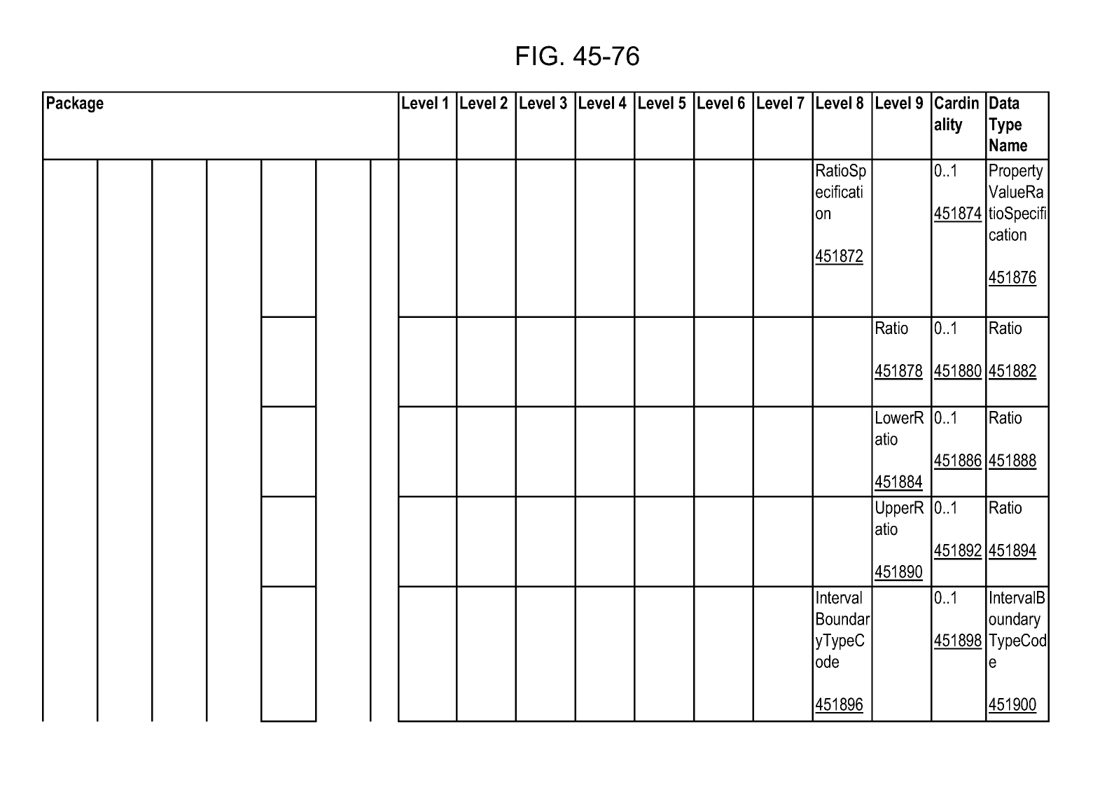

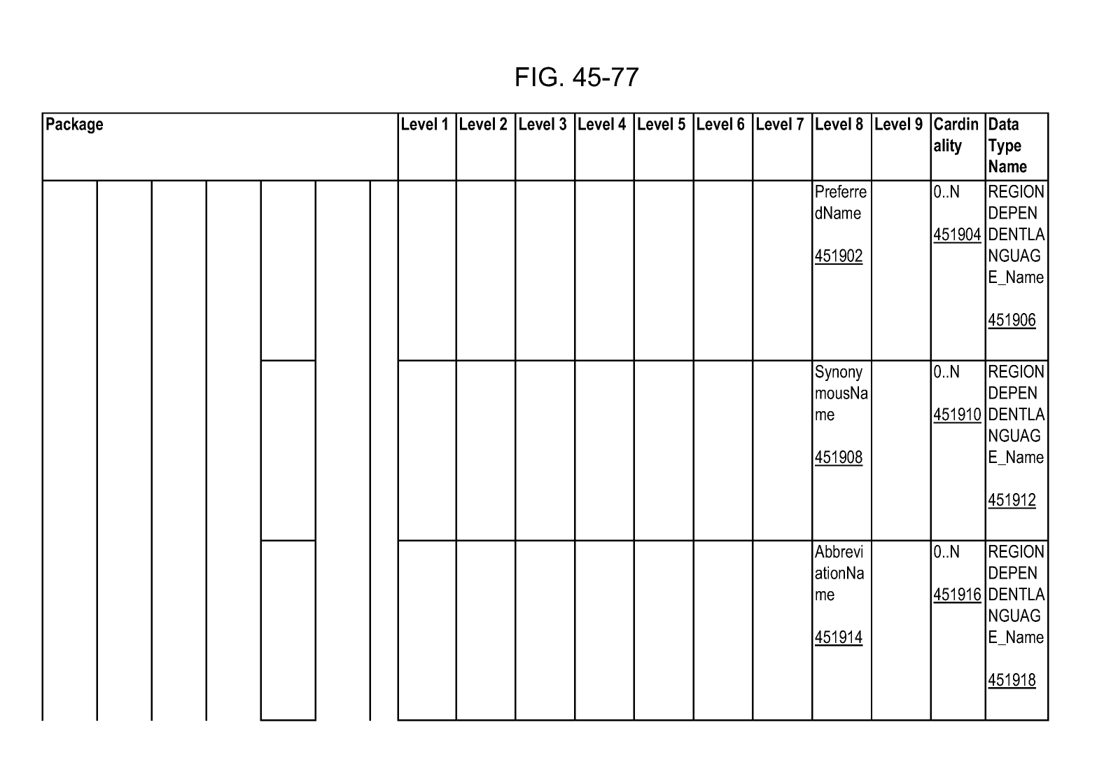

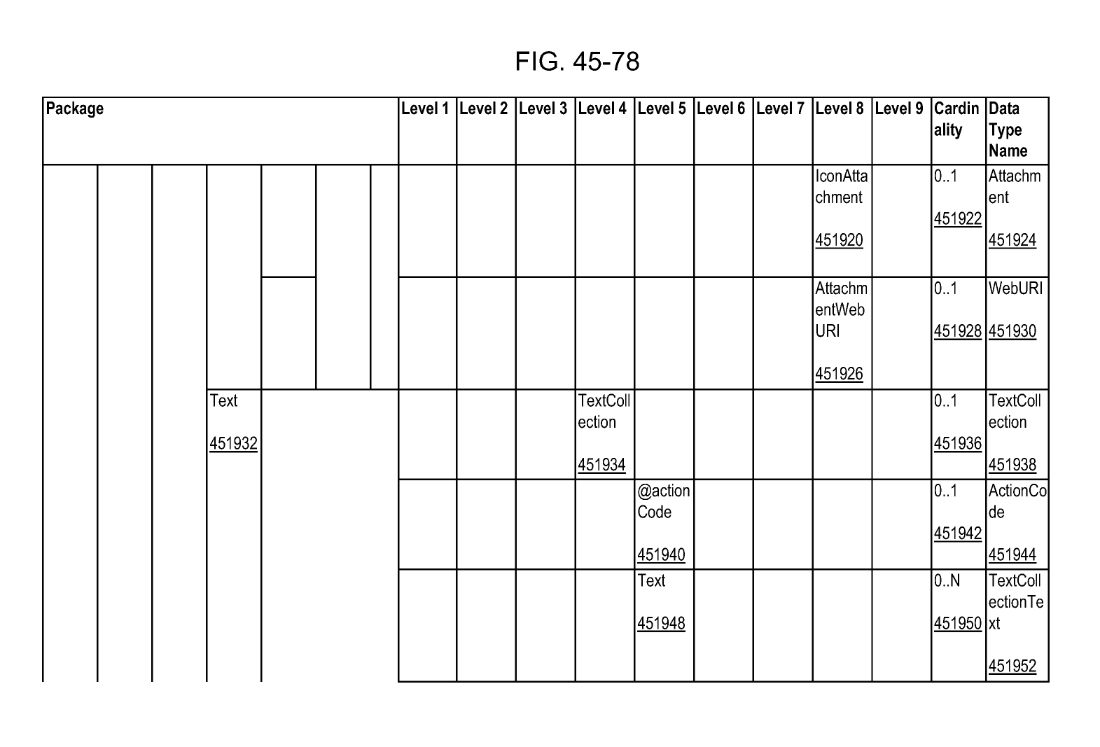

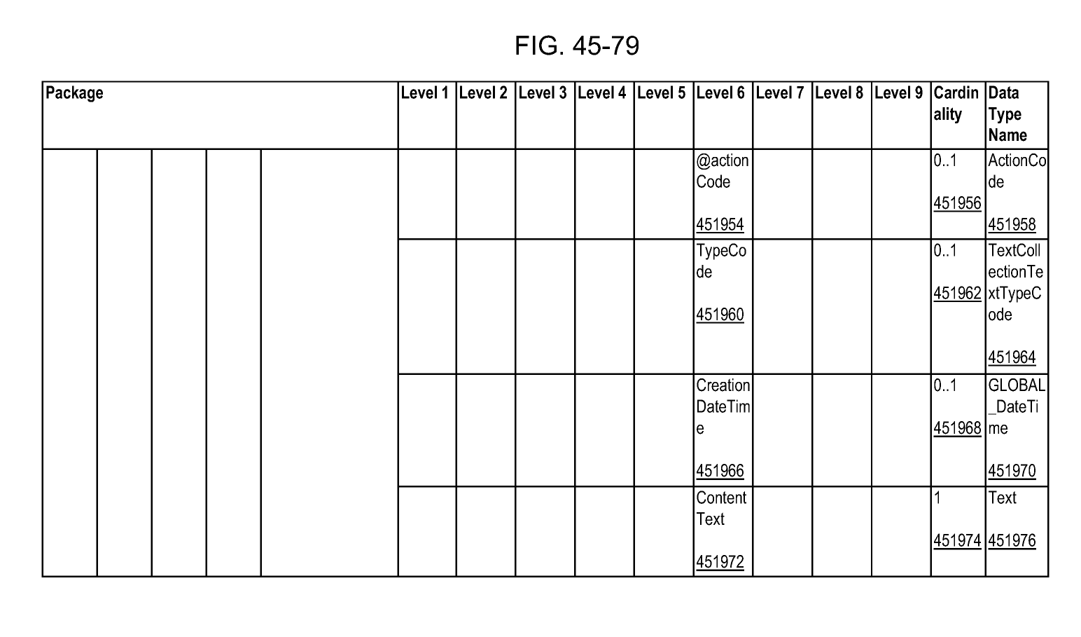

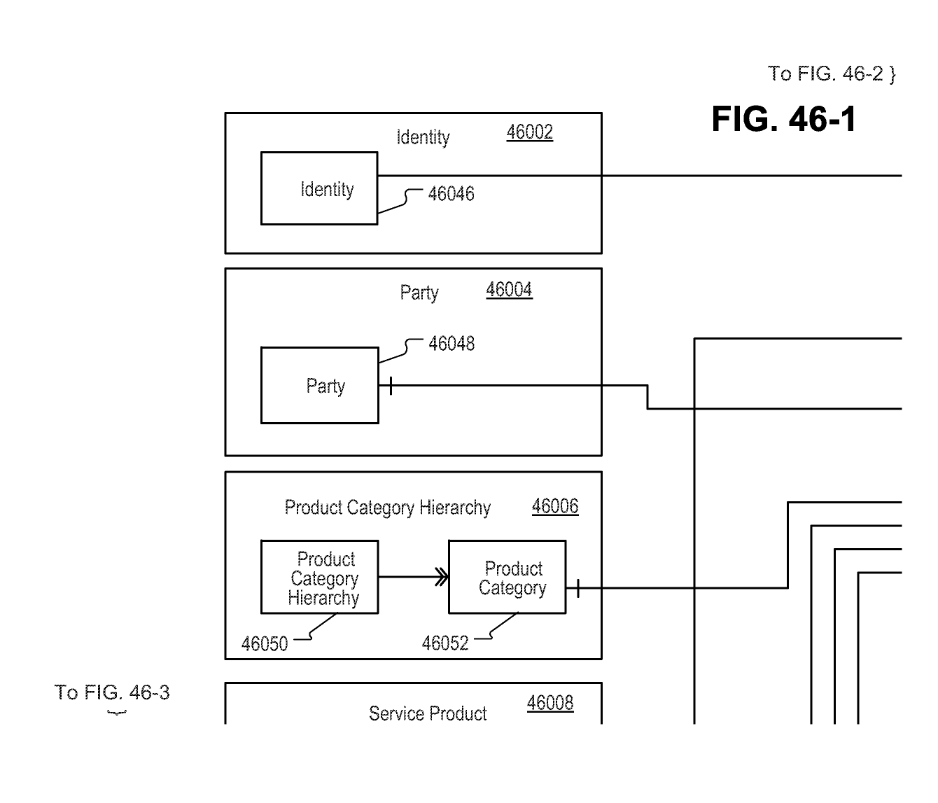

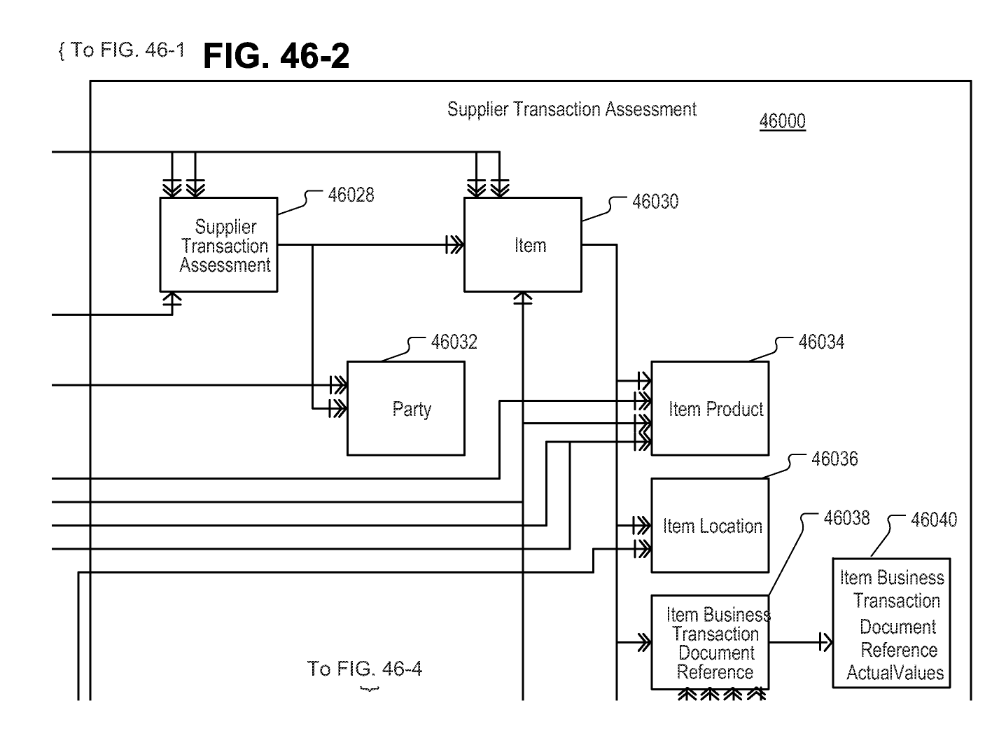

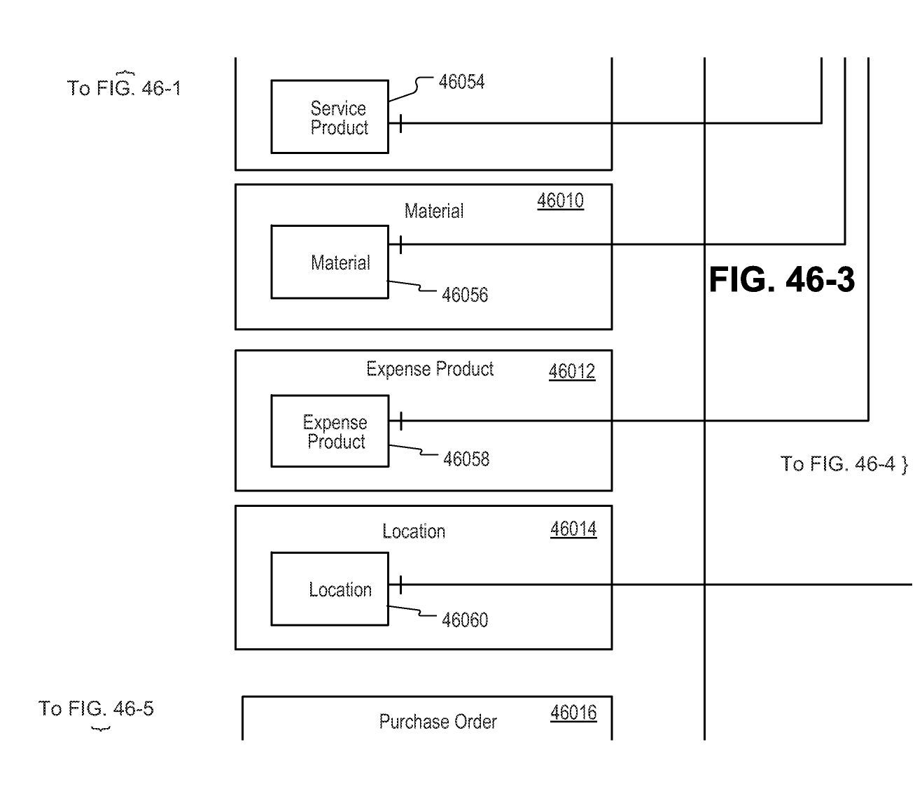

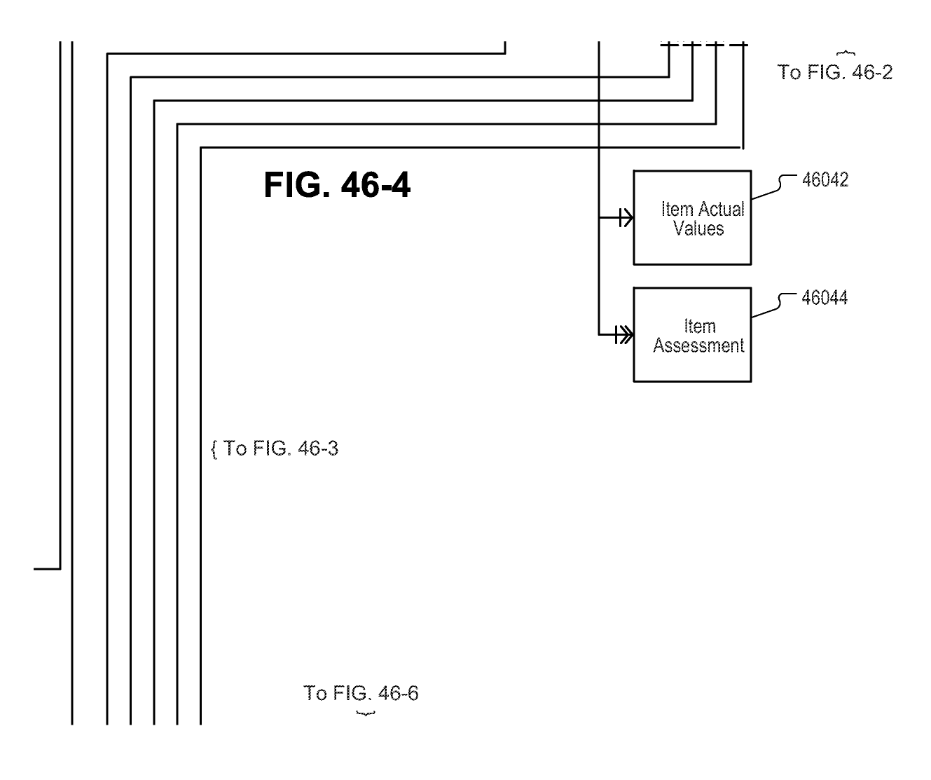

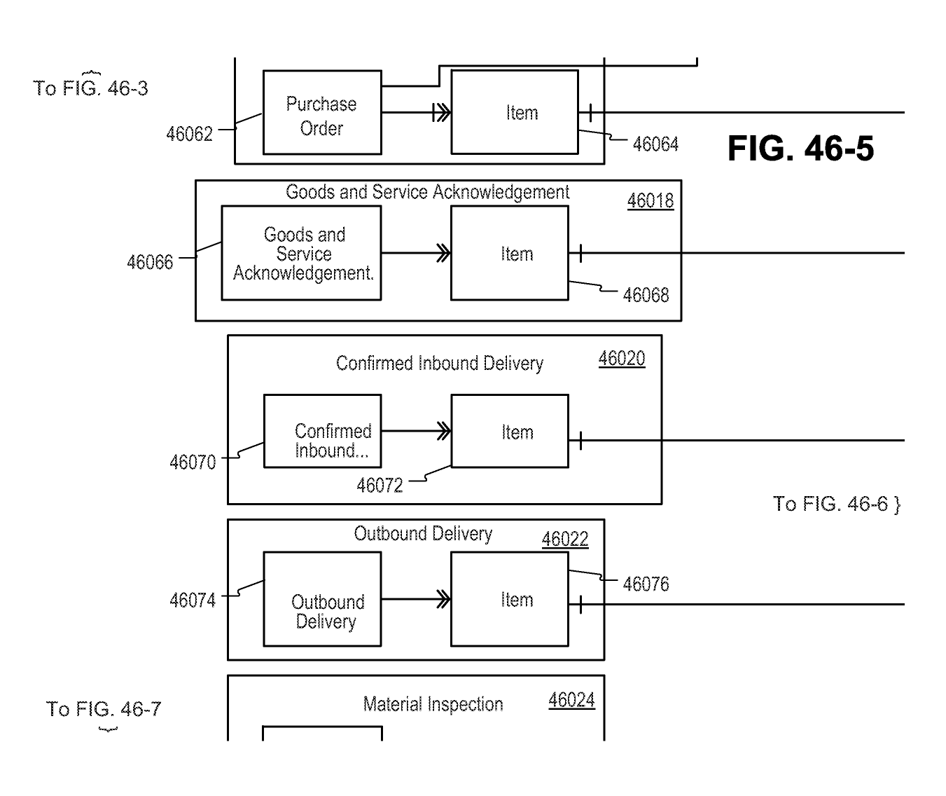

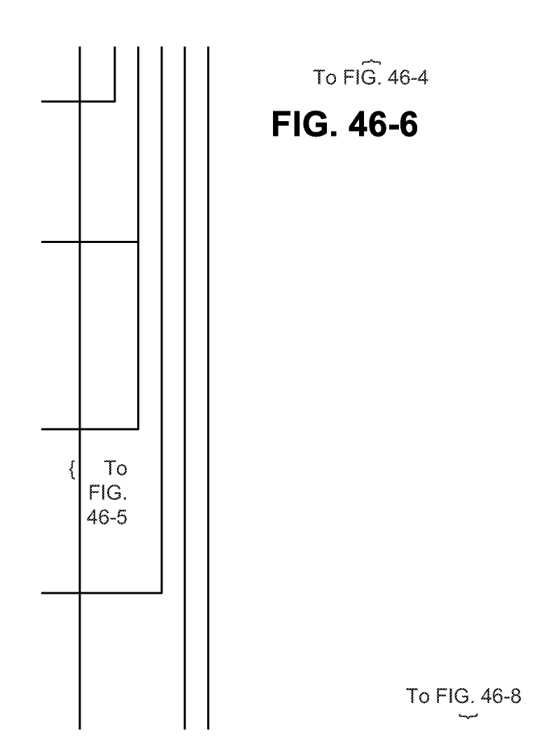

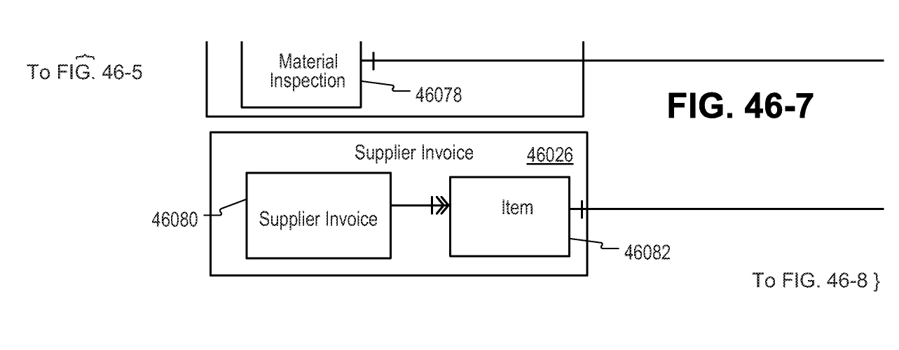

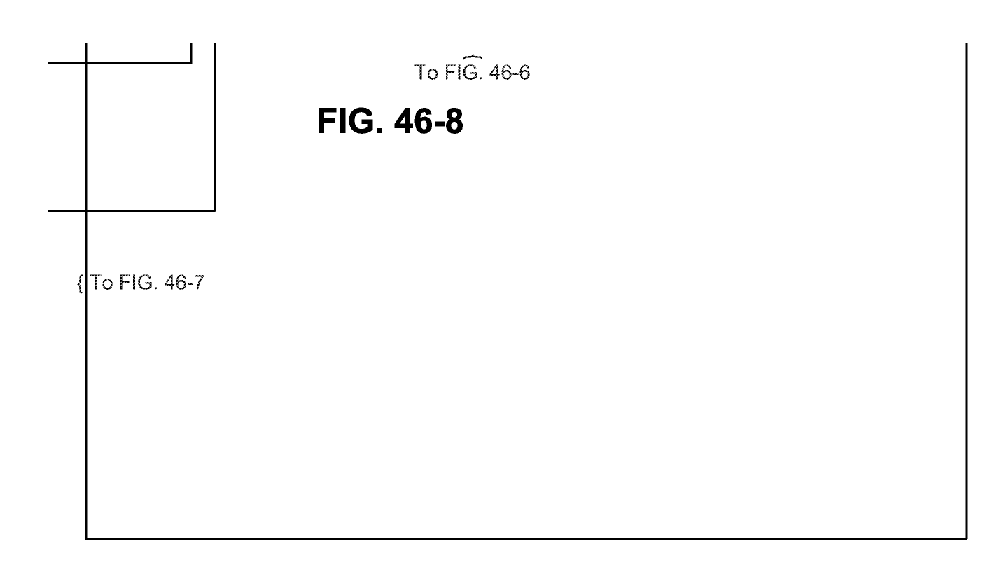

FIGS. 35-1 through 35-94 show an example configuration of an Element Structure that includes a FormRFIResponseRequest 350000 package. Specifically, these figures depict the arrangement and hierarchy of various components such as one or more levels of packages, entities, and datatypes, shown here as 350000 through 352308. As described above, packages may be used to represent hierarchy levels. Entities are discrete business elements that are used during a business transaction. Data types are used to type object entities and interfaces with a structure. For example, the FormRFIResponseRequest 350000 includes, among other things, a FormRFIResponseRequest 350002. Accordingly, heterogeneous applications may communicate using this consistent message configured as such.

FIGS. 36-1 through 36-112 show an example configuration of an Element Structure that includes an InteractiveFormRFIResponseRequest 360000 package. Specifically, these figures depict the arrangement and hierarchy of various components such as one or more levels of packages, entities, and datatypes, shown here as 360000 through 362686. As described above, packages may be used to represent hierarchy levels. Entities are discrete business elements that are used during a business transaction. Data types are used to type object entities and interfaces with a structure. For example, the InteractiveFormRFIResponseRequest 360000 includes, among other things, an InteractiveFormRFIResponseRequest 360002. Accordingly, heterogeneous applications may communicate using this consistent message configured as such.

FIGS. 37-1 through 37-4 depict an example object model for a business object RFI Response 37000. The business object 37000 has relationships with other objects 37002-37006, as shown with lines and arrows. The business object 37000 hierarchically comprises elements 37008-37038. The other objects 37002-37006 include respective elements 37040-37046 as shown.

The business object RFI Response is a response to a request for information RFI in which an existing supplier and/or potential supplier provides requested information. The business object RFI Response belongs to the process component RFI Processing. The responses to a request for information may be evaluated and compared to define next steps and to select a number of supplier candidates for further consideration. A supplier provides answers to structured questions of a request for information. A buyer then evaluates and compares information and selects the most suitable suppliers and may be optionally prepares a request for quote for a final selection. An RFI response includes a root node with general information and main texts, attachments, answers to questions from the associated request for information root, as well as a hierarchy of section nodes that include texts, attachments, and answers to questions from associated request for information sections. The Business Object is involved in the following Process Component Interaction Models: RFI Processing_IForm Lead/Opportunity Processing at Supplier.

The elements located directly at the node RFI Response root node are defined by the data type RFIResponseElements. These elements include: ID, UUID, Name, Status, ConsistencyStatusCode, SubmissionStatusCode, RelevanceStatusCode, ClosureStatusCode, LifeCycleStatusCode, and SystemAdministrativeData. ID may be an alternative key, is an identifier for an RFI response, and may be based on datatype GDT: BusinessTransactionDocumentID. UUID may be an alternative key, is a globally unique identifier for an RFI response, and may be based on datatype GDT: UUID. Name may be optional, is the name of an RFI response, and may be based on datatype GDT: MEDIUM_Name. The name may be taken over from the request for information. Status includes information about the lifecycle of an RFI response and results, and prerequisites for its processing steps. Status includes the elements that are defined by the RFI Response Status Elements data type, and may be based on datatype BOIDT: RFIResponseStatus. ConsistencyStatusCode is a coded representation of the status of an RFI response after a check process. ConsistencyStatusCode is a status variable, which may be either consistent or inconsistent, depending upon whether the check process returned error messages; that is, whether the business object is consistent and error-free. ConsistencyStatusCode may be based on datatype GDT: ConsistencyStatusCode. The Consistency status is also used for the submission of a RFI response. In order to be submitted, an RFI response may be consistent. Consistency may be tested by a precondition from ‘Consistent’ to ‘Submit’. In some implementations, the following values are used for ConsistencyStatusCode: Inconsistent, Consistent. SubmissionStatusCode is a coded representation of the submission status of an RFI response that specifies the state of the RFI response within a submission process. The ‘Not Submitted’ status value is set as soon as a RFI response is instantiated. SubmissionStatusCode may be based on datatype GDT: SubmissionStatusCode. It may be possible to save an RFI response for further processing, complete, or submit the response. When an RFI response is saved it remains in status Not Submitted, meaning the RFI response has been persisted in the system, but has not yet been submitted. For example, an RFI response may include inconsistencies or is incomplete and can therefore not be submitted. SubmissionStatusCode may have the values of Not Submitted or Submitted. RelevanceStatusCode is a coded representation of the relevance status of an RFI response that describes the result of the evaluation of the relevance of the submitted RFI response. The RFI response is evaluated in the context of the request for information and it is also evaluated whether the supplier that is associated with the RFI response is suitable for the purpose of the request for information and further processing. The relevance decision can be changed as long as the RFI response is not closed. RelevanceStatusCode may be based on datatype GDT: RelevanceStatusCode. ClosureStatusCode is a coded representation of the closure status of an RFI response that describes whether an RFI Response business transaction is closed or not. ClosureStatusCode may be based on datatype GDT: ClosureStatusCode. Closure finalizes a RFI response. In some implementations, there are no more changes possible after closure. LifeCycleStatusCode is a coded representation of the life cycle status of an RFI response which describes the current state of the RFI response. LifeCycleStatusCode is an overall status, derived from the Submission, Acceptance, Cancellation, and Closure status variables, and may be based on datatype GDT: RFIResponseLifeCycleStatusCode. A life cycle status is a status that denotes a prominent stage of a life cycle. A life cycle is a series of prominent stages through which an object can pass during its lifetime. A possible sequence of the stages is determined by the constraints under which an object can pass from one stage to another. SystemAdministrativeData includes administrative data such as system users and change dates/times, and may be based on datatype GDT: SystemAdministrativeData.

The following composition relationships to subordinate nodes exist: Section with a cardinality of 1:CN, RFI Property Valuation List with a cardinality of 1:C, Party with a cardinality of 1:CN, Business Transaction Document Reference with a cardinality of 1:1, Business Process Variant Type with a cardinality of 1:C, Access Control List with a cardinality of 1:1, Text Collection with a cardinality of 1:C, and Attachment Folder with a cardinality of 1:C. A Last Change Identity inbound association relationship may exist from the business object Identity/node Identity, with a cardinality of 1:CN, which is an identity that last changed the RFI response. A Creation Identity inbound association relationship may exist from the business object Identity/node Identity, with a cardinality of 1:CN, which is an identity that created the RFI response. The following specialization associations for navigation exist to Section node: Top Level Section, with a target cardinality of CN, which is an association to sections that are semantically associated with the root as parent. Other sections with a parent section in Hierarchy Relationship are subordinate sections. The following specialization associations for navigation exist to node Party: Seller Party, with a target cardinality of C, which is a party that provides requested information; and Buyer Party, with a target cardinality of C, which is a party on behalf of which a corresponding request for information was created. The following specialization associations for navigation exist to node BusinessTransactionDocumentReference: Base Request For Information Reference, with a target cardinality of 1, which is an association to a request for information business transaction document reference that an RFI response is associated to. The following specialization associations for navigation exist to the BusinessProcessVariantType node: MainBusinessProcessVariantType, with a target cardinality of C, which is an association to a business process variant type that is a main business process variant type. In some implementations, The ID element is not changed after creation. In some implementations, the UUID element is determined by the business object and is subsequently not changed. In some implementations, SystemAdministrativeData is determined by the business object and is subsequently not changed. In some implementations, the RFI response cannot be changed after submission. In some implementations, a complete RFI response includes one Supplier Party.

A Create with Reference enterprise service infrastructure action may be used to create an RFI response based on information from other business object instances passed as reference. The Create with Reference action accepts a supplier party node of a request for information as reference. In response to the Create with Reference action, a new RFI response with reference to the referenced request for information and with the seller party associated by the referenced party node as seller party is created, and a reference to the created RFI response is added to the associated request for information. A Submit action may be used to mark an RFI response as complete and ready for evaluation. The Submit action may have a precondition that the consistency status is set to Consistent. In response to the Submit action, the Submission status is set to Submitted. A Mark as Relevant action may be used to set the Relevance status to Relevant in order to mark the RFI response as relevant for further processing. The Mark as Relevant action may include a precondition that the action can only be performed in submitted RFI responses. In response to the Mark as Relevant action action, the Relevance status is set to Irrelevant. A Mark as Irrelevant action may be used to set the Relevance status to Irrelevant in order to mark the RFI response as irrelevant for further processing. The Mark as Irrelevant action may include a precondition that the action can only be performed in submitted RFI responses. In response to the Mark as Irrelevant action, the Relevance status is set to Relevant. A Reset Relevance action may be used to reset the Relevance status to ‘Check Pending’. The Reset Relevance action may include a precondition that the action can only be performed in submitted RFI responses. In response to the Reset Relevance action action, the Relevance status is set to its initial value. A Close action may be used to end the life cycle of the RFI response by setting the closure status to closed.

In some implementations, once the RFI response is closed, changes are no longer possible. In response to the Close action, the Closure status is set to Closed. An Update Supplier Property List action may be used to update the supplier property valuation list property list at supplier business partner with property valuations from the RFI property valuation list of an RFI response. In some implementations, only property valuations that are assigned to properties that are suitable to be used at supplier are considered and transferred. The Update Supplier Property List action may have a precondition that the action can only be performed in submitted RFI responses. In response to the Update Supplier Property List action, the supplier master data object is updated with data from the RFI response. A Create Supplier action may be used to create a supplier based on information specified in an assigned address of a supplier party and by parameter elements. The Create Supplier action may include a precondition that the action is enabled if the supplier party is not assigned to a business partner from master data but is specified as address only. In response to the Create Supplier action, the action adds a reference to the new master data object in the supplier party node and a supplier master data object is created and the role specified as parameter is assigned. The Create Supplier action may include parameter action elements. The action elements are defined by the data type RFIResponseCreateSupplierActionElements. These elements include BusinessPartnerRoleCode. BusinessPartnerRoleCode may be optional, is a coded representation of a role that is assigned to a supplier created by the action, and may be based on datatype GDT: BusinessPartnerRoleCode. In some implementations, if the role code is not specified, a supplier with role code Prospect Vendor is created. In some implementations, BusinessPartnerRoleCode may be one of the following values: “BBP000: Vendor,” “BBP001: Bidder,” or “BBP008: Prospect Vendor.”

A Select All query may be used to return the node IDs of all instances of a node, and may be used to enable an initial load of data for a fast search infrastructure. A Query by Elements query may be used to return a list of all RFI responses according to specified selection elements. The query elements are defined by the data type RFIResponseElementsQueryElements. These elements include: SearchText, ID, Name, RequestForInformationID, RequestForInformationSupplierGroupCode, RequestForInformationProductCategoryIDKey, ProductCategoryHierarchyID, ProductCategoryInternalID, Status, ConsistencyStatusCode, SubmissionStatusCode, RelevanceStatusCode, ClosureStatusCode, LifeCycleStatusCode, BuyerPartyPartyKey, SellerPartyPartyKey, PartyTypeCode, PartyID, RequestForInformationEmployeeResponsiblePartyPartyKey, RequestForInformationResponsiblePurchasingUnitPartyPartyKey, RequestForInformationInterestedEmployeePartyPartyKey, SystemAdministrativeData, CreationDateTime, CreationIdentityUUID, CreationIdentityID, CreationIdentityBusinessPartnerInternalID, CreationIdentityBusinessPartnerPersonFamilyName, CreationIdentityBusinessPartnerPersonGivenName, CreationIdentityEmployeeID, LastChangeDateTime, LastChangeIdentityUUID, LastChangeIdentityID, LastChangeIdentityBusinessPartnerInternalID, LastChangeIdentityBusinessPartnerPersonFamilyName, LastChangeIdentityBusinessPartnerPersonGivenName, and LastChangeIdentityEmployeeID. SearchText may be optional, is a text that is searched for in all search parameters, and may be based on datatype GDT: SearchText. ID may be optional, is an identifier of an RFI response, and may be based on datatype GDT: BusinessTransactionDocumentID. Name may be optional, is a name of an RFI response, and may be based on datatype GDT: MEDIUM_Name. RequestForInformationID may be optional, is an identifier for an associated request for information, and may be based on datatype GDT: BusinessTransactionDocumentID. RequestForInformationSupplierGroupCode may be optional, is a coded representation of a supplier group of an associated request for information, and may be based on datatype GDT: SupplierGroupCode. RequestForInformationProductCategoryIDKey may be optional, is a grouping of elements that uniquely identifies a product category by product category hierarchy ID and product internal ID, and may be based on datatype KDT: ProductCategoryHierarchyProductCategoryIDKey. ProductCategoryHierarchyID is an identifier for a product category hierarchy, and may be based on datatype GDT: ProductCategoryHierarchyID. ProductCategoryInternalID is an identifier for a product category, and may be based on datatype GDT: ProductCategoryInternalID. Status may be optional, includes information about the status of an RFI response, and may be based on datatype BOIDT: RFIResponseStatus. ConsistencyStatusCode is a coded representation of the status of an RFI response after a check process. ConsistencyStatusCode is a status variable, which may be either consistent or inconsistent, depending upon whether the check process returned error messages; that is, whether the business object is consistent and error-free. ConsistencyStatusCode may be based on datatype GDT: ConsistencyStatusCode. The Consistency status is also used for the submission of a RFI response. In order to be submitted, an RFI response may be consistent. Consistency may be tested by a precondition from ‘Consistent’ to ‘Submit’. In some implementations, the following values are used for ConsistencyStatusCode: Inconsistent, Consistent. SubmissionStatusCode is a coded representation of the submission status of an RFI response that specifies the state of the RFI response within a submission process. The ‘Not Submitted’ status value is set as soon as a RFI response is instantiated. SubmissionStatusCode may be based on datatype GDT: SubmissionStatusCode. It may be possible to save an RFI response for further processing, complete, or submit the response. When an RFI response is saved it remains in status Not Submitted, meaning the RFI response has been persisted in the system, but has not yet been submitted. For example, an RFI response may include inconsistencies or is incomplete and can therefore not be submitted. SubmissionStatusCode may have the values of Not Submitted or Submitted. RelevanceStatusCode is a coded representation of the relevance status of an RFI response that describes the result of the evaluation of the relevance of the submitted RFI response. The RFI response is evaluated in the context of the request for information and it is also evaluated whether the supplier that is associated with the RFI response is suitable for the purpose of the request for information and further processing. The relevance decision can be changed as long as the RFI response is not closed. RelevanceStatusCode may be based on datatype GDT: RelevanceStatusCode. ClosureStatusCode is a coded representation of the closure status of an RFI response that describes whether an RFI Response business transaction is closed or not. ClosureStatusCode may be based on datatype GDT: ClosureStatusCode. Closure finalizes a RFI response. In some implementations, there are no more changes possible after closure. LifeCycleStatusCode is a coded representation of the life cycle status of an RFI response which describes the current state of the RFI response. LifeCycleStatusCode is an overall status, derived from the Submission, Acceptance, Cancellation, and Closure status variables, and may be based on datatype GDT: RFIResponseLifeCycleStatusCode. A life cycle status is a status that denotes a prominent stage of a life cycle. A life cycle is a series of prominent stages through which an object can pass during its lifetime. A possible sequence of the stages is determined by the constraints under which an object can pass from one stage to another. BuyerPartyPartyKey may be optional, is a grouping of all elements that uniquely identifies a buyer party by party type code and party ID, and may be based on datatype KDT: PartyKey. PartyTypeCode may be optional, is a coded representation of a type of party, and may be based on datatype GDT: BusinessObjectTypeCode. SellerPartyPartyKey may be optional, is a grouping of all elements that uniquely identifies a seller party by party type code and party ID, and may be based on datatype KDT: PartyKey. PartyTypeCode may be optional, is a coded representation of a type of party, and may be based on datatype GDT: BusinessObjectTypeCode. PartyID may be optional, is an identifier for a party, and may be based on datatype GDT: PartyID. RequestForInformationEmployeeResponsiblePartyPartyKey may be optional, is a grouping of all elements that uniquely identifies an employee responsible party by party type code and party ID, and may be based on datatype KDT: PartyKey. PartyTypeCode may be optional, is a coded representation of a type of party, and may be based on datatype GDT: BusinessObjectTypeCode. RequestForInformationResponsiblePurchasingUnitPartyPartyKey may be optional, is a grouping of all elements that uniquely identifies the purchasing unit party by party type code and party ID, and may be based on datatype KDT: PartyKey. PartyTypeCode may be optional, is a coded representation of a type of party, and may be based on datatype GDT: BusinessObjectTypeCode. RequestForInformationInterestedEmployeePartyPartyKey may be optional, is a grouping of all elements that uniquely identifies an interested employee party by party type code and party ID, and may be based on datatype KDT: PartyKey. PartyTypeCode may be optional, is a coded representation of a type of party, and may be based on datatype GDT: BusinessObjectTypeCode. SystemAdministrativeData may be optional, is s search parameter to find RFI responses by creator, creation time, last changer, or last change time, and may be based on datatype QueryIDT: QueryElementSystemAdministrativeData. CreationDateTime may be optional, is a point in time when a goods tag is created, and may be based on datatype GDT: GLOBAL_DateTime. CreationIdentityUUID may be optional, is a globally unique identifier for a person who performed a creation, and may be based on datatype GDT: UUID. CreationIdentityID may be optional, is an identifier for a person who performed a creation, and may be based on datatype GDT: IdentityID. CreationIdentityBusinessPartnerInternalID may be optional, is a proprietary identifier for a business partner that is attributed to a creation identity and that can be reached following the relationships of the creation identity, and may be based on datatype GDT: BusinessPartnerInternalID. CreationIdentityBusinessPartnerPersonFamilyName may be optional, is a family name of a business partner of a category person that is attributed to a creation identity and that can be reached following the relationships of the creation identity, and may be based on datatype GDT: LANGUAGEINDEPENDENT_MEDIUM_Name. CreationIdentityBusinessPartnerPersonGivenName may be optional, is a given name of a business partner of a category person that is attributed to a creation identity and that can be reached following the relationships of the creation identity, and may be based on datatype GDT: LANGUAGEINDEPENDENT_MEDIUM_Name. CreationIdentityEmployeeID may be optional, is an identifier for an employee that is attributed to a creation identity and that can be reached following the relationships of the creation identity, and may be based on datatype GDT: EmployeeID. LastChangeDateTime may be optional, is a point in time date and time stamp of a last change, and may be based on datatype GDT: GLOBAL_DateTime. LastChangeIdentityUUID may be optional, is a globally unique identifier for an identity who made last changes, and may be based on datatype GDT: UUID. LastChangeIdentityID may be optional, is an identifier for an identity who made last changes, and may be based on datatype GDT: IdentityID. LastChangeIdentityBusinessPartnerInternalID may be optional, is a proprietary identifier for a business partner that is attributed to a last change identity and that can be reached following the relationships of the last change identity, and may be based on datatype GDT: BusinessPartnerInternalID. LastChangeIdentityBusinessPartnerPersonFamilyName may be optional, is a family name of a business partner of a category person that is attributed to a last change identity and that can be reached following the relationships of the last change identity, and may be based on datatype GDT: LANGUAGEINDEPENDENT_MEDIUM_Name. LastChangeIdentityBusinessPartnerPersonGivenName may be optional, is a given name of a business partner of a category person that is attributed to a last change identity and that can be reached following the relationships of the last change identity, and may be based on datatype GDT: LANGUAGEINDEPENDENT_MEDIUM_Name. LastChangeIdentityEmployeeID may be optional, is an identifier for an employee that is attributed to a last change identity and that can be reached following the relationships of the last change identity, and may be based on datatype GDT: EmployeeID.

Section is a subtopic in a RFI response. Sections can be structured in a hierarchical way by creating subsections. Section is the usual business term instead of Item in the context of an RFI Response. A section in an RFI response is derived from the associated request for information and in some implementations, cannot be rearranged in the RFI response after creation. Section includes texts, attachments and properties valuations for a defined sub topic of a request for information. The elements located directly at the node Section are defined by the data type RFIResponseSectionElements. These elements include: ID, UUID, RequestForInformationSectionFormattedID, OrdinalNumberValue, HierarchyRelationship, and ParentSectionUUID. ID may be an alternative key, is a unique identifier for an RFI response section that is unique within all sections that have the same parent, and may be based on datatype GDT: BusinessTransactionDocumentItemID. UUID may be an alternative key, is a globally unique identifier for an RFI response section, and may be based on datatype GDT: UUID. RequestForInformationSectionFormattedID is an identifier for a request for information section a RFI response section is associated to, that is unique and human-readable, and may be based on datatype GDT: RequestForInformationSectionFormattedID. The association to the request for information section is provided by a section business transaction document reference. OrdinalNumberValue is a value that indicates the position of a section in a linearly ordered set of sections with the same parent, and may be based on datatype GDT: OrdinalNumberValue. HierarchyRelationship may be optional, is a relationship between a subsection and a higher-level parent section in a section hierarchy, and may be based on datatype BOIDT: RFIResponseSectionHierarchyRelationship. ParentSectionUUID is a globally unique identifier for a hierarchically superior RFI Response Section, and may be based on datatype GDT: UUID. If the section doesn't have a parent section, it is a section of the first hierarchy level.

The following composition relationships to subordinate nodes exist: Section RFI Property Valuation List with a cardinality of 1:C, Section Business Transaction Document Reference with a cardinality of 1:CN, Section Text Collection with a cardinality of 1:C, and Section Attachment Folder with a cardinality of 1:C. A Parent Section inbound association relationship may exist from the business object RFI Response/node Section, with a cardinality of C:CN. Parent section of a section is a hierarchically super ordinate section. If a section is not associated with a parent section, it is at the top most level. The following specialization associations for navigation may exist to node Section: Sub Section, with a target cardinality of CN, which is a specialization association to directly subordinate sections. The following specialization associations for navigation may exist to node SectionBusinessTransactionDocumentReference: Base Request for Information Section Reference, with a target cardinality of C. The Section RFI Property Valuation List dependent object inclusion node is a list of request for information section properties with their valuations. The properties and valuations are based on a request for information property list. The property valuation list may reference a complete list of properties from a request for information.

Section Business Transaction Document Reference is a unique reference between an RFI response section and another business transaction document. BusinessTransactionDocumentReference occurs in the following incomplete and disjoint specializations: Base Request for Information Section Reference. The elements located directly at the node Section Business Transaction Document Reference are defined by the data type RFIResponseSectionBusinessTransactionDocumentReferenceElements. These elements include: BusinessTransactionDocumentReference and BusinessTransactionDocumentRelationshipRoleCode. BusinessTransactionDocumentReference is a reference to another business document that is of significance for a RFI response section, and may be based on datatype GDT: BusinessTransactionDocumentReference. BusinessTransactionDocumentRelationshipRoleCode may be optional, is a coded representation of a role that a business document has when it is set against an RFI response section within a relationship, and may be based on datatype GDT: BusinessTransactionDocumentRelationshipRoleCode. A Request for Information Section inbound association relationship may exist from the business object Request for Information/node Section, with a cardinality of 1:CN. A Section Text Collection dependent object inclusion node is a collection of textual descriptions that are related to an RFI response section. Each text can be specified in different languages and can include formatting information. A Section Attachment Folder dependent object inclusion node is a folder of documents attached to a RFI response section. The attachment folder in the RFI response section is also used to store response information from the supplier provided as binary documents (e.g., concepts, drawings). A RFI Property Valuation List dependent object inclusion node is a list of request for information properties with their valuations. The properties and valuations are based on a request for information property list. The property valuation list references the complete list of properties from the request for information.

Party is a natural or legal person, an organization, an organizational unit, or a group that is involved in an RFI response in a party role. A Party can occur within the following complete and disjoint specialisations: Seller Party, which is a party that provides requested information, and that may have a contact person that creates and submits the RFI response, where the contact person is a business partner of the specialisation BusinessPartner; Buyer Party, which is a party on behalf of which a corresponding request for information was created, and that may have a contact person; a party referenced using the inbound aggregation relationship from the Party transformed object; a business partner or one of its specializations, for example, customer, supplier, employee; or a Company or Functional Unit specialization of an organizational center. A party may exist without a reference to a business partner or an organizational unit. Such a party is a casual party, which is a party without reference to master data in the system. The external identifier and the description are included in the business document. The elements located directly at the node Party are defined by the data type RFIResponsePartyElements. These elements include: UUID, PartyUUID, PartyTypeCode, RoleCategoryCode, RoleCode, AddressReference, DeterminationMethodCode, PartyKey, PartyTypeCode, and PartyID. UUID may be an alternative key, is a globally unique identifier for an RFI response party for referencing purposes, and may be based on datatype GDT: UUID. PartyUUID may be optional, is a globally unique identifier for a business partner, an organizational center, or their specializations, and may be based on datatype GDT: UUID. PartyTypeCode may be optional, is a coded representation of a type of business partner, organizational center, or their specializations referenced by the PartyUUID element, and may be based on datatype GDT: BusinessObjectTypeCode. RoleCategoryCode may be optional, is a coded representation of a role category of a party in an RFI response, and may be based on datatype GDT: PartyRoleCategoryCode. RoleCode is a coded representation of the role of the party in the RFI response, and may be based on datatype GDT: PartyRoleCode. AddressReference may be optional, is a unique reference to an address of a party, and may be based on datatype GDT: PartyAddressReference. DeterminationMethodCode may be optional, is a coded representation of the determination method of a party, and may be based on datatype GDT: PartyDeterminationMethodCode. PartyKey may be optional, is a grouping of elements that uniquely identifies a party by party type code and party ID, and may be based on datatype KDT: PartyKey. PartyTypeCode may be optional, is a coded representation of a type of party, and may be based on datatype GDT: BusinessObjectTypeCode. PartyID may be optional, is an identifier for a party, and may be based on datatype GDT: PartyID.

The following composition relationships to subordinate nodes exist: Party Contact Party with a cardinality of 1:C and Party Address with a cardinality of 1:C. A Party inbound association relationship may exist from the business object Party/node Party, with a cardinality of C:CN, which is a referenced Party in Master Data. A UsedAddress specialization association for navigation may exist to Used Address transformed object/Root node, with a target cardinality of C. The Used Address transformed object represents a uniform way to access a party address of an RFI response, which may be a business partner address, an organization center address, or an address specified within an RFI response. The address used for the Party can be a referenced address of a master data object or a party address used by the composition relationship. A type of address used can be determined by looking at the Party Address Host Type Code element. The instance of the Used Address transformed object represents the address. The association is implemented. If the address is a referenced address of a master data object, the Party Type Code, Party Address UUID and Party Address Host Type Code elements are used to determine the node identifier of the node in the master data object which holds a composition relationship to the Address dependent object, which is represented by the Used Address transformed object. Furthermore, the following information is sent to the Used Address transformed object in the implemented association: an indication that it is a master data address, the Business Object Type Code, Business Object Node Type Code and Node ID of the Item Party node. The sent information may be used if changes are made to the Used Address transformed object. If changes are made, the Used Address transformed object copies the master data address, and the changes are applied, resulting in the generation of a corresponding Address dependent object on the Item Party node by the Party Address composition relationship. If the address used for the Party is a party address used by the composition relationship, the Business Object Type Code, Business Object Node Type Code and Node ID of the Item Party are communicated to the Used Address transformed object, along with an indication of whether the address is a referenced address. The Used Address transformed object represents the Address dependent object that is integrated by the Party Address composition relationship on the Item Party node. In some implementations, if the PartyUUID exists, the PartyTypeCode also exists. In some implementations, Parties may only be referenced by the Party transformed object, which represents at least one of the following business objects: Company, Functional Unit, Supplier, Employee, Business Partner.

Party Contact Party is a natural person or organizational unit that can be contacted for a party. The contact may be a contact person or, for example, a secretary's office. Communication data for the contact may be available. The elements located directly at the node Party Contact Party are defined by the data type RFIResponsePartyContactPartyElements. These elements include: UUID, PartyUUID, PartyTypeCode, AddressReference, DeterminationMethodCode, PartyKey, PartyTypeCode, and PartyID. UUID may be an alternative key, is a globally unique identifier for an RFI response party contact party for referencing purposes, and may be based on datatype GDT: UUID. PartyUUID may be optional, is a globally unique identifier for the contact in a party role in a RFI response or master data object, and may be based on datatype GDT: UUID. PartyTypeCode may be optional, is a coded representation of a type of business partner, organizational center, or their specializations referenced by the PartyUUID element, and may be based on datatype GDT: BusinessObjectTypeCode. AddressReference may be optional, is a reference to an address of a party contact, and may be based on datatype GDT: PartyAddressReference. DeterminationMethodCode may be optional, is a coded representation of a determination method of a party contact, and may be based on datatype GDT: PartyDeterminationMethodCode. PartyKey may be optional, is a grouping of elements that uniquely identifies a party by party type code and party ID, and may be based on datatype KDT: PartyKey. PartyTypeCode may be optional, is a coded representation of a type of party, and may be based on datatype GDT: BusinessObjectTypeCode. PartyID may be optional, is an identifier for a party, and may be based on datatype GDT: PartyID.

The following composition relationships to subordinate nodes exist: Party Contact Party Address with a cardinality of 1:C. A Party inbound association relationship may exist from the business object Party/node Party, with a cardinality of C:CN, which is a referenced Party in Master Data. A UsedAddress specialization association for navigation may exist to Used Address transformed object/Root node, with a target cardinality of CN, which is an address used for a contact party. A Party Contact Party Address dependent object inclusion node is a RFI response specific address of a party contact. A Party Address dependent object inclusion node is a RFI response specific address of a party.

Business Transaction Document Reference is a unique reference between the RFI response and another business transaction document or business transaction document item. BusinessTransactionDocumentReference occurs in the following incomplete and disjoint specializations: Base Request for Information Reference. The elements located directly at the node Business Transaction Document Reference are defined by the data type RFIResponseBusinessTransactionDocumentReferenceElements. These elements include BusinessTransactionDocumentReference and BusinessTransactionDocumentReferenceRoleCode. BusinessTransactionDocumentReference is a reference to another business document which is of significance for the RFI response, and may be based on datatype GDT: BusinessTransactionDocumentReference. Since a RFI response cannot exist without a request for information, the Request for Information Reference is an important reference. BusinessTransactionDocumentReferenceRoleCode may be optional, is a coded representation of a role that a business transaction document has when it is set against an RFI response within a relationship, and may be based on datatype GDT: BusinessTransactionDocumentRelationshipRoleCode. A Request for Information inbound association relationship may exist from the business object Request for Information/node Request for Information, with a cardinality of C:CN.

Business Process Variant Type is a representation of a typical way of processing an RFI response within a process component, from a business point of view. A BusinessProcessVariantType can occur within the following specialisations: MainBusinessProcessVariantType, and AdditionalBusinessProcessVariantType. A business process variant is a configuration of a process component. A business process variant belongs to a process component. A process component is a software package that realizes a business process and exposes its functionality as services. The functionality may include business transactions. A process component includes one or more semantically related business objects. A business object belongs to a process component. The elements located directly at the node Business Process Variant Type are defined by the data type RFIResponseBusinessProcessVariantTypeElements. These elements include BusinessProcessVariantTypeCode and MainIndicator. BusinessProcessVariantTypeCode is a coded representation of a RFI Processing business process variant type, and may be based on datatype GDT: BusinessProcessVariantTypeCode. In some implementations, a code value of “NN—Standard” may be used. MainIndicator is an indicator that specifies whether a business process variant type is a main business process variant type, and may be based on datatype GDT: Indicator. A Access Control List dependent object inclusion node is a list of access groups that have access to an RFI response. A Text Collection dependent object inclusion node is a collection of textual descriptions that are related to an RFI response. Each text can be specified in different languages and can include formatting information. An Attachment Folder dependent object inclusion node is a folder of documents attached to the RFI response. The attachment folder in the RFI response is also used to store response information from the supplier provided as binary documents (e.g., concepts, drawings).

FIGS. 38-1 through 38-2 depict an example Response for Information Response Confirmation Message Data Type 38000, which comprises elements 38002-38026, hierarchically related as shown. For example, the Response for Information Response Confirmation 38002 includes a Message Header 38004.

A Response for Information Response Confirmation is a confirmation submitted by a supplier to a buyer in response to the Request for Information. In some implementations, the Response for Information Response Confirmation is derived from the business object Response for Information Response as leading object together with its operation signature. The structure of the Response for Information Response Confirmation message type can be determined by the message data type Response for Information ResponseConfirmationMessage.

A Response for Information ResponseConfirmationMessage can include the object Response for Information Response which is included in the business document, the business information that is relevant for sending a business document in a message. The Response for Information ResponseConfirmationMessage can include the packages: MessageHeader, and Response for Information Response. The Response for Information ResponseConfirmationMessage message data type can provide the structure for the Response for Information Response Confirmation message type and the operations that are based on them.

The MessageHeader package is a grouping of business information that is relevant for sending a business document in a message. The MessageHeader package can include the MessageHeader node. The MessageHeader node is a grouping of business information from the perspective of a sending application, such as information to identify the business document in a message, information about the sender, and can be optionally information about the recipient. The MessageHeader can include SenderParty and RecipientParty. MessageHeader can be based on datatype GDT:BusinessDocumentMessageHeader. The following elements of the GDT can be used: RecipientParty, BusinessScope, SenderParty, SenderBusinessSystemID, TestDataIndicator, RecipientBusinessSystemID, ReferenceID, ReferenceUUID, ReconciliationIndicator, ID, UUID, and CreationDateTime. The SenderParty is the partner responsible for sending a business document at a business application level. The SenderParty is of the type and can be based on datatype GDT:BusinessDocumentMessageHeaderParty. The RecipientParty can be based on datatype GDT:BusinessDocumentMessageHeaderParty. The RecipientParty is the partner responsible for receiving a business document at a business application level.

The Response for Information Response package is the grouping of Response for Information Response with its packages. The packages included in the Response for Information Response package can include Property, Party, BusinessTransactionDocumentReference, TextCollection, Attachment, Section, and the entities Response for Information Response. The Response for Information Response can include the following Attributes: reconciliationPeriodCounterValue. The reconciliationPeriodCounterValue can be optional. The reconciliationPeriodCounterValue is a counter for reconciliation periods and can be based on datatype GDT:CounterValue. The Response for Information Response can include the node elements: Response for InformationPropertyValuationList with a cardinality of 1:C, SellerParty with a cardinality of 1:1, BaseRequestForInformationReference with a cardinality of 1:1, TextCollection with a cardinality of 1:C, AttachmentFolder with a cardinality of 1:C, and Section with a cardinality of 1:CN.

A Response for Information ResponseProperty package includes the entity Response for InformationPropertyValuationList. The Response for InformationPropertyValuationList can include the following non-node element PropertyValuation. The PropertyValuation is the valuation of a property and can be based on datatype GDT:PropertyValuation. The Response for Information ResponseParty package includes the entity SellerParty. The SellerParty is typed by BusinessTransactionDocumentParty. The Response for Information ResponseBusinessTransactionDocumentReference package includes the entity BaseRequestForInformationReference. The BaseRequestForInformationReference is typed by BusinessTransactionDocumentReference. The Response for Information ResponseTextCollection package can include the package Text. The TextCollection is typed by TextCollection. The Response for Information ResponseTextCollectionText package includes the entities Text. Text is unstructured, readable information that includes additional formatting information within TextCollection. The text is recorded in a specific language and is characterized by its text type. Text is typed by TextCollectionText.

The Response for Information ResponseAttachment package includes the entity AttachmentFolder. The AttachmentFolder is typed by AttachmentFolder. The Response for Information ResponseSection package can include the grouping of the packages Property, BusinessTransactionDocumentReference, TextCollection, and Attachment. The Section can include the following node elements: Response for InformationPropertyValuationList with a cardinality of 1:C, BaseRequestForInformationSectionReference with a cardinality of 1:1, TextCollection with a cardinality of 1:C, and AttachmentFolder with a cardinality of 1:C. The Response for Information ResponseSectionProperty package can include the entity Response for InformationPropertyValuationList. The Response for InformationPropertyValuationList includes the following non-node element: PropertyValuation. The PropertyValuation is the valuation of a property and can be based on datatype GDT:PropertyValuation. The Response for Information ResponseSectionBusinessTransactionDocumentReference package can include the entity BaseRequestForInformationSectionReference. The BaseRequestForInformationSectionReference is typed by BusinessTransactionDocumentReference. The Response for Information ResponseSectionTextCollection package can include the entity TextCollection. The TextCollection is typed by TextCollection. The Response for Information ResponseSectionAttachment package can include the entity AttachmentFolder. The AttachmentFolder is typed by AttachmentFolder.

FIGS. 39-1 through 39-3 show an example configuration of an Element Structure that includes a RFIResponseConfirmationMessage 39000 package. Specifically, these figures depict the arrangement and hierarchy of various components such as one or more levels of packages, entities, and datatypes, shown here as 39000 through 39118. As described above, packages may be used to represent hierarchy levels. Entities are discrete business elements that are used during a business transaction. Data types are used to type object entities and interfaces with a structure. For example, the RFIResponseConfirmationMessage 39000 includes, among other things, a RFIResponseConfirmationMessage 39002. Accordingly, heterogeneous applications may communicate using this consistent message configured as such.

FIGS. 40-1 through 40-4 depict an example object model for a business object Supplier Assessment Profile 40000. The business object 40000 has relationships with other objects 40002-40006, as shown with lines and arrows. The business object 40000 hierarchically comprises elements 40008-40036. The other objects 40002-40006 include respective elements 40040-40046 as shown.

The business object Supplier Assessment Profile is a profile for assessing suppliers, including rules, weighted assessment criteria, and questions related to supplier performance. The business object Supplier Assessment Profile belongs to the process component Supplier Performance Assessment. An assessment profile is typically assigned to multiple suppliers. In some implementations, it is possible to define an assessment profile for a specific product category. The supplier assessment profile can include information about involved parties, namely the appraisers, the appraisees, the responsible person employee of the assessment process. The supplier assessment profile can include questions regarding the performance of supplier hard and soft facts. The supplier assessment profile can include the product category to be assessed. The supplier assessment profile can include control data of the assessment process, expected target scores for each assessment category and for the whole assessment, and the assessment recurrences. The supplier assessment profile can include the definition how the criteria that belong to one category are weighted, and the weighting among the categories themselves.

A Supplier Assessment Profile Root Node is a profile for assessing the performance of suppliers. The Supplier Assessment Profile Root Node can include the involved parties appraiser, appraisee, assessment rules and properties as well as weightings. The Supplier Assessment Profile Root Node can include identification and administrative information of the profile. The Supplier Assessment Profile Root Node can be time dependent on Period. The elements located at the node Supplier Assessment Profile can be defined by the data type SupplierAssessmentProfileElements. These elements can include: ID, UUID, SystemAdministrativeData, TimeZoneCode, TemplateIndicator, Name, ProductCategory, IDKey, GracePeriodDuration, TargetScorePercent, LowerBoundaryScorePercent, UpperBoundaryScorePercent, TemplateSupplierAssessmentProfileUUID, and Status. The ID can be an alternative key. The ID is an identifier for the supplier assessment profile which can either be entered manually or is determined by the system and can be based on datatype GDT: BusinessTransactionDocumentID. The UUID can be an alternative key. The UUID is a globally unique identifier for a supplier assessment profile for referencing purposes and can be based on datatype GDT: UUID. The SystemAdministrativeData is administrative data that is stored in a system. The SystemAdministrativeData includes system users and change dates/times and can be based on datatype GDT: SystemAdministrativeData. The TimeZoneCode is a coded representation of the time zone for the supplier assessment profile and can be based on datatype GDT: TimeZoneCode. The time zone is used for the calculation of the assessment periods and deadlines. The TemplateIndicator is an indicator that specifies whether the supplier assessment profile is a template and can be based on datatype GDT: Indicator, with a qualifier of Template. The Name can be optional. The Name is the name of a supplier assessment profile and can be based on datatype GDT: MEDIUM_Name. In some implementations, the Name element cannot be changed when the supplier assessment profile has been released.

The ProductCategory can be optional. The ProductCategory is the product category for which the supplier will be assessed and can be based on datatype BOIDT: SupplierAssessmentProfileProductCategory. The ProductCategory can include UUID, IDKey, ProductCategoryHierarchyID, and ProductCategoryInternalID. The UUID can be optional. The UUID is a globally unique identifier for the product category and can be based on datatype GDT: UUID. The IDKey is a grouping of elements that uniquely identifies a product category by product category hierarchy ID and product category internal ID and can be based on datatype KDT: ProductCategoryHierarchyProductCategoryIDKey. The ProductCategoryHierarchyID is an identifier for a product category hierarchy and can be based on datatype GDT: ProductCategoryHierarchyID. The ProductCategoryInternalID is an identifier for a product category and can be based on datatype GDT: ProductCategoryInternalID. In some implementations, the entered product category cannot be changed when the supplier assessment period has been released. The GracePeriodDuration can be optional. The GracePeriodDuration is the time after the assessment period end date in which the submission of questionnaires for this assessment period is still allowed and can be based on datatype GDT: DAY_Duration, with a qualifier of GracePeriod. The TargetScorePercent can be optional. The TargetScorePercent is the target overall score for the supplier assessment and can be based on datatype GDT: SMALLNONNEGATIVE_Percent, with a qualifier of Score. The LowerBoundaryScorePercent can be optional. The LowerBoundaryScorePercent is the lower boundary of the score for the supplier assessment and can be based on datatype GDT: SMALLNONNEGATIVE_Percent, with a qualifier of Score. The UpperBoundaryScorePercent can be optional. The UpperBoundaryScorePercent the upper boundary of the score for the supplier assessment and can be based on datatype GDT: SMALLNONNEGATIVE_Percent, with a qualifier of Score. The TemplateSupplierAssessmentProfileUUID can be optional. The TemplateSupplierAssessmentProfileUUID is a globally unique identifier for a supplier assessment profile used as a template and can be based on datatype GDT: UUID. The Status is information about the lifecycle of the supplier assessment profile and the prerequisites for its processing steps. The Status includes the following elements that are defined by the data type SupplierAssessmentProfileStatusElements: ConsistencyStatusCode, and LifeCycleStatusCode. The Status can be based on datatype BOIDT: SupplierAssessmentProfileStatus. The ConsistencyStatusCode describes the status of a supplier assessment profile after a check process and can be based on datatype GDT: INCONSISTENTCONSISTENT_ConsistencyStatusCode. In some implementations, the following code values are supported: 2—Inconsistent, and 3—Consistent. The LifeCycleStatusCode is a coded representation of the life cycle of the supplier assessment profile and can be based on datatype GDT: SupplierAssessmentProfileLifeCycleStatusCode.

The following composition relationships to subordinate nodes can exist: Party with a cardinality of 1:CN, Assessment Category with a cardinality of 1:CN, CalendarDayRecurrenceSpecification with a cardinality of 1:C, Access Control List with a cardinality of 1:1, Text Collection with a cardinality of 1:C, Attachment Folder with a cardinality of 1:C, and Calculated Assessment Period with a cardinality of 1:CN. In some implementations, the Calculated Assessment Period is filtered. The filter elements can be defined by the data type SupplierAssessmentProfileCalculatedAssessmentPeriodFilterElements. The filter elements can include: StartDateTime, EndDateTime, LastAssessmentPeriodRequestedIndicator, and CurrentAssessmentPeriodRequestedIndicator. The StartDateTime can be optional. The StartDateTime is a start date and time to be displayed assessment periods and can be based on datatype GDT: LOCALNORMALISED_DateTime, with a qualifier of Start. The EndDateTime can be optional. The EndDateTime is an end date and time to be displayed assessment periods and can be based on datatype GDT: LOCALNORMALISED_DateTime, with a qualifier of End. The LastAssessmentPeriodRequestedIndicator can be optional. The LastAssessmentPeriodRequestedIndicator indicates whether the last assessment period is requested or not and can be based on datatype GDT: Indicator, with a qualifier of Requested. The CurrentAssessmentPeriodRequestedIndicator can be optional. The CurrentAssessmentPeriodRequestedIndicator indicates whether the last assessment period is requested or not and can be based on datatype GDT: Indicator, with a qualifier of Requested.

A Supplier Assessment Profile Root Node inbound aggregation relationship can exist from the business object Product Category Hierarchy/node Product Category with a cardinality of C:CN. The Product Category is the product category that classifies the supplier assessment profile. A Supplier Assessment Profile Root Node inbound association relationship can exist from the business object Identity/node Identity. The Creation Identity association relationship can have a cardinality of 1:CN. The Creation Identity is the identity that created the supplier assessment profile. A Supplier Assessment Profile Root Node inbound association relationship can exist from the business object Identity/node Identity. The Last Change Identity association relationship can have a cardinality of 1:CN. The Last Change Identity is the identity that changed the supplier assessment profile the last time.

The Supplier Assessment Profile Root Node can include Specialization Associations for Navigation. The Specialization Associations for Navigation can include to node Party, and to Supplier Assessment Run. The to node Party can include AppraiseeParty with a target cardinality of CN, AppraiserParty with a target cardinality of CN, EmployeeResponsible with a target cardinality of C, and BuyerParty with a target cardinality of C. The to Supplier Assessment Run can include SupplierAssessmentRun with a target cardinality of C. In some implementations, the UUID is determined by the service provider and cannot be changed. In some implementations, the SystemAdministrativeData is determined by the service provider and cannot be changed.

The Supplier Assessment Profile Root Node can include Enterprise Service Infrastructure Actions. The Enterprise Service Infrastructure Actions can include Activate action, Set to Obsolete action, Check and Determine action, and Start Assessment Run. The Activate action is the action used to activate a supplier assessment profile so that it is used for assessing the performance of the assigned suppliers. In some implementations, the Activate action is allowed if the lifecycle status is In Preparation and the business object is consistent and error free. In some implementations, a new instance of the Supplier Assessment Run MDRO is created and scheduled. In some implementations, executing the Activate action sets the SupplierAssessmentProfileLifeCycleStatusCode status variable to Released. The Set to Obsolete action is used to indicate that a supplier assessment profile must not be used for assessing the performance of the assigned appraisee's suppliers any longer. In some implementations, the Set to Obsolete action is only allowed if the supplier assessment profile has been activated. In some implementations, when a supplier assessment profile is closed, the instance of the Supplier Assessment Run MDRO that was created and scheduled for this supplier assessment profile is set to Closed. In some implementations, executing the Set to Obsolete action sets the SupplierAssessmentProfileLifeCycleStatusCode status variable to Closed. The Check and Determine action checks whether a supplier assessment profile is complete, consistent, and error-free. In some implementations, executing the Check and Determine action sets the ConsistencyStatusCode status variable to Consistent or Inconsistent. The Create with Reference creates a new supplier assessment profile from the data of an existing one. In some implementations, the Create with Reference creates a new instance as copy of the provided supplier assessment profile. The new ID can be determined from a number range. The Start Assessment Run starts an MDRO run. Depending on the action parameter, the result can be preliminary and will have no influence on the overall supplier assessment. The Start Assessment Run elements can be defined by the data type SupplierAssessmentProfileStartAssessmentRunActionElements. These elements can include FinalIndicator. The FinalIndicator can be optional and can be based on datatype GDT: Indicator.

The Supplier Assessment Profile Root Node can include Queries. The Queries can include Query By Elements, and Select All. Select All provides the node IDs of all instances of this node. The Select All query can be used to enable the initial load of data for the Fast Search Infrastructure. The Query By Elements provides a list of all supplier assessment profiles according to the specified selection elements. The query elements are defined by the data type SupplierAssessmentProfileElementsQueryElements. These elements can include: SearchText, ID, SystemAdministrativeData, Name, TemplateIndicator, ProductCategory, TemplateSupplierAssessmentProfileUUID, Status, PartyAppraiseePartyKey, PartyAppraiserPartyKey, PartyEmployeeResponsiblePartyKey, and CalendarDayRecurrenceSpecificationRecurringDayProgrammeCalendarDayRecurrence. The SearchText can be optional. The SearchText is a text that is searched for within all supplier assessment profiles and can be based on datatype GDT: SearchText. The ID can be optional and/or can be an alternative key. The ID is an identifier for the supplier assessment profile which can either be entered manually or is determined by the system and can be based on datatype GDT: BusinessTransactionDocumentID. The SystemAdministrativeData can be optional. The SystemAdministrativeData is administrative data that is stored in a system. This SystemAdministrativeData includes system users and change dates/times. The SystemAdministrativeData can be determined by the system and can be based on datatype QueryIDT: QueryElementSystemAdministrativeData. The SystemAdministrativeData can include CreationDateTime, CreationIdentityUUID, CreationIdentityID, CreationIdentityBusinessPartnerInternalID, CreationIdentityBusinessPartnerPersonFamilyName, CreationIdentityBusinessPartnerPersonGivenName, CreationIdentityEmployeeID, LastChangeDateTime, LastChangeIdentityUUID, LastChangeIdentityID, LastChangeIdentityBusinessPartnerInternalID, LastChangeIdentityBusinessPartnerPersonFamilyName, LastChangeIdentityBusinessPartnerPersonGivenName, and LastChangeIdentityEmployeeID. The CreationDateTime can be optional. The CreationDateTime is the point in time date and time stamp of the creation and can be based on datatype GDT: GLOBAL_DateTime. The CreationIdentityUUID can be optional. The CreationIdentityUUID is a globally unique identifier for the identity who did the creation and can be based on datatype GDT: UUID. The CreationIdentityID can be optional. The CreationIdentityID is an identifier for the identity who did the creation and can be based on datatype GDT: IdentityID. The CreationIdentityBusinessPartnerInternalID can be optional. The CreationIdentityBusinessPartnerInternalID is a proprietary identifier for the business partner that is attributed to the creation identity and that can be reached following the relationships of the creation identity and can be based on datatype GDT: BusinessPartnerInternalID. The CreationIdentityBusinessPartnerPersonFamilyName can be optional. The CreationIdentityBusinessPartnerPersonFamilyName is the family name of the business partner of the category person that is attributed to the creation identity and that can be reached following the relationships of the creation identity and can be based on datatype GDT: LANGUAGEINDEPENDENT_MEDIUM_Name. The CreationIdentityBusinessPartnerPersonGivenName can be optional. The CreationIdentityBusinessPartnerPersonGivenName is the given name of the business partner of the category person that is attributed to the creation identity and that can be reached following the relationships of the creation identity and can be based on datatype GDT: LANGUAGEINDEPENDENT_MEDIUM_Name. The CreationIdentityEmployeeID can be optional. The CreationIdentityEmployeeID is an identifier for the employee that is attributed to the creation identity and that can be reached following the relationships of the creation identity and can be based on datatype GDT: EmployeeID. The LastChangeDateTime can be optional. The LastChangeDateTime is the point in time date and time stamp of the last change and can be based on datatype GDT: GLOBAL_DateTime. The LastChangeIdentityUUID can be optional. The LastChangeIdentityUUID is a globally unique identifier for an identity who made the last changes and can be based on datatype GDT: UUID. The LastChangeIdentityID can be optional. The LastChangeIdentityID is an identifier for an identity who made the last changes and can be based on datatype GDT: IdentityID. The LastChangeIdentityBusinessPartnerInternalID can be optional. The LastChangeIdentityBusinessPartnerInternalID is a proprietary identifier for the business partner that is attributed to the last change identity and that can be reached following the relationships of the last change identity and can be based on datatype GDT: BusinessPartnerInternalID. The LastChangeIdentityBusinessPartnerPersonFamilyName can be optional. The LastChangeIdentityBusinessPartnerPersonFamilyName is the family name of the business partner of the category person that is attributed to the last change identity and that can be reached following the relationships of the last change identity and can be based on datatype GDT: LANGUAGEINDEPENDENT_MEDIUM_Name. The LastChangeIdentityBusinessPartnerPersonGivenName can be optional. The LastChangeIdentityBusinessPartnerPersonGivenName is the given name of the business partner of the category person that is attributed to the last change identity and that can be reached following the relationships of the last change identity and can be based on datatype GDT: LANGUAGEINDEPENDENT_MEDIUM_Name. The LastChangeIdentityEmployeeID can be optional. The LastChangeIdentityEmployeeID is an identifier for the employee that is attributed to the last change identity and that can be reached following the relationships of the last change identity and can be based on datatype GDT: EmployeeID.

The Name can be optional. The Name is the name of a supplier assessment profile and can be based on datatype GDT: MEDIUM_Name. In some implementations, the Name cannot be changed when the supplier assessment profile has been released. The TemplateIndicator can be optional. The TemplateIndicator is an indicator that specifies whether the supplier assessment profile is a template and can be based on datatype GDT: Indicator, with a qualifier of Template. The ProductCategory can be optional. The ProductCategory is the product category for which the supplier will be assessed and can be based on datatype BOIDT: SupplierAssessmentProfileProductCategory. The ProductCategory can include UUID and IDKey. The UUID can be optional. The UUID is a globally unique identifier for the product category and can be based on datatype GDT: UUID. The IDKey is a grouping of elements that uniquely identifies a product category by product category hierarchy ID and product category internal ID and can be based on datatype KDT: ProductCategoryHierarchyProductCategoryIDKey. The IDKey can include ProductCategoryHierarchyID and ProductCategoryInternalID. The ProductCategoryHierarchyID is an identifier for a product category hierarchy and can be based on datatype GDT: ProductCategoryHierarchyID. The ProductCategoryInternalID is an identifier for a product category and can be based on datatype GDT: ProductCategoryInternalID. In some implementations, the entered product category cannot be changed when the supplier assessment period has been released. The TemplateSupplierAssessmentProfileUUID can be optional. The TemplateSupplierAssessmentProfileUUID is a globally unique identifier for a supplier assessment profile used as a template and can be based on datatype GDT: UUID. The Status can be optional. The Status is information about the lifecycle of the supplier assessment profile and the prerequisites for its processing steps. The Status includes the following elements that are defined by the data type SupplierAssessmentProfileStatusElements and can be based on datatype BOIDT: SupplierAssessmentProfileStatus. The Status can include ConsistencyStatusCode, and LifeCycleStatusCode. The ConsistencyStatusCode describes the status of a supplier assessment profile after a check process and can be based on datatype GDT: INCONSISTENTCONSISTENT_ConsistencyStatusCode. In some implementations, the following code values are supported: 2—Inconsistent, and 3—Consistent. The LifeCycleStatusCode is a coded representation of the life cycle of the supplier assessment profile and can be based on datatype GDT: SupplierAssessmentProfileLifeCycleStatusCode.

The PartyAppraiseePartyKey can be optional. The PartyAppraiseePartyKey is a grouping of elements that uniquely identifies an appraiser party by party type code and party ID and can be based on datatype KDT: PartyKey. The PartyAppraiseePartyKey can include PartyTypeCode and PartyID. The PartyTypeCode is a coded representation of a type of party and can be based on datatype GDT: BusinessObjectTypeCode. The PartyID is an identifier for a party and can be based on datatype GDT: PartyID. The PartyAppraiserPartyKey can be optional. The PartyAppraiserPartyKey is a grouping of elements that uniquely identifies an appraisee party by party type code and party ID and can be based on datatype KDT: PartyKey. The PartyAppraiserPartyKey can include PartyTypeCode, and PartyID. The PartyTypeCode is a coded representation of a type of party and can be based on datatype GDT: BusinessObjectTypeCode. The PartyID is an identifier for a party and can be based on datatype GDT: PartyID. The PartyEmployeeResponsiblePartyKey can be optional. The PartyEmployeeResponsiblePartyKey can be based on datatype KDT: PartyKey. The PartyEmployeeResponsiblePartyKey can include PartyTypeCode and PartyID. The PartyTypeCode is a coded representation of a type of party and can be based on datatype GDT: BusinessObjectTypeCode. The PartyID is an identifier for a party and can be based on datatype GDT: PartyID. The CalendarDayRecurrenceSpecificationRecurringDayProgrammeCalendarDayRecurrence can be optional and can be based on datatype GDT: CalendarDayRecurrence.

A Party is a natural or legal person, organization, organizational unit, or group that is involved in a supplier assessment in a party role. The Party can occur within the following complete and disjoint specializations: AppraiseeParty, AppraiserParty, EmployeeResponsibleParty, and BuyerParty. The AppraiseeParty is a party that is assessed in a supplier assessment. The AppraiseeParty is a party of the specialization SupplierParty. An AppraiseeParty can have a contact person. The AppraiserParty is a party that assesses the appraisee. The AppraiserParty is a party of the specialization EmployeeParty. The EmployeeResponsibleParty is a party that is responsible and contact person for questions regarding the supplier assessment profile. The EmployeeResponsibleParty is a party of the specialization EmployeeParty. The BuyerParty is a party on behalf of which the supplier assessment is done. A BuyerParty can have a contact person. A party can be a person, organization, or group within or outside of the company. The elements located at the node Party are defined by the data type SupplierAssessmentProfilePartyElements. These elements can include: UUID, PartyUUID, PartyTypeCode, RoleCategoryCode, RoleCode, AddressReference, DeterminationMethodCode, and PartyKey. The UUID can be an alternative key. The UUID is a globally unique identifier for the supplier assessment profile party for referencing purposes and can be based on datatype GDT: UUID. The PartyUUID can be optional. The PartyUUID is a globally unique identifier for a business partner, the organizational center, or their specializations and can be based on datatype GDT: UUID. The PartyTypeCode can be optional. The PartyTypeCode is a coded representation of the type of business partner, organizational center, or their specializations referenced by the PartyUUID element and can be based on datatype GDT: BusinessObjectTypeCode. The RoleCategoryCode can be optional. The RoleCategoryCode is a coded representation of the role category of the party in the supplier assessment profile or the master data object and can be based on datatype GDT: PartyRoleCategoryCode. In some implementations, the following role codes are supported: 162 appraiser party, 163 appraisee party, or 39 employee responsible. The RoleCode is a coded representation of the role of the party in the supplier assessment profile or the master data object and can be based on datatype GDT: PartyRoleCode. The AddressReference can be optional. The AddressReference is a reference to the address of the party and can be based on datatype GDT: PartyAddressReference. The DeterminationMethodCode can be optional. The DeterminationMethodCode is a coded representation of the determination method of the party and can be based on datatype GDT: PartyDeterminationMethodCode. The PartyKey can be optional. The PartyKey is a grouping of elements that uniquely identifies the party by party type code and party ID and can be based on datatype KDT: PartyKey. The PartyKey can include PartyTypeCode, and PartyID. The PartyTypeCode is a coded representation of a type of party and can be based on datatype GDT: BusinessObjectTypeCode. The PartyID is an identifier for a party and can be based on datatype GDT: PartyID.

The following composition relationships to subordinate nodes can exist: Party Relationship with a cardinality of 1:CN, and Party Address with a cardinality of 1:C. A Party inbound aggregation relationship can exist from the business object Party/node Party with a cardinality of C:CN. The Party can be referenced in Master Data. The Party can include Specialization Associations for Navigation. The Specialization Associations for Navigation can include to Used Address transformed object/Root node. The to Used Address transformed object/Root node can include UsedAddress with a target cardinality of C. The Used Address transformed object represents a uniform way to access a party address of a supplier assessment profile, which can be a business partner address, an organization center address or an address specified within a supplier assessment profile. For the address used for the Party the UsedAddress can be: a referenced address of a master data object or the party address used by the composition relationship. The PartyAddressHostTypeCode element can determine the type of UsedAddress. The instance of the Used Address transformed object represents this address. In some implementations, the association is implemented. In some implementations, the PartyTypeCode, PartyAddressUUID and PartyAddressHostTypeCode elements are used to determine the Node ID of the node in the master data object, which holds the composition relationship to the Address dependent object, which is represented by the Used Address transformed object. The following information can be sent to the Used Address transformed object in the implemented association: the fact that it is a master data address, and/or the BusinessObjectTypeCode, BusinessObjectNodeTypeCode and Node ID of the Item Party node. These can be required if changes are made to the Used Address transformed object. In some implementations, if so, the Used Address transformed object copies the master data address, the changes are applied, and a corresponding Address dependent object is generated on the Item Party node by the Party Address composition relationship. In some implementations, the BusinessObjectTypeCode, Busines-sObjectNodeTypeCode and Node ID of the Item Party acre communicated to the Used Address transformed object. Whether or not it is a referenced address can be included. In this case, the Used Address transformed object represents the Address dependent object that is integrated by the Party Address composition relationship on the Item Party node. In some implementations, f the PartyUUID exists, the PartyTypeCode must also exist. Parties can be referenced via the Transformed Object Party that represents at least one of the following business objects: Company, FunctionalUnit, Supplier, Employee, and BusinessPartner. In some implementations, if the PartyID and PartyKey are not filled the party address should be maintained. In some implementations, an Appraisee party can be part of several supplier assessment profiles as long as these profiles differ in the element product category or another setting has been specified in the customizing. In some implementations, a supplier assessment profile includes only one EmployeeResponsibleParty. In some implementations, a supplier assessment profile includes at least one AppraiseeParty. In some implementations, a supplier assessment profile includes at least one AppraiserParty.

A Party Relationship is a relationship between two parties' appraiser and appraisee of the supplier assessment profile. The elements located directly at the node Party Relationship are defined by the data type SupplierAssessmentProfilePartyRelationshipElements. These elements can include PartyReference, and TypeCode. The PartyReference is a unique identifier for a referenced supplier assessment profile party and can be based on datatype GDT: ObjectNodeReference. The TypeCode is a type of relationship between the party and the referenced party by the party reference and can be based on datatype GDT: PartyRelationshipTypeCode. A Party Relationship inbound association relationship can exist from the business object Supplier Assessment Profile/node Party with a cardinality of 1:CN. A Party Address dependent object inclusion node is a supplier assessment profile-specific address of the party. An Assessment Category is a grouping of supplier assessment properties according to objective, enterprise-specific criteria. The assessment category can be used to structure the properties to be used for the assessment of a supplier. An assessment category can be, for example, “Quality” or “Technology.” The elements located at the node Assessment Category are defined by the data type SupplierAssessmentProfileAssessmentCategoryElements. These elements can include: UUID, ID, SystemAdministrativeData, WeightingFactorValue, OrdinalNumberValue, TargetScorePercent, LowerBoundaryScorePercent, and UpperBoundaryScorePercent. The UUID can be an alternative key. The UUID is a globally unique identifier for the supplier assessment profile category for referencing purposes and can be based on datatype GDT: UUID. The ID is a unique identifier for a supplier assessment profile assessment category within all categories and can be based on datatype GDT: BusinessTransactionDocumentItemID. The SystemAdministrativeData is administrative data that is stored in a system. The SystemAdministrativeData includes system users and change dates/times and can be based on datatype GDT: SystemAdministrativeData. The WeightingFactorValue is a value for the weighting number of this category in comparison to other categories of the same category hierarchy level. Higher number means higher importance and can be based on datatype GDT: WeightingFactorValue. The OrdinalNumberValue can be optional. The OrdinalNumberValue is a value that indicates the position of the assessment category in a linearly ordered set of assessment categories according to the user criteria and can be based on datatype GDT: OrdinalNumberValue. The TargetScorePercent can be optional. The TargetScorePercent is the target score for the supplier assessment category and can be based on datatype GDT: SMALLNONNEGATIVE_Percent. The LowerBoundaryScorePercent can be optional. The LowerBoundaryScorePercent is the lower boundary of the score for the supplier assessment category and can be based on datatype GDT: SMALLNONNEGATIVE_Percent. The UpperBoundaryScorePercent can be optional. The UpperBoundaryScorePercent is the upper boundary of the score for the supplier assessment category and can be based on datatype GDT: SMALLNONNEGATIVE_Percent.

The following composition relationships to subordinate nodes can exist: Assessment Category Supplier Assessment Property List with a cardinality of 1:C, Assessment Category Party with a cardinality of 1:CN, Assessment Category Text Collection with a cardinality of 1:C, and Assessment Category Attachment Folder with a cardinality of 1:C. A Party Relationship inbound association relationship can exist from the business object Identity/node Identity. The Last Change Identity association relationship can have a cardinality of 1:CN. The Last Change Identity can be the identity that changed the supplier assessment profile category the last time. A Party Relationship inbound association relationship can exist from the business object Identity/node Identity. The Creation Identity association relationship can have a cardinality of 1:CN. The Creation Identity is the identity that created the supplier assessment profile category. The

Party Relationship can include Specialization Associations for Navigation, including to node AssessmentCategoryParty. The to node AssessmentCategoryParty can include AppraiserAssessmentCategoryParty with a target cardinality of CN.

An Assessment Category Supplier Assessment Property List dependent object inclusion node is a list of properties from property libraries that are collected and adjusted to suit a supplier assessment. Attributes of the properties can be added or changed in the list. An Assessment Category Party is a natural or legal person that is involved in a supplier assessment category. An Assessment Category Party can occur within the following complete and disjoint specialization: AppraiserParty. The AppraiserParty is the party that assesses the category. In some implementations, only these appraiser parties are allowed to assess the related category. The AppraiserParty is a party of the specialization EmployeeParty. The elements located at the node Assessment Category Party are defined by the data type SupplierAssessmentProfileAssessmentCategoryPartyElements. These elements can include: UUID, PartyUUID, PartyTypeCode, RoleCategoryCode, RoleCode, AddressReference, DeterminationMethodCode, and PartyKey. The UUID can be an alternative key. The UUID is a globally unique identifier for the supplier assessment profile category party for referencing purposes and can be based on datatype GDT: UUID. The PartyUUID can be optional. The PartyUUID is a globally unique identifier for a business partner, the organizational center, or their specializations and can be based on datatype GDT: UUID. The PartyTypeCode can be optional. The PartyTypeCode is a coded representation of the type of business partner, organizational center, or their specializations referenced by the PartyUUID element and can be based on datatype GDT: BusinessObjectTypeCode. The RoleCategoryCode can be optional. The RoleCategoryCode is a coded representation of the role category of the party in the supplier assessment profile category or the master data object and can be based on datatype GDT: PartyRoleCategoryCode. The RoleCode is a coded representation of the role of the party in the supplier assessment profile category or the master data object and can be based on datatype GDT: PartyRoleCode. The AddressReference can be optional. The AddressReference is a reference to the address of the party and can be based on datatype GDT: PartyAddressReference. The DeterminationMethodCode can be optional. The DeterminationMethodCode is a coded representation of the determination method of the party and can be based on datatype GDT: PartyDeterminationMethodCode. The PartyKey can be optional. The PartyKey is a grouping of elements that uniquely identifies the party by party type code and party ID and can be based on datatype KDT: PartyKey. The PartyKey can include PartyTypeCode, and PartyID. The PartyTypeCode is a coded representation of a type of party and can be based on datatype GDT: BusinessObjectTypeCode. The PartyID is an identifier for a party and can be based on datatype GDT: PartyID.

The following composition relationship to subordinate nodes can exist: Assessment Category Party Address with a cardinality of 1:C. An AppraiserParty inbound aggregation relationship can exist from the business object Party/node Party with a cardinality of C:CN. The Party can be referenced in Master Data. The AppraiserParty can include Specialization Associations for Navigation including to Used Address transformed object/Root node. The to Used Address transformed object/Root node can include UsedAddress with a target cardinality of C. The Used Address transformed object can represent a uniform way to access a party address of a supplier assessment profile, which can be a business partner address, an organization center address or an address specified within a supplier assessment profile. For the address used for the Party this can be: a referenced address of a master data object or the party address used by the composition relationship. The PartyAddressHostTypeCode element can determine the type of address. The instance of the Used Address transformed object represents this address. In some implementations, the association is implemented. In some implementations, the PartyTypeCode, PartyAddressUUID and PartyAddressHostTypeCode elements are used to determine the Node ID of the node in the master data object, which holds the composition relationship to the Address dependent object, which is represented by the Used Address transformed object. The following information can be sent to the Used Address transformed object in the implemented association: the fact that it is a master data address and/or the BusinessObjectTypeCode, BusinessObjectNodeTypeCode and Node ID of the Item Party node. In some implementations, these are required if changes are made to the Used Address transformed object. In some implementations, if so, the Used Address transformed object copies the master data address, the changes are applied, and a corresponding Address dependent object is generated on the Item Party node by the Party Address composition relationship. In some implementations, the BusinessObjectTypeCode, Busines-sObjectNodeTypeCode and Node ID of the Item Party acre communicated to the Used Address transformed object. Whether or not it is a referenced address is also included. In this case, the Used Address transformed object represents the Address dependent object that is integrated by the Party Address composition relationship on the Item Party node. In some implementations, if the PartyUUID exists, the PartyTypeCode must also exist. In some implementations, Parties can only be referenced via the Transformed Object Party that represents at least one of the following business objects: Company, FunctionalUnit, Supplier, Employee, and BusinessPartner. In some implementations, if the PartyID and PartyKey are not filled the party address should be maintained. In some implementations, a supplier assessment profile includes at least one AppraiserParty.

An Assessment Category Party Address dependent object inclusion node is an assessment category-specific address of the party. An Assessment Category Text Collection dependent object inclusion node is a collection of all textual descriptions that are related to the assessment category. Each text can be specified in different languages and can include formatting information. An Assessment Category Attachment Folder dependent object inclusion node is a folder for all documents attached to the assessment category. A Calendar Day Recurrence Specification dependent object inclusion node is a set of dates that specify the occurrence of a recurring supplier performance assessment. An Access Control List dependent object inclusion node is a list of access groups that have access to the entire supplier assessment profile. A Text Collection dependent object inclusion node is a collection of all textual descriptions which are related to the supplier assessment profile. Each text can be specified in different languages and can include formatting information. An Attachment Folder dependent object inclusion node is a folder for all documents attached to a supplier assessment profile. A Calculated Assessment Period Transformation Node is an assessment period that is calculated using a recurrence rule for the supplier performance assessment. In some implementations, the Calculated Assessment Period Transformation Node is a transient node. The elements located at the node Calculated Assessment Period are defined by the data type SupplierAssessmentProfileCalculatedAssessmentPeriodElements. These elements can include: AssessmentPeriod, and AssessmentDeadlineDateTime. The AssessmentPeriod is an assessment period which is calculated using the recurring day program specified for the supplier performance assessment and can be based on datatype GDT: UPPEROPEN_LOCALNORMALISED_DateTimePeriod. The AssessmentDeadlineDateTime is a point in time which specifies the deadline of an assessment and can be based on datatype GDT: LOCALNORMALISED_DateTime. The assessment deadline can be calculated based on an assessment period and the grace period duration specified for the supplier performance assessment.

FIGS. 41-1 through 41-4 depict an example object model for a business object Supplier Questionnaire Assessment 41000. The business object 41000 has relationships with other objects 41002-41008, as shown with lines and arrows. The business object 41000 hierarchically comprises elements 41010-41032. The other objects 41002-41008 include respective elements 41034-41044 as shown.

A business object Supplier Questionnaire Assessment is an assessment of a supplier's performance based on a questionnaire. It includes answers to a list of questions about a supplier that is typically submitted by a buyer. The business object Supplier Questionnaire Assessment belongs to the process component Supplier Performance Assessment. The questionnaire assessment is based on personal experience gained by employees while working with the supplier.

The Supplier Questionnaire Assessment includes information about involved parties, namely the appraiser, the appraisee, and the responsible person, such as an employee, of the assessment process. It includes answers an appraiser gives in response to questions regarding the performance of a supplier, and the assessment period. The Business Object is involved in a Supplier Performance Assessment_IForm External Supplier Questionnaire Assessment Process Component Interaction Models.

Supplier Questionnaire Assessment root node is an assessment of a supplier's performance based on a questionnaire. It includes answers to a list of questions about a supplier that is typically submitted by a buyer. In some implementations, it may be Time dependent based on Period.

The elements located at the node Supplier Questionnaire Assessment can be defined by the data type SupplierQuestionnaireAssessmentElements. These elements include: UUID, ID, Name, SystemAdministrativeData, ReceiptDateTime, SupplierAssessmentProfileUUID, ProductCategory, Period, and Status. ProductCategory includes UUID and IDKey elements. Status includes LifeCycleStatusCode, ConsistencyStatusCode, DataEntryProcessingStatusCode, CancellationStatusCode, and IssuingStatusCode elements.

UUID is a globally unique identifier for a supplier questionnaire assessment for referencing purposes. In some implementations, UUID is used as an alternative key. It may be based on datatype GDT: UUID. ID is an identifier for a supplier questionnaire assessment, which can be entered manually or is determined by the system. In some implementations, ID is used as an alternative key. It may be based on datatype GDT: BusinessTransactionDocumentID. Name represents a name of a supplier questionnaire assessment. In some implementations, the element cannot be changed after the creation of the Supplier Questionnaire Assessment. It may be based on datatype GDT: MEDIUM_Name. SystemAdministrativeData represents administrative data that is stored in a system. This data includes system users and change dates and/or times. It may be based on datatype GDT: SystemAdministrativeData. ReceiptDateTime represents a point in time when the supplier questionnaire assessment has been received. It may be based on datatype GDT: LOCALNORMALISED_DateTime with Qualifier: Receipt. SupplierAssessmentProfileUUID is a globally unique identifier for a supplier assessment profile that specifies the assessment criteria. It may be based on datatype GDT: UUID. ProductCategory is a category that includes details for identifying a product category. The ProductCategory can be a division of products according to objective criteria. In some implementations, the product category is taken over from the supplier assessment profile and cannot be changed afterwards. It may be based on datatype BOIDT: SupplierQuestionnaireAssessmentProductCategory. UUID is a globally unique identifier for the product category. It may be based on datatype GDT: UUID. IDKey is a grouping of elements that uniquely identifies a product category by product category hierarchy ID and product category internal ID. It may be based on datatype KDT: ProductCategoryHierarchyProductCategoryIDKey. ProductCategoryHierarchyID is an identifier for a product category hierarchy. It may be based on datatype GDT: ProductCategoryHierarchyID. ProductCategoryInternalID is an identifier for a product category. It may be based on datatype GDT: ProductCategoryInternalID. Period represents a period for which an appraisee is assessed. In some implementations, a complete supplier questionnaire assessment must include exactly one assessment period. Only valid assessments periods defined by the corresponding supplier assessment profile are allowed. The period is taken over during the creation of the suppler questionnaire assessment and cannot be changed afterwards. It may be based on datatype GDT: UPPEROPEN_LOCALNORMALISED_DateTimePeriod. Status represents status information about the results and prerequisites of the supplier questionnaire assessments processing steps. It may be based on datatype BOIDT: SupplierQuestionnaireAssessmentStatus. LifeCycleStatusCode is an overall status variable that is used to provide an overall status of the SupplierQuoteAssessment's Lifecycle business object. It may be based on datatype GDT: SupplierQuestionnaireAssessmentLifeCycleStatusCode. ConsistencyStatusCode describes the status of the Supplier Questionnaire Assessment business object after a check process. It is a Boolean status variable, which may either be consistent or inconsistent, depending on whether the check process returned error messages or not, that is, whether the business object is consistent and error-free. The code values 2—Inconsistent and 3—Consistent may be supported.

The DataEntryProcessingStatusCode status variable represents the process of entering data into a supplier questionnaire assessment. The code values 2—In Process and 3—Finished may be supported. It may be based on datatype GDT: ProcessingStatusCode with Qualifier: DataEntry. The CancellationStatusCode status variable describes whether a supplier questionnaire assessment has been cancelled. In some implementations, a canceled supplier questionnaire assessment cannot be used in the assessment process any longer. The code values 1—Not Canceled and 4—Canceled may be supported. It may be based on GDT: CancellationStatusCode. The IssuingStatusCode status indicates whether a supplier questionnaire assessment has been issued to the appraiser. The code values 1—Not Issued and 3—Issued may be supported. It may be based on datatype GDT: IssuingStatusCode.

A composition relationship to a subordinate node Category may exist in a 1:CN cardinality relationship. A composition relationship to a subordinate node Party may exist in a 1:N cardinality relationship. A composition relationship to a subordinate node BusinessProcessVariantType may exist in a 1:N cardinality relationship. A composition relationship to a subordinate node Access Control List may exist in a 1:1 cardinality relationship. A composition relationship to a subordinate node Controlled Output Request may exist in a 1:C cardinality relationship. A composition relationship to a subordinate node Text Collection may exist in a 1:C cardinality relationship. A composition relationship to a subordinate node Attachment Folder may exist in a 1:C cardinality relationship.

An inbound aggregation relationship may exist from the business object Product Category Hierarchy/node Product Category to Product Category with a cardinality of C:CN, which may represent the product category for which an appraisee is assessed. An inbound aggregation relationship may exist from the business object Supplier Assessment Profile/node Supplier Assessment Profile to Supplier Assessment Profile with a cardinality of 1:CN, which may represent supplier assessment profile that defines the assessment categories and properties that are assessed in the questionnaire. An inbound association relationship may exist from the business object Identity/node Identity to Last Change Identity with a cardinality of 1:CN, which may identify the identity that last changed the supplier questionnaire assessment. An inbound association relationship may exist from the business object Identity/node Identity to Creation Identity with a cardinality of 1:CN, which may identify the identity that created the supplier questionnaire assessment. The following specialization associations for navigation may exist to the node Party: AppraiseeParty with a target cardinality of C, AppraiserParty with a target cardinality of C, and EmployeeResponsible with a target cardinality of C.

In some implementations, the ID must not be changed after creation. The UUID is determined by the service provider. The SystemAdministrativeData is determined by the service provider. In some implementations, once the supplier questionnaire assessment has been submitted, it cannot be changed any longer. In some implementations, a complete supplier questionnaire assessment must include exactly one AppraiserParty, one AppraiseeParty, one SupplierAssessmentProfileUUID and one SupplierQuestionnaireAssessmentPeriod.

The Supplier Questionnaire Assessment may be associated with the following enterprise service infrastructure actions: Submit, Finish Data Entry Processing, Issue, Check and Determine, Cancel, and Create with Reference.

The Submit action is used to submit the filled out supplier questionnaire assessment to the supplier assessment process. The Submit action can set the Supplier Questionnaire Assessment Life Cycle status to Submitted. In some implementations, a supplier questionnaire assessment can only be submitted if the assessment period is not completely in the future. In some implementations, the Submit action cannot be invoked when a supplier questionnaire assessment is Inconsistent or Cancelled. In some implementations, if a supplier questionnaire assessment object has been submitted, it cannot be changed any longer. Executing this action sets the SupplierQuestionnaireAssessmentSubmissionStatusCode status variable to Submitted.

The Finish Data Entry Processing action is used by the appraise party of a supplier questionnaire assessment to indicate that the data entry into a supplier questionnaire assessment has finished. In some implementations, the action is allowed as long as the supplier questionnaire assessment is not canceled or submitted. If the status is changed, the FinishDataEntryProcessing action sets the Data Entry Processing status to Finished.

The Issue action is used to issue a supplier questionnaire assessment to an appraiser. In some implementations, the action is always allowed as long as the supplier questionnaire assessment is not submitted, and the Data Entry Processing status is not Finished. If the status is changed, the Issue action sets the Issuing status to Issued.

The Check and Determine action checks whether the supplier questionnaire assessment is complete, consistent and error-free. Executing this action sets the status variable ConsistencyStatusCode to “Consistent” or “Inconsistent.”

The Cancel action is called by the responsible employee party of the assessment process to cancel a supplier questionnaire assessment. The Cancel action can set the SupplierQuestionnaireAssessmentLifeCycle status to Canceled. In some implementations, the action is always allowed as long as the supplier questionnaire assessment is not submitted. In some implementations, once the supplier questionnaire assessment is canceled, it cannot be changed any longer. Executing this action sets the status variable CancellationStatusCode status variable to Canceled.

The Create with Reference action is used to create a supplier questionnaire assessment with reference to a party relationship node of a supplier assessment profile. The following data from this supplier assessment profile is taken over: UUID to be stored in ProfileUUID, and ProductCategory to be stored in ProductCategory.

The UUID of the appraiser and the appraisee party which is stored in the party relationship and party node (to be stored in AppraiserUUID and AppraiseeUUID), Category to be stored in Category, and SupplierAssessmentProfilePropertyList to be stored in SupplierQuestionnaireAssessmentPropertyValuationList. In some implementations, a corresponding supplier assessment profile must be released. If the object is changed, this action creates a supplier questionnaire assessment and takes over specific data from the corresponding supplier assessment profile.

The Supplier Questionnaire Assessment includes Query By Elements and Select All Queries. The Query By Elements query provides a list of all supplier questionnaire assessment documents according to the specified selection elements. The Select All query provides the NodeIDs of all instances of this node. This query can be used to enable the initial load of data for the Fast Search Infrastructure.

The query elements can be defined by a data type SupplierQuestionnaireAssessmentElementsQueryElements. These elements include: SearchText, ID, SystemAdministrativeData, Name, PartyAppraiseePartyKey, PartyAppraiserPartyKey, SupplierAssessmentProfileUUID, Period, ProductCategory, and Status. SystemAdministrativeData includes CreationDateTime, CreationIdentityUUID, CreationIdentityID, CreationIdentityBusinessPartnerInternalID, CreationIdentityBusinessPartnerPersonFamilyName, CreationIdentityBusinessPartnerPersonGivenName, CreationIdentityEmployeeID, LastChangeDateTime, LastChangeIdentityUUID, LastChangeIdentityID, LastChangeIdentityBusinessPartnerInternalID, LastChangeIdentityBusinessPartnerPersonFamilyName, LastChangeIdentityBusinessPartnerPersonGivenName, and LastChangeIdentityEmployeeID elements. PartyAppraiseePartyKey and PartyAppraiserPartyKey include PartyTypeCode and PartyID elements. ProductCategory includes UUID and IDKey elements. IDKey includes ProductCategoryHierarchyID and ProductCategoryInternalID elements. Status includes LifeCycleStatusCode, ConsistencyStatusCode, DataEntryProcessingStatusCode, CancellationStatusCode and IssuingStatusCode elements.

SearchText is a text that is searched for within all supplier questionnaire assessments. It may be based on datatype GDT: SearchText. ID is an identifier for the supplier assessment profile, which can either be entered manually or is determined by the system. It may be based on datatype GDT: BusinessTransactionDocumentID. SystemAdministrativeData represents administrative data that is stored in a system. This data includes system users and change dates/times. It may be based on datatype QueryIDT: QueryElementSystemAdministrativeData. CreationDateTime represents a creation date/time (e.g., date and time stamp). It may be based on datatype GDT: GLOBAL_DateTime. CreationIdentityUUID is a universally unique identifier of an identity who did the creation. It may be based on datatype GDT: UUID. CreationIdentityID is an identifier for an identity who did the creation. It may be based on datatype GDT: IdentityID. CreationIdentityBusinessPartnerInternalID is a unique proprietary identifier of the business partner that is attributed to the creation identity and that can be reached following the relationships of the creation identity. It may be based on datatype GDT: BusinessPartnerInternalID. CreationIdentityBusinessPartnerPersonFamilyName represents the family name of the business partner of the category person that is attributed to the creation identity and that can be reached following the relationships of the creation identity. It may be based on datatype GDT: LANGUAGEINDEPENDENT_MEDIUM_Name. CreationIdentityBusinessPartnerPersonGivenName represents the given name of the business partner of the category person that is attributed to the creation identity and that can be reached following the relationships of the creation identity. It may be based on datatype GDT: LANGUAGEINDEPENDENT_MEDIUM_Name. CreationIdentityEmployeeID is a unique identifier of the employee that is attributed to the creation identity and that can be reached following the relationships of the creation identity. It may be based on datatype GDT: EmployeeID. LastChangeDateTime represents a time (e.g., date and time stamp) of the last change. It may be based on datatype GDT: GLOBAL_DateTime. LastChangeIdentityUUID is a universally unique identifier of an identity who did the last change. It may be based on datatype GDT: UUID. LastChangeIdentityID is a unique identifier of an identity who did the last change. It may be based on datatype GDT: IdentityID. LastChangeIdentityBusinessPartnerInternalID is a unique proprietary identifier of the business partner that is attributed to the last change identity and that can be reached following the relationships of the last change identity. It may be based on datatype GDT: BusinessPartnerInternalID. LastChangeIdentityBusinessPartnerPersonFamilyName represents a family name of the business partner of the category person that is attributed to the last change identity and that can be reached following the relationships of the last change identity. It may be based on datatype GDT: LANGUAGEINDEPENDENT_MEDIUM_Name. LastChangeIdentityBusinessPartnerPersonGivenName represents a given name of the business partner of the category person that is attributed to the last change identity and that can be reached following the relationships of the last change identity. It may be based on datatype GDT: LANGUAGEINDEPENDENT_MEDIUM_Name. LastChangeIdentityEmployeeID is a unique identifier of the employee that is attributed to the last change identity and that can be reached following the relationships of the last change identity. It may be based on datatype GDT: EmployeeID. Name may be based on datatype GDT: MEDIUM_Name. PartyAppraiseePartyKey is a grouping of elements that uniquely identifies the appraisee party by party type code and party ID. It may be based on datatype KDT: PartyKey. PartyTypeCode is a coded representation of a type of party. It may be based on datatype GDT: BusinessObjectTypeCode. PartyID is an identifier for a party. It may be based on datatype GDT: PartyID. PartyAppraiserPartyKey is a grouping of elements that uniquely identifies the appraiser party by party type code and party ID. It may be based on datatype KDT: PartyKey. SupplierAssessmentProfileUUID may be based on datatype GDT: UUID. Period may be based on datatype GDT: UPPEROPEN_LOCALNORMALISED_DateTimePeriod. ProductCategory is a category that includes details for identifying the product category. The ProductCategory is a division of products according to objective criteria. It may be based on datatype BOIDT: SupplierQuestionnaireAssessmentProductCategory. UUID is a globally unique identifier for the product category. It may be based on datatype GDT: UUID. IDKey is a grouping of elements that uniquely identifies a product category by product category hierarchy ID and product category internal ID. It may be based on datatype KDT: ProductCategoryHierarchyProductCategoryIDKey. ProductCategoryHierarchyID is an identifier for a product category hierarchy. It may be based on datatype GDT: ProductCategoryHierarchyID. ProductCategoryInternalID is an identifier for a product category. It may be based on datatype GDT: ProductCategoryInternalID. Status represents information about the status of the supplier questionnaire assessment. It may be based on datatype BOIDT: SupplierQuestionnaireAssessmentStatus. LifeCycleStatusCode is an overall status variable that is used to provide an overall status of the SupplierQuoteAssessment's Lifecycle business object. It may be based on datatype GDT: SupplierQuestionnaireAssessmentLifeCycleStatusCode. The ConsistencyStatusCode variable describes the status of the Supplier Questionnaire Assessment business object after a check process. It is a Boolean status variable, which may either be consistent or inconsistent, depending on whether the check process returned error messages or not, that is, whether the business object is consistent and error-free. The code values 2—Inconsistent and 3—Consistent may be supported. It may be based on datatype GDT: ConsistencyStatusCode. A DataEntryProcessingStatusCode status variable represents the process of entering data into a supplier questionnaire assessment. The code values 2—In Process and 3—Finished may be supported. It may be based on datatype GDT: ProcessingStatusCode with Qualifier: DataEntry. A CancellationStatusCode status variable describes whether a supplier questionnaire assessment has been cancelled. In some implementations, a canceled supplier questionnaire assessment cannot be used in the assessment process any longer. The code values 1—Not Canceled and 4—Canceled may be supported. It may be based on datatype GDT: CancellationStatusCode. An IssuingStatusCode status indicates whether a supplier questionnaire assessment has been issued to the appraiser. The code values 1—Not Issued and 3—Issued may be supported. It may be based on datatype GDT: IssuingStatusCode.

Category is a grouping of supplier assessment property valuations according to objective, enterprise-specific criteria. An assessment category can be, for example, “Quality” or

“Technology.” The elements located at the node Category can be defined by a data type SupplierQuestionnaireAssessmentCategoryElements. These elements include: UUID, ID, SystemAdministrativeData, OrdinalNumberValue, and SupplierAssessmentProfileCategoryUUID.

UUID is a unique identifier for the supplier questionnaire assessment category for referencing purposes. In some implementations, UUID is used as an alternative key. It may be based on datatype GDT: UUID. ID is a unique identifier for a supplier questionnaire assessment category within all categories. It may be based on datatype GDT: BusinessTransactionDocumentItemID. SystemAdministrativeData represents administrative data that is stored in a system. This data includes system users and change dates/times. It may be based on datatype GDT: SystemAdministrativeData. OrdinalNumberValue is a value that indicates the position of the assessment category in a linearly ordered set of assessment categories according to the user criteria. It may be based on datatype GDT: OrdinalNumberValue. SupplierAssessmentProfileCategoryUUID is a globally unique identifier for the suppler assessment profile category for referencing purposes. It may be based on datatype GDT: UUID.

A composition relationship to subordinate node Category Supplier Assessment Property Valuation List may exist in a 1:1 cardinality relationship. A composition relationship to subordinate node Category Attachment Folder may exist in a 1:C cardinality relationship. A composition relationship to subordinate node CategoryTextCollection may exist in a 1:C cardinality relationship.

An inbound aggregation relationship may exist from the business object Supplier Assessment Profile/node Assessment Category to Supplier Assessment Profile Assessment Category with a cardinality of 1:CN, which may represent the assessment category defined in a supplier assessment profile that is assessed in the questionnaire. An inbound association relationship may exist from the business object Identity/node Identity to Creation Identity with a cardinality of 1:CN, which may identify the identity that created the category. An inbound association relationship may exist from the business object Identity/node Identity to Last Change Identity with a cardinality of 1:CN, which may identify the identity that last changed the Category.

In some implementations, the assessment categories are defined in the supplier assessment profile and cannot be changed in the supplier questionnaire assessment. All assigned categories of one supplier questionnaire assessment have to be part of the assigned supplier assessment profile. Category Supplier Assessment Property Valuation List (Dependent Object Inclusion Node) is a list of instance-specific or group-specific supplier assessment criteria along with their valuations. Category Attachment Folder (Dependent Object Inclusion Node) is a folder for all documents attached to the assessment category. Category Text Collection (Dependent Object Inclusion Node) is a collection of all textual descriptions related to the category, including general comments at category level and the category designation. Each text can be specified in different languages and can include formatting information.

Party is a natural or legal person, organization, organizational unit, or group involved in a supplier assessment in a party role. A Party can occur within the following complete and disjoint specializations: AppraiseeParty, AppraiserParty, and EmployeeResponsibleParty. AppraiseeParty is a party that is assessed in a supplier questionnaire assessment. The AppraiseeParty can be a party of the specialization SupplierParty. An AppraiseeParty may have a contact person. AppraiserParty is a party that assesses the appraisee. The AppraiserParty can be a party of the specialization EmployeeParty. EmployeeResponsibleParty is a party that is responsible and contact person for the supplier questionnaire assessment. A party can be a person, organization, or group within or outside of the company.

The elements located at the node Party can be defined by a data type SupplierQuestionnaireAssessmentPartyElements. These elements include: UUID, PartyUUID, PartyTypeCode, RoleCategoryCode, RoleCode, AddressReference, DeterminationMethodCode, and PartyKey. PartyKey includes PartyTypeCode and PartyID elements.

UUID is a globally unique identifier of the supplier assessment profile party for referencing purposes. In some implementations, UUID is used as an alternative key. It may be based on datatype GDT: UUID. PartyUUID is a globally unique identifier for a business partner, the organizational center, or their specializations. It may be based on datatype GDT: UUID. PartyTypeCode is a coded representation of the type of business partner, organizational center, or their specializations referenced by the PartyUUID element. It may be based on datatype GDT: BusinessObjectTypeCode. RoleCategoryCode is a coded representation of the party role category of the Party in the supplier assessment profile or the master data object. The code values 162—AppraiserParty, 163—AppraiseeParty, and 39—EmployeeResponsibleParty may be supported. It may be based on datatype GDT: PartyRoleCategoryCode. RoleCode is a coded representation of the party role of the Party in the supplier assessment profile or the master data object. It may be based on datatype GDT: PartyRoleCode. AddressReference is a reference to the address of the Party. It may be based on datatype GDT: PartyAddressReference. DeterminationMethodCode is a coded representation of the determination method of the Party. It may be based on datatype GDT: PartyDeterminationMethodCode. PartyKey is a grouping of elements that uniquely identifies the party by party type code and party ID. It may be based on datatype KDT: PartyKey. PartyTypeCode is a coded representation of a type of party. It may be based on datatype GDT: BusinessObjectTypeCode. PartyID is an identifier for a party. It may be based on datatype GDT: PartyID.

A composition relationship to subordinate node PartyAddress may exist in a 1:C cardinality relationship. An inbound aggregation relationship may exist from the business object Party/node Party to Party with a cardinality of 1:CN, which may represent the Referenced Party in Master Data. A specialization association for navigation may exist to transformed object UsedAddress/Node Root from UsedAddress with a target cardinality of C, which may represent an Address used for the Party.

In some implementations, if the PartyUUID exists, the PartyTypeCode must also exist. Parties may be referenced via the Transformed Object Party that represents at least one of the business objects: Supplier, Employee, BusinessPartner. In some implementations, a supplier questionnaire assessment includes only one EmployeeResponsibleParty, AppraiseeParty, and AppraiserParty. Party Address (Dependent Object Inclusion Node) is a supplier questionnaire assessment specific address of the party.

Business Process Variant Type is a representation of a typical way of how supplier questionnaire assessments are processed within a process component, from a business point of view. A BusinessProcessVariantType can occur within the MainBusinessProcessVariantType and AdditionalBusinessProcessVariantType specializations. A business process variant can be a configuration of a process component. In some implementations, a business process variant belongs to exactly one process component. A process component is a software package that realizes a business process and exposes its functionality as services. The functionality includes business transactions. A process component includes one or more semantically related business objects. In some implementations, a business object belongs to exactly one process component.

The elements located at the node Business Process Variant Type can be defined by the data type SupplierQuestionnaireAssessmentBusinessProcessVariantTypeElements. These elements include BusinessProcessVariantTypeCode and MainIndicator.

BusinessProcessVariantTypeCode is a coded representation of a Supplier Questionnaire Assessment business process variant type. The code values 322—Supplier Performance Assessment-Standard and 323—Supplier Performance Assessment-With External Supplier Questionnaire Assessment Processing may be supported. It may be based on datatype GDT: BusinessProcessVariantTypeCode. MainIndicator is an indicator that specifies whether or not a business process variant type is a main business process variant type. It may be based on datatype GDT: Indicator with Qualifier: Main. In some implementations, only one of the business process variant type instances can be marked as main business process variant type.

Access Control List (Dependent Object Inclusion Node) is a list of access groups that have access to the entire supplier questionnaire assessment during a validity period. The access control list can be used to control the access to supplier questionnaire assessment instances. Controlled Output Request (Dependent Object Inclusion Node) is a controller of output requests and processed output requests related to the supplier questionnaire assessment. Several output channels can be supported for sending out documents. A controlled output request can support the output to several output channels. Possible output channels include print, e-mail, and fax. The ControlledOutputRequest can be used to display the output history of the Supplier Questionnaire Assessment. It can be used to define output channel and appraiser specific parameters. Text Collection (Dependent Object Inclusion Node) is a collection of all textual descriptions related to the supplier questionnaire assessment. Each text can be specified in different languages and can include formatting information. Attachment Folder (Dependent Object Inclusion Node) is a folder for all documents attached to a supplier questionnaire assessment.

FIGS. 42-1 through 42-2 depict an example Interactive Form Supplier Questionnaire Assessment Completion Request Message Data Type 42000, which comprises elements 42002-42020, hierarchically related as shown. For example, the Interactive Form Supplier Questionnaire Completion Request 42002 includes a Message Header 42004.

The message type Interactive Form Supplier Questionnaire Assessment Completion Request is derived from the business object Supplier Questionnaire Assessment as leading the object together with its operation signature. The message type Interactive Form Supplier Questionnaire Assessment Completion Request is a message type to enable interactive data entry in a supplier questionnaire assessment completion request. The structure of this message type can be determined by the message data type InteractiveFormSupplierQuestionnaireAssessmentCompletionRequestMessage.

The InteractiveFormSupplierQuestionnaireAssessmentCompletionRequestMessage message data type includes the object SupplierQuestionnaireAssessment which is included in the business document, and the business information relevant for sending a business document in a message. It includes MessageHeader and SupplierQuestionnaireAssessment packages. This message data type can provide the structure for the Interactive Form Supplier Questionnaire Assessment Completion Request message type and the operations that are based on it.

The MessageHeader package is a grouping of business information relevant for sending a business document in a message. It includes a MessageHeader node. MessageHeader is a grouping of business information from the perspective of the sending application. It includes information to identify the business document in a message, information about the sender, and optionally, information about the recipient. It may be based on datatype GDT:BusinessDocumentMessageHeader. The elements of the GDT used include: RecipientParty, BusinessScope, SenderParty, SenderBusinessSystemID, TestDataIndicator, RecipientBusinessSystemID, ReferenceID, ReferenceUUID, ReconciliationIndicator, ID, UUID, and CreationDateTime.

The MessageHeader includes SenderParty and RecipientParty elements. SenderParty is a partner responsible for sending a business document at a business application level. The SenderParty may be based on datatype GDT:BusinessDocumentMessageHeaderParty. RecipientParty is a partner responsible for receiving a business document at a business application level. The RecipientParty may be based on datatype GDT:BusinessDocumentMessageHeaderParty.

The InteractiveFormReturnURI package is a grouping of SupplierQuestionnaireAssessment with its packages. It includes an InteractiveFormReturnURI entity. InteractiveFormReturnURI can be typed by EmailURI.

The SupplierQuestionnaireAssessment package is a grouping of SupplierQuestionnaireAssessment with its packages. The packages include: Party, ProductInformation, Text, Attachment, and Category. It includes a SupplierQuestionnaireAssessment entity.

SupplierQuestionnaireAssessment is an assessment of a supplier's performance based on a questionnaire. SupplierQuestionnaireAssessment includes a ReconciliationPeriodCounterValue Attribute. ReconciliationPeriodCounterValue is a counter for reconciliation periods. It may be based on datatype GDT:CounterValue.

SupplierQuestionnaireAssessment includes the non-node elements: WatermarkName, ID, Name, SupplierAssessmentProfileID, Period, and PeriodClosureDateTime. WatermarkName may be based on datatype CDT:LANGUAGEINDEPENDENT_MEDIUM_Name. ID may be based on datatype GDT:BusinessTransactionDocumentID. Name may be based on datatype CDT:MEDIUM_Name. SupplierAssessmentProfileID may be based on datatype (GDT:BusinessTransactionDocumentID. Period may be based on datatype GDT:UPPEROPEN_LOCAL_DateTimePeriod. PeriodClosureDateTime may be based on datatype CDT:LOCAL_DateTime.

SupplierQuestionnaireAssessment includes a node element AppraiserParty in a 1:1 cardinality relationship, a node element AppraiseeParty in a 1:1 cardinality relationship, a node element EmployeeResponsibleParty in a 1:C cardinality relationship, a node element ProductCategory in a 1:C cardinality relationship, a node element TextCollection in a 1:C cardinality relationship, a node element AttachmentFolder in a 1:C cardinality relationship, and a node element Category in a 1:CN cardinality relationship.

The SupplierQuestionnaireAssessmentParty package includes AppraiserParty, AppraiseeParty, and EmployeeResponsibleParty entities.

AppraiserParty is a party that assesses an appraisee. The AppraiserParty can be a party of the specialization EmployeeParty. AppraiserParty includes non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormattedName, and FormAddress. InternalID may be based on datatype GDT:PartyInternalID. StandardID may be based on datatype GDT:PartyStandardID. BuyerID may be based on datatype GDT:PartyPartyID. SellerID may be based on datatype GDT:PartyPartyID. ProductRecipientID may be based on datatype GDT:PartyPartyID. VendorID may be based on datatype GDT:PartyPartyID. BillToID may be based on datatype GDT:PartyPartyID. BillFromID may be based on datatype GDT:PartyPartyID. BidderID may be based on datatype GDT:PartyPartyID. PaymentTransactionInitiatorID may be based on datatype GDT:PartyPartyID. PaymentTransactionDestinatedID may be based on datatype GDT:PartyPartyID. TaxID may be based on datatype GDT:PartyTaxID. TypeCode may be based on datatype GDT:BusinessObjectTypeCode. FormattedName may be based on datatype CDT:LANGUAGEINDEPENDENT_LONG_Name. FormAddress may be based on datatype GDT:FormAddress. AppraiserParty includes a node element ContactPerson in a 1:C cardinality relationship.

ContactPerson includes non-node elements: InternalID, BuyerID, SellerID, ProductRecipientID, VendorID, BillToID, BillFromID, BidderID, FormAddress, and FormattedName. InternalID is a proprietary identifier that is used when both sender and recipient can access shared master data. It may be based on datatype GDT:ContactPersonPartyID with Qualifier:Internal. BuyerID may be based on datatype GDT:ContactPersonPartyID. SellerID is a proprietary identifier that is used by the SellerParty for this location. It may be based on datatype GDT:ContactPersonPartyID with Qualifier:Seller. ProductRecipientID is a proprietary identifier that is used by the ProductRecipientParty for this location. It may be based on datatype GDT:ContactPersonPartyID with Qualifier:Product Recipient. VendorID may be based on datatype GDT:ContactPersonPartyID. BillToID may be based on datatype GDT:ContactPersonPartyID. BillFromID may be based on datatype GDT: ContactPersonPartyID. BidderID may be based on datatype GDT: ContactPersonPartyID. FormAddress may be based on datatype GDT:FormAddress. FormattedName may be based on datatype CDT:LANGUAGEINDEPENDENT_LONG_Name.

AppraiseeParty is a party that is assessed in a supplier questionnaire assessment. The AppraiseeParty can be a party of the specialization SupplierParty. An AppraiseeParty may have a contact person. AppraiseeParty includes the non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormattedName, and FormAddress. InternalID may be based on datatype GDT:PartyInternalID. StandardID may be based on datatype GDT:PartyStandardID. BuyerID may be based on datatype GDT:PartyPartyID. SellerID may be based on datatype GDT:PartyPartyID. ProductRecipientID may be based on datatype GDT:PartyPartyID. VendorID may be based on datatype GDT:PartyPartyID. BillToID may be based on datatype GDT:PartyPartyID. BillFromID may be based on datatype GDT:PartyPartyID. BidderID may be based on datatype GDT:PartyPartyID. PaymentTransactionInitiatorID may be based on datatype GDT:PartyPartyID. PaymentTransactionDestinatedID may be based on datatype GDT:PartyPartyID. TaxID may be based on datatype GDT:PartyTaxID. TypeCode may be based on datatype GDT:BusinessObjectTypeCode. FormattedName may be based on datatype CDT:LANGUAGEINDEPENDENT_LONG_Name. FormAddress may be based on datatype GDT:FormAddress. AppraiseeParty includes a node element ContactPerson in a 1:C cardinality relationship.

ContactPerson includes non-node elements: InternalID, BuyerID, SellerID, ProductRecipientID, VendorID, BillToID, BillFromID, BidderID, FormAddress, and FormattedName. InternalID is a proprietary identifier that is used when both sender and recipient can access shared master data. It may be based on datatype GDT:ContactPersonPartyID with Qualifier:Internal. BuyerID may be based on datatype GDT:ContactPersonPartyID. SellerID is a proprietary identifier that is used by the SellerParty for this location. It may be based on datatype GDT:ContactPersonPartyID with Qualifier:Seller. ProductRecipientID is a proprietary identifier that is used by the ProductRecipientParty for this location. It may be based on datatype GDT:ContactPersonPartyID with Qualifier:Product Recipient. VendorID may be based on datatype GDT:ContactPersonPartyID. BillToID may be based on datatype GDT:ContactPersonPartyID. BillFromID may be based on datatype GDT: ContactPersonPartyID. BidderID may be based on datatype GDT: ContactPersonPartyID. FormAddress may be based on datatype GDT:FormAddress. FormattedName may be based on datatype CDT:LANGUAGEINDEPENDENT_LONG_Name.

EmployeeResponsibleParty is a party that is responsible and contact person for the supplier questionnaire assessment. EmployeeResponsibleParty includes the non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormattedName, and FormAddress. InternalID may be based on datatype GDT:PartyInternalID. StandardID may be based on datatype GDT:PartyStandardID. BuyerID may be based on datatype GDT:PartyPartyID. SellerID may be based on datatype GDT:PartyPartyID. ProductRecipientID may be based on datatype GDT:PartyPartyID. VendorID may be based on datatype GDT:PartyPartyID. BillToID may be based on datatype GDT:PartyPartyID. BillFromID may be based on datatype GDT:PartyPartyID. BidderID may be based on datatype GDT:PartyPartyID. PaymentTransactionInitiatorID may be based on datatype GDT:PartyPartyID. PaymentTransactionDestinatedID may be based on datatype GDT:PartyPartyID. TaxID may be based on datatype GDT:PartyTaxID. TypeCode may be based on datatype GDT:BusinessObjectTypeCode. FormattedName may be based on datatype CDT:LANGUAGEINDEPENDENT_LONG_Name. FormAddress may be based on datatype GDT:FormAddress. EmployeeResponsibleParty includes a node element ContactPerson in a 1:C cardinality relationship.

ContactPerson includes non-node elements: InternalID, BuyerID, SellerID, ProductRecipientID, VendorID, BillToID, BillFromID, BidderID, FormAddress, and FormattedName. InternalID is a proprietary identifier that is used when both sender and recipient can access shared master data. It may be based on datatype GDT:ContactPersonPartyID with Qualifier:Internal. BuyerID may be based on datatype GDT:ContactPersonPartyID. SellerID is a proprietary identifier that is used by the SellerParty for this location. It may be based on datatype GDT:ContactPersonPartyID with Qualifier:Seller. ProductRecipientID is a proprietary identifier that is used by the ProductRecipientParty for this location. It may be based on datatype GDT:ContactPersonPartyID with Qualifier:Product Recipient. VendorID may be based on datatype GDT:ContactPersonPartyID. BillToID may be based on datatype GDT:ContactPersonPartyID. BillFromID may be based on datatype GDT: ContactPersonPartyID. BidderID may be based on datatype GDT: ContactPersonPartyID. FormAddress may be based on datatype GDT:FormAddress. FormattedName may be based on datatype CDT:LANGUAGEINDEPENDENT_LONG_Name.

The SupplierQuestionnaireAssessmentProductInformation package includes a ProductCategory entity. ProductCategory is a category that includes the details for identifying the product category. The ProductCategory is a division of products according to objective criteria. In some implementations, the product category is taken over from the supplier assessment profile and cannot be changed afterwards. ProductCategory includes the non-node elements: InternalID, StandardID, BuyerID, SellerID, ProductRecipientID, VendorID, ManufacturerID, BillToID, BillFromID, BidderID, and Description. InternalID may be based on datatype GDT:ProductInternalID. StandardID may be based on datatype GDT:ProductStandardID. BuyerID may be based on datatype GDT:ProductCategoryPartyID. SellerID may be based on datatype GDT:ProductCategoryPartyID. ProductRecipientID may be based on datatype GDT:ProductCategoryPartyID. VendorID may be based on datatype GDT:ProductCategoryPartyID. ManufacturerID may be based on datatype GDT:ProductCategoryPartyID. BillToID may be based on datatype GDT:ProductCategoryPartyID. BillFromID may be based on datatype GDT:ProductCategoryPartyID. BidderID may be based on datatype GDT:ProductCategoryPartyID. Description may be based on datatype GDT:MEDIUM_Description.

The SupplierQuestionnaireAssessmentText package includes a TextCollection entity. TextCollection is a collection of all textual descriptions related to the supplier questionnaire assessment. Each text can be specified in different languages and can include formatting information. TextCollection includes the non-node Text element. Text includes TypeCode, TypeName, SystemAdministrativeData, CreationDateTime, and ContentText elements. SystemAdministrativeData includes CreationDateTime, CreationIdentityUUID, CreationUserAccountID, CreationBusinessPartnerFormattedName, LastChangeDateTime, LastChangeIdentityUUID, LastChangeUserAccountID, and LastChangeBusinessPartnerFormattedName elements. Text may be based on datatype FMIDT:FormTextCollectionText. TypeCode may be based on datatype GDT:TextCollectionTextTypeCode. TypeName may be based on datatype CDT:LANGUAGEINDEPENDENT_MEDIUM_Name. SystemAdministrativeData may be based on datatype FMIDT:FormSystemAdministrativeData. CreationDateTime may be based on datatype CDT:LOCAL_DateTime. CreationIdentityUUID may be based on datatype GDT:UUID. CreationUserAccountID may be based on datatype GDT:UserAccountID. CreationBusinessPartnerFormattedName may be based on datatype CDT:LANGUAGEINDEPENDENT_LONG_Name. LastChangeDateTime may be based on datatype CDT:LOCAL_DateTime. LastChangeIdentityUUID may be based on datatype GDT:UUID. LastChangeUserAccountID may be based on datatype GDT:UserAccountID. LastChangeBusinessPartnerFormattedName may be based on datatype CDT:LANGUAGEINDEPENDENT_LONG_Name. CreationDateTime may be based on datatype CDT:LOCAL_DateTime. ContentText may be based on datatype CDT:Text.

The SupplierQuestionnaireAssessmentAttachment package includes an AttachmentFolder entity. AttachmentFolder is a folder for all documents attached to a supplier questionnaire assessment. AttachmentFolder can be typed by AttachmentFolder.

The SupplierQuestionnaireAssessmentCategory package includes a grouping of the AssessmentProperty and Text packages. Category is a grouping of supplier assessment property valuations according to objective, enterprise-specific criteria. Category includes non-node elements ID and OrdinalNumberValue. ID may be based on datatype GDT:BusinessTransactionDocumentItemID. OrdinalNumberValue may be based on datatype GDT:OrdinalNumberValue. Category includes a node element PropertyValuationList in a 1:1 cardinality relationship, and a node element TextCollection in a 1:C cardinality relationship.

The SupplierQuestionnaireAssessmentCategoryAssessmentProperty package includes a PropertyValuationList entity. PropertyValuationList is a list of instance-specific or group-specific supplier assessment criteria along with their valuations. PropertyValuationList includes a non-node PropertyValuation element. PropertyValuation includes PropertyID, PropertyName, PropertyTextCollection, PropertyDataTypeFormatCode, PropertyValue, PropertyValuationTextCollection, Allowed Value, IntervalBoundaryTypeCode, LowerBoundaryObjectPropertyValue, UpperBoundaryObjectPropertyValue, PropertyValueName, PropertyValueTextCollection, OrdinalNumberValue, ValuationRequiredIndicator, and SupplierAssessmentSpecification elements. PropertyTextCollection includes Text, TypeCode, TypeName, SystemAdministrativeData, CreationDateTime, and ContentText elements. SystemAdministrativeData includes CreationDateTime, CreationIdentityUUID, CreationUserAccountID, CreationBusinessPartnerFormattedName, LastChangeDateTime, LastChangeIdentityUUID, LastChangeUserAccountID, and LastChangeBusinessPartnerFormattedName elements. PropertyValue includes IntervalBoundaryTypeCode, LowerBoundaryObjectPropertyValue, UpperBoundaryObjectPropertyValue, PropertyValueName, PropertyValueTextCollection, and OrdinalNumberValue elements. PropertyValueTextCollection includes Text, TypeCode, TypeName, SystemAdministrativeData, CreationDateTime, and ContentText. SystemAdministrativeData includes CreationDateTime, CreationIdentityUUID, CreationUserAccountID, CreationBusinessPartnerFormattedName, LastChangeDateTime, LastChangeIdentityUUID, LastChangeUserAccountID, and LastChangeBusinessPartnerFormattedName elements. PropertyValuationTextCollection includes Text, TypeCode, TypeName, SystemAdministrativeData, CreationDateTime, and ContentText. SystemAdministrativeData includes CreationDateTime, CreationIdentityUUID, CreationUserAccountID, CreationBusinessPartnerFormattedName, LastChangeDateTime, LastChangeIdentityUUID, LastChangeUserAccountID, and LastChangeBusinessPartnerFormattedName elements. PropertyValueTextCollection includes Text, TypeCode, TypeName, SystemAdministrativeData, CreationDateTime, and ContentText. SystemAdministrativeData includes CreationDateTime, CreationIdentityUUID, CreationUserAccountID, CreationBusinessPartnerFormattedName, LastChangeDateTime, LastChangeIdentityUUID, LastChangeUserAccountID, and LastChangeBusinessPartnerFormattedName elements. SupplierAssessmentSpecification includes SupplierAssessmentPropertyAssessmentMethodCode, SupplierAssessmentPropertyAssessmentMethodCodeName, and WeightingFactorValue elements.

PropertyValuation represents a valuation of a property. It may be based on datatype FMIDT:FormPropertyValuationListPropertyValuation. PropertyID is an identifier for the property in a property library. It may be based on datatype GDT:PropertyID. PropertyName is a word or combination of words that names a property. It may be based on datatype CDT:EXTENDED_Name. PropertyTextCollection is a collection of natural-language specific texts with additional information about the property. This text may include formatting information. This can be used for different purposes depending on the use case. It may be based on datatype FMIDT:FormTextCollection. Text may be based on datatype FMIDT:FormTextCollectionText. TypeCode may be based on datatype GDT:TextCollectionTextTypeCode. TypeName may be based on datatype CDT:LANGUAGEINDEPENDENT_MEDIUM_Name. SystemAdministrativeData may be based on datatype FMIDT:FormSystemAdministrativeData. CreationDateTime may be based on datatype CDT:LOCAL_DateTime. CreationIdentityUUID may be based on datatype GDT:UUID. CreationUserAccountID may be based on datatype GDT:UserAccountID. CreationBusinessPartnerFormattedName may be based on datatype CDT:LANGUAGEINDEPENDENT_LONG_Name. LastChangeDateTime may be based on datatype CDT:LOCAL_DateTime. LastChangeIdentityUUID may be based on datatype GDT:UUID. LastChangeUserAccountID may be based on datatype GDT:UserAccountID. LastChangeBusinessPartnerFormattedName may be based on datatype CDT:LANGUAGEINDEPENDENT_LONG_Name. CreationDateTime may be based on datatype CDT:LOCAL_DateTime. ContentText may be based on datatype CDT:Text. PropertyDataTypeFormatCode represents a format of the property. It may be based on datatype GDT:PropertyDataTypeFormatCode. PropertyValue represents a value of a property. It may be based on datatype FMIDT:FormPropertyValue. IntervalBoundaryTypeCode is a coded representation of an interval boundary type. It may be based on datatype GDT:IntervalBoundaryTypeCode. LowerBoundaryObjectPropertyValue represents a lower boundary property value. Lower boundary property value can be used to store single values. It may be based on datatype GDT:ObjectPropertyValue with Qualifier:LowerBoundary. UpperBoundaryObjectPropertyValue represents an upper boundary property value. It may be based on datatype GDT:UpperBoundaryObjectPropertyValue. PropertyValueName is a language-specific designation for a property value. It may be based on datatype CDT:EXTENDED_Name. PropertyValueTextCollection is a collection of natural-language specific texts with additional information about the property value. This text may include formatting information. This can be used for different purposes depending on the use case. It may be based on datatype FMIDT:FormTextCollection. Text may be based on datatype FMIDT:FormTextCollectionText. TypeCode may be based on datatype GDT:TextCollectionTextTypeCode. TypeName may be based on datatype CDT:LANGUAGEINDEPENDENT_MEDIUM_Name. SystemAdministrativeData may be based on datatype FMIDT:FormSystemAdministrativeData. CreationDateTime may be based on datatype CDT:LOCAL_DateTime. CreationIdentityUUID may be based on datatype GDT:UUID. CreationUserAccountID may be based on datatype GDT:UserAccountID. CreationBusinessPartnerFormattedName may be based on datatype CDT:LANGUAGEINDEPENDENT_LONG_Name. LastChangeDateTime may be based on datatype CDT:LOCAL_DateTime. LastChangeIdentityUUID may be based on datatype GDT:UUID. LastChangeUserAccountID may be based on datatype GDT:UserAccountID. LastChangeBusinessPartnerFormattedName may be based on datatype CDT:LANGUAGEINDEPENDENT_LONG_Name. CreationDateTime may be based on datatype CDT:LOCAL_DateTime. ContentText may be based on datatype CDT:Text. OrdinalNumberValue is a value that specifies the position of the property value for a multivalued property in a list. It may be based on datatype GDT:OrdinalNumberValue. PropertyValuationTextCollection is a collection of natural-language specific texts with additional information about the property valuation. This text may include formatting information. This can be used for different purposes depending on the use case. It may be based on datatype FMIDT:FormTextCollection. Text may be based on datatype FMIDT:FormTextCollectionText. TypeCode may be based on datatype GDT:TextCollectionTextTypeCode. TypeName may be based on datatype CDT:LANGUAGEINDEPENDENT_MEDIUM_Name. SystemAdministrativeData may be based on datatype FMIDT:FormSystemAdministrativeData. CreationDateTime may be based on datatype CDT:LOCAL_DateTime. CreationIdentityUUID may be based on datatype GDT:UUID. CreationUserAccountID may be based on datatype GDT:UserAccountID. CreationBusinessPartnerFormattedName may be based on datatype CDT:LANGUAGEINDEPENDENT_LONG_Name. LastChangeDateTime may be based on datatype CDT:LOCAL_DateTime. LastChangeIdentityUUID may be based on datatype GDT:UUID. LastChangeUserAccountID may be based on datatype GDT:UserAccountID. LastChangeBusinessPartnerFormattedName may be based on datatype CDT:LANGUAGEINDEPENDENT_LONG_Name. CreationDateTime may be based on datatype CDT:LOCAL_DateTime. ContentText may be based on datatype CDT:Text. AllowedValue is an allowed property-valuation-list specific value that can be chosen during property valuation. It may be based on datatype FMIDT:FormPropertyValue. IntervalBoundaryTypeCode is a coded representation of an interval boundary type. It may be based on datatype GDT:IntervalBoundaryTypeCode. LowerBoundaryObjectPropertyValue represents a lower boundary property value. Lower boundary property value can be used to store single values. It may be based on datatype GDT:ObjectPropertyValue with Qualifier:LowerBoundary. UpperBoundaryObjectPropertyValue represents an upper boundary property value. It may be based on datatype GDT:UpperBoundaryObjectPropertyValue. PropertyValueName is a language-specific designation for a property value. It may be based on datatype CDT:EXTENDED_Name. PropertyValueTextCollection is a collection of natural-language specific texts with additional information about the property value. This text may include formatting information. This can be used for different purposes depending on the use case. It may be based on datatype FMIDT:FormTextCollection. Text may be based on datatype FMIDT:FormTextCollectionText. TypeCode may be based on datatype GDT:TextCollectionTextTypeCode. TypeName may be based on datatype CDT:LANGUAGEINDEPENDENT_MEDIUM_Name. SystemAdministrativeData may be based on datatype FMIDT:FormSystemAdministrativeData. CreationDateTime may be based on datatype CDT:LOCAL_DateTime. CreationIdentityUUID may be based on datatype GDT:UUID. CreationUserAccountID may be based on datatype GDT:UserAccountID. CreationBusinessPartnerFormattedName may be based on datatype CDT:LANGUAGEINDEPENDENT_LONG_Name. LastChangeDateTime may be based on datatype CDT:LOCAL_DateTime. LastChangeIdentityUUID may be based on datatype GDT:UUID. LastChangeUserAccountID may be based on datatype GDT:UserAccountID. LastChangeBusinessPartnerFormattedName may be based on datatype CDT:LANGUAGEINDEPENDENT_LONG_Name. CreationDateTime may be based on datatype CDT:LOCAL_DateTime. ContentText may be based on datatype CDT:Text. OrdinalNumberValue is a value that specifies the position of the property value for a multi-valued property in a list. It may be based on datatype GDT:OrdinalNumberValue. OrdinalNumberValue is a value that specifies the position of the property valuation in a list. It may be based on datatype GDT:OrdinalNumberValue. ValuationRequiredIndicator is an indicator that specifies whether or not a value is assigned to the property valuation. It may be based on datatype CDT:Indicator with Qualifier:Required. SupplierAssessmentSpecification is a collection of supplier assessment specific information about the property. It may be based on datatype FMIDT:FormPropertyListPropertySupplierAssessmentSpecification. SupplierAssessmentPropertyAssessmentMethodCode is a coded representation of a property assessment method, which can specify the method according to which a supplier assessment property is assessed. It may be based on datatype GDT: SupplierAssessmentPropertyAssessmentMethodCode. SupplierAssessmentPropertyAssessmentMethodCodeName is a word or combination of words that names a property assessment method. It may be based on datatype CDT:EXTENDED_Name. WeightingFactorValue is a value that specifies the weighting of the property in a supplier assessment. It may be based on datatype GDT:WeightingFactorValue.

The SupplierQuestionnaireAssessmentCategoryText package includes a TextCollection entity. TextCollection is a collection of all textual descriptions related to the supplier questionnaire assessment. Each text can be specified in different languages and can include formatting information. TextCollection includes a non-node Text element. Text includes TypeCode, TypeName, SystemAdministrativeData, CreationDateTime, and ContentText elements. SystemAdministrativeData includes CreationDateTime, CreationIdentityUUID, CreationUserAccountID, CreationBusinessPartnerFormattedName, LastChangeDateTime, LastChangeIdentityUUID, LastChangeUserAccountID, and LastChangeBusinessPartnerFormattedName elements. Text may be based on datatype FMIDT:FormTextCollectionText. TypeCode may be based on datatype GDT:TextCollectionTextTypeCode. TypeName may be based on datatype CDT:LANGUAGEINDEPENDENT_MEDIUM_Name. SystemAdministrativeData may be based on datatype FMIDT:FormSystemAdministrativeData. CreationDateTime may be based on datatype CDT:LOCAL_DateTime. ContentText may be based on datatype CDT:Text. CreationDateTime may be based on datatype CDT:LOCAL_DateTime. CreationIdentityUUID may be based on datatype GDT:UUID. CreationUserAccountID may be based on datatype GDT:UserAccountID. CreationBusinessPartnerFormattedName may be based on datatype CDT:LANGUAGEINDEPENDENT_LONG_Name. LastChangeDateTime may be based on datatype CDT:LOCAL_DateTime. LastChangeIdentityUUID may be based on datatype GDT:UUID. LastChangeUserAccountID may be based on datatype GDT:UserAccountID. LastChangeBusinessPartnerFormattedName may be based on datatype CDT:LANGUAGEINDEPENDENT_LONG_Name.

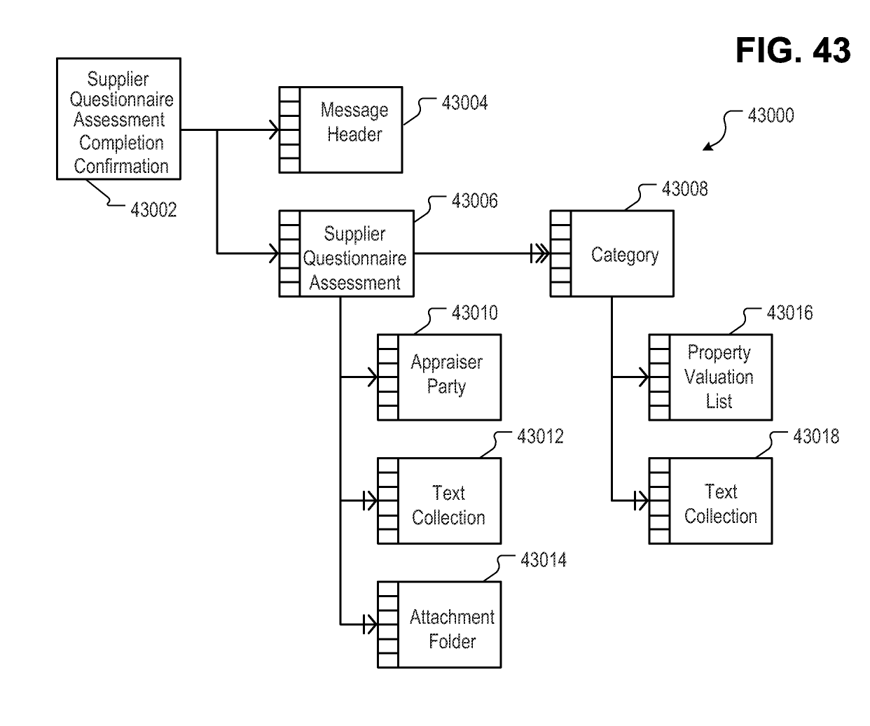

FIG. 43 depicts an example Supplier Questionnaire Assessment Completion Confirmation Message Data Type 43000, which comprises elements 43002-43018, hierarchically related as shown. For example, the Supplier Questionnaire Assessment Completion Confirmation 43002 includes a Message Header 43004.

The message type Supplier Questionnaire Assessment Completion Confirmation is derived from the business object Supplier Questionnaire Assessment as leading object together with its operation signature. The message type Supplier Questionnaire Assessment Completion Confirmation is a confirmation about the completion of a supplier questionnaire assessment. The structure of this message type can be determined by the message data type SupplierQuestionnaireAssessmentCompletionConfirmationMessage.

The SupplierQuestionnaireAssessmentCompletionConfirmationMessage message data type includes an object SupplierQuestionnaireAssessment which is included in the business document, and business information relevant for sending a business document in a message. It includes MessageHeader and SupplierQuestionnaireAssessment packages. This message data type can provide the structure for the Supplier Questionnaire Assessment Completion Confirmation message type and the operations that are based on it.

The MessageHeader package is a grouping of business information that is relevant for sending a business document in a message. It includes a MessageHeader node. The MessageHeader is a grouping of business information from the perspective of the sending application. It includes information to identify the business document in a message, information about the sender, and optionally, information about the recipient. The MessageHeader includes SenderParty and RecipientParty elements. It can be of the type GDT:BusinessDocumentMessageHeader. The elements of the GDT used include: RecipientParty, BusinessScope, SenderParty, SenderBusinessSystemID, TestDataIndicator, RecipientBusinessSystemID, ReferenceID, ReferenceUUID, ReconciliationIndicator, ID, UUID, and CreationDateTime. The SenderParty is a partner responsible for sending a business document at a business application level. The SenderParty can be of the type GDT:BusinessDocumentMessageHeaderParty. The RecipientParty is a partner responsible for receiving a business document at a business application level. The RecipientParty can be of the type GDT:BusinessDocumentMessageHeaderParty.

The SupplierQuestionnaireAssessment package is the grouping of SupplierQuestionnaireAssessment with its packages. The packages include: Party, Text, Attachment, and Category. It includes a SupplierQuestionnaireAssessment entity.

SupplierQuestionnaireAssessment includes a ReconciliationPeriodCounterValue Attribute. ReconciliationPeriodCounterValue is a counter for reconciliation periods. In some implementations, for internal communication, the reconciliationPeriodCounterValue is mandatory. It may be based on datatype GDT:CounterValue. SupplierQuestionnaireAssessment includes a non-node ID element. ID may be based on datatype GDT:BusinessTransactionDocumentID. SupplierQuestionnaireAssessment includes a node element AppraiserParty in a 1:1 cardinality relationship, a node element TextCollection in a 1:C cardinality relationship, a node element AttachmentFolder in a 1:C cardinality relationship, and a node element Category in a 1:CN cardinality relationship.

The SupplierQuestionnaireAssessmentParty package includes an AppraiserParty entity. AppraiserParty is a party that assesses the appraisee. AppraiserParty can be typed by BusinessTransactionDocumentParty. The SupplierQuestionnaireAssessmentText package includes a TextCollection entity. TextCollection can be typed by TextCollection. The SupplierQuestionnaireAssessmentAttachment package includes an AttachmentFolder entity. AttachmentFolder can be typed by AttachmentFolder.

The SupplierQuestionnaireAssessmentCategory package includes a Category entity. Category includes a non-node ID element. ID may be based on datatype GDT:BusinessTransactionDocumentItemID. SupplierQuestionnaireAssessmentCategory includes a node element PropertyValuationList in a 1:1 cardinality relationship, and a node element TextCollection in a 1:C cardinality relationship.

The SupplierQuestionnaireAssessmentCategoryAssessmentProperty package includes a PropertyValuationList entity. PropertyValuationList includes a non-node PropertyValuation element. PropertyValuation represents the valuation of a property. It may be based on datatype MAGDT:PropertyValuation_V1.

The SupplierQuestionnaireAssessmentCategoryText package includes a TextCollection entity. TextCollection can be typed by TextCollection.

FIGS. 44-1 through 44-65 show an example configuration of an Element Structure that includes an InteractiveFormSupplierQuestionnaireAssessmentCompletionRequest 440000 package. Specifically, these figures depict the arrangement and hierarchy of various components such as one or more levels of packages, entities, and datatypes, shown here as 440000 through 441764. As described above, packages may be used to represent hierarchy levels. Entities are discrete business elements that are used during a business transaction. Data types are used to type object entities and interfaces with a structure. For example, the InteractiveFormSupplierQuestionnaireAssessmentCompletionRequest 440000 includes, among other things, an InteractiveFormSupplierQuestionnaireAssessmentCompletionRequest 440002. Accordingly, heterogeneous applications may communicate using this consistent message configured as such.

FIGS. 45-1 through 45-79 show an example configuration of an Element Structure that includes a SupplierQuestionnaireAssessmentCompletionConfirmation 450000 package. Specifically, these figures depict the arrangement and hierarchy of various components such as one or more levels of packages, entities, and datatypes, shown here as 450000 through 451976. As described above, packages may be used to represent hierarchy levels. Entities are discrete business elements that are used during a business transaction. Data types are used to type object entities and interfaces with a structure. For example, the SupplierQuestionnaireAssessmentCompletionConfirmation 450000 includes, among other things, a SupplierQuestionnaireAssessmentCompletionConfirmation 450002. Accordingly, heterogeneous applications may communicate using this consistent message configured as such.

FIGS. 46-1 through 46-8 depict an example object model for a business object Supplier Transaction Assessment 46000. The business object 46000 has relationships with other objects 46002-46026, as shown with lines and arrows. The business object 46000 hierarchically comprises elements 46028-46044. The other objects 46002-46026 include respective elements 46046-46082 as shown.

The business object Supplier Transaction Assessment is an assessment of a supplier's performance based on an automatic evaluation of a business transaction and its follow-on business transactions. The business object Supplier Transaction Assessment belongs to the process component Supplier Performance Assessment. For example, the assessment can be based on the automatic evaluation of a purchase order and the follow-on documents such as inbound delivery, supplier invoices, and material inspection documents. The information used to assess a purchase order can include ordered quantity, price and date, as well as actual delivered quantity and date, and invoiced quantity and amount.

A supplier transaction assessment business object includes: 1) Detailed information about a supplier's business transactions, including information about the items, quantity, price, and delivery period; 2) Data on all parties involved in a supplier's business transactions such as a purchaser and a responsible purchasing unit; 3) Details about various assessment scores that are automatically computed; 4) Associations to related purchasing documents such as purchase orders, confirmed inbound deliveries, supplier invoices, material inspections; and 5) Associations to related supplier assessment results.

The business object Supplier Transaction Assessment is involved in the following Process Component Interaction Models: Material Inspection Processing_Supplier Performance Assessment and Purchase Order Processing_Supplier Performance Assessment.

An interface SupplierPerformanceAssessmentTransactionAssessmentIn includes various service operations. The operation Interface Transaction Assessment In is part of the following Process Component Interaction Models: Material Inspection Processing_Supplier Performance Assessment and Purchase Order Processing_Supplier Performance Assessment. A service Maintain Supplier Transaction Assessment is on message type Supplier Transaction Assessment Notification (derived from business object Supplier Transaction Assessment).

The Business Object Supplier Transaction Assessment includes a Supplier Transaction Assessment entity (Root Node), which is the assessment of a supplier's performance based on business transactions that are evaluated automatically. All the business transactions and its assessed scores are described in an item and its sub-nodes. It also includes identifying and administrative information. Dependencies can include a dependency on Time Point. In contrast to the supplier questionnaire assessment, a supplier transaction assessment can include scores relevant for multiple supplier assessment profiles, or no supplier assessment profile. The elements located directly at the node Supplier Transaction Assessment are defined by the data type: SupplierTransactionAssessmentElements. These elements can include: UUID, SystemAdministrativeData, BaseBusinessTransactionDocumentID, BaseBusinessTransactionDocumentTypeCode and BaseBusinessTransactionDocumentKey.

UUID is a globally unique identifier for the Supplier Transaction Assessment, and can be of type GDT: UUID. SystemAdministrativeData is administrative data that is stored in a system, including system user's change dates/times, and can be of type GDT: SystemAdministrativeData. BaseBusinessTransactionDocumentID can be optional, is an identifier of a business transaction document that is the basis for the Supplier Transaction Assessment, and can be of type GDT: BusinessTransactionDocumentID. BaseBusinessTransactionDocumentTypeCode can be optional, is a coded representation of a referenced business transaction document, and can be of type GDT: BusinessTransactionDocumentTypeCode.

BaseBusinessTransactionDocumentKey is an alternative key, is a grouping of elements that uniquely identifies the base business transaction document with its ID and type code, can be of type KDT: BaseBusinessTransactionDocumentKey, and can include BaseBusinessTransactionDocumentID and BaseBusinessTransactionDocumentTypeCode.

BaseBusinessTransactionDocumentID is an identifier of the business transaction document on which a BaseBusinessTransactionDocument is based, and can be of type GDT: BusinessTransactionDocumentID. BaseBusinessTransactionDocumentTypeCode is a coded representation of the type of the business transaction document on which the BaseBusinessTransactionDocument is based, and can be of type GDT: BusinessTransactionDocumentTypeCode.

The following composition relationships to subordinate nodes of the root node exist: Item (1:CN) and Party (1:CN). Inbound Association Relationships to the business object include the following: from the business object Identity/node Identity, LastChangeIdentity, with a cardinality of 1:CN, which is the identity that changed the Supplier Transaction Assessment the last time; from the business object Identity/node Identity, CreationIdentity, with a cardinality of 1:CN, which is the identity that created the Supplier Transaction Assessment; and from the business object Purchase Order/node Purchase Order (Cross DU), PurchaseOrder, with a cardinality of 1:C, which is a purchase order that is the base for assessing the supplier transaction. Specialization Associations for Navigation to the node Party include: BuyerParty (Target Cardinality: C); SellerParty (Target Cardinality: C); and ResponsiblePurchasingUnitParty (Target Cardinality: C).

Various queries are associated with the business object. A Query By Elements query returns a list of all supplier transaction assessment items according to specified selection elements. The query elements are defined by the data type: SupplierTransactionAssessmentElementsQueryElements. These elements are the following. SearchText, which can be optional, is of type GDT: SearchText. PartySellerPartyKey, which can be optional, is of type KDT: PartyKey. PartyTypeCode, which can be optional, is a coded representation of a type of party, which can be of type GDT: BusinessObjectTypeCode. PartyID, which can be optional, is an identifier for a party, which can be of type GDT: PartyID.

SystemAdministrativeData, which can be optional, is administrative data that is stored in a system. This data includes system user's change dates/times, and may be based on datatype QueryElementSystemAdministrativeData. BaseBusinessTransactionDocumentKey, which is an optional Alternative Key, is a grouping of elements that uniquely identifies the base business transaction document with its ID and type code, which can be of type KDT: BaseBusinessTransactionDocumentKey. ItemProductProductCategoryUUID, which can be optional, can be of type GDT: UUID. ItemProductProductCategoryIDKey, which can be optional, can be of type KDT: ProductCategoryHierarchyProductCategoryIDKey. SystemAdministrativeData can include the following sub-elements. CreationDateTime, which can be optional, is a creation date/time (date and time stamp), which can be of type GDT: GLOBAL_DateTime. CreationIdentityUUID, which can be optional, is a universally unique identifier of an identity who performed a creation, which can be of type GDT: UUID. CreationIdentityID, which can be optional, is an identifier for an identity who performed the creation, which can be of type GDT: IdentityID. CreationIdentityBusinessPartnerInternalID, which can be optional, is a unique proprietary identifier of the business partner that is attributed to the creation identity and that can be reached following the relationships of the creation identity, which can be of type GDT: BusinessPartnerInternalID.

CreationIdentityBusinessPartnerPersonFamilyName, which can be optional, is the family name of the business partner of the category person that is attributed to the creation identity and that can be reached following the relationships of the creation identity, which can be of type GDT: LANGUAGEINDEPENDENT_MEDIUM_Name. CreationIdentityBusinessPartnerPersonGivenName, which can be optional, is the given name of the business partner of the category person that is attributed to the creation identity and that can be reached following the relationships of the creation identity, which can be of type GDT: LANGUAGEINDEPENDENT_MEDIUM_Name. CreationIdentityEmployeeID, which can be optional, is a unique identifier of the employee that is attributed to the creation identity and that can be reached following the relationships of the creation identity, which can be of type GDT: EmployeeID.

LastChangeDateTime, which can be optional, is the time (date and time stamp) of last change, which can be of type GDT: GLOBAL_DateTime. LastChangeIdentityUUID, which can be optional, is a universally unique identifier of an identity who did the last change, which can be of type GDT: UUID. LastChangeIdentityID, which can be optional, is a unique identifier of an identity who did the last change, which can be of type GDT: IdentityID. LastChangeIdentityBusinessPartnerInternalID, which can be optional, is a unique proprietary identifier of the business partner that is attributed to the last change identity and that can be reached following the relationships of the last change identity, which can be of type GDT: BusinessPartnerInternalID.

LastChangeIdentityBusinessPartnerPersonFamilyName, which can be optional, is the family name of the business partner of the category person that is attributed to the last change identity and that can be reached following the relationships of the last change identity, which can be of type GDT: LANGUAGEINDEPENDENT_MEDIUM_Name. LastChangeIdentityBusinessPartnerPersonGivenName, which can be optional, is the given name of the business partner of the category person that is attributed to the last change identity and that can be reached following the relationships of the last change identity, which can be of type GDT: LANGUAGEINDEPENDENT_MEDIUM_Name. LastChangeIdentityEmployeeID, which can be optional, is a unique identifier of the employee that is attributed to the last change identity and that can be reached following the relationships of the last change identity, which can be of type GDT: EmployeeID.

BaseBusinessTransactionDocumentKey can include the following sub-elements. BaseBusinessTransactionDocumentID is an identifier of the business transaction document on which the BaseBusinessTransactionDocument is based, and can be of type GDT: BusinessTransactionDocumentID. BaseBusinessTransactionDocumentTypeCode is a coded representation of the type of the business transaction document on which the BaseBusinessTransactionDocument is based, and can be of type GDT: BusinessTransactionDocumentTypeCode.

ItemProductProductCategoryIDKey can include the following sub-elements. ProductCategoryHierarchyID is an identifier for a product category hierarchy, and can be of type GDT: ProductCategoryHierarchyID. ProductCategoryInternalID is an identifier for a product category, and can be of type GDT: ProductCategoryInternalID.

Definitions of nodes in the business object follow. The item node is an item from a base business transaction document that includes data used to assess a supplier. The item data that is replicated from a base business transaction document includes quantity, price and delivery period.

The elements located directly at the node Item are defined by the data type: SupplierTransactionAssessmentItemElements. These elements include the following. UUID, which is an alternate key, is a globally unique identifier of the supplier transaction assessment item for referencing purposes, which can be of type GDT: UUID. ID is an identifier of a supplier transaction assessment item, which can be of type GDT: BusinessTransactionDocumentItemID. SystemAdministrativeData is administrative data that is stored in a system. This data includes system user's change dates/times, which can be of type GDT: SystemAdministrativeData. Quantity, which can be optional, is a quantity of an item in a base business transaction document that is replicated in a supplier transaction assessment item, which can be of type GDT: Quantity. QuantityTypeCode, which can be optional, is a coded representation of the quantity type of the supplier transaction assessment item, which can be of type GDT: QuantityTypeCode. DeliveryPeriod, which can be optional, is a delivery period of an item in a base business transaction document that is replicated in the supplier transaction assessment item, which can be of type GDT: UPPEROPEN_LOCALNORMALISED_DateTimePeriod. NetUnitPrice, which can be optional, is a net price of an item in a base business transaction document that is replicated in the supplier transaction assessment item, which can be of type GDT: Price.

The following composition relationships to subordinate nodes exist: ItemProduct (with a cardinality of 1:C), ItemLocation (with a cardinality of 1:CN), ItemBusinessTransactionDocumentReference (with a cardinality of 1:N), ItemActualValues (with a cardinality of 1:C), and ItemAssessment (with a cardinality of 1:CN).

Inbound Association Relationships include the following: from the business object Identity/node Identity, LastChangeIdentity, with a cardinality of 1:CN, which is the Identity that changed the Supplier Transaction Assessment Item the last time; from the business object Identity/node Identity, CreationIdentity, with a cardinality of 1:CN, which is the Identity that created the Supplier Transaction Assessment Item; and rom the business object Purchase Order/node Item (Cross DU), PurchaseOrderItem, with a cardinality of C:C, which is the purchase order item that is the base for assessing the supplier transaction.

Specialization Associations for Navigation include: to node Item Location, Receiving Item Site, with a target cardinality of C, which is the location at the company that receives the delivery of the goods.

Integrity Conditions can include the following. In some implementations, only the items which can be assessed (e.g., materials and services) are replicated from the items of the Base Transaction Document which is associated to the root.

Enterprise Service Infrastructure Actions include Compute Score which computes the assessment scores for all the transaction-related assessment properties specified in a supplier assessment profile. The assessed scores are stored in the item property valuation node.

Queries include a Query By Elements query that returns a list of all supplier transaction assessment items according to the specified selection elements. The query elements are defined by the data type: SupplierTransactionAssessmentItemElementsQueryElements. These elements include the following. SearchText, which can be optional, can be of type GDT: SearchText. PartySellerPartyKey, which can be optional, is of type KDT: PartyKey. PartyTypeCode, which can be optional, is a coded representation of a type of party, which can be of type GDT: BusinessObjectTypeCode. PartyID, which can be optional, is an identifier for a party, which can be of type GDT: PartyID. SystemAdministrativeData, which can be optional, is administrative data that is stored in a system. This data includes system user's change dates/times, and can be of type QueryIDT: QueryElementSystemAdministrativeData. CreationDateTime, which can be optional, is a creation date/time (date and time stamp), which can be of type GDT: GLOBAL_DateTime. CreationIdentityUUID, which can be optional, is a universally unique identifier of an identity who did the creation, which can be of type GDT: UUID. CreationIdentityID, which can be optional, is an identifier for an identity who did the creation, which can be of type GDT: IdentityID. CreationIdentityBusinessPartnerInternalID, which can be optional, is a unique proprietary identifier of the business partner that is attributed to the creation identity and that can be reached following the relationships of the creation identity, which can be of type GDT: BusinessPartnerInternalID. CreationIdentityBusinessPartnerPersonFamilyName, which can be optional, is a family name of the business partner of the category person that is attributed to the creation identity and that can be reached following the relationships of the creation identity, which can be of type GDT: LANGUAGEINDEPENDENT_MEDIUM_Name. CreationIdentityBusinessPartnerPersonGivenName, which can be optional, is a given name of a business partner of the category person that is attributed to the creation identity and that can be reached following the relationships of the creation identity, which can be of type GDT: LANGUAGEINDEPENDENT_MEDIUM_Name. CreationIdentityEmployeeID, which can be optional, is a unique identifier of the employee that is attributed to the creation identity and that can be reached following the relationships of the creation identity, which can be of type GDT: EmployeeID. LastChangeDateTime, which can be optional, is a time (date and time stamp) of last change, which can be of type GDT: GLOBAL_DateTime. LastChangeIdentityUUID, which can be optional, is a universally unique identifier of an identity who did the last change, which can be of type GDT: UUID. LastChangeIdentityID, which can be optional, is a unique identifier of an identity who did the last change, which can be of type GDT: IdentityID. LastChangeIdentityBusinessPartnerInternalID, which can be optional, is a unique proprietary identifier of the business partner that is attributed to the last change identity and that can be reached following the relationships of the last change identity, which can be of type GDT: BusinessPartnerInternalID. LastChangeIdentityBusinessPartnerPersonFamilyName, which can be optional, is a family name of the business partner of the category person that is attributed to the last change identity and that can be reached following the relationships of the last change identity, which can be of type GDT: LANGUAGEINDEPENDENT_MEDIUM_Name. LastChangeIdentityBusinessPartnerPersonGivenName, which can be optional, is a given name of the business partner of the category person that is attributed to the last change identity and that can be reached following the relationships of the last change identity, which can be of type GDT: LANGUAGEINDEPENDENT_MEDIUM_Name. LastChangeIdentityEmployeeID, which can be optional, is a unique identifier of the employee that is attributed to the last change identity and that can be reached following the relationships of the last change identity, which can be of type GDT: EmployeeID. ItemProductProductCategoryUUID, which can be optional, can be of type GDT: UUID. ItemProductProductCategoryIDKey, which can be optional, can be of type KDT: ProductCategoryHierarchyProductCategoryIDKey, and include the following sub-items. ProductCategoryHierarchyID is an identifier for a product category hierarchy, which can be of type GDT: ProductCategoryHierarchyID. ProductCategoryInternalID is an identifier for a product category, which can be of type GDT: ProductCategoryInternalID.

The item product node defines a product of a base business transaction document that includes product and product category identification details The elements located directly at the node Item Product are defined by the data type: SupplierTransactionAssessmentItemProductElements. These elements include the following. ProductUUID, which can be optional, is a globally unique identifier for a product, which can be of type GDT: UUID.

ProductKey, which can be optional, is a grouping of elements that uniquely identifies a product, which can be of type KDT: ProductKey, and can include the following three sub-items. ProductTypeCode is a coded representation of a product type such as a material or service, which can be of type GDT: ProductTypeCode. ProductIdentifierTypeCode is a coded representation of a product identifier type, which can be of type GDT: ProductIdentifierTypeCode. ProductID is an identifier for a product, which can be of type GDT: ProductID.

ProductCategoryUUID is a globally unique identifier for a product category, which can be of type GDT: UUID. ProductCategoryIDKey is a grouping of elements that uniquely identifies a product category, which can be of type KDT: ProductCategoryHierarchyProductCategoryIDKey, and can include the following two sub-items. ProductCategoryHierarchyID is an identifier for a product category hierarchy, which can be of type GDT: ProductCategoryHierarchyID. ProductCategoryInternalID is an identifier for a product category, which can be of type GDT: ProductCategoryInternalID).

Inbound Aggregation Relationships can include the following: from the business object Expense Product/node Expense Product, ExpenseProduct, with a cardinality of C:CN, which defines the expense product that represents an expense incurred in the process of a supplier transaction assessment from the business object Material/node Material, Material, with a cardinality of C:CN, which defines the material that is occurs in the supplier transaction assessment; from the business object Product Category Hierarchy/node Product Category, ProductCategory, with a cardinality of C:CN, which defines a product category that classifies the material, service or expense product requested in the supplier transaction assessment item; from the business object Service Product/node Service Product, ServiceProduct, with a cardinality of C:CN, which defines the service product that is occurs in the supplier transaction assessment.

The Item Location node defines a physical or logical place that is relevant for the supplier transaction assessment item. Specializations can occur, including receiving Item Site. The elements located directly at the node Item Location are defined by the data type: SupplierTransactionAssessmentItemLocationElements. These elements are: UUID, which is an alternate key, is a globally unique identifier for the supplier transaction assessment location, which can be of type GDT: UUID. LocationID is a unique identifier for the referenced location, which can be of type GDT: LocationID. LocationUUID is a globally unique identifier for the referenced location, which can be of type GDT: UUID. AddressReference, which can be optional, is a unique reference to the address of the item location, and can be of type BOIDT: ObjectNodeLocationAddressReference.

AddressHostUUID, which can be optional, is a universally unique identifier for the address of the business partner, the organizational unit or its specializations, the business object InstalledBase or the business object InstallationPoint, which can be of type GDT: UUID. BusinessObjectTypeCode, which can be optional, is a coded representation of the type of the business object, in which the address referenced in the LocationAddressUUID is integrated as a dependent object, which can be of type GDT: BusinessObjectTypeCode. AddressHostTypeCode, which can be optional, is a coded representation of the address host type of the address referenced by the AddressUUID or the address included using the Location Address composition, which can be of type GDT: AddressHostTypeCode. PartyKey, which can be optional, is an alternative identifier of a party (representing a business partner or an organizational unit) that references the address using the AddressUUID, which can be of type KDT: PartyKey.

PartyTypeCode, which can be optional, is a coded representation of a type of party, which can be of type GDT: BusinessObjectTypeCode. PartyID, which can be optional, is an identifier for a party, which can be of type GDT: PartyID.

InstalledBaseID, which can be optional, is an identifier for an installed base that references the address using the AddressUUID, which can be of type GDT: InstalledBaseID. InstallationPointID, which can be optional, is an identifier for an installation point that references the address using the AddressUUID, which can be of type GDT: InstallationPointID.

RoleCode is a coded representation of the location role in the procurement document item, which can be of type GDT: LocationRoleCode. RoleCategoryCode is a coded representation of the location role category in the procurement document item, which can be of type GDT: LocationRoleCategoryCode. DeterminationMethodCode, which can be optional, is a coded representation of the determination method of the item location, which can be of type GDT: LocationDeterminationMethodCode.

Inbound Aggregation Relationships can include the following: from the business object Location/node Location, Location, with a cardinality of C:CN.

The Item Business Transaction Document Reference node defines a unique reference between the base business transaction document item and its follow-on business transaction document item. The elements located directly at the node Item Business Transaction Document Reference are defined by the data type: SupplierTransactionAssessmentItemBusinessTransactionDocumentReferenceElements. These elements include the following.

BusinessTransactionDocumentReference is a unique reference to a business transaction document. It is also possible to have a reference to a line item within the business transaction document, which can be of type GDT: BusinessTransactionDocumentReference. BusinessTransactionDocumentRelationshipRoleCode, which can be optional, is a coded representation of the role of a business transaction document in a reference, which can be of type GDT: BusinessTransactionDocumentRelationshipRoleCode. BusinessTransactionDocumentItemKey, which can be optional, is a grouping of elements that uniquely identifies a human-readable business transaction document item, which can be of type KDT: BusinessTransactionDocumentItemKey. BusinessTransactionDocumentKey is a key of the BusinessTransactionDocument, which can be of type KDT: BusinessTransactionDocumentKey.

BusinessTransactionDocumentID is a unique identifier for a business transaction document, which can be of type GDT: BusinessTransactionDocumentID. BusinessTransactionDocumentTypeCode is a coded representation of the document type that occurs in business transactions. The document type describes the (business) nature of similar documents and defines the basic features of this type of documents, which can be of type GDT: BusinessTransactionDocumentTypeCode.

BusinessTransactionDocumentItemID is a unique identifier of an item or subitem of a document within a business transaction and is unique in the context of the business transaction, which can be of type GDT: BusinessTransactionDocumentItemID.

The following composition relationships to subordinate nodes exist: ItemBusinessTransactionDocumentReferenceActualValues (with a cardinality of 1:C).

Inbound Association Relationships can include the following: from the business object Confirmed Inbound Delivery/node Item (Cross DU), ConfirmedInboundDeliveryItem, with a cardinality of C:CN, which is a confirmed inbound delivery item which fulfills a purchase order; from the business object Goods and Service Acknowledgement/node Item (Cross DU), GoodsAndServiceAcknowledgementItem, with a cardinality of C:CN, which is a goods and service acknowledgement item which fulfills a purchase order; from the business object Material Inspection/node Material Inspection (Cross DU), MaterialInspection, with a cardinality of C:C, which is a material inspection processed during inbound delivery processing; from the business object Outbound Delivery/node Item (Cross DU), OutboundDeliveryItem, with a cardinality of C:CN, which is an outbound delivery item that might be processed during the purchase order delivery processing; and from the business object Supplier Invoice/node Item (Cross DU), SupplierInvoiceItem, with a cardinality of C:CN, which is a supplier invoice item that is posted with reference to the base supplier transaction.

Integrity Conditions can include the following. In some implementations, the different documents whose references are stored are: Purchase Order, Material Inspection, Goods and Service Acknowledgement, Supplier Invoice, Confirmed Inbound Delivery and outbound delivery.

The Item Business Transaction Document Reference Actual Values node defines the actual values achieved from a business transaction document, referenced by a base business transaction document item. For example, delivered quantity and date from the inbound delivery and GSA and invoiced amount from supplier invoice.

The elements located directly at the node Item Business Transaction Document Reference Actual Values are defined by the data type: SupplierTransactionAssessmentItemBusinessTransactionDocumentReferenceActualValuesElements. These elements include the following. ActiveIndicator is an indicator that specifies whether or not a referenced business transaction document is commercially active in a procurement process, which can be of type GDT: Indicator, Qualifier: Active. Amount, which can be optional, is an amount of the referenced business transaction document item, and can be of type GDT: Amount. AmountRoleCode, which can be optional, is a coded representation of the role of the amount in the referenced business transaction document. Example role codes can include: 55—OrderedNetAmount, 56—DeliveredNetAmount, and 57—InvoicedNetAmount. AmountRoleCode can be of type GDT: AmountRoleCode. CancellationDocumentIndicator is an indicator that specifies whether or not the referenced business transaction document is a cancellation document, which can be of type GDT: Indicator, Qualifier: CancellationDocument. Quantity, which can be optional, is a quantity of the referenced business transaction document item, which can be of type GDT: Quantity. QuantityTypeCode, which can be optional, is a coded representation of a type of quantity in the referenced business transaction document item, which can be of type GDT: QuantityTypeCode. QuantityRoleCode, which can be optional, is a coded representation of the role of the quantity in the referenced business transaction document.

Example role codes can include: 17—DeliveredQuantity, 28—InvoicedQuantity, and 37—OrderedQuantity. QuantityRoleCode can be of type GDT: QuantityRoleCode. Percent, which can be optional, is an attribute of the referenced business transaction object item given in percent, which can be of type GDT: SMALLNONNEGATIVE_Percent. PercentRoleCode, which can be optional, is a coded representation of the role of the percentage in the referenced business transaction document, which can be of type GDT: PercentRoleCode. TimePoint, which can be optional, is a point in time at which the referenced procurement document item became active in the procurement process, which can be of type GDT: TimePoint. TimePointRoleCode, which can be optional, is a coded representation of the role of the time point in the referenced business transaction document, which can be of type GDT: TimePointRoleCode.

The Item Actual Values node defines the aggregation of the actual values achieved in all the follow-on business transaction documents for a base business transaction document item. For example, total delivered and invoiced quantities and amounts for a supplier transaction assessment item.

The elements located directly at the node Item Actual Values are defined by the data type: SupplierTransactionAssessmentItemActualValuesElements. These elements include the following. TotalDeliveredQuantity, which can be optional, is a quantity that is delivered, which can be of type GDT: Quantity, Qualifier: Delivered. TotalDeliveredQuantityTypeCode, which can be optional, is a coded representation of the type of the total delivered quantity, which can be of type GDT: QuantityTypeCode, Qualifier: Delivered. TotalDeliveredNetAmount, which can be optional, is a total net amount of delivered goods or performed services for the purchase order item, which can be of type GDT: Amount. TotalInvoicedQuantity, which can be optional, is a total quantity of invoices that have been posted for the purchase order, which can be of type GDT: Quantity. TotalInvoicedQuantityTypeCode, which can be optional, is a coded representation of the type of the total posted invoice quantity, which can be of type GDT: QuantityTypeCode. TotalInvoicedNetAmount, which can be optional, is an amount that is the total of all the invoices posted for the referenced procurement document item, which can be of type GDT: Amount.

The Item Assessment node defines a valuation of a supplier assessment property based on the comparison of the planned data within the item and the item actual values.

The elements located directly at the node Item Assessment are defined by the data type: SupplierTransactionAssessmentItemAssessmentElements. These elements include the following. UUID, which is an alternate key, is a globally unique identifier for a supplier transaction item property valuation for referencing purposes, which can be of type GDT: UUID. PropertyAssessmentMethodCode is a coded representation of a property assessment method, which specifies the method according to which a supplier assessment property is assessed. Integrity conditions can include the following. The following codes are supported: 3—Objective By Price Deviation 4—Objective By Quantity Deviation, and 5—Objective By Delivery Deviation. PropertyAssessmentMethodCode can be of type GDT: SupplierAssessmentPropertyAssessmentMethodCode. ScorePercent is a score of an assessment property given in percent, which can be of type GDT: SMALLNONNEGATIVE_Percent, Qualifier: Score. In some implementations, Best Score is 100% and Worst Score=0%.

Integrity Conditions can include the following. In some implementations, a supplier transaction assessment item property valuation is only possible for assessment properties that are specified for objective assessment methods, such as price, quantity or delivery deviation.

The Party node defines a natural or legal person, organization, organizational unit, or group that is involved in the supplier transaction assessment in a party role.

The following specializations can occur: Buyer Party, Seller Party and Responsible Purchasing Unit Party.

The elements located directly at the node Party are defined by the data type: SupplierTransactionAssessmentPartyElements. These elements are now described. UUID, which is an alternate key, is a globally unique identifier of the supplier transaction assessment party, which can be of type GDT: UUID. PartyUUID is a globally unique identifier for a business partner, the organizational center, or their specializations, which can be of type GDT: UUID. PartyTypeCode is a coded representation of the type of business partner, organizational center, or their specializations referenced by the PartyUUID element, which can be of type GDT: BusinessObjectTypeCode. RoleCategoryCode is a coded representation of a party role category of the party in a supplier assessment profile or the master data object, which can be of type GDT: PartyRoleCategoryCode. RoleCode is a coded representation of a party role of the party in a supplier assessment profile or the master data object, which can be of type GDT: PartyRoleCode. AddressReference, which can be optional, is a reference to the address of the party, which can be of type GDT: PartyAddressReference. DeterminationMethodCode, which can be optional, is a coded representation of the determination method of a party, which can be of type GDT: PartyDeterminationMethodCode. PartyKey is a grouping of elements that uniquely identifies a party that is involved in the procurement document, which can be of type KDT: PartyKey, and includes the following sub-nodes. PartyTypeCode, which can be optional, is a coded representation of a type of party, which can be of type GDT: BusinessObjectTypeCode. PartyID, which can be optional, is an identifier for a party, which can be of type GDT: PartyID.

Inbound Aggregation Relationships can include the following. From the business object Party/node Party, Party C:CN, which is a referenced Party from master data, for e.g., supplier, purchasing unit, company.

A number of implementations have been described. Nevertheless, it will be understood that various modifications may be made without departing from the spirit and scope of the disclosure. Accordingly, other implementations are within the scope of the following claims.

What is claimed is:

1. A tangible computer readable medium including program code for providing a message-based interface for exchanging capabilities-related information based on a request for information (RFI) between a buyer and existing or potential suppliers, the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for a request from the buyer to the supplier to provide a response to the RFI that includes a first message package derived from the common business object model and hierarchically organized in memory as:
a form RFI response request message entity; and
a request for information package comprising a request for information entity, where the request for information entity includes a watermark name and an ID; and
program code for processing the first message according to the hierarchical organization of the first message package, where processing the first message includes unpacking the first message package based on the common business object model; and
program code for sending a second message to the heterogeneous application responsive to the first message, where the second message includes a second message package derived from the common business object model to provide consistent semantics with the first message package.

2. The computer readable medium of claim 1, wherein the request for information package further comprises at least one of the following: a party package, a property package, a text package, an attachment package, and a section package.

3. The computer readable medium of claim 1, wherein the request for information entity comprises at least one of the following: a reconciliation period counter value, a name, and a supplier group code.

4. A distributed system operating in a landscape of computer systems providing message-based services defined in a service registry, the system comprising:
a graphical user interface comprising computer readable instructions, embedded on tangible media, for a request from a buyer to a potential supplier to provide a response to an RFI using a request;
a first memory storing a user interface controller for processing the request and involving a message including a message package derived from a common business object model, where the common business object model includes business objects having relationships that enable derivation of message-based service interfaces and message packages, the message package hierarchically organized as:
a form RFI response request message entity; and
a request for information package comprising a request for information entity, where the request for information entity includes a watermark name and an ID; and
a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

5. The distributed system of claim 4, wherein the first memory is remote from the graphical user interface.

6. The distributed system of claim 4, wherein the first memory is remote from the second memory.

7. A tangible computer readable medium including program code for providing a message-based interface for exchanging RFI response-related information in response to a request for information in which an existing supplier and/or potential supplier provides the requested information, the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for a confirmation submitted by a supplier to a buyer in response to the request for information that includes a first message package derived from the common business object model and hierarchically organized in memory as:
an RFI response confirmation message entity; and
an RFI response package comprising an RFI response entity, a party package and a business transaction document reference package, where the party package includes a seller party entity, where the business transaction document reference package includes a base request for information reference entity, and further where the base request for information reference entity comprises an ID;
program code for processing the first message according to the hierarchical organization of the first message package, where processing the first message includes unpacking the first message package based on the common business object model; and
program code for sending a second message to the heterogeneous application responsive to the first message, where the second message includes a second message package derived from the common business object model to provide consistent semantics with the first message package.

8. The computer readable medium of claim 7, wherein the RFI response package further comprises at least one of the following: a properties package, a text package, an attachment package, and a section package.

9. A distributed system operating in a landscape of computer systems providing message-based services defined in a service registry, the system comprising:
a graphical user interface comprising computer readable instructions, embedded on tangible media, for a confirmation submitted by a supplier to a buyer in response to a request for information using a request;
a first memory storing a user interface controller for processing the request and involving a message including a message package derived from a common business object model, where the common business object model includes business objects having relationships that enable derivation of message-based service interfaces and message packages, the message package hierarchically organized as:
an RFI response confirmation message entity; and
an RFI response package comprising an RFI response entity, a party package and a business transaction document reference package, where the party package includes a seller party entity, where the business transaction document reference package includes a base request for information reference entity, and further where the base request for information reference entity comprises an ID; and
a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

10. The distributed system of claim 9, wherein the first memory is remote from the graphical user interface.

11. The distributed system of claim 9, wherein the first memory is remote from the second memory.

12. A tangible computer readable medium including program code for providing a message-based interface for exchanging supplier assessment profile-related information, including information for a profile for assessing suppliers that includes rules, weighted assessment criteria, and questions related to supplier performance, the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for requesting supplier assessment profile-related information that includes a first message package derived from the common business object model and hierarchically organized in memory as:
a supplier assessment profile request message entity; and
a supplier assessment profile package comprising a supplier assessment profile entity and an access control list package, where the supplier assessment profile entity includes an identifier (ID), a universally unique identifier (UUID), system administrative data, a time zone code, and a template indicator; and
program code for processing the first message according to the hierarchical organization of the first message package, where processing the first message includes unpacking the first message package based on the common business object model; and
program code for sending a second message to the heterogeneous application responsive to the first message, where the second message includes a second message package derived from the common business object model to provide consistent semantics with the first message package.

13. The computer readable medium of claim 12, wherein the supplier assessment profile package further comprises at least one of the following: a party package, an assessment category package, a calendar day recurrence specification package, a text collection package, an attachment folder package, and a calculated assessment period.

14. The computer readable medium of claim 12, wherein the supplier assessment profile entity further comprises at least one of the following: a name and a product category.

15. A distributed system operating in a landscape of computer systems providing message-based services defined in a service registry, the system comprising:
a graphical user interface comprising computer readable instructions, embedded on tangible media, for requesting supplier assessment profile-related information, including information for a profile for assessing suppliers that includes rules, weighted assessment criteria, and questions related to supplier performance using a request;
a first memory storing a user interface controller for processing the request and involving a message including a message package derived from a common business object model, where the common business object model includes business objects having relationships that enable derivation of message-based service interfaces and message packages, the message package hierarchically organized as:
a supplier assessment profile request message entity; and
a supplier assessment profile package comprising a supplier assessment profile entity and an access control list package, where the supplier assessment profile entity includes an identifier (ID), a universally unique identifier (UUID), system administrative data, a time zone code, and a template indicator; and
a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

16. The distributed system of claim 15, wherein the first memory is remote from the graphical user interface.

17. The distributed system of claim 15, wherein the first memory is remote from the second memory.

18. A tangible computer readable medium including program code for providing a message-based interface for exchanging supplier questionnaire assessment-related information, including an assessment of a supplier's performance based on a questionnaire that includes answers to a list of questions about the supplier that is submitted by a buyer, the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for a confirmation about the completion of a supplier questionnaire assessment that includes a first message package derived from the common business object model and hierarchically organized in memory as:
a supplier questionnaire assessment completion confirmation message entity; and
a supplier questionnaire assessment package comprising a supplier questionnaire assessment entity and a party package, where the supplier questionnaire assessment entity includes an ID, and where the party package includes an appraiser party entity, and further where the appraiser party entity includes a seller ID;
program code for processing the first message according to the hierarchical organization of the first message package, where processing the first message includes unpacking the first message package based on the common business object model; and
program code for sending a second message to the heterogeneous application responsive to the first message, where the second message includes a second message package derived from the common business object model to provide consistent semantics with the first message package.

19. The computer readable medium of claim 18, wherein the supplier questionnaire assessment entity further comprises a reconciliation period counter value.

20. The computer readable medium of claim 18, wherein the supplier questionnaire assessment package further comprises at least one of the following: a text package, an attachment package, and a category package.

21. A distributed system operating in a landscape of computer systems providing message-based services defined in a service registry, the system comprising:
a graphical user interface comprising computer readable instructions, embedded on tangible media, for a confirmation about the completion of a supplier questionnaire assessment, including an assessment of a supplier's performance based on a questionnaire that includes answers to a list of questions about a supplier that is submitted by a buyer, using a request;
a first memory storing a user interface controller for processing the request and involving a message including a message package derived from a common business object model, where the common business object model includes business objects having relationships that enable derivation of message-based service interfaces and message packages, the message package hierarchically organized as:
a supplier questionnaire assessment completion confirmation message entity; and
a supplier questionnaire assessment package comprising a supplier questionnaire assessment entity and a party package, where the supplier questionnaire assessment entity includes an ID, and where the party package includes an appraiser party entity, and further where the appraiser party entity includes a seller ID; and
a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

22. The distributed system of claim 21, wherein the first memory is remote from the graphical user interface.

23. The distributed system of claim 21, wherein the first memory is remote from the second memory.

24. A tangible computer readable medium including program code for providing a message-based interface for exchanging supplier transaction assessment-related information, including an assessment of a supplier's performance based on an automatic evaluation of a business transaction and follow-on business transactions, the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for requesting supplier transaction assessment-related information that includes a first message package derived from the common business object model and hierarchically organized in memory as:
a supplier transaction assessment request message entity; and
a supplier transaction assessment package comprising a supplier transaction assessment entity, where the supplier transaction assessment entity includes a universally unique identifier, system administrative data, and a base business transaction document key;
program code for processing the first message according to the hierarchical organization of the first message package, where processing the first message includes unpacking the first message package based on the common business object model; and
program code for sending a second message to the heterogeneous application responsive to the first message, where the second message includes a second message package derived from the common business object model to provide consistent semantics with the first message package.

25. The computer readable medium of claim 24, wherein the supplier transaction assessment package further comprises at least one of the following: an item package and a party package.

26. The computer readable medium of claim 24, wherein the supplier transaction assessment entity comprises at least one of the following: a base business transaction document ID and a base business transaction document type code.

27. A distributed system operating in a landscape of computer systems providing message-based services defined in a service registry, the system comprising:
a graphical user interface comprising computer readable instructions, embedded on tangible media, for requesting supplier transaction assessment-related information, including an assessment of a supplier's performance based on an automatic evaluation of a business transaction and follow-on business transactions, using a request;
a first memory storing a user interface controller for processing the request and involving a message including a message package derived from a common business object model, where the common business object model includes business objects having relationships that enable derivation of message-based service interfaces and message packages, the message package hierarchically organized as:
a supplier transaction assessment request message entity; and
a supplier transaction assessment package comprising a supplier transaction assessment entity, where the supplier transaction assessment entity includes a universally unique identifier, system administrative data, and a base business transaction document key; and
a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

28. The distributed system of claim 27, wherein the first memory is remote from the graphical user interface.

29. The distributed system of claim 27, wherein the first memory is remote from the second memory.
